(19) United States
(12) Patent Application Publication
(10) Pub. No.: US 2002/0004457 A1
(43) Pub. Date: Jan. 10, 2002

(54) Herbicidal composition

(76) Inventors: David John Nevill, Riehen (CH); Andreas Zoschke, Weil am Rhein (DE); Andreas Stehli, Gipf-Oberfrick (CH)

Correspondence Address: William A. Teoli, Jr., Syngenta Crop Protection, Inc., Patent and Trademark Dept., 410 Swing Road, Greensboro, NC, 27409, US

(21) Appl. No.: 09/852,484

(22) Filed: May 10, 2001

Related U.S. Application Data
(63) Continuation of application No. PCT/EP99/08559, filed on Nov. 8, 1999.

(30) Foreign Application Priority Data
Nov. 10, 1998 (DE) 19851854.4
Dec. 21, 1998 (DE) 19859224.8
Apr. 1, 1999 (DE) 19915013.3
Apr. 30, 1999 (DE) 19919951.5

(51) Int. Cl. A01N 43/36

(52) U.S. Cl. 504/138

(57) ABSTRACT

A herbicidal synergistic composition for controlling broad-leaved weeds and grasses in crops of useful plants resistant to protoporphyrinogen oxidase inhibitors, comprising, in addition to customary inert formulation auxiliaries, as active compounds a) a herbicide which inhibits the action of protoporphyrinogen oxidases and b) at least one further pesticide selected from the group consisting of co-herbicides, fungicides and insecticides/acaricides.

The present invention relates to a novel herbicidal synergistic composition comprising a herbicidal active compound combination which is suitable for selectively controlling undesirable vegetation in crops of useful plants resistant to protoporphyrinogen oxidase inhibitors, for example maize, sugar beet, soya beans, rape, cotton, sunflowers, cereals, rice and sugar cane.

The invention furthermore relates to a process for controlling undesirable vegetation using the herbicidal composition, and to the use of the composition mentioned for this purpose.

Suitable active compounds are a) a herbicide which inhibits the action of protoporphyrinogen oxidases in plants (=protoporphyrinogen oxidase inhibitors), and b) at least one further pesticide selected from the group consisting of herbicides, fungicides and insecticides/acaricides.

Preference is given to a composition which comprises a protoporphyrinogen oxidase inhibitor and at least one further co-herbicide.

The pesticides under a) and b) are known and described, for example, in ‘The Pesticide Manual’, Editor C. D. S. Tomlin, 11th Edition, British Crop Protection Council, 1997, U.S. Pat. No. 5,446,197, U.S. Pat. No. 5,176,735 and WO 95/34659.

WO 98/33927, WO 98/29554 and U.S. Pat. No. 5,767,373 describe genetically transformed plants which are resistant to certain herbicides which inhibit protoporphyrinogen biosynthesis.

Surprisingly, it has now been found, that a combination, the ratios in which may vary, of protoporphyrinogen-oxidase-inhibiting active compounds under a) with one or more of the active compounds listed under b), all of which are known and most of which are also commercially available, unfolds synergistic action capable of controlling most of the broad-leaved weeds and grasses preferably occurring in crops of useful plants resistant to protoporphyrinogen oxidase inhibitors, both by the pre-emergence and the post-emergence method, without causing any significant damage to the useful plant.

According to the present invention, we therefore propose a novel synergistic composition for selectively controlling weeds in crops of useful plants resistant to protoporphyrinogen oxidase inhibitors which, in addition to customary inert formulation auxiliaries, comprises, as active compound, a mixture of

a) a herbicide which inhibits the action of protoporphyrinogen oxidases, and

b) at least one further pesticide selected from the group consisting of co-herbicides, fungicides and insecticides/acaricides.

Preferred herbicidal compositions for controlling broad-leaved weeds and grasses in crops of useful plants resistant to protoporphyrinogen oxidase inhibitors comprise a herbicide a) which inhibits the action of protoporphyrinogen oxidases and at least one further co-herbicide b).

Preferred groups of protoporphyrinogen-oxidase-inhibiting herbicides under a) are, for example, diphenyl ethers, imides and phenylpyrazoles, and fluazolate (MON 48500/BAY 11500) and thidiazimin (S1305).

Among the diphenyl ethers, particularly preferred protoporphyrinogen oxidase inhibitors are, for example, acifluorphen (7), aclonifen (8), bifenox (69), chlornitrophen (S868), ethoxyfen (HC-252; 391), fluoroglycofen-ethyl (344), fomesafen (365), lactofen (442) and oxyfluorfen (547).

Among the imides, particularly preferred protoporphyrinogen oxidase inhibitors are, for example, azafenidin (37), carfentrazon-ethyl (112), cinidon-ethyl, flumiclorac-pentyl (340), flumioxazin (341), fluthiacet-methyl (359), oxadiargyl (538), oxadiazon (539), pentoxazone (KPP 314; 560), sulfentrazone (665), flumipropyn (S1060), flupropacil, benzfendizone or the compound of the formula A

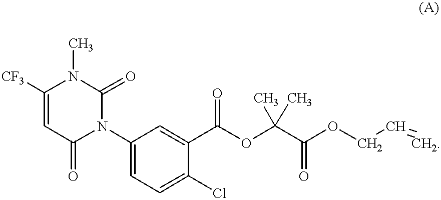

Among the phenylpyrazoles, particularly preferred protoporphyrinogen oxidase inhibitors are, for example, nipyraclofen (S1190) or pyraflufen-ethyl (ET 751; 617).

The compound of the formula A and its preparation are described, for example, in U.S. Pat. No. 5,183,492, whereas all other preferred diphenyl ethers, imides and phenylpyrazoles and also thidiazimins are described in the ‘Pesticide Manual’, 11th Edition, Editor C. D. S. Tomlin, British Crop Protection Council, 1997, under the entry number given in brackets, for example, acifluorfen (7) is described therein under the entry number 7. Fluazolate is known under the name MON 48500/BAY 11500 and the registration number (Reg.No.) [174514-07-9].

Cinidon-ethyl corresponds to the compound ethyl 2-chloro-3-[2-chloro-5-(cyclohex-1-en-1,2-dicarboximido)phenyl]acrylate, known under Reg. No. [132057-06-8]. Flupropacil corresponds to the compound isopropyl 2-chloro-5-(1,2,3,6-tetrahydro-3-methyl-2,6-dioxo-4-trifluoromethylpyrimidin-1-yl)benzoate, known under Reg. No. [120890-70-2]. Benzfendizone is the name proposed by the ISO in AGROW No. 324 of Mar. 12, 1999, for the compound of the formula

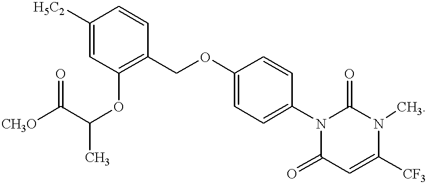

Preferred co-herbicides under b) are, for example, atrazine (34), terbuthylazine (692), (S)-metolachlor, metolachlor (493), terbutryn (693), simazine (651), dimethenamid or (S)-dimethenamid, flufenacet (=fluthiamide, 51), acetochlor (6), alachlor (14), isoxaflutole (436), isoxachlortole, mesotrione, sulcotrione (664), metosulam (495), flumetsulam (339), pendimethalin (557), bromoxynil (88), bentazone (65), carfentrazone-ethyl (112), clomazone (150), nicosulfuron (519), rimsulfuron (644), halosulfuron-methyl (389), metribuzin (497), flumiclorac-pentyl (340), prosulfuron (613), primisulfuron-methyl (589), dicamba (210), fluthiacet-methyl (359), pyridate (626), 2,4-D (192), clopyralide (153), diflufenzopyr (BAS 65400H, 50), fluroxypyr (354), MCPA (455), MCPB (457), mecoprop (MCPP, 459), metobenzuron (491), thifensulfuron-methyl (704), aclonifen (8), EPTC (274), cyanazine (168), propaquizafop (602), metamitron (474), pyramin (chloridazon, 126), phenmedipham (563), desmedipham (206), ethofumesate (285), triasulfuron (723), chloridazon (126), lenacil (443), triallate (722), fluazifop (327), sethoxydim (648), quizalofop (640), fenoxaprop(P-ethyl) (S1044), clethodim (146), oxasulfuron (542), acifluorfen (7), benazolin-ethyl (55), sulfentrazone (665), chlorimuron-ethyl (127), cloransulam-methyl (155), clopyralid (153), fomesafen (365), imazamox (412), imazaquin (414), imazethapyr (415), imazapyr (413), lactofen (442), thidiazuron (703), tribufos (729), trifluralin (740), dimethachlor (238), napropamide (513), quinmerac (636), metazachlor (475), carbetamide (108), dimefuron (236), propyzamide (611), ethametsulfuron-methyl (280), tebutam (682), fluometuron (342), prometryn (597), norflurazon (526), pyrithiobac-sodium (632), MSMA (methylarsonic acid, 486), DSMA (486), diuron (260), flurochloridone (353), dithiopyr (259), thiazopyr (702), oxyfluorfen (547), ethalfluralin (279), clodinafop (147), amidosulfuron (21), diclofop-methyl (219), diflufenican (232), ethoxysulfuron (287), fentrazamide, flazasulfuron (325), florasulam, fluazolate (=MON 48500), flucarbazone, flupyrsulfuron-methyl sodium (348), flurtamone (356), iodosulfuron, isoproturon (433), chlortoluron (134), chlorsulfuron (139), metsulfuron-methyl (498), sulfosulfuron (668), tribenuron-methyl (728), 2,4-DB (199), 2,4-DP (dichlorprop, 216), bifenox (69), ethametsulfuron-methyl (280), flamprop-M (324), imazamethabenz-methyl (411), ioxynil (425), tralkoxydim (717), fluoroglycofen-ethyl (344), methabenzthiazuron (477), isoxaben (435), prosulfocarb (612), difenzoquat-metilsulfate (229), pretilachlor (588), cinosulfuron (145), fenclorim (304), bensulfuron-methyl (62), imazosulfuron (416), pyrazosulfuron-ethyl (620), azimsulfuron (39), esprocarb (278), mefenacet (461), molinate (501), propanil (600), pyrazolate (618), cyhalofop-butyl (178), bispyribac-sodium (76), pyriminobac-methyl (630), cafenstrole (102), oxadiargyl (538), oxadiazon (539), bromobutide (85), MY-100, dymron (daimuron, 195), NB 061, MK243 (indanofan, 422), HW-52 (etobenzanid, 291), AC 014, ametryn (20), hexazinone (400), asulam (33), azafenidin (37), tebuthiuron (683), glyphosate (383), glufosinate (382), sulfosate (383), and the compounds of the formulae

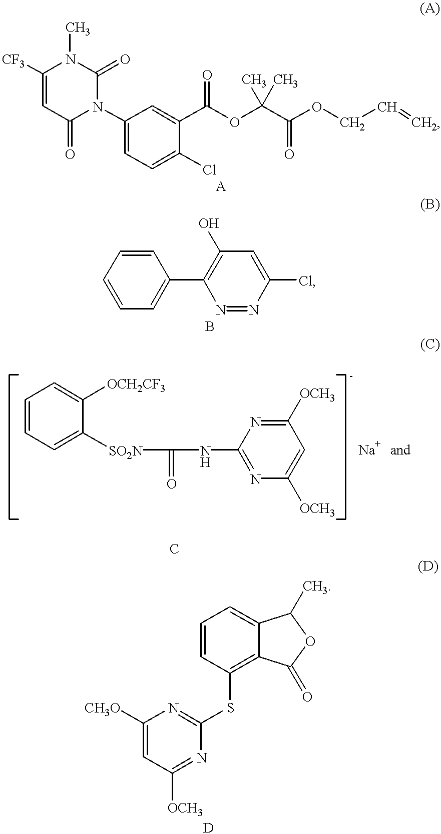

The compound of the formula B is described, for example, in Zeitschrift für Pflanzenkrankheiten and Pflanzenschutz, Special Issue X, 355-360 (1984).

The compound of the formula C is described, for example, in WO 97/41112.

The compound of the formula D is described, for example, in EP-B-0 447 506 in Table 1 as Example 12.

(S)-Metolachlor and (S)-dimethenamid are described, for example, in WO 97/34485. Mesotrion is described, for example, in U.S. Pat. No. 5,006,158. Iodosulfuron and isoxachlortole are known, for example, from ‘AGROW’ No. 296 of Jan. 16, 1998, page 22. Fentrazamide is described in ‘The 1997 British Crop Protection Conference—Weeds, Conference Proceedings Vol. 1, 2-8, pages 67 to 72.

Florasulam is the name proposed by ISO in AGROW No. 304 of May 15, 1998, page 21, for the triazolepyrimidinesulfonanilide herbicide developed by Dow Agro Sciences.

Flucarbazone corresponds to the compound N-(2-trifluoromethoxyphenylsulfonyl)-4,5-dihydro-3-methoxy-4-methyl-5-oxo-1H-1,2,4-triazole-1-carboxamide known under Reg. No. [145026-88-6].

MY-100 (Oxaziclomefone) corresponds to the compound 3-[1-(3,5-dichlorophenyl)-1-methylethyl]-3,4-dihydro-6-methyl-5-phenyl-2H-1,3-oxazin-4-one known under Reg. No. [153197-14-9].

NB 061 is known under the code BAY YRC 2388 (=fentrazamide).

AC014 (=cyclosulfamuron) corresponds to the compound 1-[2-(cyclopropylcarbonyl)anilinsulfonyl]-3-(4,6-dimethoxypyrimidin-2-yl)urea known under Reg. No. [136849-15-5].

All other preferred co-herbicides under b) are described, for example, in ‘Pesticide Manual’, 11th Edition, Editor C. D. S. Tomlin, British Crop Protection Council, 1997, under the entry number given in brackets, for example, atrazine (34) is described therein under the entry number 34.

Some of the herbicides mentioned can be present both in the form of esters, usually alkyl esters having 1 to 8 carbon atoms, or of salts or free acids. When such herbicides are mentioned, all customary derivatives, as cited preferably in the abovementioned ‘Pesticide Manual’ or another reference, shall count as having been disclosed as well.

It is highly surprising that the combination of the protoporphyrinogen-oxidase-inhibiting active compound under a) with at least one co-herbicide under b) exceeds the additive effect on the weeds to be controlled which was to be expected in principle, thus widening the activity limits of both active compounds in particular in two respects: on the one hand, the application rates of the individual compounds a) and b) are reduced, with the activity remaining equally high. On the other hand, the composition according to the invention also achieves a high degree of weed control where the individual substances in the range of low application rates have become economically useless. The consequence of this is a considerable widening of the weed spectrum as is necessary and desired in the case of an unintentional overdose of active compound. Furthermore, the composition according to the invention permits more flexibility with respect to successor crops while maintaining excellent weed control in useful plants resistant to protoporphyrinogen oxidase inhibitors.

The composition according to the invention can be used against a large number of economically important weeds, such as Stellaria, Nasturtium, Agrostis, Digitaria, Avena, Setaria, Sinapis, Lolium, Solanum, Phaseolus, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica. The composition according to the invention is suitable for all economically customary application methods, for example pre-emergent application, post-emergent application and seed dressing. The composition according to the invention is preferably suitable for controlling weeds in crops of useful plants resistant to protoporphyrinogen oxidase inhibitors, such as maize, sugar beet, soya beans, rape, cotton, sunflowers, cereals, rice and sugar cane. Such useful plants and their preparation are described, for example, in WO95134659 and WO98/33927.

The composition according to the invention comprises the protoporphyrinogen oxidase inhibitor a) and a co-herbicide b) in any mixing ratio, usually with an excess of one component over the other one. Preferred mixing ratios of active compound a) and co-herbicide b) are between 1:2000 and 2000:1, in particular between 1:200 and 200:1.

Preferred herbicidal compositions for controlling broad-leaved weeds and grasses in crops of maize resistant to protoporphyrinogen oxidase inhibitors comprise, as co-herbicide b), a compound selected from the group consisting of atrazine, terbuthylazine, (S)-metolachlor, metolachlor, terbutryn, simazine, dimethenamid or (S)-dimethenamid, flufenacet, acetochlor, alachlor, isoxaflutole, isoxachlortole, mesotrione, sulcotrione, metosulam, flumetsulam, pendimethalin, bromoxynil, bentazone, carfentrazone-ethyl, clomazone, nicosulfuron, rimsulfuron, halosulfuron-methyl, metribuzin, flumiclorac-pentyl, prosulfuron, primisulfuron-methyl, dicamba, fluthiacet-methyl, pyridate, 2,4-D, clopyralide, diflufenzopyr, fluroxypyr, MCPA, MCPB, MCPP, metobenzuron, thifensulfuron-methyl, aclonifen, EPTC, glyphosate, glufosinate, sulfosate and cyanazine, and also compounds of the formulae A and B.

Among these, preference is given to those compositions which comprise as co-herbicide b) a compound selected from the group consisting of (S)-metolachlor, metolachlor, dimethenamid and (S)-dimethenamid, acetochlor and alachlor.

Advantageously, these compositions may comprise as additional component c) a safener of the benzoxazine type, in particular benoxacor (61), or MON 4660, flurazole (350), dichlormid (213) or furilazole (377).

These safeners under c) are described, for example, in ‘Pesticide Manual’, 11th Edition, Editor C. D. S. Tomlin, British Crop Protection Council, 1997, under the entry number given in brackets, benoxacor (61), for example, is described therein under the entry number 61. MON 4660 is a safener from Monsanto of the following formula

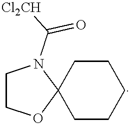

Preferred herbicidal compositions for controlling broad-leaved weeds and grasses in crops of sugar beet resistant to protoporphyrinogen oxidase inhibitors comprise as co-herbicide b) a compound selected from the group consisting of metolachlor, (S)-metolachlor, propaquizafop, metamitron, pyramin, phenmedipham, desmedipham, ethofumesate, triasulfuron, chloridazon, lenacil, triallate, fluazifop, sethoxydim, quizalofop, fenoxaprop, glyphosate, glufosinate, sulfosate and clethodim.

Preferred herbicidal compositions for controlling broad-leaved weeds and grasses in crops of soya resistant to protoporphyrinogen oxidase inhibitors comprise as co-herbicide b) a compound selected from the group consisting of (S)-metolachlor, metolachlor, oxasulfuron, fluthiacet-methyl, propaquizafop, alachlor, dimethenamid or (S)-dimethenamid, acifluorfen, benazolin-ethyl, bentazone, carfentrazone-ethyl, sulfentrazone, chlorimuron-ethyl, cloransulam-methyl, thifensulfuron-methyl, clopyralid, flumiclorac-pentyl, flumetsulam, fomesafen, imazamox, imazaquin, imazethapyr, imazapyr, lactofen, pyridate, sethoxydim, fluazifop, quizalofop, clethodim, fenoxaprop(P-ethyl), thidiazuron, tribufos, pendimethalin, glyphosate, glufosinate, sulfosate and trifluralin.

Preferred herbicidal compositions for controlling broad-leaved weeds and grasses in crops of rape resistant to protoporphyrinogen oxidase inhibitors comprise as co-herbicide b) a compound selected from the group consisting of dimethachlor, propaquizafop, clomazone, napropamide, quinmerac, metazachlor, carbetamide, dimefuron, propyzamide, clopyralid, ethametsulfuron-methyl, sethoxydim, fluazifop, quizalofop, clethodim, fenoxaprop(P-ethyl), glyphosate, glufosinate, sulfosate and tebutam.

Preferred herbicidal compositions for controlling broad-leaved weeds and grasses in crops of cotton resistant to protoporphyrinogen oxidase inhibitors comprise as co-herbicide b) a compound selected from the group consisting of fluometuron, prometryn, metolachlor, (S)-metolachlor, norflurazon, propaquizafop, pyrithiobac-sodium, trifluralin, pendimethalin, bromoxynil, clomazone, MSMA, DMSA, fluazifop, quizalofop, fenoxaprop(P-ethyl), sethoxydim, clethodim, diuron, cyanazine, alachlor, acetochlor, flurochloridone, dithiopyr, thiazopyr, lactofen, oxyfluorfen, glyphosate, glufosinate, sulfosate and ethalfluralin, and also the compound of the formula C.

Preferred herbicidal compositions for controlling broad-leaved weeds and grasses in crops of sunflowers resistant to protoporphyrinogen oxidase inhibitors comprise as co-herbicide b) a compound selected from the group consisting of metolachlor, (S)-metolachlor, pendimethalin, aclonifen, flurochloridon, prometryn, sethoxydim, fluazifop, quizalofop, clethodim, fenoxaprop(P-ethyl), terbutryn, acetochlor, glyphosate, glufosinate, sulfosate and trifluralin.

Preferred herbicide compositions for controlling broad-leaved weeds and grasses in crops of cereals resistant to protoporphyrinogen oxidase inhibitors comprise as co-herbicide b) a compound selected from the group consisting of triasulfuron, prosulfuron, clodinafop, terbutryne, amidosulfuron, bromoxynil, carfentrazone-ethyl, dicamba, diclofop-methyl, diflufenican, ethoxysulfuron, fenoxaprop(P-ethyl), fentrazamide, flazasulfuron, florasulam, fluazolate, flucarbazone, flufenacet, flupyrsulfuron-methyl sodium, flurtamone, iodosulfuron, isoproturon, chlortoluron, MCPA, MCPB, mecoprop (MCPP), chlorsulfuron, metsulfuron-methyl, sulfosulfuron, thifensulfuron-methyl, tribenuron-methyl, 2,4-D, 2,4-DB, 2,4-DP, bifenox, ethametsulfuron-methyl, flamprop-M, imazamethabenz-methyl, ioxynil, bromoxynil, metosulam, pyridate, quinmerac, tralkoxydim, fluoroglycofen-ethyl, methabenzthiazuron, ethalfluralin, pendimethalin, trifluralin, isoxaben, prosulfocarb, triallate, clopyralid, fluroxypyr, benazolin-ethyl, glyphosate, glufosinate, sulfosate and difenzoquat-metilsulfate.

Among these, preference is given to those compositions which comprise as co-herbicide b) a compound selected from the group consisting of triasulfuron, prosulfuron, clodinafop, amidosulfuron, diclofop-methyl, fenoxaprop(P-ethyl), flazasulfuron, flupyrsulfuron-methyl sodium, iodosulfuron, mecoprop (MCPP), chlorsulfuron, metsulfuron-methyl, sulfosulfuron and thifensulfuron-methyl. Advantageously, these compositions may comprise as additional component c) a safener of the quinoline type, in particular cloquintocet-mexyl (154).

Preferred herbicidal compositions for controlling broad-leaved weeds and grasses in crops of rice resistant to protoporphyrinogen oxidase inhibitors comprise as co-herbicide b) a compound selected from the group consisting of pretilachlor, cinosulfuron, triasulfuron, fenclorim, clodinafop, bensulfuron-methyl, imazosulfuron, pyrazosulfuron-ethyl, metsulfuron-methyl, azimsulfuron, halosulfuron-methyl, esprocarb, mefenacet, molinate, propanil, pyrazolate, cyhalofop-butyl, fenoxaprop(P-ethyl), bispyribac-sodium, pyriminobac-methyl, cafenstrole, oxadiargyl, oxadiazon, bromobutide, MY-100, dymron, NB 061, MK243, HW-52, glyphosate, glufosinate, sulfosate and AC 014, and also the compound of the formula D.

Preferred herbicidal compositions for controlling broad-leaved weeds and grasses in crops of sugar cane resistant to protoporphyrinogen oxidase inhibitors comprise as co-herbicide b) a compound selected from the group consisting of atrazine, ametryn, dicamba, terbutryn, prosulfuron, hexazinone, asulam, diuron, 2,4-D, halosulfuron-methyl, flazasulfuron, isoxaflutole, azafenidin, tebuthiuron, sulcotrione, pendimethalin, clomazone, metribuzin, thiazopyr, glyphosate, glufosinate, sulfosate and ethoxysulfuron, and also the compound of the formula C.

The following combinations of the compounds under a) with the co-herbicides under b) have been found to be very particularly effective synergistic compositions in crops of maize resistant to protoporphyrinogen oxidase inhibitors:

Acifluorfen+atrazine; acifluorfen+terbuthylazine; acifluorfen+(S)-metolachlor; acifluorfen +metolachlor; acifluorfen+compound of the formula A; acifluorfen+terbutryn; acifluorfen +simazine; acifluorfen+dimethenamid or (S)-dimethenamid; acifluorfen+flufenacet; acifluorfen+acetochlor; acifluorfen+alachlor; acifluorfen+isoxaflutole; acifluorfen+isoxachlortole; acifluorfen+mesotrione; acifluorfen+sulcotrione; acifluorfen+metosulam; acifluorfen+flumetsulam; acifluorfen+pendimethalin; acifluorfen+bromoxynil; acifluorfen +bentazone; acifluorfen+carfentrazone; acifluorfen+clomazone; acifluorfen+nicosulfuron; acifluorfen+rimsulfuron; acifluorfen+halosulfuron; acifluorfen+metribuzin; acifluorfen+flumiclorac; acifluorfen+prosulfuron; acifluorfen+primisulfuron; acifluorfen+dicamba; acifluorfen+fluthiacet; acifluorfen+pyridate; acifluorfen+compound of the formula B; acifluorfen+2,4-D; acifluorfen+clopyralide; acifluorfen+diflufenzopyr; acifluorfen+fluroxypyr; acifluorfen+MCPA; acifluorfen+MCPB; acifluorfen+MCPP; acifluorfen+metobenzuron; acifluorfen+thifensulfuron; acifluorfen+aclonifen; acifluorfen +EPTC; acifluorfen+cyanazine; acifluorfen+glyphosate; acifluorfen+glufosinate; acifluorfen+sulfosate; aclonifen+atrazine; aclonifen+terbuthylazine; aclonifen+(S)-metolachlor; aclonifen+metolachlor; aclonifen+compound of the formula A; aclonifen+terbutryn; aclonifen+simazine; aclonifen+dimethenamid or (S)-dimethenamid; aclonifen+flufenacet; aclonifen+acetochlor; aclonifen+alachlor; aclonifen+isoxaflutole; aclonifen+isoxachlortole; aclonifen+mesotrione; aclonifen+sulcotrione; aclonifen+metosulam; aclonifen+flumetsulam; aclonifen+pendimethalin; aclonifen+bromoxynil; aclonifen+bentazone; aclonifen+carfentrazone; aclonifen+clomazone; aclonifen+nicosulfuron; aclonifen+rimsulfuron; aclonifen+halosulfuron; aclonifen+metribuzin; aclonifen+flumiclorac; aclonifen+prosulfuron; aclonifen+primisulfuron; aclonifen+dicamba; aclonifen+fluthiacet; aclonifen+pyridate; aclonifen+compound of the formula B; aclonifen+2,4-D; aclonifen+clopyralide; aclonifen+diflufenzopyr; aclonifen+fluroxypyr; aclonifen+MCPA; aclonifen+MCPB; aclonifen+MCPP; aclonifen+metobenzuron; aclonifen+thifensulfuron; aclonifen+EPTC; aclonifen+cyanazine; aclonifen+glyphosate; aclonifen+glufosinate; aclonifen+sulfosate; bifenox+atrazine; bifenox+terbuthylazine; bifenox+(S)-metolachlor; bifenox+metolachlor, bifenox+compound of the formula A; bifenox+terbutryn; bifenox+simazine; bifenox+dimethenamid or (S)-dimethenamid; bifenox+flufenacet; bifenox+acetochlor; bifenox+alachlor; bifenox+isoxaflutole; bifenox +isoxachlortole; bifenox+mesotrione; bifenox+sulcotrione; bifenox+metosulam; bifenox +flumetsulam; bifenox+pendimethalin; bifenox+bromoxynil; bifenox+bentazone; bifenox +carfentrazone; bifenox+clomazone; bifenox+nicosulfuron; bifenox+rimsulfuron; bifenox+halosulfuron; bifenox+metribuzin; bifenox+flumiclorac; bifenox+prosulfuron; bifenox+primisulfuron; bifenox+dicamba; bifenox+fluthiacet; bifenox+pyridate; bifenox +compound of the formula B; bifenox+2,4-D; bifenox+clopyralide; bifenox+diflufenzopyr; bifenox+fluroxypyr; bifenox+MCPA; bifenox+MCPB; bifenox+MCPP; bifenox+metobenzuron; bifenox+thifensulfuron; bifenox+aclonifen; bifenox+EPTC; bifenox+cyanazine; bifenox+glyphosate; bifenox+glufosinate; bifenox+sulfosate; chlomitrofen+atrazine; chlomitrofen+terbuthylazine; chlomitrofen+(S)-metolachlor; chlomitrofen+metolachlor; chlomitrofen+compound of the formula A; chlomitrofen+terbutryn; chlomitrofen+simazine; chlomitrofen+dimethenamid or (S)-dimethenamid; chlomitrofen+flufenacet; chlomitrofen+acetochlor; chlomitrofen+alachlor; chlomitrofen+isoxaflutole; chlomitrofen+isoxachlortole; chlomitrofen+mesotrione; chlomitrofen+sulcotrione; chlomitrofen+metosulam; chlomitrofen+flumetsulam; chlomitrofen+pendimethalin; chlomitrofen+bromoxynil; chlomitrofen+bentazone; chlomitrofen+carfentrazone; chlomitrofen+clomazone; chlomitrofen+nicosulfuron; chlomitrofen+rimsulfuron; chlomitrofen+halosulfuron; chlomitrofen+metribuzin; chlomitrofen+flumiclorac; chlomitrofen+prosulfuron; chlomitrofen+primisulfuron; chlomitrofen+dicamba; chlomitrofen+fluthiacet; chlomitrofen+pyridate; chlomitrofen+compound of the formula B; chlomitrofen+2,4-D; chlomitrofen+clopyralide; chlomitrofen+diflufenzopyr; chlomitrofen+fluroxypyr; chlomitrofen+MCPA; chlomitrofen+MCPB; chlomitrofen+MCPP; chlomitrofen+metobenzuron; chlomitrofen+thifensulfuron; chlomitrofen+aclonifen; chlomitrofen+EPTC; chlomitrofen+cyanazine; chlomitrofen+glyphosate; chlomitrofen+glufosinate; chlomitrofen+sulfosate; ethoxyfen+atrazine; ethoxyfen+terbuthylazine; ethoxyfen+(S)-metolachlor; ethoxyfen+metolachlor; ethoxyfen+compound of the formula A; ethoxyfen+terbutryn; ethoxyfen+simazine; ethoxyfen+dimethenamid or (S)-dimethenamid; ethoxyfen+flufenacet; ethoxyfen+acetochlor; ethoxyfen+alachlor; ethoxyfen+isoxaflutole; ethoxyfen+isoxachlortole; ethoxyfen+mesotrione; ethoxyfen+sulcotrione; ethoxyfen+metosulam; ethoxyfen+flumetsulam; ethoxyfen+pendimethalin; ethoxyfen+bromoxynil; ethoxyfen+bentazone; ethoxyfen+carfentrazone; ethoxyfen+clomazone; ethoxyfen+nicosulfuron; ethoxyfen+rimsulfuron; ethoxyfen+halosulfuron; ethoxyfen+metribuzin; ethoxyfen+flumiclorac; ethoxyfen+prosulfuron; ethoxyfen+primisulfuron; ethoxyfen+dicamba; ethoxyfen+fluthiacet; ethoxyfen+pyridate; ethoxyfen+compound of the formula B; ethoxyfen+2,4-D; ethoxyfen +clopyralide; ethoxyfen+diflufenzopyr; ethoxyfen+fluroxypyr; ethoxyfen+MCPA; ethoxyfen+MCPB; ethoxyfen+MCPP; ethoxyfen+metobenzuron; ethoxyfen+thifensulfuron; ethoxyfen+aclonifen; ethoxyfen+EPTC; ethoxyfen+cyanazine; ethoxyfen +glyphosate; ethoxyfen+glufosinate; ethoxyfen+sulfosate; fluoroglycofen+atrazine; fluoroglycofen+terbuthylazine; fluoroglycofen+(S)-metolachlor; fluoroglycofen+metolachlor; fluoroglycofen+compound of the formula A; fluoroglycofen+terbutryn; fluoroglycofen+simazine; fluoroglycofen+dimethenamid or (S)-dimethenamid; fluoroglycofen+flufenacet; fluoroglycofen+acetochlor; fluoroglycofen+alachlor; fluoroglycofen+isoxaflutole; fluoroglycofen+isoxachlortole; fluoroglycofen+mesotrione; fluoroglycofen+sulcotrione; fluoroglycofen+metosulam; fluoroglycofen+flumetsulam; fluoroglycofen+pendimethalin; fluoroglycofen+bromoxynil; fluoroglycofen+bentazone; fluoroglycofen+carfentrazone; fluoroglycofen+clomazone; fluoroglycofen+nicosulfuron; fluoroglycofen+rimsulfuron; fluoroglycofen+halosulfuron; fluoroglycofen+metribuzin; fluoroglycofen+flumiclorac; fluoroglycofen+prosulfuron; fluoroglycofen+primisulfuron; fluoroglycofen+dicamba; fluoroglycofen+fluthiacet; fluoroglycofen+pyridate; fluoroglycofen+compound of the formula B; fluoroglycofen+2,4-D; fluoroglycofen+clopyralide; fluoroglycofen+diflufenzopyr; fluoroglycofen+fluroxypyr; fluoroglycofen+MCPA; fluoroglycofen+MCPB; fluoroglycofen+MCPP; fluoroglycofen+metobenzuron; fluoroglycofen+thifensulfuron; fluoroglycofen+aclonifen; fluoroglycofen+EPTC; fluoroglycofen+cyanazine; fluoroglycofen+glyphosate; fluoroglycofen+glufosinate; fluoroglycofen+sulfosate; fomesafen+atrazine; fomesafen+terbuthylazine; fomesafen+(S)-metolachlor; fomesafen+metolachlor; fomesafen+compound of the formula A; fomesafen+terbutryn; fomesafen+simazine; fomesafen+dimethenamid or (S)-dimethenamid; fomesafen+flufenacet; fomesafen+acetochlor; fomesafen+alachlor; fomesafen+isoxaflutole; fomesafen+isoxachlortole; fomesafen+mesotrione; fomesafen +sulcotrione; fomesafen+metosulam; fomesafen+flumetsulam; fomesafen+pendimethalin; fomesafen+bromoxynil; fomesafen+bentazone; fomesafen+carfentrazone; fomesafen+clomazone; fomesafen+nicosulfuron; fomesafen+rimsulfuron; fomesafen+halosulfuron; fomesafen+metribuzin; fomesafen+flumiclorac; fomesafen+prosulfuron; fomesafen+primisulfuron; fomesafen+dicamba; fomesafen+fluthiacet; fomesafen+pyridate; fomesafen+compound of the formula B; fomesafen+2,4-D; fomesafen+clopyralide; fomesafen+diflufenzopyr; fomesafen+fluroxypyr; fomesafen +MCPA; fomesafen+MCPB; fomesafen+MCPP; fomesafen+metobenzuron; fomesafen +thifensulfuron; fomesafen+aclonifen; fomesafen+EPTC; fomesafen+cyanazine; fomesafen+glyphosate; fomesafen+glufosinate; fomesafen+sulfosate; lactofen+atrazine; lactofen+terbuthylazine; lactofen+(S)-metolachlor; lactofen+metolachlor; lactofen+compound of the formula A; lactofen+terbutryn; lactofen+simazine; lactofen+dimethenamid or (S)-dimethenamid; lactofen+flufenacet; lactofen+acetochlor; lactofen+alachlor; lactofen+isoxaflutole; lactofen+isoxachlortole; lactofen+mesotrione; lactofen+sulcotrione; lactofen+metosulam; lactofen+flumetsulam; lactofen+pendimethalin; lactofen+bromoxynil; lactofen+bentazone; lactofen+carfentrazone; lactofen+clomazone; lactofen+nicosulfuron; lactofen+rimsulfuron; lactofen+halosulfuron; lactofen +metribuzin; lactofen+flumiclorac; lactofen+prosulfuron; lactofen+primisulfuron; lactofen+dicamba; lactofen+fluthiacet; lactofen+pyridate; lactofen+compound of the formula B; lactofen+2,4-D; lactofen+clopyralide; lactofen+diflufenzopyr; lactofen+fluroxypyr; lactofen+MCPA; lactofen+MCPB; lactofen+MCPP; lactofen+metobenzuron; lactofen+thifensulfuron; lactofen+aclonifen; lactofen+EPTC; lactofen+cyanazine; lactofen+glyphosate; lactofen+glufosinate; lactofen+sulfosate; oxyfluorfen+atrazine; oxyfluorfen+terbuthylazine; oxyfluorfen+(S)-metolachlor; oxyfluorfen+metolachlor; oxyfluorfen+compound of the formula A; oxyfluorfen+terbutryn; oxyfluorfen+simazine; oxyfluorfen+dimethenamid or (S)-dimethenamid; oxyfluorfen+flufenacet; oxyfluorfen+acetochlor; oxyfluorfen+alachlor; oxyfluorfen+isoxaflutole; oxyfluorfen+isoxachlortole; oxyfluorfen+mesotrione; oxyfluorfen+sulcotrione; oxyfluorfen+metosulam; oxyfluorfen+flumetsulam; oxyfluorfen+pendimethalin; oxyfluorfen+bromoxynil; oxyfluorfen+bentazone; oxyfluorfen+carfentrazone; oxyfluorfen+clomazone; oxyfluorfen+nicosulfuron; oxyfluorfen+rimsulfuron; oxyfluorfen+halosulfuron; oxyfluorfen+metribuzin; oxyfluorfen+flumiclorac; oxyfluorfen+prosulfuron; oxyfluorfen+primisulfuron; oxyfluorfen +dicamba; oxyfluorfen+fluthiacet; oxyfluorfen+pyridate; oxyfluorfen+compound of the formula B; oxyfluorfen+2,4-D; oxyfluorfen+clopyralide; oxyfluorfen+diflufenzopyr; oxyfluorfen+fluroxypyr; oxyfluorfen+MCPA; oxyfluorfen+MCPB; oxyfluorfen+MCPP; oxyfluorfen+metobenzuron; oxyfluorfen+thifensulfuron; oxyfluorfen+aclonifen; oxyfluorfen+EPTC; oxyfluorfen+cyanazine; oxyfluorfen+glyphosate; oxyfluorfen+glufosinate; oxyfluorfen+sulfosate; azafenidin+atrazine; azafenidin+terbuthylazine; azafenidin+(S)-metolachlor; azafenidin+metolachlor; azafenidin+compound of the formula A; azafenidin+terbutryn; azafenidin+simazine; azafenidin+dimethenamid or (S)-dimethenamid; azafenidin+flufenacet; azafenidin+acetochlor; azafenidin+alachlor; azafenidin+isoxaflutole; azafenidin+isoxachlortole; azafenidin+mesotrione; azafenidin+sulcotrione; azafenidin+metosulam; azafenidin+flumetsulam; azafenidin+pendimethalin; azafenidin+bromoxynil; azafenidin+bentazone; azafenidin+carfentrazone; azafenidin+clomazone; azafenidin+nicosulfuron; azafenidin+rimsulfuron; azafenidin+halosulfuron; azafenidin+metribuzin; azafenidin+flumiclorac; azafenidin+prosulfuron; azafenidin+primisulfuron; azafenidin+dicamba; azafenidin+fluthiacet; azafenidin+pyridate; azafenidin+compound of the formula B; azafenidin+2,4-D; azafenidin+clopyralide; azafenidin+diflufenzopyr; azafenidin+fluroxypyr; azafenidin+MCPA; azafenidin+MCPB; azafenidin+MCPP; azafenidin+metobenzuron; azafenidin+thifensulfuron; azafenidin+aclonifen; azafenidin+EPTC; azafenidin+cyanazine; azafenidin+glyphosate; azafenidin +glufosinate; azafenidin+sulfosate; carfentrazone-ethyl+atrazine; carfentrazone-ethyl+terbuthylazine; carfentrazone-ethyl+(S)-metolachlor; carfentrazone-ethyl+metolachlor; carfentrazone-ethyl+compound of the formula A; carfentrazone-ethyl+terbutryn; carfentrazone-ethyl+simazine; carfentrazone-ethyl+dimethenamid or (S)-dimethenamid; carfentrazone-ethyl+flufenacet; carfentrazone-ethyl+acetochlor; carfentrazone-ethyl+alachlor; carfentrazone-ethyl+isoxaflutole; carfentrazone-ethyl+isoxachlortole; carfentrazone-ethyl+mesotrione; carfentrazone-ethyl+sulcotrione; carfentrazone-ethyl+metosulam; carfentrazone-ethyl+flumetsulam; carfentrazone-ethyl+pendimethalin; carfentrazone-ethyl+bromoxynil; carfentrazone-ethyl+bentazone; carfentrazone-ethyl+clomazone; carfentrazone-ethyl+nicosulfuron; carfentrazone-ethyl+rimsulfuron; carfentrazone-ethyl+halosulfuron; carfentrazone-ethyl+metribuzin; carfentrazone-ethyl+flumiclorac; carfentrazone-ethyl+prosulfuron; carfentrazone-ethyl+primisulfuron; carfentrazone-ethyl+dicamba; carfentrazone-ethyl+fluthiacet; carfentrazone-ethyl+pyridate; carfentrazone-ethyl+compound of the formula B; carfentrazone-ethyl+2,4-D; carfentrazone-ethyl+clopyralide; carfentrazone-ethyl+diflufenzopyr; carfentrazone-ethyl+fluroxypyr; carfentrazone-ethyl+MCPA; carfentrazone-ethyl+MCPB; carfentrazone-ethyl+MCPP; carfentrazone-ethyl+metobenzuron; carfentrazone-ethyl+thifensulfuron; carfentrazone-ethyl+aclonifen; carfentrazone-ethyl+EPTC; carfentrazone-ethyl+cyanazine; carfentrazone-ethyl+glyphosate; carfentrazone-ethyl+glufosinate; carfentrazone-ethyl+sulfosate; compound of the formula A+atrazine; compound of the formula A+terbuthylazine; compound of the formula A+(S)-metolachlor; compound of the formula A+metolachlor; compound of the formula A+terbutryn; compound of the formula A+simazine; compound of the formula A+dimethenamid or (S)-dimethenamid; compound of the formula A+flufenacet; compound of the formula A+acetochlor; compound of the formula A+alachlor; compound of the formula A+isoxaflutole; compound of the formula A+isoxachlortole; compound of the formula A+mesotrione; compound of the formula A+sulcotrione; compound of the formula A+metosulam; compound of the formula A+flumetsulam; compound of the formula A+pendimethalin; compound of the formula A+bromoxynil; compound of the formula A+bentazone; compound of the formula A+carfentrazone; compound of the formula A+clomazone; compound of the formula A+nicosulfuron; compound of the formula A+rimsulfuron; compound of the formula A+halosulfuron; compound of the formula A+metribuzin; compound of the formula A+flumiclorac; compound of the formula A+prosulfuron; compound of the formula A+primisulfuron; compound of the formula A+dicamba; compound of the formula A+fluthiacet; compound of the formula A+pyridate; compound of the formula A+compound of the formula B; compound of the formula A+2,4-D; compound of the formula A+clopyralide; compound of the formula A+diflufenzopyr; compound of the formula A+fluroxypyr; compound of the formula A+MCPA; compound of the formula A+MCPB; compound of the formula A+MCPP; compound of the formula A+metobenzuron; compound of the formula A+thifensulfuron; compound of the formula A+aclonifen; compound of the formula A+EPTC; compound of the formula A+cyanazine; compound of the formula A+glyphosate; compound of the formula A+glufosinate; compound of the formula A+sulfosate; cinidon-ethyl+atrazine; cinidon-ethyl+terbuthylazine; cinidon-ethyl +(S)-metolachlor; cinidon-ethyl+metolachlor; cinidon-ethyl+compound of the formula A; cinidon-ethyl+terbutryn; cinidon-ethyl+simazine; cinidon-ethyl+dimethenamid or (S)-dimethenamid; cinidon-ethyl+flufenacet; cinidon-ethyl+acetochlor; cinidon-ethyl+alachlor; cinidon-ethyl+isoxaflutole; cinidon-ethyl+isoxachlortole; cinidon-ethyl+mesotrione; cinidon-ethyl+sulcotrione; cinidon-ethyl+metosulam; cinidon-ethyl+flumetsulam; cinidon-ethyl+pendimethalin; cinidon-ethyl+bromoxynil; cinidon-ethyl+bentazone; cinidon-ethyl+carfentrazone; cinidon-ethyl+clomazone; cinidon-ethyl+nicosulfuron; cinidon-ethyl+rimsulfuron; cinidon-ethyl+halosulfuron; cinidon-ethyl+metribuzin; cinidon-ethyl+flumiclorac; cinidon-ethyl+prosulfuron; cinidon-ethyl+primisulfuron; cinidon-ethyl+dicamba; cinidon-ethyl+fluthiacet; cinidon-ethyl+pyridate; cinidon-ethyl+compound of the formula B; cinidon-ethyl+2,4-D; cinidon-ethyl+clopyralide; cinidon-ethyl+diflufenzopyr; cinidon-ethyl+fluroxypyr; cinidon-ethyl+MCPA; cinidon-ethyl+MCPB; cinidon-ethyl+MCPP; cinidon-ethyl+metobenzuron; cinidon-ethyl+thifensulfuron; cinidon-ethyl+aclonifen; cinidon-ethyl+EPTC; cinidon-ethyl+cyanazine; cinidon-ethyl+glyphosate; cinidon-ethyl+glufosinate; cinidon-ethyl+sulfosate; flumiclorac-pentyl+atrazine; flumiclorac-pentyl+terbuthylazine; flumiclorac-pentyl+(S)-metolachlor; flumiclorac-pentyl+metolachlor; flumiclorac-pentyl+compound of the formula A; flumiclorac-pentyl+terbutryn; flumiclorac-pentyl+simazine; flumiclorac-pentyl+dimethenamid or (S)-dimethenamid; flumiclorac-pentyl+flufenacet; flumiclorac-pentyl+acetochlor; flumiclorac-pentyl+alachlor; flumiclorac-pentyl+isoxaflutole; flumiclorac-pentyl +isoxachlortole; flumiclorac-pentyl+mesotrione; flumiclorac-pentyl+sulcotrione; flumiclorac-pentyl+metosulam; flumiclorac-pentyl+flumetsulam; flumiclorac-pentyl+pendimethalin; flumiclorac-pentyl+bromoxynil; flumiclorac-pentyl+bentazone; flumiclorac-pentyl+carfentrazone; flumiclorac-pentyl+clomazone; flumiclorac-pentyl+nicosulfuron; flumiclorac-pentyl+rimsulfuron; flumiclorac-pentyl+halosulfuron; flumiclorac-pentyl+metribuzin; flumiclorac-pentyl+prosulfuron; flumiclorac-pentyl+primisulfuron; flumiclorac-pentyl+dicamba; flumiclorac-pentyl+fluthiacet; flumiclorac-pentyl+pyridate; flumiclorac-pentyl+compound of the formula B; flumiclorac-pentyl+2,4-D; flumiclorac-pentyl+clopyralide; flumiclorac-pentyl+diflufenzopyr; flumiclorac-pentyl+fluroxypyr; flumiclorac-pentyl+MCPA; flumiclorac-pentyl+MCPB; flumiclorac-pentyl+MCPP; flumiclorac-pentyl+metobenzuron; flumiclorac-pentyl+thifensulfuron; flumiclorac-pentyl+aclonifen; flumiclorac-pentyl+EPTC; flumiclorac-pentyl+cyanazine; flumiclorac-pentyl+glyphosate; flumiclorac-pentyl+glufosinate; flumiclorac-pentyl+sulfosate; flumioxazin+atrazine; flumioxazin+terbuthylazine; flumioxazin+(S)-metolachlor; flumioxazin+metolachlor; flumioxazin+compound of the formula A; flumioxazin+terbutryn; flumioxazin+simazine; flumioxazin+dimethenamid or (S)-dimethenamid; flumioxazin+flufenacet; flumioxazin+acetochlor; flumioxazin+alachlor; flumioxazin+isoxaflutole; flumioxazin+isoxachlortole; flumioxazin+mesotrione; flumioxazin+sulcotrione; flumioxazin+metosulam; flumioxazin+flumetsulam; flumioxazin+pendimethalin; flumioxazin+bromoxynil; flumioxazin+bentazone; flumioxazin+carfentrazone; flumioxazin+clomazone; flumioxazin+nicosulfuron; flumioxazin+rimsulfuron; flumioxazin+halosulfuron; flumioxazin+metribuzin; flumioxazin+flumiclorac; flumioxazin+prosulfuron; flumioxazin+primisulfuron; flumioxazin+dicamba; flumioxazin+fluthiacet; flumioxazin+pyridate; flumioxazin+compound of the formula B; flumioxazin+2,4-D; flumioxazin+clopyralide; flumioxazin+diflufenzopyr; flumioxazin+fluroxypyr; flumioxazin+MCPA; flumioxazin+MCPB; flumioxazin+MCPP; flumioxazin+metobenzuron; flumioxazin+thifensulfuron; flumioxazin +aclonifen; flumioxazin+EPTC; flumioxazin+cyanazine; flumioxazin+glyphosate; flumioxazin+glufosinate; flumioxazin+sulfosate; fluthiacet-methyl+atrazine; fluthiacet-methyl+terbuthylazine; fluthiacet-methyl+(S)-metolachlor; fluthiacet-methyl+metolachlor; fluthiacet-methyl+compound of the formula A; fluthiacet-methyl+terbutryn; fluthiacet-methyl+simazine; fluthiacet-methyl+dimethenamid or (S)-dimethenamid; fluthiacet-methyl +flufenacet; fluthiacet-methyl+acetochlor; fluthiacet-methyl+alachlor; fluthiacet-methyl+isoxaflutole; fluthiacet-methyl+isoxachlortole; fluthiacet-methyl+mesotrione; fluthiacet-methyl+sulcotrione; fluthiacet-methyl+metosulam; fluthiacet-methyl+flumetsulam; fluthiacet-methyl+pendimethalin; fluthiacet-methyl+bromoxynil; fluthiacet-methyl+bentazone; fluthiacet-methyl+carfentrazone; fluthiacet-methyl+clomazone; fluthiacet-methyl+nicosulfuron; fluthiacet-methyl+rimsulfuron; fluthiacet-methyl+halosulfuron; fluthiacet-methyl+metribuzin; fluthiacet-methyl+flumiclorac; fluthiacet-methyl+prosulfuron; fluthiacet-methyl+primisulfuron; fluthiacet-methyl+dicamba; fluthiacet-methyl +pyridate; fluthiacet-methyl+compound of the formula B; fluthiacet-methyl+2,4-D; fluthiacet-methyl+clopyralide; fluthiacet-methyl+diflufenzopyr; fluthiacet-methyl+fluroxypyr; fluthiacet-methyl+MCPA; fluthiacet-methyl+MCPB; fluthiacet-methyl+MCPP; fluthiacet-methyl+metobenzuron; fluthiacet-methyl+thifensulfuron; fluthiacet-methyl+aclonifen; fluthiacet-methyl+EPTC; fluthiacet-methyl+cyanazine; fluthiacet-methyl+glyphosate; fluthiacet-methyl+glufosinate; fluthiacet-methyl+sulfosate; oxadiargyl+atrazine; oxadiargyl+terbuthylazine; oxadiargyl+(S)-metolachlor; oxadiargyl+metolachlor; oxadiargyl+compound of the formula A; oxadiargyl+terbutryn; oxadiargyl+simazine; oxadiargyl+dimethenamid or (S)-dimethenamid; oxadiargyl+flufenacet; oxadiargyl+acetochlor; oxadiargyl+alachlor; oxadiargyl+isoxaflutole; oxadiargyl+ioxachlortole; oxadiargyl+mesotrione; oxadiargyl+sulcotrione; oxadiargyl+metosulam; oxadiargyl+flumetsulam; oxadiargyl+pendimethalin; oxadiargyl+bromoxynil; oxadiargyl+bentazone; oxadiargyl+carfentrazone; oxadiargyl+clomazone; oxadiargyl+nicosulfuron; oxadiargyl+rimsulfuron; oxadiargyl+halosulfuron; oxadiargyl+metribuzin; oxadiargyl+flumiclorac; oxadiargyl+prosulfuron; oxadiargyl+primisulfuron; oxadiargyl+dicamba; oxadiargyl+fluthiacet; oxadiargyl+pyridate; oxadiargyl+compound of the formula B; oxadiargyl+2,4-D; oxadiargyl+clopyralide; oxadiargyl+diflufenzopyr; oxadiargyl+fluroxypyr; oxadiargyl+MCPA; oxadiargyl+MCPB; oxadiargyl+MCPP; oxadiargyl+metobenzuron; oxadiargyl+thifensulfuron; oxadiargyl+aclonifen; oxadiargyl+EPTC; oxadiargyl+cyanazine; oxadiargyl+glyphosate; oxadiargyl+glufosinate; oxadiargyl+sulfosate; oxadiazon+atrazine; oxadiazon+terbuthylazine; oxadiazon+(S)-metolachlor; oxadiazon+metolachlor; oxadiazon+compound of the formula A; oxadiazon+terbutryn; oxadiazon+simazine; oxadiazon+dimethenamid or (S)-dimethenamid; oxadiazon+flufenacet; oxadiazon+acetochlor; oxadiazon+alachlor; oxadiazon+isoxaflutole; oxadiazon+isoxachlortole; oxadiazon+mesotrione; oxadiazon+sulcotrione; oxadiazon+metosulam; oxadiazon+flumetsulam; oxadiazon+pendimethalin; oxadiazon+bromoxynil; oxadiazon+bentazone; oxadiazon+carfentrazone; oxadiazon+clomazone; oxadiazon+nicosulfuron; oxadiazon+rimsulfuron; oxadiazon+halosulfuron; oxadiazon+metribuzin; oxadiazon+flumiclorac; oxadiazon+prosulfuron; oxadiazon+primisulfuron; oxadiazon+dicamba; oxadiazon+fluthiacet; oxadiazon+pyridate; oxadiazon+compound of the formula B; oxadiazon+2,4-D; oxadiazon+clopyralide; oxadiazon+diflufenzopyr; oxadiazon+fluroxypyr; oxadiazon+MCPA; oxadiazon+MCPB; oxadiazon+MCPP; oxadiazon+metobenzuron; oxadiazon+thifensulfuron; oxadiazon+aclonifen; oxadiazon+EPTC; oxadiazon+cyanazine; oxadiazon+glyphosate; oxadiazon+glufosinate; oxadiazon+sulfosate; pentoxazone+atrazine; pentoxazone+terbuthylazine; pentoxazone+(S)-metolachlor; pentoxazone+metolachlor; pentoxazone+compound of the formula A; pentoxazone+terbutryn; pentoxazone+simazine; pentoxazone+dimethenamid or (S)-dimethenamid; pentoxazone+flufenacet; pentoxazone+acetochlor; pentoxazone+alachlor; pentoxazone+isoxaflutole; pentoxazone+isoxachlortole; pentoxazone+mesotrione; pentoxazone+sulcotrione; pentoxazone+metosulam; pentoxazone+flumetsulam; pentoxazone+pendimethalin; pentoxazone+bromoxynil; pentoxazone+bentazone; pentoxazone+carfentrazone; pentoxazone+clomazone; pentoxazone+nicosulfuron; pentoxazone+rimsulfuron; pentoxazone+halosulfuron; pentoxazone+metribuzin; pentoxazone+flumiclorac; pentoxazone+prosulfuron; pentoxazone+primisulfuron; pentoxazone+dicamba; pentoxazone+fluthiacet; pentoxazone+pyridate; pentoxazone+compound of the formula B; pentoxazone+2,4-D; pentoxazone+clopyralide; pentoxazone+diflufenzopyr; pentoxazone+fluroxypyr; pentoxazone+MCPA; pentoxazone+MCPB; pentoxazone+MCPP; pentoxazone+metobenzuron; pentoxazone+thifensulfuron; pentoxazone+aclonifen; pentoxazone+EPTC; pentoxazone+cyanazine; pentoxazone+glyphosate; pentoxazone+glufosinate; pentoxazone+sulfosate; sulfentrazone+atrazine; sulfentrazone+terbuthylazine; sulfentrazone+(S)-metolachlor; sulfentrazone+metolachlor; sulfentrazone+compound of the formula A; sulfentrazone+terbutryn; sulfentrazone+simazine; sulfentrazone+dimethenamid or (S)-dimethenamid; sulfentrazone+flufenacet; sulfentrazone+acetochlor; sulfentrazone+alachlor; sulfentrazone+isoxaflutole; sulfentrazone+isoxachlortole; sulfentrazone+mesotrione; sulfentrazone+sulcotrione; sulfentrazone+metosulam; sulfentrazone+flumetsulam; sulfentrazone+pendimethalin; sulfentrazone+bromoxynil; sulfentrazone+bentazone; sulfentrazone+carfentrazone; sulfentrazone+clomazone; sulfentrazone+nicosulfuron; sulfentrazone+rimsulfuron; sulfentrazone+halosulfuron; sulfentrazone+metribuzin; sulfentrazone+flumiclorac; sulfentrazone+prosulfuron; sulfentrazone+primisulfuron; sulfentrazone+dicamba; sulfentrazone+fluthiacet; sulfentrazone+pyridate; sulfentrazone+compound of the formula B; sulfentrazone+2,4-D; sulfentrazone+clopyralide; sulfentrazone+diflufenzopyr; sulfentrazone+fluroxypyr; sulfentrazone+MCPA; sulfentrazone+MCPB; sulfentrazone+MCPP; sulfentrazone+metobenzuron; sulfentrazone+thifensulfuron; sulfentrazone+aclonifen; sulfentrazone+EPTC; sulfentrazone+cyanazine; sulfentrazone+glyphosate; sulfentrazone+glufosinate; sulfentrazone+sulfosate; fluazolate+atrazine; fluazolate+terbuthylazine; fluazolate+(S)-metolachlor; fluazolate+metolachlor; fluazolate+compound of the formula A; fluazolate+terbutryn; fluazolate+simazine; fluazolate+dimethenamid or (S)-dimethenamid; fluazolate+flufenacet; fluazolate+acetochlor; fluazolate+alachlor; fluazolate+isoxaflutole; fluazolate+isoxachlortole; fluazolate+mesotrione; fluazolate+sulcotrione; fluazolate+metosulam; fluazolate+flumetsulam; fluazolate+pendimethalin; fluazolate+bromoxynil; fluazolate+bentazone; fluazolate+carfentrazone; fluazolate+clomazone; fluazolate+nicosulfuron; fluazolate+rimsulfuron; fluazolate+halosulfuron; fluazolate+metribuzin; fluazolate+flumiclorac; fluazolate+prosulfuron; fluazolate+primisulfuron; fluazolate+dicamba; fluazolate+fluthiacet; fluazolate+pyridate; fluazolate +compound of the formula B; fluazolate+2,4-D; fluazolate+clopyralide; fluazolate+diflufenzopyr; fluazolate+fluroxypyr; fluazolate+MCPA; fluazolate+MCPB; fluazolate+MCPP; fluazolate+metobenzuron; fluazolate+thifensulfuron; fluazolate+aclonifen; fluazolate+EPTC; fluazolate+cyanazine; fluazolate+glyphosate; fluazolate+glufosinate; fluazolate+sulfosate; pyraflufen-ethyl+atrazine; pyraflufen-ethyl+terbuthylazine; pyraflufen-ethyl+(S)-metolachlor; pyraflufen-ethyl+metolachlor; pyraflufen-ethyl+compound of the formula A; pyraflufen-ethyl+terbutryn; pyraflufen-ethyl+simazine; pyraflufen-ethyl+dimethenamid or (S)-dimethenamid; pyraflufen-ethyl+flufenacet; pyraflufen-ethyl+acetochlor; pyraflufen-ethyl+alachlor; pyraflufen-ethyl+isoxaflutole; pyraflufen-ethyl+isoxachlortole; pyraflufen-ethyl+mesotrione; pyraflufen-ethyl+sulcotrione; pyraflufen-ethyl+metosulam; pyraflufen-ethyl+flumetsulam; pyraflufen-ethyl+pendimethalin; pyraflufen-ethyl+bromoxynil; pyraflufen-ethyl+bentazone; pyraflufen-ethyl +carfentrazone; pyraflufen-ethyl+clomazone; pyraflufen-ethyl+nicosulfuron; pyraflufen-ethyl+rimsulfuron; pyraflufen-ethyl+halosulfuron; pyraflufen-ethyl+metribuzin; pyraflufen-ethyl+flumiclorac; pyraflufen-ethyl+prosulfuron; pyraflufen-ethyl+primisulfuron; pyraflufen-ethyl+dicamba; pyraflufen-ethyl+fluthiacet; pyraflufen-ethyl+pyridate; pyraflufen-ethyl+compound of the formula B; pyraflufen-ethyl+2,4-D; pyraflufen-ethyl+clopyralide; pyraflufen-ethyl+diflufenzopyr; pyraflufen-ethyl+fluroxypyr; pyraflufen-ethyl+MCPA; pyraflufen-ethyl+MCPB; pyraflufen-ethyl+MCPP; pyraflufen-ethyl+metobenzuron; pyraflufen-ethyl+thifensulfuron; pyraflufen-ethyl+aclonifen; pyraflufen-ethyl+EPTC; pyraflufen-ethyl+cyanazine; pyraflufen-ethyl+glyphosate; pyraflufen-ethyl+glufosinate; pyraflufen-ethyl+sulfosate; flumipropyn+atrazine; flumipropyn+terbuthylazine; flumipropyn+(S)-metolachlor; flumipropyn+metolachlor; flumipropyn+compound of the formula A; flumipropyn+terbutryn; flumipropyn+simazine; flumipropyn+dimethenamid or (S)-dimethenamid; flumipropyn+flufenacet; flumipropyn+acetochlor; flumipropyn+alachlor; flumipropyn+isoxaflutole; flumipropyn+isoxachlortole; flumipropyn +mesotrione; flumipropyn+sulcotrione; flumipropyn+metosulam; flumipropyn+flumetsulam; flumipropyn+pendimethalin; flumipropyn+bromoxynil; flumipropyn+bentazone; flumipropyn+carfentrazone; flumipropyn+clomazone; flumipropyn+nicosulfuron; flumipropyn+rimsulfuron; flumipropyn+halosulfuron; flumipropyn+metribuzin; flumipropyn+flumiclorac; flumipropyn+prosulfuron; flumipropyn+primisulfuron; flumipropyn+dicamba; flumipropyn+fluthiacet; flumipropyn+pyridate; flumipropyn+compound of the formula B; flumipropyn+2,4-D; flumipropyn+clopyralide; flumipropyn+diflufenzopyr; flumipropyn+fluroxypyr; flumipropyn+-MCPA; flumipropyn+MCPB; flumipropyn+MCPP; flumipropyn+metobenzuron; flumipropyn+thifensulfuron; flumipropyn+aclonifen; flumipropyn+EPTC; flumipropyn+cyanazine; flumipropyn+glyphosate; flumipropyn+glufosinate; flumipropyn+sulfosate; flupropacil+atrazine; flupropacil+terbuthylazine; flupropacil+(S)-metolachlor; flupropacil+metolachlor; flupropacil+compound of the formula A; flupropacil+terbutryn; flupropacil+simazine; flupropacil+dimethenamid or (S)-dimethenamid; flupropacil+flufenacet; flupropacil+acetochlor; flupropacil+alachlor; flupropacil+isoxaflutole; flupropacil+isoxachlortole; flupropacil+mesotrione; flupropacil+sulcotrione; flupropacil+metosulam; flupropacil+flumetsulam; flupropacil+pendimethalin; flupropacil+bromoxynil; flupropacil+bentazone; flupropacil+carfentrazone; flupropacil+clomazone; flupropacil+nicosulfuron; flupropacil+rimsulfuron; flupropacil+halosulfuron; flupropacil+metribuzin; flupropacil+flumiclorac; flupropacil+prosulfuron; flupropacil+primisulfuron; flupropacil+dicamba; flupropacil+fluthiacet; flupropacil+pyridate; flupropacil+compound of the formula B; flupropacil+2,4-D; flupropacil+clopyralide; flupropacil+diflufenzopyr; flupropacil+fluroxypyr; flupropacil+MCPA; flupropacil+MCPB; flupropacil+MCPP; flupropacil+metobenzuron; flupropacil+thifensulfuron; flupropacil+aclonifen; flupropacil+EPTC; flupropacil+cyanazine; flupropacil+glyphosate; flupropacil+glufosinate; flupropacil+sulfosate; nipyraclofen+atrazine; nipyraclofen+terbuthylazine; nipyraclofen+(S)-metolachlor; nipyraclofen+metolachlor; nipyraclofen+compound of the formula A; nipyraclofen+terbutryn; nipyraclofen+simazine; nipyraclofen+dimethenamid or (S)-dimethenamid; nipyraclofen+flufenacet; nipyraclofen+acetochlor; nipyraclofen+alachlor; nipyraclofen+isoxaflutole; nipyraclofen+isoxachlortole; nipyraclofen+mesotrione; nipyraclofen+sulcotrione; nipyraclofen+metosulam; nipyraclofen+flumetsulam; nipyraclofen+pendimethalin; nipyraclofen+bromoxynil; nipyraclofen+bentazone; nipyraclofen+carfentrazone; nipyraclofen+clomazone; nipyraclofen+nicosulfuron; nipyraclofen+rimsulfuron; nipyraclofen+halosulfuron; nipyraclofen+metribuzin; nipyraclofen+flumiclorac; nipyraclofen+prosulfuron; nipyraclofen+primisulfuron; nipyraclofen+dicamba; nipyraclofen+fluthiacet; nipyraclofen+pyridate; nipyraclofen+compound of the formula B; nipyraclofen+2,4-D; nipyraclofen+clopyralide; nipyraclofen+diflufenzopyr; nipyraclofen+fluroxypyr; nipyraclofen+MCPA; nipyraclofen+MCPB; nipyraclofen+MCPP; nipyraclofen+metobenzuron; nipyraclofen+thifensulfuron; nipyraclofen+aclonifen; nipyraclofen+EPTC; nipyraclofen+cyanazine; nipyraclofen+glyphosate; nipyraclofen+glufosinate; nipyraclofen+sulfosate; benzfendizone+atrazine; benzfendizone+terbuthylazine; benzfendizone+(S)-metolachlor; benzfendizone+metolachlor; benzfendizone+compound of the formula A; benzfendizone+terbutryn; benzfendizone+simazine; benzfendizone+dimethenamid or (S)-dimethenamid; benzfendizone+flufenacet; benzfendizone+acetochlor; benzfendizone+alachlor; benzfendizone+isoxaflutole; benzfendizone+isoxachlortole; benzfendizone+mesotrione; benzfendizone+sulcotrione; benzfendizone+metosulam; benzfendizone+flumetsulam; benzfendizone+pendimethalin; benzfendizone+bromoxynil; benzfendizone+bentazone; benzfendizone+carfentrazone; benzfendizone+clomazone; benzfendizone+nicosulfuron; benzfendizone+rimsulfuron; benzfendizone+halosulfuron; benzfendizone+metribuzin; benzfendizone+flumiclorac; benzfendizone+prosulfuron; benzfendizone+primisulfuron; benzfendizone+dicamba; benzfendizone+fluthiacet; benzfendizone+pyridate; benzfendizone+compound of the formula B; benzfendizone+2,4-D; benzfendizone+clopyralide; benzfendizone+diflufenzopyr; benzfendizone+fluroxypyr; benzfendizone+MCPA; benzfendizone+MCPB; benzfendizone+MCPP; benzfendizone+metobenzuron; benzfendizone+thifensulfuron; benzfendizone+aclonifen; benzfendizone +EPTC; benzfendizone+cyanazine; benzfendizone+glyphosate; benzfendizone+glufosinate; benzfendizone+sulfosate; thidiazimin+atrazine; thidiazimin+terbuthylazine; thidiazimin+(S)-metolachlor; thidiazimin+metolachlor; thidiazimin+compound of the formula A; thidiazimin+terbutryn; thidiazimin+simazine; thidiazimin+dimethenamid or (S)-dimethenamid; thidiazimin+flufenacet; thidiazimin+acetochlor; thidiazimin+alachlor; thidiazimin+isoxaflutole; thidiazimin+isoxachlortole; thidiazimin+mesotrione; thidiazimin +sulcotrione; thidiazimin+metosulam; thidiazimin+flumetsulam; thidiazimin+pendimethalin; thidiazimin+bromoxynil; thidiazimin+bentazone; thidiazimin+carfentrazone; thidiazimin+clomazone; thidiazimin+nicosulfuron; thidiazimin+rimsulfuron; thidiazimin+halosulfuron; thidiazimin+metribuzin; thidiazimin+flumiclorac; thidiazimin+prosulfuron; thidiazimin+primisulfuron; thidiazimin+dicamba; thidiazimin+fluthiacet; thidiazimin+pyridate; thidiazimin+compound of the formula B; thidiazimin+2,4-D; thidiazimin+clopyralide; thidiazimin+diflufenzopyr; thidiazimin+fluroxypyr; thidiazimin +MCPA; thidiazimin+MCPB; thidiazimin+MCPP; thidiazimin+metobenzuron; thidiazimin +thifensulfuron; thidiazimin+aclonifen; thidiazimin+EPTC; thidiazimin+cyanazine; thidiazimin+glyphosate; thidiazimin+glufosinate; and thidiazimin+sulfosate.

The following combinations of the compounds under a) with the co-herbicides under b) have been found to be very particularly effective synergistic compositions in crops of sugar beet resistant to protoporphyrinogen oxidase inhibitors:

acifluorfen+metolachlor; acifluorfen+(S)-metolachlor; acifluorfen+propaquizafop; acifluorfen+metamitron; acifluorfen+pyramin; acifluorfen+phenmedipham; acifluorfen+desmedipham; acifluorfen+ethofumesate; acifluorfen+triasulfuron; acifluorfen+chloridazon; acifluorfen+lenacil; acifluorfen+triallate; acifluorfen+fluazifop; acifluorfen+sethoxydim; acifluorfen+quizalofop; acifluorfen+fenoxaprop; acifluorfen+clethodim; acifluorfen+glyphosate; acifluorfen+glufosinate; acifluorfen+sulfosate; aclonifen+metolachlor; aclonifen+(S)-metolachlor; aclonifen+propaquizafop; aclonifen+metamitron; aclonifen+pyramin; aclonifen+phenmedipham; aclonifen+desmedipham; aclonifen+ethofumesate; aclonifen+triasulfuron; aclonifen+chloridazon; aclonifen+lenacil; aclonifen+triallate; aclonifen+fluazifop; aclonifen+sethoxydim; aclonifen+quizalofop; aclonifen+fenoxaprop; aclonifen+clethodim; aclonifen+glyphosate; aclonifen +glufosinate; aclonifen+sulfosate; bifenox+metolachlor; bifenox+(S)-metolachlor; bifenox+propaquizafop; bifenox+metamitron; bifenox+pyramin; bifenox+phenmedipham; bifenox+desmedipham; bifenox+ethofumesate; bifenox+triasulfuron; bifenox+chloridazon; bifenox+lenacil; bifenox+triallate; bifenox+fluazifop; bifenox+sethoxydim; bifenox+quizalofop; bifenox+fenoxaprop; bifenox+clethodim; bifenox+glyphosate; bifenox+glufosinate; bifenox+sulfosate; chlomitrofen+metolachlor; chlomitrofen+(S)-metolachlor; chlomitrofen+propaquizafop; chlomitrofen+metamitron; chlomitrofen+pyramin; chlomitrofen+phenmedipham; chlomitrofen+desmedipham; chlomitrofen+ethofumesate; chlomitrofen+triasulfuron; chlomitrofen+chloridazon; chlomitrofen+lenacil; chlomitrofen+triallate; chlomitrofen+fluazifop; chlomitrofen+sethoxydim; chlomitrofen+quizalofop; chlomitrofen+fenoxaprop; chlomitrofen+clethodim; chlomitrofen+glyphosate; chlomitrofen+glufosinate; chlomitrofen+sulfosate; ethoxyfen+metolachlor; ethoxyfen+(S)-metolachlor; ethoxyfen+propaquizafop; ethoxyfen+metamitron; ethoxyfen+pyramin; ethoxyfen+phenmedipham; ethoxyfen+desmedipham; ethoxyfen+ethofumesate; ethoxyfen+triasulfuron; ethoxyfen+chloridazon; ethoxyfen+lenacil; ethoxyfen+triallate; ethoxyfen+fluazifop; ethoxyfen+sethoxydim; ehoxyfen+quizalofop; ethoxyfen+fenoxaprop; ethoxyfen+clethodim; ethoxyfen+glyphosate; ethoxyfen+glufosinate; ethoxyfen+sulfosate; fluoroglycofen+metolachlor; fluoroglycofen+(S)-metolachlor; fluoroglycofen+propaquizafop; fluoroglycofen+metamitron; fluoroglycofen+pyramin; fluoroglycofen+phenmedipham; fluoroglycofen+desmedipham; fluoroglycofen+ethofumesate; fluoroglycofen+triasulfuron; fluoroglycofen+chloridazon; fluoroglycofen+lenacil; fluoroglycofen+triallate; fluoroglycofen+fluazifop; fluoroglycofen+sethoxydim; fluoroglycofen+quizalofop; fluoroglycofen+fenoxaprop; fluoroglycofen+clethodim; fluoroglycofen+glyphosate; fluoroglycofen+glufosinate; fluoroglycofen+sulfosate; fomesafen+metolachlor; fomesafen+(S)-metolachlor; fomesafen+propaquizafop; fomesafen+metamitron; fomesafen+pyramin; fomesafen+phenmedipham; fomesafen+desmedipham; fomesafen +ethofumesate; fomesafen+triasulfuron; fomesafen+chloridazon; fomesafen+lenacil; fomesafen+triallate; fomesafen+fluazifop; fomesafen+sethoxydim; fomesafen+quizalofop; fomesafen+fenoxaprop; fomesafen+clethodim; fomesafen+glyphosate; fomesafen+glufosinate; fomesafen+sulfosate; lactofen+metolachlor; lactofen+(S)-metolachlor; lactofen+propaquizafop; lactofen+metamitron; lactofen+pyramin; lactofen+phenmedipham; lactofen+desmedipham; lactofen+ethofumesate; lactofen+triasulfuron; lactofen+chloridazon; lactofen+lenacil; lactofen+triallate; lactofen+fluazifop; lactofen+sethoxydim; lactofen+quizalofop; lactofen+fenoxaprop; lactofen+clethodim; lactofen+glyphosate; lactofen+glufosinate; lactofen+sulfosate; oxyfluorfen+metolachlor; oxyfluorfen+(S)-metolachlor; oxyfluorfen+propaquizafop; oxyfluorfen+metamitron; oxyfluorfen+pyramin; oxyfluorfen+phenmedipham; oxyfluorfen+desmedipham; oxyfluorfen+ethofumesate; oxyfluorfen+triasulfuron; oxyfluorfen+chloridazon; oxyfluorfen+lenacil; oxyfluorfen+triallate; oxyfluorfen+fluazifop; oxyfluorfen+sethoxydim; oxyfluorfen+quizalofop; oxyfluorfen+fenoxaprop; oxyfluorfen+clethodim; oxyfluorfen+glyphosate; oxyfluorfen+glufosinate; oxyfluorfen+sulfosate; azafenidin+metolachlor; azafenidin+(S)-metolachlor; azafenidin+propaquizafop; azafenidin+metamitron; azafenidin+pyramin; azafenidin+phenmedipham; azafenidin+desmedipham; azafenidin+ethofumesate; azafenidin+triasulfuron; azafenidin+chloridazon; azafenidin+lenacil; azafenidin+triallate; azafenidin+fluazifop; azafenidin+sethoxydim; azafenidin+quizalofop; azafenidin+fenoxaprop; azafenidin+clethodim; azafenidin+glyphosate; azafenidin+glufosinate; azafenidin+sulfosate; carfentrazone-ethyl+metolachlor; carfentrazone-ethyl+(S)-metolachlor; carfentrazone-ethyl+propaquizafop; carfentrazone-ethyl+metamitron; carfentrazone-ethyl+pyramin; carfentrazone-ethyl+phenmedipham; carfentrazone-ethyl+desmedipham; carfentrazone-ethyl+ethofumesate; carfentrazone-ethyl+triasulfuron; carfentrazone-ethyl+chloridazon; carfentrazone-ethyl+lenacil; carfentrazone-ethyl+triallate; carfentrazone-ethyl+fluazifop; carfentrazone-ethyl+sethoxydim; carfentrazone-ethyl+quizalofop; carfentrazone-ethyl+fenoxaprop; carfentrazone-ethyl+clethodim; carfentrazone-ethyl+glyphosate; carfentrazone-ethyl+glufosinate; carfentrazone-ethyl+sulfosate; compound of the formula A+metolachlor; compound of the formula A+(S)-metolachlor; compound of the formula A +propaquizafop; compound of the formula A+metamitron; compound of the formula A+pyramin; compound of the formula A+phenmedipham; compound of the formula A+desmedipham; compound of the formula A+ethofumesate; compound of the formula A+triasulfuron; compound of the formula A+chloridazon; compound of the formula A+lenacil; compound of the formula A+triallate; compound of the formula A+fluazifop; compound of the formula A+sethoxydim; compound of the formula A+quizalofop; compound of the formula A+fenoxaprop; compound of the formula A+clethodim; compound of the formula A+glyphosate; compound of the formula A+glufosinate; compound of the formula A+sulfosate; cinidon-ethyl+metolachlor; cinidon-ethyl+(S)-metolachlor; cinidon-ethyl+propaquizafop; cinidon-ethyl+metamitron; cinidon-ethyl+pyramin; cinidon-ethyl+phenmedipham; cinidon-ethyl+desmedipham; cinidon-ethyl+ethofumesate; cinidon-ethyl +triasulfuron; cinidon-ethyl+chloridazon; cinidon-ethyl+lenacil; cinidon-ethyl+triallate; cinidon-ethyl+fluazifop; cinidon-ethyl+sethoxydim; cinidon-ethyl+quizalofop; cinidon-ethyl+fenoxaprop; cinidon-ethyl+clethodim; cinidon-ethyl+glyphosate; cinidon-ethyl+glufosinate; cinidon-ethyl+sulfosate; flumiclorac-pentyl+metolachlor; flumiclorac-pentyl+(S)-metolachlor; flumiclorac-pentyl+Propaquizafop; flumiclorac-pentyl+metamitron; flumiclorac-pentyl+pyramin; flumiclorac-pentyl+phenmedipham; flumiclorac-pentyl+desmedipham; flumiclorac-pentyl+ethofumesate; flumiclorac-pentyl+triasulfuron; flumiclorac-pentyl+chloridazon; flumiclorac-pentyl+lenacil; flumiclorac-pentyl+triallate; flumiclorac-pentyl+fluazifop; flumiclorac-pentyl+sethoxydim; flumiclorac-pentyl+quizalofop; flumiclorac-pentyl+fenoxaprop; flumiclorac-pentyl+clethodim; flumiclorac-pentyl+glyphosate; flumiclorac-pentyl+glufosinate; flumiclorac-pentyl+sulfosate; flumioxazin+metolachlor; flumioxazin+(S)-metolachlor; flumioxazin+propaquizafop; flumioxazin+metamitron; flumioxazin+pyramin; flumioxazin+phenmedipham; flumioxazin +desmedipham; flumioxazin+ethofumesate; flumioxazin+triasulfuron; flumioxazin+chloridazon; flumioxazin+lenacil; flumioxazin+triallate; flumioxazin+fluazifop; flumioxazin +sethoxydim; flumioxazin+quizalofop; flumioxazin+fenoxaprop; flumioxazin+clethodim; flumioxazin+glyphosate; flumioxazin+glufosinate; flumioxazin+sulfosate; fluthiacet-methyl+metolachlor; fluthiacet-methyl+(S)-metolachlor; fluthiacet-methyl+propaquizafop; fluthiacet-methyl+metamitron; fluthiacet-methyl+pyramin; fluthiacet-methyl+phenmedipham; fluthiacet-methyl+desmedipham; fluthiacet-methyl+ethofumesate; fluthiacet-methyl+triasulfuron; fluthiacet-methyl+chloridazon; fluthiacet-methyl+lenacil; fluthiacet-methyl+triallate; fluthiacet-methyl+fluazifop; fluthiacet-methyl+sethoxydim; fluthiacet-methyl+quizalofop; fluthiacet-methyl+fenoxaprop; fluthiacet-methyl+clethodim; fluthiacet-methyl+glyphosate; fluthiacet-methyl+glufosinate; fluthiacet-methyl+sulfosate; oxadiargyl+metolachlor; oxadiargyl+(S)-metolachlor; oxadiargyl+propaquizafop; oxadiargyl+metamitron; oxadiargyl+pyramin; oxadiargyl+phenmedipham; oxadiargyl+desmedipham; oxadiargyl+ethofumesate; oxadiargyl+triasulfuron; oxadiargyl+chloridazon; oxadiargyl+lenacil; oxadiargyl+triallate; oxadiargyl+fluazifop; oxadiargyl+sethoxydim; oxadiargyl+quizalofop; oxadiargyl+fenoxaprop; oxadiargyl+clethodim; oxadiargyl+glyphosate; oxadiargyl+glufosinate; oxadiargyl+sulfosate; oxadiazon+metolachlor; oxadiazon+(S)-metolachlor; oxadiazon+propaquizafop; oxadiazon+metamitron; oxadiazon+pyramin; oxadiazon+phenmedipham; oxadiazon+desmedipham; oxadiazon+ethofumesate; oxadiazon+triasulfuron; oxadiazon+chloridazon; oxadiazon+lenacil; oxadiazon+triallate; oxadiazon+fluazifop; oxadiazon+sethoxydim; oxadiazon+quizalofop; oxadiazon+fenoxaprop; oxadiazon+clethodim; oxadiazon+glyphosate; oxadiazon+glufosinate; oxadiazon+sulfosate; pentoxazone+metolachlor; pentoxazone+(S)-metolachlor; pentoxazone+propaquizafop; pentoxazone+metamitron; pentoxazone+pyramin; pentoxazone+phenmedipham; pentoxazone+desmedipham; pentoxazone+ethofumesate; pentoxazone+triasulfuron; pentoxazone+chloridazon; pentoxazone+lenacil; pentoxazone+triallate; pentoxazone+fluazifop; pentoxazone+sethoxydim; pentoxazone+quizalofop; pentoxazone+fenoxaprop; pentoxazone+clethodim; pentoxazone+glyphosate; pentoxazone+glufosinate; pentoxazone+sulfosate; sulfentrazone+metolachlor; sulfentrazone+(S)-metolachlor; sulfentrazone+propaquizafop; sulfentrazone+metamitron; sulfentrazone+pyramin; sulfentrazone+phenmedipham; sulfentrazone+desmedipham; sulfentrazone+ethofumesate; sulfentrazone+triasulfuron; sulfentrazone+chloridazon; sulfentrazone+lenacil; sulfentrazone+triallate; sulfentrazone+fluazifop; sulfentrazone+sethoxydim; sulfentrazone+quizalofop; sulfentrazone+fenoxaprop; sulfentrazone+clethodim; sulfentrazone+glyphosate; sulfentrazone+glufosinate; sulfentrazone+sulfosate; fluazolate+metolachlor; fluazolate+(S)-metolachlor; fluazolate+propaquizafop; fluazolate +metamitron; fluazolate+pyramin; fluazolate+phenmedipham; fluazolate+desmedipham; fluazolate+ethofumesate; fluazolate+triasulfuron; fluazolate+chloridazon; fluazolate+lenacil; fluazolate+triallate; fluazolate+fluazifop; fluazolate+sethoxydim; fluazolate+quizalofop; fluazolate+fenoxaprop; fluazolate+clethodim; fluazolate+glyphosate; fluazolate+glufosinate; fluazolate+sulfosate; pyraflufen-ethyl+metolachlor; pyraflufen-ethyl+(S)-metolachlor; pyraflufen-ethyl+propaquizafop; pyraflufen-ethyl+metamitron; pyraflufen-ethyl+pyramin; pyraflufen-ethyl+phenmedipham; pyraflufen-ethyl+desmedipham; pyraflufen-ethyl+ethofumesate; pyraflufen-ethyl+triasulfuron; pyraflufen-ethyl+chloridazon; pyraflufen-ethyl+lenacil; pyraflufen-ethyl+triallate; pyraflufen-ethyl+fluazifop; pyraflufen-ethyl+sethoxydim; pyraflufen-ethyl+quizalofop; pyraflufen-ethyl+fenoxaprop; pyraflufen-ethyl+clethodim; pyraflufen-ethyl+glyphosate; pyraflufen-ethyl+glufosinate; pyraflufen-ethyl+sulfosate; flumipropyn+metolachlor; flumipropyn+(S)-metolachlor; flumipropyn+propaquizafop; flumipropyn+metamitron; flumipropyn+pyramin; flumipropyn+phenmedipham; flumipropyn+desmedipham; flumipropyn+ethofumesate; flumipropyn+triasulfuron; flumipropyn+chloridazon; flumipropyn+lenacil; flumipropyn+triallate; flumipropyn+fluazifop; flumipropyn+sethoxydim; flumipropyn+quizalofop; flumipropyn+fenoxaprop; flumipropyn+clethodim; flumipropyn+glyphosate; flumipropyn+glufosinate; flumipropyn+sulfosate; flupropacil+metolachlor; flupropacil+(S)-metolachlor; flupropacil+propaquizafop; flupropacil+metamitron; flupropacil+pyramin; flupropacil+phenmedipham; flupropacil+desmedipham; flupropacil+ethofumesate; flupropacil+triasulfuron; flupropacil+chloridazon; flupropacil+lenacil; flupropacil+triallate; flupropacil +fluazifop; flupropacil+sethoxydim; flupropacil+quizalofop; flupropacil+fenoxaprop; flupropacil+clethodim; flupropacil+glyphosate; flupropacil+glufosinate; flupropacil+sulfosate; nipyraclofen+metolachlor; nipyraclofen+(S)-metolachlor; nipyraclofen+propaquizafop; nipyraclofen+metamitron; nipyraclofen+pyramin; nipyraclofen+phenmedipham; nipyraclofen+desmedipham; nipyraclofen+ethofumesate; nipyraclofen+triasulfuron; nipyraclofen+chloridazon; nipyraclofen+lenacil; nipyraclofen+triallate; nipyraclofen+fluazifop; nipyraclofen+sethoxydim; nipyraclofen+quizalofop; nipyraclofen +fenoxaprop; nipyraclofen+clethodim; nipyraclofen+glyphosate; nipyraclofen+glufosinate; nipyraclofen+sulfosate; benzfendizone+metolachlor; benzfendizone+(S)-metolachlor; benzfendizone+propaquizafop; benzfendizone+metamitron; benzfendizone +pyramin; benzfendizone+phenmedipham; benzfendizone+desmedipham; benzfendizone+ethofumesate; benzfendizone+triasulfuron; benzfendizone+chloridazon; benzfendizone+lenacil; benzfendizone+triallate; benzfendizone+fluazifop; benzfendizone+sethoxydim; benzfendizone+quizalofop; benzfendizone+fenoxaprop; benzfendizone+clethodim; benzfendizone+glyphosate; benzfendizone+glufosinate; benzfendizone+sulfosate; thidiazimin+metolachlor; thidiazimin+(S)-metolachlor; thidiazimin+propaquizafop; thidiazimin+metamitron; thidiazimin+pyramin; thidiazimin+phenmedipham; thidiazimin+desmedipham; thidiazimin+ethofumesate; thidiazimin+triasulfuron; thidiazimin+chloridazon; thidiazimin+lenacil; thidiazimin+triallate; thidiazimin+fluazifop; thidiazimin+sethoxydim; thidiazimin+quizalofop; thidiazimin+fenoxaprop; thidiazimin+clethodim; thidiazimin+glyphosate; thidiazimin+glufosinate; and thidiazimin+sulfosate.

The following combinations of the compound under a) with the co-herbicides under b) have been found to be very particularly effective synergistic compositions in soya crops resistant to protoporphyrinogen oxidase inhibitors:

Acifluorfen+(S)-metolachlor; acifluorfen+metolachlor; acifluorfen+oxasulfuron; acifluorfen+fluthiacet; acifluorfen+propaquizafop; acifluorfen+alachlor; acifluorfen+dimethenamid or (S)-dimethenamid; acifluorfen+benazolin; acifluorfen+bentazone; acifluorfen+carfentrazone; acifluorfen+sulfentrazone; acifluorfen+chlorimuron-ethyl; acifluorfen+cloransulam-methyl; acifluorfen+thifensulfuron-methyl; acifluorfen+clopyralid; acifluorfen+flumiclorac-pentyl; acifluorfen+flumetsulam; acifluorfen+fomesafen; acifluorfen+imazamox; acifluorfen+imazaquin; acifluorfen+imazethapyr; acifluorfen+imazapyr; acifluorfen+lactofen; acifluorfen+pyridate; acifluorfen+sethoxydim; acifluorfen+fluazifop; acifluorfen+quizalofop; acifluorfen+clethodim; acifluorfen+fenoxaprop; acifluorfen+thidiazuron; acifluorfen+tribufos; acifluorfen+pendimethalin; acifluorfen+trifluralin; acifluorfen+glyphosate; acifluorfen+glufosinate; acifluorfen+sulfosate; aclonifen+(S)-metolachlor; aclonifen+metolachlor; aclonifen+oxasulfuron; aclonifen+fluthiacet; aclonifen+propaquizafop; aclonifen+alachlor; aclonifen+dimethenamid or (S)-dimethenamid; aclonifen+acifluorfen; aclonifen+benazolin; aclonifen+bentazone; aclonifen+carfentrazone; aclonifen+sulfentrazone; aclonifen+chlorimuron-ethyl; aclonifen+cloransulam-methyl; aclonifen+thifensulfuron-methyl; aclonifen+clopyralid; aclonifen+flumiclorac-pentyl; aclonifen+flumetsulam; aclonifen+fomesafen; aclonifen+imazamox; aclonifen+imazaquin; aclonifen+imazethapyr; aclonifen+imazapyr; aclonifen+lactofen; aclonifen+pyridate; aclonifen+sethoxydim; aclonifen+fluazifop; aclonifen+quizalofop; aclonifen+clethodim; aclonifen+fenoxaprop; aclonifen+thidiazuron; aclonifen+tribufos; aclonifen+pendimethalin; aclonifen+trifluralin; aclonifen+glyphosate; aclonifen+glufosinate; aclonifen+sulfosate; bifenox+(S)-metolachlor; bifenox+metolachlor; bifenox+oxasulfuron; bifenox+fluthiacet; bifenox+propaquizafop; bifenox+alachlor; bifenox+dimethenamid or (S)-dimethenamid; bifenox+acifluorfen; bifenox+benazolin; bifenox+bentazone; bifenox+carfentrazone; bifenox+sulfentrazone; bifenox+chlorimuron-ethyl; bifenox+cloransulam-methyl; bifenox +thifensulfuron-methyl; bifenox+clopyralid; bifenox+flumiclorac-pentyl; bifenox+flumetsulam; bifenox+fomesafen; bifenox+imazamox; bifenox+imazaquin; bifenox+imazethapyr; bifenox+imazapyr; bifenox+lactofen; bifenox+pyridate; bifenox+sethoxydim; bifenox+fluazifop; bifenox+quizalofop; bifenox+clethodim; bifenox+fenoxaprop; bifenox+thidiazuron; bifenox+tribufos; bifenox+pendimethalin; bifenox+trifluralin; bifenox+glyphosate; bifenox+glufosinate; bifenox+sulfosate; chlomitrofen+(S)-metolachlor; chlomitrofen+metolachlor; chlomitrofen+oxasulfuron; chlomitrofen+fluthiacet; chlomitrofen+propaquizafop; chlomitrofen+alachlor; chlomitrofen+dimethenamid or (S)-dimethenamid; chlomitrofen+acifluorfen; chlomitrofen+benazolin; chlomitrofen+bentazone; chlomitrofen+carfentrazone; chlomitrofen+sulfentrazone; chlomitrofen+chlorimuron-ethyl; chlomitrofen+cloransulam-methyl; chlomitrofen+thifensulfuron-methyl; chlomitrofen+clopyralid; chlomitrofen+flumiclorac-pentyl; chlomitrofen+flumetsulam; chlomitrofen+fomesafen; chlomitrofen+Imazamox; chlomitrofen+imazaquin; chlomitrofen+imazethapyr; chlomitrofen+imazapyr; chlomitrofen+lactofen; chlomitrofen+pyridate; chlomitrofen+sethoxydim; chlomitrofen+fluazifop; chlomitrofen+quizalofop; chlomitrofen+clethodim; chlomitrofen+fenoxaprop; chlomitrofen+thidiazuron; chlomitrofen+tribufos; chlomitrofen+pendimethalin; chlomitrofen+trifluralin; chlomitrofen+glyphosate; chlomitrofen+glufosinate; chlomitrofen +sulfosate; ethoxyfen+(S)-metolachlor; ethoxyfen+metolachlor; ethoxyfen+oxasulfuron; ethoxyfen+fluthiacet; ethoxyfen+propaquizafop; ethoxyfen+alachlor; ethoxyfen+dimethenamid or (S)-dimethenamid; ethoxyfen+acifluorfen; ethoxyfen+benazolin; ethoxyfen+bentazone; ethoxyfen+carfentrazone; ethoxyfen+sulfentrazone; ethoxyfen+chlorimuron-ethyl; ethoxyfen+cloransulam-methyl; ethoxyfen+thifensulfuron-methyl; ethoxyfen+clopyralid; ethoxyfen+flumiclorac-pentyl; ethoxyfen+flumetsulam; ethoxyfen +fomesafen; ethoxyfen+imazamox; ethoxyfen+imazaquin; ethoxyfen+imazethapyr; ethoxyfen+imazapyr; ethoxyfen+lactofen; ethoxyfen+pyridate; ethoxyfen+sethoxydim; ethoxyfen+fluazifop; ethoxyfen+quizalofop; ethoxyfen+clethodim; ethoxyfen+fenoxaprop; ethoxyfen+thidiazuron; ethoxyfen+tribufos; ethoxyfen+pendimethalin; ethoxyfen+trifluralin; ethoxyfen+glyphosate; ethoxyfen+glufosinate; ethoxyfen+sulfosate; fluoroglycofen+(S)-metolachlor; fluoroglycofen+metolachlor; fluoroglycofen+oxasulfuron; fluoroglycofen+fluthiacet; fluoroglycofen+propaquizafop; fluoroglycofen+alachlor; fluoroglycofen+dimethenamid or (S)-dimethenamid; fluoroglycofen+acifluorfen; fluoroglycofen+benazolin; fluoroglycofen+bentazone; fluoroglycofen+carfentrazone; fluoroglycofen+sulfentrazone; fluoroglycofen+chlorimuron-ethyl; fluoroglycofen+cloransulam-methyl; fluoroglycofen+thifensulfuron-methyl; fluoroglycofen+clopyralid; fluoroglycofen+flumiclorac-pentyl; fluoroglycofen+flumetsulam; fluoroglycofen+fomesafen; fluoroglycofen+imazamox; fluoroglycofen+imazaquin; fluoroglycofen+imazethapyr; fluoroglycofen+imazapyr; fluoroglycofen+lactofen; fluoroglycofen+pyridate; fluoroglycofen+sethoxydim; fluoroglycofen+fluazifop; fluoroglycofen+quizalofop; fluoroglycofen+clethodim; fluoroglycofen+fenoxaprop; fluoroglycofen+thidiazuron; fluoroglycofen+tribufos; fluoroglycofen+pendimethalin; fluoroglycofen+trifluralin; fluoroglycofen+glyphosate; fluoroglycofen+glufosinate; fluoroglycofen+sulfosate; fomesafen+(S)-metolachlor; fomesafen+metolachlor; fomesafen+oxasulfuron; fomesafen+fluthiacet; fomesafen+propaquizafop; fomesafen+alachlor; fomesafen+dimethenamid or (S)-dimethenamid; fomesafen+acifluorfen; fomesafen+benazolin; fomesafen+bentazone; fomesafen+carfentrazone; fomesafen+sulfentrazone; fomesafen+chlorimuron-ethyl; fomesafen+cloransulam-methyl; fomesafen+thifensulfuron-methyl; fomesafen+clopyralid; fomesafen+flumiclorac-pentyl; fomesafen+flumetsulam; fomesafen+imazamox; fomesafen+imazaquin; fomesafen+imazethapyr; fomesafen+imazapyr; fomesafen+lactofen; fomesafen+pyridate; fomesafen+sethoxydim; fomesafen+fluazifop; fomesafen+quizalofop; fomesafen+clethodim; fomesafen+fenoxaprop; fomesafen+thidiazuron; fomesafen+tribufos; fomesafen+pendimethalin; fomesafen+trifluralin; fomesafen+glyphosate; fomesafen+glufosinate; fomesafen+sulfosate; lactofen+(S)-metolachlor; lactofen+metolachlor, lactofen+oxasulfuron; lactofen+fluthiacet; lactofen+propaquizafop; lactofen+alachlor; lactofen+dimethenamid or (S)-dimethenamid; lactofen+acifluorfen; lactofen+benazolin; lactofen+bentazone; lactofen+carfentrazone; lactofen+sulfentrazone; lactofen+chlorimuron-ethyl; lactofen+cloransulam-methyl; lactofen+thifensulfuron-methyl; lactofen+clopyralid; lactofen+flumiclorac-pentyl; lactofen+flumetsulam; lactofen+fomesafen; lactofen+imazamox; lactofen+imazaquin; lactofen+imazethapyr; lactofen+imazapyr; lactofen+pyridate; lactofen+sethoxydim; lactofen+fluazifop; lactofen+quizalofop; lactofen+clethodim; lactofen+fenoxaprop; lactofen+thidiazuron; lactofen+tribufos; lactofen+pendimethalin; lactofen+trifluralin; lactofen+glyphosate; lactofen+glufosinate; lactofen+sulfosate; oxyfluorfen+(S)-metolachlor; oxyfluorfen+metolachlor; oxyfluorfen+oxasulfuron; oxyfluorfen+fluthiacet; oxyfluorfen+propaquizafop; oxyfluorfen+alachlor; oxyfluorfen+dimethenamid or (S)-dimethenamid; oxyfluorfen+acifluorfen; oxyfluorfen+benazolin; oxyfluorfen+bentazone; oxyfluorfen+carfentrazone; oxyfluorfen+sulfentrazone; oxyfluorfen+chlorimuron-ethyl; oxyfluorfen+cloransulam-methyl; oxyfluorfen+thifensulfuron-methyl; oxyfluorfen+clopyralid; oxyfluorfen+flumiclorac-pentyl; oxyfluorfen+flumetsulam; oxyfluorfen+fomesafen; oxyfluorfen+imazamox; oxyfluorfen+imazaquin; oxyfluorfen+imazethapyr; oxyfluorfen+imazapyr; oxyfluorfen+lactofen; oxyfluorfen+pyridate; oxyfluorfen+sethoxydim; oxyfluorfen+fluazifop; oxyfluorfen+quizalofop; oxyfluorfen+clethodim; oxyfluorfen+fenoxaprop; oxyfluorfen+thidiazuron; oxyfluorfen+tribufos; oxyfluorfen+pendimethalin; oxyfluorfen+trifluralin; oxyfluorfen+glyphosate; oxyfluorfen+glufosinate; oxyfluorfen+sulfosate; azafenidin+(S)-metolachlor; azafenidin+metolachlor; azafenidin+oxasulfuron; azafenidin+fluthiacet; azafenidin+propaquizafop; azafenidin+alachlor; azafenidin+dimethenamid or (S)-dimethenamid; azafenidin+acifluorfen; azafenidin+benazolin; azafenidin+bentazone; azafenidin+carfentrazone; azafenidin+sulfentrazone; azafenidin+chlorimuron-ethyl; azafenidin+cloransulam-methyl; azafenidin+thifensulfuron-methyl; azafenidin+clopyralid; azafenidin+flumiclorac-pentyl; azafenidin+flumetsulam; azafenidin+fomesafen; azafenidin+imazamox; azafenidin+imazaquin; azafenidin+imazethapyr; azafenidin+imazapyr; azafenidin+lactofen; azafenidin+pyridate; azafenidin+sethoxydim; azafenidin +fluazifop; azafenidin+quizalofop; azafenidin+clethodim; azafenidin+fenoxaprop; azafenidin+thidiazuron; azafenidin+tribufos; azafenidin+pendimethalin; azafenidin+trifluralin; azafenidin+glyphosate; azafenidin+glufosinate; azafenidin+sulfosate; carfentrazone-ethyl+(S)-metolachlor; carfentrazone-ethyl+metolachlor; carfentrazone-ethyl+oxasulfuron; carfentrazone-ethyl+fluthiacet; carfentrazone-ethyl+propaquizafop; carfentrazone-ethyl+alachlor; carfentrazone-ethyl+dimethenamid or (S)-dimethenamid; carfentrazone-ethyl+acifluorfen; carfentrazone-ethyl+benazolin; carfentrazone-ethyl+bentazone; carfentrazone-ethyl+sulfentrazone; carfentrazone-ethyl+chlorimuron-ethyl; carfentrazone-ethyl+cloransulam-methyl; carfentrazone-ethyl+thifensulfuron-methyl; carfentrazone-ethyl+clopyralid; carfentrazone-ethyl+flumiclorac-pentyl; carfentrazone-ethyl+flumetsulam; carfentrazone-ethyl+fomesafen; carfentrazone-ethyl+imazamox; carfentrazone-ethyl+imazaquin; carfentrazone-ethyl+imazethapyr; carfentrazone-ethyl+imazapyr; carfentrazone-ethyl+lactofen; carfentrazone-ethyl+pyridate; carfentrazone-ethyl+sethoxydim; carfentrazone-ethyl+fluazifop; carfentrazone-ethyl+quizalofop; carfentrazone-ethyl+clethodim; carfentrazone-ethyl+fenoxaprop; carfentrazone-ethyl+thidiazuron; carfentrazone-ethyl+tribufos; carfentrazone-ethyl+pendimethalin; carfentrazone-ethyl+trifluralin; carfentrazone-ethyl+glyphosate; carfentrazone-ethyl+glufosinate; carfentrazone-ethyl+sulfosate; compound of the formula A+(S)-metolachlor; compound of the formula A+metolachlor; compound of the formula A+oxasulfuron; compound of the formula A+fluthiacet; compound of the formula A+propaquizafop; compound of the formula A+alachlor; compound of the formula A+dimethenamid or (S)-dimethenamid; compound of the formula A+acifluorfen; compound of the formula A+benazolin; compound of the formula A+bentazone; compound of the formula A+carfentrazone; compound of the formula A+sulfentrazone; compound of the formula A+chlorimuron-ethyl; compound of the formula A+cloransulam-methyl; compound of the formula A+thifensulfuron-methyl; compound of the formula A+clopyralid; compound of the formula A+flumiclorac-pentyl; compound of the formula A+flumetsulam; compound of the formula A+fomesafen; compound of the formula A+imazamox; compound of the formula A+imazaquin; compound of the formula A+imazethapyr; compound of the formula A+imazapyr; compound of the formula A+lactofen; compound of the formula A+pyridate; compound of the formula A+sethoxydim; compound of the formula A+fluazifop; compound of the formula A+quizalofop; compound of the formula A+clethodim; compound of the formula A+fenoxaprop; compound of the formula A+thidiazuron; compound of the formula A+tribufos; compound of the formula A+pendimethalin; compound of the formula A+trifluralin; compound of the formula A+glyphosate; compound of the formula A+glufosinate; compound of the formula A+sulfosate; cinidon-ethyl+(S)-metolachlor; cinidon-ethyl+metolachlor; cinidon-ethyl+oxasulfuron; cinidon-ethyl+fluthiacet; cinidon-ethyl+propaquizafop; cinidon-ethyl+alachlor; cinidon-ethyl+dimethenamid or (S)-dimethenamid; cinidon-ethyl+acifluorfen; cinidon-ethyl+benazolin; cinidon-ethyl+bentazone; cinidon-ethyl+carfentrazone; cinidon-ethyl+sulfentrazone; cinidon-ethyl+chlorimuron-ethyl; cinidon-ethyl+cloransulam-methyl; cinidon-ethyl+thifensulfuron-methyl; cinidon-ethyl+clopyralid; cinidon-ethyl+flumiclorac-pentyl; cinidon-ethyl+flumetsulam; cinidon-ethyl+fomesafen; cinidon-ethyl+imazamox; cinidon-ethyl+imazaquin; cinidon-ethyl+imazethapyr; cinidon-ethyl+imazapyr; cinidon-ethyl+lactofen; cinidon-ethyl+pyridate; cinidon-ethyl+sethoxydim; cinidon-ethyl+fluazifop; cinidon-ethyl +quizalofop; cinidon-ethyl+clethodim; cinidon-ethyl+fenoxaprop; cinidon-ethyl+thidiazuron; cinidon-ethyl+tribufos; cinidon-ethyl+pendimethalin; cinidon-ethyl+trifluralin; cinidon-ethyl+glyphosate; cinidon-ethyl+glufosinate; cinidon-ethyl+sulfosate; flumiclorac-pentyl+(S)-metolachlor; flumiclorac-pentyl+metolachlor; flumiclorac-pentyl+oxasulfuron; flumiclorac-pentyl+fluthiacet; flumiclorac-pentyl+propaquizafop; flumiclorac-pentyl+alachlor; flumiclorac-pentyl+dimethenamid or (S)-dimethenamid; flumiclorac-pentyl +acifluorfen; flumiclorac-pentyl+benazolin; flumiclorac-pentyl+bentazone; flumiclorac-pentyl+carfentrazone; flumiclorac-pentyl+sulfentrazone; flumiclorac-pentyl+chlorimuron-ethyl; flumiclorac-pentyl+cloransulam-methyl; flumiclorac-pentyl+thifensulfuron-methyl; flumiclorac-pentyl+clopyralid; flumiclorac-pentyl+flumetsulam; flumiclorac-pentyl+fomesafen; flumiclorac-pentyl+imazamox; flumiclorac-pentyl+imazaquin; flumiclorac-pentyl+imazethapyr; flumiclorac-pentyl+imazapyr; flumiclorac-pentyl+lactofen; flumiclorac-pentyl+pyridate; flumiclorac-pentyl+sethoxydim; flumiclorac-pentyl+fluazifop; flumiclorac-pentyl+quizalofop; flumiclorac-pentyl+clethodim; flumiclorac-pentyl+fenoxaprop; flumiclorac-pentyl+thidiazuron; flumiclorac-pentyl+tribufos; flumiclorac-pentyl +pendimethalin; flumiclorac-pentyl+trifluralin; flumiclorac-pentyl+glyphosate; flumiclorac-pentyl+glufosinate; flumiclorac-pentyl+sulfosate; flumioxazin+(S)-metolachlor; flumioxazin+metolachlor; flumioxazin+oxasulfuron; flumioxazin+fluthiacet; flumioxazin+propaquizafop; flumioxazin+alachlor; flumioxazin+dimethenamid or (S)-dimethenamid; flumioxazin+acifluorfen; flumioxazin+benazolin; flumioxazin+bentazone; flumioxazin+carfentrazone; flumioxazin+sulfentrazone; flumioxazin+chlorimuron-ethyl; flumioxazin+cloransulam-methyl; flumioxazin+thifensulfuron-methyl; flumioxazin+clopyralid; flumioxazin+flumiclorac-pentyl; flumioxazin+flumetsulam; flumioxazin+fomesafen; flumioxazin+imazamox; flumioxazin+imazaquin; flumioxazin+imazethapyr; flumioxazin+imazapyr; flumioxazin+lactofen; flumioxazin+pyridate; flumioxazin+sethoxydim; flumioxazin+fluazifop; flumioxazin+quizalofop; flumioxazin+clethodim; flumioxazin+fenoxaprop; flumioxazin+thidiazuron; flumioxazin+tribufos; flumioxazin+pendimethalin; flumioxazin+trifluralin; flumioxazin+glyphosate; flumioxazin+glufosinate; flumioxazin+sulfosate; fluthiacet-methyl+(S)-metolachlor; fluthiacet-methyl+metolachlor; fluthiacet-methyl+oxasulfuron; fluthiacet-methyl+propaquizafop; fluthiacet-methyl+alachlor; fluthiacet-methyl+dimethenamid or (S)-dimethenamid; fluthiacet-methyl+acifluorfen; fluthiacet-methyl+benazolin; fluthiacet-methyl+bentazone; fluthiacet-methyl+carfentrazone; fluthiacet-methyl+sulfentrazone; fluthiacet-methyl+chlorimuron-ethyl; fluthiacet-methyl+cloransulam-methyl; fluthiacet-methyl+thifensulfuron-methyl; fluthiacet-methyl+clopyralid; fluthiacet-methyl+flumiclorac-pentyl; fluthiacet-methyl+flumetsulam; fluthiacet-methyl+fomesafen; fluthiacet-methyl+imazamox; fluthiacet-methyl+imazaquin; fluthiacet-methyl+imazethapyr; fluthiacet-methyl+imazapyr; fluthiacet-methyl+lactofen; fluthiacet-methyl+pyridate; fluthiacet-methyl+sethoxydim; fluthiacet-methyl+fluazifop; fluthiacet-methyl+quizalofop; fluthiacet-methyl+clethodim; fluthiacet-methyl+fenoxaprop; fluthiacet-methyl+thidiazuron; fluthiacet-methyl+tribufos; fluthiacet-methyl+pendimethalin; fluthiacet-methyl+trifluralin; fluthiacet-methyl+glyphosate; fluthiacet-methyl +glufosinate; fluthiacet-methyl+sulfosate; oxadiargyl+(S)-metolachlor; oxadiargyl+metolachlor; oxadiargyl+oxasulfuron; oxadiargyl+fluthiacet; oxadiargyl+propaquizafop; oxadiargyl+alachlor; oxadiargyl+dimethenamid or (S)-dimethenamid; oxadiargyl+acifluorfen; oxadiargyl+benazolin; oxadiargyl+bentazone; oxadiargyl+carfentrazone; oxadiargyl+sulfentrazone; oxadiargyl+chlorimuron-ethyl; oxadiargyl+cloransulam-methyl; oxadiargyl+thifensulfuron-methyl; oxadiargyl+clopyralid; oxadiargyl+flumiclorac-pentyl; oxadiargyl+flumetsulam; oxadiargyl+fomesafen; oxadiargyl+imazamox; oxadiargyl+imazaquin; oxadiargyl+imazethapyr; oxadiargyl+imazapyr; oxadiargyl+lactofen; oxadiargyl+pyridate; oxadiargyl+sethoxydim; oxadiargyl+fluazifop; oxadiargyl+quizalofop; oxadiargyl+clethodim; oxadiargyl+fenoxaprop; oxadiargyl+thidiazuron; oxadiargyl+tribufos; oxadiargyl+pendimethalin; oxadiargyl+trifluralin; oxadiargyl+glyphosate; oxadiargyl+glufosinate; oxadiargyl+sulfosate; oxadiazon+(S)-metolachlor; oxadiazon+metolachlor; oxadiazon+oxasulfuron; oxadiazon+fluthiacet; oxadiazon+propaquizafop; oxadiazon+alachlor; oxadiazon+dimethenamid or (S)-dimethenamid; oxadiazon+acifluorfen; oxadiazon+benazolin; oxadiazon+bentazone; oxadiazon+carfentrazone; oxadiazon+sulfentrazone; oxadiazon+chlorimuron-ethyl; oxadiazon+cloransulam-methyl; oxadiazon+thifensulfuron-methyl; oxadiazon+clopyralid; oxadiazon+flumiclorac-pentyl; oxadiazon+flumetsulam; oxadiazon+fomesafen; oxadiazon+imazamox; oxadiazon+imazaquin; oxadiazon+imazethapyr; oxadiazon+imazapyr; oxadiazon+lactofen; oxadiazon+pyridate; oxadiazon+sethoxydim; oxadiazon+fluazifop; oxadiazon+quizalofop; oxadiazon+clethodim; oxadiazon+fenoxaprop; oxadiazon+thidiazuron; oxadiazon+tribufos; oxadiazon+pendimethalin; oxadiazon+trifluralin; oxadiazon+glyphosate; oxadiazon+glufosinate; oxadiazon+sulfosate; pentoxazone+(S)-metolachlor; pentoxazone+metolachlor; pentoxazone+oxasulfuron; pentoxazone+fluthiacet; pentoxazone+propaquizafop; pentoxazone+alachlor; pentoxazone+dimethenamid or (S)-dimethenamid; pentoxazone+acifluorfen; pentoxazone+benazolin; pentoxazone+bentazone; pentoxazone+carfentrazone; pentoxazone+sulfentrazone; pentoxazone+chlorimuron-ethyl; pentoxazone+cloransulam-methyl; pentoxazone+thifensulfuron-methyl; pentoxazone+clopyralid; pentoxazone+flumiclorac-pentyl; pentoxazone+flumetsulam; pentoxazone+fomesafen; pentoxazone+imazamox; pentoxazone+imazaquin; pentoxazone+imazethapyr; pentoxazone+imazapyr; pentoxazone+lactofen; pentoxazone+pyridate; pentoxazone+sethoxydim; pentoxazone +fluazifop; pentoxazone+quizalofop; pentoxazone+clethodim; pentoxazone+fenoxaprop; pentoxazone+thidiazuron; pentoxazone+tribufos; pentoxazone+pendimethalin; pentoxazone+trifluralin; pentoxazone+glyphosate; pentoxazone+glufosinate; pentoxazone+sulfosate; sulfentrazone+(S)-metolachlor; sulfentrazone+metolachlor; sulfentrazone+oxasulfuron; sulfentrazone+fluthiacet; sulfentrazone+propaquizafop; sulfentrazone+alachlor; sulfentrazone+dimethenamid or (S)-dimethenamid; sulfentrazone+acifluorfen; sulfentrazone+benazolin; sulfentrazone+bentazone; sulfentrazone+carfentrazone; sulfentrazone+chlorimuron-ethyl; sulfentrazone +cloransulam-methyl; sulfentrazone+thifensulfuron-methyl; sulfentrazone+clopyralid; sulfentrazone+flumiclorac-pentyl; sulfentrazone+flumetsulam; sulfentrazone+fomesafen; sulfentrazone+imazamox; sulfentrazone+imazaquin; sulfentrazone+imazethapyr; sulfentrazone+imazapyr; sulfentrazone+lactofen; sulfentrazone+pyridate; sulfentrazone+sethoxydim; sulfentrazone+fluazifop; sulfentrazone+quizalofop; sulfentrazone+clethodim; sulfentrazone+fenoxaprop; sulfentrazone+thidiazuron; sulfentrazone+tribufos; sulfentrazone+pendimethalin; sulfentrazone+trifluralin; sulfentrazone+glyphosate; sulfentrazone+glufosinate; sulfentrazone+sulfosate; fluazolate+(S)-metolachlor; fluazolate+metolachlor; fluazolate+oxasulfuron; fluazolate+fluthiacet; fluazolate+propaquizafop; fluazolate+alachlor; fluazolate+dimethenamid or (S)-dimethenamid; fluazolate+acifluorfen; fluazolate+benazolin; fluazolate+bentazone; fluazolate+carfentrazone; fluazolate+sulfentrazone; fluazolate+chlorimuron-ethyl; fluazolate+cloransulam-methyl; fluazolate+thifensulfuron-methyl; fluazolate+clopyralid; fluazolate+flumiclorac-pentyl; fluazolate+flumetsulam; fluazolate+fomesafen; fluazolate +imazamox; fluazolate+imazaquin; fluazolate+imazethapyr; fluazolate+imazapyr; fluazolate+lactofen; fluazolate+pyridate; fluazolate+sethoxydim; fluazolate+fluazifop; fluazolate+quizalofop; fluazolate+clethodim; fluazolate+fenoxaprop; fluazolate+thidiazuron; fluazolate+tribufos; fluazolate+pendimethalin; fluazolate+trifluralin; fluazolate+glyphosate; fluazolate+glufosinate; fluazolate+sulfosate; pyraflufen-ethyl+(S)-metolachlor; pyraflufen-ethyl+metolachlor; pyraflufen-ethyl+oxasulfuron; pyraflufen-ethyl+fluthiacet; pyraflufen-ethyl+propaquizafop; pyraflufen-ethyl+alachlor; pyraflufen-ethyl+dimethenamid or (S)-dimethenamid; pyraflufen-ethyl+acifluorfen; pyraflufen-ethyl+benazolin; pyraflufen-ethyl+bentazone; pyraflufen-ethyl+carfentrazone; pyraflufen-ethyl+sulfentrazone; pyraflufen-ethyl+chlorimuron-ethyl; pyraflufen-ethyl+cloransulam-methyl; pyraflufen-ethyl+thifensulfuron-methyl; pyraflufen-ethyl+clopyralid; pyraflufen-ethyl+flumiclorac-pentyl; pyraflufen-ethyl+flumetsulam; pyraflufen-ethyl+fomesafen; pyraflufen-ethyl+imazamox; pyraflufen-ethyl+imazaquin; pyraflufen-ethyl+imazethapyr; pyraflufen-ethyl+imazapyr; pyraflufen-ethyl+lactofen; pyraflufen-ethyl+pyridate; pyraflufen-ethyl+sethoxydim; pyraflufen-ethyl+fluazifop; pyraflufen-ethyl+quizalofop; pyraflufen-ethyl+clethodim; pyraflufen-ethyl+fenoxaprop; pyraflufen-ethyl+thidiazuron; pyraflufen-ethyl+tribufos; pyraflufen-ethyl+pendimethalin; pyraflufen-ethyl+trifluralin; pyraflufen-ethyl+glyphosate; pyraflufen-ethyl+glufosinate; pyraflufen-ethyl+sulfosate; flumipropyn+(S)-metolachlor; flumipropyn+metolachlor; flumipropyn+oxasulfuron; flumipropyn+fluthiacet; flumipropyn+propaquizafop; flumipropyn+alachlor; flumipropyn+dimethenamid or (S)-dimethenamid; flumipropyn+acifluorfen; flumipropyn+benazolin; flumipropyn+bentazone; flumipropyn+carfentrazone; flumipropyn+sulfentrazone; flumipropyn+chlorimuron-ethyl; flumipropyn+cloransulam-methyl; flumipropyn+thifensulfuron-methyl; flumipropyn+clopyralid; flumipropyn+flumiclorac-pentyl; flumipropyn+flumetsulam; flumipropyn+fomesafen; flumipropyn+imazamox; flumipropyn +imazaquin; flumipropyn+imazethapyr; flumipropyn+imazapyr; flumipropyn+lactofen; flumipropyn+pyridate; flumipropyn+sethoxydim; flumipropyn+fluazifop; flumipropyn+quizalofop; flumipropyn+clethodim; flumipropyn+fenoxaprop; flumipropyn+thidiazuron; flumipropyn+tribufos; flumipropyn+pendimethalin; flumipropyn+trifluralin; flumipropyn+glyphosate; flumipropyn+glufosinate; flumipropyn+sulfosate; flupropacil+(S)-metolachlor; flupropacil+metolachlor; flupropacil+oxasulfuron; flupropacil+fluthiacet; flupropacil+propaquizafop; flupropacil+alachlor, flupropacil+dimethenamid or (S)-dimethenamid; flupropacil+acifluorfen; flupropacil+benazolin; flupropacil+bentazone; flupropacil+carfentrazone; flupropacil+sulfentrazone; flupropacil+chlorimuron-ethyl; flupropacil+cloransulam-methyl; flupropacil+thifensulfuron-methyl; flupropacil+clopyralid; flupropacil+flumiclorac-pentyl; flupropacil+flumetsulam; flupropacil+fomesafen; flupropacil+imazamox; flupropacil+imazaquin; flupropacil+imazethapyr; flupropacil+imazapyr; flupropacil+lactofen; flupropacil+pyridate; flupropacil+sethoxydim; flupropacil +fluazifop; flupropacil+quizalofop; flupropacil+clethodim; flupropacil+fenoxaprop; flupropacil+thidiazuron; flupropacil+tribufos; flupropacil+pendimethalin; flupropacil+trifluralin; flupropacil+glyphosate; flupropacil+glufosinate; flupropacil+sulfosate; benzfendizone+(S)-metolachlor; benzfendizone+metolachlor; benzfendizone+oxasulfuron; benzfendizone+fluthiacet; benzfendizone+propaquizafop; benzfendizone+alachlor; benzfendizone+dimethenamid or (S)-dimethenamid; benzfendizone+acifluorfen; benzfendizone+benazolin; benzfendizone+bentazone; benzfendizone+carfentrazone; benzfendizone+sulfentrazone; benzfendizone+chlorimuron-ethyl; benzfendizone+cloransulam-methyl; benzfendizone+thifensulfuron-methyl; benzfendizone+clopyralid; benzfendizone+flumiclorac-pentyl; benzfendizone+flumetsulam; benzfendizone+fomesafen; benzfendizone+imazamox; benzfendizone+imazaquin; benzfendizone+imazethapyr; benzfendizone+imazapyr; benzfendizone+lactofen; benzfendizone+pyridate; benzfendizone+sethoxydim; benzfendizone+fluazifop; benzfendizone+quizalofop; benzfendizone+clethodim; benzfendizone+fenoxaprop; benzfendizone+thidiazuron; benzfendizone+tribufos; benzfendizone+pendimethalin; benzfendizone+trifluralin; benzfendizone+glyphosate; benzfendizone+glufosinate; benzfendizone+sulfosate; thidiazimin+(S)-metolachlor; thidiazimin+metolachlor; thidiazimin+oxasulfuron; thidiazimin+fluthiacet; thidiazimin+propaquizafop; thidiazimin+alachlor; thidiazimin+dimethenamid or (S)-dimethenamid; thidiazimin+acifluorfen; thidiazimin+benazolin; thidiazimin+bentazone; thidiazimin+carfentrazone; thidiazimin+sulfentrazone; thidiazimin+chlorimuron-ethyl; thidiazimin+cloransulam-methyl; thidiazimin+thifensulfuron-methyl; thidiazimin+clopyralid; thidiazimin+flumiclorac-pentyl; thidiazimin+flumetsulam; thidiazimin+tomesafen; thidiazimin+imazamox; thidiazimin+imazaquin; thidiazimin+imazethapyr; thidiazimin+imazapyr; thidiazimin+lactofen; thidiazimin+pyridate; thidiazimin+sethoxydim; thidiazimin+fluazifop; thidiazimin+quizalofop; thidiazimin+clethodim; thidiazimin+fenoxaprop; thidiazimin+thidiazuron; thidiazimin+tribufos; thidiazimin+pendimethalin; thidiazimin+trifluralin; thidiazimin+glyphosate; thidiazimin+glufosinate; and thidiazimin+sulfosate.

The following combinations of the compounds under a) with the co-herbicides under b) have been found to be very particularly effective synergistic compositions in crops of rape resistant to protoporphyrinogen oxidase inhibitors:

acifluorfen+dimethachlor; acifluorfen+propaquizafop; acifluorfen+clomazone; acifluorfen +napropamide; acifluorfen+quinmerac; acifluorfen+metazachlor; acifluorfen+carbetamide; acifluorfen+dimefuron; acifluorfen+propyzamide; acifluorfen+clopyralid; acifluorfen+ethametsulfuron; acifluorfen+sethoxydim; acifluorfen+fluazifop; acifluorfen+quizalofop; acifluorfen+clethodim; acifluorfen+fenoxaprop; acifluorfen+tebutam; acifluorfen+glyphosate; acifluorfen+glufosinate; acifluorfen+sulfosate; bifenox+dimethachlor; bifenox+propaquizafop; bifenox+clomazone; bifenox+napropamide; bifenox+quinmerac; bifenox+metazachlor; bifenox+carbetamide; bifenox+dimefuron; bifenox+propyzamide; bifenox+clopyralid; bifenox+ethametsulfuron; bifenox+sethoxydim; bifenox+fluazifop; bifenox+quizalofop; bifenox+clethodim; bifenox+fenoxaprop; bifenox+tebutam; bifenox+glyphosate; bifenox+glufosinate; bifenox+sulfosate, chlomitrofen+dimethachlor; chlomitrofen+propaquizafop; chlomitrofen+clomazone; chlomitrofen+napropamide; chlomitrofen+quinmerac; chlomitrofen+metazachlor; chlomitrofen+carbetamide; chlomitrofen+dimefuron; chlomitrofen+propyzamide; chlomitrofen+clopyralid; chlomitrofen+ethametsulfuron; chlomitrofen+sethoxydim; chlomitrofen+fluazifop; chlomitrofen+quizalofop; chlomitrofen+clethodim; chlomitrofen+fenoxaprop; chlomitrofen+tebutam; chlomitrofen+glyphosate; chlomitrofen +glufosinate; chlomitrofen+sulfosate; ethoxyfen+dimethachlor; ethoxyfen+propaquizafop; ethoxyfen+clomazone; ethoxyfen+napropamide; ethoxyfen+quinmerac; ethoxyfen+metazachlor; ethoxyfen+carbetamide; ethoxyfen+dimefuron; ethoxyfen+propyzamide; ethoxyfen+clopyralid; ethoxyfen+ethametsulfuron; ethoxyfen+sethoxydim; ethoxyfen+fluazifop; ethoxyfen+quizalofop; ethoxyfen+clethodim; ethoxyfen+fenoxaprop; ethoxyfen+tebutam; ethoxyfen+glyphosate; ethoxyfen+glufosinate; ethoxyfen+sulfosate; fluoroglycofen+dimethachlor; fluoroglycofen+propaquizafop; fluoroglycofen+clomazone; fluoroglycofen+napropamide; fluoroglycofen+quinmerac; fluoroglycofen+metazachlor; fluoroglycofen+carbetamide; fluoroglycofen+dimefuron; fluoroglycofen+propyzamide; fluoroglycofen+clopyralid; fluoroglycofen+ethametsulfuron; fluoroglycofen+sethoxydim; fluoroglycofen+fluazifop; fluoroglycofen+quizalofop; fluoroglycofen+clethodim; fluoroglycofen+fenoxaprop; fluoroglycofen+tebutam; fluoroglycofen+glyphosate; fluoroglycofen+glufosinate; fluoroglycofen+sulfosate; fomesafen+dimethachlor; fomesafen+propaquizafop; fomesafen+clomazone; fomesafen+napropamide; fomesafen+quinmerac; fomesafen+metazachlor; fomesafen +carbetamide; fomesafen+dimefuron; fomesafen+propyzamide; fomesafen+clopyralid; fomesafen+ethametsulfuron; fomesafen+sethoxydim; fomesafen+fluazifop; fomesafen +quizalofop; fomesafen+clethodim; fomesafen+fenoxaprop; fomesafen+tebutam; fomesafen+glyphosate; fomesafen+glufosinate; fomesafen+sulfosate; lactofen+dimethachlor; lactofen+propaquizafop; lactofen+clomazone; lactofen+napropamide; lactofen+quinmerac; lactofen+metazachlor; lactofen+carbetamide; lactofen+dimefuron; lactofen+propyzamide; lactofen+clopyralid; lactofen+ethametsulfuron; lactofen+sethoxydim; lactofen+fluazifop; lactofen+quizalofop; lactofen+clethodim; lactofen+fenoxaprop; lactofen+tebutam; lactofen+glyphosate; lactofen+glufosinate; lactofen+sulfosate; oxyfluorfen+dimethachlor; oxyfluorfen+propaquizafop; oxyfluorfen+clomazone; oxyfluorfen+napropamide; oxyfluorfen+quinmerac; oxyfluorfen+metazachlor; oxyfluorfen+carbetamide; oxyfluorfen+dimefuron; oxyfluorfen+propyzamide; oxyfluorfen+clopyralid; oxyfluorfen+ethametsulfuron; oxyfluorfen+sethoxydim; oxyfluorfen+fluazifop; oxyfluorfen+quizalofop; oxyfluorfen+clethodim; oxyfluorfen+fenoxaprop; oxyfluorfen+tebutam; oxyfluorfen+glyphosate; oxyfluorfen+glufosinate; oxyfluorfen+sulfosate; azafenidin+dimethachlor; azafenidin+propaquizafop; azafenidin+clomazone; azafenidin+napropamide; azafenidin+quinmerac; azafenidin+metazachlor; azafenidin+carbetamide; azafenidin+dimefuron; azafenidin+propyzamide; azafenidin+clopyralid; azafenidin+ethametsulfuron; azafenidin+sethoxydim; azafenidin +fluazifop; azafenidin+quizalofop; azafenidin+clethodim; azafenidin+fenoxaprop; azafenidin+tebutam; azafenidin+glyphosate; azafenidin+glufosinate; azafenidin+sulfosate; carfentrazone-ethyl+dimethachlor; carfentrazone-ethyl+propaquizafop; carfentrazone-ethyl+clomazone; carfentrazone-ethyl+napropamide; carfentrazone-ethyl+quinmerac; carfentrazone-ethyl+metazachlor; carfentrazone-ethyl+carbetamide; carfentrazone-ethyl+dimefuron; carfentrazone-ethyl+propyzamide; carfentrazone-ethyl+clopyralid; carfentrazone-ethyl+ethametsulfuron; carfentrazone-ethyl+sethoxydim; carfentrazone-ethyl+fluazifop; carfentrazone-ethyl+quizalofop; carfentrazone-ethyl+clethodim; carfentrazone-ethyl+fenoxaprop; carfentrazone-ethyl+tebutam; carfentrazone-ethyl+glyphosate; carfentrazone-ethyl+glufosinate; carfentrazone-ethyl+sulfosate; compound of the formula A+dimethachlor; compound of the formula A+propaquizafop; compound of the formula A+clomazone; compound of the formula A+napropamide; compound of the formula A+quinmerac; compound of the formula A+metazachlor; compound of the formula A+carbetamide; compound of the formula A+dimefuron; compound of the formula A+propyzamide; compound of the formula A+clopyralid; compound of the formula A+ethametsulfuron; compound of the formula A+sethoxydim; compound of the formula A+fluazifop; compound of the formula A+quizalofop; compound of the formula A+clethodim; compound of the formula A+fenoxaprop; compound of the formula A+tebutam; compound of the formula A+glyphosate; compound of the formula A +glufosinate; compound of the formula A+sulfosate; cinidon-ethyl+dimethachlor; cinidon-ethyl+propaquizafop; cinidon-ethyl+clomazone; cinidon-ethyl+napropamide; cinidon-ethyl+quinmerac; cinidon-ethyl+metazachlor; cinidon-ethyl+carbetamide; cinidon-ethyl+dimefuron; cinidon-ethyl+propyzamide; cinidon-ethyl+clopyralid; cinidon-ethyl+ethametsulfuron; cinidon-ethyl+sethoxydim; cinidon-ethyl+fluazifop; cinidon-ethyl+quizalofop; cinidon-ethyl+clethodim; cinidon-ethyl+fenoxaprop; cinidon-ethyl+tebutam; cinidon-ethyl+glyphosate; cinidon-ethyl+glufosinate; cinidon-ethyl+sulfosate; flumiclorac-pentyl+dimethachlor; flumiclorac-pentyl+propaquizafop; flumiclorac-pentyl+clomazone; flumiclorac-pentyl+napropamide; flumiclorac-pentyl+quinmerac; flumiclorac-pentyl+metazachlor; flumiclorac-pentyl+carbetamide; flumiclorac-pentyl+dimefuron; flumiclorac-pentyl+propyzamide; flumiclorac-pentyl+clopyralid; flumiclorac-pentyl+ethametsulfuron; flumiclorac-pentyl+sethoxydim; flumiclorac-pentyl+fluazifop; flumiclorac-pentyl+quizalofop; flumiclorac-pentyl+clethodim; flumiclorac-pentyl+fenoxaprop; flumiclorac-pentyl+tebutam; flumiclorac-pentyl+glyphosate; glufosinate; flumiclorac-pentyl +sulfosate; flumioxazin+dimethachlor; flumioxazin+propaquizafop; flumioxazin+clomazone; flumioxazin+napropamide; flumioxazin+quinmerac; flumioxazin+metazachlor; flumioxazin+carbetamide; flumioxazin+dimefuron; flumioxazin+propyzamide; flumioxazin+clopyralid; flumioxazin+ethametsulfuron; flumioxazin+sethoxydim; flumioxazin+fluazifop; flumioxazin+quizalofop; flumioxazin+clethodim; flumioxazin+fenoxaprop; flumioxazin+tebutam; flumioxazin+glyphosate; flumioxazin+glufosinate; flumioxazin+sulfosate; fluthiacet-methyl+dimethachlor; fluthiacet-methyl+propaquizafop; fluthiacet-methyl+clomazone; fluthiacet-methyl+napropamide; fluthiacet-methyl+quinmerac; fluthiacet-methyl+metazachlor; fluthiacet-methyl+carbetamide; fluthiacet-methyl+dimefuron; fluthiacet-methyl+propyzamide; fluthiacet-methyl+clopyralid; fluthiacet-methyl+ethametsulfuron; fluthiacet-methyl+sethoxydim; fluthiacet-methyl+fluazifop; fluthiacet-methyl+quizalofop; fluthiacet-methyl+clethodim; fluthiacet-methyl+fenoxaprop; fluthiacet-methyl+tebutam; fluthiacet-methyl+glyphosate; fluthiacet-methyl+glufosinate; fluthiacet-methyl+sulfosate; oxadiargyl+dimethachlor; oxadiargyl+propaquizafop; oxadiargyl+clomazone; oxadiargyl+napropamide; oxadiargyl+quinmerac; oxadiargyl+metazachlor; oxadiargyl+carbetamide; oxadiargyl+dimefuron; oxadiargyl+propyzamide; oxadiargyl+clopyralid; oxadiargyl+ethametsulfuron; oxadiargyl+sethoxydim; oxadiargyl+fluazifop; oxadiargyl+quizalofop; oxadiargyl+clethodim; oxadiargyl+fenoxaprop; oxadiargyl+tebutam; oxadiargyl+glyphosate; oxadiargyl+glufosinate; oxadiargyl+sulfosate; oxadiazon+dimethachlor; oxadiazon+propaquizafop; oxadiazon+clomazone; oxadiazon+napropamide; oxadiazon+quinmerac; oxadiazon+metazachlor; oxadiazon+carbetamide; oxadiazon+dimefuron; oxadiazon+propyzamide; oxadiazon+clopyralid; oxadiazon+ethametsulfuron; oxadiazon+sethoxydim; oxadiazon+fluazifop; oxadiazon+quizalofop; oxadiazon+clethodim; oxadiazon+fenoxaprop; oxadiazon+tebutam; oxadiazon+glyphosate; oxadiazon+glufosinate; oxadiazon+sulfosate; pentoxazone+dimethachlor; pentoxazone+propaquizafop; pentoxazone+clomazone; pentoxazone+napropamide; pentoxazone+quinmerac; pentoxazone+metazachlor; pentoxazone+carbetamide; pentoxazone+dimefuron; pentoxazone+propyzamide; pentoxazone+clopyralid; pentoxazone+ethametsulfuron; pentoxazone+sethoxydim; pentoxazone+fluazifop; pentoxazone+quizalofop; pentoxazone+clethodim; pentoxazone+fenoxaprop; pentoxazone+tebutam; pentoxazone+glyphosate; pentoxazone+glufosinate; pentoxazone+sulfosate; sulfentrazone+dimethachlor; sulfentrazone+propaquizafop; sulfentrazone+clomazone; sulfentrazone+napropamide; sulfentrazone+quinmerac; sulfentrazone+metazachlor; sulfentrazone+carbetamide; sulfentrazone+dimefuron; sulfentrazone+propyzamide; sulfentrazone+clopyralid; sulfentrazone+ethametsulfuron; sulfentrazone+sethoxydim; sulfentrazone+fluazifop; sulfentrazone+quizalofop; sulfentrazone+clethodim; sulfentrazone+fenoxaprop; sulfentrazone+tebutam; sulfentrazone+glyphosate; sulfentrazone+glufosinate; sulfentrazone+sulfosate; fluazolate+dimethachlor; fluazolate+propaquizafop; fluazolate +clomazone; fluazolate+napropamide; fluazolate+quinmerac; fluazolate+metazachlor; fluazolate+carbetamide; fluazolate+dimefuron; fluazolate+propyzamide; fluazolate+clopyralid; fluazolate+ethametsulfuron; fluazolate+sethoxydim; fluazolate+fluazifop; fluazolate+quizalofop; fluazolate+clethodim; fluazolate+fenoxaprop; fluazolate+tebutam; fluazolate+glyphosate; fluazolate+glufosinate; fluazolate+sulfosate; pyraflufen-ethyl+dimethachlor; pyraflufen-ethyl+propaquizafop; pyraflufen-ethyl+clomazone; pyraflufen-ethyl+napropamide; pyraflufen-ethyl+quinmerac; pyraflufen-ethyl+metazachlor; pyraflufen-ethyl+carbetamide; pyraflufen-ethyl+dimefuron; pyraflufen-ethyl +propyzamide; pyraflufen-ethyl+clopyralid; pyraflufen-ethyl+ethametsulfuron; pyraflufen-ethyl+sethoxydim; pyraflufen-ethyl+fluazifop; pyraflufen-ethyl+quizalofop; pyraflufen-ethyl+clethodim; pyraflufen-ethyl+fenoxaprop; pyraflufen-ethyl+tebutam; pyraflufen-ethyl+glyphosate; pyraflufen-ethyl+glufosinate; sulfosate; flumipropyn+dimethachlor; flumipropyn+propaquizafop; flumipropyn+clomazone; flumipropyn+napropamide; flumipropyn+quinmerac; flumipropyn+metazachlor; flumipropyn+carbetamide; flumipropyn+dimefuron; flumipropyn+propyzamide; flumipropyn+clopyralid; flumipropyn +ethametsulfuron; flumipropyn+sethoxydim; flumipropyn+fluazifop; flumipropyn+quizalofop; flumipropyn+clethodim; flumipropyn+fenoxaprop; flumipropyn+tebutam; pyraflufen-ethyl+glyphosate; pyraflufen-ethyl+glufosinate; pyraflufen-ethyl+sulfosate; flupropacil+dimethachlor; flupropacil+propaquizafop; flupropacil+clomazone; flupropacil +napropamide; flupropacil+quinmerac; flupropacil+metazachlor; flupropacil+carbetamide; flupropacil+dimefuron; flupropacil+propyzamide; flupropacil+clopyralid; flupropacil+ethametsulfuron; flupropacil+sethoxydim; flupropacil+fluazifop; flupropacil+quizalofop; flupropacil+clethodim; flupropacil+fenoxaprop; flupropacil+tebutam; pyraflufen-ethyl+glyphosate; pyraflufen-ethyl+glufosinate; pyraflufen-ethyl+sulfosate; nipyraclofen+dimethachlor; nipyraclofen+propaquizafop; nipyraclofen+clomazone; nipyraclofen+napropamide; nipyraclofen+quinmerac; nipyraclofen+metazachlor; nipyraclofen+carbetamide; nipyraclofen+dimefuron; nipyraclofen+propyzamide; nipyraclofen+clopyralid; nipyraclofen+ethametsulfuron; nipyraclofen+sethoxydim; nipyraclofen+fluazifop; nipyraclofen+quizalofop; nipyraclofen+clethodim; nipyraclofen+fenoxaprop; nipyraclofen+tebutam; nipyraclofen+glyphosate; nipyraclofen+glufosinate; nipyraclofen+sulfosate; benzfendizone+dimethachlor; benzfendizone+propaquizafop; benzfendizone+clomazone; benzfendizone+napropamide; benzfendizone+quinmerac; benzfendizone+metazachlor; benzfendizone+carbetamide; benzfendizone+dimefuron; benzfendizone+propyzamide; benzfendizone+clopyralid; benzfendizone+ethametsulfuron; benzfendizone+sethoxydim; benzfendizone+fluazifop; benzfendizone+quizalofop; benzfendizone+clethodim; benzfendizone+fenoxaprop; benzfendizone+tebutam; benzfendizone+glyphosate; benzfendizone+glufosinate; benzfendizone+sulfosate; thidiazimin+dimethachlor; thidiazimin+propaquizafop; thidiazimin+clomazone; thidiazimin+napropamide; thidiazimin+quinmerac; thidiazimin+metazachlor; thidiazimin+carbetamide; thidiazimin+dimefuron; thidiazimin+propyzamide; thidiazimin+clopyralid; thidiazimin+ethametsulfuron; thidiazimin+sethoxydim; thidiazimin+fluazifop; thidiazimin +quizalofop; thidiazimin+clethodim; thidiazimin+fenoxaprop; thidiazimin+tebutam; thidiazimin+glyphosate; thidiazimin+glufosinate; and thidiazimin+sulfosate.

The following combinations of the compounds under a) with the co-herbicides under b) have been found to be very particularly effective synergistic compositions in crops of cotton resistant to protoporphyrinogen oxidase inhibitors:

acifluorfen+fluometuron; acifluorfen+prometryn; acifluorfen+metolachlor; acifluorfen+(S)-metolachlor; acifluorfen+norflurazon; acifluorfen+propaquizafop; acifluorfen+pyrithiobac; acifluorfen+trifluralin; acifluorfen+pendimethalin; acifluorfen+bromoxynil; acifluorfen+clomazone; acifluorfen+MSMA; acifluorfen+DMSA; acifluorfen+fluazifop; acifluorfen+quizalofop; acifluorfen+fenoxaprop; acifluorfen+sethoxydim; acifluorfen+clethodim; acifluorfen+diuron; acifluorfen+cyanazine; acifluorfen+glyphosate; acifluorfen +glufosinate; acifluorfen+sulfosate; acifluorfen+alachlor; acifluorfen+acetochlor; acifluorfen+flurochloridone; acifluorfen+dithiopyr; acifluorfen+thiazopyr; acifluorfen+lactofen; acifluorfen+oxyfluorfen; acifluorfen+ethalfluralin; acifluorfen+compound of the formula C; aclonifen+fluometuron; aclonifen+prometryn; aclonifen+metolachlor; aclonifen+(S)-metolachlor; aclonifen+norflurazon; aclonifen+propaquizafop; aclonifen+pyrithiobac; aclonifen+trifluralin; aclonifen+pendimethalin; aclonifen+bromoxynil; aclonifen+clomazone; aclonifen+MSMA; aclonifen+DMSA; aclonifen+fluazifop; aclonifen+quizalofop; aclonifen+fenoxaprop; aclonifen+sethoxydim; aclonifen+clethodim; aclonifen+diuron; aclonifen+cyanazine; aclonifen+glyphosate; aclonifen+glufosinate; aclonifen+sulfosate; aclonifen+alachlor; aclonifen+acetochlor; aclonifen+flurochloridone; aclonifen+dithiopyr; aclonifen+thiazopyr; aclonifen+lactofen; aclonifen+oxyfluorfen; aclonifen+ethalfluralin; aclonifen+compound of the formula C; bifenox+fluometuron; bifenox+prometryn; bifenox+metolachlor; bifenox+(S)-metolachlor; bifenox +norflurazon; bifenox+propaquizafop; bifenox+pyrithiobac; bifenox+trifluralin; bifenox+pendimethalin; bifenox+bromoxynil; bifenox+clomazone; bifenox+MSMA; bifenox+DMSA; bifenox+fluazifop; bifenox+quizalofop; bifenox+fenoxaprop; bifenox+sethoxydim; bifenox+clethodim; bifenox+diuron; bifenox+cyanazine; bifenox+glyphosate; bifenox+glufosinate; bifenox+sulfosate; bifenox+alachlor; bifenox+acetochlor; bifenox+flurochloridone; bifenox+dithiopyr; bifenox+thiazopyr; bifenox+lactofen; bifenox+oxyfluorfen; bifenox+ethalfluralin; bifenox+compound of the formula C; chlomitrofen+fluometuron; chlomitrofen+prometryn; chlomitrofen+metolachlor; chlomitrofen+(S)-metolachlor; chlomitrofen+norflurazon; chlomitrofen+propaquizafop; chlomitrofen+pyrithiobac; chlomitrofen+trifluralin; chlomitrofen+pendimethalin; chlomitrofen+bromoxynil; chlomitrofen+clomazone; chlomitrofen+MSMA; chlomitrofen+DMSA; chlomitrofen+fluazifop; chlomitrofen+quizalofop; chlomitrofen+fenoxaprop; chlomitrofen+sethoxydim; chlomitrofen+clethodim; chlomitrofen+diuron; chlomitrofen+cyanazine; chlomitrofen+alachlor; chlomitrofen+acetochlor; chlomitrofen+flurochloridone; chlomitrofen+dithiopyr; chlomitrofen+thiazopyr; chlomitrofen+lactofen; chlomitrofen+oxyfluorfen; chlomitrofen+ethalfluralin; chlomitrofen+compound of the formula C; chlomitrofen+glyphosate; chlomitrofen+glufosinate; chlomitrofen+sulfosate; ethoxyfen+fluometuron; ethoxyfen+prometryn; ethoxyfen+metolachlor; ethoxyfen+(S)-metolachlor; ethoxyfen+norflurazon; ethoxyfen+propaquizafop; ethoxyfen+pyrithiobac; ethoxyfen+trifluralin; ethoxyfen+pendimethalin; ethoxyfen+bromoxynil; ethoxyfen+clomazone; ethoxyfen+MSMA; ethoxyfen+DMSA; ethoxyfen+fluazifop; ethoxyfen+quizalofop; ethoxyfen+fenoxaprop; ethoxyfen+sethoxydim; ethoxyfen+clethodim; ethoxyfen+diuron; ethoxyfen+cyanazine; ethoxyfen+alachlor; ethoxyfen+acetochlor; ethoxyfen+flurochloridone; ethoxyfen+dithiopyr; ethoxyfen+thiazopyr; ethoxyfen+lactofen; ethoxyfen+oxyfluorfen; ethoxyfen+ethalfluralin; ethoxyfen+compound of the formula C; ethoxyfen+glyphosate; ethoxyfen+glufosinate; ethoxyfen+sulfosate; fluoroglycofen+fluometuron; fluoroglycofen+prometryn; fluoroglycofen+metolachlor; fluoroglycofen+(S)-metolachlor; fluoroglycofen+norflurazon; fluoroglycofen+propaquizafop; fluoroglycofen+pyrithiobac; fluoroglycofen+trifluralin; fluoroglycofen+pendimethalin; fluoroglycofen+bromoxynil; fluoroglycofen+clomazone; fluoroglycofen+MSMA; fluoroglycofen+DMSA; fluoroglycofen+fluazifop; fluoroglycofen+quizalofop; fluoroglycofen+fenoxaprop; fluoroglycofen+sethoxydim; fluoroglycofen+clethodim; fluoroglycofen+diuron; fluoroglycofen+cyanazine; fluoroglycofen+alachlor; fluoroglycofen+acetochlor; fluoroglycofen+flurochloridone; fluoroglycofen+dithiopyr; fluoroglycofen+thiazopyr; fluoroglycofen+lactofen; fluoroglycofen+oxyfluorfen; fluoroglycofen+ethalfluralin; fluoroglycofen+compound of the formula C; fluoroglycofen+glyphosate; fluoroglycofen+glufosinate; fluoroglycofen+sulfosate; fomesafen+fluometuron; fomesafen+prometryn; fomesafen+metolachlor; fomesafen+(S)-metolachlor; fomesafen+norflurazon; fomesafen+propaquizafop; fomesafen+pyrithiobac; fomesafen+trifluralin; fomesafen+pendimethalin; fomesafen+bromoxynil; fomesafen+clomazone; fomesafen+MSMA; fomesafen+DMSA; fomesafen+fluazifop; fomesafen+quizalofop; fomesafen+fenoxaprop; fomesafen+sethoxydim; fomesafen+clethodim; fomesafen+diuron; fomesafen+cyanazine; fomesafen+alachlor; fomesafen+acetochlor; fomesafen+flurochloridone; fomesafen+dithiopyr; fomesafen+thiazopyr; fomesafen+lactofen; fomesafen+oxyfluorfen; fomesafen+ethalfluralin; fomesafen+compound of the formula C; fomesafen+glyphosate; fomesafen+glufosinate; fomesafen +sulfosate; lactofen+fluometuron; lactofen+prometryn; lactofen+metolachlor; lactofen+(S)-metolachlor; lactofen+norflurazon; lactofen+propaquizafop; lactofen+pyrithiobac; lactofen+trifluralin; lactofen+pendimethalin; lactofen+bromoxynil; lactofen+clomazone; lactofen+MSMA; lactofen+DMSA; lactofen+fluazifop; lactofen+quizalofop; lactofen+fenoxaprop; lactofen+sethoxydim; lactofen+clethodim; lactofen+diuron; lactofen+cyanazine; lactofen+alachlor; lactofen+acetochlor; lactofen+flurochloridone; lactofen+dithiopyr; lactofen+thiazopyr; lactofen+oxyfluorfen; lactofen+ethalfluralin; lactofen+compound of the formula C; lactofen+glyphosate; lactofen+glufosinate; lactofen+sulfosate; oxyfluorfen+fluometuron; oxyfluorfen+prometryn; oxyfluorfen+metolachlor; oxyfluorfen+(S)-metolachlor; oxyfluorfen+norflurazon; oxyfluorfen+propaquizafop; oxyfluorfen+pyrithiobac; oxyfluorfen+trifluralin; oxyfluorfen+pendimethalin; oxyfluorfen+bromoxynil; oxyfluorfen+clomazone; oxyfluorfen+MSMA; oxyfluorfen+DMSA; oxyfluorfen+fluazifop; oxyfluorfen+quizalofop; oxyfluorfen+fenoxaprop; oxyfluorfen+sethoxydim; oxyfluorfen+clethodim; oxyfluorfen+diuron; oxyfluorfen+cyanazine; oxyfluorfen+alachlor; oxyfluorfen+acetochlor; oxyfluorfen+flurochloridone; oxyfluorfen+dithiopyr; oxyfluorfen+thiazopyr; oxyfluorfen+lactofen; oxyfluorfen+ethalfluralin; oxyfluorfen+compound of the formula C; oxyfluorfen+glyphosate; oxyfluorfen+glufosinate; oxyfluorfen+sulfosate; azafenidin+fluometuron; azafenidin+prometryn; azafenidin+metolachlor; azafenidin+(S)-metolachlor; azafenidin+norflurazon; azafenidin +propaquizafop; azafenidin+pyrithiobac; azafenidin+trifluralin; azafenidin+pendimethalin; azafenidin+bromoxynil; azafenidin+clomazone; azafenidin+MSMA; azafenidin+DMSA; azafenidin+fluazifop; azafenidin+quizalofop; azafenidin+fenoxaprop; azafenidin+sethoxydim; azafenidin+clethodim; azafenidin+diuron; azafenidin+cyanazine; azafenidin+alachlor; azafenidin+acetochlor; azafenidin+flurochloridone; azafenidin+dithiopyr; azafenidin+thiazopyr; azafenidin+lactofen; azafenidin+oxyfluorfen; azafenidin+ethalfluralin; azafenidin+compound of the formula C; azafenidin+glyphosate; azafenidin+glufosinate; azafenidin+sulfosate; carfentrazone-ethyl+fluometuron; carfentrazone-ethyl+prometryn; carfentrazone-ethyl+metolachlor; carfentrazone-ethyl+(S)-metolachlor, carfentrazone-ethyl+norflurazon; carfentrazone-ethyl+propaquizafop; carfentrazone-ethyl+pyrithiobac; carfentrazone-ethyl+trifluralin; carfentrazone-ethyl+pendimethalin; carfentrazone-ethyl+bromoxynil; carfentrazone-ethyl +clomazone; carfentrazone-ethyl+MSMA; carfentrazone-ethyl+DMSA; carfentrazone-ethyl+fluazifop; carfentrazone-ethyl+quizalofop; carfentrazone-ethyl+fenoxaprop; carfentrazone-ethyl+sethoxydim; carfentrazone-ethyl+clethodim; carfentrazone-ethyl+diuron; carfentrazone-ethyl+cyanazine; carfentrazone-ethyl+alachlor; carfentrazone-ethyl +acetochlor, carfentrazone-ethyl+flurochloridone; carfentrazone-ethyl+dithiopyr; carfentrazone-ethyl+thiazopyr; carfentrazone-ethyl+lactofen; carfentrazone-ethyl+oxyfluorfen; carfentrazone-ethyl+ethalfluralin; carfentrazone-ethyl+compound of the formula C; carfentrazone-ethyl+glyphosate; carfentrazone-ethyl+glufosinate; carfentrazone-ethyl+sulfosate; compound of the formula A+fluometuron; compound of the formula A+prometryn; compound of the formula A+metolachlor; compound of the formula A+(S)-metolachlor; compound of the formula A+norflurazon; compound of the formula A+propaquizafop; compound of the formula A+pyrithiobac; compound of the formula A+trifluralin; compound of the formula A+pendimethalin; compound of the formula A+bromoxynil; compound of the formula A+clomazone; compound of the formula A+MSMA; compound of the formula A+DMSA; compound of the formula A+fluazifop; compound of the formula A+quizalofop; compound of the formula A+fenoxaprop; compound of the formula A+sethoxydim; compound of the formula A+clethodim; compound of the formula A+diuron; compound of the formula A+cyanazine; compound of the formula A+alachlor; compound of the formula A+acetochlor; compound of the formula A+flurochloridone; compound of the formula A+dithiopyr; compound of the formula A+thiazopyr; compound of the formula A+lactofen; compound of the formula A+oxyfluorfen; compound of the formula A+ethalfluralin; compound of the formula A+compound of the formula C; compound of the formula A+glyphosate; compound of the formula A+glufosinate; compound of the formula A+sulfosate; cinidon-ethyl+fluometuron; cinidon-ethyl+prometryn; cinidon-ethyl+metolachlor; cinidon-ethyl+(S)-metolachlor; cinidon-ethyl +norflurazon; cinidon-ethyl+propaquizafop; cinidon-ethyl+pyrithiobac; cinidon-ethyl+trifluralin; cinidon-ethyl+pendimethalin; cinidon-ethyl+bromoxynil; cinidon-ethyl+clomazone; cinidon-ethyl+MSMA; cinidon-ethyl+DMSA; cinidon-ethyl+fluazifop; cinidon-ethyl+quizalofop; cinidon-ethyl+fenoxaprop; cinidon-ethyl+sethoxydim; cinidon-ethyl+clethodim; cinidon-ethyl+diuron; cinidon-ethyl+cyanazine; cinidon-ethyl+alachlor; cinidon-ethyl+acetochlor; cinidon-ethyl+flurochloridone; cinidon-ethyl+dithiopyr; cinidon-ethyl+thiazopyr; cinidon-ethyl+lactofen; cinidon-ethyl+oxyfluorfen; cinidon-ethyl+ethalfluralin; cinidon-ethyl+compound of the formula C; cinidon-ethyl+glyphosate; cinidon-ethyl+glufosinate; cinidon-ethyl+sulfosate; flumiclorac-pentyl+fluometuron; flumiclorac-pentyl+prometryn; flumiclorac-pentyl+metolachlor; flumiclorac-pentyl+(S)-metolachlor; flumiclorac-pentyl+norflurazon; flumiclorac-pentyl+propaquizafop; flumiclorac-pentyl+pyrithiobac; flumiclorac-pentyl+trifluralin; flumiclorac-pentyl+pendimethalin; flumiclorac-pentyl+bromoxynil; flumiclorac-pentyl+clomazone; flumiclorac-pentyl+MSMA; flumiclorac-pentyl+DMSA; flumiclorac-pentyl+fluazifop; flumiclorac-pentyl +quizalofop; flumiclorac-pentyl+fenoxaprop; flumiclorac-pentyl+sethoxydim; flumiclorac-pentyl+clethodim; flumiclorac-pentyl+diuron; flumiclorac-pentyl+cyanazine; flumiclorac-pentyl+alachlor; flumiclorac-pentyl+acetochlor; flumiclorac-pentyl+flurochloridone; flumiclorac-pentyl+dithiopyr; flumiclorac-pentyl+thiazopyr; flumiclorac-pentyl+lactofen; flumiclorac-pentyl+oxyfluorfen; flumiclorac-pentyl+ethalfluralin; flumiclorac-pentyl+compound of the formula C; flumiclorac-pentyl+glyphosate; flumiclorac-pentyl+glufosinate; flumiclorac-pentyl+sulfosate; flumioxazin+fluometuron; flumioxazin+prometryn; flumioxazin+metolachlor; flumioxazin+(S)-metolachlor; flumioxazin+norflurazon; flumioxazin+propaquizafop; flumioxazin+pyrithiobac; flumioxazin+Trifluralin; flumioxazin+pendimethalin; flumioxazin+bromoxynil; flumioxazin+clomazone; flumioxazin+MSMA; flumioxazin+DMSA; flumioxazin+fluazifop; flumioxazin+quizalofop; flumioxazin+fenoxaprop; flumioxazin+sethoxydim; flumioxazin+clethodim; flumioxazin+diuron; flumioxazin+cyanazine; flumioxazin+alachlor; flumioxazin+acetochlor; flumioxazin+flurochloridone; flumioxazin+dithiopyr; flumioxazin+thiazopyr; flumioxazin+lactofen; flumioxazin+oxyfluorfen; flumioxazin+ethalfluralin; flumioxazin+compound of the formula C; flumioxazin+glyphosate; flumioxazin+glufosinate; flumioxazin+sulfosate; fluthiacet-methyl+fluometuron; fluthiacet-methyl+prometryn; fluthiacet-methyl+metolachlor; fluthiacet-methyl+(S)-metolachlor; fluthiacet-methyl+norflurazon; fluthiacet-methyl+propaquizafop; fluthiacet-methyl+pyrithiobac; fluthiacet-methyl+trifluralin; fluthiacet-methyl+pendimethalin; fluthiacet-methyl+bromoxynil; fluthiacet-methyl+clomazone; fluthiacet-methyl+MSMA; fluthiacet-methyl+DMSA; fluthiacet-methyl+fluazifop; fluthiacet-methyl+quizalofop; fluthiacet-methyl+fenoxaprop; fluthiacet-methyl+sethoxydim; fluthiacet-methyl+clethodim; fluthiacet-methyl+diuron; fluthiacet-methyl+cyanazine; fluthiacet-methyl+alachlor; fluthiacet-methyl+acetochlor, fluthiacet-methyl+flurochloridone; fluthiacet-methyl+dithiopyr; fluthiacet-methyl+thiazopyr; fluthiacet-methyl +lactofen; fluthiacet-methyl+oxyfluorfen; fluthiacet-methyl+ethalfluralin; fluthiacet-methyl +compound of the formula C; fluthiacet-methyl+glyphosate; fluthiacet-methyl+glufosinate; fluthiacet-methyl+sulfosate; oxadiargyl+fluometuron; oxadiargyl+prometryn; oxadiargyl+metolachlor; oxadiargyl+(S)-metolachlor; oxadiargyl+norflurazon; oxadiargyl +propaquizafop; oxadiargyl+pyrithiobac; oxadiargyl+trifluralin; oxadiargyl+pendimethalin; oxadiargyl+bromoxynil; oxadiargyl+clomazone; oxadiargyl+MSMA; oxadiargyl+DMSA; oxadiargyl+fluazifop; oxadiargyl+quizalofop; oxadiargyl+fenoxaprop; oxadiargyl+sethoxydim; oxadiargyl+clethodim; oxadiargyl+diuron; oxadiargyl+cyanazine; oxadiargyl+alachlor; oxadiargyl+acetochlor; oxadiargyl+flurochloridone; oxadiargyl+dithiopyr; oxadiargyl+thiazopyr; oxadiargyl+lactofen; oxadiargyl+oxyfluorfen; oxadiargyl+ethalfluralin; oxadiargyl+compound of the formula C; oxadiargyl+glyphosate; oxadiargyl+glufosinate; oxadiargyl+sulfosate; oxadiazon+fluometuron; oxadiazon+prometryn; oxadiazon+metolachlor; oxadiazon+(S)-metolachlor; oxadiazon+norflurazon; oxadiazon+propaquizafop; oxadiazon+pyrithiobac; oxadiazon+trifluralin; oxadiazon+pendimethalin; oxadiazon+bromoxynil; oxadiazon+clomazone; oxadiazon+MSMA; oxadiazon+DMSA; oxadiazon+fluazifop; oxadiazon+quizalofop; oxadiazon+fenoxaprop; oxadiazon+sethoxydim; oxadiazon+clethodim; oxadiazon+diuron; oxadiazon+cyanazine; oxadiazon+alachlor; oxadiazon+acetochlor; oxadiazon+flurochloridone; oxadiazon+dithiopyr; oxadiazon+thiazopyr; oxadiazon+lactofen; oxadiazon+oxyfluorfen; oxadiazon+ethalfluralin; oxadiazon+compound of the formula C; oxadiazon+glyphosate; oxadiazon+glufosinate; oxadiazon+sulfosate; pentoxazone+fluometuron; pentoxazone+prometryn; pentoxazone+metolachlor; pentoxazone+(S)-metolachlor; pentoxazone+norflurazon; pentoxazone+propaquizafop; pentoxazone+pyrithiobac; pentoxazone+trifluralin; pentoxazone+pendimethalin; pentoxazone+bromoxynil; pentoxazone+clomazone; pentoxazone+MSMA; pentoxazone +DMSA; pentoxazone+fluazifop; pentoxazone+quizalofop; pentoxazone+fenoxaprop; pentoxazone+sethoxydim; pentoxazone+clethodim; pentoxazone+diuron; pentoxazone +cyanazine; pentoxazone+alachlor; pentoxazone+acetochlor; pentoxazone+flurochloridone; pentoxazone+dithiopyr; pentoxazone+thiazopyr; pentoxazone+lactofen; pentoxazone+oxyfluorfen; pentoxazone+ethalfluralin; pentoxazone+compound of the formula C; pentoxazone+glyphosate; pentoxazone+glufosinate; pentoxazone+sulfosate; sulfentrazone+fluometuron; sulfentrazone+prometryn; sulfentrazone+metolachlor; sulfentrazone+(S)-metolachlor; sulfentrazone+norflurazon; sulfentrazone+propaquizafop; sulfentrazone+pyrithiobac; sulfentrazone+trifluralin; sulfentrazone+pendimethalin; sulfentrazone+bromoxynil; sulfentrazone+clomazone; sulfentrazone+MSMA; sulfentrazone+DMSA; sulfentrazone+fluazifop; sulfentrazone+quizalofop; sulfentrazone+fenoxaprop; sulfentrazone+sethoxydim; sulfentrazone+clethodim; sulfentrazone+diuron; sulfentrazone+cyanazine; sulfentrazone+alachlor, sulfentrazone +acetochlor; sulfentrazone+flurochloridone; sulfentrazone+dithiopyr; sulfentrazone+thiazopyr; sulfentrazone+lactofen; sulfentrazone+oxyfluorfen; sulfentrazone+ethalfluralin; sulfentrazone+compound of the formula C; sulfentrazone+glyphosate; sulfentrazone+glufosinate; sulfentrazone+sulfosate; fluazolate+fluometuron; fluazolate +prometryn; fluazolate+metolachlor; fluazolate+(S)-metolachlor; fluazolate+norflurazon; fluazolate+propaquizafop; fluazolate+pyrithiobac; fluazolate+trifluralin; fluazolate+pendimethalin; fluazolate+bromoxynil; fluazolate+clomazone; fluazolate+MSMA; fluazolate+DMSA; fluazolate+fluazifop; fluazolate+quizalofop; fluazolate+fenoxaprop; fluazolate+Sethoxydim; fluazolate+clethodim; fluazolate+diuron; fluazolate+cyanazine; fluazolate+alachlor; fluazolate+acetochlor; fluazolate+flurochloridone; fluazolate+dithiopyr; fluazolate+thiazopyr; fluazolate+lactofen; fluazolate+oxyfluorfen; fluazolate+ethalfluralin; fluazolate+compound of the formula C; fluazolate+glyphosate; fluazolate+glufosinate; fluazolate+sulfosate; pyraflufen-ethyl+fluometuron; pyraflufen-ethyl+prometryn; pyraflufen-ethyl+metolachlor; pyraflufen-ethyl+(S)-metolachlor; pyraflufen-ethyl+norflurazon; pyraflufen-ethyl+propaquizafop; pyraflufen-ethyl+pyrithiobac; pyraflufen-ethyl+trifluralin; pyraflufen-ethyl+pendimethalin; pyraflufen-ethyl+bromoxynil; pyraflufen-ethyl+clomazone; pyraflufen-ethyl+MSMA; pyraflufen-ethyl+DMSA; pyraflufen-ethyl+fluazifop; pyraflufen-ethyl+quizalofop; pyraflufen-ethyl+fenoxaprop; pyraflufen-ethyl+Sethoxydim; pyraflufen-ethyl+clethodim; pyraflufen-ethyl+diuron; pyraflufen-ethyl+cyanazine; pyraflufen-ethyl+alachlor; pyraflufen-ethyl+acetochlor; pyraflufen-ethyl+flurochloridone; pyraflufen-ethyl+dithiopyr; pyraflufen-ethyl+thiazopyr; pyraflufen-ethyl+lactofen; pyraflufen-ethyl+oxyfluorfen; pyraflufen-ethyl+ethalfluralin; pyraflufen-ethyl+compound of the formula C; pyraflufen-ethyl+glyphosate; pyraflufen-ethyl+glufosinate; pyraflufen-ethyl+sulfosate; flumipropyn+fluometuron; flumipropyn+prometryn; flumipropyn+metolachlor; flumipropyn+(S)-metolachlor; flumipropyn+norflurazon; flumipropyn+propaquizafop; flumipropyn+pyrithiobac; flumipropyn+trifluralin; flumipropyn+pendimethalin; flumipropyn+bromoxynil; flumipropyn+clomazone; flumipropyn+MSMA; flumipropyn+DMSA; flumipropyn+fluazifop; flumipropyn+quizalofop; flumipropyn+fenoxaprop; flumipropyn+sethoxydim; flumipropyn+clethodim; flumipropyn+diuron; flumipropyn+cyanazine; flumipropyn+alachlor; flumipropyn+acetochlor; flumipropyn+flurochloridone; flumipropyn+dithiopyr; flumipropyn+thiazopyr; flumipropyn+lactofen; flumipropyn+oxyfluorfen; flumipropyn+ethalfluralin; flumipropyn+compound of the formula C; flumipropyn+glyphosate; flumipropyn+glufosinate; flumipropyn+sulfosate; flupropacil+fluometuron; flupropacil+prometryn; flupropacil+metolachlor, flupropacil+(S)-metolachlor; flupropacil+norflurazon; flupropacil+propaquizafop; flupropacil+pyrithiobac; flupropacil+trifluralin; flupropacil+pendimethalin; flupropacil+bromoxynil; flupropacil+clomazone; flupropacil+MSMA; flupropacil+DMSA; flupropacil+fluazifop; flupropacil+quizalofop; flupropacil+fenoxaprop; flupropacil+sethoxydim; flupropacil+clethodim; flupropacil+diuron; flupropacil+cyanazine; flupropacil +alachlor; flupropacil+acetochlor; flupropacil+flurochloridone; flupropacil+dithiopyr; flupropacil+thiazopyr; flupropacil+lactofen; flupropacil+oxyfluorfen; flupropacil+ethalfluralin; flupropacil+compound of the formula C; flupropacil+glyphosate; flupropacil+glufosinate; flupropacil+sulfosate; nipyraclofen+fluometuron; nipyraclofen+prometryn; nipyraclofen+metolachlor; nipyraclofen+(S)-metolachlor; nipyraclofen+norflurazon; nipyraclofen+propaquizafop; nipyraclofen+pyrithiobac; nipyraclofen+trifluralin; nipyraclofen+pendimethalin; nipyraclofen+bromoxynil; nipyraclofen+clomazone; nipyraclofen+MSMA; nipyraclofen+DMSA; nipyraclofen+fluazifop; nipyraclofen+quizalofop; nipyraclofen+fenoxaprop; nipyraclofen+sethoxydim; nipyraclofen+clethodim; nipyraclofen+diuron; nipyraclofen+cyanazine; nipyraclofen+alachlor; nipyraclofen+acetochlor; nipyraclofen+flurochloridone; nipyraclofen+dithiopyr; nipyraclofen+thiazopyr; nipyraclofen+lactofen; nipyraclofen+oxyfluorfen; nipyraclofen+ethalfluralin; nipyraclofen +compound of the formula C; nipyraclofen+glyphosate; nipyraclofen+glufosinate; nipyraclofen+sulfosate; benzfendizone+fluometuron; benzfendizone+prometryn; benzfendizone+metolachlor; benzfendizone+(S)-metolachlor; benzfendizone+norflurazon; benzfendizone+propaquizafop; benzfendizone+pyrithiobac; benzfendizone+trifluralin; benzfendizone+pendimethalin; benzfendizone+bromoxynil; benzfendizone+clomazone; benzfendizone+MSMA; benzfendizone+DMSA; benzfendizone+fluazifop; benzfendizone+quizalofop; benzfendizone+fenoxaprop; benzfendizone+sethoxydim; benzfendizone+clethodim; benzfendizone+diuron; benzfendizone+cyanazine; benzfendizone+alachlor; benzfendizone+acetochlor; benzfendizone+flurochloridone; benzfendizone+dithiopyr; benzfendizone+thiazopyr; benzfendizone+lactofen; benzfendizone+oxyfluorfen; benzfendizone+ethalfluralin; benzfendizone+compound of the formula C; benzfendizone+glyphosate; benzfendizone+glufosinate; benzfendizone+sulfosate; thidiazimin+fluometuron; thidiazimin+prometryn; thidiazimin+metolachlor; thidiazimin+(S)-metolachlor; thidiazimin+norflurazon; thidiazimin+propaquizafop; thidiazimin+pyrithiobac; thidiazimin+trifluralin; thidiazimin+pendimethalin; thidiazimin+bromoxynil; thidiazimin+clomazone; thidiazimin+MSMA; thidiazimin+DMSA; thidiazimin+fluazifop; thidiazimin+quizalofop; thidiazimin+fenoxaprop; thidiazimin+sethoxydim; thidiazimin+clethodim; thidiazimin+diuron; thidiazimin+cyanazine; thidiazimin+alachlor; thidiazimin+acetochlor; thidiazimin+flurochloridone; thidiazimin+dithiopyr; thidiazimin+thiazopyr; thidiazimin+lactofen; thidiazimin+oxyfluorfen; thidiazimin+ethalfluralin; thidiazimin+compound of the formula C; thidiazimin+glyphosate; thidiazimin+glufosinate; and thidiazimin+sulfosate.

The following combinations of the compounds under a) with the co-herbicides under b) have been found to be very particularly effective synergistic compositions in crops of sunflowers resistant to protoporphyrinogen oxidase inhibitors:

acifluorfen+metolachlor; acifluorfen+(S)-metolachlor; acifluorfen+pendimethalin; acifluorfen+aclonifen; acifluorfen+flurochloridone; acifluorfen+prometryn; acifluorfen+sethoxydim; acifluorfen+fluazifop; acifluorfen+quizalofop; acifluorfen+clethodim; acifluorfen+fenoxaprop; acifluorfen+terbutryn; acifluorfen+acetochlor; acifluorfen+trifluralin; acifluorfen+glyphosate; acifluorfen+glufosinate; acifluorfen+sulfosate; aclonifen+metolachlor; aclonifen+(S)-metolachlor; aclonifen+pendimethalin; aclonifen+flurochloridon; aclonifen+prometryn; aclonifen+sethoxydim; aclonifen+fluazifop; aclonifen+quizalofop; aclonifen+clethodim; aclonifen+fenoxaprop; aclonifen+terbutryn; aclonifen+acetochlor; aclonifen+trifiuralin; aclonifen+glyphosate; aclonifen+glufosinate; aclonifen+sulfosate; bifenox+metolachlor; bifenox+(S)-metolachlor; bifenox +pendimethalin; bifenox+aclonifen; bifenox+flurochloridon; bifenox+prometryn; bifenox +sethoxydim; bifenox+fluazifop; bifenox+quizalofop; bifenox+clethodim; bifenox+fenoxaprop; bifenox+terbutryn; bifenox+acetochlor; bifenox+trifluralin; bifenox+glyphosate; bifenox+glufosinate; bifenox+sulfosate; chlomitrofen+metolachlor; chlomitrofen+(S)-metolachlor; chlomitrofen+pendimethalin; chlomitrofen+aclonifen; chlomitrofen+flurochloridon; chlomitrofen+prometryn; chlomitrofen+sethoxydim; chlomitrofen+fluazifop; chlomitrofen+quizalofop; chlomitrofen+clethodim; chlomitrofen+fenoxaprop; chlomitrofen+terbutryn; chlomitrofen+acetochlor; chlomitrofen+trifluralin; chlomitrofen+glyphosate; chlomitrofen+glufosinate; chlomitrofen+sulfosate; ethoxyfen+metolachlor; ethoxyfen+(S)-metolachlor; ethoxyfen+pendimethalin; ethoxyfen+aclonifen; ethoxyfen+flurochloridon; ethoxyfen+prometryn; ethoxyfen+sethoxydim; ethoxyfen+fluazifop; ethoxyfen+quizalofop; ethoxyfen+clethodim; ethoxyfen+fenoxaprop; ethoxyfen+terbutryn; ethoxyfen+acetochlor; ethoxyfen+trifluralin; ethoxyfen+glyphosate; ethoxyfen+glufosinate; ethoxyfen+sulfosate; fluoroglycofen+metolachlor; fluoroglycofen+(S)-metolachlor; fluoroglycofen+pendimethalin; fluoroglycofen+aclonifen; fluoroglycofen+flurochloridon; fluoroglycofen+prometryn; fluoroglycofen+sethoxydim; fluoroglycofen+fluazifop; fluoroglycofen+quizalofop; fluoroglycofen+clethodim; fluoroglycofen+fenoxaprop; fluoroglycofen+terbutryn; fluoroglycofen+acetochlor; fluoroglycofen+trifluralin; fluoroglycofen+glyphosate; fluoroglycofen+glufosinate; fluoroglycofen+sulfosate; fomesafen+metolachlor; fomesafen+(S)-metolachlor; fomesafen+pendimethalin; fomesafen+aclonifen; fomesafen+flurochloridon; fomesafen +prometryn; fomesafen+sethoxydim; fomesafen+fluazifop; fomesafen+quizalofop; fomesafen+clethodim; fomesafen+fenoxaprop; fomesafen+terbutryn; fomesafen+acetochlor; fomesafen+trifluralin; fomesafen+glyphosate; fomesafen+glufosinate; fomesafen+sulfosate; lactofen+metolachlor; lactofen+(S)-metolachlor; lactofen+pendimethalin; lactofen+aclonifen; lactofen+flurochloridon; lactofen+prometryn; lactofen +sethoxydim; lactofen+fluazifop; lactofen+quizalofop; lactofen+clethodim; lactofen+fenoxaprop; lactofen+terbutryn; lactofen+acetochlor; lactofen+trifluralin; lactofen+glyphosate; lactofen+glufosinate; lactofen+sulfosate; oxyfluorfen+metolachlor; oxyfluorfen+(S)-metolachlor; oxyfluorfen+pendimethalin; oxyfluorfen+aclonifen; oxyfluorfen+flurochloridon; oxyfluorfen+prometryn; oxyfluorfen+sethoxydim; oxyfluorfen +fluazifop; oxyfluorfen+quizalofop; oxyfluorfen+clethodim; oxyfluorfen+fenoxaprop; oxyfluorfen+terbutryn; oxyfluorfen+acetochlor; oxyfluorfen+trifluralin; oxyfluorfen+glyphosate; oxyfluorfen+glufosinate; oxyfluorfen+sulfosate; azafenidin+metolachlor; azafenidin+(S)-metolachlor; azafenidin+pendimethalin; azafenidin+aclonifen; azafenidin +flurochloridon; azafenidin+prometryn; azafenidin+sethoxydim; azafenidin+fluazifop; azafenidin+quizalofop; azafenidin+clethodim; azafenidin+fenoxaprop; azafenidin+terbutryn; azafenidin+acetochlor; azafenidin+trifluralin; azafenidin+glyphosate; azafenidin+glufosinate; azafenidin+sulfosate; carfentrazone-ethyl+metolachlor; carfentrazone-ethyl+(S)-metolachlor; carfentrazone-ethyl+pendimethalin; carfentrazone-ethyl+aclonifen; carfentrazone-ethyl+flurochloridon; carfentrazone-ethyl+prometryn; carfentrazone-ethyl+sethoxydim; carfentrazone-ethyl+fluazifop; carfentrazone-ethyl+quizalofop; carfentrazone-ethyl+clethodim; carfentrazone-ethyl+fenoxaprop; carfentrazone-ethyl+terbutryn; carfentrazone-ethyl+acetochlor; carfentrazone-ethyl+trifluralin; carfentrazone-ethyl+glyphosate; carfentrazone-ethyl+glufosinate; carfentrazone-ethyl+sulfosate; compound of the formula A+metolachlor; compound of the formula A+(S)-metolachlor; compound of the formula A+pendimethalin; compound of the formula A+aclonifen; compound of the formula A+flurochloridon; compound of the formula A+prometryn; compound of the formula A+sethoxydim; compound of the formula A+fluazifop; compound of the formula A+quizalofop; compound of the formula A+clethodim; compound of the formula A+fenoxaprop; compound of the formula A+terbutryn; compound of the formula A+acetochlor; compound of the formula A+trifluralin; compound of the formula A+glyphosate; compound of the formula A+glufosinate; compound of the formula A+sulfosate; cinidon-ethyl+metolachlor; cinidon-ethyl+(S)-metolachlor; cinidon-ethyl+pendimethalin; cinidon-ethyl+aclonifen; cinidon-ethyl+flurochloridon; cinidon-ethyl+prometryn; cinidon-ethyl+sethoxydim; cinidon-ethyl+fluazifop; cinidon-ethyl+quizalofop; cinidon-ethyl+clethodim; cinidon-ethyl+fenoxaprop; cinidon-ethyl+terbutryn; cinidon-ethyl+acetochlor; cinidon-ethyl+trifluralin; cinidon-ethyl+glyphosate; cinidon-ethyl+glufosinate; cinidon-ethyl+sulfosate; flumiclorac-pentyl+metolachlor; flumiclorac-pentyl+(S)-metolachlor, flumiclorac-pentyl+pendimethalin; flumiclorac-pentyl+aclonifen; flumiclorac-pentyl+flurochloridon; flumiclorac-pentyl+prometryn; flumiclorac-pentyl+sethoxydim; flumiclorac-pentyl+fluazifop; flumiclorac-pentyl +quizalofop; flumiclorac-pentyl+clethodim; flumiclorac-pentyl+fenoxaprop; flumiclorac-pentyl+terbutryn; flumiclorac-pentyl+acetochlor; flumiclorac-pentyl+trifluralin; flumiclorac-pentyl+glyphosate; flumiclorac-pentyl+glufosinate; flumiclorac-pentyl+sulfosate; flumioxazin+metolachlor; flumioxazin+(S)-metolachlor; flumioxazin+pendimethalin; flumioxazin+aclonifen; flumioxazin+flurochloridon; flumioxazin+prometryn; flumioxazin+sethoxydim; flumioxazin+fluazifop; flumioxazin+quizalofop; flumioxazin+clethodim; flumioxazin+fenoxaprop; flumioxazin+terbutryn; flumioxazin+acetochlor; flumioxazin+trifluralin; flumioxazin+glyphosate; flumioxazin+glufosinate; flumioxazin+sulfosate; fluthiacet-methyl+metolachlor; fluthiacet-methyl+(S)-metolachlor; fluthiacet-methyl+pendimethalin; fluthiacet-methyl+aclonifen; fluthiacet-methyl+flurochloridon; fluthiacet-methyl+prometryn; fluthiacet-methyl+sethoxydim; fluthiacet-methyl+fluazifop; fluthiacet-methyl+quizalofop; fluthiacet-methyl+clethodim; fluthiacet-methyl+fenoxaprop; fluthiacet-methyl+terbutryn; fluthiacet-methyl+acetochlor; fluthiacet-methyl+trifluralin; fluthiacet-methyl+glyphosate; fluthiacet-methyl+glufosinate; fluthiacet-methyl+sulfosate; oxadiargyl+metolachlor; oxadiargyl+(S)-metolachlor; oxadiargyl+pendimethalin; oxadiargyl+aclonifen; oxadiargyl+flurochloridon; oxadiargyl+prometryn; oxadiargyl+sethoxydim; oxadiargyl+fluazifop; oxadiargyl+quizalofop; oxadiargyl+clethodim; oxadiargyl+fenoxaprop; oxadiargyl+terbutryn; oxadiargyl+acetochlor; oxadiargyl+trifluralin; oxadiargyl+glyphosate; oxadiargyl+glufosinate; oxadiargyl+sulfosate; oxadiazon+metolachlor; oxadiazon+(S)-metolachlor; oxadiazon+pendimethalin; oxadiazon+aclonifen; oxadiazon+flurochloridon; oxadiazon+prometryn; oxadiazon+sethoxydim; oxadiazon+fluazifop; oxadiazon+quizalofop; oxadiazon+clethodim; oxadiazon+fenoxaprop; oxadiazon+terbutryn; oxadiazon+acetochlor; oxadiazon+trifluralin; oxadiazon+glyphosate; oxadiazon+glufosinate; oxadiazon+sulfosate; pentoxazone+metolachlor; pentoxazone+(S)-metolachlor; pentoxazone+pendimethalin; pentoxazone+aclonifen; pentoxazone+flurochloridon; pentoxazone+prometryn; pentoxazone+sethoxydim; pentoxazone+fluazifop; pentoxazone+quizalofop; pentoxazone+clethodim; pentoxazone+fenoxaprop; pentoxazone+terbutryn; pentoxazone+acetochlor; pentoxazone+trifluralin; pentoxazone+glyphosate; pentoxazone+glufosinate; pentoxazone+sulfosate; sulfentrazone+metolachlor; sulfentrazone+(S)-metolachlor; sulfentrazone+pendimethalin; sulfentrazone+aclonifen; sulfentrazone+flurochloridon; sulfentrazone+prometryn; sulfentrazone+sethoxydim; sulfentrazone+fluazifop; sulfentrazone+quizalofop; sulfentrazone+clethodim; sulfentrazone+fenoxaprop; sulfentrazone+terbutryn; sulfentrazone+acetochlor; sulfentrazone+trifluralin; sulfentrazone+glyphosate; sulfentrazone+glufosinate; sulfentrazone+sulfosate; fluazolate+metolachlor; fluazolate+(S)-metolachlor; fluazolate +pendimethalin; fluazolate+aclonifen; fluazolate+flurochloridon; fluazolate+prometryn; fluazolate+sethoxydim; fluazolate+fluazifop; fluazolate+quizalofop; fluazolate+clethodim; fluazolate+fenoxaprop; fluazolate+terbutryn; fluazolate+acetochlor; fluazolate+trifluralin; fluazolate+glyphosate; fluazolate+glufosinate; fluazolate+sulfosate; pyraflufen-ethyl+metolachlor; pyraflufen-ethyl+(S)-metolachlor; pyraflufen-ethyl +pendimethalin; pyraflufen-ethyl+aclonifen; pyraflufen-ethyl+flurochloridon; pyraflufen-ethyl+prometryn; pyraflufen-ethyl+sethoxydim; pyraflufen-ethyl+fluazifop; pyraflufen-ethyl+quizalofop; pyraflufen-ethyl+clethodim; pyraflufen-ethyl+fenoxaprop; pyraflufen-ethyl+terbutryn; pyraflufen-ethyl+acetochlor; pyraflufen-ethyl+trifluralin; pyraflufen-ethyl +glyphosate; pyraflufen-ethyl+glufosinate; pyraflufen-ethyl+sulfosate; flumipropyn+metolachlor; flumipropyn+(S)-metolachlor; flumipropyn+pendimethalin; flumipropyn+aclonifen; flumipropyn+flurochloridon; flumipropyn+prometryn; flumipropyn+sethoxydim; flumipropyn+fluazifop; flumipropyn+quizalofop; flumipropyn+clethodim; flumipropyn+fenoxaprop; flumipropyn+terbutryn; flumipropyn+acetochlor; flumipropyn+trifluralin; flumipropyn+glyphosate; flumipropyn+glufosinate; flumipropyn+sulfosate; flupropacil+metolachlor; flupropacil+(S)-metolachlor; flupropacil+pendimethalin; flupropacil+aclonifen; flupropacil+flurochloridon; flupropacil+prometryn; flupropacil+sethoxydim; flupropacil+fluazifop; flupropacil+quizalofop; flupropacil+clethodim; flupropacil+fenoxaprop; flupropacil+terbutryn; flupropacil+acetochlor; flupropacil+trifluralin; flupropacil+glyphosate; flupropacil+glufosinate; flupropacil+sulfosate; nipyraclofen+metolachlor; nipyraclofen+(S)-metolachlor; nipyraclofen+pendimethalin; nipyraclofen+aclonifen; nipyraclofen+flurochloridon; nipyraclofen+prometryn; nipyraclofen+sethoxydim; nipyraclofen+fluazifop; nipyraclofen+quizalofop; nipyraclofen+clethodim; nipyraclofen+fenoxaprop; nipyraclofen+terbutryn; nipyraclofen+acetochlor; nipyraclofen +trifluralin; nipyraclofen+glyphosate; nipyraclofen+glufosinate; nipyraclofen+sulfosate; benzfendizone+metolachlor; benzfendizone+(S)-metolachlor; benzfendizone+pendimethalin; benzfendizone+aclonifen; benzfendizone+flurochloridon; benzfendizone +prometryn; benzfendizone+sethoxydim; benzfendizone+fluazifop; benzfendizone+quizalofop; benzfendizone+clethodim; benzfendizone+fenoxaprop; benzfendizone+terbutryn; benzfendizone+acetochlor; benzfendizone+trifluralin; benzfendizone+glyphosate; benzfendizone+glufosinate; benzfendizone+sulfosate; thidiazimin+metolachlor; thidiazimin+(S)-metolachlor; thidiazimin+pendimethalin; thidiazimin+aclonifen; thidiazimin+flurochloridon; thidiazimin+prometryn; thidiazimin+sethoxydim; thidiazimin+fluazifop; thidiazimin+quizalofop; thidiazimin+clethodim; thidiazimin+fenoxaprop; thidiazimin+terbutryn; thidiazimin+acetochlor; thidiazimin+trifluralin; thidiazimin+glyphosate; thidiazimin+glufosinate; and thidiazimin+sulfosate.

The following combinations of the compounds under a) with the co-herbicides under b) have been found to be very particularly effective synergistic compositions in crops of cereals resistant to protoporphyrinogen oxidase inhibitors:

acifluorfen+triasulfuron; acifluorfen+prosulfuron; acifluorfen+clodinafop; acifluorfen+terbutryne; acifluorfen+amidosulfuron; acifluorfen+bromoxynil; acifluorfen+carfentrazone; acifluorfen+dicamba; acifluorfen+diclofop-methyl; acifluorfen+diflufenican; acifluorfen+ethoxysulfuron; acifluorfen+fenoxaprop(P-ethyl); acifluorfen+fentrazamide; acifluorfen+flazasulfuron; acifluorfen+florasulam; acifluorfen+fluazolate; acifluorfen+flucarbazone; acifluorfen+flufenacet; acifluorfen+flupyrsulfuron; acifluorfen +flurtamone; acifluorfen+iodosulfuron; acifluorfen+isoproturon; acifluorfen+chlortoluron; acifluorfen+MCPA; acifluorfen+MCPB; acifluorfen+mecoprop; acifluorfen+MCPP; acifluorfen+chlorsulfuron; acifluorfen+metsulfuron; acifluorfen+sulfosulfuron; acifluorfen +thifensulfuron; acifluorfen+tribenuron; acifluorfen+2,4-D; acifluorfen+2,4-DB; acifluorfen+2,4-DP; acifluorfen+bifenox; acifluorfen+ethametsulfuron; acifluorfen+flamprop-M; acifluorfen+imazamethabenz; acifluorfen+ioxynil; acifluorfen+bromoxynil; acifluorfen+metosulam; acifluorfen+pyridate; acifluorfen+quinmerac; acifluorfen+tralkoxydim; acifluorfen+fluoroglycofen-ethyl; acifluorfen+methabenzthiazuron; acifluorfen +ethalfluralin; acifluorfen+pendimethalin; acifluorfen+trifluralin; acifluorfen+isoxaben; acifluorfen+prosulfocarb; acifluorfen+triallate; acifluorfen+clopyralid; acifluorfen+fluroxypyr; acifluorfen+benazolin-ethyl; acifluorfen+difenzoquat; acifluorfen+glyphosate; acifluorfen+glufosinate; acifluorfen+sulfosate; aclonifen+triasulfuron; aclonifen+prosulfuron; aclonifen+clodinafop; aclonifen+terbutryne; aclonifen+amidosulfuron; aclonifen+bromoxynil; aclonifen+carfentrazone; aclonifen+dicamba; aclonifen+diclofop-methyl; aclonifen+diflufenican; aclonifen+ethoxysulfuron; aclonifen+fenoxaprop(P-ethyl); aclonifen+fentrazamide; aclonifen+flazasulfuron; aclonifen+florasulam; aclonifen+fluazolate; aclonifen+flucarbazone; aclonifen+flufenacet; aclonifen+flupyrsulfuron; aclonifen+flurtamone; aclonifen+iodosulfuron; aclonifen+isoproturon; aclonifen+chlortoluron; aclonifen+MCPA; aclonifen+MCPB; aclonifen+mecoprop; aclonifen+MCPP; aclonifen+chlorsulfuron; aclonifen+metsulfuron; aclonifen +sulfosulfuron; aclonifen+thifensulfuron; aclonifen+tribenuron; aclonifen+2,4-D; aclonifen+2,4-DB; aclonifen+2,4-DP; aclonifen+bifenox; aclonifen+ethametsulfuron; aclonifen+flamprop-M; aclonifen+imazamethabenz; aclonifen+ioxynil; aclonifen+bromoxynil; aclonifen+metosulam; aclonifen+pyridate; aclonifen+quinmerac; aclonifen+tralkoxydim; aclonifen+fluoroglycofen-ethyl; aclonifen+methabenzthiazuron; aclonifen+ethalfluralin; aclonifen+pendimethalin; aclonifen+trifluralin; aclonifen+isoxaben; aclonifen+prosulfocarb; aclonifen+triallate; aclonifen+clopyralid; aclonifen+fluroxypyr; aclonifen+benazolin-ethyl; aclonifen+difenzoquat; aclonifen+glyphosate; aclonifen+glufosinate; aclonifen+sulfosate; bifenox+triasulfuron; bifenox+prosulfuron; bifenox+clodinafop; bifenox+terbutryne; bifenox+amidosulfuron; bifenox+bromoxynil; bifenox+carfentrazone; bifenox+dicamba; bifenox+diclofop-methyl; bifenox+diflufenican; bifenox +ethoxysulfuron; bifenox+fenoxaprop(P-ethyl); bifenox+fentrazamide; bifenox+flazasulfuron; bifenox+florasulam; bifenox+fluazolate; bifenox+flucarbazone; bifenox+flufenacet; bifenox+flupyrsulfuron; bifenox+flurtamone; bifenox+iodosulfuron; bifenox+isoproturon; bifenox+chlortoluron; bifenox+MCPA; bifenox+MCPB; bifenox+mecoprop; bifenox+MCPP; bifenox+chlorsulfuron; bifenox+metsulfuron; bifenox+sulfosulfuron: bifenox+thifensulfuron; bifenox+tribenuron; bifenox+2,4-D; bifenox+2,4-DB; bifenox+2,4-DP; bifenox+ethametsulfuron; bifenox+flamprop-M; bifenox+imazamethabenz; bifenox+ioxynil; bifenox+bromoxynil; bifenox+metosulam; bifenox+pyridate; bifenox+quinmerac; bifenox+tralkoxydim; bifenox+fluoroglycofen-ethyl; bifenox+methabenzthiazuron; bifenox+ethalfluralin; bifenox+pendimethalin; bifenox+trifluralin; bifenox+isoxaben; bifenox+prosulfocarb; bifenox+triallate; bifenox+clopyralid; bifenox +fluroxypyr; bifenox+benazolin-ethyl; bifenox+difenzoquat; aclonifen+glyphosate; aclonifen+glufosinate; aclonifen+sulfosate; chlomitrofen+triasulfuron; chlomitrofen+prosulfuron; chlomitrofen+clodinafop; chlomitrofen+terbutryne; chlomitrofen+amidosulfuron; chlomitrofen+bromoxynil; chlomitrofen+carfentrazone; chlomitrofen+dicamba; chlomitrofen+diclofop-methyl; chlomitrofen+diflufenican; chlomitrofen+ethoxysulfuron; chlomitrofen+fenoxaprop(P-ethyl); chlomitrofen+fentrazamide; chlomitrofen+flazasulfuron; chlomitrofen+florasulam; chlomitrofen+fluazolate; chlomitrofen+flucarbazone; chlomitrofen+flufenacet; chlomitrofen+flupyrsulfuron; chlomitrofen+flurtamone; chlomitrofen+iodosulfuron; chlomitrofen+isoproturon; chlomitrofen+chlortoluron; chlomitrofen+MCPA; chlomitrofen+MCPB; chlomitrofen+mecoprop; chlomitrofen+MCPP; chlomitrofen+chlorsulfuron; chlomitrofen+metsulfuron; chlomitrofen+sulfosulfuron; chlomitrofen+thifensulfuron; chlomitrofen+tribenuron; chlomitrofen+2,4-D; chlomitrofen+2,4-DB; chlomitrofen+2,4-DP; chlomitrofen+bifenox; chlomitrofen+ethametsulfuron; chlomitrofen+flamprop-M; chlomitrofen+imazamethabenz; chlomitrofen+ioxynil; chlomitrofen+bromoxynil; chlomitrofen+metosulam; chlomitrofen+pyridate; chlomitrofen+quinmerac; chlomitrofen+tralkoxydim; chlomitrofen+fluoroglycofen-ethyl; chlomitrofen+methabenzthiazuron; chlomitrofen+ethalfluralin; chlomitrofen+pendimethalin; chlomitrofen+trifluralin; chlomitrofen+isoxaben; chlomitrofen+prosulfocarb; chlomitrofen+triallate; chlomitrofen+clopyralid; chlomitrofen+fluroxypyr; chlomitrofen+benazolin-ethyl; chlomitrofen+difenzoquat; chlomitrofen+glyphosate; chlomitrofen+glufosinate; chlomitrofen+sulfosate; ethoxyfen+triasulfuron; ethoxyfen+prosulfuron; ethoxyfen+clodinafop; ethoxyfen+terbutryne; ethoxyfen+amidosulfuron; ethoxyfen+bromoxynil; ethoxyfen+carfentrazone; ethoxyfen+dicamba; ethoxyfen+diclofop-methyl; ethoxyfen+diflufenican; ethoxyfen+ethoxysulfuron; ethoxyfen+fenoxaprop(P-ethyl); ethoxyfen+fentrazamide; ethoxyfen+flazasulfuron; ethoxyfen+florasulam; ethoxyfen+fluazolate; ethoxyfen+flucarbazone; ethoxyfen+flufenacet; ethoxyfen+flupyrsulfuron; ethoxyfen+flurtamone; ethoxyfen+iodosulfuron; ethoxyfen+isoproturon; ethoxyfen+chlortoluron; ethoxyfen+MCPA; ethoxyfen+MCPB; ethoxyfen+mecoprop; ethoxyfen+MCPP; ethoxyfen+chlorsulfuron; ethoxyfen+a metsulfuron; ethoxyfen+sulfosulfuron; ethoxyfen+thifensulfuron; ethoxyfen+tribenuron; ethoxyfen+2,4-D; ethoxyfen+2,4-DB; ethoxyfen+2,4-DP; ethoxyfen+bifenox; ethoxyfen +ethametsulfuron; ethoxyfen+flamprop-M; ethoxyfen+imazamethabenz; ethoxyfen+ioxynil; ethoxyfen+bromoxynil; ethoxyfen+metosulam; ethoxyfen+pyridate; ethoxyfen+quinmerac; ethoxyfen+tralkoxydim; ethoxyfen+fluoroglycofen-ethyl; ethoxyfen+methabenzthiazuron; ethoxyfen+ethalfluralin; ethoxyfen+pendimethalin; ethoxyfen+trifluralin; ethoxyfen+isoxaben; ethoxyfen+prosulfocarb; ethoxyfen+triallate; ethoxyfen+clopyralid; ethoxyfen+fluroxypyr; ethoxyfen+benazolin-ethyl; ethoxyfen+difenzoquat; ethoxyfen+glyphosate; ethoxyfen+glufosinate; ethoxyfen+sulfosate; fluoroglycofen+triasulfuron; fluoroglycofen+prosulfuron; fluoroglycofen+clodinafop; fluoroglycofen+terbutryne; fluoroglycofen+amidosulfuron; fluoroglycofen+bromoxynil; fluoroglycofen+carfentrazone; fluoroglycofen+dicamba; fluoroglycofen+diclofop-methyl; fluoroglycofen+diflufenican; fluoroglycofen+ethoxysulfuron; fluoroglycofen+fenoxaprop(P-ethyl); fluoroglycofen+fentrazamide; fluoroglycofen+flazasulfuron; fluoroglycofen+florasulam; fluoroglycofen+fluazolate; fluoroglycofen+flucarbazone; fluoroglycofen+flufenacet; fluoroglycofen+flupyrsulfuron; fluoroglycofen+flurtamone; fluoroglycofen+iodosulfuron; fluoroglycofen+isoproturon; fluoroglycofen+chlortoluron; fluoroglycofen+MCPA; fluoroglycofen+MCPB; fluoroglycofen+mecoprop; fluoroglycofen+MCPP; fluoroglycofen +chlorsulfuron; fluoroglycofen+metsulfuron; fluoroglycofen+sulfosulfuron; fluoroglycofen +thifensulfuron; fluoroglycofen+tribenuron; fluoroglycofen+2,4-D; fluoroglycofen+2,4-DB; fluoroglycofen+2,4-DP; fluoroglycofen+bifenox; fluoroglycofen+ethametsulfuron; fluoroglycofen+flamprop-M; fluoroglycofen+imazamethabenz; fluoroglycofen+ioxynil; fluoroglycofen+bromoxynil; fluoroglycofen+metosulam; fluoroglycofen+pyridate; fluoroglycofen+quinmerac; fluoroglycofen+tralkoxydim; fluoroglycofen+methabenzthiazuron; fluoroglycofen+ethalfluralin; fluoroglycofen+pendimethalin; fluoroglycofen+trifluralin; fluoroglycofen+isoxaben; fluoroglycofen+prosulfocarb; fluoroglycofen+triallate; fluoroglycofen+clopyralid; fluoroglycofen+fluroxypyr; fluoroglycofen+benazolin-ethyl; fluoroglycofen+difenzoquat; fluoroglycofen+glyphosate; fluoroglycofen+glufosinate; fluoroglycofen+sulfosate; fomesafen+triasulfuron; fomesafen+prosulfuron; fomesafen+clodinafop; fomesafen+terbutryne; fomesafen+amidosulfuron; fomesafen+bromoxynil; fomesafen+carfentrazone; fomesafen+dicamba; fomesafen+diclofop-methyl; fomesafen+diflufenican; fomesafen+ethoxysulfuron; fomesafen+fenoxaprop(P-ethyl); fomesafen+fentrazamide; fomesafen+flazasulfuron; fomesafen+florasulam; fomesafen+fluazolate; fomesafen+flucarbazone; fomesafen+flufenacet; fomesafen+flupyrsulfuron; fomesafen+flurtamone; fomesafen+iodosulfuron; fomesafen+isoproturon; fomesafen+chlortoluron; fomesafen+MCPA; fomesafen+MCPB; fomesafen+mecoprop; fomesafen+MCPP; fomesafen+chlorsulfuron; fomesafen +metsulfuron; fomesafen+sulfosulfuron; fomesafen+thifensulfuron; fomesafen+tribenuron; fomesafen+2,4-D; fomesafen+2,4-DB; fomesafen+2,4-DP; fomesafen+bifenox; fomesafen+ethametsulfuron; fomesafen+flamprop-M; fomesafen+imazamethabenz; fomesafen+ioxynil; fomesafen+bromoxynil; fomesafen+metosulam; fomesafen+pyridate; fomesafen+quinmerac; fomesafen+tralkoxydim; fomesafen+fluoroglycofen-ethyl; fomesafen+methabenzthiazuron; fomesafen+ethalfluralin; fomesafen+pendimethalin; fomesafen+trifluralin; fomesafen+isoxaben; fomesafen+prosulfocarb; fomesafen+triallate; fomesafen+clopyralid; fomesafen+fluroxypyr; fomesafen+benazolin-ethyl; fomesafen+difenzoquat; fomesafen+glyphosate; fomesafen+glufosinate; fomesafen+sulfosate; lactofen+triasulfuron; lactofen+prosulfuron; lactofen+clodinafop; lactofen+terbutryne; lactofen+amidosulfuron; lactofen +bromoxynil; lactofen+carfentrazone; lactofen+dicamba; lactofen+diclofop-methyl; lactofen+diflufenican; lactofen+ethoxysulfuron; lactofen+fenoxaprop(P-ethyl); lactofen+fentrazamide; lactofen+flazasulfuron; lactofen+florasulam; lactofen+fluazolate; lactofen +flucarbazone; lactofen+flufenacet; lactofen+flupyrsulfuron; lactofen+flurtamone; lactofen+iodosulfuron; lactofen+isoproturon; lactofen+chlortoluron; lactofen+MCPA; lactofen+MCPB; lactofen+mecoprop; lactofen+MCPP; lactofen+chlorsulfuron; lactofen +metsulfuron; lactofen+sulfosulfuron; lactofen+thifensulfuron; lactofen+tribenuron; lactofen+2,4-D; lactofen+2,4-DB; lactofen+2,4-DP; lactofen+bifenox; lactofen+ethametsulfuron; lactofen+flamprop-M; lactofen+imazamethabenz; lactofen+ioxynil; lactofen+bromoxynil; lactofen+metosulam; lactofen+pyridate; lactofen+quinmerac; lactofen+tralkoxydim; lactofen+fluoroglycofen-ethyl; lactofen+methabenzthiazuron; lactofen+ethalfluralin; lactofen+pendimethalin; lactofen+trifluralin; lactofen+isoxaben; lactofen+prosulfocarb; lactofen+triallate; lactofen+clopyralid; lactofen+fluroxypyr; lactofen+benazolin-ethyl; lactofen+difenzoquat; lactofen+glyphosate; lactofen+glufosinate; lactofen+sulfosate; oxyfluorfen+triasulfuron; oxyfluorfen+prosulfuron; oxyfluorfen+clodinafop; oxyfluorfen+terbutryne; oxyfluorfen+amidosulfuron; oxyfluorfen +bromoxynil; oxyfluorfen+carfentrazone; oxyfluorfen+dicamba; oxyfluorfen+diclofop-methyl; oxyfluorfen+diflufenican; oxyfluorfen+ethoxysulfuron; oxyfluorfen+fenoxaprop(P-ethyl); oxyfluorfen+fentrazamide; oxyfluorfen+flazasulfuron; oxyfluorfen+florasulam; oxyfluorfen+fluazolate; oxyfluorfen+flucarbazone; oxyfluorfen+flufenacet; oxyfluorfen+flupyrsulfuron; oxyfluorfen+flurtamone; oxyfluorfen+iodosulfuron; oxyfluorfen+isoproturon; oxyfluorfen+chlortoluron; oxyfluorfen+MCPA; oxyfluorfen+MCPB; oxyfluorfen+mecoprop; oxyfluorfen+MCPP; oxyfluorfen+chlorsulfuron; oxyfluorfen+metsulfuron; oxyfluorfen+sulfosulfuron; oxyfluorfen+thifensulfuron; oxyfluorfen+tribenuron; oxyfluorfen+2,4-D; oxyfluorfen+2,4-DB; oxyfluorfen+2,4-DP; oxyfluorfen+bifenox; oxyfluorfen+ethametsulfuron; oxyfluorfen+flamprop-M; oxyfluorfen +imazamethabenz; oxyfluorfen+ioxynil; oxyfluorfen+bromoxynil; oxyfluorfen+metosulam; oxyfluorfen+pyridate; oxyfluorfen+quinmerac; oxyfluorfen+tralkoxydim; oxyfluorfen+fluoroglycofen-ethyl; oxyfluorfen+methabenzthiazuron; oxyfluorfen+ethalfluralin; oxyfluorfen+pendimethalin; oxyfluorfen+trifluralin; oxyfluorfen+isoxaben; oxyfluorfen+prosulfocarb; oxyfluorfen+triallate; oxyfluorfen+clopyralid; oxyfluorfen+fluroxypyr; oxyfluorfen+benazolin-ethyl; oxyfluorfen+difenzoquat; oxyfluorfen+glyphosate; oxyfluorfen+glufosinate; oxyfluorfen+sulfosate; azafenidin+triasulfuron; azafenidin+prosulfuron; azafenidin+clodinafop; azafenidin+terbutryne; azafenidin+amidosulfuron; azafenidin+bromoxynil; azafenidin+carfentrazone; azafenidin+dicamba; azafenidin+diclofop-methyl; azafenidin+diflufenican; azafenidin+ethoxysulfuron; azafenidin+fenoxaprop(P-ethyl); azafenidin+fentrazamide; azafenidin+flazasulfuron; azafenidin+florasulam; azafenidin+fluazolate; azafenidin+flucarbazone; azafenidin+flufenacet; azafenidin+flupyrsulfuron; azafenidin+flurtamone; azafenidin+iodosulfuron; azafenidin+isoproturon; azafenidin+chlortoluron; azafenidin+MCPA; azafenidin+MCPB; azafenidin+mecoprop; azafenidin+MCPP; azafenidin+chlorsulfuron; azafenidin +metsulfuron; azafenidin+sulfosulfuron; azafenidin+thifensulfuron; azafenidin+tribenuron; azafenidin+2,4-D; azafenidin+2,4-DB; azafenidin+2,4-DP; azafenidin+bifenox; azafenidin+ethametsulfuron; azafenidin+flamprop-M; azafenidin+imazamethabenz; azafenidin+ioxynil; azafenidin+bromoxynil; azafenidin+metosulam; azafenidin+pyridate; azafenidin+quinmerac; azafenidin+tralkoxydim; azafenidin+fluoroglycofen-ethyl; azafenidin+methabenzthiazuron; azafenidin+ethalfluralin; azafenidin +pendimethalin; azafenidin+trifluralin; azafenidin+isoxaben; azafenidin+prosulfocarb; azafenidin+triallate; azafenidin+clopyralid; azafenidin+fluroxypyr; azafenidin+benazolin-ethyl; azafenidin+difenzoquat; azafenidin+glyphosate; azafenidin+glufosinate; azafenidin+sulfosate; carfentrazone-ethyl+triasulfuron; carfentrazone-ethyl+prosulfuron; carfentrazone-ethyl+clodinafop; carfentrazone-ethyl+terbutryne; carfentrazone-ethyl+amidosulfuron; carfentrazone-ethyl+bromoxynil; carfentrazone-ethyl +dicamba; carfentrazone-ethyl+diclofop-methyl; carfentrazone-ethyl+diflufenican; carfentrazone-ethyl+ethoxysulfuron; carfentrazone-ethyl+fenoxaprop(P-ethyl); carfentrazone-ethyl+fentrazamide; carfentrazone-ethyl+flazasulfuron; carfentrazone-ethyl +florasulam; carfentrazone-ethyl+fluazolate; carfentrazone-ethyl+flucarbazone; carfentrazone-ethyl+flufenacet; carfentrazone-ethyl+flupyrsulfuron; carfentrazone-ethyl+flurtamone; carfentrazone-ethyl+iodosulfuron; carfentrazone-ethyl+isoproturon; carfentrazone-ethyl+chlortoluron; carfentrazone-ethyl+MCPA; carfentrazone-ethyl+MCPB; carfentrazone-ethyl+mecoprop; carfentrazone-ethyl+MCPP; carfentrazone-ethyl+chlorsulfuron; carfentrazone-ethyl+metsulfuron; carfentrazone-ethyl+sulfosulfuron; carfentrazone-ethyl+thifensulfuron; carfentrazone-ethyl+tribenuron; carfentrazone-ethyl+2,4-D; carfentrazone-ethyl+2,4-DB; carfentrazone-ethyl+2,4-DP; carfentrazone-ethyl+bifenox; carfentrazone-ethyl+ethametsulfuron; carfentrazone-ethyl+flamprop-M; carfentrazone-ethyl+imazamethabenz; carfentrazone-ethyl+ioxynil; carfentrazone-ethyl+bromoxynil; carfentrazone-ethyl+metosulam; carfentrazone-ethyl+pyridate; carfentrazone-ethyl+quinmerac; carfentrazone-ethyl+tralkoxydim; carfentrazone-ethyl+fluoroglycofen-ethyl; carfentrazone-ethyl+methabenzthiazuron; carfentrazone-ethyl+ethalfluralin; carfentrazone-ethyl+pendimethalin; carfentrazone-ethyl+trifluralin; carfentrazone-ethyl+isoxaben; carfentrazone-ethyl+prosulfocarb; carfentrazone-ethyl+triallate; carfentrazone-ethyl+clopyralid; carfentrazone-ethyl+fluroxypyr; carfentrazone-ethyl+benazolin-ethyl; carfentrazone-ethyl+difenzoquat; carfentrazone-ethyl+glyphosate; carfentrazone-ethyl+glufosinate; carfentrazone-ethyl+sulfosate; compound of the formula A+triasulfuron; compound of the formula A+prosulfuron; compound of the formula A+clodinafop; compound of the formula A+terbutryne; compound of the formula A+amidosulfuron; compound of the formula A+bromoxynil; compound of the formula A+carfentrazone; compound of the formula A+dicamba; compound of the formula A+diclofop-methyl; compound of the formula A+diflufenican; compound of the formula A+ethoxysulfuron; compound of the formula A+fenoxaprop(P-ethyl); compound of the formula A+fentrazamide; compound of the formula A+flazasulfuron; compound of the formula A+florasulam; compound of the formula A+fluazolate; compound of the formula A+flucarbazone; compound of the formula A+flufenacet; compound of the formula A+flupyrsulfuron; compound of the formula A+flurtamone; compound of the formula A+iodosulfuron; compound of the formula A+isoproturon; compound of the formula A+chlortoluron; compound of the formula A+MCPA; compound of the formula A+MCPB; compound of the formula A+mecoprop; compound of the formula A+MCPP; compound of the formula A+chlorsulfuron; compound of the formula A+metsulfuron; compound of the formula A+sulfosulfuron; compound of the formula A+thifensulfuron; compound of the formula A+tribenuron; compound of the formula A+2,4-D; compound of the formula A+2,4-DB; compound of the formula A+2,4-DP; compound of the formula A+bifenox; compound of the formula A+ethametsulfuron; compound of the formula A+flamprop-M; compound of the formula A+imazamethabenz; compound of the formula A+ioxynil; compound of the formula A+bromoxynil; compound of the formula A+metosulam; compound of the formula A+pyridate; compound of the formula A+quinmerac; compound of the formula A+tralkoxydim; compound of the formula A+fluoroglycofen-ethyl; compound of the formula A+methabenzthiazuron; compound of the formula A+ethalfluralin; compound of the formula A+pendimethalin; compound of the formula A+trifluralin; compound of the formula A+isoxaben; compound of the formula A+prosulfocarb; compound of the formula A+triallate; compound of the formula A+clopyralid; compound of the formula A+fluroxypyr; compound of the formula A+benazolin-ethyl; compound of the formula A+difenzoquat; compound of the formula A+glyphosate; compound of the formula A+glufosinate; compound of the formula A+sulfosate; cinidon-ethyl+triasulfuron; cinidon-ethyl+prosulfuron; cinidon-ethyl+clodinafop; cinidon-ethyl+terbutryne; cinidon-ethyl+amidosulfuron; cinidon-ethyl+bromoxynil; cinidon-ethyl+carfentrazone; cinidon-ethyl+dicamba; cinidon-ethyl+diclofop-methyl; cinidon-ethyl+diflufenican; cinidon-ethyl+ethoxysulfuron; cinidon-ethyl+fenoxaprop(P-ethyl); cinidon-ethyl+fentrazamide; cinidon-ethyl+flazasulfuron; cinidon-ethyl+florasulam; cinidon-ethyl +fluazolate; cinidon-ethyl+flucarbazone; cinidon-ethyl+flufenacet; cinidon-ethyl+flupyrsulfuron; cinidon-ethyl+flurtamone; cinidon-ethyl+iodosulfuron; cinidon-ethyl+isoproturon; cinidon-ethyl+chlortoluron; cinidon-ethyl+MCPA; cinidon-ethyl+MCPB; cinidon-ethyl+mecoprop; cinidon-ethyl+MCPP; cinidon-ethyl+chlorsulfuron; cinidon-ethyl +metsulfuron; cinidon-ethyl+sulfosulfuron; cinidon-ethyl+thifensulfuron; cinidon-ethyl+tribenuron; cinidon-ethyl+2,4-D; cinidon-ethyl+2,4-DB; cinidon-ethyl+2,4-DP; cinidon-ethyl+bifenox; cinidon-ethyl+ethametsulfuron; cinidon-ethyl+flamprop-M; cinidon-ethyl+imazamethabenz; cinidon-ethyl+ioxynil; cinidon-ethyl+bromoxynil; cinidon-ethyl+metosulam; cinidon-ethyl+pyridate; cinidon-ethyl+quinmerac; cinidon-ethyl+tralkoxydim; cinidon-ethyl+fluoroglycofen-ethyl; cinidon-ethyl+methabenzthiazuron; cinidon-ethyl+ethalfluralin; cinidon-ethyl+pendimethalin; cinidon-ethyl+trifluralin; cinidon-ethyl+isoxaben; cinidon-ethyl+prosulfocarb; cinidon-ethyl+triallate; cinidon-ethyl+clopyralid; cinidon-ethyl+fluroxypyr; cinidon-ethyl+benazolin-ethyl; cinidon-ethyl+difenzoquat; cinidon-ethyl+glyphosate; cinidon-ethyl+glufosinate; cinidon-ethyl+sulfosate; flumiclorac-pentyl+flurtamone; flumiclorac-pentyl+iodosulfuron; flumiclorac-pentyl+isoproturon; flumiclorac-pentyl+chlortoluron; flumiclorac-pentyl+MCPA; flumiclorac-pentyl +MCPB; flumiclorac-pentyl+mecoprop; flumiclorac-pentyl+MCPP; flumiclorac-pentyl+chlorsulfuron; flumiclorac-pentyl+metsulfuron; flumiclorac-pentyl+sulfosulfuron; flumiclorac-pentyl+thifensulfuron; flumiclorac-pentyl+tribenuron; flumiclorac-pentyl+2,4-D; flumiclorac-pentyl+2,4-DB; flumiclorac-pentyl+2,4-DP; flumiclorac-pentyl+bifenox; flumiclorac-pentyl+ethametsulfuron; flumiclorac-pentyl+flamprop-M; flumiclorac-pentyl+imazamethabenz; flumiclorac-pentyl+ioxynil; flumiclorac-pentyl+bromoxynil; flumiclorac-pentyl+metosulam; flumiclorac-pentyl+pyridate; flumiclorac-pentyl+quinmerac; flumiclorac-pentyl+tralkoxydim; flumiclorac-pentyl+fluoroglycofen-ethyl; flumiclorac-pentyl +methabenzthiazuron; flumiclorac-pentyl+ethalfluralin; flumiclorac-pentyl+pendimethalin; flumiclorac-pentyl+trifuralin; flumiclorac-pentyl+isoxaben; flumiclorac-pentyl+prosulfocarb; flumiclorac-pentyl+triallate; flumiclorac-pentyl+clopyralid; flumiclorac-pentyl +fluroxypyr; flumiclorac-pentyl+benazolin-ethyl; flumiclorac-pentyl+difenzoquat; flumiclorac-pentyl+glyphosate; flumiclorac-pentyl+glufosinate; flumiclorac-pentyl+sulfosate; flumioxazin+triasulfuron; flumioxazin+prosulfuron; flumioxazin+clodinafop; flumioxazin+terbutryne; flumioxazin+amidosulfuron; flumioxazin+bromoxynil; flumioxazin +carfentrazone; flumioxazin+dicamba; flumioxazin+diclofop-methyl; flumioxazin+diflufenican; flumioxazin+ethoxysulfuron; flumioxazin+fenoxaprop(P-ethyl); flumioxazin+fentrazamide; flumioxazin+flazasulfuron; flumioxazin+florasulam; flumioxazin+fluazolate; flumioxazin+flucarbazone; flumioxazin+flufenacet; flumioxazin+flupyrsulfuron; flumioxazin+flurtamone; flumioxazin+iodosulfuron; flumioxazin+isoproturon; flumioxazin+chlortoluron; flumioxazin+MCPA; flumioxazin+MCPB; flumioxazin+mecoprop; flumioxazin+MCPP; flumioxazin+chlorsulfuron; flumioxazin+metsulfuron; flumioxazin+sulfosulfuron; flumioxazin+thifensulfuron; flumioxazin+tribenuron; flumioxazin+2,4-D; flumioxazin+2,4-DB; flumioxazin+2,4-DP; flumioxazin+bifenox; flumioxazin+ethametsulfuron; flumioxazin+flamprop-M; flumioxazin+imazamethabenz; flumioxazin+ioxynil; flumioxazin+bromoxynil; flumioxazin+metosulam; flumioxazin+pyridate; flumioxazin+quinmerac; flumioxazin+tralkoxydim; flumioxazin+fluoroglycofen-ethyl; flumioxazin+methabenzthiazuron; flumioxazin+ethalfluralin; flumioxazin+pendimethalin; flumioxazin+trifluralin; flumioxazin+isoxaben; flumioxazin+prosulfocarb; flumioxazin+triallate; flumioxazin+clopyralid; flumioxazin+fluroxypyr; flumioxazin+benazolin-ethyl; flumioxazin+difenzoquat; flumioxazin+glyphosate; flumioxazin+glufosinate; flumioxazin+sulfosate; fluthiacet-methyl+triasulfuron; fluthiacet-methyl+prosulfuron; fluthiacet-methyl+clodinafop; fluthiacet-methyl+terbutryne; fluthiacet-methyl+amidosulfuron; fluthiacet-methyl+bromoxynil; fluthiacet-methyl+carfentrazone; fluthiacet-methyl+dicamba; fluthiacet-methyl+diclofop-methyl; fluthiacet-methyl+diflufenican; fluthiacet-methyl+ethoxysulfuron; fluthiacet-methyl+fenoxaprop(P-ethyl); fluthiacet-methyl+fentrazamide; fluthiacet-methyl+flazasulfuron; fluthiacet-methyl+florasulam; fluthiacet-methyl+fluazolate; fluthiacet-methyl+flucarbazone; fluthiacet-methyl +flufenacet; fluthiacet-methyl+flupyrsulfuron; fluthiacet-methyl+flurtamone; fluthiacet-methyl+iodosulfuron; fluthiacet-methyl+isoproturon; fluthiacet-methyl+chlortoluron; fluthiacet-methyl+MCPA; fluthiacet-methyl+MCPB; fluthiacet-methyl+mecoprop; fluthiacet-methyl+MCPP; fluthiacet-methyl+chlorsulfuron; fluthiacet-methyl+metsulfuron; fluthiacet-methyl+sulfosulfuron; fluthiacet-methyl+thifensulfuron; fluthiacet-methyl+tribenuron; fluthiacet-methyl+2,4-D; fluthiacet-methyl+2,4-DB; fluthiacet-methyl+2,4-DP; fluthiacet-methyl+bifenox; fluthiacet-methyl+ethametsulfuron; fluthiacet-methyl+flamprop-M; fluthiacet-methyl+Imazamethabenz; fluthiacet-methyl+ioxynil; fluthiacet-methyl+bromoxynil; fluthiacet-methyl+metosulam; fluthiacet-methyl+pyridate; fluthiacet-methyl+quinmerac; fluthiacet-methyl+tralkoxydim; fluthiacet-methyl+fluoroglycofen-ethyl; fluthiacet-methyl+methabenzthiazuron; fluthiacet-methyl+ethalfluralin; fluthiacet-methyl+pendimethalin; fluthiacet-methyl+trifluralin; fluthiacet-methyl+isoxaben; fluthiacet-methyl+prosulfocarb; fluthiacet-methyl+triallate; fluthiacet-methyl+clopyralid; fluthiacet-methyl+fluroxypyr; fluthiacet-methyl+benazolin-ethyl; fluthiacet-methyl+difenzoquat; fluthiacet-methyl+glyphosate; fluthiacet-methyl+glufosinate; fluthiacet-methyl+sulfosate; oxadiargyl+triasulfuron; oxadiargyl+prosulfuron; oxadiargyl+clodinafop; oxadiargyl+terbutryne; oxadiargyl+amidosulfuron; oxadiargyl+bromoxynil; oxadiargyl+carfentrazone; oxadiargyl+dicamba; oxadiargyl+diclofop-methyl; oxadiargyl+diflufenican; oxadiargyl+ethoxysulfuron; oxadiargyl+fenoxaprop(P-ethyl); oxadiargyl+fentrazamide; oxadiargyl+flazasulfuron; oxadiargyl+florasulam; oxadiargyl+fluazolate; oxadiargyl+flucarbazone; oxadiargyl+flufenacet; oxadiargyl+flupyrsulfuron; oxadiargyl+flurtamone; oxadiargyl+iodosulfuron; oxadiargyl+isoproturon; oxadiargyl+chlortoluron; oxadiargyl+MCPA; oxadiargyl+MCPB; oxadiargyl+mecoprop; oxadiargyl+MCPP; oxadiargyl+chlorsulfuron; oxadiargyl+metsulfuron; oxadiargyl+sulfosulfuron; oxadiargyl +thifensulfuron; oxadiargyl+tribenuron; oxadiargyl+2,4-D; oxadiargyl+2,4-DB; oxadiargyl+2,4-DP; oxadiargyl+bifenox; oxadiargyl+ethametsulfuron; oxadiargyl+flamprop-M; oxadiargyl+imazamethabenz; oxadiargyl+ioxynil; oxadiargyl+bromoxynil; oxadiargyl+metosulam; oxadiargyl+pyridate; oxadiargyl+quinmerac; oxadiargyl+tralkoxydim; oxadiargyl+fluoroglycofen-ethyl; oxadiargyl+methabenzthiazuron; oxadiargyl +ethalfluralin; oxadiargyl+pendimethalin; oxadiargyl+trifluralin; oxadiargyl+isoxaben; oxadiargyl+prosulfocarb; oxadiargyl+triallate; oxadiargyl+clopyralid; oxadiargyl+fluroxypyr; oxadiargyl+benazolin-ethyl; oxadiargyl+difenzoquat; oxadiargyl+glyphosate; oxadiargyl+glufosinate; oxadiargyl+sulfosate; oxadiazon+triasulfuron; oxadiazon+prosulfuron; oxadiazon+clodinafop; oxadiazon+terbutryne; oxadiazon+amidosulfuron; oxadiazon+bromoxynil; oxadiazon+carfentrazone; oxadiazon+dicamba; oxadiazon+diclofop-methyl; oxadiazon+diflufenican; oxadiazon+ethoxysulfuron; oxadiazon+fenoxaprop(P-ethyl); oxadiazon+fentrazamide; oxadiazon+flazasulfuron; oxadiazon+florasulam; oxadiazon+fluazolate; oxadiazon+flucarbazone; oxadiazon+flufenacet; oxadiazon+flupyrsulfuron; oxadiazon+flurtamone; oxadiazon+iodosulfuron; oxadiazon+isoproturon; oxadiazon+chlortoluron; oxadiazon+MCPA; oxadiazon+MCPB; oxadiazon+mecoprop; oxadiazon+MCPP; oxadiazon+chlorsulfuron; oxadiazon+metsulfuron; oxadiazon+sulfosulfuron; oxadiazon+thifensulfuron; oxadiazon+tribenuron; oxadiazon+2,4-D; oxadiazon+2,4-DB; oxadiazon+2,4-DP; oxadiazon+bifenox; oxadiazon+ethametsulfuron; oxadiazon+flamprop-M; oxadiazon+imazamethabenz; oxadiazon+ioxynil; oxadiazon+bromoxynil; oxadiazon+metosulam; oxadiazon+pyridate; oxadiazon +quinmerac; oxadiazon+tralkoxydim; oxadiazon+fluoroglycofen-ethyl; oxadiazon+methabenzthiazuron; oxadiazon+ethalfluralin; oxadiazon+pendimethalin; oxadiazon+trifluralin; oxadiazon+isoxaben; oxadiazon+prosulfocarb; oxadiazon+triallate; oxadiazon +clopyralid; oxadiazon+fluroxypyr; oxadiazon+benazolin-ethyl; oxadiazon+difenzoquat; oxadiazon+glyphosate; oxadiazon+glufosinate; oxadiazon+sulfosate; pentoxazone+triasulfuron; pentoxazone+prosulfuron; pentoxazone+clodinafop; pentoxazone+terbutryne; pentoxazone+amidosulfuron; pentoxazone+bromoxynil; pentoxazone+carfentrazone; pentoxazone+dicamba; pentoxazone+diclofop-methyl; pentoxazone+diflufenican; pentoxazone+ethoxysulfuron; pentoxazone+fenoxaprop(P-ethyl); pentoxazone+fentrazamide; pentoxazone+flazasulfuron; pentoxazone+florasulam; pentoxazone+fluazolate; pentoxazone+flucarbazone; pentoxazone+flufenacet; pentoxazone+flupyrsulfuron; pentoxazone+flurtamone; pentoxazone+iodosulfuron; pentoxazone+isoproturon; pentoxazone+chlortoluron; pentoxazone+MCPA; pentoxazone+MCPB; pentoxazone+mecoprop; pentoxazone+MCPP; pentoxazone+chlorsulfuron; pentoxazone+metsulfuron; pentoxazone+sulfosulfuron; pentoxazone+thifensulfuron; pentoxazone+tribenuron; pentoxazone+2,4-D; pentoxazone+2,4-DB; pentoxazone+2,4-DP; pentoxazone+bifenox; pentoxazone+ethametsulfuron; pentoxazone+flamprop-M; pentoxazone+imazamethabenz; pentoxazone+ioxynil; pentoxazone+bromoxynil; pentoxazone+metosulam; pentoxazone+pyridate; pentoxazone+quinmerac; pentoxazone+tralkoxydim; pentoxazone+fluoroglycofen-ethyl; pentoxazone+methabenzthiazuron; pentoxazone+ethalfluralin; pentoxazone+pendimethalin; pentoxazone+trifluralin; pentoxazone+isoxaben; pentoxazone+prosulfocarb; pentoxazone+triallate; pentoxazone+clopyralid; pentoxazone+fluroxypyr; pentoxazone+benazolin-ethyl; pentoxazone+difenzoquat; pentoxazone+glyphosate; pentoxazone+glufosinate; pentoxazone+sulfosate; sulfentrazone+triasulfuron; sulfentrazone+prosulfuron; sulfentrazone+clodinafop; sulfentrazone+terbutryne; sulfentrazone+Amidosulfuron; sulfentrazone+bromoxynil; sulfentrazone+carfentrazone; sulfentrazone+dicamba; sulfentrazone+diclofop-methyl; sulfentrazone+diflufenican; sulfentrazone+ethoxysulfuron; sulfentrazone+fenoxaprop(P-ethyl); sulfentrazone+fentrazamide; sulfentrazone+flazasulfuron; sulfentrazone+florasulam; sulfentrazone+fluazolate; sulfentrazone+flucarbazone; sulfentrazone+flufenacet; sulfentrazone+flupyrsulfuron; sulfentrazone+flurtamone; sulfentrazone+iodosulfuron; sulfentrazone+isoproturon; sulfentrazone+chlortoluron; sulfentrazone+MCPA; sulfentrazone+MCPB; sulfentrazone+mecoprop; sulfentrazone+MCPP; sulfentrazone+chlorsulfuron; sulfentrazone+metsulfuron; sulfentrazone+sulfosulfuron; sulfentrazone+thifensulfuron; sulfentrazone+tribenuron; sulfentrazone+2,4-D; sulfentrazone+2,4-DB; sulfentrazone+2,4-DP; sulfentrazone+bifenox; sulfentrazone+ethametsulfuron; sulfentrazone+flamprop-M; sulfentrazone+imazamethabenz; sulfentrazone+ioxynil; sulfentrazone+bromoxynil; sulfentrazone+metosulam; sulfentrazone+pyridate; sulfentrazone+quinmerac; sulfentrazone+tralkoxydim; sulfentrazone+fluoroglycofen-ethyl; sulfentrazone+methabenzthiazuron; sulfentrazone+ethalfluralin; sulfentrazone+pendimethalin; sulfentrazone+trifluralin; sulfentrazone+isoxaben; sulfentrazone+prosulfocarb; sulfentrazone+triallate; sulfentrazone+clopyralid; sulfentrazone+fluroxypyr; sulfentrazone+benazolin-ethyl; sulfentrazone+difenzoquat; sulfentrazone+glyphosate; sulfentrazone+glufosinate; sulfentrazone+sulfosate; fluazolate+triasulfuron; fluazolate+prosulfuron; fluazolate+clodinafop; fluazolate+terbutryne; fluazolate+amidosulfuron; fluazolate+bromoxynil; fluazolate+carfentrazone; fluazolate+dicamba; fluazolate+diclofop-methyl; fluazolate+diflufenican; fluazolate+ethoxysulfuron; fluazolate+fenoxaprop(P-ethyl); fluazolate+fentrazamide; fluazolate+flazasulfuron; fluazolate+florasulam; fluazolate+fluazolate; fluazolate+flucarbazone; fluazolate+flufenacet; fluazolate+flupyrsulfuron; fluazolate+flurtamone; fluazolate+iodosulfuron; fluazolate+isoproturon; fluazolate+chlortoluron; fluazolate+MCPA; fluazolate+MCPB; fluazolate+mecoprop; fluazolate+MCPP; fluazolate+chlorsulfuron; fluazolate+metsulfuron; fluazolate+sulfosulfuron; fluazolate+thifensulfuron; fluazolate+tribenuron; fluazolate+2,4-D; fluazolate+2,4-DB; fluazolate+2,4-DP; fluazolate+bifenox; fluazolate+ethametsulfuron; fluazolate+flamprop-M; fluazolate+imazamethabenz; fluazolate+ioxynil; fluazolate+bromoxynil; fluazolate+metosulam; fluazolate+pyridate; fluazolate+quinmerac; fluazolate+tralkoxydim; fluazolate+fluoroglycofen-ethyl; fluazolate+methabenzthiazuron; fluazolate+ethalfluralin; fluazolate+pendimethalin; fluazolate+trifluralin; fluazolate+isoxaben; fluazolate+prosulfocarb; fluazolate+triallate; fluazolate+clopyralid; fluazolate+fluroxypyr; fluazolate+benazolin-ethyl; fluazolate+difenzoquat; fluazolate+glyphosate; fluazolate+glufosinate; fluazolate+sulfosate; pyraflufen-ethyl+triasulfuron; pyraflufen-ethyl+prosulfuron; pyraflufen-ethyl+clodinafop; pyraflufen-ethyl+terbutryne; pyraflufen-ethyl+amidosulfuron; pyraflufen-ethyl+bromoxynil; pyraflufen-ethyl +carfentrazone; pyraflufen-ethyl+dicamba; pyraflufen-ethyl+diclofop-methyl; pyraflufen-ethyl+diflufenican; pyraflufen-ethyl+ethoxysulfuron; pyraflufen-ethyl+fenoxaprop(P-ethyl); pyraflufen-ethyl+fentrazamide; pyraflufen-ethyl+flazasulfuron; pyraflufen-ethyl+florasulam; pyraflufen-ethyl+fluazolate; pyraflufen-ethyl+flucarbazone; pyraflufen-ethyl+flufenacet; pyraflufen-ethyl+flupyrsulfuron; pyraflufen-ethyl+flurtamone; pyraflufen-ethyl+iodosulfuron; pyraflufen-ethyl+isoproturon; pyraflufen-ethyl+chlortoluron; pyraflufen-ethyl +MCPA; pyraflufen-ethyl+MCPB; pyraflufen-ethyl+mecoprop; pyraflufen-ethyl+MCPP; pyraflufen-ethyl+chlorsulfuron; pyraflufen-ethyl+metsulfuron; pyraflufen-ethyl+sulfosulfuron; pyraflufen-ethyl+thifensulfuron; pyraflufen-ethyl+tribenuron; pyraflufen-ethyl+2,4-D; pyraflufen-ethyl+2,4-DB; pyraflufen-ethyl+2,4-DP; pyraflufen-ethyl+bifenox; pyraflufen-ethyl+ethametsulfuron; pyraflufen-ethyl+flamprop-M; pyraflufen-ethyl +imazamethabenz; pyraflufen-ethyl+ioxynil; pyraflufen-ethyl+bromoxynil; pyraflufen-ethyl +metosulam; pyraflufen-ethyl+pyridate; pyraflufen-ethyl+quinmerac; pyraflufen-ethyl+tralkoxydim; pyraflufen-ethyl+fluoroglycofen-ethyl; pyraflufen-ethyl+methabenzthiazuron; pyraflufen-ethyl+ethalfluralin; pyraflufen-ethyl+pendimethalin; pyraflufen-ethyl+trifluralin; pyraflufen-ethyl+isoxaben; pyraflufen-ethyl+prosulfocarb; pyraflufen-ethyl+triallate; pyraflufen-ethyl+clopyralid; pyraflufen-ethyl+fluroxypyr; pyraflufen-ethyl+benazolin-ethyl; pyraflufen-ethyl+difenzoquat; pyraflufen-ethyl+glyphosate; pyraflufen-ethyl+glufosinate; pyraflufen-ethyl+sulfosate; flumipropyn+triasulfuron; flumipropyn+prosulfuron; flumipropyn+clodinafop; flumipropyn+terbutryne; flumipropyn+amidosulfuron; flumipropyn+bromoxynil; flumipropyn+carfentrazone; flumipropyn+dicamba; flumipropyn +diclofop-methyl; flumipropyn+diflufenican; flumipropyn+ethoxysulfuron; flumipropyn+fenoxaprop(P-ethyl); flumipropyn+fentrazamide; flumipropyn+flazasulfuron; flumipropyn+florasulam; flumipropyn+fluazolate; flumipropyn+flucarbazone; flumipropyn+flufenacet; flumipropyn+flupyrsulfuron; flumipropyn+flurtamone; flumipropyn+iodosulfuron; flumipropyn+isoproturon; flumipropyn+chlortoluron; flumipropyn+MCPA; flumipropyn+MCPB; flumipropyn+mecoprop; flumipropyn+MCPP; flumipropyn+chlorsulfuron; flumipropyn+metsulfuron; flumipropyn+sulfosulfuron; flumipropyn+thifensulfuron; flumipropyn+tribenuron; flumipropyn+2,4-D; flumipropyn+2,4-DB; flumipropyn+2,4-DP; flumipropyn+bifenox; flumipropyn+ethametsulfuron; flumipropyn+flamprop-M; flumipropyn+imazamethabenz; flumipropyn+ioxynil; flumipropyn+bromoxynil; flumipropyn+metosulam; flumipropyn+pyridate; flumipropyn+quinmerac; flumipropyn+tralkoxydim; flumipropyn+fluoroglycofen-ethyl; flumipropyn+methabenzthiazuron; flumipropyn+ethalfluralin; flumipropyn+pendimethalin; flumipropyn+trifluralin; flumipropyn+isoxaben; flumipropyn+prosulfocarb; flumipropyn+triallate; flumipropyn+clopyralid; flumipropyn+fluroxypyr; flumipropyn+benazolin-ethyl; flumipropyn+difenzoquat; flumipropyn+glyphosate; flumipropyn+glufosinate; flumipropyn+sulfosate; flupropacil+triasulfuron; flupropacil+prosulfuron; flupropacil+clodinafop; flupropacil+terbutryne; flupropacil+amidosulfuron; flupropacil+bromoxynil; flupropacil+carfentrazone; flupropacil+dicamba; flupropacil+diclofop-methyl; flupropacil+diflufenican; flupropacil+ethoxysulfuron; flupropacil+fenoxaprop(P-ethyl); flupropacil+fentrazamide; flupropacil+flazasulfuron; flupropacil+florasulam; flupropacil+fluazolate; flupropacil+flucarbazone; flupropacil+flufenacet; flupropacil+flupyrsulfuron; flupropacil+flurtamone; flupropacil+iodosulfuron; flupropacil+isoproturon; flupropacil+chlortoluron; flupropacil+MCPA; flupropacil+MCPB; flupropacil+mecoprop; flupropacil+MCPP; flupropacil+chlorsulfuron; flupropacil+metsulfuron; flupropacil+sulfosulfuron; flupropacil +thifensulfuron; flupropacil+tribenuron; flupropacil+2,4-D; flupropacil+2,4-DB; flupropacil+2,4-DP; flupropacil+bifenox; flupropacil+ethametsulfuron; flupropacil+flamprop-M; flupropacil+imazamethabenz; flupropacil+ioxynil; flupropacil+bromoxynil; flupropacil+metosulam; flupropacil+pyridate; flupropacil+quinmerac; flupropacil+tralkoxydim; flupropacil+fluoroglycofen-ethyl; flupropacil+methabenzthiazuron; flupropacil +ethalfluralin; flupropacil+pendimethalin; flupropacil+trifluralin; flupropacil+isoxaben; flupropacil+prosulfocarb; flupropacil+triallate; flupropacil+clopyralid; flupropacil+fluroxypyr; flupropacil+benazolin-ethyl; flupropacil+difenzoquat; flupropacil+glyphosate; flupropacil+glufosinate; flupropacil+sulfosate; nipyraclofen+triasulfuron; nipyraclofen+prosulfuron; nipyraclofen+clodinafop; nipyraclofen+terbutryne; nipyraclofen+amidosulfuron; nipyraclofen+bromoxynil; nipyraclofen+carfentrazone; nipyraclofen+dicamba; nipyraclofen+diclofop-methyl; nipyraclofen+diflufenican; nipyraclofen+ethoxysulfuron; nipyraclofen+fenoxaprop (P-ethyl); nipyraclofen+fentrazamide; nipyraclofen+flazasulfuron; nipyraclofen+florasulam; nipyraclofen+fluazolate; nipyraclofen+flucarbazone; nipyraclofen+flufenacet; nipyraclofen+flupyrsulfuron; nipyraclofen+flurtamone; nipyraclofen+iodosulfuron; nipyraclofen+isoproturon; nipyraclofen+chlortoluron; nipyraclofen+MCPA; nipyraclofen+MCPB; nipyraclofen+mecoprop; nipyraclofen+MCPP; nipyraclofen+chlorsulfuron; nipyraclofen+metsulfuron; nipyraclofen+sulfosulfuron; nipyraclofen+thifensulfuron; nipyraclofen+tribenuron; nipyraclofen+2,4-D; nipyraclofen+2,4-DB; nipyraclofen+2,4-DP; nipyraclofen+bifenox; nipyraclofen+ethametsulfuron; nipyraclofen+flamprop-M; nipyraclofen+imazamethabenz; nipyraclofen+ioxynil; nipyraclofen+bromoxynil; nipyraclofen+metosulam; nipyraclofen+pyridate; nipyraclofen+quinmerac; nipyraclofen+tralkoxydim; nipyraclofen+fluoroglycofen-ethyl; nipyraclofen+methabenzthiazuron; nipyraclofen+ethalfluralin; nipyraclofen+pendimethalin; nipyraclofen+trifluralin; nipyraclofen+isoxaben; nipyraclofen+prosulfocarb; nipyraclofen+triallate; nipyraclofen+clopyralid; nipyraclofen+fluroxypyr; nipyraclofen+benazolin-ethyl; nipyraclofen+difenzoquat; nipyraclofen+glyphosate; nipyraclofen+glufosinate; nipyraclofen+sulfosate; benzfendizone+triasulfuron; benzfendizone+prosulfuron; benzfendizone+clodinafop; benzfendizone+terbutryne; benzfendizone+amidosulfuron; benzfendizone+bromoxynil; benzfendizone+carfentrazone; benzfendizone+dicamba; benzfendizone+diclofop-methyl; benzfendizone+diflufenican; benzfendizone+ethoxysulfuron; benzfendizone+fenoxaprop(P-ethyl); benzfendizone+fentrazamide; benzfendizone+flazasulfuron; benzfendizone+florasulam; benzfendizone+fluazolate; benzfendizone+flucarbazone; benzfendizone+flufenacet; benzfendizone+flupyrsulfuron; benzfendizone+flurtamone; benzfendizone+iodosulfuron; benzfendizone+isoproturon; benzfendizone+chlortoluron; benzfendizone+MCPA; benzfendizone+MCPB; benzfendizone+mecoprop; benzfendizone+MCPP; benzfendizone+chlorsulfuron; benzfendizone+metsulfuron; benzfendizone+sulfosulfuron; benzfendizone+thifensulfuron; benzfendizone+tribenuron; benzfendizone+2,4-D; benzfendizone+2,4-DB; benzfendizone+2,4-DP; benzfendizone+bifenox; benzfendizone+ethametsulfuron; benzfendizone+flamprop-M; benzfendizone+imazamethabenz; benzfendizone+ioxynil; benzfendizone+bromoxynil; benzfendizone+metosulam; benzfendizone+pyridate; benzfendizone+quinmerac; benzfendizone+tralkoxydim; benzfendizone+fluoroglycofen-ethyl; benzfendizone+methabenzthiazuron; benzfendizone+ethalfluralin; benzfendizone+pendimethalin; benzfendizone+trifluralin; benzfendizone+isoxaben; benzfendizone+prosulfocarb; benzfendizone+triallate; benzfendizone+clopyralid; benzfendizone+fluroxypyr; benzfendizone+benazolin-ethyl; benzfendizone+difenzoquat; benzfendizone+glyphosate; benzfendizone+glufosinate; benzfendizone+sulfosate; thidiazimin+triasulfuron; thidiazimin+prosulfuron; thidiazimin+clodinafop; thidiazimin+terbutryne; thidiazimin+amidosulfuron; thidiazimin+bromoxynil; thidiazimin+carfentrazone; thidiazimin+dicamba; thidiazimin+diclofop-methyl; thidiazimin+diflufenican; thidiazimin+ethoxysulfuron; thidiazimin+fenoxaprop(P-ethyl); thidiazimin+fentrazamide; thidiazimin+flazasulfuron; thidiazimin+florasulam; thidiazimin+fluazolate; thidiazimin+flucarbazone; thidiazimin+flufenacet; thidiazimin+flupyrsulfuron; thidiazimin+flurtamone; thidiazimin+iodosulfuron; thidiazimin+isoproturon; thidiazimin+chlortoluron; thidiazimin+MCPA; thidiazimin+MCPB; thidiazimin+mecoprop; thidiazimin+MCPP; thidiazimin+chlorsulfuron; thidiazimin+metsulfuron; thidiazimin+sulfosulfuron; thidiazimin+thifensulfuron; thidiazimin+tribenuron; thidiazimin+2,4-D; thidiazimin+2,4-DB; thidiazimin +2,4-DP; thidiazimin+bifenox; thidiazimin+ethametsulfuron; thidiazimin+flamprop-M; thidiazimin+imazamethabenz; thidiazimin+ioxynil; thidiazimin+bromoxynil; thidiazimin+metosulam; thidiazimin+pyridate; thidiazimin+quinmerac; thidiazimin+tralkoxydim; thidiazimin+fluoroglycofen-ethyl; thidiazimin+methabenzthiazuron; thidiazimin+ethalfluralin; thidiazimin+pendimethalin; thidiazimin+trifluralin; thidiazimin+isoxaben; thidiazimin+prosulfocarb; thidiazimin+triallate; thidiazimin+clopyralid; thidiazimin+fluroxypyr; thidiazimin+benazolin-ethyl; thidiazimin+difenzoquat; thidiazimin+glyphosate; thidiazimin+glufosinate; and thidiazimin+sulfosate.

The following combinations of the compounds under a) with the co-herbicides under b) have been found to be very particularly effective synergistic compositions in crops of rice resistant to protoporphyrinogen oxidase inhibitors:

acifluorfen+pretilachlor; acifluorfen+cinosulfuron; acifluorfen+triasulfuron; acifluorfen+fenclorim; acifluorfen+clodinafop; acifluorfen+bensulfuron; acifluorfen+imazosulfuron; acifluorfen+pyrazosulfuron; acifluorfen+metsulfuron; acifluorfen+azimsulfuron; acifluorfen+halosulfuron; acifluorfen+esprocarb; acifluorfen+mefenacet; acifluorfen+molinate; acifluorfen+propanil; acifluorfen+pyrazolate; acifluorfen+cyhalofop; acifluorfen +fenoxaprop; acifluorfen+bispyribac; acifluorfen+pyriminobac; acifluorfen+cafenstrole; acifluorfen+oxadiargyl; acifluorfen+oxadiazon; acifluorfen+bromobutide; acifluorfen+MY-100; acifluorfen+dymron; acifluorfen+NB 061; acifluorfen+MK243; acifluorfen+HW-52; acifluorfen+AC 014; acifluorfen+compound of the formula D; acifluorfen+glyphosate; acifluorfen+glufosinate; acifluorfen+sulfosate; aclonifen+pretilachlor; aclonifen+cinosulfuron; aclonifen+triasulfuron; aclonifen+fenclorim; aclonifen+clodinafop; aclonifen+bensulfuron; aclonifen+imazosulfuron; aclonifen+pyrazosulfuron; aclonifen+metsulfuron; aclonifen+azimsulfuron; aclonifen+halosulfuron; aclonifen+esprocarb; aclonifen+mefenacet; aclonifen+molinate; aclonifen+propanil; aclonifen+pyrazolate; aclonifen+cyhalofop; aclonifen+fenoxaprop; aclonifen+bispyribac; aclonifen +pyriminobac; aclonifen+cafenstrole; aclonifen+oxadiargyl; aclonifen+oxadiazon; aclonifen+bromobutide; aclonifen+MY-100; aclonifen+dymron; aclonifen+NB 061; aclonifen+MK243; aclonifen+HW-52; aclonifen+AC 014; aclonifen+compound of the formula D; aclonifen+glyphosate; aclonifen+glufosinate; aclonifen+sulfosate; bifenox+pretilachlor; bifenox+cinosulfuron; bifenox+triasulfuron; bifenox+fenclorim; bifenox+clodinafop; bifenox+bensulfuron; bifenox+imazosulfuron; bifenox+pyrazosulfuron; bifenox+metsulfuron; bifenox+azimsulfuron; bifenox+halosulfuron; bifenox+esprocarb; bifenox+mefenacet; bifenox+molinate; bifenox+propanil; bifenox+pyrazolate; bifenox+cyhalofop; bifenox+fenoxaprop; bifenox+bispyribac; bifenox+pyriminobac; bifenox+cafenstrole; bifenox+oxadiargyl; bifenox+oxadiazon; bifenox+bromobutide; bifenox+MY-100; bifenox+dymron; bifenox+NB 061; bifenox+MK243; bifenox+HW-52; bifenox +AC 014; bifenox+compound of the formula D; bifenox+glyphosate; bifenox+glufosinate; bifenox+sulfosate; chlomitrofen+pretilachlor; chlomitrofen+cinosulfuron; chlomitrofen+triasulfuron; chlomitrofen+fenclorim; chlomitrofen+clodinafop; chlomitrofen+bensulfuron; chlomitrofen+imazosulfuron; chlomitrofen+pyrazosulfuron; chlomitrofen+metsulfuron; chlomitrofen+azimsulfuron; chlomitrofen+halosulfuron; chlomitrofen+esprocarb; chlomitrofen+mefenacet; chlomitrofen+molinate; chlomitrofen +propanil; chlomitrofen+pyrazolate; chlomitrofen+cyhalofop; chlomitrofen+fenoxaprop; chlomitrofen+bispyribac; chlomitrofen+pyriminobac; chlomitrofen+cafenstrole; chlomitrofen+oxadiargyl; chlomitrofen+oxadiazon; chlomitrofen+bromobutide; chlomitrofen+MY-100; chlomitrofen+dymron; chlomitrofen+NB 061; chlomitrofen+MK243; chlomitrofen+HW-52; chlomitrofen+AC 014; chlomitrofen+compound of the formula D; chlomitrofen+glyphosate; chlomitrofen+glufosinate; chlomitrofen+sulfosate; ethoxyfen+pretilachlor; ethoxyfen+cinosulfuron; ethoxyfen+triasulfuron; ethoxyfen+fenclorim; ethoxyfen+clodinafop; ethoxyfen+bensulfuron; ethoxyfen+imazosulfuron; ethoxyfen+pyrazosulfuron; ethoxyfen+metsulfuron; ethoxyfen+azimsulfuron; ethoxyfen +halosulfuron; ethoxyfen+esprocarb; ethoxyfen+mefenacet; ethoxyfen+molinate; ethoxyfen+propanil; ethoxyfen+pyrazolate; ethoxyfen+cyhalofop; ethoxyfen+fenoxaprop; ethoxyfen+bispyribac; ethoxyfen+pyriminobac; ethoxyfen+cafenstrole; ethoxyfen+oxadiargyl; ethoxyfen+oxadiazon; ethoxyfen+bromobutide; ethoxyfen+MY-100; ethoxyfen+dymron; ethoxyfen+NB 061; ethoxyfen+MK243; ethoxyfen+HW-52; ethoxyfen+AC 014; ethoxyfen+compound of the formula D; ethoxyfen+glyphosate; ethoxyfen+glufosinate; ethoxyfen+sulfosate; fluoroglycofen+pretilachlor; fluoroglycofen +cinosulfuron; fluoroglycofen+triasulfuron; fluoroglycofen+fenclorim; fluoroglycofen+clodinafop; fluoroglycofen+bensulfuron; fluoroglycofen+imazosulfuron; fluoroglycofen+pyrazosulfuron; fluoroglycofen+metsulfuron; fluoroglycofen+azimsulfuron; fluoroglycofen +halosulfuron; fluoroglycofen+esprocarb; fluoroglycofen+mefenacet; fluoroglycofen+molinate; fluoroglycofen+propanil; fluoroglycofen+pyrazolate; fluoroglycofen+cyhalofop; fluoroglycofen+fenoxaprop; fluoroglycofen+bispyribac; fluoroglycofen+pyriminobac; fluoroglycofen+cafenstrole; fluoroglycofen+oxadiargyl; fluoroglycofen+oxadiazon; fluoroglycofen+bromobutide; fluoroglycofen+MY-100; fluoroglycofen+dymron; fluoroglycofen+NB 061; fluoroglycofen+MK243; fluoroglycofen+HW-52; fluoroglycofen+AC 014; fluoroglycofen+compound of the formula D; fluoroglycofen+glyphosate; fluoroglycofen+glufosinate; fluoroglycofen+sulfosate; fomesafen+pretilachlor; fomesafen+cinosulfuron; fomesafen+triasulfuron; fomesafen+fenclorim; fomesafen+clodinafop; fomesafen+bensulfuron; fomesafen+imazosulfuron; fomesafen+pyrazosulfuron; fomesafen+metsulfuron; fomesafen+azimsulfuron; fomesafen+halosulfuron; fomesafen+esprocarb; fomesafen+mefenacet; fomesafen+molinate; fomesafen+propanil; fomesafen+pyrazolate; fomesafen+cyhalofop; fomesafen+fenoxaprop; fomesafen+bispyribac; fomesafen+pyriminobac; fomesafen+cafenstrole; fomesafen+oxadiargyl; fomesafen+oxadiazon; fomesafen+bromobutide; fomesafen+MY-100; fomesafen+dymron; fomesafen+NB 061; fomesafen+MK243; fomesafen+HW-52; fomesafen+AC 014; fomesafen+compound of the formula D; fomesafen+glyphosate; fomesafen+glufosinate; fomesafen+sulfosate; lactofen+pretilachlor; lactofen+cinosulfuron; lactofen+triasulfuron; lactofen+fenclorim; lactofen+clodinafop; lactofen+bensulfuron; lactofen+imazosulfuron; lactofen+pyrazosulfuron; lactofen+metsulfuron; lactofen+azimsulfuron; lactofen+halosulfuron; lactofen+esprocarb; lactofen +mefenacet; lactofen+molinate; lactofen+propanil; lactofen+pyrazolate; lactofen+cyhalofop; lactofen+fenoxaprop; lactofen+bispyribac; lactofen+pyriminobac; lactofen+cafenstrole; lactofen+oxadiargyl; lactofen+oxadiazon; lactofen+bromobutide; lactofen+MY-100; lactofen+dymron; lactofen+NB 061; lactofen+MK243; lactofen+HW-52; lactofen+AC 014; lactofen+compound of the formula D; lactofen+glyphosate; lactofen+glufosinate; lactofen+sulfosate; oxyfluorfen+pretilachlor; oxyfluorfen+cinosulfuron; oxyfluorfen+triasulfuron; oxyfluorfen+fenclorim; oxyfluorfen+clodinafop; oxyfluorfen+bensulfuron; oxyfluorfen+imazosulfuron; oxyfluorfen+pyrazosulfuron; oxyfluorfen+metsulfuron; oxyfluorfen+azimsulfuron; oxyfluorfen+halosulfuron; oxyfluorfen+esprocarb; oxyfluorfen+mefenacet; oxyfluorfen+molinate; oxyfluorfen+propanil; oxyfluorfen+pyrazolate; oxyfluorfen+cyhalofop; oxyfluorfen+fenoxaprop; oxyfluorfen+bispyribac; oxyfluorfen+pyriminobac; oxyfluorfen+cafenstrole; oxyfluorfen+oxadiargyl; oxyfluorfen+oxadiazon; oxyfluorfen+bromobutide; oxyfluorfen+MY-100; oxyfluorfen+dymron; oxyfluorfen+NB 061; oxyfluorfen+MK243; oxyfluorfen+HW-52; oxyfluorfen+AC 014; oxyfluorfen+compound of the formula D; oxyfluorfen+glyphosate; oxyfluorfen+glufosinate; sulfosate; azafenidin+pretilachlor; azafenidin+cinosulfuron; azafenidin+triasulfuron; azafenidin+fenclorim; azafenidin+clodinafop; azafenidin+bensulfuron; azafenidin+imazosulfuron; azafenidin+pyrazosulfuron; azafenidin+metsulfuron; azafenidin+azimsulfuron; azafenidin+halosulfuron; azafenidin+esprocarb; azafenidin+mefenacet; azafenidin+molinate; azafenidin+propanil; azafenidin+pyrazolate; azafenidin +cyhalofop; azafenidin+fenoxaprop; azafenidin+bispyribac; azafenidin+pyriminobac; azafenidin+cafenstrole; azafenidin+oxadiargyl; azafenidin+oxadiazon; azafenidin+bromobutide; azafenidin+MY-100; azafenidin+dymron; azafenidin+NB 061; azafenidin+MK243; azafenidin+HW-52; azafenidin+AC 014; azafenidin+compound of the formula D; azafenidin+glyphosate; azafenidin+glufosinate; azafenidin+sulfosate; carfentrazone-ethyl+pretilachlor; carfentrazone-ethyl+cinosulfuron; carfentrazone-ethyl+triasulfuron; carfentrazone-ethyl+fenclorim; carfentrazone-ethyl+clodinafop; carfentrazone-ethyl+bensulfuron; carfentrazone-ethyl+imazosulfuron; carfentrazone-ethyl+pyrazosulfuron; carfentrazone-ethyl+metsulfuron; carfentrazone-ethyl+azimsulfuron; carfentrazone-ethyl +halosulfuron; carfentrazone-ethyl+esprocarb; carfentrazone-ethyl+mefenacet; carfentrazone-ethyl+molinate; carfentrazone-ethyl+propanil; carfentrazone-ethyl+pyrazolate; carfentrazone-ethyl+cyhalofop; carfentrazone-ethyl+fenoxaprop; carfentrazone-ethyl+bispyribac; carfentrazone-ethyl+pyriminobac; carfentrazone-ethyl+cafenstrole; carfentrazone-ethyl+oxadiargyl; carfentrazone-ethyl+oxadiazon; carfentrazone-ethyl+bromobutide; carfentrazone-ethyl+MY-100; carfentrazone-ethyl+dymron; carfentrazone -ethyl+NB 061; carfentrazone-ethyl+MK243; carfentrazone-ethyl+HW-52; carfentrazone-ethyl+AC 014; carfentrazone-ethyl+compound of the formula D; carfentrazone-ethyl+glyphosate; carfentrazone-ethyl+glufosinate; carfentrazone-ethyl+sulfosate; compound of the formula A+pretilachlor; compound of the formula A+cinosulfuron; compound of the formula A+triasulfuron; compound of the formula A+fenclorim; compound of the formula A+clodinafop; compound of the formula A+bensulfuron; compound of the formula A+imazosulfuron; compound of the formula A+pyrazosulfuron; compound of the formula A+metsulfuron; compound of the formula A+azimsulfuron; compound of the formula A+halosulfuron; compound of the formula A+esprocarb; compound of the formula A+mefenacet; compound of the formula A+molinate; compound of the formula A+propanil; compound of the formula A+pyrazolate; compound of the formula A+cyhalofop; compound of the formula A+fenoxaprop; compound of the formula A+bispyribac; compound of the formula A+pyriminobac; compound of the formula A+cafenstrole; compound of the formula A+oxadiargyl; compound of the formula A+oxadiazon; compound of the formula A+bromobutide; compound of the formula A+MY-100; compound of the formula A+dymron; compound of the formula A+NB 061; compound of the formula A+MK243; compound of the formula A+HW-52; compound of the formula A+AC 014; compound of the formula A+compound of the formula D; compound of the formula A+glyphosate; compound of the formula A+glufosinate; compound of the formula A+sulfosate; cinidon-ethyl+pretilachlor; cinidon-ethyl+cinosulfuron; cinidon-ethyl+triasulfuron; cinidon-ethyl+fenclorim; cinidon-ethyl+clodinafop; cinidon-ethyl+bensulfuron; cinidon-ethyl+imazosulfuron; cinidon-ethyl+pyrazosulfuron; cinidon-ethyl+metsulfuron; cinidon-ethyl+azimsulfuron; cinidon-ethyl+halosulfuron; cinidon-ethyl+esprocarb; cinidon-ethyl+mefenacet; cinidon-ethyl+molinate; cinidon-ethyl+propanil; cinidon-ethyl+pyrazolate; cinidon-ethyl+cyhalofop; cinidon-ethyl +fenoxaprop; cinidon-ethyl+bispyribac; cinidon-ethyl+pyriminobac; cinidon-ethyl+cafenstrole; cinidon-ethyl+oxadiargyl; cinidon-ethyl+oxadiazon; cinidon-ethyl+bromobutide; cinidon-ethyl+MY-100; cinidon-ethyl+dymron; cinidon-ethyl+NB 061; cinidon-ethyl+MK243; cinidon-ethyl+HW-52; cinidon-ethyl+AC 014; cinidon-ethyl+compound of the formula D; cinidon-ethyl+glyphosate; cinidon-ethyl+glufosinate; cinidon-ethyl+sulfosate; flumiclorac-pentyl+pretilachlor; flumiclorac-pentyl+cinosulfuron; flumiclorac-pentyl+triasulfuron; flumiclorac-pentyl+fenclorim; flumiclorac-pentyl+clodinafop; flumiclorac-pentyl+bensulfuron; flumiclorac-pentyl+imazosulfuron; flumiclorac-pentyl+pyrazosulfuron; flumiclorac-pentyl+metsulfuron; flumiclorac-pentyl+azimsulfuron; flumiclorac-pentyl+halosulfuron; flumiclorac-pentyl+esprocarb; flumiclorac-pentyl+mefenacet; flumiclorac-pentyl+molinate; flumiclorac-pentyl+propanil; flumiclorac-pentyl+pyrazolate; flumiclorac-pentyl+cyhalofop; flumiclorac-pentyl+fenoxaprop; flumiclorac-pentyl+bispyribac; flumiclorac-pentyl+pyriminobac; flumiclorac-pentyl+cafenstrole; flumiclorac-pentyl+oxadiargyl; flumiclorac-pentyl+oxadiazon; flumiclorac-pentyl+bromobutide; flumiclorac-pentyl+MY-100; flumiclorac-pentyl+dymron; flumiclorac-pentyl+NB 061; flumiclorac-pentyl+MK243; flumiclorac-pentyl+HW-52; flumiclorac-pentyl+AC 014; flumiclorac-pentyl+compound of the formula D; flumiclorac-pentyl+glyphosate; flumiclorac-pentyl+glufosinate; flumiclorac-pentyl+sulfosate; flumioxazin+pretilachlor; flumioxazin+cinosulfuron; flumioxazin+triasulfuron; flumioxazin+fenclorim; flumioxazin+clodinafop; flumioxazin+bensulfuron; flumioxazin+imazosulfuron; flumioxazin+pyrazosulfuron; flumioxazin+metsulfuron; flumioxazin+azimsulfuron; flumioxazin+halosulfuron; flumioxazin+esprocarb; flumioxazin+mefenacet; flumioxazin+molinate; flumioxazin+propanil; flumioxazin+pyrazolate; flumioxazin+cyhalofop; flumioxazin+fenoxaprop; flumioxazin+bispyribac; flumioxazin+pyriminobac; flumioxazin+cafenstrole; flumioxazin+oxadiargyl; flumioxazin+oxadiazon; flumioxazin+bromobutide; flumioxazin+MY-100; flumioxazin+dymron; flumioxazin+NB 061; flumioxazin+MK243; flumioxazin+HW-52; flumioxazin+AC 014; flumioxazin+compound of the formula D; flumioxazin+glyphosate; flumioxazin+glufosinate; flumioxazin+sulfosate; fluthiacet-methyl+pretilachlor; fluthiacet-methyl+cinosulfuron; fluthiacet-methyl+triasulfuron; fluthiacet-methyl+fenclorim; fluthiacet-methyl+clodinafop; fluthiacet-methyl+bensulfuron; fluthiacet-methyl+imazosulfuron; fluthiacet-methyl+pyrazosulfuron; fluthiacet-methyl+metsulfuron; fluthiacet-methyl+azimsulfuron; fluthiacet-methyl+halosulfuron; fluthiacet-methyl+esprocarb; fluthiacet-methyl+mefenacet; fluthiacet-methyl+molinate; fluthiacet-methyl+propanil; fluthiacet-methyl+pyrazolate; fluthiacet-methyl+cyhalofop; fluthiacet-methyl+fenoxaprop; fluthiacet-methyl+bispyribac; fluthiacet-methyl+pyriminobac; fluthiacet-methyl+cafenstrole; fluthiacet-methyl+oxadiargyl; fluthiacet-methyl+oxadiazon; fluthiacet-methyl+bromobutide; fluthiacet-methyl+MY-100; fluthiacet-methyl+dymron; fluthiacet-methyl+NB 061; fluthiacet-methyl+MK243; fluthiacet-methyl+HW-52; fluthiacet-methyl+AC 014; fluthiacet-methyl+compound of the formula D; fluthiacet-methyl +glyphosate; fluthiacet-methyl+glufosinate; fluthiacet-methyl+sulfosate; oxadiargyl+pretilachlor; oxadiargyl+cinosulfuron; oxadiargyl+triasulfuron; oxadiargyl+fenclorim; oxadiargyl+clodinafop; oxadiargyl+bensulfuron; oxadiargyl+imazosulfuron; oxadiargyl+pyrazosulfuron; oxadiargyl+metsulfuron; oxadiargyl+azimsulfuron; oxadiargyl+halosulfuron; oxadiargyl+esprocarb; oxadiargyl+mefenacet; oxadiargyl+molinate; oxadiargyl+propanil; oxadiargyl+pyrazolate; oxadiargyl+cyhalofop; oxadiargyl+fenoxaprop; oxadiargyl+bispyribac; oxadiargyl+pyriminobac; oxadiargyl+cafenstrole; oxadiargyl+oxadiazon; oxadiargyl+bromobutide; oxadiargyl+MY-100; oxadiargyl+dymron; oxadiargyl+NB 061; oxadiargyl+MK243; oxadiargyl+HW-52; oxadiargyl+AC 014; oxadiargyl+compound of the formula D; oxadiargyl+glyphosate; oxadiargyl+glufosinate; oxadiargyl+sulfosate; oxadiazon+pretilachlor; oxadiazon+cinosulfuron; oxadiazon+triasulfuron; oxadiazon+fenclorim; oxadiazon+clodinafop; oxadiazon+bensulfuron; oxadiazon+imazosulfuron; oxadiazon+pyrazosulfuron; oxadiazon+metsulfuron; oxadiazon+azimsulfuron; oxadiazon+halosulfuron; oxadiazon+esprocarb; oxadiazon+mefenacet; oxadiazon+molinate; oxadiazon+propanil; oxadiazon+pyrazolate; oxadiazon+cyhalofop; oxadiazon+fenoxaprop; oxadiazon+bispyribac; oxadiazon+pyriminobac; oxadiazon+cafenstrole; oxadiazon+oxadiargyl; oxadiazon+bromobutide; oxadiazon+MY-100; oxadiazon+dymron; oxadiazon+NB 061; oxadiazon+MK243; oxadiazon+HW-52; oxadiazon+AC 014; oxadiazon+compound of the formula D; oxadiazon+glyphosate; oxadiazon+glufosinate; oxadiazon+sulfosate; pentoxazone+pretilachlor; pentoxazone+cinosulfuron; pentoxazone+triasulfuron; pentoxazone+fenclorim; pentoxazone+clodinafop; pentoxazone+bensulfuron; pentoxazone+imazosulfuron; pentoxazone+pyrazosulfuron; pentoxazone+metsulfuron; pentoxazone+azimsulfuron; pentoxazone+halosulfuron; pentoxazone+esprocarb; pentoxazone+mefenacet; pentoxazone+molinate; pentoxazone+propanil; pentoxazone+pyrazolate; pentoxazone+cyhalofop; pentoxazone+fenoxaprop; pentoxazone+bispyribac; pentoxazone+pyriminobac; pentoxazone+cafenstrole; pentoxazone+oxadiargyl; pentoxazone+oxadiazon; pentoxazone+bromobutide; pentoxazone+MY-100; pentoxazone+dymron; pentoxazone+NB 061; pentoxazone+MK243; pentoxazone+HW-52; pentoxazone+AC 014; pentoxazone+compound of the formula D; pentoxazone+glyphosate; pentoxazone+glufosinate; pentoxazone+sulfosate; sulfentrazone+pretilachlor; sulfentrazone+cinosulfuron; sulfentrazone+triasulfuron; sulfentrazone+fenclorim; sulfentrazone+clodinafop; sulfentrazone+bensulfuron; sulfentrazone+imazosulfuron; sulfentrazone+pyrazosulfuron; sulfentrazone+metsulfuron; sulfentrazone +azimsulfuron; sulfentrazone+halosulfuron; sulfentrazone+esprocarb; sulfentrazone+mefenacet; sulfentrazone+molinate; sulfentrazone+propanil; sulfentrazone+pyrazolate; sulfentrazone+cyhalofop; sulfentrazone+fenoxaprop; sulfentrazone+bispyribac; sulfentrazone+pyriminobac; sulfentrazone+cafenstrole; sulfentrazone+oxadiargyl; sulfentrazone+oxadiazon; sulfentrazone+bromobutide; sulfentrazone+MY-100; sulfentrazone+dymron; sulfentrazone+NB 061; sulfentrazone+MK243; sulfentrazone+HW-52; sulfentrazone+AC 014; sulfentrazone+compound of the formula D; sulfentrazone +glyphosate; sulfentrazone+glufosinate; sulfentrazone+sulfosate; fluazolate+pretilachlor; fluazolate+cinosulfuron; fluazolate+triasulfuron; fluazolate+fenclorim; fluazolate+clodinafop; fluazolate+bensulfuron; fluazolate+imazosulfuron; fluazolate+pyrazosulfuron; fluazolate+metsulfuron; fluazolate+azimsulfuron; fluazolate+halosulfuron; fluazolate+esprocarb; fluazolate+mefenacet; fluazolate+molinate; fluazolate+propanil; fluazolate+pyrazolate; fluazolate+cyhalofop; fluazolate+fenoxaprop; fluazolate+bispyribac; fluazolate+pyriminobac; fluazolate+cafenstrole; fluazolate+oxadiargyl; fluazolate+oxadiazon; fluazolate+bromobutide; fluazolate+MY-100; fluazolate+dymron; fluazolate+NB 061; fluazolate+MK243; fluazolate+HW-52; fluazolate+AC 014; fluazolate+compound of the formula D; fluazolate+glyphosate; fluazolate+glufosinate; fluazolate+sulfosate; pyraflufen-ethyl+pretilachlor; pyraflufen-ethyl+cinosulfuron; pyraflufen-ethyl+triasulfuron; pyraflufen-ethyl+fenclorim; pyraflufen-ethyl+clodinafop; pyraflufen-ethyl+bensulfuron; pyraflufen-ethyl+imazosulfuron; pyraflufen-ethyl+pyrazosulfuron; pyraflufen-ethyl+metsulfuron; pyraflufen-ethyl+azimsulfuron; pyraflufen-ethyl+halosulfuron; pyraflufen-ethyl+esprocarb; pyraflufen-ethyl +mefenacet; pyraflufen-ethyl+molinate; pyraflufen-ethyl+propanil; pyraflufen-ethyl+pyrazolate; pyraflufen-ethyl+cyhalofop; pyraflufen-ethyl+fenoxaprop; pyraflufen-ethyl+bispyribac; pyraflufen-ethyl+pyriminobac; pyraflufen-ethyl+cafenstrole; pyraflufen-ethyl+oxadiargyl; pyraflufen-ethyl+oxadiazon; pyraflufen-ethyl+bromobutide; pyraflufen-ethyl+MY-100; pyraflufen-ethyl+dymron; pyraflufen-ethyl+NB 061; pyraflufen-ethyl+MK243; pyraflufen-ethyl+HW-52; pyraflufen-ethyl+AC 014; pyraflufen-ethyl+compound of the formula D; pyraflufen-ethyl+glyphosate; pyraflufen-ethyl+glufosinate; pyraflufen-ethyl+sulfosate; flumipropyn+pretilachlor; flumipropyn+cinosulfuron; flumipropyn+triasulfuron; flumipropyn+fenclorim; flumipropyn+clodinafop; flumipropyn+bensulfuron; flumipropyn+imazosulfuron; flumipropyn+pyrazosulfuron; flumipropyn+metsulfuron; flumipropyn+azimsulfuron; flumipropyn+halosulfuron; flumipropyn+esprocarb; flumipropyn+mefenacet; flumipropyn+molinate; flumipropyn+propanil; flumipropyn+pyrazolate; flumipropyn+cyhalofop; flumipropyn+fenoxaprop; flumipropyn+bispyribac; flumipropyn+pyriminobac; flumipropyn+cafenstrole; flumipropyn+oxadiargyl; flumipropyn+oxadiazon; flumipropyn+bromobutide; flumipropyn+MY-100; flumipropyn+dymron; flumipropyn+NB 061; flumipropyn+MK243; flumipropyn+HW-52; flumipropyn+AC 014; flumipropyn+compound of the formula D; flumipropyn+glyphosate; flumipropyn+glufosinate; flumipropyn+sulfosate; flupropacil+pretilachlor; flupropacil+cinosulfuron; flupropacil+triasulfuron; flupropacil+fenclorim; flupropacil+clodinafop; flupropacil+bensulfuron; flupropacil+imazosulfuron; flupropacil+pyrazosulfuron; flupropacil+metsulfuron; flupropacil+azimsulfuron; flupropacil+halosulfuron; flupropacil+esprocarb; flupropacil+mefenacet; flupropacil+molinate; flupropacil+propanil; flupropacil+pyrazolate; flupropacil +cyhalofop; flupropacil+fenoxaprop; flupropacil+bispyribac; flupropacil+pyriminobac; flupropacil+cafenstrole; flupropacil+oxadiargyl; flupropacil+oxadiazon; flupropacil+bromobutide; flupropacil+MY-100; flupropacil+dymron; flupropacil+NB 061; flupropacil+MK243; flupropacil+HW-52; flupropacil+AC 014; flupropacil+compound of the formula D; flupropacil+glyphosate; flupropacil+glufosinate; flupropacil+sulfosate; nipyraclofen+pretilachlor; nipyraclofen+cinosulfuron; nipyraclofen+triasulfuron; nipyraclofen+fenclorim; nipyraclofen+clodinafop; nipyraclofen+bensulfuron; nipyraclofen+imazosulfuron; nipyraclofen+pyrazosulfuron; nipyraclofen+metsulfuron; nipyraclofen+azimsulfuron; nipyraclofen+halosulfuron; nipyraclofen+esprocarb; nipyraclofen+mefenacet; nipyraclofen+molinate; nipyraclofen+propanil; nipyraclofen+pyrazolate; nipyraclofen+cyhalofop; nipyraclofen+fenoxaprop; nipyraclofen+bispyribac; nipyraclofen +pyriminobac; nipyraclofen+cafenstrole; nipyraclofen+oxadiargyl; nipyraclofen+oxadiazon; nipyraclofen+bromobutide; nipyraclofen+MY-100; nipyraclofen+dymron; nipyraclofen+NB 061; nipyraclofen+MK243; nipyraclofen+HW-52; nipyraclofen+AC 014; nipyraclofen+compound of the formula D; nipyraclofen+glyphosate; nipyraclofen+glufosinate; nipyraclofen+sulfosate; benzfendizone+pretilachlor; benzfendizone+cinosulfuron; benzfendizone+triasulfuron; benzfendizone+fenclorim; benzfendizone+clodinafop; benzfendizone+bensulfuron; benzfendizone+imazosulfuron; benzfendizone+pyrazosulfuron; benzfendizone+metsulfuron; benzfendizone+azimsulfuron; benzfendizone+halosulfuron; benzfendizone+esprocarb; benzfendizone+mefenacet; benzfendizone+molinate; benzfendizone+propanil; benzfendizone+pyrazolate; benzfendizone+cyhalofop; benzfendizone+fenoxaprop; benzfendizone+bispyribac; benzfendizone+pyriminobac; benzfendizone+cafenstrole; benzfendizone+oxadiargyl; benzfendizone+oxadiazon; benzfendizone+bromobutide; benzfendizone+MY-100; benzfendizone+dymron; benzfendizone+NB 061; benzfendizone+MK243; benzfendizone+HW-52; benzfendizone+AC 014; benzfendizone+compound of the formula D; benzfendizone+glyphosate; benzfendizone+glufosinate; benzfendizone+sulfosate; thidiazimin+pretilachlor; thidiazimin+cinosulfuron; thidiazimin+triasulfuron; thidiazimin+fenclorim; thidiazimin+clodinafop; thidiazimin+bensulfuron; thidiazimin+imazosulfuron; thidiazimin+pyrazosulfuron; thidiazimin+metsulfuron; thidiazimin+azimsulfuron; thidiazimin+halosulfuron; thidiazimin+esprocarb; thidiazimin+mefenacet; thidiazimin+molinate; thidiazimin+propanil; thidiazimin+pyrazolate; thidiazimin+cyhalofop; thidiazimin+fenoxaprop; thidiazimin+bispyribac; thidiazimin+pyriminobac; thidiazimin+cafenstrole; thidiazimin+oxadiargyl; thidiazimin+oxadiazon; thidiazimin+bromobutide; thidiazimin+MY-100; thidiazimin+dymron; thidiazimin+NB 061; thidiazimin +MK243; thidiazimin+HW-52; thidiazimin+AC 014; thidiazimin+compound of the formula D; thidiazimin+glyphosate; thidiazimin+glufosinate; and thidiazimin+sulfosate.

The following combinations of the compounds under a) with the co-herbicides under b) have been found to be very particularly effective synergistic compositions in crops of sugar cane resistant to protoporphyrinogen oxidase inhibitors:

acifluorfen+atrazine; acifluorfen+ametryn; acifluorfen+dicamba; acifluorfen+terbutryn; acifluorfen+prosulfuron; acifluorfen+hexazinone; acifluorfen+asulam; acifluorfen+diuron; acifluorfen+2,4-D; acifluorfen+halosulfuron; acifluorfen+flazasulfuron; acifluorfen +isoxaflutole; acifluorfen+azafenidin; acifluorfen+tebuthiuron; acifluorfen+sulcotrione; acifluorfen+pendimethalin; acifluorfen+clomazone; acifluorfen+metribuzin; acifluorfen+thiazopyr; acifluorfen+ethoxysulfuron; acifluorfen+compound of the formula C; acifluorfen +glyphosate; acifluorfen+glufosinate; acifluorfen+sulfosate; aclonifen+atrazine; aclonifen+ametryn; aclonifen+dicamba; aclonifen+terbutryn; aclonifen+prosulfuron; aclonifen+hexazinone; aclonifen+asulam; aclonifen+diuron; aclonifen+2,4-D; aclonifen +halosulfuron; aclonifen+flazasulfuron; aclonifen+isoxaflutole; aclonifen+azafenidin; aclonifen+tebuthiuron; aclonifen+sulcotrione; aclonifen+pendimethalin; aclonifen+clomazone; aclonifen+metribuzin; aclonifen+thiazopyr, aclonifen+ethoxysulfuron; aclonifen+compound of the formula C; aclonifen+glyphosate; aclonifen+glufosinate; aclonifen+sulfosate; bifenox+atrazine; bifenox+ametryn; bifenox+dicamba; bifenox+terbutryn; bifenox+prosulfuron; bifenox+hexazinone; bifenox+asulam; bifenox+diuron; bifenox+2,4-D; bifenox+halosulfuron; bifenox+flazasulfuron; bifenox+isoxaflutole; bifenox+azafenidin; bifenox+tebuthiuron; bifenox+sulcotrione; bifenox+pendimethalin; bifenox+clomazone; bifenox+metribuzin; bifenox+thiazopyr; bifenox+ethoxysulfuron; bifenox+compound of the formula C; bifenox+glyphosate; bifenox+glufosinate; bifenox +sulfosate; chlomitrofen+atrazine; chlomitrofen+ametryn; chlomitrofen+dicamba; chlomitrofen+terbutryn; chlomitrofen+prosulfuron; chlomitrofen+hexazinone; chlomitrofen+asulam; chlomitrofen+diuron; chlomitrofen+2,4-D; chlomitrofen+halosulfuron; chlomitrofen+flazasulfuron; chlomitrofen+isoxaflutole; chlomitrofen+azafenidin; chlomitrofen+tebuthiuron; chlomitrofen+sulcotrione; chlomitrofen+pendimethalin; chlomitrofen+clomazone; chlomitrofen+metribuzin; chlomitrofen+thiazopyr; chlomitrofen+ethoxysulfuron; chlomitrofen+compound of the formula C; chlomitrofen+glyphosate; chlomitrofen+glufosinate; chlomitrofen+sulfosate; ethoxyfen+atrazine; ethoxyfen+ametryn; ethoxyfen+dicamba; ethoxyfen+terbutryn; ethoxyfen+prosulfuron; ethoxyfen+hexazinone; ethoxyfen+asulam; ethoxyfen+diuron; ethoxyfen+2,4-D; ethoxyfen+halosulfuron; ethoxyfen+flazasulfuron; ethoxyfen+isoxaflutole; ethoxyfen+azafenidin; ethoxyfen+tebuthiuron; ethoxyfen+sulcotrione; ethoxyfen+pendimethalin; ethoxyfen+clomazone; ethoxyfen+metribuzin; ethoxyfen+thiazopyr; ethoxyfen+ethoxysulfuron; ethoxyfen+compound of the formula C; ethoxyfen+glyphosate; ethoxyfen+glufosinate; ethoxyfen+sulfosate; fluoroglycofen+atrazine; fluoroglycofen+ametryn; fluoroglycofen+dicamba; fluoroglycofen+terbutryn; fluoroglycofen+prosulfuron; fluoroglycofen+hexazinone; fluoroglycofen+asulam; fluoroglycofen+diuron; fluoroglycofen+2,4-D; fluoroglycofen+halosulfuron; fluoroglycofen+flazasulfuron; fluoroglycofen+isoxaflutole; fluoroglycofen+azafenidin; fluoroglycofen+tebuthiuron; fluoroglycofen+sulcotrione; fluoroglycofen+pendimethalin; fluoroglycofen+clomazone; fluoroglycofen+metribuzin; fluoroglycofen+thiazopyr; fluoroglycofen+ethoxysulfuron; fluoroglycofen+compound of the formula C; fluoroglycofen+glyphosate; fluoroglycofen+glufosinate; fluoroglycofen+sulfosate; fomesafen+atrazine; fomesafen+ametryn; fomesafen+dicamba; fomesafen+terbutryn; fomesafen+prosulfuron; fomesafen+hexazinone; fomesafen+asulam; fomesafen+diuron; fomesafen+2,4-D; fomesafen+halosulfuron; fomesafen+flazasulfuron; fomesafen+isoxaflutole; fomesafen+azafenidin; fomesafen+tebuthiuron; fomesafen+sulcotrione; fomesafen+pendimethalin; fomesafen+clomazone; fomesafen+metribuzin; fomesafen+thiazopyr; fomesafen+ethoxysulfuron; fomesafen+compound of the formula C; fomesafen+glyphosate; fomesafen+glufosinate; fomesafen+sulfosate; lactofen+atrazine; lactofen+ametryn; lactofen+dicamba; lactofen+terbutryn; lactofen+prosulfuron; lactofen+hexazinone; lactofen+asulam; lactofen+diuron; lactofen+2,4-D; lactofen+halosulfuron; lactofen+flazasulfuron; lactofen+isoxaflutole; lactofen+azafenidin; lactofen+tebuthiuron; lactofen+sulcotrione; lactofen+pendimethalin; lactofen +clomazone; lactofen+metribuzin; lactofen+thiazopyr; lactofen+ethoxysulfuron; lactofen +compound of the formula C; lactofen+glyphosate; lactofen+glufosinate; lactofen+sulfosate; oxyfluorfen+atrazine; oxyfluorfen+ametryn; oxyfluorfen+dicamba; oxyfluorfen +terbutryn; oxyfluorfen+prosulfuron; oxyfluorfen+hexazinone; oxyfluorfen+asulam; oxyfluorfen+diuron; oxyfluorfen+2,4-D; oxyfluorfen+halosulfuron; oxyfluorfen+flazasulfuron; oxyfluorfen+isoxaflutole; oxyfluorfen+azafenidin; oxyfluorfen+tebuthiuron; oxyfluorfen+sulcotrione; oxyfluorfen+pendimethalin; oxyfluorfen+clomazone; oxyfluorfen +metribuzin; oxyfluorfen+thiazopyr; oxyfluorfen+ethoxysulfuron; oxyfluorfen+compound of the formula C; oxyfluorfen+glyphosate; oxyfluorfen+glufosinate; oxyfluorfen+sulfosate; azafenidin+atrazine; azafenidin+ametryn; azafenidin+dicamba; azafenidin+terbutryn; azafenidin+prosulfuron; azafenidin+hexazinone; azafenidin+asulam; azafenidin+diuron; azafenidin+2,4-D; azafenidin+halosulfuron; azafenidin+flazasulfuron; azafenidin+isoxaflutole; azafenidin+tebuthiuron; azafenidin+sulcotrione; azafenidin+pendimethalin; azafenidin+clomazone; azafenidin+metribuzin; azafenidin+thiazopyr; azafenidin+ethoxysulfuron; azafenidin+compound of the formula C; azafenidin +glyphosate; azafenidin+glufosinate; azafenidin+sulfosate; carfentrazone-ethyl+atrazine; carfentrazone-ethyl+ametryn; carfentrazone-ethyl+dicamba; carfentrazone-ethyl +terbutryn; carfentrazone-ethyl+prosulfuron; carfentrazone-ethyl+hexazinone; carfentrazone-ethyl+asulam; carfentrazone-ethyl+diuron; carfentrazone-ethyl+2,4-D; carfentrazone-ethyl+halosulfuron; carfentrazone-ethyl+flazasulfuron; carfentrazone-ethyl +isoxaflutole; carfentrazone-ethyl+azafenidin; carfentrazone-ethyl+tebuthiuron; carfentrazone-ethyl+sulcotrione; carfentrazone-ethyl+pendimethalin; carfentrazone-ethyl +clomazone; carfentrazone-ethyl+metribuzin; carfentrazone-ethyl+thiazopyr; carfentrazone-ethyl+ethoxysulfuron; carfentrazone-ethyl+compound of the formula C; carfentrazone-ethyl+glyphosate; carfentrazone-ethyl+glufosinate; carfentrazone-ethyl+sulfosate; compound of the formula A+atrazine; compound of the formula A+ametryn; compound of the formula A+dicamba; compound of the formula A+terbutryn; compound of the formula A+prosulfuron; compound of the formula A+hexazinone; compound of the formula A+asulam; compound of the formula A+diuron; compound of the formula A+2,4-D; compound of the formula A+halosulfuron; compound of the formula A+flazasulfuron; compound of the formula A+isoxaflutole; compound of the formula A+azafenidin; compound of the formula A+tebuthiuron; compound of the formula A+sulcotrione; compound of the formula A+pendimethalin; compound of the formula A+clomazone; compound of the formula A+metribuzin; compound of the formula A+thiazopyr; compound of the formula A+ethoxysulfuron; compound of the formula A+compound of the formula C; compound of the formula A+glyphosate; compound of the formula A+glufosinate; compound of the formula A+sulfosate; cinidon-ethyl+atrazine; cinidon-ethyl+ametryn; cinidon-ethyl+dicamba; cinidon-ethyl+terbutryn; cinidon-ethyl+prosulfuron; cinidon-ethyl+hexazinone; cinidon-ethyl+asulam; cinidon-ethyl+diuron; cinidon-ethyl+2,4-D; cinidon-ethyl+halosulfuron; cinidon-ethyl+flazasulfuron; cinidon-ethyl+isoxaflutole; cinidon-ethyl+azafenidin; cinidon-ethyl+tebuthiuron; cinidon-ethyl+sulcotrione; cinidon-ethyl+pendimethalin; cinidon-ethyl+clomazone; cinidon-ethyl+metribuzin; cinidon-ethyl+thiazopyr; cinidon-ethyl+ethoxysulfuron; cinidon-ethyl+compound of the formula C; cinidon-ethyl+glyphosate; cinidon-ethyl+glufosinate; cinidon-ethyl+sulfosate; flumiclorac-pentyl+atrazine; flumiclorac-pentyl+ametryn; flumiclorac-pentyl+dicamba; flumiclorac-pentyl+terbutryn; flumiclorac-pentyl+prosulfuron; flumiclorac-pentyl+hexazinone; flumiclorac-pentyl+asulam; flumiclorac-pentyl+diuron; flumiclorac-pentyl+2,4-D; flumiclorac-pentyl+halosulfuron; flumiclorac-pentyl+flazasulfuron; flumiclorac-pentyl+isoxaflutole; flumiclorac-pentyl+azafenidin; flumiclorac-pentyl+tebuthiuron; flumiclorac-pentyl+sulcotrione; flumiclorac-pentyl+pendimethalin; flumiclorac-pentyl+clomazone; flumiclorac-pentyl+metribuzin; flumiclorac-pentyl+thiazopyr; flumiclorac-pentyl+ethoxysulfuron; flumiclorac-pentyl+compound of the formula C; flumiclorac-pentyl+glyphosate; flumiclorac-pentyl+glufosinate; flumiclorac-pentyl+sulfosate; flumioxazin+atrazine; flumioxazin+ametryn; flumioxazin+dicamba; flumioxazin +terbutryn; flumioxazin+prosulfuron; flumioxazin+hexazinone; flumioxazin+asulam; flumioxazin+diuron; flumioxazin+2,4-D; flumioxazin+halosulfuron; flumioxazin+flazasulfuron; flumioxazin+isoxaflutole; flumioxazin+azafenidin; flumioxazin+tebuthiuron; flumioxazin+sulcotrione; flumioxazin+pendimethalin; flumioxazin+clomazone; flumioxazin+metribuzin; flumioxazin+thiazopyr; flumioxazin+ethoxysulfuron; flumioxazin +compound of the formula C; flumioxazin+glyphosate; flumioxazin+glufosinate; flumioxazin+sulfosate; fluthiacet-methyl+atrazine; fluthiacet-methyl+ametryn; fluthiacet-methyl+dicamba; fluthiacet-methyl+terbutryn; fluthiacet-methyl+prosulfuron; fluthiacet-methyl+hexazinone; fluthiacet-methyl+asulam; fluthiacet-methyl+diuron; fluthiacet-methyl+2,4-D; fluthiacet-methyl+halosulfuron; fluthiacet-methyl+flazasulfuron; fluthiacet-methyl+isoxaflutole; fluthiacet-methyl+azafenidin; fluthiacet-methyl+tebuthiuron; fluthiacet-methyl+sulcotrione; fluthiacet-methyl+pendimethalin; fluthiacet-methyl+clomazone; fluthiacet-methyl+metribuzin; fluthiacet-methyl+thiazopyr; fluthiacet-methyl+ethoxysulfuron; fluthiacet-methyl+compound of the formula C; fluthiacet-methyl+glyphosate; fluthiacet-methyl+glufosinate; fluthiacet-methyl+sulfosate; oxadiargyl+atrazine; oxadiargyl+ametryn; oxadiargyl+dicamba; oxadiargyl+terbutryn; oxadiargyl+prosulfuron; oxadiargyl+hexazinone; oxadiargyl+asulam; oxadiargyl+diuron; oxadiargyl +2,4-D; oxadiargyl+halosulfuron; oxadiargyl+flazasulfuron; oxadiargyl+isoxaflutole; oxadiargyl+azafenidin; oxadiargyl+tebuthiuron; oxadiargyl+sulcotrione; oxadiargyl+pendimethalin; oxadiargyl+clomazone; oxadiargyl+metribuzin; oxadiargyl+thiazopyr; oxadiargyl+ethoxysulfuron; oxadiargyl+compound of the formula C; oxadiargyl+glyphosate; oxadiargyl+glufosinate; oxadiargyl+sulfosate; oxadiazon+atrazine; oxadiazon+ametryn; oxadiazon+dicamba; oxadiazon+terbutryn; oxadiazon+prosulfuron; oxadiazon+hexazinone; oxadiazon+asulam; oxadiazon+diuron; oxadiazon +2,4-D; oxadiazon+halosulfuron; oxadiazon+flazasulfuron; oxadiazon+isoxaflutole; oxadiazon+azafenidin; oxadiazon+tebuthiuron; oxadiazon+sulcotrione; oxadiazon+pendimethalin; oxadiazon+clomazone; oxadiazon+metribuzin; oxadiazon+thiazopyr; oxadiazon+ethoxysulfuron; oxadiazon+compound of the formula C; oxadiazon+glyphosate; oxadiazon+glufosinate; oxadiazon+sulfosate; pentoxazone+atrazine; pentoxazone+ametryn; pentoxazone+dicamba; pentoxazone+terbutryn; pentoxazone+prosulfuron; pentoxazone+hexazinone; pentoxazone+asulam; pentoxazone+diuron; pentoxazone+2,4-D; pentoxazone+halosulfuron; pentoxazone+flazasulfuron; pentoxazone+isoxaflutole; pentoxazone+azafenidin; pentoxazone+tebuthiuron; pentoxazone+sulcotrione; pentoxazone+pendimethalin; pentoxazone+clomazone; pentoxazone+metribuzin; pentoxazone+thiazopyr, pentoxazone+ethoxysulfuron; pentoxazone+compound of the formula C; pentoxazone+glyphosate; pentoxazone+glufosinate; pentoxazone+sulfosate; sulfentrazone+atrazine; sulfentrazone+ametryn; sulfentrazone+dicamba; sulfentrazone+terbutryn; sulfentrazone+prosulfuron; sulfentrazone+hexazinone; sulfentrazone+asulam; sulfentrazone+diuron; sulfentrazone +2,4-D; sulfentrazone+halosulfuron; sulfentrazone+flazasulfuron; sulfentrazone+isoxaflutole; sulfentrazone+azafenidin; sulfentrazone+tebuthiuron; sulfentrazone+sulcotrione; sulfentrazone+pendimethalin; sulfentrazone+clomazone; sulfentrazone+metribuzin; sulfentrazone+thiazopyr; sulfentrazone+ethoxysulfuron; sulfentrazone+compound of the formula C; sulfentrazone+glyphosate; sulfentrazone+glufosinate; sulfentrazone+sulfosate; fluazolate+atrazine; fluazolate+ametryn; fluazolate+dicamba; fluazolate+terbutryn; fluazolate+prosulfuron; fluazolate+hexazinone; fluazolate+asulam; fluazolate+diuron; fluazolate+2,4-D; fluazolate+halosulfuron; fluazolate+flazasulfuron; fluazolate+isoxaflutole; fluazolate+azafenidin; fluazolate+tebuthiuron; fluazolate+sulcotrione; fluazolate+pendimethalin; fluazolate+clomazone; fluazolate+metribuzin; fluazolate+thiazopyr; fluazolate+ethoxysulfuron; fluazolate+compound of the formula C; fluazolate+glyphosate; fluazolate+glufosinate; fluazolate+sulfosate; pyraflufen-ethyl+atrazine; pyraflufen-ethyl+ametryn; pyraflufen-ethyl+dicamba; pyraflufen-ethyl+terbutryn; pyraflufen-ethyl+prosulfuron; pyraflufen-ethyl+hexazinone; pyraflufen-ethyl+asulam; pyraflufen-ethyl+diuron; pyraflufen-ethyl+2,4-D; pyraflufen-ethyl halosulfuron; pyraflufen-ethyl+flazasulfuron; pyraflufen-ethyl+Isoxaflutole; pyraflufen-ethyl+azafenidin; pyraflufen-ethyl+tebuthiuron; pyraflufen-ethyl+sulcotrione; pyraflufen-ethyl+pendimethalin; pyraflufen-ethyl+clomazone; pyraflufen-ethyl+metribuzin; pyraflufen-ethyl+thiazopyr; pyraflufen-ethyl+ethoxysulfuron; pyraflufen-ethyl+compound of the formula C; pyraflufen-ethyl+glyphosate; pyraflufen-ethyl+glufosinate; pyraflufen-ethyl+sulfosate; flumipropyn+atrazine; flumipropyn+ametryn; flumipropyn+dicamba; flumipropyn+terbutryn; flumipropyn+prosulfuron; flumipropyn+hexazinone, flumipropyn+asulam; flumipropyn+diuron; flumipropyn+2,4-D; flumipropyn+halosulfuron; flumipropyn+flazasulfuron; flumipropyn+isoxaflutole; flumipropyn+azafenidin; flumipropyn+tebuthiuron; flumipropyn+sulcotrione; flumipropyn+pendimethalin; flumipropyn+clomazone; flumipropyn+metribuzin; flumipropyn+thiazopyr; flumipropyn+ethoxysulfuron; flumipropyn+compound of the formula C; flumipropyn+glyphosate; flumipropyn+glufosinate; flumipropyn+sulfosate; flupropacil+atrazine; flupropacil+ametryn; flupropacil+dicamba; flupropacil+terbutryn; flupropacil+prosulfuron; flupropacil+hexazinone; flupropacil+asulam; flupropacil+diuron; flupropacil +2,4-D; flupropacil+halosulfuron; flupropacil+flazasulfuron; flupropacil+isoxaflutole; flupropacil+azafenidin; flupropacil+tebuthiuron; flupropacil+sulcotrione; flupropacil+pendimethalin; flupropacil+clomazone; flupropacil+metribuzin; flupropacil+thiazopyr; flupropacil+ethoxysulfuron; flupropacil+compound of the formula C; flupropacil+glyphosate; flupropacil+glufosinate; flupropacil+sulfosate; nipyraclofen+atrazine; nipyraclofen+ametryn; nipyraclofen+dicamba; nipyraclofen+terbutryn; nipyraclofen+prosulfuron; nipyraclofen+hexazinone; nipyraclofen+asulam; nipyraclofen+diuron; nipyraclofen+2,4-D; nipyraclofen+halosulfuron; nipyraclofen+flazasulfuron; nipyraclofen +isoxaflutole; nipyraclofen+azafenidin; nipyraclofen+tebuthiuron; nipyraclofen+sulcotrione; nipyraclofen+pendimethalin; nipyraclofen+clomazone; nipyraclofen+metribuzin; nipyraclofen+thiazopyr; nipyraclofen+ethoxysulfuron; nipyraclofen+compound of the formula C; nipyraclofen+glyphosate; nipyraclofen+glufosinate; nipyraclofen+sulfosate; benzfendizone+atrazine; benzfendizone+ametryn; benzfendizone+dicamba; benzfendizone+terbutryn; benzfendizone+prosulfuron; benzfendizone+hexazinone; benzfendizone+asulam; benzfendizone+diuron; benzfendizone+2,4-D; benzfendizone+halosulfuron; benzfendizone+flazasulfuron; benzfendizone+isoxaflutole; benzfendizone+azafenidin; benzfendizone+tebuthiuron; benzfendizone+sulcotrione; benzfendizone+pendimethalin; benzfendizone+clomazone; benzfendizone+metribuzin; benzfendizone+thiazopyr; benzfendizone+ethoxysulfuron; benzfendizone+compound of the formula C; benzfendizone+glyphosate; benzfendizone +glufosinate; benzfendizone+sulfosate; thidiazimin+atrazine; thidiazimin+ametryn; thidiazimin+dicamba; thidiazimin+terbutryn; thidiazimin+prosulfuron; thidiazimin+hexazinone; thidiazimin+asulam; thidiazimin+diuron; thidiazimin+2,4-D; thidiazimin+halosulfuron; thidiazimin+flazasulfuron; thidiazimin+isoxaflutole; thidiazimin+azafenidin; thidiazimin+tebuthiuron; thidiazimin+sulcotrione; thidiazimin+pendimethalin; thidiazimin +clomazone; thidiazimin+metribuzin; thidiazimin+thiazopyr; thidiazimin+ethoxysulfuron; thidiazimin+compound of the formula C; thidiazimin+glyphosate; thidiazimin+glufosinate; and thidiazimin+sulfosate.

The application rate may vary within wide ranges and depends on the soil properties, the type of application (pre- or postemergent; seed dressing; application in a seed farrow, no tillage application, etc.), the crop plant, the weed to be controlled, the climatic conditions prevailing in each case and other factors determined by the type and the time of application and the target crop. In general, the active compound mixture according to the invention can be used with an application rate of from 1 to 5000 g/ha, in particular from 1 to 2000 g/ha, of active compound mixture.

The composition according to the invention comprises the protoporphyrinogen oxidase inhibitor a) and the pesticide under b) in any mixing ratio, usually with an excess of one component over the other. Preferred mixing ratios of active compound a) and the pesticides under b) are between 1:2000 and 2000:1, in particular between 1:200 and 200:1.

It may be advantageous for the herbicidal compositions according to the invention to additionally comprise one or more fungicides as further active compounds. Herbicide mixture and fungicide(s) can be applied, it appropriate, simultaneously or successively. Particularly preferred fungicidally active mixing partners are, for example, azoles such as azaconazole, bitertanol, propiconazole, difenoconazole, diniconazole, cyproconazole, epoxiconazole, fluquinconazole, flusilazole, flutriafol, hexaconazole, imazalil, imibenconazole, ipconazole, tebuconazole, tetraconazole, fenbuconazole, metconazole, myclobutanil, perfurazoate, penconazole, bromuconazole, pyrifenox, prochloraz, triadimefon, triadimenol, triflumizole or triticonazole; pyrimidinyl carbinols such as ancymidol, fenarimol or nuarimol; 2-amino-pyrimidines such as bupirimate, dimethirimol or ethirimol; morpholines, such as dodemorph, fenpropidin, fenpropimorph, spiroxamine or tridemorph; anilinopyrimidines such as cyprodinil, pyrimethanil or mepanipyrim; pyrroles, such as fenpiclonil or fludioxonil; phenylamides, such as benalaxyl, furalaxyl, metalaxyl, R-metalaxyl, ofurace or oxadixyl; benzimidazoles, such as benomyl, carbendazim, debacarb, fuberidazole or thiabendazole; dicarboximides, such as chlozolinate, dichlozoline, iprodine, myclozoline, procymidone or vinclozolin; carboxamides, such as carboxin, fenfuram, flutolanil, mepronil, oxycarboxin or thifluzamide; guanidines, such as guazatine, dodine or iminoctadine; strobilurins, such as azoxystrobin, kresoxim-methyl, metominostrobin, SSF-129, methyl 2-[(2-trifluoromethyl)-pyrid-6-yloxymethyl]-3-methoxyacrylate or methyl 2-[α{[(α-methyl-3-trifluormethylbenzyl)imino]-oxy}-o-tolyl]glyoxylate O-methyl oxime (trifloxystrobin); dithiocarbamates, such as ferbam, mancozeb, maneb, metiram, propineb, thiram, zineb or ziram; N-halomethylthio-dicarboximides, such as captafol, captan, dichlofluanid, fluoromide, folpet or tolyfluanid; copper compounds, such as Bordeaux mixture, copper hydroxide, copper oxychloride, copper sulphate, copper oxide, mancopper or oxine copper; nitrophenol derivates, such as dinocap or nitrothal-isopropyl; organophosphorous derivatives, such as edifenphos, iprobenphos, isoprothiolane, phosdiphen, pyrazophos or toclofos-methyl; and other compounds, for example acibenzolar-S-methyl, anilazine, blasticidin-S, chinomethionat, chloroneb, chlorothalonil, cymoxanil, dichlone, diclomezine, dicloran, diethofencarb, dimethomorph, dithianon, etridiazole, famoxadone, fenamidone, fentin, ferimzone, fluazinam, flusulfamide, fenhexamide, fesetyl-aluminium, hymexazol, kasuga-mycin, methasulfocarb, pencycuron, phthalide, polyoxins, probenazole, propamocarb, pyroquilon, quinoxyfen, quintozene, sulphur, triazoxide, tricyclazole, triforine, validamycin, (S)-5-methyl-2-methylthio-5-phenyl-3-phenylamino-3,5-dihydroimidazol-4-one (RPA 407213), 3,5-dichloro-N-(3-chloro-1-ethyl-1-methyl-2-oxopropyl)-4-methylbenzamide (RH-7281), N-allyl-4,5-dimethyl-2-trimethylsilylthiophene-3-carboxamide (MON 65500), 4-chloro-4-cyano-N,N-dimethyl-5-p-tolylimidazole-1-sulfonamide (IKF-916), N-(1-cyano-1,2-dimethylpropyl)-2-(2,4-dichlorophenoxy)propionamide (AC 382042), or iprovalicarb (SZX 722).

Preference is given to mixtures of the compound of the formula A with each individual of the aforementioned fungicides. Preference is likewise given to a herbicidal composition comprising a herbicide a) which inhibits the action of protoporphyrinogen oxidases and, as further component(s) b), one or more other co-herbicides and also one or more fungicides; particular preference is given to a composition which, in addition to the protoporphyrinogen oxidase inhibitor a), comprises one or more further co-herbicides and, if appropriate, one or more further fungicides; in particular to a composition which comprises the compound of the formula A and one further co-herbicide and one fungicide.

It may furthermore be advantageous for the herbicidal compositions according to the invention to comprise additionally one or more pesticides which are active against insects and representatives of the order Acarina as further active compounds b). Herbicide mixture and insecticide(s)/acaricide(s) can be applied, if appropriate, simultaneously or successively. Insecticides/acaricides which are suitable for this purpose are, for example: azamethiphos; chlorfenvinphos; cypermethrin, cypermethrin high-cis; cyromazin; diafenthiuron; diazinon; dichlorvos; dicrotophos; dicyclanil; fenoxycarb; fluazuron; furathiocarb; isazofos; jodfenphos; kinoprene; lufenuron; methacriphos; methidathion; monocrotophos; phosphamidon; profenofos; diofenolan; a substance obtainable from the Bacillus thuringiensis strain GC91 or from NCTC11821; pymetrozine; bromopropylate; methoprene; disulfuton; quinalphos; tau-fluvalinat; thiocyclam; thiometon; aldicarb; azinphos-methyl; benturacarb; bifenthrin; buprofezin; carbofuran; dibutylaminothio; cartap; chlorfluazuron; chlorpyrifos; cyfluthrin; lambda-cy-halothrin; alpha-cypermethrin; zeta-cypermethrin; deltamethrin; diflubenzuron; endosulfan; ethiofencarb; fenitrothion; fenobucarb; fenvalerate; formothion; methiocarb; heptenophos; imidacloprid; isoprocarb; methamidophos; methomyl; mevinphos; parathion; parathion-methyl; phosalone; pirimicarb; propoxur; teflubenzuron; terbufos; triazamate; abamectin; fenobucarb; tebufenozide; fipronil; beta-cyfluthrin; silafluofen; fenpyroximate; pyridaben; fenazaquin; priproxyfen; pyrimidifen; nitenpyram; NI-25, acetamiprid; avermectin B₁ (abamectin); an insect-active extract from a plant; a preparation comprising insect-active nematodes; a preparation obtainable from Bacillus subtilis; a preparation comprising insect-active fungi; a preparation comprising insect-active viruses; AC 303 630; acephat; acrinathrin; alanycarb; alphamethrin; amitraz; AZ 60541; azinphos A; azinphos M; azocyclotin; bendiocarb; bensultap; betacyfluthrin; BPMC; brofenprox; bromophos A; bufencarb; butocarboxin; butylpyridaben; cadusafos; carbaryl; carbopheno-thion; chloethocarb; chlorethoxyfos; chlormephos; cis-resmethrin; clocythrin; clofentezin; cyanophos; cycloprothrin; cyhexatin; demeton M; demeton S; demeton-S-methyl; dichlofenthion; dicliphos; diethion; dimethoate; dimethylvinphos; dioxathion; edifenphos; emamectin; esfenvalerate; ethion; ethofenprox; ethoprophos; etrimphos; fenamiphos; fenbutatinoxid; fenothiocarb; fenpropathrin; fenpyrad; tenthion, fluazinam; flucycioxuron; flucythrinate; flufenoxuron; flufenprox; tonophos; fosthiazat; fubfenprox; HCH; hexatlumuron; hexythiazox; iprobenfos; isofenphos; isoxathion; ivermectin; lambda-cyhalothrin; malathion; mecarbam; mesulfenphos; metaldehyde; metolcarb; milbemectin; moxidectin; naled; NC 184; omethoate; oxamyl; oxydemethon M; oxydeprofos; permethrin; phenthoate; phorate; phosmet; phoxim; pirimiphos M; pirimiphos A; promecarb; propaphos; prothiofos; prothoate; pyrachlophos; pyrada-phenthion; pyresmethrin; pyrethrum; RH 5992; salithion; sebufos; sulfotep; sulprofos; tebufenpyrad; tebupirimphos; tefluthrin; temephos; terbam; tetrachlor-vinphos; thiacloprid; thiamethoxam; thiafenox; thiodicarb; thiofanox; thionazin; thuringiensin; tralomethrin; triarthen; triazophos; triazuron; trichlorfon; triflumuron; trimethacarb; vamidothion; xylylcarb; YI 5301/5302; zetamethrin; DPX-MP062; RH-2485; D 2341 and XMC (3,5-xylyl methylcarbamate).

Preference is given to mixtures of the compound of the formula A with each individual of the abovementioned insecticides/acaricides. Preference is likewise given to a herbicidal composition comprising a herbicide a) which inhibits the action of protoporphyrinogen oxidases and as further component(s) b) one or more further co-herbicides and, if appropriate, one or more insecticide(s)/acaricide(s); particular preference is given to a composition which, in addition to the protoporphyrinogen oxidase inhibitor, comprises one further co-herbicide and one further insecticide/acaricide, in particular to a composition which comprises a compound of the formula A and one further co-herbicide and one insecticide/acaracide.

The invention also relates to a method for the selective control of broad-leaved weeds and grasses in crops of useful plants resistant to protoporphyrinogen oxidase inhibitors which comprises treating the useful plants, their seeds or seedlings or the area under cultivation simultaneously or separately with a herbicide-synergistically effective amount of the herbicide a), at least one further pesticide b), and, if appropriate, a herbicide-antagonistically effective amount of the safener c).

Preference is given to a method which is characterized in that, for controlling undesirable vegetation, a herbicide a) and at least one further co-herbicide is used on useful plants resistant to protoporphyrinogen oxidase inhibitors or on the surroundings of these useful plants, or, for controlling fungal attack, one or more fungicide(s) are used on useful plants resistant to protoporphyrinogen oxidase inhibitors or on the surroundings of these useful plants, or, for controlling animal pests, one or more insecticide(s)/acaracide(s) are used on useful plants resistant to protoporphyrinogen oxidase inhibitors or the surroundings of these useful plants, or, for controlling fungal attack and for controlling animal pests, one or more fungicide(s) and one or more insecticide(s)/acaracide(s), jointly or successively are used on useful plants resistant to protoporphyrinogen oxidase inhibitors or the surroundings of these useful plants. Suitable herbicides a), co-herbicides, fungicides and insecticides/acaracides b) are the same active compounds as listed above.

Preference is likewise given to a method characterized in that a herbicide a) is used on useful plants resistant to protoporphyrinogen oxidase inhibitors or on the surroundings of these useful plants, and, jointly with the herbicide a) or at a later point in time, a further co-herbicide and/or fungicide and/or insecticide/acaracide or, if appropriate, a mixture of such substances is used. Suitable herbicides a), co-herbicides, fungicides and insecticides/acaracides are the same active compounds as listed above

A further aspect of the present invention is a method for protecting seed of plants resistant to protoporphyrinogen oxidase inhibitors, characterized in that a composition comprising one or more fungicide(s) and/or one or more insecticide(s)/acaracide(s) is applied to the seed. The seed treated in this manner is protected in an optimum manner against attack by fungi and soil insects, in particular in the early phase of plant growth. The invention furthermore provides the seed treated in this manner. Suitable fungicides and/or insecticides/acaracides are the same active compounds as mentioned above.

The mixtures of the protoporphyrinogen oxidase inhibitors a) with the co-herbicides b) can be employed in unmodified form, i.e. as obtained in the synthesis. However, they are preferably processed in a conventional manner using auxiliaries customary in formulation technique, such as solvents, solid carriers or surfactants, for example to emulsifiable concentrates, directly sprayable or dilutable solutions, diluted emulsions, wettable powders, soluble powders, dusts, granules or microcapsules. The application methods, such as spraying, atomizing, dusting, wetting, scattering or watering, like the type of composition, are chosen according to the targets and the prevailing conditions.

The formulations, i.e. the compositions, preparations or combinations comprising the protoporphyrinogen oxidase inhibitors a) and the co-herbicides b) and, if appropriate, one or more solid or liquid formulation auxiliaries, are prepared in a manner known per se, for example by intimately mixing and/or grinding the active compounds with the formulation auxilaries, for example solvents or solid carriers. Furthermore, surface-active compounds (surfactants) may additionally be used in the preparation of the formulations.

Examples of solvents and solid carriers are given, for example, in WO 97/34485, on page 6.

Suitable surface-active compounds are, depending on the nature of the active compounds under a) and b) to be formulated, nonionic, cationic and/or anionic surfactants and surfactant mixtures having good emulsifying, dispersing and wetting properties.

Examples of suitable anionic, nonionic and cationic surfactants are listed, for example, in WO 97/34485, on pages 7 and 8.

The surfactants conventionally used in the art of formulation and which can also be used in the preparation of the herbicidal compositions according to the invention are described, inter alia, in “McCutcheon's Detergents and Emulsifiers Annual” MC Publishing Corp., Ridgewood, N.J., 1981, Stache, H., “Tensid-Taschenbuch” [Surfactant Handbook], Carl Hanser Verlag, Münich/Vienna, 1981 and M. and J. Ash, “Encyclopedia of Surfactants”, Vol I-III, Chemical Publishing Co., New York, 1980-81.

The herbicidal formulations generally comprise 0.1 to 99% by weight, in particular 0.1 to 95% by weight, of the active compound mixture of the compound under a) with the co-herbicides under b), 1 to 99.9% by weight of a solid or liquid formulation auxiliary and 0 to 25% by weight, in particular 0.1 to 25% by weight, of a surfactant.

While concentrated compositions are usually preferred as commercial goods, the end user generally uses dilute compositions. The compositions can also comprise further additives, such as stabilizers, for example epoxidized or non-epoxidized vegetable oils (epoxidized coconut oil, rapeseed oil or soya oil), defoamers, for example silicone oil, preservatives, viscosity regulators, binders, tackifiers and fertilizers or other active substances. Preferred formulations have, in particular, the following compositions: (%=% by weight)

Emulsifable concentrates:

| | |
|---|---|
| Active compound mixture: | 1 to 90%, preferably 5 to 20% |
| Surface-active agent: | 1 to 30%, preferably 10 to 20% |
| Liquid carrier: | 5 to 94%, preferably 70 to 85% |

Dusts:

| | |
|---|---|
| Active compound mixture: | 0.1 to 10%, preferably 0.1 to 5% |
| Solid carrier: | 99.9 to 90%, preferably 99.9 to 99% |

Suspension concentrates:

| | |
|---|---|
| Active compound mixture: | 5 to 75%, preferably 10 to 50% |
| Water: | 94 to 24%, preferably 88 to 30% |
| Surface-active agent: | 1 to 40%, preferably 2 to 30% |

Wettable powders:

| | |
|---|---|
| Active compound mixture: | 0.5 to 90%, preferably 1 to 80% |
| Surface-active agent: | 0.5 to 20%, preferably 1 to 15% |
| Solid carrier: | 5 to 95%, preferably 15 to 90% |

Granules:

| | |
|---|---|
| Active compound mixture: | 0.1 to 30%, preferably 0.1 to 15% |
| Solid carrier: | 99.5 to 70%, preferably 97 to 85% |

The examples below illustrate the invention in more detail, without limiting it.

| F1. Emulsion concentrates | a) | b) | c) | d) |
|---|---|---|---|---|
| Active compound mixture | 5% | 10% | 25% | 50% |
| Ca dodecylbenzenesulfonate | 6% | 8% | 6% | 8% |
| Castor oil polyglycol ether | 4% | — | 4% | 4% |
| (36 mol of EO) | | | | |
| Octylphenol polyglycol ether | — | 4% | — | 2% |
| (7-8 mol of EO) | | | | |
| Cyclohexanone | — | — | 10% | 20% |
| Arom. C₉-C₁₂ | 85% | 78% | 55% | 16% |
| hydrocarbon mixture | | | | |

Emulsions of any desired concentration can be prepared from such concentrates by dilution with water.

| F2. Solutions | a) | b) | c) | d) |
|---|---|---|---|---|
| Active compound mixture | 5% | 10% | 50% | 90% |
| 1-Methoxy-3-(3-methoxy- | — | 20% | 20% | — |
| propoxy)propane | | | | |
| Polyethylene glycol MW 400 | 20% | 10% | — | — |
| N-Methyl-2-pyrrolidone | — | — | 30% | 10% |
| Arom. C₉-C₁₂ | 75% | 60% | — | — |
| hydrocarbon mixture | | | | |

The solutions are suitable for use in the form of tiny droplets.

| F3. Wettable powders | a) | b) | c) | d) |
|---|---|---|---|---|
| Active compound mixture | 5% | 25% | 50% | 80% |
| Sodium lignosulfonate | 4% | — | 3% | — |
| Sodium laurylsulfate | 2% | 3% | — | 4% |
| Sodium diisobutylnaphthalene | — | 6% | 5% | 6% |
| sulfonate | | | | |
| Octylphenol polyglycol ether | — | 1% | 2% | — |
| (7-8 mol of EO) | | | | |
| Finely divided silica | 1% | 3% | 5% | 10% |
| Kaolin | 88% | 62% | 35% | — |

The active compound is thoroughly mixed with the additives and ground well in a suitable mill. This gives wettable powders which can be diluted with water to give suspensions of any desired concentration.

| F4. Coated granules | a) | b) | c) |
|---|---|---|---|
| Active compound mixture | 0.1% | 5% | 15% |
| Finely divided silica | 0.9% | 2% | 2% |
| lnorg. carrier | 99.0% | 93% | 83% |
| ( [symbol] 0.1-1 mm), | | | |
| for example CaCO₃ or SiO₂ | | | |

The active compound is dissolved in methylene chloride, the solution is sprayed onto the carrier and the solvent is subsequently evaporated off under reduced pressure.

| F5. Coated granules | a) | b) | c) |
|---|---|---|---|
| Active compound mixture | 0.1% | 5% | 15% |
| Polyethylene glycol MW 200 | 1.0% | 2% | 3% |
| Finely divided silica | 0.9% | 1% | 2% |
| lnorg. Carrier | 98.0% | 92% | 80% |
| ( [symbol] 0.1-1 mm), | | | |
| for example CaCO₃ or SiO₂ | | | |

In a mixer, the finely ground active compound is applied evenly to the carrier moistened with polyethylene glycol. In this manner, dust-free coated granules are obtained.

| F6. Extruder granules | a) | b) | c) | d) |
|---|---|---|---|---|
| Active compound mixture | 0.1% | 3% | 5% | 15% |
| Sodium lignosulfonate | 1.5% | 2% | 3% | 4% |
| Carboxymethylcellulose | 1.4% | 2% | 2% | 2% |
| Kaolin | 97.0% | 93% | 90% | 79% |

The active compound is mixed with the additives, ground and moistened with water. This mixture is extruded and subsequently dried in a stream of air.

| F7. Dusts | a) | b) | c) |
|---|---|---|---|
| Active compound mixture | 0.1% | 1% | 5% |
| Talc | 39.9% | 49% | 35% |
| Kaolin | 60.0% | 50% | 60% |

Ready-to-use dusts are obtained by mixing the active compound with the carriers and grinding the mixture in a suitable mill.

| F8. Suspension concentrates | a) | b) | c) | d) |
|---|---|---|---|---|
| Active compound mixture | 3% | 10% | 25% | 50% |
| Ethylene glycol | 5% | 5% | 5% | 5% |
| Nonylphenol polyglycol ether | — | 1% | 2% | — |
| (15 mol of EO) | | | | |
| Sodium lignosulfonate | 3% | 3% | 4% | 5% |
| Carboxymethylcellulose | 1% | 1% | 1% | 1% |
| 37% aqueous formaldehyde | 0.2% | 0.2% | 0.2% | 0.2% |
| solution | | | | |
| Silicone oil emulsion | 0.8% | 0.8% | 0.8% | 0.8% |
| Water | 87% | 79% | 62% | 38% |

The finely ground active compound is intimately mixed with the additives. This gives a suspension concentrate, from which suspensions of any desired concentration can be prepared by dilution with water.

It is often more practical to formulate the active compound under a) and the mixing partner under b) individually and then to mix them shortly before application in the applicator in the desired mixing ratio as “tank mix” in water.

### BIOLOGICAL EXAMPLES

A synergistic effect is always given when the effect of the combination of the active compounds a) and b) is greater than the sum of the effect of the active compounds applied on their own. The expected herbicidal effect Ee for a given combination of two herbicides can be calculated using the method of COLBY, S. R., “Calculating synergistic and antagonistic response of herbicide combinations”, Weeds 15, pages 20-22, 1967. This method has already been used in EP-A-0 768 034.

The synergistic effect of the combination of the active compound under a) with the active co-herbicides under b) is demonstrated in the examples below.

### Example B1

### Pre-emergence Test

Under greenhouse conditions, the test plants are sown in pots. The culture substrate used is a standard soil. At the pre-emergence stage, the herbicides are applied to the surface of the soil both on their own and in a mixture. Application is carried out as an aqueous suspension of the test substances, prepared from a 25% wettable powder (Example F3, b)), using 500 l of water/ha. The application rates depend on the optimum dosages determined under outdoor or greenhouse conditions. Evaluation of the tests is carried out after 2 to 4 weeks.

In this test, the mixtures used show good synergistic effects.

### Example B2

### Post-emergence Test

Under greenhouse conditions, the test plants are grown in pots until they have reached a post-emergence stage. The culture substrate used is a standard soil. In a post-emergence stage, the herbicides are applied to the test plants both on their own and in a mixture. Application is carried out as an aqueous suspension of the test substances prepared from a 25% wettable powder (Example F3, b)), using 500 l of water/ha. The application rates depend on the optimum dosages determined under outdoor or greenhouse conditions. Evaluation of the tests is carried out after 2 to 4 weeks.

The mixtures used in this test likewise show good synergistic effects.

Surprisingly, it has been found that specific safeners as additional component c) are suitable for mixing with the synergistic composition according to the invention. The present invention therefore also relates to a selective-herbicidal composition for controlling broad-leaved weeds and grasses in crops of useful plants resistant to protoporphyrinogen oxidase inhibitors, in particular in crops of maize and cereal, said composition comprising a protoporphyrinogen oxidase inhibitor a), at least one co-herbicide b), and one safener (antidote) c) which protects the useful plants but not the broad-leaved weeds and grasses against the pytotoxic action of the herbicides, and to the use of this composition for controlling weeds in crops of useful plants.

Suitable additional components c) are herbicide safeners of the benzoxazine type, in particular benoxacor (61), and also MON 4660, flurazole (350), dichlormid (213) and furilazole (377).

The following combinations of the compounds under a) with the co-herbicides under b) and benoxacor have been found to be very particularly effective selective-herbicidal compositions in crops of maize resistant to protoporphyrinogen oxidase inhibitors:

acifluorfen+(S)-metolachlor+benoxacor; acifluorfen+metolachlor+benoxacor; acifluorfen+dimethenamid or (S)-dimethenamid+benoxacor; acifluorfen+acetochlor+benoxacor; acifluorfen+alachlor+benoxacor; aclonifen+(S)-metolachlor+benoxacor; aclonifen+metolachlor+benoxacor; aclonifen+dimethenamid or (S)-dimethenamid+benoxacor; aclonifen+acetochlor+benoxacor; aclonifen+alachlor+benoxacor; bifenox+(S)-metolachlor+benoxacor; bifenox+metolachlor+benoxacor; bifenox+dimethenamid or (S)-dimethenamid+benoxacor; bifenox+acetochlor+benoxacor; bifenox+alachlor+benoxacor; chlomitrofen+(S)-metolachlor+benoxacor; chlomitrofen+metolachlor+benoxacor; chlomitrofen+dimethenamid or (S)-dimethenamid+benoxacor; chlomitrofen+acetochlor+benoxacor; chlomitrofen+alachlor+benoxacor; ethoxyfen+(S)-metolachlor+benoxacor; ethoxyfen+metolachlor+benoxacor; ethoxyfen+dimethenamid or (S)-dimethenamid+benoxacor; ethoxyfen+acetochlor+benoxacor; ethoxyfen+alachlor+benoxacor; fluoroglycofen+(S)-metolachlor+benoxacor; fluoroglycofen+metolachlor+benoxacor; fluoroglycofen+dimethenamid or (S)-dimethenamid+benoxacor; fluoroglycofen+acetochlor+benoxacor; fluoroglycofen+alachlor+benoxacor; fomesafen +(S)-metolachlor+benoxacor; fomesafen+metolachlor+benoxacor; fomesafen+dimethenamid or (S)-dimethenamid+benoxacor; fomesafen+acetochlor+benoxacor; fomesafen+alachlor+benoxacor; lactofen+(S)-metolachlor+benoxacor; lactofen+metolachlor+benoxacor; lactofen+dimethenamid or (S)-dimethenamid+benoxacor; lactofen+acetochlor+benoxacor; lactofen+alachlor+benoxacor; oxyfluorfen+(S)-metolachlor+benoxacor; oxyfluorfen+metolachlor+benoxacor; oxyfluorfen+dimethenamid or (S)-dimethenamid+benoxacor; oxyfluorfen+acetochlor+benoxacor; oxyfluorfen+alachlor+benoxacor; azafenidin+(S)-metolachlor+benoxacor; azafenidin+metolachlor+benoxacor; azafenidin+dimethenamid or (S)-dimethenamid+benoxacor; azafenidin+acetochlor+benoxacor; azafenidin+alachlor+benoxacor; carfentrazone-ethyl+(S)-metolachlor+benoxacor; carfentrazone-ethyl+metolachlor+benoxacor; carfentrazone-ethyl+dimethenamid or (S)-dimethenamid+benoxacor; carfentrazone-ethyl +acetochlor+benoxacor; carfentrazone-ethyl+alachlor+benoxacor; compound of the formula A+(S)-metolachlor+benoxacor; compound of the formula A+metolachlor+benoxacor; compound of the formula A+dimethenamid or (S)-dimethenamid+benoxacor; compound of the formula A+acetochlor+benoxacor; compound of the formula A+alachlor+benoxacor; cinidon-ethyl+(S)-metolachlor+benoxacor; cinidon-ethyl+metolachlor+benoxacor; cinidon-ethyl+dimethenamid or (S)-dimethenamid+benoxacor; cinidon-ethyl+acetochlor+benoxacor; cinidon-ethyl+alachlor+benoxacor; flumiclorac-pentyl+(S)-metolachlor+benoxacor; flumiclorac-pentyl+metolachlor+benoxacor; flumiclorac-pentyl+dimethenamid or (S)-dimethenamid+benoxacor; flumiclorac-pentyl+acetochlor+benoxacor; flumiclorac-pentyl+alachlor+benoxacor; flumioxazin+(S)-metolachlor+benoxacor; flumioxazin+metolachlor+benoxacor; flumioxazin+dimethenamid or (S)-dimethenamid+benoxacor; flumioxazin+acetochlor+benoxacor; flumioxazin+alachlor+benoxacor; fluthiacet-methyl+(S)-metolachlor+benoxacor; fluthiacet-methyl+metolachlor+benoxacor; fluthiacet-methyl+dimethenamid or (S)-dimethenamid+benoxacor; fluthiacet-methyl+acetochlor+benoxacor; fluthiacet-methyl+alachlor+benoxacor; oxadiargyl+(S)-metolachlor+benoxacor; oxadiargyl+metolachlor+benoxacor; oxadiargyl+dimethenamid or (S)-dimethenamid+benoxacor; oxadiargyl+acetochlor+benoxacor; oxadiargyl+alachlor+benoxacor; oxadiazon+(S)-metolachlor+benoxacor; oxadiazon+metolachlor+benoxacor; oxadiazon+dimethenamid or (S)-dimethenamid+benoxacor; oxadiazon+acetochlor+benoxacor; oxadiazon+alachlor+benoxacor; pentoxazone+(S)-metolachlor+benoxacor; pentoxazone+metolachlor+benoxacor; pentoxazone+dimethenamid or (S)-dimethenamid+benoxacor; pentoxazone +acetochlor+benoxacor; pentoxazone+alachlor+benoxacor; sulfentrazone+(S)-metolachlor+benoxacor; sulfentrazone+metolachlor+benoxacor; sulfentrazone+dimethenamid or (S)-dimethenamid+benoxacor; sulfentrazone+acetochlor+benoxacor; sulfentrazone+alachlor+benoxacor; fluazolate+(S)-metolachlor+benoxacor; fluazolate +metolachlor+benoxacor; fluazolate+dimethenamid or (S)-dimethenamid+benoxacor; fluazolate+acetochlor+benoxacor, fluazolate+alachlor+benoxacor, pyraflufen-ethyl+(S)-metolachlor+benoxacor; pyraflufen-ethyl+metolachlor+benoxacor; pyraflufen-ethyl+dimethenamid or (S)-dimethenamid+benoxacor; pyraflufen-ethyl+acetochlor+benoxacor; pyraflufen-ethyl+alachlor+benoxacor; flumipropyn+(S)-metolachlor+benoxacor; flumipropyn+metolachlor+benoxacor; flumipropyn+dimethenamid or (S)-dimethenamid+benoxacor; flumipropyn+acetochlor+benoxacor; flumipropyn+alachlor+benoxacor; flupropacil+(S)-metolachlor+benoxacor; flupropacil+metolachlor+benoxacor; flupropacil +dimethenamid or (S)-dimethenamid+benoxacor; flupropacil+acetochlor+benoxacor; flupropacil+alachlor+benoxacor; nipyraclofen+(S)-metolachlor+benoxacor; nipyraclofen +metolachlor+benoxacor, nipyraclofen+dimethenamid or (S)-dimethenamid+benoxacor, nipyraclofen+acetochlor+benoxacor; nipyraclofen+alachlor+benoxacor; benzfendizone +(S)-metolachlor+benoxacor; benzfendizone+metolachlor+benoxacor; benzfendizone+dimethenamid or (S)-dimethenamid+benoxacor; benzfendizone+acetochlor+benoxacor; benzfendizone+alachlor+benoxacor; thidiazimin+(S)-metolachlor+benoxacor; thidiazimin+metolachlor+benoxacor; thidiazimin+dimethenamid or (S)-dimethenamid+benoxacor; thidiazimin+acetochlor+benoxacor; and thidiazimin+alachlor+benoxacor.

The following combinations of the compounds under a) with the co-herbicides under b) and MON 4660 have likewise been found to be very particularly effective selective-herbicidal compositions in crops of maize resistant to protoporphyrinogen oxidase inhibitors:

acifluorfen+(S)-metolachlor+MON 4660; acifluorfen+metolachlor+MON 4660; acifluorfen+dimethenamid or (S)-dimethenamid+MON 4660; acifluorfen+acetochlor+MON 4660; acifluorfen+alachlor+MON 4660; aclonifen+(S)-metolachlor+MON 4660; aclonifen+metolachlor+MON 4660; aclonifen+dimethenamid or (S)-dimethenamid+MON 4660; aclonifen+acetochlor+MON 4660; aclonifen+alachlor+MON 4660; bifenox +(S)-metolachlor+MON 4660; bifenox+metolachlor+MON 4660; bifenox+dimethenamid or (S)-dimethenamid+MON 4660; bifenox+acetochlor+MON 4660; bifenox+alachlor+MON 4660; chlomitrofen+(S)-metolachlor+MON 4660; chlomitrofen+metolachlor+MON 4660; chlomitrofen+dimethenamid or (S)-dimethenamid+MON 4660; chlomitrofen+acetochlor+MON 4660; chlomitrofen+alachlor+MON 4660; ethoxyfen+(S)-metolachlor+MON 4660; ethoxyfen+metolachlor+MON 4660; ethoxyfen+dimethenamid or (S)-dimethenamid+MON 4660; ethoxyfen+acetochlor+MON 4660; ethoxyfen+alachlor+MON 4660; fluoroglycofen+(S)-metolachlor+MON 4660; fluoroglycofen+metolachlor+MON 4660; fluoroglycofen+dimethenamid or (S)-dimethenamid+MON 4660; fluoroglycofen+acetochlor+MON 4660; fluoroglycofen+alachlor+MON 4660; fomesafen+(S)-metolachlor+MON 4660; fomesafen+metolachlor +MON 4660; fomesafen+dimethenamid or (S)-dimethenamid+MON 4660; fomesafen+acetochlor+MON 4660; fomesafen+alachlor+MON 4660; lactofen+(S)-metolachlor+MON 4660; lactofen+metolachlor+MON 4660; lactofen+dimethenamid or (S)-dimethenamid+MON 4660; lactofen+acetochlor+MON 4660; lactofen+alachlor+MON 4660; oxyfluorfen+(S)-metolachlor+MON 4660; oxyfluorfen+metolachlor+MON 4660; oxyfluorfen+dimethenamid or (S)-dimethenamid+MON 4660; oxyfluorfen+acetochlor+MON 4660; oxyfluorfen+alachlor+MON 4660; azafenidin+(S)-metolachlor+MON 4660; azafenidin+metolachlor+MON 4660; azafenidin+dimethenamid or (S)-dimethenamid+MON 4660; azafenidin+acetochlor+MON 4660; azafenidin+alachlor+MON 4660; carfentrazone-ethyl+(S)-metolachlor+MON 4660; carfentrazone-ethyl+metolachlor+MON 4660; carfentrazone-ethyl+dimethenamid or (S)-dimethenamid+MON 4660; carfentrazone-ethyl+acetochlor+MON 4660; carfentrazone-ethyl+alachlor+MON 4660; compound of the formula A+(S)-metolachlor+MON 4660; compound of the formula A+metolachlor+MON 4660; compound of the formula A+dimethenamid or (S)-dimethenamid +MON 4660; compound of the formula A+acetochlor+MON 4660; compound of the formula A+alachlor+MON 4660; cinidon-ethyl+(S)-metolachlor+MON 4660; cinidon-ethyl+metolachlor+MON 4660; cinidon-ethyl+dimethenamid or (S)-dimethenamid+MON 4660; cinidon-ethyl+acetochlor+MON 4660; cinidon-ethyl+alachlor+MON 4660; flumiclorac-pentyl+(S)-metolachlor+MON 4660; flumiclorac-pentyl+metolachlor+MON 4660; flumiclorac-pentyl+dimethenamid or (S)-dimethenamid+MON 4660; flumiclorac-pentyl+acetochlor+MON 4660; flumiclorac-pentyl+alachlor+MON 4660; flumioxazin+(S)-metolachlor+MON 4660; flumioxazin+metolachlor+MON 4660; flumioxazin+dimethenamid or (S)-dimethenamid+MON 4660; flumioxazin+acetochlor+MON 4660; flumioxazin+alachlor+MON 4660; fluthiacet-methyl+(S)-metolachlor+MON 4660; fluthiacet-methyl+metolachlor+MON 4660; fluthiacet-methyl+dimethenamid or (S)-dimethenamid+MON 4660; fluthiacet-methyl+acetochlor+MON 4660; fluthiacet-methyl+alachlor+MON 4660; oxadiargyl+(S)-metolachlor+MON 4660; oxadiargyl+metolachlor+MON 4660; oxadiargyl+dimethenamid or (S)-dimethenamid+MON 4660; oxadiargyl+acetochlor+MON 4660; oxadiargyl+alachlor+MON 4660; oxadiazon+(S)-metolachlor+MON 4660; oxadiazon+metolachlor+MON 4660; oxadiazon+dimethenamid or (S)-dimethenamid+MON 4660; oxadiazon+acetochlor+MON 4660; oxadiazon+alachlor+MON 4660; pentoxazone+(S)-metolachlor+MON 4660; pentoxazone+metolachlor+MON 4660; pentoxazone+dimethenamid or (S)-dimethenamid+MON 4660; pentoxazone +acetochlor+MON 4660; pentoxazone+alachlor+MON 4660; sulfentrazone+(S)-metolachlor+MON 4660; sulfentrazone+metolachlor+MON 4660; sulfentrazone+dimethenamid or (S)-dimethenamid+MON 4660; sulfentrazone+acetochlor+MON 4660; sulfentrazone+alachlor+MON 4660; fluazolate+(S)-metolachlor+MON 4660; fluazolate +metolachlor+MON 4660; fluazolate+dimethenamid or (S)-dimethenamid+MON 4660; fluazolate+acetochlor+MON 4660; fluazolate+alachlor+MON 4660; pyraflufen-ethyl+(S)-metolachlor+MON 4660; pyraflufen-ethyl+metolachlor+MON 4660; pyraflufen-ethyl +dimethenamid or (S)-dimethenamid+MON 4660; pyraflufen-ethyl+acetochlor+MON 4660; pyraflufen-ethyl+alachlor+MON 4660; flumipropyn+(S)-metolachlor+MON 4660; flumipropyn+metolachlor+MON 4660; flumipropyn+dimethenamid or (S)-dimethenamid +MON 4660; flumipropyn+acetochlor+MON 4660; flumipropyn+alachlor+MON 4660; flupropacil+(S)-metolachlor+MON 4660; flupropacil+metolachlor+MON 4660; flupropacil+dimethenamid or (S)-dimethenamid+MON 4660; flupropacil+acetochlor+MON 4660; flupropacil+alachlor+MON 4660; nipyraclofen+(S)-metolachlor+MON 4660; nipyraclofen+metolachlor+MON 4660; nipyraclofen+dimethenamid or (S)-dimethenamid +MON 4660; nipyraclofen+acetochlor+MON 4660; nipyraclofen+alachlor+MON 4660; benzfendizone+(S)-metolachlor+MON 4660; benzfendizone+metolachlor+MON 4660; benzfendizone+dimethenamid or (S)-dimethenamid+MON 4660; benzfendizone+acetochlor+MON 4660; benzfendizone+alachlor+MON 4660; thidiazimin+(S)-metolachlor+MON 4660; thidiazimin+metolachlor+MON 4660; thidiazimin+dimethenamid or (S)-dimethenamid+MON 4660; thidiazimin+acetochlor+MON 4660; and thidiazimin+alachlor+MON 4660.

The following combinations of the compounds under a) with the co-herbicides under b) and flurazole have likewise been found to be very particularly effective selective-herbicidal compositions in crops of maize resistant to protoporphyrinogen oxidase inhibitors:

acifluorfen+(S)-metolachlor+flurazole; acifluorfen+metolachlor+flurazole; acifluorfen+dimethenamid or (S)-dimethenamid+flurazole; acifluorfen+acetochlor+flurazole; acifluorfen+alachlor+flurazole; aclonifen+(S)-metolachlor+flurazole; aclonifen+metolachlor+flurazole; aclonifen+dimethenamid or (S)-dimethenamid+flurazole; aclonifen+acetochlor+flurazole; aclonifen+alachlor+flurazole; bifenox+(S)-metolachlor +flurazole; bifenox+metolachlor+flurazole; bifenox+dimethenamid or (S)-dimethenamid +flurazole; bifenox+acetochlor+flurazole; bifenox+alachlor+flurazole; chlomitrofen+(S)-metolachlor+flurazole; chlomitrofen+metolachlor+flurazole; chlomitrofen+dimethenamid or (S)-dimethenamid+flurazole; chlomitrofen+acetochlor+flurazole; chlomitrofen+alachlor+flurazole; ethoxyfen+(S)-metolachlor+flurazole; ethoxyfen+metolachlor+flurazole; ethoxyfen+dimethenamid or (S)-dimethenamid+flurazole; ethoxyfen+acetochlor+flurazole; ethoxyfen+alachlor+flurazole; fluoroglycofen+(S)-metolachlor+flurazole; fluoroglycofen+metolachlor+flurazole; fluoroglycofen+dimethenamid or (S)-dimethenamid+flurazole; fluoroglycofen+acetochlor+flurazole; fluoroglycofen+alachlor+flurazole; fomesafen+(S)-metolachlor+flurazole; fomesafen+metolachlor+flurazole; fomesafen+dimethenamid or (S)-dimethenamid+flurazole; fomesafen+acetochlor+flurazole; fomesafen+alachlor+flurazole; lactofen+(S)-metolachlor+flurazole; lactofen+metolachlor+flurazole; lactofen+dimethenamid or (S)-dimethenamid+flurazole; lactofen+acetochlor+flurazole; lactofen+alachlor+flurazole; oxyfluorfen+(S)-metolachlor+flurazole; oxyfluorfen+metolachlor+flurazole; oxyfluorfen +dimethenamid or (S)-dimethenamid+flurazole; oxyfluorfen+acetochlor+flurazole; oxyfluorfen+alachlor+flurazole; azafenidin+(S)-metolachlor+flurazole; azafenidin+metolachlor+flurazole; azafenidin+dimethenamid or (S)-dimethenamid+flurazole; azafenidin+acetochlor+flurazole; azafenidin+alachlor+flurazole; carfentrazone-ethyl+(S)-metolachlor+flurazole; carfentrazone-ethyl+metolachlor+flurazole; carfentrazone-ethyl+dimethenamid or (S)-dimethenamid+flurazole; carfentrazone-ethyl+acetochlor+flurazole; carfentrazone-ethyl+alachlor+flurazole; compound of the formula A+(S)-metolachlor+flurazole; compound of the formula A+metolachlor+flurazole; compound of the formula A+dimethenamid or (S)-dimethenamid+flurazole; compound of the formula A +acetochlor+flurazole; compound of the formula A+alachlor+flurazole; cinidon-ethyl+(S)-metolachlor+flurazole; cinidon-ethyl+metolachlor+flurazole; cinidon-ethyl+dimethenamid or (S)-dimethenamid+flurazole; cinidon-ethyl+acetochlor+flurazole; cinidon-ethyl+alachlor+flurazole; flumiclorac-pentyl+(S)-metolachlor+flurazole; flumiclorac-pentyl+metolachlor+flurazole; flumiclorac-pentyl+dimethenamid or (S)-dimethenamid+flurazole; flumiclorac-pentyl+acetochlor+flurazole; flumiclorac-pentyl+alachlor+flurazole; flumioxazin+(S)-metolachlor+flurazole; flumioxazin+metolachlor+flurazole; flumioxazin+dimethenamid or (S)-dimethenamid+flurazole; flumioxazin+acetochlor+flurazole; flumioxazin+alachlor+flurazole; fluthiacet-methyl+(S)-metolachlor +flurazole; fluthiacet-methyl+metolachlor+flurazole; fluthiacet-methyl+dimethenamid or (S)-dimethenamid+flurazole; fluthiacet-methyl+acetochlor+flurazole; fluthiacet-methyl+alachlor+flurazole; oxadiargyl+(S)-metolachlor+flurazole; oxadiargyl+metolachlor+flurazole; oxadiargyl+dimethenamid or (S)-dimethenamid+flurazole; oxadiargyl+acetochlor+flurazole; oxadiargyl+alachlor+flurazole; oxadiazon+(S)-metolachlor+flurazole; oxadiazon+metolachlor+flurazole; oxadiazon+dimethenamid or (S)-dimethenamid+flurazole; oxadiazon+acetochlor+flurazole; oxadiazon+alachlor+flurazole; pentoxazone+(S)-metolachlor+flurazole; pentoxazone+metolachlor+flurazole; pentoxazone+dimethenamid or (S)-dimethenamid+flurazole; pentoxazone+acetochlor+flurazole; pentoxazone+alachlor+flurazole; sulfentrazone+(S)-metolachlor +flurazole; sulfentrazone+metolachlor+flurazole; sulfentrazone+dimethenamid or (S)-dimethenamid+flurazole; sulfentrazone+acetochlor+flurazole; sulfentrazone+alachlor+flurazole; fluazolate+(S)-metolachlor+flurazole; fluazolate+metolachlor+flurazole; fluazolate+dimethenamid or (S)-dimethenamid+flurazole; fluazolate+acetochlor+flurazole; fluazolate+alachlor+flurazole; pyraflufen-ethyl+(S)-metolachlor+flurazole; pyraflufen-ethyl+metolachlor+flurazole; pyraflufen-ethyl+dimethenamid or (S)-dimethenamid+flurazole; pyraflufen-ethyl+acetochlor+flurazole; pyraflufen-ethyl+alachlor+flurazole; flumipropyn+(S)-metolachlor+flurazole; flumipropyn+metolachlor+flurazole; flumipropyn+dimethenamid or (S)-dimethenamid+flurazole; flumipropyn+acetochlor+flurazole; flumipropyn+alachlor+flurazole; flupropacil+(S)-metolachlor+flurazole; flupropacil+metolachlor+flurazole; flupropacil+dimethenamid or (S)-dimethenamid+flurazole; flupropacil+acetochlor+flurazole; flupropacil+alachlor+flurazole; nipyraclofen+(S)-metolachlor+flurazole; nipyraclofen+metolachlor+flurazole; nipyraclofen+dimethenamid or (S)-dimethenamid+flurazole; nipyraclofen+acetochlor+flurazole; nipyraclofen+alachlor+flurazole; benzfendizone+(S)-metolachlor+flurazole; benzfendizone+metolachlor+flurazole; benzfendizone+dimethenamid or (S)-dimethenamid+flurazole; benzfendizone+acetochlor+flurazole; benzfendizone+alachlor+flurazole; thidiazimin+(S)-metolachlor+flurazole; thidiazimin+metolachlor+flurazole; thidiazimin+dimethenamid or (S)-dimethenamid+flurazole; thidiazimin+acetochlor+flurazole; and thidiazimin+alachlor+flurazole.

The following combinations of the compounds under a) with the co-herbicides under b) and dichlormid have likewise been found to be very particularly effective selective-herbicidal compositions in crops of maize resistant to protoporphyrinogen oxidase inhibitors:

acifluorfen+(S)-metolachlor+dichlormid; acifluorfen+metolachlor+dichlormid; acifluorfen +dimethenamid or (S)-dimethenamid+dichlormid; acifluorfen+acetochlor+dichlormid; acifluorfen+alachlor+dichlormid; aclonifen+(S)-metolachlor+dichlormid; aclonifen+metolachlor+dichlormid; aclonifen+dimethenamid or (S)-dimethenamid+dichlormid; aclonifen+acetochlor+dichlormid; aclonifen+alachlor+dichlormid; bifenox+(S)-metolachlor+dichlormid; bifenox+metolachlor+dichlormid; bifenox+dimethenamid or (S)-dimethenamid+dichlormid; bifenox+acetochlor+dichlormid; bifenox+alachlor+dichlormid; chlomitrofen+(S)-metolachlor+dichlormid; chlomitrofen+metolachlor+dichlormid; chlomitrofen+dimethenamid or (S)-dimethenamid+dichlormid; chlomitrofen+acetochlor+dichlormid; chlomitrofen+alachlor+dichlormid; ethoxyfen+(S)-metolachlor+dichlormid; ethoxyfen+metolachlor+dichlormid; ethoxyfen+dimethenamid or (S)-dimethenamid+dichlormid; ethoxyfen+acetochlor+dichlormid; ethoxyfen+alachlor+dichlormid; fluoroglycofen+(S)-metolachlor+dichlormid; fluoroglycofen+metolachlor+dichlormid; fluoroglycofen+dimethenamid or (S)-dimethenamid+dichlormid; fluoroglycofen +acetochlor+dichlormid; fluoroglycofen+alachlor+dichlormid; fomesafen+(S)-metolachlor+dichlormid; fomesafen+metolachlor+dichlormid; fomesafen+dimethenamid or (S)-dimethenamid+dichlormid; fomesafen+acetochlor+dichlormid; fomesafen+alachlor+dichlormid; lactofen+(S)-metolachlor+dichlormid; lactofen+metolachlor+dichlormid; lactofen+dimethenamid or (S)-dimethenamid+dichlormid; lactofen+acetochlor+dichlormid; lactofen+alachlor+dichlormid; oxyfluorfen+(S) metolachlor+dichlormid; oxyfluorfen+metolachlor+dichlormid; oxyfluorfen+dimethenamid or (S)-dimethenamid+dichlormid; oxyfluorfen+acetochlor+dichlormid; oxyfluorfen+alachlor+dichlormid; azafenidin+(S)-metolachlor+dichlormid, azafenidin+metolachlor+dichlormid; azafenidin+dimethenamid or (S)-dimethenamid+dichlormid; azafenidin+acetochlor+dichlormid; azafenidin+alachlor+dichlormid; carfentrazone-ethyl +(S)-metolachlor+dichlormid; carfentrazone-ethyl+metolachlor+dichlormid; carfentrazone-ethyl+dimethenamid or (S)-dimethenamid+dichlormid; carfentrazone-ethyl +acetochlor+dichlormid; carfentrazone-ethyl+alachlor+dichlormid; compound of the formula A+(S)-metolachlor+dichlormid; compound of the formula A+metolachlor+dichlormid; compound of the formula A+dimethenamid or (S)-dimethenamid+dichlormid; compound of the formula A+acetochlor+dichlormid; compound of the formula A+alachlor+dichlormid; cinidon-ethyl+(S)-metolachlor+dichlormid; cinidon-ethyl+metolachlor+dichlormid; cinidon-ethyl+dimethenamid or (S)-dimethenamid+dichlormid; cinidon-ethyl+acetochlor+dichlormid; cinidon-ethyl+alachlor+dichlormid; flumiclorac-pentyl+(S)-metolachlor+dichlormid; flumiclorac-pentyl+metolachlor+dichlormid; flumiclorac-pentyl+dimethenamid or (S)-dimethenamid+dichlormid; flumiclorac-pentyl+acetochlor+dichlormid; flumiclorac-pentyl+alachlor+dichlormid; flumioxazin+(S)-metolachlor+dichlormid; flumioxazin+metolachlor+dichlormid; flumioxazin+dimethenamid or (S)-dimethenamid+dichlormid; flumioxazin+acetochlor+dichlormid; flumioxazin+alachlor+dichlormid; fluthiacet-methyl+(S)-metolachlor+dichlormid; fluthiacet-methyl+metolachlor+dichlormid; fluthiacet-methyl+dimethenamid or (S)-dimethenamid+dichlormid; fluthiacet-methyl+acetochlor+dichlormid; fluthiacet-methyl+alachlor+dichlormid; oxadiargyl+(S)-metolachlor+dichlormid; oxadiargyl+metolachlor+dichlormid; oxadiargyl+dimethenamid or (S)-dimethenamid+dichlormid; oxadiargyl+acetochlor+dichlormid; oxadiargyl+alachlor+dichlormid; oxadiazon+(S)-metolachlor+dichlormid; oxadiazon+metolachlor+dichlormid; oxadiazon+dimethenamid or (S)-dimethenamid+dichlormid; oxadiazon+acetochlor+dichlormid; oxadiazon+alachlor+dichlormid; pentoxazone+(S)-metolachlor+dichlormid; pentoxazone+metolachlor+dichlormid; pentoxazone+dimethenamid or (S)-dimethenamid+dichlormid; pentoxazone+acetochlor+dichlormid; pentoxazone+alachlor+dichlormid; sulfentrazone+(S)-metolachlor+dichlormid; sulfentrazone+metolachlor+dichlormid; sulfentrazone+dimethenamid or (S)-dimethenamid+dichlormid; sulfentrazone+acetochlor+dichlormid; sulfentrazone+alachlor+dichlormid; fluazolate+(S)-metolachlor+dichlormid; fluazolate+metolachlor+dichlormid; fluazolate+dimethenamid or (S)-dimethenamid+dichlormid; fluazolate+acetochlor+dichlormid; fluazolate+alachlor+dichlormid; pyraflufen-ethyl+(S)-metolachlor+dichlormid; pyraflufen-ethyl+metolachlor+dichlormid; pyraflufen-ethyl+dimethenamid or (S)-dimethenamid+dichlormid; pyraflufen-ethyl+acetochlor+dichlormid; pyraflufen-ethyl+alachlor+dichlormid; flumipropyn+(S)-metolachlor+dichlormid; flumipropyn+metolachlor+dichlormid; flumipropyn+dimethenamid or (S)-dimethenamid+dichlormid; flumipropyn+acetochlor+dichlormid; flumipropyn+alachlor+dichlormid; flupropacil+(S)-metolachlor+dichlormid; flupropacil+metolachlor+dichlormid; flupropacil +dimethenamid or (S)-dimethenamid+dichlormid; flupropacil+acetochlor+dichlormid; flupropacil+alachlor+dichlormid; nipyraclofen+(S)-metolachlor+dichlormid; nipyraclofen +metolachlor+dichlormid; nipyraclofen+dimethenamid or (S)-dimethenamid+dichlormid; nipyraclofen+acetochlor+dichlormid; nipyraclofen+alachlor+dichlormid; benzfendizone +(S)-metolachlor+dichlormid; benzfendizone+metolachlor+dichlormid; benzfendizone+dimethenamid or (S)-dimethenamid+dichlormid; benzfendizone+acetochlor+dichlormid; benzfendizone+alachlor+dichlormid; thidiazimin+(S)-metolachlor+dichlormid; thidiazimin+metolachlor+dichlormid; thidiazimin+dimethenamid or (S)-dimethenamid+dichlormid; thidiazimin+acetochlor+dichlormid; and thidiazimin+alachlor+dichlormid.

The following combinations of the compounds under a) with the co-herbicides under b) and furilazole have likewise been found to be very particularly effective selective-herbicidal compositions in crops of maize resistant to protoporphyrinogen oxidase inhibitors:

acifluorfen+(S)-metolachlor+furilazole; acifluorfen+metolachlor+furilazole; acifluorfen+dimethenamid or (S)-dimethenamid+furilazole; acifluorfen+acetochlor+furilazole; acifluorfen+alachlor+furilazole; aclonifen+(S)-metolachlor+furilazole; aclonifen+metolachlor+furilazole; aclonifen+dimethenamid or (S)-dimethenamid+furilazole; aclonifen+acetochlor+furilazole; aclonifen+alachlor+furilazole; bifenox+(S)-metolachlor+furilazole; bifenox+metolachlor+furilazole; bifenox+dimethenamid or (S)-dimethenamid+furilazole; bifenox+acetochlor+furilazole; bifenox+alachlor+furilazole; chlomitrofen+(S)-metolachlor+furilazole; chlomitrofen+metolachlor+furilazole; chlomitrofen+dimethenamid or (S)-dimethenamid+furilazole; chlomitrofen+acetochlor+furilazole; chlomitrofen+alachlor+furilazole; ethoxyfen+(S)-metolachlor+furilazole; ethoxyfen+metolachlor+furilazole; ethoxyfen+dimethenamid or (S)-dimethenamid+furilazole; ethoxyfen+acetochlor+furilazole; ethoxyfen+alachlor+furilazole; fluoroglycofen+(S)-metolachlor+furilazole; fluoroglycofen+metolachlor+furilazole; fluoroglycofen+dimethenamid or (S)-dimethenamid+furilazole; fluoroglycofen+acetochlor+furilazole; fluoroglycofen+alachlor+furilazole; fomesafen+(S)-metolachlor+furilazole; fomesafen+metolachlor+furilazole; fomesafen+dimethenamid or (S)-dimethenamid+furilazole; fomesafen+acetochlor+furilazole; fomesafen+alachlor+furilazole; lactofen+(S)-metolachlor+furilazole; lactofen+metolachlor+furilazole; lactofen+dimethenamid or (S)-dimethenamid+furilazole; lactofen+acetochlor+furilazole; lactofen+alachlor+furilazole; oxyfluorfen+(S)-metolachlor+furilazole; oxyfluorfen+metolachlor+furilazole; oxyfluorfen+dimethenamid or (S)-dimethenamid+furilazole; oxyfluorfen+acetochlor+furilazole; oxyfluorfen+alachlor+furilazole; azafenidin+(S)-metolachlor+furilazole; azafenidin+metolachlor+furilazole; azafenidin+dimethenamid or (S)-dimethenamid+furilazole; azafenidin+acetochlor+furilazole; azafenidin+alachlor+furilazole; carfentrazone-ethyl+(S)-metolachlor+furilazole; carfentrazone-ethyl+metolachlor+furilazole; carfentrazone-ethyl+dimethenamid or (S)-dimethenamid+furilazole; carfentrazone-ethyl+acetochlor+furilazole; carfentrazone-ethyl+alachlor+furilazole; compound of the formula A+(S)-metolachlor+furilazole; compound of the formula A+metolachlor+furilazole; compound of the formula A+dimethenamid or (S)-dimethenamid+furilazole; compound of the formula A+acetochlor+furilazole; compound of the formula A+alachlor+furilazole; cinidon-ethyl+(S)-metolachlor+furilazole; cinidon-ethyl+metolachlor+furilazole; cinidon-ethyl+dimethenamid or (S)-dimethenamid+furilazole; cinidon-ethyl+acetochlor+furilazole; cinidon-ethyl+alachlor+furilazole; flumiclorac-pentyl+(S)-metolachlor+furilazole; flumiclorac-pentyl+metolachlor+furilazole; flumiclorac-pentyl+dimethenamid or (S)-dimethenamid+furilazole; flumiclorac-pentyl+acetochlor+furilazole; flumiclorac-pentyl+alachlor+furilazole; flumioxazin+(S)-metolachlor+furilazole; flumioxazin+metolachlor+furilazole; flumioxazin+dimethenamid or (S)-dimethenamid+furilazole; flumioxazin+acetochlor+furilazole; flumioxazin+alachlor+furilazole; fluthiacet-methyl+(S)-metolachlor+furilazole; fluthiacet-methyl+metolachlor+furilazole; fluthiacet-methyl+dimethenamid or (S)-dimethenamid+furilazole; fluthiacet-methyl+acetochlor+furilazole; fluthiacet-methyl+alachlor+furilazole; oxadiargyl+(S)-metolachlor+furilazole; oxadiargyl+metolachlor+furilazole; oxadiargyl+dimethenamid or (S)-dimethenamid+furilazole; oxadiargyl+acetochlor+furilazole; oxadiargyl+alachlor+furilazole; oxadiazon+(S)-metolachlor+furilazole; oxadiazon+metolachlor+furilazole; oxadiazon+dimethenamid or (S)-dimethenamid+furilazole; oxadiazon+acetochlor+furilazole; oxadiazon+alachlor+furilazole; pentoxazone+(S)-metolachlor+furilazole; pentoxazone+metolachlor+furilazole; pentoxazone+dimethenamid or (S)-dimethenamid+furilazole; pentoxazone+acetochlor+furilazole; pentoxazone+alachlor+furilazole; sulfentrazone+(S)-metolachlor+furilazole; sulfentrazone+metolachlor+furilazole; sulfentrazone+dimethenamid or (S)-dimethenamid+furilazole; sulfentrazone+acetochlor+furilazole; sulfentrazone+alachlor +furilazole; fluazolate+(S)-metolachlor+furilazole; fluazolate+metolachlor+furilazole; fluazolate+dimethenamid or (S)-dimethenamid+furilazole; fluazolate+acetochlor+furilazole; fluazolate+alachlor+furilazole; pyraflufen-ethyl+(S)-metolachlor+furilazole; pyraflufen-ethyl+metolachlor+furilazole; pyraflufen-ethyl+dimethenamid or (S)-dimethenamid+furilazole; pyraflufen-ethyl+acetochlor+furilazole; pyraflufen-ethyl+alachlor+furilazole; flumipropyn+(S)-metolachlor+furilazole; flumipropyn+metolachlor+furilazole; flumipropyn+dimethenamid or (S)-dimethenamid+furilazole; flumipropyn+acetochlor+furilazole; flumipropyn+alachlor+furilazole; flupropacil+(S)-metolachlor+furilazole; flupropacil+metolachlor+furilazole; flupropacil+dimethenamid or (S)-dimethenamid+furilazole; flupropacil+acetochlor+furilazole; flupropacil+alachlor+furilazole; nipyraclofen+(S)-metolachlor+furilazole; nipyraclofen+metolachlor+furilazole; nipyraclofen+dimethenamid or (S)-dimethenamid+furilazole; nipyraclofen+acetochlor+furilazole; nipyraclofen+alachlor+furilazole; benzfendizone+(S)-metolachlor +furilazole; benzfendizone+metolachlor+furilazole; benzfendizone+dimethenamid or (S)-dimethenamid+furilazole; benzfendizone+acetochlor+furilazole; benzfendizone+alachlor+furilazole; thidiazimin+(S)-metolachlor+furilazole; thidiazimin+metolachlor+furilazole; thidiazimin+dimethenamid or (S)-dimethenamid+furilazole; thidiazimin+acetochlor+furilazole; and thidiazimin+alachlor+furilazole.

The following combinations of the compounds under a) with the co-herbicides under b) and cloquintocet-mexyl have likewise been found to be very particularly effective selective-herbicidal compositions in crops of cereals resistant to protoporphyrinogen oxidase inhibitors:

acifluorfen+triasulfuron+cloquintocet; acifluorfen+prosulfuron+cloquintocet; acifluorfen +clodinafop+cloquintocet; acifluorfen+amidosulfuron+cloquintocet; acifluorfen+diclofop-methyl+cloquintocet; acifluorfen+fenoxaprop(P-ethyl)+cloquintocet; acifluorfen +flazasulfuron+cloquintocet; acifluorfen+flupyrsulfuron+cloquintocet; acifluorfen+iodosulfuron+cloquintocet; acifluorfen+mecoprop+cloquintocet; acifluorfen+chlorsulfuron+cloquintocet; acifluorfen+metsulfuron+cloquintocet; acifluorfen+sulfosulfuron+cloquintocet; acifluorfen+thifensulfuron+cloquintocet; acifluorfen+tribenuron+cloquintocet; acifluorfen+ethametsulfuron+cloquintocet; acifluorfen+flamprop-M+cloquintocet; aclonifen+triasulfuron+cloquintocet; aclonifen+prosulfuron+cloquintocet; aclonifen+clodinafop+cloquintocet; aclonifen+amidosulfuron+cloquintocet; aclonifen+diclofop-methyl+cloquintocet; aclonifen+fenoxaprop(P-ethyl)+cloquintocet; aclonifen+flazasulfuron+cloquintocet; aclonifen+flupyrsulfuron+cloquintocet; aclonifen+iodosulfuron+cloquintocet; aclonifen+mecoprop+cloquintocet; aclonifen+chlorsulfuron+cloquintocet; aclonifen+metsulfuron+cloquintocet; aclonifen+sulfosulfuron+cloquintocet; aclonifen+thifensulfuron+cloquintocet; aclonifen+tribenuron +cloquintocet; aclonifen+ethametsulfuron+cloquintocet; aclonifen+flamprop-M+cloquintocet; bifenox+triasulfuron+cloquintocet; bifenox+prosulfuron+cloquintocet; bifenox+clodinafop+cloquintocet; bifenox+amidosulfuron+cloquintocet; bifenox+diclofop-methyl+cloquintocet; bifenox+fenoxaprop(P-ethyl)+cloquintocet; bifenox+flazasulfuron+cloquintocet; bifenox+flupyrsulfuron+cloquintocet; bifenox+iodosulfuron +cloquintocet; bifenox+mecoprop+cloquintocet; bifenox+chlorsulfuron+cloquintocet; bifenox+metsulfuron+cloquintocet; bifenox+sulfosulfuron+cloquintocet; bifenox+thifensulfuron+cloquintocet; bifenox+tribenuron+cloquintocet; bifenox+ethametsulfuron +cloquintocet; bifenox+flamprop-M+cloquintocet; chlomitrofen+triasulfuron+cloquintocet; chlomitrofen+prosulfuron+cloquintocet; chlomitrofen+clodinafop+cloquintocet; chlomitrofen+amidosulfuron+cloquintocet; chlomitrofen+diclofop-methyl+cloquintocet; chlomitrofen+fenoxaprop (P-ethyl)+cloquintocet; chlomitrofen+flazasulfuron+cloquintocet; chlomitrofen+flupyrsulfuron+cloquintocet; chlomitrofen+iodosulfuron+cloquintocet; chlomitrofen+mecoprop+cloquintocet; chlomitrofen+chlorsulfuron+cloquintocet; chlomitrofen+metsulfuron+cloquintocet; chlomitrofen+sulfosulfuron+cloquintocet; chlomitrofen+thifensulfuron+cloquintocet; chlomitrofen+tribenuron+cloquintocet; chlomitrofen+ethametsulfuron+cloquintocet; chlomitrofen+flamprop-M+cloquintocet; ethoxyfen+triasulfuron+cloquintocet; ethoxyfen+prosulfuron +cloquintocet; ethoxyfen+clodinafop+cloquintocet; ethoxyfen+amidosulfuron+cloquintocet; ethoxyfen+diclofop-methyl+cloquintocet; ethoxyfen+fenoxaprop(P-ethyl)+cloquintocet; ethoxyfen+flazasulfuron+cloquintocet; ethoxyfen+flupyrsulfuron+cloquintocet; ethoxyfen+iodosulfuron+cloquintocet; ethoxyfen+mecoprop+cloquintocet; ethoxyfen+chlorsulfuron+cloquintocet; ethoxyfen+metsulfuron+cloquintocet; ethoxyfen +sulfosulfuron+cloquintocet; ethoxyfen+thifensulfuron+cloquintocet; ethoxyfen+tribenuron+cloquintocet; ethoxyfen+ethametsulfuron+cloquintocet; ethoxyfen+flamprop-M+cloquintocet; fluoroglycofen+triasulfuron+cloquintocet; fluoroglycofen+prosulfuron+cloquintocet; fluoroglycofen+clodinafop+cloquintocet; fluoroglycofen+amidosulfuron+cloquintocet; fluoroglycofen+diclofop-methyl+cloquintocet; fluoroglycofen+fenoxaprop(P-ethyl)+cloquintocet; fluoroglycofen+flazasulfuron+cloquintocet; fluoroglycofen+flupyrsulfuron+cloquintocet; fluoroglycofen+iodosulfuron+cloquintocet; fluoroglycofen+mecoprop+cloquintocet; fluoroglycofen+chlorsulfuron+cloquintocet; fluoroglycofen+metsulfuron+cloquintocet; fluoroglycofen+sulfosulfuron+cloquintocet; fluoroglycofen+thifensulfuron+cloquintocet; fluoroglycofen+tribenuron+cloquintocet; fluoroglycofen+ethametsulfuron+cloquintocet; fluoroglycofen+flamprop-M +cloquintocet; fomesafen+triasulfuron+cloquintocet; fomesafen+prosulfuron+cloquintocet; fomesafen+clodinafop+cloquintocet; fomesafen+amidosulfuron+cloquintocet; fomesafen+diclofop-methyl+cloquintocet; fomesafen+fenoxaprop(P-ethyl) +cloquintocet; fomesafen+flazasulfuron+cloquintocet; fomesafen+flupyrsulfuron+cloquintocet; fomesafen+iodosulfuron+cloquintocet; fomesafen+mecoprop+cloquintocet; fomesafen+chlorsulfuron+cloquintocet; fomesafen+metsulfuron+cloquintocet; fomesafen+sulfosulfuron+cloquintocet; fomesafen+thifensulfuron+cloquintocet; fomesafen+tribenuron+cloquintocet; fomesafen+ethametsulfuron+cloquintocet; fomesafen+flamprop-M+cloquintocet; lactofen+triasulfuron+cloquintocet; lactofen+prosulfuron+cloquintocet; lactofen+clodinafop+cloquintocet; lactofen+amidosulfuron+cloquintocet; lactofen+diclofop-methyl+cloquintocet; lactofen+fenoxaprop(P-ethyl)+cloquintocet; lactofen+flazasulfuron+cloquintocet; lactofen+flupyrsulfuron+cloquintocet; lactofen+iodosulfuron+cloquintocet; lactofen+mecoprop+cloquintocet; lactofen+chlorsulfuron+cloquintocet; lactofen+metsulfuron+cloquintocet; lactofen+sulfosulfuron+cloquintocet; lactofen+thifensulfuron+cloquintocet; lactofen+tribenuron+cloquintocet; lactofen+ethametsulfuron+cloquintocet; lactofen+flamprop-M +cloquintocet; oxyfluorfen+triasulfuron+cloquintocet; oxyfluorfen+prosulfuron+cloquintocet; oxyfluorfen+clodinafop+cloquintocet; oxyfluorfen+amidosulfuron+cloquintocet; oxyfluorfen+diclofop-methyl+cloquintocet; oxyfluorfen+fenoxaprop(P-ethyl) +cloquintocet; oxyfluorfen+flazasulfuron+cloquintocet; oxyfluorfen+flupyrsulfuron+cloquintocet; oxyfluorfen+iodosulfuron+cloquintocet; oxyfluorfen+mecoprop+cloquintocet; oxyfluorfen+chlorsulfuron+cloquintocet; oxyfluorfen+metsulfuron+cloquintocet; oxyfluorfen+sulfosulfuron+cloquintocet; oxyfluorfen+thifensulfuron+cloquintocet; oxyfluorfen+tribenuron+cloquintocet; oxyfluorfen+ethametsulfuron+cloquintocet; oxyfluorfen+flamprop-M+cloquintocet; azafenidin+triasulfuron+cloquintocet; azafenidin+prosulfuron+cloquintocet; azafenidin+clodinafop+cloquintocet; azafenidin+amidosulfuron+cloquintocet; azafenidin+diclofop-methyl+cloquintocet; azafenidin+fenoxaprop(P-ethyl)+cloquintocet; azafenidin+flazasulfuron+cloquintocet; azafenidin+flupyrsulfuron+cloquintocet; azafenidin+iodosulfuron+cloquintocet; azafenidin+mecoprop+cloquintocet; azafenidin+chlorsulfuron+cloquintocet; azafenidin+metsulfuron+cloquintocet; azafenidin+sulfosulfuron+cloquintocet; azafenidin+thifensulfuron+cloquintocet; azafenidin+tribenuron+cloquintocet; azafenidin+ethametsulfuron+cloquintocet; azafenidin+flamprop-M+cloquintocet; carfentrazone-ethyl+triasulfuron+cloquintocet; carfentrazone-ethyl+prosulfuron+cloquintocet; carfentrazone-ethyl+clodinafop+cloquintocet; carfentrazone-ethyl+amidosulfuron+cloquintocet; carfentrazone-ethyl+diclofop-methyl+cloquintocet; carfentrazone-ethyl+fenoxaprop(P-ethyl)+cloquintocet; carfentrazone-ethyl+flazasulfuron+cloquintocet; carfentrazone-ethyl+flupyrsulfuron+cloquintocet; carfentrazone-ethyl+iodosulfuron+cloquintocet; carfentrazone-ethyl+mecoprop+cloquintocet; carfentrazone-ethyl+chlorsulfuron+cloquintocet; carfentrazone-ethyl+metsulfuron+cloquintocet; carfentrazone-ethyl+sulfosulfuron+cloquintocet; carfentrazone-ethyl+thifensulfuron+cloquintocet; carfentrazone-ethyl+tribenuron+cloquintocet; carfentrazone-ethyl+ethametsulfuron+cloquintocet; carfentrazone-ethyl+flamprop-M+cloquintocet; compound of the formula A+triasulfuron+cloquintocet; compound of the formula A+prosulfuron+cloquintocet; compound of the formula A+clodinafop+cloquintocet; compound of the formula A+amidosulfuron+cloquintocet; compound of the formula A+diclofop-methyl+cloquintocet; compound of the formula A+fenoxaprop(P-ethyl)+cloquintocet; compound of the formula A+flazasulfuron+cloquintocet; compound of the formula A+flupyrsulfuron+cloquintocet; compound of the formula A+iodosulfuron+cloquintocet; compound of the formula A+mecoprop+cloquintocet; compound of the formula A+chlorsulfuron+cloquintocet; compound of the formula A+metsulfuron+cloquintocet; compound of the formula A+sulfosulfuron+cloquintocet; compound of the formula A+thifensulfuron+cloquintocet; compound of the formula A+tribenuron+cloquintocet; compound of the formula A+ethametsulfuron+cloquintocet; compound of the formula A+flamprop-M+cloquintocet; cinidon-ethyl+triasulfuron+cloquintocet; cinidon-ethyl+prosulfuron+cloquintocet; cinidon-ethyl+clodinafop+cloquintocet; cinidon-ethyl+amidosulfuron+cloquintocet; cinidon-ethyl+diclofop-methyl+cloquintocet; cinidon-ethyl+fenoxaprop (P-ethyl)+cloquintocet; cinidon-ethyl+flazasulfuron+cloquintocet; cinidon-ethyl+flupyrsulfuron+cloquintocet; cinidon-ethyl+iodosulfuron+cloquintocet; cinidon-ethyl+mecoprop+cloquintocet; cinidon-ethyl+chlorsulfuron+cloquintocet; cinidon-ethyl+metsulfuron+cloquintocet; cinidon-ethyl+sulfosulfuron+cloquintocet; cinidon-ethyl+thifensulfuron+cloquintocet; cinidon-ethyl+tribenuron+cloquintocet; cinidon-ethyl+ethametsulfuron+cloquintocet; cinidon-ethyl+flamprop-M+cloquintocet; flumiclorac-pentyl+metsulfuron+cloquintocet; flumiclorac-pentyl +prosulfuron+cloquintocet; flumiclorac-pentyl+clodinafop+cloquintocet; flumiclorac-pentyl+amidosulfuron+cloquintocet; flumiclorac-pentyl+diclofop-methyl+cloquintocet; flumiclorac-pentyl+fenoxaprop(P-ethyl)+cloquintocet; flumiclorac-pentyl+flazasulfuron+cloquintocet; flumiclorac-pentyl+flupyrsulfuron on+cloquintocet; flumiclorac-pentyl+iodosulfuron+cloquintocet; flumiclorac-pentyl+mecoprop+cloquintocet; flumiclorac-pentyl +chlorsulfuron+cloquintocet; flumiclorac-pentyl+metsulfuron+cloquintocet; flumiclorac-pentyl+sulfosulfuron+cloquintocet; flumiclorac-pentyl+thifensulfuron+cloquintocet; flumiclorac-pentyl+tribenuron+cloquintocet; flumiclorac-pentyl+ethametsulfuron+cloquintocet; flumiclorac-pentyl+flamprop-M+cloquintocet; flumioxazin+triasulfuron+cloquintocet; flumioxazin+prosulfuron+cloquintocet; flumioxazin+clodinafop+cloquintocet; flumioxazin+amidosulfuron+cloquintocet; flumioxazin+diclofop-methyl+cloquintocet; flumioxazin+fenoxaprop(P-ethyl)+cloquintocet; flumioxazin+flazasulfuron+cloquintocet; flumioxazin+flupyrsulfuron+cloquintocet; flumioxazin+iodosulfuron+cloquintocet; flumioxazin+mecoprop+cloquintocet; flumioxazin+chlorsulfuron+cloquintocet; flumioxazin+metsulfuron+cloquintocet; flumioxazin+sulfosulfuron+cloquintocet; flumioxazin+thifensulfuron+cloquintocet; flumioxazin+tribenuron+cloquintocet; flumioxazin+ethametsulfuron+cloquintocet; flumioxazin+flamprop-M+cloquintocet; fluthiacet-methyl+triasulfuron+cloquintocet; fluthiacet-methyl+prosulfuron+cloquintocet; fluthiacet-methyl+clodinafop+cloquintocet; fluthiacet-methyl+amidosulfuron +cloquintocet; fluthiacet-methyl+diclofop-methyl+cloquintocet; fluthiacet-methyl+fenoxaprop(P-ethyl)+cloquintocet; fluthiacet-methyl+flazasulfuron+cloquintocet; fluthiacet-methyl+flupyrsulfuron+cloquintocet; fluthiacet-methyl+iodosulfuron+cloquintocet; fluthiacet-methyl+mecoprop+cloquintocet; fluthiacet-methyl+chlorsulfuron +cloquintocet; fluthiacet-methyl+metsulfuron+cloquintocet; fluthiacet-methyl+sulfosulfuron+cloquintocet; fluthiacet-methyl+thifensulfuron+cloquintocet; fluthiacet-methyl+tribenuron+cloquintocet; fluthiacet-methyl+ethametsulfuron+cloquintocet; fluthiacet-methyl+flamprop-M+ctoquintocet; oxadiargyl+triasulfuron+cloquintocet; oxadiargyl+prosulfuron+cloquintocet; oxadiargyl+clodinafop+cloquintocet; oxadiargyl+amidosulfuron+cloquintocet; oxadiargyl+diclofop-methyl+cloquintocet; oxadiargyl+fenoxaprop(P-ethyl)+cloquintocet; oxadiargyl+flazasulfuron+cloquintocet; oxadiargyl+flupyrsulfuron+cloquintocet; oxadiargyl+iodosulfuron+cloquintocet; oxadiargyl+mecoprop+cloquintocet; oxadiargyl+chlorsulfuron+cloquintocet; oxadiargyl+metsulfuron+cloquintocet; oxadiargyl+sulfosulfuron+cloquintocet; oxadiargyl+thifensulfuron+cloquintocet; oxadiargyl+tribenuron+cloquintocet; oxadiargyl+ethametsufruron+cloquintocet; oxadiargyl+flamprop-M+cloquintocet; oxadiazon+triasulfuron+cloquintocet; oxadiazon+prosulfuron+cloquintocet; oxadiazon+clodinafop +cloquintocet; oxadiazon+amidosulfuron+cloquintocet; oxadiazon+diclofop-methyl+cloquintocet; oxadiazon+fenoxaprop(P-ethyl)+cloquintocet; oxadiazon+flazasulfuron+cloquintocet; oxadiazon+flupyrsulfuron+cloquintocet; oxadiazon+iodosulfuron+cloquintocet; oxadiazon+mecoprop+cloquintocet; oxadiazon+chlorsulfuron+cloquintocet; oxadiazon+metsulfuron+cloquintocet; oxadiazon+sulfosulfuron+cloquintocet; oxadiazon+thifensulfuron+cloquintocet; oxadiazon+tribenuron+cloquintocet; oxadiazon+ethametsulfuron+cloquintocet; oxadiazon+flamprop-M+cloquintocet; pentoxazone+triasulfuron+cloquintocet; pentoxazone+prosulfuron+cloquintocet; pentoxazone+clodinafop+cloquintocet; pentoxazone+amidosulfuron+cloquintocet; pentoxazone+diclofop-methyl+cloquintocet; pentoxazone+fenoxaprop (P-ethyl)+cloquintocet; pentoxazone+flazasulfuron+cloquintocet; pentoxazone+flupyrsulfuron+cloquintocet; pentoxazone+iodosulfuron+cloquintocet; pentoxazone+mecoprop+cloquintocet; pentoxazone+chlorsulfuron+cloquintocet; pentoxazone+metsulfuron+cloquintocet; pentoxazone+sulfosulfuron+cloquintocet; pentoxazone+thifensulfuron+cloquintocet; pentoxazone+tribenuron+cloquintocet; pentoxazone+ethametsulfuron+cloquintocet; pentoxazone+flamprop-M+cloquintocet; sulfentrazone+triasulfuron+cloquintocet; sulfentrazone+prosulfuron+cloquintocet; sulfentrazone+clodinafop+cloquintocet; sulfentrazone+amidosulfuron+cloquintocet; sulfentrazone+diclofop-methyl+cloquintocet; sulfentrazone+fenoxaprop(P-ethyl)+cloquintocet; sulfentrazone+flazasulfuron+cloquintocet; sulfentrazone+flupyrsulfuron+cloquintocet; sulfentrazone+iodosulfuron+cloquintocet; sulfentrazone+mecoprop+cloquintocet; sulfentrazone+chlorsulfuron+cloquintocet; sulfentrazone+metsulfuron+cloquintocet; sulfentrazone+sulfosulfuron+cloquintocet; sulfentrazone+thifensulfuron+cloquintocet; sulfentrazone+tribenuron+cloquintocet; sulfentrazone+ethametsulfuron+cloquintocet; sulfentrazone+flamprop-M+cloquintocet; fluazolate+triasulfuron+cloquintocet; fluazolate+prosulfuron+cloquintocet; fluazolate+clodinafop+cloquintocet; fluazolate+amidosulfuron+cloquintocet; fluazolate+diclofop-methyl+cloquintocet; fluazolate+fenoxaprop(P-ethyl)+cloquintocet; fluazolate+flazasulfuron+cloquintocet; fluazolate+flupyrsulfuron+cloquintocet; fluazolate+iodosulfuron+cloquintocet; fluazolate+mecoprop+cloquintocet; fluazolate+chlorsulfuron+cloquintocet; fluazolate+metsulfuron +cloquintocet; fluazolate+sulfosulfuron+cloquintocet; fluazolate+thifensulfuron+cloquintocet; fluazolate+tribenuron+cloquintocet; fluazolate+ethametsulfuron+cloquintocet; fluazolate+flamprop-M+cloquintocet; pyraflufen-ethyl+triasulfuron+cloquintocet; pyraflufen-ethyl+prosulfuron+cloquintocet; pyraflufen-ethyl+clodinafop+cloquintocet; pyraflufen-ethyl+amidosulfuron+cloquintocet; pyraflufen-ethyl+diclofop-methyl+cloquintocet; pyraflufen-ethyl+fenoxaprop(P-ethyl)+cloquintocet; pyraflufen-ethyl +flazasulfuron+cloquintocet; pyraflufen-ethyl+flupyrsulfuron+cloquintocet; pyraflufen-ethyl+iodosulfuron+cloquintocet; pyraflufen-ethyl+mecoprop+cloquintocet; pyraflufen-ethyl+chlorsulfuron+cloquintocet; pyraflufen-ethyl+metsulfuron+cloquintocet; pyraflufen-ethyl+sulfosulfuron+cloquintocet; pyraflufen-ethyl+thifensulfuron+cloquintocet; pyraflufen-ethyl+tribenuron+cloquintocet; pyraflufen-ethyl+ethametsulfuron +cloquintocet; pyraflufen-ethyl+flamprop-M+cloquintocet; flumipropyn+triasulfuron+cloquintocet; flumipropyn+prosulfuron+cloquintocet; flumipropyn+clodinafop+cloquintocet; flumipropyn+amidosulfuron+cloquintocet; flumipropyn+diclofop-methyl+cloquintocet; flumipropyn+fenoxaprop(P-ethyl)+cloquintocet; flumipropyn+flazasulfuron +cloquintocet; flumipropyn+flupyrsulfuron+cloquintocet; flumipropyn+iodosulfuron+cloquintocet; flumipropyn+mecoprop+cloquintocet; flumipropyn+chlorsulfuron+cloquintocet; flumipropyn+metsulfuron+cloquintocet; flumipropyn+sulfosulfuron+cloquintocet; flumipropyn+thifensulfuron+cloquintocet; flumipropyn+tribenuron+cloquintocet; flumipropyn+ethametsulfuron+cloquintocet; flumipropyn+flamprop-M+cloquintocet; flupropacil+triasulfuron+cloquintocet; flupropacil+prosulfuron+cloquintocet; flupropacil+clodinafop+cloquintocet; flupropacil+amidosulfuron+cloquintocet; flupropacil+diclofop-methyl+cloquintocet; flupropacil+fenoxaprop(P-ethyl) +cloquintocet; flupropacil+flazasulfuron+cloquintocet; flupropacil+flupyrsulfuron+cloquintocet; flupropacil+iodosulfuron+cloquintocet; flupropacil+mecoprop+cloquintocet; flupropacil+chlorsulfuron+cloquintocet; flupropacil+metsulfuron+cloquintocet; flupropacil+sulfosulfuron+cloquintocet; flupropacil+thifensulfuron+cloquintocet; flupropacil+tribenuron+cloquintocet; flupropacil+ethametsulfuron+cloquintocet; flupropacil+flamprop-M+cloquintocet; nipyraclofen+triasulfuron+cloquintocet; nipyraclofen+prosulfuron+cloquintocet; nipyraclofen+clodinafop+cloquintocet; nipyraclofen+amidosulfuron+cloquintocet; nipyraclofen+diclofop-methyl+cloquintocet; nipyraclofen+fenoxaprop(P-ethyl)+cloquintocet; nipyraclofen+flazasulfuron +cloquintocet; nipyraclofen+flupyrsulfuron+cloquintocet; nipyraclofen+iodosulfuron+cloquintocet; nipyraclofen+mecoprop+cloquintocet; nipyraclofen+chlorsulfuron+cloquintocet; nipyraclofen+metsulfuron+cloquintocet; nipyraclofen+sulfosulfuron+cloquintocet; nipyraclofen+thifensulfuron+cloquintocet; nipyraclofen+tribenuron+cloquintocet; nipyraclofen+ethametsulfuron+cloquintocet; nipyraclofen+flamprop-M+cloquintocet; benzfendizone+triasulfuron+cloquintocet; benzfendizone+prosulfuron+cloquintocet; benzfendizone+clodinafop+cloquintocet; benzfendizone+amidosulfuron+cloquintocet; benzfendizone+diclofop-methyl+cloquintocet; benzfendizone+fenoxaprop(P-ethyl)+cloquintocet; benzfendizone+flazasulfuron+cloquintocet; benzfendizone+flupyrsulfuron+cloquintocet; benzfendizone+iodosulfuron+cloquintocet; benzfendizone+mecoprop+cloquintocet; benzfendizone+chlorsulfuron+cloquintocet; benzfendizone+metsulfuron+cloquintocet; benzfendizone+sulfosulfuron+cloquintocet; benzfendizone+thifensulfuron+cloquintocet; benzfendizone+tribenuron+cloquintocet; benzfendizone+ethametsulfuron+cloquintocet; benzfendizone+flamprop-M+cloquintocet; thidiazimin+triasulfuron+cloquintocet; thidiazimin+prosulfuron+cloquintocet; thidiazimin+clodinafop+cloquintocet; thidiazimin+amidosulfuron+cloquintocet; thidiazimin+diclofop-methyl+cloquintocet; thidiazimin+fenoxaprop(P-ethyl) +cloquintocet; thidiazimin+flazasulfuron+cloquintocet; thidiazimin+flupyrsulfuron+cloquintocet; thidiazimin+iodosulfuron+cloquintocet; thidiazimin+mecoprop+cloquintocet; thidiazimin+chlorsulfuron+cloquintocet; thidiazimin+metsulfuron+cloquintocet; thidiazimin+sulfosulfuron+cloquintocet; thidiazimin+thifensulfuron+cloquintocet; thidiazimin+tribenuron+cloquintocet; thidiazimin+ethametsulfuron+cloquintocet; and thidiazimin+flamprop-M+cloquintocet.

The following specific combinations of the compounds under a) with the co-herbicides under b) (3-compound and 4-compound combinations) have been found to be further groups of very particularly effective herbicidal synergistic and selective-herbicidal compositions, in particular in crops of maize resistant to protoporphyrinogen oxidase inhibitors:

acifluorfen+prosulfuron+primisulfuron; acifluorfen+prosulfuron+dicamba; acifluorfen+primisulfuron+dicamba; acifluorfen+nicosulfuron+primisulfuron; acifluorfen+nicosulfuron+prosulfuron; acifluorfen+rimsulfuron+primisulfuron; acifluorfen+rimsulfuron+prosulfuron; acifluorfen+metolachlor+isoxaflutole; acifluorfen+metolachlor +isoxaflutole+benoxacor; acifluorfen+S-metolachlor+isoxaflutole; acifluorfen+S-metolachlor+isoxaflutole+benoxacor; acifluorfen+metolachlor+mesotrione; acifluorfen +metolachlor+mesotrione+benoxacor; acifluorfen+S-metolachlor+mesotrione; acifluorfen+S-metolachlor+mesotrione+benoxacor; acifluorfen+metolachlor or+atrazine; acifluorfen+metolachlor+atrazine+benoxacor; acifluorfen+S-metolachlor+atrazine; acifluorfen+S-metolachlor+atrazine+benoxacor; acifluorfen+metolachlor+terbuthylazine; acifluorfen+metolachlor+terbuthylazine+benoxacor; acifluorfen+S-metolachlor+terbuthylazine; acifluorfen+S-metolachlor+terbuthylazine+benoxacor; acifluorfen+atrazine+nicosulfuron; acifluorfen+atrazine+nicosulfuron+benoxacor; aclonifen+prosulfuron+primisulfuron; aclonifen+prosulfuron+dicamba; aclonifen+primisulfuron+dicamba; aclonifen+nicosulfuron+primisulfuron; aclonifen+nicosulfuron+prosulfuron; aclonifen+rimsulfuron+primisulfuron; aclonifen+rimsulfuron+prosulfuron; aclonifen+metolachlor+isoxaflutole; aclonifen+metolachlor+isoxaflutole+benoxacor; aclonifen+S-metolachlor+isoxaflutole; aclonifen+S-metolachlor+isoxaflutole+benoxacor; aclonifen+metolachlor+mesotrione; aclonifen+metolachlor+mesotrione+benoxacor; aclonifen+S-metolachlor+mesotrione; aclonifen+S-metolachlor+mesotrione +benoxacor; aclonifen+metolachlor+atrazine; aclonifen+metolachlor+atrazine+benoxacor; aclonifen+,S-metolachlor+atrazine; aclonifen+S-metolachlor+atrazine+benoxacor, aclonifen+metolachlor+terbuthylazine; aclonifen+metolachlor+terbuthylazine+benoxacor; aclonifen+S-metolachlor+terbuthylazine; aclonifen+S-metolachlor+terbuthylazine+benoxacor; aclonifen+atrazine+nicosulfuron; aclonifen+atrazine+nicosulfuron+benoxacor; bifenox+prosulfuron+primisulfuron; bifenox+prosulfuron+dicamba; bifenox+primisulfuron+dicamba; bifenox+nicosulfuron+primisulfuron; bifenox+nicosulfuron+prosulfuron; bifenox+rimsulfuron+primisulfuron; bifenox+rimsulfuron+prosulfuron; bifenox+metolachlor+isoxaflutole; bifenox+metolachlor+isoxaflutole+benoxacor; bifenox+S-metolachlor+isoxaflutole; bifenox+S-metolachlor+isoxaflutole+benoxacor; bifenox+metolachlor+mesotrione; bifenox+metolachlor+mesotrione+benoxacor; bifenox+S-metolachlor+mesotrione; bifenox+S-metolachlor+mesotrione+benoxacor; bifenox+metolachlor+atrazine; bifenox+metolachlor+atrazine+benoxacor; bifenox+S-metolachlor+atrazine; bifenox+S-metolachlor+atrazine+benoxacor; bifenox+metolachlor+terbuthylazine; bifenox+metolachlor+terbuthylazine+benoxacor; bifenox+S-metolachlor+terbuthylazine; bifenox +S-metolachlor+terbuthylazine+benoxacor; bifenox+atrazine+nicosulfuron; bifenox+atrazine+nicosulfuron+benoxacor; chlomitrofen+prosulfuron+primisulfuron; chlomitrofen+prosulfuron+dicamba; chlomitrofen+primisulfuron+dicamba; chlomitrofen +nicosulfuron+primisulfuron; chlomitrofen+nicosulfuron+prosulfuron; chlomitrofen+rimsulfuron+primisulfuron; chlomitrofen+rimsulfuron+prosulfuron; chlomitrofen+metolachlor+isoxaflutole; chlomitrofen+metolachlor+isoxaflutole+benoxacor; chlomitrofen+S-metolachlor+isoxaflutole; chlomitrofen+S-metolachlor+isoxaflutole+benoxacor; chlomitrofen+metolachlor+mesotrione; chlomitrofen+metolachlor+mesotrione+benoxacor; chlomitrofen+S-metolachlor+mesotrione; chlomitrofen+S-metolachlor+mesotrione+benoxacor; chlomitrofen+metolachlor+atrazine; chlomitrofen +metolachlor+atrazine+benoxacor; chlomitrofen+S-metolachlor+atrazine; chlomitrofen +-metolachlor+atrazine+benoxacor; chlomitrofen+metolachlor+terbuthylazine; chlomitrofen+metolachlor+terbuthylazine+benoxacor, chlomitrofen+S-metolachlor+terbuthylazine; chlomitrofen+S-metolachlor+terbuthylazine+benoxacor; chlomitrofen+atrazine+nicosulfuron; chlomitrofen+atrazine+nicosulfuron+benoxacor; ethoxyfen+prosulfuron+primisulfuron; ethoxyfen+prosulfuron+dicamba; ethoxyfen+primisulfuron+dicamba; ethoxyfen+nicosulfuron+primisulfuron; ethoxyfen+nicosulfuron+prosulfuron; ethoxyfen+rimsulfuron+primisulfuron; ethoxyfen+rimsulfuron+prosulfuron; ethoxyfen+metolachlor+isoxaflutole; ethoxyfen+metolachlor+isoxaflutole+benoxacor; ethoxyfen+S-metolachlor+isoxaflutole; ethoxyfen+S-metolachlor+isoxaflutole+benoxacor; ethoxyfen+metolachlor+mesotrione; ethoxyfen+metolachlor+mesotrione+benoxacor; ethoxyfen+S-metolachlor+mesotrione; ethoxyfen+S-metolachlor+mesotrione+benoxacor, ethoxyfen+metolachlor+atrazine; ethoxyfen+metolachlor+atrazine+benoxacor; ethoxyfen+S-metolachlor+atrazine; ethoxyfen+S-metolachlor+atrazine+benoxacor; ethoxyfen+metolachlor+terbuthylazine; ethoxyfen+metolachlor+terbuthylazine+benoxacor; ethoxyfen+S-metolachlor+terbuthylazine; ethoxyfen+S-metolachlor+terbuthylazine+benoxacor; ethoxyfen+atrazine+nicosulfuron; ethoxyfen+atrazine+nicosulfuron+benoxacor; fluoroglycofen+prosulfuron+primisulfuron; fluoroglycofen+prosulfuron+dicamba; fluoroglycofen+primisulfuron+dicamba; fluoroglycofen+nicosulfuron+primisulfuron; fluoroglycofen+nicosulfuron+prosulfuron; fluoroglycofen+rimsulfuron+primisulfuron; fluoroglycofen+rimsulfuron+prosulfuron; fluoroglycofen+metolachlor+isoxaflutole; fluoroglycofen+metolachlor+isoxaflutole+benoxacor; fluoroglycofen+S-metolachlor+isoxaflutole; fluoroglycofen+S-metolachlor+isoxaflutole+benoxacor; fluoroglycofen+metolachlor+mesotrione; fluoroglycofen+metolachlor+mesotrione+benoxacor; fluoroglycofen+S-metolachlor+mesotrione; fluoroglycofen+S-metolachlor+mesotrione+benoxacor; fluoroglycofen+metolachlor+atrazine; fluoroglycofen+metolachlor+atrazine+benoxacor; fluoroglycofen+S-metolachlor+atrazine; fluoroglycofen+S-metolachlor+atrazine+benoxacor; fluoroglycofen+metolachlor+terbuthylazine; fluoroglycofen+metolachlor+terbuthylazine +benoxacor; fluoroglycofen+S-metolachlor+terbuthylazine; fluoroglycofen+S-metolachlor+terbuthylazine+benoxacor; fluoroglycofen+atrazine+nicosulfuron; fluoroglycofen+atrazine+nicosulfuron+benoxacor; fomesafen+prosulfuron+primisulfuron; fomesafen+prosulfuron+dicamba; fomesafen+primisulfuron+dicamba; fomesafen+nicosulfuron+primisulfuron; fomesafen+nicosulfuron+prosulfuron; fomesafen+rimsulfuron+primisulfuron; fomesafen+rimsulfuron+prosulfuron; fomesafen +metolachlor+isoxaflutole; fomesafen+metolachlor+isoxaflutole+benoxacor; fomesafen+S-metolachlor+isoxaflutole; fomesafen+S-metolachlor+isoxaflutole+benoxacor; fomesafen+metolachlor+mesotrione; fomesafen+metolachlor+mesotrione +benoxacor; fomesafen+S-metolachlor+mesotrione; fomesafen+S-metolachlor+mesotrione+benoxacor; fomesafen+metolachlor+atrazine; fomesafen+metolachlor+atrazine+benoxacor; fomesafen+S-metolachlor+atrazine; fomesafen+S-metolachlor+atrazine+benoxacor; fomesafen+metolachlor+terbuthylazine; fomesafen+metolachlor +terbuthylazine+benoxacor; fomesafen+S-metolachlor+terbuthylazine; fomesafen+S-metolachlor+terbuthylazine+benoxacor; fomesafen+atrazine+nicosulfuron; fomesafen +atrazine+nicosulfuron+benoxacor; lactofen+prosulfuron+primisulfuron; lactofen+prosulfuron+dicamba; lactofen+primisulfuron+dicamba; lactofen+nicosulfuron+primisulfuron; lactofen+nicosulfuron+prosulfuron; lactofen+rimsulfuron+primisulfuron; lactofen+rimsulfuron+prosulfuron; lactofen+metolachlor+isoxaflutole; lactofen+metolachlor+isoxaflutole+benoxacor; lactofen+S-metolachlor+isoxaflutole; lactofen+S-metolachlor+isoxaflutole+benoxacor; lactofen+metolachlor+mesotrione; lactofen+metolachlor+mesotrione+benoxacor; lactofen+S-metolachlor+mesotrione; lactofen+S-metolachlor+mesotrione+benoxacor; lactofen+metolachlor+atrazine; lactofen+metolachlor+atrazine+benoxacor; lactofen+S-metolachlor+atrazine; lactofen+S-metolachlor+atrazine+benoxacor; lactofen+metolachlor+terbuthylazine; lactofen+metolachlor+terbuthylazine+benoxacor; lactofen+S-metolachlor+terbuthylazine; lactofen+S-metolachlor+terbuthylazine+benoxacor; lactofen+atrazine+nicosulfuron; lactofen+atrazine+nicosulfuron+benoxacor; oxyfluorfen+prosulfuron+primisulfuron; oxyfluorfen+prosulfuron+dicamba; oxyfluorfen+primisulfuron+dicamba; oxyfluorfen+nicosulfuron+primisulfuron; oxyfluorfen+nicosulfuron+prosulfuron; oxyfluorfen+rimsulfuron+primisulfuron; oxyfluorfen+rimsulfuron+prosulfuron; oxyfluorfen+metolachlor+isoxaflutole; oxyfluorfen+metolachlor+isoxaflutole+benoxacor; oxyfluorfen +S-metolachlor+isoxaflutole; oxyfluorfen+S-metolachlor+isoxaflutole+benoxacor; oxyfluorfen+metolachlor+mesotrione; oxyfluorfen+metolachlor+mesotrione+benoxacor; oxyfluorfen+S-metolachlor+mesotrione; oxyfluorfen+S-metolachlor+mesotrione+benoxacor; oxyfluorfen+metolachlor+atrazine; oxyfluorfen+metolachlor+atrazine+benoxacor; oxyfluorfen+S-metolachlor+atrazine; oxyfluorfen+S-metolachlor+atrazine+benoxacor; oxyfluorfen+metolachlor+terbuthylazine; oxyfluorfen+metolachlor +terbuthylazine+benoxacor; oxyfluorfen+S-metolachlor+terbuthylazine; oxyfluorfen+S-metolachlor+terbuthylazine+benoxacor; oxyfluorfen+atrazine+nicosulfuron; oxyfluorfen +atrazine+nicosulfuron+benoxacor; azafenidin+prosulfuron+primisulfuron; azafenidin +prosulfuron+dicamba; azafenidin+primisulfuron+dicamba; azafenidin+nicosulfuron+primisulfuron; azafenidin+nicosulfuron+prosulfuron; azafenidin+rimsulfuron+primisulfuron; azafenidin+rimsulfuron+prosulfuron; azafenidin+metolachlor+isoxaflutole; azafenidin+metolachlor+isoxaflutole+benoxacor; azafenidin+S-=metolachlor+isoxaflutole; azafenidin+S-metolachlor+isoxaflutole+benoxacor; azafenidin+metolachlor+mesotrione; azafenidin+metolachlor+mesotrione+benoxacor; azafenidin+S-metolachlor+mesotrione; azafenidin+S-metolachlor+mesotrione+benoxacor; azafenidin+metolachlor+atrazine; azafenidin+metolachlor+atrazine+benoxacor; azafenidin+S-metolachlor+atrazine; azafenidin+S-metolachlor+atrazine+benoxacor; azafenidin+metolachlor+terbuthylazine; azafenidin+metolachlor+terbuthylazine+benoxacor; azafenidin+S-metolachlor+terbuthylazine; azafenidin+S-metolachlor+terbuthylazine+benoxacor; azafenidin+atrazine+nicosulfuron; azafenidin +atrazine+nicosulfuron+benoxacor; carfentrazone-ethyl+prosulfuron+primisulfuron; carfentrazone-ethyl+prosulfuron+dicamba; carfentrazone-ethyl+primisulfuron+dicamba; carfentrazone-ethyl+nicosulfuron+primisulfuron; carfentrazone-ethyl+nicosulfuron+prosulfuron; carfentrazone-ethyl+rimsulfuron+primisulfuron; carfentrazone-ethyl+rimsulfuron+prosulfuron; carfentrazone-ethyl+metolachlor+isoxaflutole; carfentrazone-ethyl+metolachlor+isoxaflutole+benoxacor; carfentrazone-ethyl+S-metolachlor+isoxaflutole; carfentrazone-ethyl+S-metolachlor+isoxaflutole+benoxacor; carfentrazone-ethyl+metolachlor+mesotrione; carfentrazone-ethyl+metolachlor+mesotrione+benoxacor; carfentrazone-ethyl+S-metolachlor+mesotrione; carfentrazone-ethyl+S-metolachlor+mesotrione+benoxacor; carfentrazone-ethyl+metolachlor+atrazine; carfentrazone-ethyl+metolachlor+atrazine+benoxacor; carfentrazone-ethyl+S-metolachlor+atrazine; carfentrazone-ethyl+S-metolachlor+atrazine+benoxacor; carfentrazone-ethyl+metolachlor+terbuthylazine; carfentrazone-ethyl+metolachlor+terbuthylazine+benoxacor; carfentrazone-ethyl+S-metolachlor+terbuthylazine; carfentrazone-ethyl+S-metolachlor+terbuthylazine+benoxacor; carfentrazone-ethyl+atrazine+nicosulfuron; carfentrazone-ethyl+atrazine+nicosulfuron+benoxacor; compound of the formula A+prosulfuron+primisulfuron; compound of the formula A+prosulfuron+dicamba; compound of the formula A+primisulfuron+dicamba; compound of the formula A+nicosulfuron+primisulfuron; compound of the formula A+nicosulfuron+prosulfuron; compound of the formula A+rimsulfuron+primisulfuron; compound of the formula A+rimsulfuron+prosulfuron; compound of the formula A+metolachlor+isoxaflutole; compound of the formula A+metolachlor+isoxaflutole+benoxacor; compound of the formula A+S-metolachlor+isoxaflutole; compound of the formula A+S-metolachlor+isoxaflutole+benoxacor; compound of the formula A+metolachlor+mesotrione; compound of the formula A+metolachlor+mesotrione+benoxacor; compound of the formula A+S-metolachlor+mesotrione; compound of the formula A+S-metolachlor+mesotrione+benoxacor; compound of the formula A+metolachlor+atrazine; compound of the formula A+metolachlor+atrazine+benoxacor; compound of the formula A+S-metolachlor+atrazine; compound of the formula A+S-metolachlor+atrazine+benoxacor; compound of the formula A+metolachlor+terbuthylazine; compound of the formula A+metolachlor+terbuthylazine+benoxacor; compound of the formula A+S-metolachlor+terbuthylazine; compound of the formula A+S-metolachlor+terbuthylazine+benoxacor; compound of the formula A+atrazine+nicosulfuron; compound of the formula A+atrazine+nicosulfuron+benoxacor; cinidon-ethyl+prosulfuron+primisulfuron; cinidon-ethyl+prosulfuron+dicamba; cinidon-ethyl+primisulfuron+dicamba; cinidon-ethyl+nicosulfuron+primisulfuron; cinidon-ethyl+nicosulfuron+prosulfuron; cinidon-ethyl+rimsulfuron+primisulfuron; cinidon-ethyl+rimsulfuron+prosulfuron; cinidon-ethyl+metolachlor+isoxaflutole; cinidon-ethyl+metolachlor+isoxaflutole+benoxacor; cinidon-ethyl+S-metolachlor+isoxaflutole; cinidon-ethyl+S-metolachlor+isoxaflutole+benoxacor; cinidon-ethyl+metolachlor+mesotrione; cinidon-ethyl+metolachlor+mesotrione+benoxacor; cinidon-ethyl+S-metolachlor+mesotrione; cinidon-ethyl+S-metolachlor+mesotrione+benoxacor; cinidon-ethyl+metolachlor+atrazine; cinidon-ethyl+metolachlor+atrazine+benoxacor; cinidon-ethyl+S-metolachlor+atrazine; cinidon-ethyl+S-metolachlor+atrazine+benoxacor; cinidon-ethyl+metolachlor+terbuthylazine; cinidon-ethyl+metolachlor+terbuthylazine+benoxacor; cinidon-ethyl+S-metolachlor+terbuthylazine; cinidon-ethyl+S-metolachlor+terbuthylazine+benoxacor; cinidon-ethyl+atrazine+nicosulfuron; cinidon-ethyl+atrazine +nicosulfuron+benoxacor; flumiclorac-pentyl+prosulfuron+primisulfuron; flumiclorac-pentyl+prosulfuron+dicamba; flumiclorac-pentyl+primisulfuron+dicamba; flumiclorac-pentyl+nicosulfuron+primisulfuron; flumiclorac-pentyl+nicosulfuron+prosulfuron; flumiclorac-pentyl+rimsulfuron+primisulfuron; flumiclorac-pentyl+rimsulfuron+prosulfuron; flumiclorac-pentyl+metolachlor+isoxaflutole; flumiclorac-pentyl+metolachlor +isoxaflutole+benoxacor; flumiclorac-pentyl+S-metolachlor+isoxaflutole; flumiclorac-pentyl+S-metolachlor+isoxaflutole+benoxacor; flumiclorac-pentyl+metolachlor+mesotrione; flumiclorac-pentyl+metolachlor+mesotrione+benoxacor; flumiclorac-pentyl+S-metolachlor+mesotrione; flumiclorac-pentyl+S-metolachlor+mesotrione+benoxacor; flumiclorac-pentyl+metolachlor+atrazine; flumiclorac-pentyl+metolachlor+atrazine+benoxacor; flumiclorac-pentyl+S-metolachlor+atrazine; flumiclorac-pentyl+S-metolachlor +atrazine+benoxacor; flumiclorac-pentyl+metolachlor+terbuthylazine; flumiclorac-pentyl +metolachlor+terbuthylazine+benoxacor; flumiclorac-pentyl+S-metolachlor+terbuthylazine; flumiclorac-pentyl+S-metolachlor+terbuthylazine+benoxacor; flumiclorac-pentyl+atrazine+nicosulfuron; flumiclorac-pentyl+atrazine+nicosulfuron+benoxacor; flumioxazin+prosulfuron+primisulfuron; flumioxazin+prosulfuron+dicamba; flumioxazin +primisulfuron+dicamba; flumioxazin+nicosulfuron+primisulfuron; flumioxazin+nicosulfuron+prosulfuron; flumioxazin+rimsulfuron+primisulfuron; flumioxazin+rimsulfuron+prosulfuron; flumioxazin+metolachlor+isoxaflutole; flumioxazin+metolachlor+isoxaflutole+benoxacor; flumioxazin+S-metolachlor+isoxaflutole; flumioxazin+S-metolachlor+isoxaflutole+benoxacor; flumioxazin+metolachlor+mesotrione; flumioxazin+metolachlor+mesotrione+benoxacor; flumioxazin+S-metolachlor+mesotrione; flumioxazin+S-metolachlor+mesotrione+benoxacor; flumioxazin+metolachlor+atrazine; flumioxazin+metolachlor+atrazine+benoxacor; flumioxazin+S-metolachlor+atrazine; flumioxazin+S-metolachlor+atrazine+benoxacor; flumioxazin+metolachlor+terbuthylazine; flumioxazin+metolachlor+terbuthylazine+benoxacor; flumioxazin+S-metolachlor+terbuthylazine; flumioxazin+S-metolachlor+terbuthylazine+benoxacor; flumioxazin+atrazine+nicosulfuron; flumioxazin+atrazine+nicosulfuron+benoxacor; fluthiacet-methyl+prosulfuron+primisulfuron; fluthiacet-methyl +prosulfuron+dicamba; fluthiacet-methyl+primisulfuron+dicamba; fluthiacet-methyl+nicosulfuron+primisulfuron; fluthiacet-methyl+nicosulfuron+prosulfuron; fluthiacet-methyl +rimsulfuron+primisulfuron; fluthiacet-methyl+rimsulfuron+prosulfuron; fluthiacet-methyl +metolachlor+isoxaflutole; fluthiacet-methyl+metolachlor+isoxaflutole+benoxacor; fluthiacet-methyl+S-metolachlor+isoxaflutole; fluthiacet-methyl+S-metolachlor+isoxaflutole+benoxacor; fluthiacet-methyl+metolachlor+mesotrione; fluthiacet-methyl+metolachlor+mesotrione+benoxacor; fluthiacet-methyl+S-metolachlor+mesotrione; fluthiacet-methyl+S-metolachlor+mesotrione+benoxacor; fluthiacet-methyl+metolachlor +atrazine; fluthiacet-methyl+metolachlor+atrazine+benoxacor; fluthiacet-methyl+S-metolachlor+atrazine; fluthiacet-methyl+S-metolachlor+atrazine+benoxacor; fluthiacet-methyl+metolachlor+terbuthylazine; fluthiacet-methyl+metolachlor+terbuthylazine+benoxacor; fluthiacet-methyl+S-metolachlor+terbuthylazine; fluthiacet-methyl+S-metolachlor+terbuthylazine+benoxacor; fluthiacet-methyl+atrazine+nicosulfuron; fluthiacet-methyl+atrazine+nicosulfuron+benoxacor; oxadiargyl+prosulfuron+primisulfuron; oxadiargyl+prosulfuron+dicamba; oxadiargyl+primisulfuron+dicamba; oxadiargyl+nicosulfuron+primisulfuron; oxadiargyl+nicosulfuron+prosulfuron; oxadiargyl+rimsulfuron+primisulfuron; oxadiargyl+rimsulfuron+prosulfuron; oxadiargyl +metolachlor+isoxaflutole; oxadiargyl+metolachlor+isoxaflutole+benoxacor; oxadiargyl +S-metolachlor+isoxaflutole; oxadiargyl+S-metolachlor+isoxaflutole+benoxacor; oxadiargy+metolachlor or+mesotrione; oxadiargyl+metolachlor+mesotrione+benoxacor; oxadiargyl+S-metolachlor+mesotrione; oxadiargyl+S-metolachlor+mesotrione+benoxacor; oxadiargyl+metolachlor+atrazine; oxadiargyl+metolachlor+atrazine+benoxacor; oxadiargyl+S-metolachlor+atrazine; oxadiargyl+S-metolachlor+atrazine+benoxacor; oxadiargyl+metolachlor+terbuthylazine; oxadiargyl+metolachlor+terbuthylazine+benoxacor; oxadiargyl+S-metolachlor+terbuthylazine; oxadiargyl+S-metolachlor+terbuthylazine+benoxacor; oxadiargyl+atrazine+nicosulfuron; oxadiargyl+atrazine+nicosulfuron+benoxacor; oxadiazon+prosulfuron+primisulfuron; oxadiazon+prosulfuron+dicamba; oxadiazon+primisulfuron+dicamba; oxadiazon+nicosulfuron+primisulfuron; oxadiazon+nicosulfuron+prosulfuron; oxadiazon+rimsulfuron+primisulfuron; oxadiazon+rimsulfuron+prosulfuron; oxadiazon+metolachlor +isoxaflutole; oxadiazon+metolachlor+isoxaflutole+benoxacor; oxadiazon+S-metolachlor+isoxaflutole; oxadiazon+S-metolachlor+isoxaflutole+benoxacor; oxadiazon+metolachlor+mesotrione; oxadiazon+metolachlor+mesotrione+benoxacor; oxadiazon+S-metolachlor+mesotrione; oxadiazon+S-metolachlor+mesotrione+benoxacor; oxadiazon+metolachlor+atrazine; oxadiazon+metolachlor+atrazine+benoxacor; oxadiazon+S-metolachlor+atrazine; oxadiazon+S-metolachlor+atrazine+benoxacor; oxadiazon+metolachlor+terbuthylazine; oxadiazon+metolachlor+terbuthylazine+benoxacor; oxadiazon+S-metolachlor+terbuthylazine; oxadiazon+S-metolachlor+terbuthylazine+benoxacor; oxadiazon+atrazine+nicosulfuron; oxadiazon+atrazine+nicosulfuron+benoxacor; pentoxazone+prosulfuron+primisulfuron; pentoxazone+prosulfuron+dicamba; pentoxazone+primisulfuron+dicamba; pentoxazone+nicosulfuron+primisulfuron; pentoxazone+nicosulfuron+prosulfuron; pentoxazone+rimsulfuron+primisulfuron; pentoxazone+rimsulfuron+prosulfuron; pentoxazone+metolachlor+isoxaflutole; pentoxazone+metolachlor+isoxaflutole+benoxacor; pentoxazone+S-metolachlor+isoxaflutole; pentoxazone+S-metolachlor+isoxaflutole+benoxacor; pentoxazone+metolachlor+mesotrione; pentoxazone+metolachlor+mesotrione+benoxacor; pentoxazone+S-metolachlor+mesotrione; pentoxazone+S-metolachlor+mesotrione+benoxacor; pentoxazone+metolachlor+atrazine; pentoxazone+metolachlor+atrazine+benoxacor; pentoxazone+S-metolachlor +atrazine; pentoxazone+S-metolachlor+atrazine+benoxacor; pentoxazone+metolachlor+terbuthylazine; pentoxazone+metolachlor+terbuthylazine+benoxacor; pentoxazone+S-metolachlor+terbuthylazine; pentoxazone+S-metolachlor+terbuthylazine+benoxacor; pentoxazone+atrazine+nicosulfuron; pentoxazone+atrazine +nicosulfuron+benoxacor; sulfentrazone+prosulfuron+primisulfuron; sulfentrazone+prosulfuron+dicamba; sulfentrazone+primisulfuron+dicamba; sulfentrazone+nicosulfuron+primisulfuron; sulfentrazone+nicosulfuron+prosulfuron; sulfentrazone+rimsulfuron+primisulfuron; sulfentrazone+rimsulfuron+prosulfuron; sulfentrazone+metolachlor+isoxaflutole; sulfentrazone+metolachlor+isoxaflutole+benoxacor; sulfentrazone+S-metolachlor+isoxaflutole; sulfentrazone+S-metolachlor+isoxaflutole+benoxacor; sulfentrazone+metolachlor+mesotrione; sulfentrazone+metolachlor+mesotrione+benoxacor; sulfentrazone+S-metolachlor+mesotrione; sulfentrazone+S-metolachlor+mesotrione+benoxacor; sulfentrazone+metolachlor+atrazine; sulfentrazone+metolachlor+atrazine+benoxacor; sulfentrazone+S-metolachlor+atrazine; sulfentrazone+S-metolachlor+atrazine+benoxacor; sulfentrazone+metolachlor+terbuthylazine; sulfentrazone+metolachlor+terbuthylazine+benoxacor; sulfentrazone+S-metolachlor+terbuthylazine; sulfentrazone+S-metolachlor+terbuthylazine+benoxacor; sulfentrazone+atrazine+nicosulfuron; sulfentrazone+atrazine+nicosulfuron+benoxacor; fluazolate+prosulfuron+primisulfuron; fluazolate+prosulfuron+dicamba; fluazolate+primisulfuron+dicamba; fluazolate+nicosulfuron+primisulfuron; fluazolate+nicosulfuron+prosulfuron; fluazolate+rimsulfuron+primisulfuron; fluazolate+rimsulfuron+prosulfuron; fluazolate+metolachlor+isoxaflutole; fluazolate+metolachlor+isoxaflutole+benoxacor; fluazolate+S-metolachlor+isoxaflutole; fluazolate+S-metolachlor+isoxaflutole+benoxacor; fluazolate+metolachlor +mesotrione; fluazolate+metolachlor+mesotrione+benoxacor; fluazolate+S-metolachlor+mesotrione; fluazolate+S-metolachlor+mesotrione+benoxacor; fluazolate +metolachlor+atrazine; fluazolate+metolachlor+atrazine+benoxacor; fluazolate+S-metolachlor+atrazine; fluazolate+S-metolachlor+atrazine+benoxacor; fluazolate+metolachlor+terbuthylazine; fluazolate+metolachlor+terbuthylazine+benoxacor; fluazolate+S-metolachlor+terbuthylazine; fluazolate+S-metolachlor+terbuthylazine+benoxacor; fluazolate+atrazine+nicosulfuron; fluazolate+atrazine+nicosulfuron+benoxacor; pyraflufen-ethyl+prosulfuron+primisulfuron; pyraflufen-ethyl+prosulfuron+dicamba; pyraflufen-ethyl+primisulfuron+dicamba; pyraflufen-ethyl+nicosulfuron+primisulfuron; pyraflufen-ethyl+nicosulfuron+prosulfuron; pyraflufen-ethyl+rimsulfuron+primisulfuron; pyraflufen-ethyl+rimsulfuron+prosulfuron; pyraflufen-ethyl+metolachlor+isoxaflutole; pyraflufen-ethyl+metolachlor+isoxaflutole+benoxacor; pyraflufen-ethyl+S-metolachlor+isoxaflutole; pyraflufen-ethyl+S-metolachlor+isoxaflutole+benoxacor; pyraflufen-ethyl+metolachlor+mesotrione; pyraflufen-ethyl+metolachlor+mesotrione+benoxacor; pyraflufen-ethyl+S-metolachlor+mesotrione; pyraflufen-ethyl+S-metolachlor +mesotrione+benoxacor; pyraflufen-ethyl+metolachlor+atrazine; pyraflufen-ethyl+metolachlor+atrazine+benoxacor; pyraflufen-ethyl+S-metolachlor+atrazine; pyraflufen-ethyl+S-metolachlor+atrazine+benoxacor; pyraflufen-ethyl+metolachlor+terbuthylazine; pyraflufen-ethyl+metolachlor+terbuthylazine+benoxacor; pyraflufen-ethyl +S-metolachlor+terbuthylazine; pyraflufen-ethyl+S-metolachlor+terbuthylazine+benoxacor; pyraflufen-ethyl+atrazine+nicosulfuron; pyraflufen-ethyl+atrazine+nicosulfuron+benoxacor; flumipropyn+prosulfuron+primisulfuron; flumipropyn+prosulfuron+dicamba; flumipropyn+primisulfuron+dicamba; flumipropyn+nicosulfuron+primisulfuron; flumipropyn+nicosulfuron+prosulfuron; flumipropyn+rimsulfuron+primisulfuron; flumipropyn+rimsulfuron+prosulfuron; flumipropyn+metolachlor+isoxaflutole; flumipropyn+metolachlor+isoxaflutole+benoxacor; flumipropyn+S-metolachlor+isoxaflutole; flumipropyn+S-metolachlor+isoxaflutole+benoxacor; flumipropyn+metolachlor+mesotrione; flumipropyn+metolachlor+mesotrione+benoxacor; flumipropyn+S-metolachlor+mesotrione; flumipropyn+S-metolachlor+mesotrione+benoxacor; flumipropyn+metolachlor+atrazine; flumipropyn+metolachlor+atrazine+benoxacor; flumipropyn+S-metolachlor+atrazine; flumipropyn+S-metolachlor +atrazine+benoxacor; flumipropyn+metolachlor+terbuthylazine; flumipropyn+metolachlor+terbuthylazine+benoxacor, flumipropyn+S-metolachlor+terbuthylazine; flumipropyn+S-metolachlor+terbuthylazine+benoxacor; flumipropyn+atrazine+nicosulfuron; flumipropyn+atrazine+nicosulfuron+benoxacor; flupropacil+prosulfuron+primisulfuron; flupropacil+prosulfuron+dicamba; flupropacil+primisulfuron+dicamba; flupropacil+nicosulfuron+primisulfuron; flupropacil+nicosulfuron+prosulfuron; flupropacil+rimsulfuron+primisulfuron; flupropacil+rimsulfuron+prosulfuron; flupropacil +metolachlor+isoxaflutole; flupropacil+metolachlor+isoxaflutole+benoxacor; flupropacil +S-metolachlor+isoxaflutole; flupropacil+S-metolachlor+isoxaflutole+benoxacor; flupropacil+metolachlor+mesotrione; flupropacil+metolachlor+mesotrione+benoxacor; flupropacil+S-metolachlor+mesotrione; flupropacil+S-metolachlor+mesotrione+benoxacor; flupropacil+metolachlor+atrazine; flupropacil+metolachlor+atrazine+benoxacor; flupropacil+S-metolachlor+atrazine; flupropacil+S-metolachlor+atrazine+benoxacor; flupropacil+metolachlor+terbuthylazine; flupropacil+metolachlor+terbuthylazine+benoxacor; flupropacil+S-metolachlor+terbuthylazine; flupropacil+S-metolachlor+terbuthylazine+benoxacor; flupropacil+atrazine+nicosulfuron; flupropacil+atrazine+nicosulfuron+benoxacor; nipyraclofen+prosulfuron+primisulfuron; nipyraclofen+prosulfuron+dicamba; nipyraclofen+primisulfuron+dicamba; nipyraclofen +nicosulfuron+primisulfuron; nipyraclofen+nicosulfuron+prosulfuron; nipyraclofen+rimsulfuron+primisulfuron; nipyraclofen+rimsulfuron+prosulfuron; nipyraclofen+metolachlor+isoxaflutole; nipyraclofen+metolachlor+isoxaflutole+benoxacor; nipyraclofen+S-metolachlor+isoxaflutole; nipyraclofen+S-metolachlor+isoxaflutole+benoxacor; nipyraclofen+metolachlor+mesotrione; nipyraclofen+metolachlor+mesotrione+benoxacor; nipyraclofen+S-metolachlor+mesotrione; nipyraclofen+S-metolachlor+mesotrione+benoxacor; nipyraclofen+metolachlor+atrazine; nipyraclofen +metolachlor+atrazine+benoxacor; nipyraclofen+S-metolachlor+atrazine; nipyraclofen +S-metolachlor+atrazine+benoxacor; nipyraclofen+metolachlor+terbuthylazine; nipyraclofen+metolachlor+terbuthylazine+benoxacor; nipyraclofen+S-metolachlor+terbuthylazine; nipyraclofen+S-metolachlor+terbuthylazine+benoxacor; nipyraclofen+atrazine+nicosulfuron; nipyraclofen+atrazine+nicosulfuron+benoxacor; benzfendizone +prosulfuron+primisulfuron; benzfendizone+prosulfuron+dicamba; benzfendizone+primisulfuron+dicamba; benzfendizone+nicosulfuron+primisulfuron; benzfendizone+nicosulfuron+prosulfuron; benzfendizone+rimsulfuron+primisulfuron; benzfendizone+rimsulfuron+prosulfuron; benzfendizone+metolachlor+isoxaflutole; benzfendizone+metolachlor+isoxaflutole+benoxacor; benzfendizone+S-metolachlor+isoxaflutole; benzfendizone+S-metolachlor+isoxaflutole+benoxacor; benzfendizone+metolachlor+mesotrione; benzfendizone+metolachlor+mesotrione+benoxacor; benzfendizone+S-metolachlor+mesotrione; benzfendizone+S-metolachlor+mesotrione+benoxacor; benzfendizone+metolachlor+atrazine; benzfendizone+metolachlor+atrazine+benoxacor; benzfendizone+S-metolachlor+atrazine; benzfendizone+S-metolachlor+atrazine+benoxacor; benzfendizone+metolachlor+terbuthylazine; benzfendizone+metolachlor+terbuthylazine+benoxacor; benzfendizone+S-metolachlor+terbuthylazine; benzfendizone+S-metolachlor+terbuthylazine+benoxacor; benzfendizone+atrazine+nicosulfuron; benzfendizone+atrazine+nicosulfuron+benoxacor; thidiazimin+prosulfuron+primisulfuron; thidiazimin+prosulfuron+dicamba; thidiazimin+primisulfuron +dicamba; thidiazimin+nicosulfuron+primisulfuron; thidiazimin+nicosulfuron+prosulfuron; thidiazimin+rimsulfuron+primisulfuron; thidiazimin+rimsulfuron+prosulfuron; thidiazimin+metolachlor+isoxaflutole; thidiazimin+metolachlor+isoxaflutole +benoxacor; thidiazimin+S-metolachlor+isoxaflutole; thidiazimin+S-metolachlor+isoxaflutole+benoxacor; thidiazimin+metolachlor+mesotrione; thidiazimin+metolachlor +mesotrione+benoxacor; thidiazimin+S-metolachlor+mesotrione; thidiazimin+S-metolachlor+mesotrione+benoxacor; thidiazimin+metolachlor+atrazine; thidiazimin+metolachlor+atrazine+benoxacor; thidiazimin+S-metolachlor+atrazine; thidiazimin+S-metolachlor+atrazine+benoxacor; thidiazimin+metolachlor+terbuthylazine; thidiazimin+metolachlor+terbuthylazine+benoxacor; thidiazimin+S-metolachlor+terbuthylazine; thidiazimin+S-metolachlor+terbuthylazine+benoxacor; thidiazimin+atrazine+nicosulfuron; and thidiazimin+atrazine+nicosulfuron+benoxacor.

Acifluorfen+metolachlor+isoxaflutole+MON 4660; acifluorfen+S-metolachlor+isoxaflutole+MON 4660; acifluorfen+metolachlor+mesotrione+MON 4660; acifluorfen+S-metolachlor+mesotrione+MON 4660; acifluorfen+metolachlor+atrazine+MON 4660; acifluorfen+S-metolachlor+atrazine+MON 4660; acifluorfen+metolachlor+terbuthylazine+MON 4660; acifluorfen+S-metolachlor+terbuthylazine+MON 4660; acifluorfen+atrazine+nicosulfuron+MON 4660; aclonifen+metolachlor+isoxaflutole+MON 4660; aclonifen+S-metolachlor+isoxaflutole+MON 4660; aclonifen+metolachlor+mesotrione+MON 4660; aclonifen+S-metolachlor+mesotrione+MON 4660; aclonifen+metolachlor+atrazine+MON 4660; aclonifen+S-metolachlor+atrazine+MON 4660; aclonifen+metolachlor+terbuthylazine+MON 4660; aclonifen+S-metolachlor+terbuthylazine+MON 4660; aclonifen+atrazine+nicosulfuron+MON 4660; bifenox+metolachlor+isoxaflutole+MON 4660; bifenox+S-metolachlor+isoxaflutole+MON 4660; bifenox+metolachlor+mesotrione+MON 4660; bifenox+S-metolachlor+mesotrione+MON 4660; bifenox+metolachlor+atrazine+MON 4660; bifenox+S-metolachlor+atrazine+MON 4660; bifenox+metolachlor+terbuthylazine+MON 4660; bifenox+S-metolachlor+terbuthylazine+MON 4660; bifenox+atrazine+nicosulfuron+MON 4660; chlomitrofen+metolachlor+isoxaflutole+MON 4660; chlomitrofen+-S-metolachlor+isoxaflutole+MON 4660; chlomitrofen+metolachlor+mesotrione+MON 4660; chlomitrofen+S-metolachlor+mesotrione+MON 4660; chlomitrofen+metolachlor +atrazine+MON 4660; chlomitrofen+S-metolachlor+atrazine+MON 4660; chlomitrofen +metolachlor+terbuthylazine+MON 4660; chlomitrofen+S-metolachlor+terbuthylazine +MON 4660; chlomitrofen+atrazine+nicosulfuron+MON 4660; ethoxyfen+metolachlor +isoxaflutole+MON 4660; ethoxyfen+S-metolachlor+isoxaflutole+MON 4660; ethoxyfen+metolachlor+mesotrione+MON 4660; ethoxyfen+S-metolachlor+mesotrione+MON 4660; ethoxyfen+metolachlor+atrazine+MON 4660; ethoxyfen+S-metolachlor+atrazine+MON 4660; ethoxyfen+metolachlor+terbuthylazine+MON 4660; ethoxyfen+S-metolachlor+terbuthylazine+MON 4660; ethoxyfen+atrazine+nicosulfuron+MON 4660; fluoroglycofen+metolachlor+isoxaflutole+MON 4660; fluoroglycofen+S-metolachlor+isoxaflutole+MON 4660; fluoroglycofen+metolachlor+mesotrione+MON 4660; fluoroglycofen+S-metolachlor+mesotrione+MON 4660; fluoroglycofen+metolachlor+atrazine+MON 4660; fluoroglycofen+S-metolachlor+atrazine+MON 4660; fluoroglycofen+metolachlor+terbuthylazine+MON 4660; fluoroglycofen+S-metolachlor+terbuthylazine+MON 4660; fluoroglycofen+atrazine+nicosulfuron+MON 4660; fomesafen+metolachlor+isoxaflutole+MON 4660; fomesafen +S-metolachlor+isoxaflutole+MON 4660; fomesafen+metolachlor+mesotrione+MON 4660; fomesafen+S-metolachlor+mesotrione+MON 4660; fomesafen+metolachlor+atrazine+MON 4660; fomesafen+S-metolachlor+atrazine+MON 4660; fomesafen+metolachlor+terbuthylazine+MON 4660; fomesafen+S-metolachlor+terbuthylazine+MON 4660; fomesafen+atrazine+nicosulfuron+MON 4660; lactofen+metolachlor+isoxaflutole+MON 4660; lactofen+S-metolachlor+isoxaflutole+MON 4660; lactofen+metolachlor+mesotrione+MON 4660; lactofen+S-metolachlor+mesotrione+MON 4660; lactofen+metolachlor+atrazine+MON 4660; lactofen+S-metolachlor+atrazine+MON 4660; lactofen+metolachlor+terbuthylazine+MON 4660; lactofen+S-metolachlor +terbuthylazine+MON 4660; lactofen+atrazine+nicosulfuron+MON 4660; oxyfluorfen+metolachlor+isoxaflutole+MON 4660; oxyfluorfen+S-metolachlor+isoxaflutole+MON 4660; oxyfluorfen+metolachlor+mesotrione+MON 4660; oxyfluorfen+S-metolachlor+mesotrione+MON 4660; oxyfluorfen+metolachlor+atrazine+MON 4660; oxyfluorfen+S-metolachlor+atrazine+MON 4660; oxyfluorfen+metolachlor+terbuthylazine+MON 4660; oxyfluorfen+S-metolachlor+terbuthylazine+MON 4660; oxyfluorfen+atrazine+nicosulfuron+MON 4660; azafenidin+metolachlor+isoxaflutole+MON 4660; azafenidin +S-metolachlor+isoxaflutole+MON 4660; azafenidin+metolachlor+mesotrione+MON 4660; azafenidin+S-metolachlor+mesotrione+MON 4660; azafenidin+metolachlor+atrazine+MON 4660; azafenidin+S-metolachlor+atrazine+MON 4660; azafenidin+metolachlor+terbuthylazine+MON 4660; azafenidin+S-metolachlor+terbuthylazine+MON 4660; azafenidin+atrazine+nicosulfuron+MON 4660; carfentrazone-ethyl+metolachlor+isoxaflutole+MON 4660; carfentrazone-ethyl+S-metolachlor+isoxaflutole+MON 4660; carfentrazone-ethyl+metolachlor+mesotrione+MON 4660; carfentrazone-ethyl+S-metolachlor+mesotrione+MON 4660; carfentrazone-ethyl+metolachlor+atrazine+MON 4660; carfentrazone-ethyl+S-metolachlor+atrazine+MON 4660; carfentrazone-ethyl+metolachlor+terbuthylazine+MON 4660; carfentrazone-ethyl+S-metolachlor+terbuthylazine+MON 4660; carfentrazone-ethyl+atrazine+nicosulfuron+MON 4660; compound of the formula A+metolachlor+isoxaflutole+MON 4660; compound of the formula A+S-metolachlor+isoxaflutole+MON 4660; compound of the formula A+metolachlor+mesotrione+MON 4660; compound of the formula A+S-metolachlor+mesotrione+MON 4660; compound of the formula A+metolachlor+atrazine+MON 4660; compound of the formula A+S-metolachlor+atrazine+MON 4660; compound of the formula A+metolachlor+terbuthylazine+MON 4660; compound of the formula A+S-metolachlor+terbuthylazine+MON 4660; compound of the formula A+atrazine+nicosulfuron+MON 4660; cinidon-ethyl+metolachlor+isoxaflutole+MON 4660; cinidon-ethyl+S-metolachlor+isoxaflutole+MON 4660; cinidon-ethyl+metolachlor +mesotrione+MON 4660; cinidon-ethyl+S-metolachlor+mesotrione+MON 4660; cinidon-ethyl+metolachlor+atrazine+MON 4660; cinidon-ethyl+S-metolachlor+atrazine +MON 4660; cinidon-ethyl+metolachlor+terbuthylazine+MON 4660; cinidon-ethyl+S-metolachlor+terbuthylazine+MON 4660; cinidon-ethyl+atrazine+nicosulfuron+MON 4660; flumiclorac-pentyl+metolachlor+isoxaflutole+MON 4660; flumiclorac-pentyl+S-metolachlor+isoxaflutole+MON 4660; flumiclorac-pentyl+metolachlor+mesotrione+MON 4660; flumiclorac-pentyl+S-metolachlor+mesotrione+MON 4660; flumiclorac-pentyl+metolachlor+atrazine+MON 4660; flumiclorac-pentyl+S-metolachlor+atrazine +MON 4660; flumiclorac-pentyl+metolachlor+terbuthylazine+MON 4660; flumiclorac-pentyl+S-metolachlor+terbuthylazine+MON 4660; flumiclorac-pentyl+atrazine+nicosulfuron+MON 4660; flumioxazin+metolachlor+isoxaflutole+MON 4660; flumioxazin+S-metolachlor+isoxaflutole+MON 4660; flumioxazin+metolachlor+mesotrione+MON 4660; flumioxazin+S-metolachlor+mesotrione+MON 4660; flumioxazin+metolachlor+atrazine+MON 4660; flumioxazin+S-metolachlor+atrazine+MON 4660; flumioxazin+metolachlor+terbuthylazine+MON 4660; flumioxazin+S-metolachlor+terbuthylazine+MON 4660; flumioxazin+atrazine+nicosulfuron+MON 4660; fluthiacet-methyl+metolachlor+isoxaflutole+MON 4660; fluthiacet-methyl+S-metolachlor+isoxaflutole+MON 4660; fluthiacet-methyl+metolachlor+mesotrione+MON 4660; fluthiacet-methyl+S-metolachlor+mesotrione+MON 4660; fluthiacet-methyl+metolachlor+atrazine+MON 4660; fluthiacet-methyl+S-metolachlor+atrazine+MON 4660; fluthiacet-methyl+metolachlor+terbuthylazine+MON 4660; fluthiacet-methyl+S-metolachlor+terbuthylazine+MON 4660; fluthiacet-methyl+atrazine+nicosulfuron+MON 4660; oxadiargyl+metolachlor+isoxaflutole+MON 4660; oxadiargyl+S-metolachlor +isoxaflutole+MON 4660; oxadiargyl+metolachlor+mesotrione+MON 4660; oxadiargyl +S-metolachlor+mesotrione+MON 4660; oxadiargyl+metolachlor+atrazine+MON 4660; oxadiargyl+S-metolachlor+atrazine+MON 4660; oxadiargyl+metolachlor+terbuthylazine+MON 4660; oxadiargyl+S-metolachlor+terbuthylazine+MON 4660; oxadiargyl+atrazine+nicosulfuron+MON 4660; oxadiazon+metolachlor+isoxaflutole+MON 4660; oxadiazon+S-metolachlor+isoxaflutole+MON 4660; oxadiazon+metolachlor+mesotrione+MON 4660; oxadiazon+S-metolachlor+mesotrione+MON 4660; oxadiazon+metolachlor+atrazine+MON 4660; oxadiazon+S-metolachlor+atrazine+MON 4660; oxadiazon+metolachlor+terbuthylazine+MON 4660; oxadiazon+S-metolachlor+terbuthylazine+MON 4660; oxadiazon+atrazine+nicosulfuron+MON 4660; pentoxazone+metolachlor+isoxaflutole+MON 4660; pentoxazone+S-metolachlor +isoxaflutole+MON 4660; pentoxazone+metolachlor+mesotrione+MON 4660; pentoxazone+S-metolachlor+mesotrione+MON 4660; pentoxazone+metolachlor+atrazine+MON 4660; pentoxazone+S-metolachlor+atrazine+MON 4660; pentoxazone +metolachlor+terbuthylazine+MON 4660; pentoxazone+S-metolachlor+terbuthylazine +MON 4660; pentoxazone+atrazine+nicosulfuron+MON 4660; sulfentrazone+metolachlor+isoxaflutole+MON 4660; sulfentrazone+S-metolachlor+isoxaflutole+MON 4660; sulfentrazone+metolachlor+mesotrione+MON 4660; sulfentrazone+S-metolachlor+mesotrione+MON 4660; sulfentrazone+metolachlor+atrazine+MON 4660; sulfentrazone+S-metolachlor+atrazine+MON 4660; sulfentrazone+metolachlor+terbuthylazine+MON 4660; sulfentrazone+S-metolachlor+terbuthylazine+MON 4660; sulfentrazone+atrazine+nicosulfuron+MON 4660; fluazolate+metolachlor+isoxaflutole +MON 4660; fluazolate+S-metolachlor+isoxaflutole+MON 4660; fluazolate+metolachlor+mesotrione+MON 4660; fluazolate+S-metolachlor+mesotrione+MON 4660; fluazolate+metolachlor+atrazine+MON 4660; fluazolate+S-metolachlor+atrazine+MON 4660; fluazolate+metolachlor+terbuthylazine+MON 4660; fluazolate+S-metolachlor+terbuthylazine+MON 4660; fluazolate+atrazine+nicosulfuron+MON 4660; pyraflufen-ethyl+metolachlor+isoxaflutole+MON 4660; pyraflufen-ethyl+S-metolachlor+isoxaflutole+MON 4660; pyraflufen-ethyl+metolachlor+mesotrione+MON 4660; pyraflufen-ethyl+S-metolachlor+mesotrione+MON 4660; pyraflufen-ethyl+metolachlor+atrazine+MON 4660; pyraflufen-ethyl+S-metolachlor+atrazine+MON 4660; pyraflufen-ethyl+metolachlor+terbuthylazine+MON 4660; pyraflufen-ethyl+S-metolachlor+terbuthylazine+MON 4660; pyraflufen-ethyl+atrazine+nicosulfuron+MON 4660; flumipropyn+metolachlor+isoxaflutole+MON 4660; flumipropyn+S-metolachlor+isoxaflutole+MON 4660; flumipropyn+metolachlor+mesotrione+MON 4660; flumipropyn+S-metolachlor+mesotrione+MON 4660; flumipropyn+metolachlor+atrazine+MON 4660; flumipropyn+S-metolachlor+atrazine+MON 4660; flumipropyn+metolachlor+terbuthylazine+MON 4660; flumipropyn+S-metolachlor+terbuthylazine+MON 4660; flumipropyn+atrazine+nicosulfuron+MON 4660; flupropacil+metolachlor+isoxaflutole+MON 4660; flupropacil+S-metolachlor+isoxaflutole+MON 4660; flupropacil +metolachlor+mesotrione+MON 4660; flupropacil+S-metolachlor+mesotrione+MON 4660; flupropacil+metolachlor+atrazine+MON 4660; flupropacil+S-metolachlor+atrazine+MON 4660; flupropacil+metolachlor+terbuthylazine+MON 4660; flupropacil+S-metolachlor+terbuthylazine+MON 4660; flupropacil+atrazine+nicosulfuron+MON 4660; nipyraclofen+metolachlor+isoxaflutole+MON 4660; nipyraclofen+S-metolachlor+isoxaflutole+MON 4660; nipyraclofen+metolachlor+mesotrione+MON 4660; nipyraclofen+S-metolachlor+mesotrione+MON 4660; nipyraclofen+metolachlor+atrazine+MON 4660; nipyraclofen+S-metolachlor+atrazine+MON 4660; nipyraclofen+metolachlor+terbuthylazine+MON 4660; nipyraclofen+S-metolachlor+terbuthylazine+MON 4660; nipyraclofen+atrazine+nicosulfuron+MON 4660; benzfendizone+metolachlor+isoxaflutole+MON 4660; benzfendizone+S-metolachlor+isoxaflutole+MON 4660; benzfendizone+metolachlor+mesotrione+MON 4660; benzfendizone+S-metolachlor+mesotrione+MON 4660; benzfendizone+metolachlor+atrazine+MON 4660; benzfendizone+S-metolachlor+atrazine+MON 4660; benzfendizone+metolachlor +terbuthylazine+MON 4660; benzfendizone+S-metolachlor+terbuthylazine+MON 4660; benzfendizone+atrazine+nicosulfuron+MON 4660; thidiazimin+metolachlor+isoxaflutole+MON 4660; thidiazimin+S-metolachlor+isoxaflutole+MON 4660; thidiazimin+metolachlor+mesotrione+MON 4660; thidiazimin+S-metolachlor+mesotrione+MON 4660; thidiazimin+metolachlor+atrazine+MON 4660; thidiazimin+S-metolachlor+atrazine+MON 4660; thidiazimin+metolachlor+terbuthylazine+MON 4660; thidiazimin+S-metolachlor+terbuthylazine+MON 4660; and thidiazimin+atrazine +nicosulfuron+MON 4660.

Acifluorfen+metolachlor+isoxaflutole+FLURAZOLE; acifluorfen+S-metolachlor+isoxaflutole+FLURAZOLE; acifluorfen+metolachlor+mesotrione+FLURAZOLE; acifluorfen+S-metolachlor+mesotrione+FLURAZOLE; acifluorfen+metolachlor+atrazine+FLURAZOLE; acifluorfen+S-metolachlor+atrazine+FLURAZOLE; acifluorfen +metolachlor+terbuthylazine+FLURAZOLE; acifluorfen+S-metolachlor+terbuthylazine +FLURAZOLE; acifluorfen+atrazine+nicosulfuron+FLURAZOLE; aclonifen+metolachlor+isoxaflutole+FLURAZOLE; aclonifen+S-metolachlor+isoxaflutole+FLURAZOLE; aclonifen+metolachlor+mesotrione+FLURAZOLE; aclonifen+S-metolachlor+mesotrione+FLURAZOLE; aclonifen+metolachlor+atrazine+FLURAZOLE; aclonifen+S-metolachlor+atrazine+FLURAZOLE; aclonifen+metolachlor +terbuthylazine+FLURAZOLE; aclonifen+S-metolachlor+terbuthylazine+FLURAZOLE; aclonifen+atrazine+nicosulfuron+FLURAZOLE; bifenox+metolachlor+isoxaflutole+FLURAZOLE; bifenox+S-metolachlor+isoxaflutole+FLURAZOLE; bifenox+metolachlor +mesotrione+FLURAZOLE; bifenox+S-metolachlor+mesotrione+FLURAZOLE; bifenox+metolachlor+atrazine+FLURAZOLE; bifenox+S-metolachlor+atrazine+FLURAZOLE; bifenox+metolachlor+terbuthylazine+FLURAZOLE; bifenox+S-metolachlor+terbuthylazine+FLURAZOLE; bifenox+atrazine+nicosulfuron+FLURAZOLE; chlomitrofen+metolachlor+isoxaflutole+FLURAZOLE; chlomitrofen+S-metolachlor+isoxaflutole+FLURAZOLE; chlomitrofen+metolachlor+mesotrione+FLURAZOLE; chlomitrofen+S-metolachlor+mesotrione+FLURAZOLE; chlomitrofen+metolachlor+atrazine+FLURAZOLE; chlomitrofen+S-metolachlor+atrazine+FLURAZOLE; chlomitrofen+metolachlor+terbuthylazine+FLURAZOLE; chlomitrofen+S-metolachlor+terbuthylazine+FLURAZOLE; chlomitrofen+atrazine+nicosulfuron+FLURAZOLE; ethoxyfen+metolachlor+isoxaflutole+FLURAZOLE; ethoxyfen+S-metolachlor+isoxaflutole+FLURAZOLE; ethoxyfen+metolachlor+mesotrione+FLURAZOLE; ethoxyfen+S-metolachlor+mesotrione+FLURAZOLE; ethoxyfen+metolachlor+atrazine+FLURAZOLE; ethoxyfen+S-metolachlor+atrazine+FLURAZOLE; ethoxyfen+metolachlor+terbuthylazine+FLURAZOLE; ethoxyfen+S-metolachlor+terbuthylazine+FLURAZOLE; ethoxyfen+atrazine+nicosulfuron+FLURAZOLE; fluoroglycofen+metolachlor+isoxaflutole+FLURAZOLE; fluoroglycofen+S-metolachlor+isoxaflutole+FLURAZOLE; fluoroglycofen+metolachlor+mesotrione+FLURAZOLE; fluoroglycofen+S-metolachlor+mesotrione+FLURAZOLE; fluoroglycofen +metolachlor+atrazine+FLURAZOLE; fluoroglycofen+S-metolachlor+atrazine+FLURAZOLE; fluoroglycofen+metolachlor+terbuthylazine+FLURAZOLE; fluoroglycofen +S-metolachlor+terbuthylazine+FLURAZOLE; fluoroglycofen+atrazine+nicosulfuron+FLURAZOLE; fomesafen+metolachlor+isoxaflutole+FLURAZOLE; fomesafen+S-metolachlor+isoxaflutole+FLURAZOLE; fomesafen+metolachlor+mesotrione+FLURAZOLE; fomesafen+S-metolachlor+mesotrione+FLURAZOLE; fomesafen+metolachlor+atrazine+FLURAZOLE; fomesafen+S-metolachlor+atrazine+FLURAZOLE; fomesafen+metolachlor+terbuthylazine+FLURAZOLE; fomesafen+S-metolachlor+terbuthylazine+FLURAZOLE; fomesafen+atrazine+nicosulfuron+FLURAZOLE; lactofen+metolachlor+isoxaflutole+FLURAZOLE; lactofen+S-metolachlor+isoxaflutole+FLURAZOLE; lactofen+metolachlor+mesotrione+FLURAZOLE; lactofen+S-metolachlor+mesotrione+FLURAZOLE; lactofen+metolachlor +atrazine+FLURAZOLE; lactofen+S-metolachlor+atrazine+FLURAZOLE; lactofen+metolachlor+terbuthylazine+FLURAZOLE; lactofen+S-metolachlor+terbuthylazine+FLURAZOLE; lactofen+atrazine+nicosulfuron+FLURAZOLE; oxyfluorfen+metolachlor +isoxaflutole+FLURAZOLE; oxyfluorfen+S-metolachlor+isoxaflutole+FLURAZOLE; oxyfluorfen+metolachlor+mesotrione+FLURAZOLE; oxyfluorfen+S-metolachlor+mesotrione+FLURAZOLE; oxyfluorfen+metolachlor+atrazine+FLURAZOLE; oxyfluorfen+S-metolachlor+atrazine+FLURAZOLE; oxyfluorfen+metolachlor+terbuthylazine+FLURAZOLE; oxyfluorfen+S-metolachlor+terbuthylazine+FLURAZOLE; oxyfluorfen+atrazine+nicosulfuron+FLURAZOLE; azafenidin+metolachlor+isoxaflutole+FLURAZOLE; azafenidin+S-metolachlor+isoxaflutole+FLURAZOLE; azafenidin+metolachlor+mesotrione+FLURAZOLE; azafenidin+S-metolacotrione+FLURAZOLE; azafenidin+metolachlor+atrazine+FLURAZOLE; azafenidin+S-metolachlor+atrazine+FLURAZOLE; azafenidin+metolachlor+terbuthylazine+FLURAZOLE; azafenidin+S-metolachlor+terbuthylazine+FLURAZOLE; azafenidin+atrazine+nicosulfuron+FLURAZOLE; carfentrazone-ethyl+metolachlor+isoxaflutole+FLURAZOLE; carfentrazone-ethyl+S-metolachlor+isoxaflutole+FLURAZOLE; carfentrazone-ethyl+metolachlor+mesotrione+FLURAZOLE; carfentrazone-ethyl+S-metolachlor+mesotrione+FLURAZOLE; carfentrazone-ethyl+metolachlor+atrazine+FLURAZOLE; carfentrazone-ethyl+S-metolachlor+atrazine+FLURAZOLE; carfentrazone-ethyl+metolachlor+terbuthylazine+FLURAZOLE; carfentrazone-ethyl+S-metolachlor+terbuthylazine+FLURAZOLE; carfentrazone-ethyl+atrazine+nicosulfuron +FLURAZOLE; compounds of the formula A+metolachlor+isoxaflutole+FLURAZOLE; compounds of the formula A+S-metolachlor+isoxaflutole+FLURAZOLE; compounds of the formula A+metolachlor+mesotrione+FLURAZOLE; compounds of the formula A+S-metolachlor+mesotrione+FLURAZOLE; compounds of the formula A+metolachlor+atrazine+FLURAZOLE; compounds of the formula A+S-metolachlor+atrazine+FLURAZOLE; compounds of the formula A+metolachlor+terbuthylazine+FLURAZOLE; compounds of the formula A+S-metolachlor+terbuthylazine+FLURAZOLE; compounds of the formula A+atrazine+nicosulfuron+FLURAZOLE; cinidon-ethyl+metolachlor+isoxaflutole+FLURAZOLE; cinidon-ethyl+S-metolachlor+isoxaflutole+FLURAZOLE; cinidon-ethyl+metolachlor+mesotrione+FLURAZOLE; cinidon-ethyl+S-metolachlor+mesotrione+FLURAZOLE; cinidon-ethyl+metolachlor+atrazine+FLURAZOLE; cinidon-ethyl+S-metolachlor+atrazine+FLURAZOLE; cinidon-ethyl+metolachlor+terbuthylazine+FLURAZOLE; cinidon-ethyl+S-metolachlor+terbuthylazine+FLURAZOLE; cinidon-ethyl+atrazine+nicosulfuron+FLURAZOLE; flumiclorac-pentyl+metolachlor+isoxaflutole+FLURAZOLE; flumiclorac-pentyl+S-metolachlor+isoxaflutole +FLURAZOLE; flumiclorac-pentyl+metolachlor+mesotrione+FLURAZOLE; flumiclorac-pentyl+S-metolachlor+mesotrione+FLURAZOLE; flumiclorac-pentyl+metolachlor+atrazine+FLURAZOLE; flumiclorac-pentyl+S-metolachlor+atrazine+FLURAZOLE; flumiclorac-pentyl+metolachlor+terbuthylazine+FLURAZOLE; flumiclorac-pentyl+S-metolachlor+terbuthylazine+FLURAZOLE; flumiclorac-pentyl+atrazine+nicosulfuron+FLURAZOLE; flumioxazin+metolachlor+isoxaflutole+FLURAZOLE; flumioxazin+S-metolachlor+isoxaflutole+FLURAZOLE; flumioxazin+metolachlor+mesotrione+FLURAZOLE; flumioxazin+S-metolachlor+mesotrione+FLURAZOLE; flumioxazin+metolachlor+atrazine+FLURAZOLE; flumioxazin+S-metolachlor+atrazine+FLURAZOLE; flumioxazin+metolachlor+terbuthylazine+FLURAZOLE; flumioxazin+S-metolachlor+terbuthylazine+FLURAZOLE; flumioxazin+atrazine+nicosulfuron+FLURAZOLE; fluthiacet-methyl+metolachlor+isoxaflutole+FLURAZOLE; fluthiacet-methyl+S-metolachlor+isoxaflutole+FLURAZOLE; fluthiacet-methyl+metolachlor+mesotrione+FLURAZOLE; fluthiacet-methyl+S-metolachlor+mesotrione+FLURAZOLE; fluthiacet-methyl+metolachlor+atrazine+FLURAZOLE; fluthiacet-methyl+S-metolachlor +atrazine+FLURAZOLE; fluthiacet-methyl+metolachlor+terbuthylazine+FLURAZOLE; fluthiacet-methyl+S-metolachlor+terbuthylazine+FLURAZOLE; fluthiacet-methyl+atrazine+nicosulfuron+FLURAZOLE; oxadiargyl+metolachlor+isoxaflutole+FLURAZOLE; oxadiargyl+S-metolachlor+isoxaflutole+FLURAZOLE; oxadiargyl+metolachlor+mesotrione+FLURAZOLE; oxadiargyl+S-metolachlor+mesotrione+FLURAZOLE; oxadiargyl+metolachlor+atrazine+FLURAZOLE; oxadiargyl+S-metolachlor+atrazine+FLURAZOLE; oxadiargyl+metolachlor+terbuthylazine+FLURAZOLE; oxadiargyl+S-metolachlor+terbuthylazine+FLURAZOLE; oxadiargyl+atrazine+nicosulfuron+FLURAZOLE; oxadiazon+metolachlor+isoxaflutole+FLURAZOLE; oxadiazon+S-metolachlor+isoxaflutole+FLURAZOLE; oxadiazon+metolachlor+mesotrione+FLURAZOLE; oxadiazon+S-metolachlor+mesotrione+FLURAZOLE; oxadiazon+metolachlor+atrazine+FLURAZOLE; oxadiazon+S-metolachlor+atrazine+FLURAZOLE; oxadiazon+metolachlor+terbuthylazine+FLURAZOLE; oxadiazon+S-metolachlor+terbuthylazine+FLURAZOLE; oxadiazon+atrazine+nicosulfuron+FLURAZOLE; pentoxazone+metolachlor+isoxaflutole+FLURAZOLE; pentoxazone+S-metolachlor+isoxaflutole+FLURAZOLE; pentoxazone+metolachlor+mesotrione+FLURAZOLE; pentoxazone+S-metolachlor+mesotrione+FLURAZOLE; pentoxazone+metolachlor+atrazine+FLURAZOLE; pentoxazone+S-metolachlor+atrazine+FLURAZOLE; pentoxazone+metolachlor+terbuthylazine+FLURAZOLE; pentoxazone+S-metolachlor+terbuthylazine+FLURAZOLE; pentoxazone +atrazine+nicosulfuron+FLURAZOLE; sulfentrazone+metolachlor+isoxaflutole+FLURAZOLE; sulfentrazone+S-metolachlor+isoxaflutole+FLURAZOLE; sulfentrazone+metolachlor+mesotrione+FLURAZOLE; sulfentrazone+S-metolachlor+mesotrione+FLURAZOLE; sulfentrazone+metolachlor+atrazine+FLURAZOLE; sulfentrazone+S-metolachlor+atrazine+FLURAZOLE; sulfentrazone+metolachlor+terbuthylazine+FLURAZOLE; sulfentrazone+S-metolachlor+terbuthylazine+FLURAZOLE; sulfentrazone +atrazine+nicosulfuron+FLURAZOLE; fluazolate+metolachlor+isoxaflutole+FLURAZOLE; fluazolate+S-metolachlor+isoxaflutole+FLURAZOLE; fluazolate+metolachlor+mesotrione+FLURAZOLE; fluazolate+S-metolachlor+mesotrione+FLURAZOLE; fluazolate+metolachlor+atrazine+FLURAZOLE; fluazolate+S-metolachlor+atrazine+FLURAZOLE; fluazolate+metolachlor+terbuthylazine+FLURAZOLE; fluazolate+S-metolachlor+terbuthylazine+FLURAZOLE; fluazolate+atrazine+nicosulfuron+FLURAZOLE; pyraflufen-ethyl+metolachlor+isoxaflutole+FLURAZOLE; pyraflufen-ethyl+S-metolachlor+isoxaflutole+FLURAZOLE; pyraflufen-ethyl+metolachlor+mesotrione+FLURAZOLE; pyraflufen-ethyl+S-metolachlor+mesotrione+FLURAZOLE; pyraflufen-ethyl+metolachlor+atrazine+FLURAZOLE; pyraflufen-ethyl+S-metolachlor+atrazine+FLURAZOLE; pyraflufen-ethyl+metolachlor+terbuthylazine+FLURAZOLE; pyraflufen-ethyl+S-metolachlor+terbuthylazine+FLURAZOLE; pyraflufen-ethyl+atrazine+nicosulfuron+FLURAZOLE; flumipropyn+metolachlor+isoxaflutole+FLURAZOLE; flumipropyn+S-metolachlor+isoxaflutole+FLURAZOLE; flumipropyn+metolachlor+mesotrione+FLURAZOLE; flumipropyn+S-metolachlor+mesotrione+FLURAZOLE; flumipropyn+metolachlor+atrazine+FLURAZOLE; flumipropyn+S-metolachlor+atrazine+FLURAZOLE; flumipropyn+metolachlor+terbuthylazine+FLURAZOLE; flumipropyn+S-metolachlor+terbuthylazine +FLURAZOLE; flumipropyn+atrazine+nicosulfuron+FLURAZOLE; flupropacil+metolachlor+isoxaflutole+FLURAZOLE; flupropacil+S-metolachlor+isoxaflutole+FLURAZOLE; flupropacil+metolachlor+mesotrione+FLURAZOLE; flupropacil+S-metolachlor+mesotrione+FLURAZOLE; flupropacil+metolachlor+atrazine+FLURAZOLE; flupropacil+S-metolachlor+atrazine+FLURAZOLE; flupropacil+metolachlor+terbuthylazine+FLURAZOLE; flupropacil+S-metolachlor+terbuthylazine+FLURAZOLE; flupropacil+atrazine+nicosulfuron+FLURAZOLE; nipyraclofen+metolachlor+isoxaflutole+FLURAZOLE; nipyraclofen+S-metolachlor+isoxaflutole+FLURAZOLE; nipyraclofen+metolachlor+mesotrione+FLURAZOLE; nipyraclofen+S-metolachlor+mesotrione+FLURAZOLE; nipyraclofen+metolachlor+atrazine+FLURAZOLE; nipyraclofen+S-metolachlor+atrazine+FLURAZOLE; nipyraclofen+metolachlor+terbuthylazine+FLURAZOLE; nipyraclofen+S-metolachlor+terbuthylazine +FLURAZOLE; nipyraclofen+atrazine+nicosulfuron+FLURAZOLE; benzfendizone+metolachlor+isoxaflutole+FLURAZOLE; benzfendizone+S-metolachlor+isoxaflutole+FLURAZOLE; benzfendizone+metolachlor+mesotrione+FLURAZOLE; benzfendizone+S-metolachlor+mesotrione+FLURAZOLE; benzfendizone+metolachlor+atrazine+FLURAZOLE; benzfendizone+S-metolachlor+atrazine+FLURAZOLE; benzfendizone+metolachlor+terbuthylazine+FLURAZOLE; benzfendizone+S-metolachlor+terbuthylazine+FLURAZOLE; benzfendizone+atrazine+nicosulfuron+FLURAZOLE; thidiazimin+metolachlor+isoxaflutole+FLURAZOLE; thidiazimin+S-metolachlor+isoxaflutole+FLURAZOLE; thidiazimin+metolachlor+mesotrione+FLURAZOLE; thidiazimin+S-metolachlor+mesotrione+FLURAZOLE; thidiazimin+metolachlor+atrazine+FLURAZOLE; thidiazimin+S-metolachlor+atrazine+FLURAZOLE; thidiazimin +metolachlor+terbuthylazine+FLURAZOLE; thidiazimin+S-metolachlor+terbuthylazine +FLURAZOLE; and thidiazimin+atrazine+nicosulfuron+FLURAZOLE.

Acifluorfen+metolachlor+isoxaflutole+DICHLORMID; acifluorfen+S-metolachlor+isoxaflutole+DICHLORMID; acifluorfen+metolachlor+mesotrione+DICHLORMID; acifluorfen+S-metolachlor+mesotrione+DICHLORMID; acifluorfen+metolachlor+atrazine+DICHLORMID; acifluorfen+S-metolachlor+atrazine+DICHLORMID; acifluorfen +metolachlor+terbuthylazine+DICHLORMID; acifluorfen+S-metolachlor+terbuthylazine +DICHLORMID; acifluorfen+atrazine+nicosulfuron+DICHLORMID; aclonifen+metolachlor+isoxaflutole+DICHLORMID; aclonifen+S-metolachlor+isoxaflutole+DICHLORMID; aclonifen+metolachlor+mesotrione+DICHLORMID; aclonifen+S-metolachlor+mesotrione+DICHLORMID; aclonifen+metolachlor+atrazine+DICHLORMID; aclonifen+S-metolachlor+atrazine+DICHLORMID; aclonifen+metolachlor+terbuthylazine+DICHLORMID; aclonifen+S-metolachlor+terbuthylazine+DICHLORMID; aclonifen+atrazine+nicosulfuron+DICHLORMID; bifenox+metolachlor+isoxaflutole+DICHLORMID; bifenox+S-metolachlor+isoxaflutole+DICHLORMID; bifenox+metolachlor+mesotrione+DICHLORMID; bifenox+S-metolachlor+mesotrione +DICHLORMID; bifenox+metolachlor+atrazine+DICHLORMID; bifenox+S-metolachlor +atrazine+DICHLORMID; bifenox+metolachlor+terbuthylazine+DICHLORMID; bifenox +S-metolachlor+terbuthylazine+DICHLORMID; bifenox+atrazine+nicosulfuron+DICHLORMID; chlomitrofen+metolachlor+isoxaflutole+DICHLORMID; chlomitrofen+S-metolachlor+isoxaflutole+DICHLORMID; chlomitrofen+metolachlor+mesotrione+DICHLORMID; chlomitrofen+S-metolachlor+mesotrione+DICHLORMID; chlomitrofen+metolachlor+atrazine+DICHLORMID; chlomitrofen+S-metolachlor+atrazine+DICHLORMID; chlomitrofen+metolachlor+terbuthylazine+DICHLORMID; chlomitrofen+S-metolachlor+terbuthylazine+DICHLORMID; chlomitrofen+atrazine+nicosulfuron+DICHLORMID; ethoxyfen+metolachlor+isoxaflutole+DICHLORMID; ethoxyfen+S-metolachlor+isoxaflutole+DICHLORMID; ethoxyfen+metolachlor+mesotrione+DICHLORMID; ethoxyfen+S-metolachlor+mesotrione+DICHLORMID; ethoxyfen+metolachlor+atrazine+DICHLORMID; ethoxyfen+S-metolachlor+atrazine+DICHLORMID; ethoxyfen+metolachlor+terbuthylazine+DICHLORMID; ethoxyfen+S-metolachlor+terbuthylazine+DICHLORMID; ethoxyfen+atrazine+nicosulfuron+DICHLORMID; fluoroglycofen+metolachlor+isoxaflutole+DICHLORMID; fluoroglycofen +S-metolachlor+isoxaflutole+DICHLORMID; fluoroglycofen+metolachlor+mesotrione+DICHLORMID; fluoroglycofen+S-metolachlor+mesotrione+DICHLORMID; fluoroglycofen +metolachlor+atrazine+DICHLORMID; fluoroglycofen+S-metolachlor+atrazine+DICHLORMID; fluoroglycofen+metolachlor+terbuthylazine+DICHLORMID; fluoroglycofen+S-metolachlor+terbuthylazine+DICHLORMID; fluoroglycofen+atrazine+nicosulfuron+DICHLORMID; fomesafen+metolachlor+isoxaflutole+DICHLORMID; fomesafen+S-metolachlor+isoxaflutole+DICHLORMID; fomesafen+metolachlor+mesotrione+DICHLORMID; fomesafen+S-metolachlor+mesotrione+DICHLORMID; fomesafen+metolachlor+atrazine+DICHLORMID; fomesafen+S-metolachlor+atrazine +DICHLORMID; fomesafen+metolachlor+terbuthylazine+DICHLORMID; fomesafen+S-metolachlor+terbuthylazine+DICHLORMID; fomesafen+atrazine+nicosulfuron+DICHLORMID; lactofen+metolachlor+isoxaflutole+DICHLORMID; lactofen+S-metolachlor+isoxaflutole+DICHLORMID; lactofen+metolachlor+mesotrione+DICHLORMID; lactofen+S-metolachlor+mesotrione+DICHLORMID; lactofen+metolachlor+atrazine+DICHLORMID; lactofen+S-metolachlor+atrazine+DICHLORMID; lactofen+metolachlor+terbuthylazine+DICHLORMID; lactofen+S-metolachlor+terbuthylazine+DICHLORMID; lactofen+atrazine+nicosulfuron+DICHLORMID; oxyfluorfen+metolachlor+isoxaflutole+DICHLORMID; oxyfluorfen+S-metolachlor+isoxaflutole+DICHLORMID; oxyfluorfen+metolachlor+mesotrione+DICHLORMID; oxyfluorfen+S-metolachlor+mesotrione+DICHLORMID; oxyfluorfen+metolachlor+atrazine+DICHLORMID; oxyfluorfen+S-metolachlor+atrazine+DICHLORMID; oxyfluorfen+metolachlor+terbuthylazine+DICHLORMID; oxyfluorfen en+S-metolachlor+terbuthylazine+DICHLORMID; oxyfluorfen+atrazine+nicosulfuron+DICHLORMID; azafenidin+metolachlor+isoxaflutole+DICHLORMID; azafenidin+S-metolachlor+isoxaflutole+DICHLORMID; azafenidin+metolachlor+mesotrione+DICHLORMID; azafenidin+S-metolachlor+mesotrione+DICHLORMID; azafenidin+metolachlor+atrazine+DICHLORMID; azafenidin+S-metolachlor+atrazine+DICHLORMID; azafenidin+metolachlor+terbuthylazine+DICHLORMID; azafenidin+S-metolachlor+terbuthylazine+DICHLORMID; azafenidin+atrazine+nicosulfuron+DICHLORMID; carfentrazone-ethyl+metolachlor+isoxaflutole+DICHLORMID; carfentrazone-ethyl+S-metolachlor+isoxaflutole+DICHLORMID; carfentrazone-ethyl+metolachlor+mesotrione+DICHLORMID; carfentrazone-ethyl+S-metolachlor+mesotrione+DICHLORMID; carfentrazone-ethyl+metolachlor+atrazine+DICHLORMID; carfentrazone-ethyl+S-metolachlor+atrazine+DICHLORMID; carfentrazone-ethyl+metolachlor+terbuthylazine+DICHLORMID; carfentrazone-ethyl+S-metolachlor+terbuthylazine+DICHLORMID; carfentrazone-ethyl+atrazine+nicosulfuron+DICHLORMID; compound of the formula A+metolachlor+isoxaflutole+DICHLORMID; compound of the formula A+S-metolachlor+isoxaflutole+DICHLORMID; compound of the formula A+metolachlor+mesotrione+DICHLORMID; compound of the formula A+S-metolachlor+mesotrione+DICHLORMID; compound of the formula A+metolachlor+atrazine+DICHLORMID; compound of the formula A+S-metolachlor+atrazine+DICHLORMID; compound of the formula A+metolachlor+terbuthylazine+DICHLORMID; compound of the formula A+S-metolachlor+terbuthylazine+DICHLORMID; compound of the formula A+atrazine+nicosulfuron+DICHLORMID; cinidon-ethyl+metolachlor+isoxaflutole+DICHLORMID; cinidon-ethyl+S-metolachlor+isoxaflutole+DICHLORMID; cinidon-ethyl+metolachlor+mesotrione+DICHLORMID; cinidon-ethyl+S-metolachlor+mesotrione+DICHLORMID; cinidon-ethyl+metolachlor+atrazine+DICHLORMID; cinidon-ethyl+S-metolachlor+atrazine+DICHLORMID; cinidon-ethyl+metolachlor+terbuthylazine+DICHLORMID; cinidon-ethyl+S-metolachlor+terbuthylazine+DICHLORMID; cinidon-ethyl+atrazine+nicosulfuron+DICHLORMID; flumiclorac-pentyl+metolachlor+isoxaflutole+DICHLORMID; flumiclorac-pentyl+S-metolachlor+isoxaflutole +DICHLORMID; flumiclorac-pentyl+metolachlor+mesotrione+DICHLORMID; flumiclorac-pentyl+S-metolachlor+mesotrione+DICHLORMID; flumiclorac-pentyl+metolachlor+atrazine+DICHLORMID; flumiclorac-pentyl+S-metolachlor+atrazine+DICHLORMID; flumiclorac-pentyl+metolachlor+terbuthylazine+DICHLORMID; flumiclorac-pentyl+S-metolachlor+terbuthylazine+DICHLORMID; flumiclorac-pentyl+atrazine+nicosulfuron+DICHLORMID; flumioxazin+metolachlor+isoxaflutole+DICHLORMID; flumioxazin+S-metolachlor+isoxaflutole+DICHLORMID; flumioxazin+metolachlor+mesotrione+DICHLORMID; flumioxazin+S-metolachlor+mesotrione+DICHLORMID; flumioxazin+metolachlor+atrazine+DICHLORMID; flumioxazin+S-metolachlor+atrazine+DICHLORMID; flumioxazin+metolachlor+terbuthylazine+DICHLORMID; flumioxazin+S-metolachlor+terbuthylazine+DICHLORMID; flumioxazin+atrazine+nicosulfuron+DICHLORMID; fluthiacet-methyl+metolachlor+isoxaflutole+DICHLORMID; fluthiacet-methyl+S-metolachlor+isoxaflutole+DICHLORMID; fluthiacet-methyl+metolachlor+mesotrione+DICHLORMID; fluthiacet-methyl+S-metolachlor+mesotrione+DICHLORMID; fluthiacet-methyl+metolachlor+atrazine+DICHLORMID; fluthiacet-methyl+S-metolachlor+atrazine+DICHLORMID; fluthiacet-methyl+metolachlor+terbuthylazine+DICHLORMID; fluthiacet-methyl+S-metolachlor+terbuthylazine+DICHLORMID; fluthiacet-methyl+atrazine+nicosulfuron+DICHLORMID; oxadiargyl+metolachlor+isoxaflutole+DICHLORMID; oxadiargyl+S-metolachlor+isoxaflutole+DICHLORMID; oxadiargyl+metolachlor+mesotrione+DICHLORMID; oxadiargyl+S-metolachlor+mesotrione+DICHLORMID; oxadiargyl+metolachlor+atrazine+DICHLORMID; oxadiargyl+S-metolachlor+atrazine+DICHLORMID; oxadiargyl +metolachlor+terbuthylazine+DICHLORMID; oxadiargyl+S-metolachlor+terbuthylazine +DICHLORMID; oxadiargyl+atrazine+nicosulfuron+DICHLORMID; oxadiazon+metolachlor+isoxaflutole+DICHLORMID; oxadiazon+S-metolachlor+isoxaflutole+DICHLORMID; oxadiazon+metolachlor+mesotrione+DICHLORMID; oxadiazon+S-metolachlor+mesotrione+DICHLORMID; oxadiazon+metolachlor+atrazine+DICHLORMID; oxadiazon+S-metolachlor+atrazine+DICHLORMID; oxadiazon+metolachlor+terbuthylazine+DICHLORMID; oxadiazon+S-metolachlor+terbuthylazine+DICHLORMID; oxadiazon+atrazine+nicosulfuron+DICHLORMID; pentoxazone+metolachlor+isoxaflutole+DICHLORMID; pentoxazone+S-metolachlor+isoxaflutole+DICHLORMID; pentoxazone+metolachlor+mesotrione+DICHLORMID; pentoxazone+S-metolachlor+mesotrione+DICHLORMID; pentoxazone+metolachlor+atrazine+DICHLORMID; pentoxazone+S-metolachlor+atrazine+DICHLORMID; pentoxazone+metolachlor+terbuthylazine+DICHLORMID; pentoxazone+S-metolachlor+terbuthylazine+DICHLORMID; pentoxazone+atrazine+nicosulfuron+DICHLORMID; sulfentrazone+metolachlor+isoxaflutole+DICHLORMID; sulfentrazone+S-metolachlor+isoxaflutole+DICHLORMID; sulfentrazone+metolachlor+mesotrione+DICHLORMID; sulfentrazone+S-metolachlor+mesotrione+DICHLORMID; sulfentrazone+metolachlor+atrazine+DICHLORMID; sulfentrazone+S-metolachlor+atrazine+DICHLORMID; sulfentrazone+metolachlor+terbuthylazine+DICHLORMID; sulfentrazone+S-metolachlor+terbuthylazine+DICHLORMID; sulfentrazone+atrazine+nicosulfuron+DICHLORMID; fluazolate+metolachlor+isoxaflutole+DICHLORMID; fluazolate+S-metolachlor+isoxaflutole+DICHLORMID; fluazolate+metolachlor+mesotrione+DICHLORMID; fluazolate+S-metolachlor+mesotrione+DICHLORMID; fluazolate+metolachlor+atrazine+DICHLORMID; fluazolate+S-metolachlor+atrazine+DICHLORMID; fluazolate+metolachlor+terbuthylazine+DICHLORMID; fluazolate+S-metolachlor+terbuthylazine+DICHLORMID; fluazolate+atrazine+nicosulfuron+DICHLORMID; pyraflufen-ethyl+metolachlor+isoxaflutole+DICHLORMID; pyraflufen-ethyl+S-metolachlor+isoxaflutole+DICHLORMID; pyraflufen-ethyl+metolachlor+mesotrione+DICHLORMID; pyraflufen-ethyl+S-metolachlor+mesotrione+DICHLORMID; pyraflufen-ethyl+metolachlor+atrazine+DICHLORMID; pyraflufen-ethyl+S-metolachlor +atrazine+DICHLORMID; pyraflufen-ethyl+metolachlor+terbuthylazine+DICHLORMID; pyraflufen-ethyl+S-metolachlor+terbuthylazine+DICHLORMID; pyraflufen-ethyl+atrazine+nicosulfuron+DICHLORMID; flumipropyn+metolachlor+isoxaflutole+DICHLORMID; flumipropyn+S-metolachlor+isoxaflutole+DICHLORMID; flumipropyn+metolachlor+mesotrione+DICHLORMID; flumipropyn+S-metolachlor+mesotrione+DICHLORMID; flumipropyn+metolachlor+atrazine+DICHLORMID; flumipropyn+S-metolachlor+atrazine+DICHLORMID; flumipropyn+metolachlor+terbuthylazine+DICHLORMID; flumipropyn+S-metolachlor+terbuthylazine+DICHLORMID; flumipropyn+atrazine+nicosulfuron+DICHLORMID; flupropacil+metolachlor+isoxaflutole+DICHLORMID; flupropacil+S-metolachlor+isoxaflutole+DICHLORMID; flupropacil+metolachlor+mesotrione+DICHLORMID; flupropacil+S-metolachlor+mesotrione+DICHLORMID; flupropacil+metolachlor+atrazine+DICHLORMID; flupropacil+S-metolachlor+atrazine+DICHLORMID; flupropacil+metolachlor+terbuthylazine+DICHLORMID; flupropacil+S-metolachlor+terbuthylazine+DICHLORMID; flupropacil+atrazine+nicosulfuron+DICHLORMID; nipyraclofen+metolachlor+isoxaflutole+DICHLORMID; nipyraclofen+S-metolachlor+isoxaflutole+DICHLORMID; nipyraclofen+metolachlor+mesotrione+DICHLORMID; nipyraclofen+S-metolachlor+mesotrione+DICHLORMID; nipyraclofen+metolachlor+atrazine+DICHLORMID; nipyraclofen+S-metolachlor+atrazine+DICHLORMID; nipyraclofen+metolachlor+terbuthylazine+DICHLORMID; nipyraclofen+S-metolachlor+terbuthylazine+DICHLORMID; nipyraclofen +atrazine+nicosulfuron+DICHLORMID; benzfendizone+metolachlor+isoxaflutole+DICHLORMID; benzfendizone+S-metolachlor+isoxaflutole+DICHLORMID; benzfendizone+metolachlor+mesotrione+DICHLORMID; benzfendizone+S-metolachlor +mesotrione+DICHLORMID; benzfendizone+metolachlor+atrazine+DICHLORMID; benzfendizone+S-metolachlor+atrazine+DICHLORMID; benzfendizone+metolachlor+terbuthylazine+DICHLORMID; benzfendizone+S-metolachlor+terbuthylazine+DICHLORMID; benzfendizone+atrazine+nicosulfuron+DICHLORMID; thidiazimin+metolachlor+isoxaflutole+DICHLORMID; thidiazimin+S-metolachlor+isoxaflutole+DICHLORMID; thidiazimin+metolachlor+mesotrione+DICHLORMID; thidiazimin+S-metolachlor+mesotrione+DICHLORMID; thidiazimin+metolachlor+atrazine+DICHLORMID; thidiazimin+S-metolachlor+atrazine+DICHLORMID; thidiazimin+metolachlor+terbuthylazine+DICHLORMID; thidiazimin+S-metolachlor+terbuthylazine+DICHLORMID; and thidiazimin+atrazine+nicosulfuron+DICHLORMID. Acifluorfen+metolachlor+isoxaflutole+FURILAZOLE; acifluorfen+S-metolachlor+isoxaflutole+FURILAZOLE; acifluorfen+metolachlor+mesotrione+FURILAZOLE; acifluorfen+S-metolachlor+mesotrione+FURILAZOLE; acifluorfen+metolachlor+atrazine+FURILAZOLE; acifluorfen+S-metolachlor+atrazine+FURILAZOLE; acifluorfen +metolachlor+terbuthylazine+FURILAZOLE; acifluorfen+S-metolachlor+terbuthylazine +FURILAZOLE; acifluorfen+atrazine+nicosulfuron+FURILAZOLE; aclonifen+metolachlor+isoxaflutole+FURILAZOLE; aclonifen+S-metolachlor+isoxaflutole+FURILAZOLE; aclonifen+metolachlor+mesotrione+FURILAZOLE; aclonifen+S-metolachlor+mesotrione+FURILAZOLE; aclonifen+metolachlor+atrazine+FURILAZOLE; aclonifen+S-metolachlor+atrazine+FURILAZOLE; aclonifen+metolachlor+terbuthylazine+FURILAZOLE; aclonifen+S-metolachlor+terbuthylazine+FURILAZOLE; aclonifen+atrazine+nicosulfuron+FURILAZOLE; bifenox+metolachlor+isoxaflutole+FURILAZOLE; bifenox+S-metolachlor+isoxaflutole+FURILAZOLE; bifenox +metolachlor+mesotrione+FURILAZOLE; bifenox+S-metolachlor+mesotrione+FURILAZOLE; bifenox+metolachlor+atrazine+FURILAZOLE; bifenox+S-metolachlor+atrazine+FURILAZOLE; bifenox+metolachlor+terbuthylazine+FURILAZOLE; bifenox+S-metolachlor+terbuthylazine+FURILAZOLE; bifenox+atrazine+nicosulfuron+FURILAZOLE; chlomitrofen+metolachlor+isoxaflutole+FURILAZOLE; chlomitrofen+S-metolachlor+isoxaflutole+FURILAZOLE; chlomitrofen+metolachlor+mesotrione+FURILAZOLE; chlomitrofen+S-metolachlor+mesotrione+FURILAZOLE; chlomitrofen+metolachlor+atrazine+FURILAZOLE; chlomitrofen+S-metolachlor+atrazine+FURILAZOLE; chlomitrofen+metolachlor+terbuthylazine+FURILAZOLE; chlomitrofen+S-metolachlor+terbuthylazine+FURILAZOLE; chlomitrofen+atrazine+nicosulfuron+FURILAZOLE; ethoxyfen+metolachlor+isoxaflutole+FURILAZOLE; ethoxyfen+S-metolachlor+isoxaflutole+FURILAZOLE; ethoxyfen+metolachlor+mesotrione+FURILAZOLE; ethoxyfen+S-metolachlor+mesotrione+FURILAZOLE; ethoxyfen+metolachlor+atrazine+FURILAZOLE; ethoxyfen+S-metolachlor+atrazine+FURILAZOLE; ethoxyfen+metolachlor+terbuthylazine+FURILAZOLE; ethoxyfen+S-metolachlor+terbuthylazine+FURILAZOLE; ethoxyfen+atrazine+nicosulfuron+FURILAZOLE; fluoroglycofen+metolachlor+isoxaflutole+FURILAZOLE; fluoroglycofen+S-metolachlor+isoxaflutole+FURILAZOLE; fluoroglycofen+metolachlor+mesotrione+FURILAZOLE; fluoroglycofen+S-metolachlor+mesotrione+FURILAZOLE; fluoroglycofen +metolachlor+atrazine+FURILAZOLE; fluoroglycofen+S-metolachlor+atrazine+FURILAZOLE; fluoroglycofen+metolachlor+terbuthylazine+FURILAZOLE; fluoroglycofen +S-metolachlor+terbuthylazine+FURILAZOLE; fluoroglycofen+atrazine+nicosulfuron+FURILAZOLE; fomesafen+metolachlor+isoxaflutole+FURILAZOLE; fomesafen+S-metolachlor+isoxaflutole+FURILAZOLE; fomesafen+metolachlor+mesotrione+FURILAZOLE; fomesafen+S-metolachlor+mesotrione+FURILAZOLE; fomesafen+metolachlor+atrazine+FURILAZOLE; fomesafen+S-metolachlor+atrazine+FURILAZOLE; fomesafen+metolachlor+terbuthylazine+FURILAZOLE; fomesafen+S-metolachlor+terbuthylazine+FURILAZOLE; fomesafen+atrazine+nicosulfuron+FURILAZOLE; lactofen+metolachlor+isoxaflutole+FURILAZOLE; lactofen+S-metolachlor+isoxaflutole+FURILAZOLE; lactofen+metolachlor+mesotrione+FURILAZOLE; lactofen+S-metolachlor+mesotrione+FURILAZOLE; lactofen+metolachlor+atrazine+FURILAZOLE; lactofen+S-metolachlor+atrazine+FURILAZOLE; lactofen+metolachlor+terbuthylazine+FURILAZOLE; lactofen+S-metolachlor+terbuthylazine+FURILAZOLE; lactofen+atrazine+nicosulfuron+FURILAZOLE; oxyfluorfen+metolachlor+isoxaflutole+FURILAZOLE; oxyfluorfen+S-metolachlor+isoxaflutole+FURILAZOLE; oxyfluorfen+metolachlor+mesotrione+FURILAZOLE; oxyfluorfen+S-metolachlor+mesotrione+FURILAZOLE; oxyfluorfen+metolachlor+atrazine+FURILAZOLE; oxyfluorfen+S-metolachlor+atrazine+FURILAZOLE; oxyfluorfen+metolachlor+terbuthylazine+FURILAZOLE; oxyfluorfen+S-metolachlor+terbuthylazine+FURILAZOLE; oxyfluorfen+atrazine+nicosulfuron+FURILAZOLE; azafenidin+metolachlor+isoxaflutole+FURILAZOLE; azafenidin+S-metolachlor+isoxaflutole+FURILAZOLE; azafenidin+metolachlor+mesotrione+FURILAZOLE; azafenidin+S-metolachlor+mesotrione+FURILAZOLE; azafenidin+metolachlor+atrazine+FURILAZOLE; azafenidin+S-metolachlor+atrazine+FURILAZOLE; azafenidin +metolachlor+terbuthylazine+FURILAZOLE; azafenidin+S-metolachlor+terbuthylazine +FURILAZOLE; azafenidin+atrazine+nicosulfuron+FURILAZOLE; carfentrazone-ethyl +metolachlor+isoxaflutole+FURILAZOLE; carfentrazone-ethyl+S-metolachlor+isoxaflutole+FURILAZOLE; carfentrazone-ethyl+metolachlor+mesotrione+FURILAZOLE; carfentrazone-ethyl+S-metolachlor+mesotrione+FURILAZOLE; carfentrazone-ethyl+metolachlor+atrazine+FURILAZOLE; carfentrazone-ethyl+S-metolachlor+atrazine+FURILAZOLE; carfentrazone-ethyl+metolachlor+terbuthylazine +FURILAZOLE; carfentrazone-ethyl+S-metolachlor+terbuthylazine+FURILAZOLE; carfentrazone-ethyl+atrazine+nicosulfuron+FURILAZOLE; compound of the formula A +metolachlor+isoxaflutole+FURILAZOLE; compound of the formula A+S-metolachlor+isoxaflutole+FURILAZOLE; compound of the formula A+metolachlor+mesotrione+FURILAZOLE; compound of the formula A+S-metolachlor+mesotrione+FURILAZOLE; compound of the formula A+metolachlor+atrazine+FURILAZOLE; compound of the formula A+S-metolachlor+atrazine+FURILAZOLE; compound of the formula A+metolachlor+terbuthylazine+FURILAZOLE; compound of the formula A+S-metolachlor+terbuthylazine+FURILAZOLE; compound of the formula A+atrazine+nicosulfuron+FURILAZOLE; cinidon-ethyl+metolachlor+isoxaflutole+FURILAZOLE; cinidon-ethyl+S-metolachlor+isoxaflutole+FURILAZOLE; cinidon-ethyl+metolachlor+mesotrione+FURILAZOLE; cinidon-ethyl+S-metolachlor+mesotrione+FURILAZOLE; cinidon-ethyl+metolachlor+atrazine+FURILAZOLE; cinidon-ethyl+S-metolachlor+atrazine+FURILAZOLE; cinidon-ethyl+metolachlor+terbuthylazine+FURILAZOLE; cinidon-ethyl+S-metolachlor+terbuthylazine+FURILAZOLE; cinidon-ethyl+atrazine+nicosulfuron+FURILAZOLE; flumiclorac-pentyl+metolachlor+isoxaflutole+FURILAZOLE; flumiclorac-pentyl+S-metolachlor+isoxaflutole+FURILAZOLE; flumiclorac-pentyl+metolachlor+mesotrione+FURILAZOLE; flumiclorac-pentyl+S-metolachlor+mesotrione+FURILAZOLE; flumiclorac-pentyl+metolachlor+atrazine+FURILAZOLE; flumiclorac-pentyl+S-metolachlor+atrazine+FURILAZOLE; flumiclorac-pentyl+metolachlor+terbuthylazine+FURILAZOLE; flumiclorac-pentyl+S-metolachlor+terbuthylazine+FURILAZOLE; flumiclorac-pentyl+atrazine+nicosulfuron+FURILAZOLE; flumioxazin+metolachlor+isoxaflutole+FURILAZOLE; flumioxazin+S-metolachlor+isoxaflutole+FURILAZOLE; flumioxazin+metolachlor+mesotrione+FURILAZOLE; flumioxazin+S-metolachlor+mesotrione+FURILAZOLE; flumioxazin+metolachlor+atrazine+FURILAZOLE; flumioxazin+S-metolachlor+atrazine+FURILAZOLE; flumioxazin+metolachlor+terbuthylazine+FURILAZOLE; flumioxazin+S-metolachlor+terbuthylazine +FURILAZOLE; flumioxazin+atrazine+nicosulfuron+FURILAZOLE; fluthiacet-methyl+metolachlor+isoxaflutole+FURILAZOLE; fluthiacet-methyl+S-metolachlor+isoxaflutole+FURILAZOLE; fluthiacet-methyl+metolachlor+mesotrione+FURILAZOLE; fluthiacet-methyl+S-metolachlor+mesotrione+FURILAZOLE; fluthiacet-methyl+metolachlor+atrazine+FURILAZOLE; fluthiacet-methyl+S-metolachlor+atrazine+FURILAZOLE; fluthiacet-methyl+metolachlor+terbuthylazine+FURILAZOLE; fluthiacet-methyl+S-metolachlor+terbuthylazine+FURILAZOLE; fluthiacet-methyl+atrazine+nicosulfuron+FURILAZOLE; oxadiargyl+metolachlor+isoxaflutole+FURILAZOLE; oxadiargyl+S-metolachlor+isoxaflutole+FURILAZOLE; oxadiargyl+metolachlor+mesotrione+FURILAZOLE; oxadiargyl+S-metolachlor+mesotrione+FURILAZOLE; oxadiargyl+metolachlor+atrazine+FURILAZOLE; oxadiargyl+S-metolachlor+atrazine+FURILAZOLE; oxadiargyl+metolachlor+terbuthylazine+FURILAZOLE; oxadiargyl+S-metolachlor+terbuthylazine+FURILAZOLE; oxadiargyl+atrazine+nicosulfuron+FURILAZOLE; oxadiazon+metolachlor+isoxaflutole+FURILAZOLE; oxadiazon+S-metolachlor+isoxaflutole+FURILAZOLE; oxadiazon+metolachlor+mesotrione+FURILAZOLE; oxadiazon+S-metolachlor+mesotrione+FURILAZOLE; oxadiazon+metolachlor+atrazine+FURILAZOLE; oxadiazon+S-metolachlor+atrazine+FURILAZOLE; oxadiazon+metolachlor+terbuthylazine+FURILAZOLE; oxadiazon+S-metolachlor+terbuthylazine+FURILAZOLE; oxadiazon+atrazine+nicosulfuron+FURILAZOLE; pentoxazone+metolachlor+isoxaflutole+FURILAZOLE; pentoxazone+S-metolachlor+isoxaflutole+FURILAZOLE; pentoxazone+metolachlor+mesotrione+FURILAZOLE; pentoxazone+S-metolachlor+mesotrione+FURILAZOLE; pentoxazone+metolachlor+atrazine+FURILAZOLE; pentoxazone+S-metolachlor+atrazine+FURILAZOLE; pentoxazone+metolachlor+terbuthylazine+FURILAZOLE; pentoxazone+S-metolachlor+terbuthylazine+FURILAZOLE; pentoxazone+atrazine+nicosulfuron+FURILAZOLE; sulfentrazone+metolachlor+isoxaflutole+FURILAZOLE; sulfentrazone+S-metolachlor+isoxaflutole+FURILAZOLE; sulfentrazone+metolachlor+mesotrione+FURILAZOLE; sulfentrazone+S-metolachlor+mesotrione+FURILAZOLE; sulfentrazone +metolachlor+atrazine+FURILAZOLE; sulfentrazone+S-metolachlor+atrazine+FURILAZOLE; sulfentrazone+metolachlor+terbuthylazine+FURILAZOLE; sulfentrazone +S-metolachlor+terbuthylazine+FURILAZOLE; sulfentrazone+atrazine+nicosulfuron+FURILAZOLE; fluazolate+metolachlor+isoxaflutole+FURILAZOLE; fluazolate+S-metolachlor+isoxaflutole+FURILAZOLE; fluazolate+metolachlor+mesotrione+FURILAZOLE; fluazolate+S-metolachlor+mesotrione+FURILAZOLE; fluazolate+metolachlor+atrazine+FURILAZOLE; fluazolate+S-metolachlor+atrazine+FURILAZOLE; fluazolate+metolachlor+terbuthylazine+FURILAZOLE; fluazolate+S-metolachlor+terbuthylazine+FURILAZOLE; fluazolate+atrazine+nicosulfuron+FURILAZOLE; pyraflufen-ethyl+metolachlor+isoxaflutole+FURILAZOLE; pyraflufen-ethyl+S-metolachlor+isoxaflutole+FURILAZOLE; pyraflufen-ethyl+metolachlor+mesotrione+FURILAZOLE; pyraflufen-ethyl+S-metolachlor+mesotrione+FURILAZOLE; pyraflufen-ethyl+metolachlor+atrazine+FURILAZOLE; pyraflufen-ethyl+S-metolachlor+atrazine+FURILAZOLE; pyraflufen-ethyl+metolachlor+terbuthylazine+FURILAZOLE; pyraflufen-ethyl+S-metolachlor+terbuthylazine+FURILAZOLE; pyraflufen-ethyl+atrazine+nicosulfuron+FURILAZOLE; flumipropyn+metolachlor+isoxaflutole+FURILAZOLE; flumipropyn+S-metolachlor+isoxaflutole+FURILAZOLE; flumipropyn+metolachlor+mesotrione+FURILAZOLE; flumipropyn+S-metolachlor+mesotrione+FURILAZOLE; flumipropyn+metolachlor+atrazine+FURILAZOLE; flumipropyn+S-metolachlor+atrazine+FURILAZOLE; flumipropyn+metolachlor+terbuthylazine+FURILAZOLE; flumipropyn+S-metolachlor+terbuthylazine+FURILAZOLE; flumipropyn+atrazine+nicosulfuron+FURILAZOLE; flupropacil+metolachlor+isoxaflutole+FURILAZOLE; flupropacil+S-metolachlor+isoxaflutole+FURILAZOLE; flupropacil+metolachlor+mesotrione+FURILAZOLE; flupropacil+S-metolachlor+mesotrione+FURILAZOLE; flupropacil+metolachlor+atrazine+FURILAZOLE; flupropacil+S-metolachlor+atrazine+FURILAZOLE; flupropacil+metolachlor+terbuthylazine+FURILAZOLE; flupropacil+S-metolachlor+terbuthylazine+FURILAZOLE; flupropacil+atrazine+nicosulfuron+FURILAZOLE; nipyraclofen+metolachlor+isoxaflutole+FURILAZOLE; nipyraclofen+S-metolachlor+isoxaflutole+FURILAZOLE; nipyraclofen+metolachlor+mesotrione+FURILAZOLE; nipyraclofen+S-metolachlor+mesotrione+FURILAZOLE; nipyraclofen+metolachlor+atrazine+FURILAZOLE; nipyraclofen+S-metolachlor+atrazine+FURILAZOLE; nipyraclofen+metolachlor+terbuthylazine+FURILAZOLE; nipyraclofen+S-metolachlor+terbuthylazine+FURILAZOLE; nipyraclofen +atrazine+nicosulfuron+FURILAZOLE; benzfendizone+metolachlor+isoxaflutole+FURILAZOLE; benzfendizone+S-metolachlor+isoxaflutole+FURILAZOLE; benzfendizone+metolachlor+mesotrione+FURILAZOLE; benzfendizone+S-metolachlor +mesotrione+FURILAZOLE; benzfendizone+metolachlor+atrazine+FURILAZOLE; benzfendizone+S-metolachlor+atrazine+FURILAZOLE; benzfendizone+metolachlor+terbuthylazine+FURILAZOLE; benzfendizone+S-metolachlor+terbuthylazine+FURILAZOLE; benzfendizone+atrazine+nicosulfuron+FURILAZOLE; thidiazimin+metolachlor+isoxaflutole+FURILAZOLE; thidiazimin+S-metolachlor+isoxaflutole+FURILAZOLE; thidiazimin+metolachlor+mesotrione+FURILAZOLE; thidiazimin+S-metolachlor+mesotrione+FURILAZOLE; thidiazimin+metolachlor+atrazine+FURILAZOLE; thidiazimin+S-metolachlor+atrazine+FURILAZOLE; thidiazimin+metolachlor+terbuthylazine+FURILAZOLE; thidiazimin+S-metolachlor+terbuthylazine+FURILAZOLE; and thidiazimin+atrazine+nicosulfuron+FURILAZOLE.

Acifluorfen+atrazin+glyphosate; acifluorfen+terbuthylazine+glyphosate; acifluorfen+(S)-metolachlor+glyphosate; acifluorfen+metolachlor+glyphosate; acifluorfen+compound of the formula A+glyphosate; acifluorfen+terbutryn+glyphosate; acifluorfen+simazine+glyphosate; acifluorfen+dimethenamid or (S-dimethenamid+glyphosate; acifluorfen+flufenacet+glyphosate; acifluorfen+acetochlor+glyphosate; acifluorfen+alachlor+glyphosate; acifluorfen+isoxaflutole+glyphosate; acifluorfen+isoxachlortole+glyphosate; acifluorfen+mesotrione+glyphosate; acifluorfen+sulcotrione+glyphosate; acifluorfen+metosulam+glyphosate; acifluorfen+flumetsulam+glyphosate; acifluorfen+pendimethalin+glyphosate; acifluorfen+bromoxynil+glyphosate; acifluorfen+bentazone +glyphosate; acifluorfen+carfentrazone+glyphosate; acifluorfen+clomazone+glyphosate; acifluorfen+nicosulfuron+glyphosate; acifluorfen+rimsulfuron+glyphosate; acifluorfen+halosulfuron+glyphosate; acifluorfen+metribuzin+glyphosate; acifluorfen+flumiclorac+glyphosate; acifluorfen+prosulfuron+glyphosate; acifluorfen+primisulfuron +glyphosate; acifluorfen+dicamba+glyphosate; acifluorfen+fluthiacet+glyphosate; acifluorfen+pyridate+glyphosate; acifluorfen+compound of the formula B+glyphosate; acifluorfen+2,4-D+glyphosate; acifluorfen+clopyralide+glyphosate; acifluorfen+diflufenzopyr+glyphosate; acifluorfen+fluroxypyr+glyphosate; acifluorfen+MCPA+glyphosate; acifluorfen+MCPB+glyphosate; acifluorfen+MCPP+glyphosate; acifluorfen +metobenzuron+glyphosate; acifluorfen+thifensulfuron+glyphosate; acifluorfen+aclonifen+glyphosate; acifluorfen+EPTC+glyphosate; acifluorfen+cyanazine+glyphosate; aclonifen+atrazin+glyphosate; aclonifen+terbuthylazine+glyphosate; aclonifen+(S)-metolachlor+glyphosate; aclonifen+metolachlor+glyphosate; aclonifen+compound of the formula A+glyphosate; aclonifen+terbutryn+glyphosate; aclonifen+simazine+glyphosate; aclonifen+dimethenamid or (S)-dimethenamid+glyphosate; aclonifen+flufenacet+glyphosate; aclonifen+acetochlor+glyphosate; aclonifen+alachlor+glyphosate; aclonifen+isoxaflutole+glyphosate; aclonifen+isoxachlortole+glyphosate; aclonifen+mesotrione+glyphosate; aclonifen+sulcotrione+glyphosate; aclonifen+metosulam+glyphosate; aclonifen+flumetsulam+glyphosate; aclonifen+pendimethalin+glyphosate; aclonifen+bromoxynil+glyphosate; aclonifen+bentazone+glyphosate; aclonifen+carfentrazone+glyphosate; aclonifen+clomazone+glyphosate; aclonifen+nicosulfuron+glyphosate; aclonifen+rimsulfuron+glyphosate; aclonifen+halosulfuron+glyphosate; aclonifen+metribuzin+glyphosate; aclonifen+flumiclorac+glyphosate; aclonifen+prosulfuron+glyphosate; aclonifen+primisulfuron+glyphosate; aclonifen+dicamba+glyphosate; aclonifen+fluthiacet+glyphosate; aclonifen+pyridate +glyphosate; aclonifen+compound of the formula B+glyphosate; aclonifen+2,4-D+glyphosate; aclonifen+clopyralide+glyphosate; aclonifen+diflufenzopyr+glyphosate; aclonifen+fluroxypyr+glyphosate; aclonifen+MCPA+glyphosate; aclonifen+MCPB+glyphosate; aclonifen+MCPP+glyphosate; aclonifen+metobenzuron+glyphosate; aclonifen+thifensulfuron+glyphosate; aclonifen+EPTC+glyphosate; aclonifen+cyanazine+glyphosate; bifenox+atrazin+glyphosate; bifenox+terbuthylazine+glyphosate; bifenox+(S)-metolachlor+glyphosate; bifenox+metolachlor+glyphosate; bifenox+compound of the formula A+glyphosate; bifenox+terbutryn+glyphosate; bifenox+simazine+glyphosate; bifenox+dimethenamid or (S)-dimethenamid+glyphosate; bifenox+flufenacet+glyphosate; bifenox+acetochlor+glyphosate; bifenox+alachlor+glyphosate; bifenox+isoxaflutole+glyphosate; bifenox+isoxachlortole+glyphosate; bifenox+mesotrione+glyphosate; bifenox+sulcotrione+glyphosate; bifenox +metosulam+glyphosate; bifenox+flumetsulam+glyphosate; bifenox+pendimethalin+glyphosate; bifenox+bromoxynil+glyphosate; bifenox+bentazone+glyphosate; bifenox +carfentrazone+glyphosate; bifenox+clomazone+glyphosate; bifenox+nicosulfuron+glyphosate; bifenox+rimsulfuron+glyphosate; bifenox+halosulfuron+glyphosate; bifenox+metribuzin+glyphosate; bifenox+flumiclorac+glyphosate; bifenox+prosulfuron +glyphosate; bifenox+primisulfuron+glyphosate; bifenox+dicamba+glyphosate; bifenox+fluthiacet+glyphosate; bifenox+pyridate+glyphosate; bifenox+compound of the formula B+glyphosate; bifenox+2,4-D+glyphosate; bifenox+clopyralide+glyphosate; bifenox+diflufenzopyr+glyphosate; bifenox+fluroxypyr+glyphosate; bifenox +MCPA+glyphosate; bifenox+MCPB+glyphosate; bifenox+MCPP+glyphosate; bifenox+metobenzuron+glyphosate; bifenox+thifensulfuron+glyphosate; bifenox+aclonifen+glyphosate; bifenox+EPTC+glyphosate; bifenox+cyanazine+glyphosate; chlomitrofen+atrazin+glyphosate; chlomitrofen+terbuthylazine+glyphosate; chlomitrofen+(S)-metolachlor+glyphosate; chlomitrofen+metolachlor+glyphosate; chlomitrofen+compound of the formula A+glyphosate; chlomitrofen+terbutryn+glyphosate; chlomitrofen+simazine+glyphosate; chlomitrofen+dimethenamid or (S)-dimethenamid+glyphosate; chlomitrofen+flufenacet+glyphosate; chlomitrofen+acetochlor+glyphosate; chlomitrofen+alachlor+glyphosate; chlomitrofen+isoxaflutole+glyphosate; chlomitrofen+isoxachlortole+glyphosate; chlomitrofen+mesotrione+glyphosate; chlomitrofen+sulcotrione+glyphosate; chlomitrofen+metosulam+glyphosate; chlomitrofen+flumetsulam+glyphosate; chlomitrofen+pendimethalin+glyphosate; chlomitrofen+bromoxynil+glyphosate; chlomitrofen+bentazone+glyphosate; chlomitrofen+carfentrazone+glyphosate; chlomitrofen+clomazone+glyphosate; chlomitrofen+nicosulfuron+glyphosate; chlomitrofen+rimsulfuron+glyphosate; chlomitrofen+halosulfuron+glyphosate; chlomitrofen+metribuzin+glyphosate; chlomitrofen+flumiclorac+glyphosate; chlomitrofen+prosulfuron+glyphosate; chlomitrofen+primisulfuron+glyphosate; chlomitrofen+dicamba+glyphosate; chlomitrofen+fluthiacet+glyphosate; chlomitrofen+pyridate+glyphosate; chlomitrofen+compound of the formula B+glyphosate; chlomitrofen+2,4-D+glyphosate; chlomitrofen+clopyralide+glyphosate; chlomitrofen+diflufenzopyr+glyphosate; chlomitrofen+fluroxypyr+glyphosate; chlomitrofen+MCPA+glyphosate; chlomitrofen+MCPB+glyphosate; chlomitrofen+MCPP+glyphosate; chlomitrofen+metobenzuron+glyphosate; chlomitrofen+thifensulfuron+glyphosate; chlomitrofen+aclonifen+glyphosate; chlomitrofen+EPTC+glyphosate; chlomitrofen+cyanazine+glyphosate; ethoxyfen+atrazin+glyphosate; ethoxyfen+terbuthylazine+glyphosate; ethoxyfen+(S)-metolachlor+glyphosate; ethoxyfen+metolachlor+glyphosate; ethoxyfen+compound of the formula A+glyphosate; ethoxyfen+terbutryn+glyphosate; ethoxyfen+simazine+glyphosate; ethoxyfen+dimethenamid or (S)-dimethenamid+glyphosate; ethoxyfen+flufenacet+glyphosate; ethoxyfen+acetochlor+glyphosate; ethoxyfen+alachlor+glyphosate; ethoxyfen+isoxaflutole+glyphosate; ethoxyfen+isoxachlortole+glyphosate; ethoxyfen+mesotrione+glyphosate; ethoxyfen+sulcotrione+glyphosate; ethoxyfen+metosulam+glyphosate; ethoxyfen+flumetsulam+glyphosate; ethoxyfen+pendimethalin +glyphosate; ethoxyfen+bromoxynil+glyphosate; ethoxyfen+bentazone+glyphosate; ethoxyfen+carfentrazone+glyphosate; ethoxyfen+clomazone+glyphosate; ethoxyfen+nicosulfuron+glyphosate; ethoxyfen+rimsulfuron+glyphosate; ethoxyfen+halosulfuron +glyphosate; ethoxyfen+metribuzin+glyphosate; ethoxyfen+flumiclorac+glyphosate; ethoxyfen+prosulfuron+glyphosate; ethoxyfen+primisulfuron+glyphosate; ethoxyfen+dicamba+glyphosate; ethoxyfen+fluthiacet+glyphosate; ethoxyfen+pyridate+glyphosate; ethoxyfen+compound of the formula B+glyphosate; ethoxyfen+2,4-D+glyphosate; ethoxyfen+clopyralide+glyphosate; ethoxyfen+diflufenzopyr+glyphosate; ethoxyfen+fluroxypyr+glyphosate; ethoxyfen+MCPA+glyphosate; ethoxyfen+MCPB+glyphosate; ethoxyfen+MCPP+glyphosate; ethoxyfen+metobenzuron+glyphosate; ethoxyfen+thifensulfuron+glyphosate; ethoxyfen+aclonifen+glyphosate; ethoxyfen+EPTC+glyphosate; ethoxyfen+cyanazine+glyphosate; fluoroglycofen+atrazin+glyphosate; fluoroglycofen+terbuthylazine+glyphosate; fluoroglycofen+(S)-metolachlor+glyphosate; fluoroglycofen+metolachlor+glyphosate; fluoroglycofen+compound of the formula A+glyphosate; fluoroglycofen+terbutryn+glyphosate; fluoroglycofen+simazine +glyphosate; fluoroglycofen+dimethenamid or (S)-dimethenamid+glyphosate; fluoroglycofen+flufenacet+glyphosate; fluoroglycofen+acetochlor+glyphosate; fluoroglycofen+alachlor+glyphosate; fluoroglycofen+isoxaflutole+glyphosate; fluoroglycofen+isoxachlortole+glyphosate; fluoroglycofen+mesotrione+glyphosate; fluoroglycofen+sulcotrione+glyphosate; fluoroglycofen+metosulam+glyphosate; fluoroglycofen+flumetsulam+glyphosate; fluoroglycofen+pendimethalin+glyphosate; fluoroglycofen+bromoxynil+glyphosate; fluoroglycofen+bentazone+glyphosate; fluoroglycofen+carfentrazone+glyphosate; fluoroglycofen+clomazone+glyphosate; fluoroglycofen+nicosulfuron+glyphosate; fluoroglycofen+rimsulfuron+glyphosate; fluoroglycofen+halosulfuron+glyphosate; fluoroglycofen+metribuzin+glyphosate; fluoroglycofen+flumiclorac+glyphosate; fluoroglycofen+prosulfuron+glyphosate; fluoroglycofen+primisulfuron+glyphosate; fluoroglycofen+dicamba+glyphosate; fluoroglycofen+fluthiacet+glyphosate; fluoroglycofen+pyridate+glyphosate; fluoroglycofen+compound of the formula B+glyphosate; fluoroglycofen+2,4-D+glyphosate; fluoroglycofen+clopyralide+glyphosate; fluoroglycofen+diflufenzopyr+glyphosate; fluoroglycofen+fluroxypyr+glyphosate; fluoroglycofen+MCPA+glyphosate; fluoroglycofen+MCPB+glyphosate; fluoroglycofen+MCPP+glyphosate; fluoroglycofen +metobenzuron+glyphosate; fluoroglycofen+thifensulfuron+glyphosate; fluoroglycofen +aclonifen+glyphosate; fluoroglycofen+EPTC+glyphosate; fluoroglycofen+cyanazine +glyphosate; fomesafen+atrazin+glyphosate; fomesafen+terbuthylazine+glyphosate; fomesafen+(S)-metolachlor+glyphosate; fomesafen+metolachlor+glyphosate; fomesafen+compound of the formula A+glyphosate; fomesafen+terbutryn+glyphosate; fomesafen+simazine+glyphosate; fomesafen+dimethenamid or (S)-dimethenamid+glyphosate; fomesafen+flufenacet+glyphosate; fomesafen+acetochlor+glyphosate; fomesafen+alachlor+glyphosate; fomesafen+isoxaflutole+glyphosate; fomesafen+isoxachlortole+glyphosate; fomesafen+mesotrione+glyphosate; fomesafen+sulcotrione +glyphosate; fomesafen+metosulam+glyphosate; fomesafen+flumetsulam+glyphosate; fomesafen+pendimethalin+glyphosate; fomesafen+bromoxynil+glyphosate; fomesafen+bentazone+glyphosate; fomesafen+carfentrazone+glyphosate; fomesafen+clomazone+glyphosate; fomesafen+nicosulfuron+glyphosate; fomesafen+rimsulfuron+glyphosate; fomesafen+halosulfuron+glyphosate; fomesafen +metribuzin+glyphosate; fomesafen+flumiclorac+glyphosate; fomesafen+prosulfuron +glyphosate; fomesafen+primisulfuron+glyphosate; fomesafen+dicamba+glyphosate; fomesafen+fluthiacet+glyphosate; fomesafen+pyridate+glyphosate; fomesafen+compound of the formula B+glyphosate; fomesafen+2,4-D+glyphosate; fomesafen+clopyralide+glyphosate; fomesafen+diflufenzopyr+glyphosate; fomesafen+fluroxypyr+glyphosate; fomesafen+MCPA+glyphosate; fomesafen+MCPB+glyphosate; fomesafen +MCPP+glyphosate; fomesafen+metobenzuron+glyphosate; fomesafen+thifensulfuron+glyphosate; fomesafen+aclonifen+glyphosate; fomesafen+EPTC+glyphosate; fomesafen+cyanazine+glyphosate; lactofen+atrazin+glyphosate; lactofen +terbuthylazine+glyphosate; lactofen+(S)-metolachlor+glyphosate; lactofen+metolachlor+glyphosate; lactofen+compound of the formula A+glyphosate; lactofen+terbutryn+glyphosate; lactofen+simazine+glyphosate; lactofen+dimethenamid or (S)-dimethenamid+glyphosate; lactofen+flufenacet+glyphosate; lactofen+acetochlor+glyphosate; lactofen+alachlor+glyphosate; lactofen+isoxaflutole+glyphosate; lactofen +isoxachlortole+glyphosate; lactofen+mesotrione+glyphosate; lactofen+sulcotrione+glyphosate; lactofen+metosulam+glyphosate; lactofen+flumetsulam+glyphosate; lactofen+pendimethalin+glyphosate; lactofen+bromoxynil+glyphosate; lactofen+bentazone+glyphosate; lactofen+carfentrazone+glyphosate; lactofen+clomazone+glyphosate; lactofen+nicosulfuron+glyphosate; lactofen+rimsulfuron+glyphosate; lactofen+halosulfuron+glyphosate; lactofen+metribuzin+glyphosate; lactofen+flumiclorac+glyphosate; lactofen+prosulfuron+glyphosate; lactofen+primisulfuron+glyphosate; lactofen+dicamba+glyphosate; lactofen+fluthiacet+glyphosate; lactofen+pyridate+glyphosate; lactofen+compound of the formula B+glyphosate; lactofen+2,4-D +glyphosate; lactofen+clopyralide+glyphosate; lactofen+diflufenzopyr+glyphosate; lactofen+fluroxypyr+glyphosate; lactofen+MCPA+glyphosate; lactofen+MCPB+glyphosate; lactofen+MCPP+glyphosate; lactofen+metobenzuron+glyphosate; lactofen +thifensulfuron+glyphosate; lactofen+aclonifen+glyphosate; lactofen+EPTC+glyphosate; lactofen+cyanazine+glyphosate; oxyfluorfen+atrazin+glyphosate; oxyfluorfen+terbuthylazine+glyphosate; oxyfluorfen+(S)-metolachlor+glyphosate; oxyfluorfen+metolachlor+glyphosate; oxyfluorfen+compound of the formula A+glyphosate; oxyfluorfen+terbutryn+glyphosate; oxyfluorfen+simazine+glyphosate; oxyfluorfen+dimethenamid or (S)-dimethenamid+glyphosate; oxyfluorfen+flufenacet+glyphosate; oxyfluorfen+acetochlor+glyphosate; oxyfluorfen+alachlor+glyphosate; oxyfluorfen+isoxaflutole+glyphosate; oxyfluorfen+isoxachlortole+glyphosate; oxyfluorfen+mesotrione+glyphosate; oxyfluorfen+sulcotrione+glyphosate; oxyfluorfen +metosulam+glyphosate; oxyfluorfen+flumetsulam+glyphosate; oxyfluorfen+pendimethalin+glyphosate; oxyfluorfen+bromoxynil+glyphosate; oxyfluorfen+bentazone+glyphosate; oxyfluorfen+carfentrazone+glyphosate; oxyfluorfen+clomazone+glyphosate; oxyfluorfen+nicosulfuron+glyphosate; oxyfluorfen+rimsulfuron +glyphosate; oxyfluorfen+halosulfuron+glyphosate; oxyfluorfen+metribuzin+glyphosate; oxyfluorfen+flumiclorac+glyphosate; oxyfluorfen+prosulfuron+glyphosate; oxyfluorfen+primisulfuron+glyphosate; oxyfluorfen+dicamba+glyphosate; oxyfluorfen+fluthiacet+glyphosate; oxyfluorfen+pyridate+glyphosate; oxyfluorfen+compound of the formula B+glyphosate; oxyfluorfen+2,4-D+glyphosate; oxyfluorfen+clopyralide+glyphosate; oxyfluorfen+diflufenzopyr+glyphosate; oxyfluorfen+fluroxypyr+glyphosate; oxyfluorfen+MCPA+glyphosate; oxyfluorfen+MCPB+glyphosate; oxyfluorfen+MCPP+glyphosate; oxyfluorfen+metobenzuron+glyphosate; oxyfluorfen+thifensulfuron+glyphosate; oxyfluorfen+aclonifen+glyphosate; oxyfluorfen+EPTC+glyphosate; oxyfluorfen+cyanazine+glyphosate; azafenidin+atrazin+glyphosate; azafenidin+terbuthylazine+glyphosate; azafenidin+(S)-metolachlor+glyphosate; azafenidin+metolachlor+glyphosate; azafenidin+compound of the formula A+glyphosate; azafenidin +terbutryn+glyphosate; azafenidin+simazine+glyphosate; azafenidin+dimethenamid or (S)-dimethenamid+glyphosate; azafenidin+flufenacet+glyphosate; azafenidin+acetochlor+glyphosate; azafenidin+alachlor+glyphosate; azafenidin+isoxaflutole+glyphosate; azafenidin+isoxachlortole+glyphosate; azafenidin+mesotrione+glyphosate; azafenidin+sulcotrione+glyphosate; azafenidin+metosulam+glyphosate; azafenidin+flumetsulam+glyphosate; azafenidin+pendimethalin+glyphosate; azafenidin+bromoxynil+glyphosate; azafenidin+bentazone+glyphosate; azafenidin+carfentrazone +glyphosate; azafenidin+clomazone+glyphosate; azafenidin+nicosulfuron+glyphosate; azafenidin+rimsulfuron+glyphosate; azafenidin+halosulfuron+glyphosate; azafenidin+metribuzin+glyphosate; azafenidin+flumiclorac+glyphosate; azafenidin+prosulfuron+glyphosate; azafenidin+primisulfuron+glyphosate; azafenidin+dicamba+glyphosate; azafenidin+fluthiacet+glyphosate; azafenidin+pyridate+glyphosate; azafenidin+compound of the formula B+glyphosate; azafenidin+2,4-D+glyphosate; azafenidin+clopyralide+glyphosate; azafenidin+diflufenzopyr+glyphosate; azafenidin+fluroxypyr+glyphosate; azafenidin+MCPA+glyphosate; azafenidin+MCPB+glyphosate; azafenidin+MCPP+glyphosate; azafenidin+metobenzuron+glyphosate; azafenidin+thifensulfuron+glyphosate; azafenidin+aclonifen+glyphosate; azafenidin+EPTC+glyphosate; azafenidin+cyanazine+glyphosate; carfentrazone-ethyl+atrazin+glyphosate; carfentrazone-ethyl+terbuthylazine+glyphosate; carfentrazone-ethyl+(S)-metolachlor+glyphosate; carfentrazone-ethyl+metolachlor+glyphosate; carfentrazone-ethyl+compound of the formula A+glyphosate; carfentrazone-ethyl+terbutryn+glyphosate; carfentrazone-ethyl+simazine+glyphosate; carfentrazone-ethyl+dimethenamid or (S)-dimethenamid+glyphosate; carfentrazone-ethyl+flufenacet+glyphosate; carfentrazone-ethyl+acetochlor+glyphosate; carfentrazone-ethyl+alachlor+glyphosate; carfentrazone-ethyl+isoxaflutole+glyphosate; carfentrazone-ethyl+isoxachlortole+glyphosate; carfentrazone-ethyl+mesotrione+glyphosate; carfentrazone-ethyl+sulcotrione+glyphosate; carfentrazone-ethyl+metosulam+glyphosate; carfentrazone-ethyl+flumetsulam+glyphosate; carfentrazone-ethyl+pendimethalin+glyphosate; carfentrazone-ethyl+bromoxynil+glyphosate; carfentrazone-ethyl+bentazone+glyphosate; carfentrazone-ethyl+clomazone+glyphosate; carfentrazone-ethyl+nicosulfuron+glyphosate; carfentrazone-ethyl+rimsulfuron+glyphosate; carfentrazone-ethyl+halosulfuron+glyphosate; carfentrazone-ethyl+metribuzin+glyphosate; carfentrazone-ethyl+flumiclorac+glyphosate; carfentrazone-ethyl+prosulfuron+glyphosate; carfentrazone-ethyl+primisulfuron+glyphosate; carfentrazone-ethyl+dicamba+glyphosate; carfentrazone-ethyl+fluthiacet+glyphosate; carfentrazone-ethyl+pyridate+glyphosate; carfentrazone-ethyl+compound of the formula B+glyphosate; carfentrazone-ethyl+2,4-D+glyphosate; carfentrazone-ethyl+clopyralide+glyphosate; carfentrazone-ethyl+diflufenzopyr+glyphosate; carfentrazone-ethyl+fluroxypyr+glyphosate; carfentrazone-ethyl+MCPA+glyphosate; carfentrazone-ethyl+MCPB+glyphosate; carfentrazone-ethyl+MCPP+glyphosate; carfentrazone-ethyl+metobenzuron+glyphosate; carfentrazone-ethyl+thifensulfuron+glyphosate; carfentrazone-ethyl+aclonifen+glyphosate; carfentrazone-ethyl+EPTC+glyphosate; carfentrazone-ethyl+cyanazine+glyphosate; compound of the formula A+atrazin+glyphosate; compound of the formula A+terbuthylazine+glyphosate; compound of the formula A+(S)-metolachlor+glyphosate; compound of the formula A+metolachlor+glyphosate; compound of the formula A+terbutryn+glyphosate; compound of the formula A+simazine+glyphosate; compound of the formula A+dimethenamid or (S)-dimethenamid+glyphosate; compound of the formula A+flufenacet+glyphosate; compound of the formula A+acetochlor+glyphosate; compound of the formula A+alachlor; compound of the formula A+isoxaflutole+glyphosate; compound of the formula A+isoxachlortole+glyphosate; compound of the formula A+mesotrione+glyphosate; compound of the formula A+sulcotrione+glyphosate; compound of the formula A+metosulam+glyphosate; compound of the formula A+flumetsulam+glyphosate; compound of the formula A+pendimethalin+glyphosate; compound of the formula A+bromoxynil+glyphosate; compound of the formula A+bentazone+glyphosate; compound of the formula A+carfentrazone+glyphosate; compound of the formula A+clomazone+glyphosate; compound of the formula A+nicosulfuron+glyphosate; compound of the formula A+rimsulfuron+glyphosate; compound of the formula A+halosulfuron+glyphosate; compound of the formula A+metribuzin+glyphosate; compound of the formula A+flumiclorac+glyphosate; compound of the formula A+prosulfuron+glyphosate; compound of the formula A+primisulfuron+glyphosate; compound of the formula A+dicamba+glyphosate; compound of the formula A+fluthiacet+glyphosate; compound of the formula A+pyridate+glyphosate; compound of the formula A+compound of the formula B+glyphosate; compound of the formula A+2,4-D+glyphosate; compound of the formula A+clopyralide+glyphosate; compound of the formula A+diflufenzopyr+glyphosate; compound of the formula A+fluroxypyr+glyphosate; compound of the formula A+MCPA+glyphosate; compound of the formula A+MCPB+glyphosate; compound of the formula A+MCPP+glyphosate; compound of the formula A +metobenzuron+glyphosate; compound of the formula A+thifensulfuron+glyphosate; compound of the formula A+aclonifen+glyphosate; compound of the formula A+EPTC+glyphosate; compound of the formula A+cyanazine+glyphosate; cinidon-ethyl+atrazin+glyphosate; cinidon-ethyl+terbuthylazine+glyphosate; cinidon-ethyl+(S)-metolachlor+glyphosate; cinidon-ethyl+metolachlor+glyphosate; cinidon-ethyl+compound of the formula A+glyphosate; cinidon-ethyl+terbutryn+glyphosate; cinidon-ethyl+simazine+glyphosate; cinidon-ethyl+dimethenamid or (S)-dimethenamid+glyphosate; cinidon-ethyl +flufenacet+glyphosate; cinidon-ethyl+acetochlor+glyphosate; cinidon-ethyl+alachlor +glyphosate; cinidon-ethyl+isoxaflutole+glyphosate; cinidon-ethyl+isoxachlortole+glyphosate; cinidon-ethyl+mesotrione+glyphosate; cinidon-ethyl+sulcotrione+glyphosate; cinidon-ethyl+metosulam+glyphosate; cinidon-ethyl+flumetsulam+glyphosate; cinidon-ethyl+pendimethalin+glyphosate; cinidon-ethyl+bromoxynil+glyphosate; cinidon-ethyl+bentazone+glyphosate; cinidon-ethyl+carfentrazone+glyphosate; cinidon-ethyl+clomazone+glyphosate; cinidon-ethyl+nicosulfuron+glyphosate; cinidon-ethyl+rimsulfuron+glyphosate; cinidon-ethyl+halosulfuron+glyphosate; cinidon-ethyl+metribuzin+glyphosate; cinidon-ethyl+flumiclorac+glyphosate; cinidon-ethyl+prosulfuron+glyphosate; cinidon-ethyl+primisulfuron+glyphosate; cinidon-ethyl+dicamba+glyphosate; cinidon-ethyl+fluthiacet+glyphosate; cinidon-ethyl+pyridate+glyphosate; cinidon-ethyl+compound of the formula B+glyphosate; cinidon-ethyl+2,4-D+glyphosate; cinidon-ethyl+clopyralide+glyphosate; cinidon-ethyl+diflufenzopyr+glyphosate; cinidon-ethyl+fluroxypyr+glyphosate; cinidon-ethyl+MCPA+glyphosate; cinidon-ethyl+MCPB+glyphosate; cinidon-ethyl+MCPP+glyphosate; cinidon-ethyl+metobenzuron+glyphosate; cinidon-ethyl+thifensulfuron+glyphosate; cinidon-ethyl+aclonifen+glyphosate; cinidon-ethyl+EPTC+glyphosate; cinidon-ethyl+cyanazine+glyphosate; flumiclorac-pentyl+atrazin+glyphosate; flumiclorac-pentyl+terbuthylazine+glyphosate; flumiclorac-pentyl+(S)-metolachlor+glyphosate; flumiclorac-pentyl+metolachlor+glyphosate; flumiclorac-pentyl+compound of the formula A+glyphosate; flumiclorac-pentyl+terbutryn+glyphosate; flumiclorac-pentyl+simazine+glyphosate; flumiclorac-pentyl+dimethenamid or (S)-dimethenamid+glyphosate; flumiclorac-pentyl+flufenacet+glyphosate; flumiclorac-pentyl+acetochlor+glyphosate; flumiclorac-pentyl+alachlor+glyphosate; flumiclorac-pentyl+isoxaflutole+glyphosate; flumiclorac-pentyl+isoxachlortole+glyphosate; flumiclorac-pentyl+mesotrione+glyphosate; flumiclorac-pentyl+sulcotrione+glyphosate; flumiclorac-pentyl+metosulam+glyphosate; flumiclorac-pentyl+flumetsulam+glyphosate; flumiclorac-pentyl +pendimethalin+glyphosate; flumiclorac-pentyl+bromoxynil+glyphosate; flumiclorac-pentyl+bentazone+glyphosate; flumiclorac-pentyl+carfentrazone+glyphosate; flumiclorac-pentyl+clomazone+glyphosate; flumiclorac-pentyl+nicosulfuron+glyphosate; flumiclorac-pentyl+rimsulfuron+glyphosate; flumiclorac-pentyl+halosulfuron +glyphosate; flumiclorac-pentyl+metribuzin+glyphosate; flumiclorac-pentyl+prosulfuron +glyphosate; flumiclorac-pentyl+primisulfuron+glyphosate; flumiclorac-pentyl+dicamba +glyphosate; flumiclorac-pentyl+fluthiacet+glyphosate; flumiclorac-pentyl+pyridate+glyphosate; flumiclorac-pentyl+compound of the formula B+glyphosate; flumiclorac-pentyl +2,4-D+glyphosate; flumiclorac-pentyl+clopyralide+glyphosate; flumiclorac-pentyl+diflufenzopyr+glyphosate; flumiclorac-pentyl+fluroxypyr+glyphosate; flumiclorac-pentyl+MCPA+glyphosate; flumiclorac-pentyl+MCPB+glyphosate; flumiclorac-pentyl+MCPP+glyphosate; flumiclorac-pentyl+metobenzuron+glyphosate; flumiclorac-pentyl+thifensulfuron+glyphosate; flumiclorac-pentyl+aclonifen+glyphosate; flumiclorac-pentyl+EPTC+glyphosate; flumiclorac-pentyl+cyanazine+glyphosate; flumioxazin+atrazin+glyphosate; flumioxazin+terbuthylazine+glyphosate; flumioxazin+(S)-metolachlor+glyphosate; flumioxazin+metolachlor+glyphosate; flumioxazin+compound of the formula A+glyphosate; flumioxazin+terbutryn+glyphosate; flumioxazin+simazine+glyphosate;. flumioxazin+dimethenamid or (S)-dimethenamid+glyphosate; flumioxazin+flufenacet+glyphosate; flumioxazin+acetochlor+glyphosate; flumioxazin+alachlor+glyphosate; flumioxazin+isoxaflutole+glyphosate; flumioxazin+isoxachlortole+glyphosate; flumioxazin+mesotrione+glyphosate; flumioxazin+sulcotrione+glyphosate; flumioxazin +metosulam+glyphosate; flumioxazin+flumetsulam+glyphosate; flumioxazin+pendimethalin+glyphosate; flumioxazin+bromoxynil+glyphosate; flumioxazin+bentazone+glyphosate; flumioxazin+carfentrazone+glyphosate; flumioxazin+clomazone+glyphosate; flumioxazin+nicosulfuron+glyphosate; flumioxazin+rimsulfuron +glyphosate; flumioxazin+halosulfuron+glyphosate; flumioxazin+metribuzin+glyphosate; flumioxazin+flumiclorac+glyphosate; flumioxazin+prosulfuron+glyphosate; flumioxazin+primisulfuron+glyphosate; flumioxazin+dicamba+glyphosate; flumioxazin+fluthiacet+glyphosate; flumioxazin+pyridate+glyphosate; flumioxazin+compound of the formula B+glyphosate; flumioxazin+2,4-D+glyphosate; flumioxazin+clopyralide+glyphosate; flumioxazin+diflufenzopyr+glyphosate; flumioxazin+fluroxypyr+glyphosate; flumioxazin+MCPA+glyphosate; flumioxazin+MCPB+glyphosate; flumioxazin+MCPP +glyphosate; flumioxazin+metobenzuron+glyphosate; flumioxazin+thifensulfuron+glyphosate; flumioxazin+aclonifen+glyphosate; flumioxazin+EPTC+glyphosate; flumioxazin+cyanazine+glyphosate; fluthiacet-methyl+atrazin+glyphosate; fluthiacet-methyl+terbuthylazine+glyphosate; fluthiacet-methyl+(S)-metolachlor+glyphosate; fluthiacet-methyl+metolachlor+glyphosate; fluthiacet-methyl+compound of the formula A +glyphosate; fluthiacet-methyl+terbutryn+glyphosate; fluthiacet-methyl+simazine+glyphosate; fluthiacet-methyl+dimethenamid or (S)-dimethenamid+glyphosate; fluthiacet-methyl+flufenacet+glyphosate; fluthiacet-methyl+acetochlor+glyphosate; fluthiacet-methyl+alachlor+glyphosate; fluthiacet-methyl+isoxaflutole+glyphosate; fluthiacet-methyl+isoxachlortole+glyphosate; fluthiacet-methyl+mesotrione+glyphosate; fluthiacet-methyl+sulcotrione+glyphosate; fluthiacet-methyl+metosulam+glyphosate; fluthiacet-methyl+flumetsulam+glyphosate; fluthiacet-methyl+pendimethalin+glyphosate; fluthiacet-methyl+bromoxynil+glyphosate; fluthiacet-methyl+bentazone+glyphosate; fluthiacet-methyl+carfentrazone+glyphosate; fluthiacet-methyl+clomazone+glyphosate; fluthiacet-methyl+nicosulfuron+glyphosate; fluthiacet-methyl+rimsulfuron+glyphosate; fluthiacet-methyl+halosulfuron+glyphosate; fluthiacet-methyl+metribuzin+glyphosate; fluthiacet-methyl+flumiclorac+glyphosate; fluthiacet-methyl+prosulfuron+glyphosate; fluthiacet-methyl+primisulfuron+glyphosate; fluthiacet-methyl+dicamba+glyphosate; fluthiacet-methyl+pyridate+glyphosate; fluthiacet-methyl+compound of the formula B+glyphosate; fluthiacet-methyl+2,4-D+glyphosate; fluthiacet-methyl+clopyralide+glyphosate; fluthiacet-methyl+diflufenzopyr+glyphosate; fluthiacet-methyl+fluroxypyr+glyphosate; fluthiacet-methyl+MCPA+glyphosate; fluthiacet-methyl+MCPB +glyphosate; fluthiacet-methyl+MCPP+glyphosate; fluthiacet-methyl+metobenzuron+glyphosate; fluthiacet-methyl+thifensulfuron+glyphosate; fluthiacet-methyl+aclonifen+glyphosate; fluthiacet-methyl+EPTC+glyphosate; fluthiacet-methyl+cyanazine+glyphosate; oxadiargyl+atrazin+glyphosate; oxadiargyl+terbuthylazine+glyphosate; oxadiargyl+(S)-metolachlor+glyphosate; oxadiargyl+metolachlor+glyphosate; oxadiargyl+compound of the formula A+glyphosate; oxadiargyl+terbutryn+glyphosate; oxadiargyl+simazine+glyphosate; oxadiargyl+dimethenamid or (S)-dimethenamid+glyphosate; oxadiargyl+flufenacet+glyphosate; oxadiargyl+acetochlor+glyphosate; oxadiargyl+alachlor+glyphosate; oxadiargyl+isoxaflutole+glyphosate; oxadiargyl+isoxachlortole+glyphosate; oxadiargyl+mesotrione+glyphosate; oxadiargyl+sulcotrione +glyphosate; oxadiargyl+metosulam+glyphosate; oxadiargyl+flumetsulam+glyphosate; oxadiargyl+pendimethalin+glyphosate; oxadiargyl+bromoxynil+glyphosate; oxadiargyl +bentazone+glyphosate; oxadiargyl+carfentrazone+glyphosate; oxadiargyl+clomazone+glyphosate; oxadiargyl+nicosulfuron+glyphosate; oxadiargyl+rimsulfuron+glyphosate; oxadiargyl+halosulfuron+glyphosate; oxadiargyl+metribuzin+glyphosate; oxadiargyl+flumiclorac+glyphosate; oxadiargyl+prosulfuron+glyphosate; oxadiargyl+primisulfuron+glyphosate; oxadiargyl+dicamba+glyphosate; oxadiargyl+fluthiacet+glyphosate; oxadiargyl+pyridate+glyphosate; oxadiargyl+compound of the formula B+glyphosate; oxadiargyl+2,4-D+glyphosate; oxadiargyl+clopyralide+glyphosate; oxadiargyl+diflufenzopyr+glyphosate; oxadiargyl+fluroxypyr+glyphosate; oxadiargyl+MCPA+glyphosate; oxadiargyl+MCPB+glyphosate; oxadiargyl+MCPP+glyphosate; oxadiargyl+metobenzuron+glyphosate; oxadiargyl+thifensulfuron+glyphosate; oxadiargyl+aclonifen+glyphosate; oxadiargyl+EPTC+glyphosate; oxadiargyl+cyanazine+glyphosate; oxadiazon+atrazin+glyphosate; oxadiazon+terbuthylazine+glyphosate; oxadiazon+(S)-metolachlor+glyphosate; oxadiazon+metolachlor+glyphosate; oxadiazon+compound of the formula A+glyphosate; oxadiazon+terbutryn+glyphosate; oxadiazon+simazine+glyphosate; oxadiazon+dimethenamid or (S)-dimethenamid+glyphosate; oxadiazon+flufenacet+glyphosate; oxadiazon+acetochlor+glyphosate; oxadiazon+alachlor+glyphosate; oxadiazon+isoxaflutole+glyphosate; oxadiazon+isoxachlortole+glyphosate; oxadiazon+mesotrione+glyphosate; oxadiazon +sulcotrione+glyphosate; oxadiazon+metosulam+glyphosate; oxadiazon+flumetsulam +glyphosate; oxadiazon+pendimethalin+glyphosate; oxadiazon+bromoxynil+glyphosate; oxadiazon+bentazone+glyphosate; oxadiazon+carfentrazone+glyphosate; oxadiazon+clomazone+glyphosate; oxadiazon+nicosulfuron+glyphosate; oxadiazon+rimsulfuron+glyphosate; oxadiazon+halosulfuron+glyphosate; oxadiazon+metribuzin+glyphosate; oxadiazon+flumiclorac+glyphosate; oxadiazon+prosulfuron+glyphosate; oxadiazon+primisulfuron+glyphosate; oxadiazon+dicamba+glyphosate; oxadiazon+fluthiacet+glyphosate; oxadiazon+pyridate+glyphosate; oxadiazon+compound of the formula B+glyphosate; oxadiazon+2,4-D+glyphosate; oxadiazon+clopyralide+glyphosate; oxadiazon+diflufenzopyr+glyphosate; oxadiazon+fluroxypyr+glyphosate; oxadiazon+MCPA+glyphosate; oxadiazon+MCPB+glyphosate; oxadiazon+MCPP+glyphosate; oxadiazon+metobenzuron+glyphosate; oxadiazon+thifensulfuron+glyphosate; oxadiazon+aclonifen+glyphosate; oxadiazon+EPTC+glyphosate; oxadiazon+cyanazine+glyphosate; pentoxazone+atrazin+glyphosate; pentoxazone+terbuthylazine+glyphosate; pentoxazone+(S)-metolachlor+glyphosate; pentoxazone+metolachlor+glyphosate; pentoxazone+compound of the formula A+glyphosate; pentoxazone+terbutryn+glyphosate; pentoxazone+simazine+glyphosate; pentoxazone+dimethenamid or (S)-dimethenamid+glyphosate; pentoxazone+flufenacet+glyphosate; pentoxazone+acetochlor+glyphosate; pentoxazone+alachlor +glyphosate; pentoxazone+isoxaflutole+glyphosate; pentoxazone+isoxachlortole+glyphosate; pentoxazone+mesotrione+glyphosate; pentoxazone+sulcotrione+glyphosate; pentoxazone+metosulam+glyphosate; pentoxazone+flumetsulam+glyphosate; pentoxazone+pendimethalin+glyphosate; pentoxazone+bromoxynil+glyphosate; pentoxazone+bentazone+glyphosate; pentoxazone+carfentrazone+glyphosate; pentoxazone+clomazone+glyphosate; pentoxazone+nicosulfuron+glyphosate; pentoxazone+rimsulfuron+glyphosate; pentoxazone+halosulfuron+glyphosate; pentoxazone+metribuzin+glyphosate; pentoxazone+flumiclorac+glyphosate; pentoxazone+prosulfuron+glyphosate; pentoxazone+primisulfuron+glyphosate; pentoxazone+dicamba+glyphosate; pentoxazone+fluthiacet+glyphosate; pentoxazone+pyridate+glyphosate; pentoxazone+compound of the formula B+glyphosate; pentoxazone+2,4-D+glyphosate; pentoxazone+clopyralide+glyphosate; pentoxazone+diflufenzopyr+glyphosate; pentoxazone+fluroxypyr+glyphosate; pentoxazone+MCPA+glyphosate; pentoxazone+MCPB+glyphosate; pentoxazone+MCPP+glyphosate; pentoxazone+metobenzuron+glyphosate; pentoxazone+thifensulfuron+glyphosate; pentoxazone+aclonifen+glyphosate; pentoxazone+EPTC +glyphosate; pentoxazone+cyanazine+glyphosate; sulfentrazone+atrazin+glyphosate; sulfentrazone+terbuthylazine+glyphosate; sulfentrazone+(S)-metolachlor+glyphosate; sulfentrazone+metolachlor+glyphosate; sulfentrazone+compound of the formula A+glyphosate; sulfentrazone+terbutryn+glyphosate; sulfentrazone+simazine+glyphosate; sulfentrazone+dimethenamid or (S)-dimethenamid+glyphosate; sulfentrazone+flufenacet+glyphosate; sulfentrazone+acetochlor+glyphosate; sulfentrazone+alachlor+glyphosate; sulfentrazone+isoxaflutole+glyphosate; sulfentrazone+isoxachlortole+glyphosate; sulfentrazone+mesotrione+glyphosate; sulfentrazone+sulcotrione+glyphosate; sulfentrazone+metosulam+glyphosate; sulfentrazone+flumetsulam+glyphosate; sulfentrazone+pendimethalin+glyphosate; sulfentrazone+bromoxynil+glyphosate; sulfentrazone+bentazone+glyphosate; sulfentrazone+carfentrazone+glyphosate; sulfentrazone+clomazone+glyphosate; sulfentrazone+nicosulfuron+glyphosate; sulfentrazone+rimsulfuron+glyphosate; sulfentrazone+halosulfuron+glyphosate; sulfentrazone+metribuzin+glyphosate; sulfentrazone+flumiclorac+glyphosate; sulfentrazone+prosulfuron+glyphosate; sulfentrazone+primisulfuron+glyphosate; sulfentrazone+dicamba+glyphosate; sulfentrazone+fluthiacet+glyphosate; sulfentrazone+pyridate+glyphosate; sulfentrazone+compound of the formula B+glyphosate; sulfentrazone+2,4-D+glyphosate; sulfentrazone+clopyralide+glyphosate; sulfentrazone+diflufenzopyr+glyphosate; sulfentrazone+fluroxypyr+glyphosate; sulfentrazone+MCPA+glyphosate; sulfentrazone+MCPB+glyphosate; sulfentrazone+MCPP+glyphosate; sulfentrazone+metobenzuron+glyphosate; sulfentrazone+thifensulfuron+glyphosate; sulfentrazone+aclonifen+glyphosate; sulfentrazone+EPTC+glyphosate; sulfentrazone+cyanazine+glyphosate; fluazolate+atrazin+glyphosate; fluazolate+terbuthylazine+glyphosate; fluazolate+(S)-metolachlor+glyphosate; fluazolate+metolachlor+glyphosate; fluazolate+compound of the formula A+glyphosate; fluazolate+terbutryn+glyphosate; fluazolate+simazine+glyphosate; fluazolate+dimethenamid or (S)-dimethenamid+glyphosate; fluazolate+flufenacet+glyphosate; fluazolate+acetochlor+glyphosate; fluazolate+alachlor+glyphosate; fluazolate+isoxaflutole+glyphosate; fluazolate+isoxachlortole+glyphosate; fluazolate+mesotrione+glyphosate; fluazolate+sulcotrione +glyphosate; fluazolate+metosulam+glyphosate; fluazolate+flumetsulam+glyphosate; fluazolate+pendimethalin+glyphosate; fluazolate+bromoxynil+glyphosate; fluazolate+bentazone+glyphosate; fluazolate+carfentrazone+glyphosate; fluazolate +clomazone+glyphosate; fluazolate+nicosulfuron+glyphosate; fluazolate+rimsulfuron +glyphosate; fluazolate+halosulfuron+glyphosate; fluazolate+metribuzin+glyphosate; fluazolate+flumiclorac+glyphosate; fluazolate+prosulfuron+glyphosate; fluazolate+primisulfuron+glyphosate; fluazolate+dicamba+glyphosate; fluazolate+fluthiacet+glyphosate; fluazolate+pyridate+glyphosate; fluazolate+compound of the formula B+glyphosate; fluazolate+2,4-D+glyphosate; fluazolate+clopyralide+glyphosate; fluazolate+diflufenzopyr+glyphosate; fluazolate+fluroxypyr+glyphosate; fluazolate+MCPA+glyphosate; fluazolate+MCPB+glyphosate; fluazolate+MCPP+glyphosate; fluazolate+metobenzuron+glyphosate; fluazolate+thifensulfuron+glyphosate; fluazolate+aclonifen+glyphosate; fluazolate+EPTC+glyphosate; fluazolate+cyanazine+glyphosate; pyraflufen-ethyl+atrazin+glyphosate; pyraflufen-ethyl+terbuthylazine+glyphosate; pyraflufen-ethyl+(S)-metolachlor+glyphosate; pyraflufen-ethyl+metolachlor+glyphosate; pyraflufen-ethyl+compound of the formula A+glyphosate; pyraflufen-ethyl+terbutryn+glyphosate; pyraflufen-ethyl+simazine+glyphosate; pyraflufen-ethyl+dimethenamid or (S)-dimethenamid+glyphosate; pyraflufen-ethyl+flufenacet+glyphosate; pyraflufen-ethyl+acetochlor+glyphosate; pyraflufen-ethyl+alachlor+glyphosate; pyraflufen-ethyl+isoxaflutole+glyphosate; pyraflufen-ethyl +isoxachlortole+glyphosate; pyraflufen-ethyl+mesotrione+glyphosate; pyraflufen-ethyl +sulcotrione+glyphosate; pyraflufen-ethyl+metosulam+glyphosate; pyraflufen-ethyl+flumetsulam+glyphosate; pyraflufen-ethyl+pendimethalin+glyphosate; pyraflufen-ethyl +bromoxynil+glyphosate; pyraflufen-ethyl+bentazone+glyphosate; pyraflufen-ethyl+carfentrazone+glyphosate; pyraflufen-ethyl+clomazone+glyphosate; pyraflufen-ethyl+nicosulfuron+glyphosate; pyraflufen-ethyl+rimsulfuron+glyphosate; pyraflufen-ethyl+halosulfuron+glyphosate; pyraflufen-ethyl+metribuzin+glyphosate; pyraflufen-ethyl+flumiclorac+glyphosate; pyraflufen-ethyl+prosulfuron+glyphosate; pyraflufen-ethyl+primisulfuron+glyphosate; pyraflufen-ethyl+dicamba+glyphosate; pyraflufen-ethyl+fluthiacet+glyphosate; pyraflufen-ethyl+pyridate+glyphosate; pyraflufen-ethyl+compound of the formula B+glyphosate; pyraflufen-ethyl+2,4-D+glyphosate; pyraflufen-ethyl+clopyralide+glyphosate; pyraflufen-ethyl+diflufenzopyr+glyphosate; pyraflufen-ethyl+fluroxypyr+glyphosate; pyraflufen-ethyl+MCPA+glyphosate; pyraflufen-ethyl+MCPB+glyphosate; pyraflufen-ethyl+MCPP+glyphosate; pyraflufen-ethyl+metobenzuron+glyphosate; pyraflufen-ethyl+thifensulfuron+glyphosate; pyraflufen-ethyl +aclonifen+glyphosate; pyraflufen-ethyl+EPTC+glyphosate; pyraflufen-ethyl+cyanazine+glyphosate; flumipropyn+atrazin+glyphosate; flumipropyn+terbuthylazine+glyphosate; flumipropyn+(S)-metolachlor+glyphosate; flumipropyn+metolachlor+glyphosate; flumipropyn+compound of the formula A+glyphosate; flumipropyn+terbutryn +glyphosate; flumipropyn+simazine+glyphosate; flumipropyn+dimethenamid or (S)-dimethenamid+glyphosate; flumipropyn+flufenacet+glyphosate; flumipropyn+acetochlor+glyphosate; flumipropyn+alachlor+glyphosate; flumipropyn+isoxaflutole+glyphosate; flumipropyn+isoxachlortole+glyphosate; flumipropyn+mesotrione+glyphosate; flumipropyn+sulcotrione+glyphosate; flumipropyn+metosulam+glyphosate; flumipropyn+flumetsulam+glyphosate; flumipropyn+pendimethalin+glyphosate; flumipropyn+bromoxynil+glyphosate; flumipropyn+bentazone+glyphosate; flumipropyn +carfentrazone+glyphosate; flumipropyn+clomazone+glyphosate; flumipropyn+nicosulfuron+glyphosate; flumipropyn+rimsulfuron+glyphosate; flumipropyn+halosulfuron+glyphosate; flumipropyn+metribuzin+glyphosate; flumipropyn+flumiclorac +glyphosate; flumipropyn+prosulfuron+glyphosate; flumipropyn+primisulfuron+glyphosate; flumipropyn+dicamba+glyphosate; flumipropyn+fluthiacet+glyphosate; flumipropyn+pyridate+glyphosate; flumipropyn+compound of the formula B+glyphosate; flumipropyn+2,4-D+glyphosate; flumipropyn+clopyralide+glyphosate; flumipropyn+diflufenzopyr+glyphosate; flumipropyn+fluroxypyr+glyphosate; flumipropyn+MCPA+glyphosate; flumipropyn+MCPB+glyphosate; flumipropyn+MCPP +glyphosate; flumipropyn+metobenzuron+glyphosate; flumipropyn+thifensulfuron+glyphosate; flumipropyn+aclonifen+glyphosate; flumipropyn+EPTC+glyphosate; flumipropyn+cyanazine+glyphosate; flupropacil+atrazin+glyphosate; flupropacil+terbuthylazine+glyphosate; flupropacil+(S)-metolachlor+glyphosate; flupropacil+metolachlor+glyphosate; flupropacil+compound of the formula A+glyphosate; flupropacil +terbutryn+glyphosate; flupropacil+simazine+glyphosate; flupropacil+dimethenamid or (S)-dimethenamid+glyphosate; flupropacil+flufenacet+glyphosate; flupropacil+acetochlor+glyphosate; flupropacil+alachlor+glyphosate; flupropacil+isoxaflutole+glyphosate; flupropacil+isoxachlortole+glyphosate; flupropacil+mesotrione+glyphosate; flupropacil+sulcotrione+glyphosate; flupropacil+metosulam+glyphosate; flupropacil+flumetsulam+glyphosate; flupropacil+pendimethalin+glyphosate; flupropacil+bromoxynil+glyphosate; flupropacil+bentazone+glyphosate; flupropacil+carfentrazone +glyphosate; flupropacil+clomazone+glyphosate; flupropacil+nicosulfuron+glyphosate; flupropacil+rimsulfuron+glyphosate; flupropacil+halosulfuron+glyphosate; flupropacil+metribuzin+glyphosate; flupropacil+flumiclorac+glyphosate; flupropacil+prosulfuron+glyphosate; flupropacil+primisulfuron+glyphosate; flupropacil+dicamba+glyphosate; flupropacil+fluthiacet+glyphosate; flupropacil+pyridate+glyphosate; flupropacil+compound of the formula B+glyphosate; flupropacil+2,4-D+glyphosate; flupropacil+clopyralide+glyphosate; flupropacil+diflufenzopyr+glyphosate; flupropacil+fluroxypyr+glyphosate; flupropacil+MCPA+glyphosate; flupropacil+MCPB+glyphosate; flupropacil+MCPP+glyphosate; flupropacil+metobenzuron+glyphosate; flupropacil+thifensulfuron+glyphosate; flupropacil+aclonifen+glyphosate; flupropacil+EPTC+glyphosate; flupropacil+cyanazine+glyphosate; nipyraclofen+atrazin+glyphosate; nipyraclofen+terbuthylazine+glyphosate; nipyraclofen+(S)-metolachlor+glyphosate; nipyraclofen+metolachlor+glyphosate; nipyraclofen+compound of the formula A+glyphosate; nipyraclofen+terbutryn+glyphosate; nipyraclofen+simazine+glyphosate; nipyraclofen+dimethenamid or (S)-dimethenamid+glyphosate; nipyraclofen+flufenacet+glyphosate; nipyraclofen+acetochlor+glyphosate; nipyraclofen+alachlor+glyphosate; nipyraclofen+isoxaflutole+glyphosate; nipyraclofen+isoxachlortole+glyphosate; nipyraclofen+mesotrione+glyphosate; nipyraclofen+sulcotrione+glyphosate; nipyraclofen+metosulam+glyphosate; nipyraclofen+flumetsulam+glyphosate; nipyraclofen+pendimethalin+glyphosate; nipyraclofen+bromoxynil+glyphosate; nipyraclofen+bentazone+glyphosate; nipyraclofen+carfentrazone+glyphosate; nipyraclofen+clomazone+glyphosate; nipyraclofen+nicosulfuron+glyphosate; nipyraclofen+rimsulfuron+glyphosate; nipyraclofen+halosulfuron+glyphosate; nipyraclofen+metribuzin+glyphosate; nipyraclofen+flumiclorac+glyphosate; nipyraclofen+prosulfuron+glyphosate; nipyraclofen+primisulfuron+glyphosate; nipyraclofen+dicamba+glyphosate; nipyraclofen+fluthiacet+glyphosate; nipyraclofen+pyridate+glyphosate; nipyraclofen+compound of the formula B+glyphosate; nipyraclofen +2,4-D+glyphosate; nipyraclofen+clopyralide+glyphosate; nipyraclofen+diflufenzopyr +glyphosate; nipyraclofen+fluroxypyr+glyphosate; nipyraclofen+MCPA+glyphosate; nipyraclofen+MCPB+glyphosate; nipyraclofen+MCPP+glyphosate; nipyraclofen+metobenzuron+glyphosate; nipyraclofen+thifensulfuron+glyphosate; nipyraclofen+aclonifen+glyphosate; nipyraclofen+EPTC+glyphosate; nipyraclofen+cyanazine+glyphosate; benzfendizone+atrazin+glyphosate; benzfendizone+terbuthylazine+glyphosate; benzfendizone+(S)-metolachlor+glyphosate; benzfendizone+metolachlor+glyphosate; benzfendizone+compound of the formula A+glyphosate; benzfendizone+terbutryn+glyphosate; benzfendizone+simazine+glyphosate; benzfendizone+dimethenamid or (S)-dimethenamid+glyphosate; benzfendizone+flufenacet+glyphosate; benzfendizone+acetochlor+glyphosate; benzfendizone+alachlor+glyphosate; benzfendizone+isoxaflutole+glyphosate; benzfendizone+isoxachlortole+glyphosate; benzfendizone+mesotrione+glyphosate; benzfendizone+sulcotrione+glyphosate; benzfendizone+metosulam+glyphosate; benzfendizone+flumetsulam+glyphosate; benzfendizone+pendimethalin+glyphosate; benzfendizone+bromoxynil+glyphosate; benzfendizone+bentazone+glyphosate; benzfendizone+carfentrazone+glyphosate; benzfendizone+clomazone+glyphosate; benzfendizone+nicosulfuron+glyphosate; benzfendizone+rimsulfuron+glyphosate; benzfendizone+halosulfuron+glyphosate; benzfendizone+metribuzin+glyphosate; benzfendizone+flumiclorac+glyphosate; benzfendizone+prosulfuron+glyphosate; benzfendizone+primisulfuron+glyphosate; benzfendizone+dicamba+glyphosate; benzfendizone+fluthiacet+glyphosate; benzfendizone+pyridate+glyphosate; benzfendizone+compound of the formula B+glyphosate; benzfendizone+2,4-D+glyphosate; benzfendizone+clopyralide+glyphosate; benzfendizone+diflufenzopyr+glyphosate; benzfendizone+fluroxypyr+glyphosate; benzfendizone+MCPA+glyphosate; benzfendizone+MCPB+glyphosate; benzfendizone+MCPP+glyphosate; benzfendizone+metobenzuron+glyphosate; benzfendizone+thifensulfuron+glyphosate; benzfendizone+aclonifen+glyphosate; benzfendizone+EPTC+glyphosate; benzfendizone+cyanazine+glyphosate; thidiazimin +atrazin+glyphosate; thidiazimin+terbuthylazine+glyphosate; thidiazimin+(S)-metolachlor+glyphosate; thidiazimin+metolachlor+glyphosate; thidiazimin+compound of the formula A+glyphosate; thidiazimin+terbutryn+glyphosate; thidiazimin+simazine+glyphosate; thidiazimin+dimethenamid or (S)-dimethenamid+glyphosate; thidiazimin+flufenacet+glyphosate; thidiazimin+acetochlor+glyphosate; thidiazimin+alachlor+glyphosate; thidiazimin+isoxaflutole+glyphosate; thidiazimin+isoxachlortole+glyphosate; thidiazimin+mesotrione+glyphosate; thidiazimin+sulcotrione+glyphosate; thidiazimin+metosulam+glyphosate; thidiazimin+flumetsulam+glyphosate; thidiazimin+pendimethalin+glyphosate; thidiazimin+bromoxynil+glyphosate; thidiazimin+bentazone +glyphosate; thidiazimin+carfentrazone+glyphosate; thidiazimin+clomazone+glyphosate; thidiazimin+nicosulfuron+glyphosate; thidiazimin+rimsulfuron+glyphosate; thidiazimin+halosulfuron+glyphosate; thidiazimin+metribuzin+glyphosate; thidiazimin+flumiclorac+glyphosate; thidiazimin+prosulfuron+glyphosate; thidiazimin+primisulfuron +glyphosate; thidiazimin+dicamba+glyphosate; thidiazimin+fluthiacet+glyphosate; thidiazimin+pyridate+glyphosate; thidiazimin+compound of the formula B+glyphosate; thidiazimin+2,4-D+glyphosate; thidiazimin+clopyralide+glyphosate; thidiazimin+diflufenzopyr+glyphosate; thidiazimin+fluroxypyr+glyphosate; thidiazimin+MCPA+glyphosate; thidiazimin+MCPB+glyphosate; thidiazimin+MCPP+glyphosate; thidiazimin +metobenzuron+glyphosate; thidiazimin+thifensulfuron+glyphosate; thidiazimin+aclonifen+glyphosate; thidiazimin+EPTC+glyphosate; and thidiazimin+cyanazine+glyphosate.

acifluorfen+atrazin+glufosinate; acifluorfen+terbuthylazine+glufosinate; acifluorfen+(S)-metolachlor+glufosinate; acifluorfen+metolachlor+glufosinate; acifluorfen+compound of the formula A+glufosinate; acifluorfen+terbutryn+glufosinate; acifluorfen+simazine+glufosinate; acifluorfen+dimethenamid or (S)-dimethenamid+glufosinate; acifluorfen+flufenacet+glufosinate; acifluorfen+acetochlor+glufosinate; acifluorfen+alachlor+glufosinate; acifluorfen+isoxaflutole+glufosinate; acifluorfen+isoxachlortole+glufosinate; acifluorfen+mesotrione+glufosinate; acifluorfen+sulcotrione+glufosinate; acifluorfen+metosulam+glufosinate; acifluorfen+flumetsulam+glufosinate; acifluorfen+pendimethalin+glufosinate; acifluorfen+bromoxynil+glufosinate; acifluorfen+bentazone +glufosinate; acifluorfen+carfentrazone+glufosinate; acifluorfen+clomazone+glufosinate; acifluorfen+nicosulfuron+glufosinate; acifluorfen+rimsulfuron+glufosinate; acifluorfen+halosulfuron+glufosinate; acifluorfen+metribuzin+glufosinate; acifluorfen+flumiclorac+glufosinate; acifluorfen+prosulfuron+glufosinate; acifluorfen+primisulfuron +glufosinate; acifluorfen+dicamba+glufosinate; acifluorfen+fluthiacet+glufosinate; acifluorfen+pyridate+glufosinate; acifluorfen+compound of the formula B+glufosinate; acifluorfen+2,4-D+glufosinate; acifluorfen+clopyralide+glufosinate; acifluorfen+diflufenzopyr+glufosinate; acifluorfen+fluroxypyr+glufosinate; acifluorfen+MCPA+glufosinate; acifluorfen+MCPB+glufosinate; acifluorfen+MCPP+glufosinate; acifluorfen +metobenzuron+glufosinate; acifluorfen+thifensulfuron+glufosinate; acifluorfen+aclonifen+glufosinate; acifluorfen+EPTC+glufosinate; acifluorfen+cyanazine+glufosinate; aclonifen+atrazin+glufosinate; aclonifen+terbuthylazine+glufosinate; aclonifen+(S)-metolachlor+glufosinate; aclonifen+metolachlor+glufosinate; aclonifen+compound of the formula A+glufosinate; aclonifen+terbutryn+glufosinate; aclonifen+simazine+glufosinate; aclonifen+dimethenamid or (S)-dimethenamid+glufosinate; aclonifen+flufenacet+glufosinate; aclonifen+acetochlor+glufosinate; aclonifen+alachlor+glufosinate; aclonifen+isoxaflutole+glufosinate; aclonifen+isoxachlortole+glufosinate; aclonifen+mesotrione+glufosinate; aclonifen+sulcotrione+glufosinate; aclonifen+metosulam+glufosinate; aclonifen+flumetsulam+glufosinate; aclonifen+pendimethalin+glufosinate; aclonifen+bromoxynil+glufosinate; aclonifen+bentazone+glufosinate; aclonifen+carfentrazone+glufosinate; aclonifen+clomazone+glufosinate; aclonifen+nicosulfuron+glufosinate; aclonifen+rimsulfuron+glufosinate; aclonifen+halosulfuron+glufosinate; aclonifen+metribuzin+glufosinate; aclonifen+flumiclorac+glufosinate; aclonifen+prosulfuron+glufosinate; aclonifen+primisulfuron+glufosinate; aclonifen+dicamba+glufosinate; aclonifen+fluthiacet+glufosinate; aclonifen+pyridate +glufosinate; aclonifen+compound of the formula B+glufosinate; aclonifen+2,4-D+glufosinate; aclonifen+clopyralide+glufosinate; aclonifen+diflufenzopyr+glufosinate; aclonifen+fluroxypyr+glufosinate; aclonifen+MCPA+glufosinate; aclonifen+MCPB+glufosinate; aclonifen+MCPP+glufosinate; aclonifen+metobenzuron+glufosinate; aclonifen+thifensulfuron+glufosinate; aclonifen+EPTC+glufosinate; aclonifen+cyanazine+glufosinate; bifenox+atrazin+glufosinate; bifenox+terbuthylazine+glufosinate; bifenox+(S)-metolachlor+glufosinate; bifenox+metolachlor+glufosinate; bifenox+compound of the formula A+glufosinate; bifenox+terbutryn+glufosinate; bifenox+simazine+glufosinate; bifenox+dimethenamid or (S)-dimethenamid+glufosinate; bifenox+flufenacet+glufosinate; bifenox+acetochlor+glufosinate; bifenox+alachlor+glufosinate; bifenox+isoxaflutole+glufosinate; bifenox+isoxachlortole+glufosinate; bifenox+mesotrione+glufosinate; bifenox+sulcotrione+glufosinate; bifenox +metosulam+glufosinate; bifenox+flumetsulam+glufosinate; bifenox+pendimethalin+glufosinate; bifenox+bromoxynil+glufosinate; bifenox+bentazone+glufosinate; bifenox +carfentrazone+glufosinate; bifenox+clomazone+glufosinate; bifenox+nicosulfuron+glufosinate; bifenox+rimsulfuron+glufosinate; bifenox+halosulfuron+glufosinate; bifenox+metribuzin+glufosinate; bifenox+flumiclorac+glufosinate; bifenox+prosulfuron +glufosinate; bifenox+primisulfuron+glufosinate; bifenox+dicamba+glufosinate; bifenox+fluthiacet+glufosinate; bifenox+pyridate+glufosinate; bifenox+compound of the formula B+glufosinate; bifenox+2,4-D+glufosinate; bifenox+clopyralide+glufosinate; bifenox+diflufenzopyr+glufosinate; bifenox+fluroxypyr+glufosinate; bifenox +MCPA+glufosinate; bifenox+MCPB+glufosinate; bifenox+MCPP+glufosinate; bifenox+metobenzuron+glufosinate; bifenox+thifensulfuron+glufosinate; bifenox+aclonifen+glufosinate; bifenox+EPTC+glufosinate; bifenox+cyanazine+glufosinate; chlomitrofen+atrazin+glufosinate; chlomitrofen+terbuthylazine+glufosinate; chlomitrofen+(S)-metolachlor+glufosinate; chlomitrofen+metolachlor+glufosinate; chlomitrofen+compound of the formula A+glufosinate; chlomitrofen+terbutryn+glufosinate; chlomitrofen+simazine+glufosinate; chlomitrofen+dimethenamid or (S)-dimethenamid+glufosinate; chlomitrofen+flufenacet+glufosinate; chlomitrofen+acetochlor+glufosinate; chlomitrofen+alachlor+glufosinate; chlomitrofen+isoxaflutole+glufosinate; chlomitrofen+isoxachlortole+glufosinate; chlomitrofen+mesotrione+glufosinate; chlomitrofen+sulcotrione+glufosinate; chlomitrofen+metosulam+glufosinate; chlomitrofen+flumetsulam+glufosinate; chlomitrofen+pendimethalin+glufosinate; chlomitrofen+bromoxynil+glufosinate; chlomitrofen+bentazone+glufosinate; chlomitrofen+carfentrazone+glufosinate; chlomitrofen+clomazone+glufosinate; chlomitrofen+nicosulfuron+glufosinate; chlomitrofen+rimsulfuron+glufosinate; chlomitrofen+halosulfuron+glufosinate; chlomitrofen+metribuzin+glufosinate; chlomitrofen+flumiclorac+glufosinate; chlomitrofen+prosulfuron+glufosinate; chlomitrofen+primisulfuron+glufosinate; chlomitrofen+dicamba+glufosinate; chlomitrofen+fluthiacet+glufosinate; chlomitrofen+pyridate+glufosinate; chlomitrofen+compound of the formula B+glufosinate; chlomitrofen+2,4-D+glufosinate; chlomitrofen+clopyralide+glufosinate; chlomitrofen+diflufenzopyr+glufosinate; chlomitrofen+fluroxypyr+glufosinate; chlomitrofen+MCPA+glufosinate; chlomitrofen+MCPB+glufosinate; chlomitrofen+MCPP+glufosinate; chlomitrofen+metobenzuron+glufosinate; chlomitrofen+thifensulfuron+glufosinate; chlomitrofen+aclonifen+glufosinate; chlomitrofen+EPTC+glufosinate; chlomitrofen+cyanazine+glufosinate; ethoxyfen+atrazin+glufosinate; ethoxyfen+terbuthylazine+glufosinate; ethoxyfen+(S)-metolachlor+glufosinate; ethoxyfen+metolachlor+glufosinate; ethoxyfen+compound of the formula A+glufosinate; ethoxyfen+terbutryn+glufosinate; ethoxyfen+simazine+glufosinate; ethoxyfen+dimethenamid or (S)-dimethenamid+glufosinate; ethoxyfen+flufenacet+glufosinate; ethoxyfen+acetochlor+glufosinate; ethoxyfen+alachlor+glufosinate; ethoxyfen+isoxaflutole+glufosinate; ethoxyfen+isoxachlortole+glufosinate; ethoxyfen+mesotrione+glufosinate; ethoxyfen+sulcotrione+glufosinate; ethoxyfen+metosulam+glufosinate; ethoxyfen+flumetsulam+glufosinate; ethoxyfen+pendimethalin +glufosinate; ethoxyfen+bromoxynil+glufosinate; ethoxyfen+bentazone+glufosinate; ethoxyfen+carfentrazone+glufosinate; ethoxyfen+clomazone+glufosinate; ethoxyfen+nicosulfuron+glufosinate; ethoxyfen+rimsulfuron+glufosinate; ethoxyfen+halosulfuron +glufosinate; ethoxyfen+metribuzin+glufosinate; ethoxyfen+flumiclorac+glufosinate; ethoxyfen+prosulfuron+glufosinate; ethoxyfen+primisulfuron+glufosinate; ethoxyfen+dicamba+glufosinate; ethoxyfen+fluthiacet+glufosinate; ethoxyfen+pyridate+glufosinate; ethoxyfen+compound of the formula B+glufosinate; ethoxyfen+2,4-D+glufosinate; ethoxyfen+clopyralide+glufosinate; ethoxyfen+diflufenzopyr+glufosinate; ethoxyfen+fluroxypyr+glufosinate; ethoxyfen+MCPA+glufosinate; ethoxyfen+MCPB+glufosinate; ethoxyfen+MCPP+glufosinate; ethoxyfen+metobenzuron+glufosinate; ethoxyfen+thifensulfuron+glufosinate; ethoxyfen+aclonifen+glufosinate; ethoxyfen+EPTC+glufosinate; ethoxyfen+cyanazine+glufosinate; fluoroglycofen+atrazin+glufosinate; fluoroglycofen+terbuthylazine+glufosinate; fluoroglycofen+(S)-metolachlor+glufosinate; fluoroglycofen+metolachlor+glufosinate; fluoroglycofen+compound of the formula A+glufosinate; fluoroglycofen+terbutryn+glufosinate; fluoroglycofen+simazine +glufosinate; fluoroglycofen+dimethenamid or (S)-dimethenamid+glufosinate; fluoroglycofen+flufenacet+glufosinate; fluoroglycofen+acetochlor-+glufosinate; fluoroglycofen+alachlor+glufosinate; fluoroglycofen+isoxaflutole+glufosinate; fluoroglycofen+isoxachlortole+glufosinate; fluoroglycofen+mesotrione+glufosinate; fluoroglycofen+sulcotrione+glufosinate; fluoroglycofen+metosulam+glufosinate; fluoroglycofen+flumetsulam+glufosinate; fluoroglycofen+pendimethalin+glufosinate; fluoroglycofen+bromoxynil+glufosinate; fluoroglycofen+bentazone+glufosinate; fluoroglycofen+carfentrazone+glufosinate; fluoroglycofen+clomazone+glufosinate; fluoroglycofen+nicosulfuron+glufosinate; fluoroglycofen+rimsulfuron+glufosinate; fluoroglycofen+halosulfuron+glufosinate; fluoroglycofen+metribuzin+glufosinate; fluoroglycofen+flumiclorac+glufosinate; fluoroglycofen+prosulfuron+glufosinate; fluoroglycofen+primisulfuron+glufosinate; fluoroglycofen+dicamba+glufosinate; fluoroglycofen+fluthiacet+glufosinate; fluoroglycofen+pyridate+glufosinate; fluoroglycofen+compound of the formula B+glufosinate; fluoroglycofen+2,4-D+glufosinate; fluoroglycofen+clopyralide+glufosinate; fluoroglycofen+diflufenzopyr+glufosinate; fluoroglycofen+fluroxypyr+glufosinate; fluoroglycofen+MCPA+glufosinate; fluoroglycofen+MCPB+glufosinate; fluoroglycofen+MCPP+glufosinate; fluoroglycofen +metobenzuron+glufosinate; fluoroglycofen+thifensulfuron+glufosinate; fluoroglycofen +aclonifen+glufosinate; fluoroglycofen+EPTC+glufosinate; fluoroglycofen+cyanazine +glufosinate; fomesafen+atrazin+glufosinate; fomesafen+terbuthylazine+glufosinate; fomesafen+(S)-metolachlor+glufosinate; fomesafen+metolachlor+glufosinate; fomesafen+compound of the formula A+glufosinate; fomesafen+terbutryn+glufosinate; fomesafen+simazine+glufosinate; fomesafen+dimethenamid or (S)-dimethenamid+glufosinate; fomesafen+flufenacet+glufosinate; fomesafen+acetochlor+glufosinate; fomesafen+alachlor+glufosinate; fomesafen+isoxaflutole+glufosinate; fomesafen+isoxachlortole+glufosinate; fomesafen+mesotrione+glufosinate; fomesafen+sulcotrione +glufosinate; fomesafen+metosulam+glufosinate; fomesafen+flumetsulam+glufosinate; fomesafen+pendimethalin+glufosinate; fomesafen+bromoxynil+glufosinate; fomesafen+bentazone+glufosinate; fomesafen+carfentrazone+glufosinate; fomesafen+clomazone+glufosinate; fomesafen+nicosulfuron+glufosinate; fomesafen+rimsulfuron+glufosinate; fomesafen+halosulfuron+glufosinate; fomesafen +metribuzin+glufosinate; fomesafen+flumiclorac+glufosinate; fomesafen+prosulfuron +glufosinate; fomesafen+primisulfuron+glufosinate; fomesafen+dicamba+glufosinate; fomesafen+fluthiacet+glufosinate; fomesafen+pyridate+glufosinate; fomesafen+compound of the formula B+glufosinate; fomesafen+2,4-D+glufosinate; fomesafen+clopyralide+glufosinate; fomesafen+diflufenzopyr+glufosinate; fomesafen+fluroxypyr+glufosinate; fomesafen+MCPA+glufosinate; fomesafen+MCPB+glufosinate; fomesafen +MCPP+glufosinate; fomesafen+metobenzuron+glufosinate; fomesafen+thifensulfuron+glufosinate; fomesafen+aclonifen+glufosinate; fomesafen+EPTC+glufosinate; fomesafen+cyanazine+glufosinate; lactofen+atrazin+glufosinate; lactofen +terbuthylazine+glufosinate; lactofen+(S)-metolachlor+glufosinate; lactofen+metolachlor+glufosinate; lactofen+compound of the formula A+glufosinate; lactofen+terbutryn+glufosinate; lactofen+simazine+glufosinate; lactofen+dimethenamid or (S)-dimethenamid+glufosinate; lactofen+flufenacet+glufosinate; lactofen+acetochlor+glufosinate; lactofen+alachlor+glufosinate; lactofen+isoxaflutole+glufosinate; lactofen +isoxachlortole+glufosinate; lactofen+mesotrione+glufosinate; lactofen+sulcotrione+glufosinate; lactofen+-metosulam+glufosinate; lactofen+flumetsulam+glufosinate; lactofen+pendimethalin+glufosinate; lactofen+bromoxynil+glufosinate; lactofen+bentazone+glufosinate; lactofen+carfentrazone+glufosinate; lactofen+clomazone+glufosinate; lactofen+nicosulfuron+glufosinate; lactofen+rimsulfuron+glufosinate; lactofen+halosulfuron+glufosinate; lactofen+metribuzin+glufosinate; lactofen+flumiclorac+glufosinate; lactofen+prosulfuron+glufosinate; lactofen+primisulfuron+glufosinate; lactofen+dicamba+glufosinate; lactofen+fluthiacet+glufosinate; lactofen+pyridate+glufosinate; lactofen+compound of the formula B+glufosinate; lactofen+2,4-D +glufosinate; lactofen+clopyralide+glufosinate; lactofen+diflufenzopyr+glufosinate; lactofen+fluroxypyr+glufosinate; lactofen+MCPA+glufosinate; lactofen+MCPB+glufosinate; lactofen+MCPP+glufosinate; lactofen+metobenzuron+glufosinate; lactofen +thifensulfuron+glufosinate; lactofen+aclonifen+glufosinate; lactofen+EPTC+glufosinate; lactofen+cyanazine+glufosinate; oxyfluorfen+atrazin+glufosinate; oxyfluorfen+terbuthylazine+glufosinate; oxyfluorfen+(S)-metolachlor+glufosinate; oxyfluorfen+metolachlor+glufosinate; oxyfluorfen+compound of the formula A+glufosinate; oxyfluorfen+terbutryn+glufosinate; oxyfluorfen+simazine+glufosinate; oxyfluorfen+dimethenamid or (S)-dimethenamid+glufosinate; oxyfluorfen+flufenacet+glufosinate; oxyfluorfen+acetochlor+glufosinate; oxyfluorfen+alachlor+glufosinate; oxyfluorfen+isoxaflutole+glufosinate; oxyfluorfen+isoxachlortole+glufosinate; oxyfluorfen+mesotrione+glufosinate; oxyfluorfen+sulcotrione+glufosinate; oxyfluorfen +metosulam+glufosinate; oxyfluorfen+flumetsulam+glufosinate; oxyfluorfen+pendimethalin+glufosinate; oxyfluorfen+bromoxynil+glufosinate; oxyfluorfen+bentazone+glufosinate; oxyfluorfen+carfentrazone+glufosinate; oxyfluorfen+clomazone+glufosinate; oxyfluorfen+nicosulfuron+glufosinate; oxyfluorfen+rimsulfuron +glufosinate; oxyfluorfen+halosulfuron+glufosinate; oxyfluorfen+metribuzin+glufosinate; oxyfluorfen+flumiclorac+glufosinate; oxyfluorfen+prosulfuron+glufosinate; oxyfluorfen+primisulfuron+glufosinate; oxyfluorfen+dicamba+glufosinate; oxyfluorfen+fluthiacet+glufosinate; oxyfluorfen+pyridate+glufosinate; oxyfluorfen+compound of the formula B+glufosinate; oxyfluorfen+2,4-D+glufosinate; oxyfluorfen+clopyralide+glufosinate; oxyfluorfen+diflufenzopyr+glufosinate; oxyfluorfen+fluroxypyr+glufosinate; oxyfluorfen+MCPA+glufosinate; oxyfluorfen+MCPB+glufosinate; oxyfluorfen+MCPP +glufosinate; oxyfluorfen+metobenzuron+glufosinate; oxyfluorfen+thifensulfuron+glufosinate; oxyfluorfen+aclonifen+glufosinate; oxyfluorfen+EPTC+glufosinate; oxyfluorfen+cyanazine+glufosinate; azafenidin+atrazin+glufosinate; azafenidin+terbuthylazine+glufosinate; azafenidin+(S)-metolachlor+glufosinate; azafenidin+metolachlor+glufosinate; azafenidin+compound of the formula A+glufosinate; azafenidin +terbutryn+glufosinate; azafenidin+simazine+glufosinate; azafenidin+dimethenamid or (S)-dimethenamid+glufosinate; azafenidin+flufenacet+glufosinate; azafenidin+acetochlor+glufosinate; azafenidin+alachlor+glufosinate; azafenidin+isoxaflutole+glufosinate; azafenidin+isoxachlortole+glufosinate; azafenidin+mesotrione+glufosinate; azafenidin+sulcotrione+glufosinate; azafenidin+metosulam+glufosinate; azafenidin+flumetsulam+glufosinate; azafenidin+pendimethalin+glufosinate; azafenidin+bromoxynil+glufosinate; azafenidin+bentazone+glufosinate; azafenidin+carfentrazone+glufosinate; azafenidin+clomazone+glufosinate; azafenidin+nicosulfuron+glufosinate; azafenidin+rimsulfuron+glufosinate; azafenidin+halosulfuron +glufosinate; azafenidin+metribuzin+glufosinate; azafenidin+flumiclorac+glufosinate; azafenidin+prosulfuron+glufosinate; azafenidin+primisulfuron+glufosinate; azafenidin +dicamba+glufosinate; azafenidin+fluthiacet+glufosinate; azafenidin+pyridate+glufosinate; azafenidin+compound of the formula B+glufosinate; azafenidin+2,4-D+glufosinate; azafenidin+clopyralide+glufosinate; azafenidin+diflufenzopyr+glufosinate; azafenidin+fluroxypyr+glufosinate; azafenidin+MCPA+glufosinate; azafenidin+MCPB +glufosinate; azafenidin+MCPP+glufosinate; azafenidin+metobenzuron+glufosinate; azafenidin+thifensulfuron+glufosinate; azafenidin+aclonifen+glufosinate; azafenidin+EPTC+glufosinate; azafenidin+cyanazine+glufosinate; carfentrazone-ethyl+atrazin+glufosinate; carfentrazone-ethyl+terbuthylazine+glufosinate; carfentrazone-ethyl+(S)-metolachlor+glufosinate; carfentrazone-ethyl+metolachlor+glufosinate; carfentrazone-ethyl+compound of the formula A+glufosinate; carfentrazone-ethyl+terbutryn+glufosinate; carfentrazone-ethyl+simazine+glufosinate; carfentrazone-ethyl+dimethenamid or (S)-dimethenamid+glufosinate; carfentrazone-ethyl+flufenacet+glufosinate; carfentrazone-ethyl+acetochlor+glufosinate; carfentrazone-ethyl+alachlor+glufosinate; carfentrazone-ethyl+isoxaflutole+glufosinate; carfentrazone-ethyl+isoxachlortole+glufosinate; carfentrazone-ethyl+mesotrione+glufosinate; carfentrazone-ethyl+sulcotrione+glufosinate; carfentrazone-ethyl+metosulam+glufosinate; carfentrazone-ethyl+flumetsulam+glufosinate; carfentrazone-ethyl+pendimethalin+glufosinate; carfentrazone-ethyl+bromoxynil+glufosinate; carfentrazone-ethyl+bentazone+glufosinate; carfentrazone-ethyl+clomazone+glufosinate; carfentrazone-ethyl+nicosulfuron+glufosinate; carfentrazone-ethyl+rimsulfuron+glufosinate; carfentrazone-ethyl+halosulfuron+glufosinate; carfentrazone-ethyl+metribuzin+glufosinate; carfentrazone-ethyl+flumiclorac+glufosinate; carfentrazone-ethyl+prosulfuron+glufosinate; carfentrazone-ethyl+primisulfuron+glufosinate; carfentrazone-ethyl+dicamba+glufosinate; carfentrazone-ethyl+fluthiacet+glufosinate; carfentrazone-ethyl+pyridate+glufosinate; carfentrazone-ethyl+compound of the formula B+glufosinate; carfentrazone-ethyl+2,4-D+glufosinate; carfentrazone-ethyl+clopyralide+glufosinate; carfentrazone-ethyl+diflufenzopyr+glufosinate; carfentrazone-ethyl+fluroxypyr+glufosinate; carfentrazone-ethyl+MCPA+glufosinate; carfentrazone-ethyl+MCPB+glufosinate; carfentrazone-ethyl+MCPP+glufosinate; carfentrazone-ethyl+metobenzuron+glufosinate; carfentrazone-ethyl+thifensulfuron+glufosinate; carfentrazone-ethyl+aclonifen+glufosinate; carfentrazone-ethyl+EPTC+glufosinate; carfentrazone-ethyl+cyanazine+glufosinate; compound of the formula A+atrazin+glufosinate; compound of the formula A+terbuthylazine+glufosinate; compound of the formula A+(S)-metolachlor+glufosinate; compound of the formula A+metolachlor+glufosinate; compound of the formula A+terbutryn+glufosinate; compound of the formula A+simazine+glufosinate; compound of the formula A+dimethenamid or (S)-dimethenamid+glufosinate; compound of the formula A+flufenacet+glufosinate; compound of the formula A+acetochlor+glufosinate; compound of the formula A+alachlor, compound of the formula A+isoxaflutole+glufosinate; compound of the formula A+isoxachlortole+glufosinate; compound of the formula A+mesotrione+glufosinate; compound of the formula A+sulcotrione+glufosinate; compound of the formula A+metosulam+glufosinate; compound of the formula A+flumetsulam+glufosinate; compound of the formula A+pendimethalin+glufosinate; compound of the formula A+bromoxynil+glufosinate; compound of the formula A+bentazone+glufosinate; compound of the formula A+carfentrazone+glufosinate; compound of the formula A+clomazone+glufosinate; compound of the formula A+nicosulfuron+glufosinate; compound of the formula A+rimsulfuron+glufosinate; compound of the formula A+halosulfuron+glufosinate; compound of the formula A+metribuzin+glufosinate; compound of the formula A+flumiclorac+glufosinate; compound of the formula A+prosulfuron+glufosinate; compound of the formula A+primisulfuron+glufosinate; compound of the formula A+dicamba+glufosinate; compound of the formula A+fluthiacet+glufosinate; compound of the formula A+pyridate+glufosinate; compound of the formula A+compound of the formula B+glufosinate; compound of the formula A+2,4-D+glufosinate; compound of the formula A+clopyralide+glufosinate; compound of the formula A+diflufenzopyr+glufosinate; compound of the formula A+fluroxypyr+glufosinate; compound of the formula A+MCPA+glufosinate; compound of the formula A+MCPB+glufosinate; compound of the formula A+MCPP+glufosinate; compound of the formula A +metobenzuron+glufosinate; compound of the formula A+thifensulfuron+glufosinate; compound of the formula A+aclonifen+glufosinate; compound of the formula A+EPTC+glufosinate; compound of the formula A+cyanazine+glufosinate; cinidon-ethyl+atrazin+glufosinate; cinidon-ethyl+terbuthylazine+glufosinate; cinidon-ethyl+(S)-metolachlor+glufosinate; cinidon-ethyl+metolachlor+glufosinate; cinidon-ethyl+compound of the formula A+glufosinate; cinidon-ethyl+terbutryn+glufosinate; cinidon-ethyl+simazine+glufosinate; cinidon-ethyl+dimethenamid or (S)-dimethenamid+glufosinate; cinidon-ethyl +flufenacet+glufosinate; cinidon-ethyl+acetochlor+glufosinate; cinidon-ethyl+alachlor +glufosinate; cinidon-ethyl+isoxaflutole+glufosinate; cinidon-ethyl+isoxachlortole+glufosinate; cinidon-ethyl+mesotrione+glufosinate; cinidon-ethyl+sulcotrione+glufosinate; cinidon-ethyl+metosulam+glufosinate; cinidon-ethyl+flumetsulam+glufosinate; cinidon-ethyl+pendimethalin+glufosinate; cinidon-ethyl+bromoxynil+glufosinate; cinidon-ethyl+bentazone+glufosinate; cinidon-ethyl+carfentrazone+glufosinate; cinidon-ethyl+clomazone+glufosinate; cinidon-ethyl+nicosulfuron+glufosinate; cinidon-ethyl+rimsulfuron+glufosinate; cinidon-ethyl+halosulfuron+glufosinate; cinidon-ethyl+metribuzin+glufosinate; cinidon-ethyl+flumiclorac+glufosinate; cinidon-ethyl+prosulfuron+glufosinate; cinidon-ethyl+primisulfuron+glufosinate; cinidon-ethyl+dicamba+glufosinate; cinidon-ethyl+fluthiacet+glufosinate; cinidon-ethyl+pyridate+glufosinate; cinidon-ethyl+compound of the formula B+glufosinate; cinidon-ethyl+2,4-D+glufosinate; cinidon-ethyl+clopyralide+glufosinate; cinidon-ethyl+diflufenzopyr+glufosinate; cinidon-ethyl+fluroxypyr+glufosinate; cinidon-ethyl+MCPA+glufosinate; cinidon-ethyl+MCPB+glufosinate; cinidon-ethyl+MCPP+glufosinate; cinidon-ethyl+metobenzuron+glufosinate; cinidon-ethyl+thifensulfuron+glufosinate; cinidon-ethyl+aclonifen+glufosinate; cinidon-ethyl+EPTC+glufosinate; cinidon-ethyl+cyanazine+glufosinate; flumiclorac-pentyl+atrazin+glufosinate; flumiclorac-pentyl+terbuthylazine+glufosinate; flumiclorac-pentyl+(S)-metolachlor+glufosinate; flumiclorac-pentyl+metolachlor+glufosinate; flumiclorac-pentyl+compound of the formula A+glufosinate; flumiclorac-pentyl+terbutryn+glufosinate; flumiclorac-pentyl+simazine+glufosinate; flumiclorac-pentyl+dimethenamid or (S)-dimethenamid+glufosinate; flumiclorac-pentyl+flufenacet+glufosinate; flumiclorac-pentyl+acetochlor+glufosinate; flumiclorac-pentyl+alachlor+glufosinate; flumiclorac-pentyl+isoxaflutole+glufosinate; flumiclorac-pentyl+isoxachlortole+glufosinate; flumiclorac-pentyl+mesotrione+glufosinate; flumiclorac-pentyl+sulcotrione+glufosinate; flumiclorac-pentyl+metosulam+glufosinate; flumiclorac-pentyl+flumetsulam+glufosinate; flumiclorac-pentyl +pendimethalin+glufosinate; flumiclorac-pentyl+bromoxynil+glufosinate; flumiclorac-pentyl+bentazone+glufosinate; flumiclorac-pentyl+carfentrazone+glufosinate; flumiclorac-pentyl+clomazone+glufosinate; flumiclorac-pentyl+nicosulfuron+glufosinate; flumiclorac-pentyl+rimsulfuron+glufosinate; flumiclorac-pentyl+halosulfuron +glufosinate; flumiclorac-pentyl+metribuzin+glufosinate; flumiclorac-pentyl+prosulfuron +glufosinate; flumiclorac-pentyl+primisulfuron+glufosinate; flumiclorac-pentyl+dicamba +glufosinate; flumiclorac-pentyl+fluthiacet+glufosinate; flumiclorac-pentyl+pyridate+glufosinate; flumiclorac-pentyl+compound of the formula B+glufosinate; flumiclorac-pentyl +2,4-D+glufosinate; flumiclorac-pentyl+clopyralide+glufosinate; flumiclorac-pentyl+diflufenzopyr+glufosinate; flumiclorac-pentyl+fluroxypyr+glufosinate: flumiclorac-pentyl+MCPA+glufosinate; flumiclorac-pentyl+MCPB+glufosinate; flumiclorac-pentyl+MCPP+glufosinate; flumiclorac-pentyl+metobenzuron+glufosinate; flumiclorac-pentyl+thifensulfuron+glufosinate; flumiclorac-pentyl+aclonifen+glufosinate; flumiclorac-pentyl +EPTC+glufosinate; flumiclorac-pentyl+cyanazine+glufosinate; flumioxazin+atrazin+glufosinate; flumioxazin+terbuthylazine+glufosinate; flumioxazin+(S)-metolachlor+glufosinate; flumioxazin+metolachlor+glufosinate; flumioxazin+compound of the formula A+glufosinate; flumioxazin+terbutryn+glufosinate; flumioxazin+simazine+glufosinate; flumioxazin+dimethenamid or (S)-dimethenamid+glufosinate; flumioxazin+flufenacet+glufosinate; flumioxazin+acetochlor+glufosinate; flumioxazin+alachlor+glufosinate; flumioxazin+isoxaflutole+glufosinate; flumioxazin+isoxachlortole+glufosinate; flumioxazin+mesotrione+glufosinate; flumioxazin+sulcotrione+glufosinate; flumioxazin +metosulam+glufosinate; flumioxazin+flumetsulam+glufosinate; flumioxazin+pendimethalin+glufosinate; flumioxazin+bromoxynil+glufosinate; flumioxazin+bentazone+glufosinate; flumioxazin+carfentrazone+glufosinate; flumioxazin+clomazone+glufosinate; flumioxazin+nicosulfuron+glufosinate; flumioxazin+rimsulfuron +glufosinate; flumioxazin+halosulfuron+glufosinate; flumioxazin+metribuzin+glufosinate; flumioxazin+flumiclorac+glufosinate; flumioxazin+prosulfuron+glufosinate; flumioxazin+primisulfuron+glufosinate; flumioxazin+dicamba+glufosinate; flumioxazin +fluthiacet+glufosinate; flumioxazin+pyridate+glufosinate; flumioxazin+compound of the formula B+glufosinate; flumioxazin+2,4-D+glufosinate; flumioxazin+clopyralide+glufosinate; flumioxazin+diflufenzopyr+glufosinate; flumioxazin+fluroxypyr+glufosinate; flumioxazin+MCPA+glufosinate; flumioxazin+MCPB+glufosinate; flumioxazin+MCPP +glufosinate; flumioxazin+metobenzuron+glufosinate; flumioxazin+thifensulfuron+glufosinate; flumioxazin+aclonifen+glufosinate; flumioxazin+EPTC+glufosinate; flumioxazin+cyanazine+glufosinate; fluthiacet-methyl+atrazin+glufosinate; fluthiacet-methyl+terbuthylazine+glufosinate; fluthiacet-methyl+(S)-metolachlor+glufosinate; fluthiacet-methyl+metolachlor+glufosinate; fluthiacet-methyl+compound of the formula A +glufosinate; fluthiacet-methyl+terbutryn+glufosinate; fluthiacet-methyl+simazine+glufosinate; fluthiacet-methyl+dimethenamid or (S)-dimethenamid+glufosinate; fluthiacet-methyl+flufenacet+glufosinate; fluthiacet-methyl+acetochlor+glufosinate; fluthiacet-methyl+alachlor+glufosinate; fluthiacet-methyl+isoxaflutole+glufosinate; fluthiacet-methyl+isoxachlortole+glufosinate; fluthiacet-methyl+mesotrione+glufosinate; fluthiacet-methyl+sulcotrione+glufosinate; fluthiacet-methyl+metosulam+glufosinate; fluthiacet-methyl+flumetsulam+glufosinate; fluthiacet-methyl+pendimethalin+glufosinate; fluthiacet-methyl+bromoxynil+glufosinate; fluthiacet-methyl+bentazone+glufosinate; fluthiacet-methyl+carfentrazone+glufosinate; fluthiacet-methyl+clomazone+glufosinate; fluthiacet-methyl+nicosulfuron+glufosinate; fluthiacet-methyl+rimsulfuron+glufosinate; fluthiacet-methyl+halosulfuron+glufosinate; fluthiacet-methyl+metribuzin+glufosinate; fluthiacet-methyl+flumiclorac+glufosinate; fluthiacet-methyl+prosulfuron+glufosinate; fluthiacet-methyl+primisulfuron+glufosinate; fluthiacet-methyl+dicamba+glufosinate; fluthiacet-methyl+pyridate+glufosinate; fluthiacet-methyl+compound of the formula B+glufosinate; fluthiacet-methyl+2,4-D+glufosinate; fluthiacet-methyl+clopyralide+glufosinate; fluthiacet-methyl+diflufenzopyr+glufosinate; fluthiacet-methyl+fluroxypyr+glufosinate; fluthiacet-methyl+MCPA+glufosinate; fluthiacet-methyl+MCPB +glufosinate; fluthiacet-methyl+MCPP+glufosinate; fluthiacet-methyl+metobenzuron+glufosinate; fluthiacet-methyl+thifensulfuron+glufosinate; fluthiacet-methyl+aclonifen+glufosinate; fluthiacet-methyl+EPTC+glufosinate; fluthiacet-methyl+cyanazine+glufosinate; oxadiargyl+atrazin+glufosinate; oxadiargyl+terbuthylazine+glufosinate; oxadiargyl+(S)-metolachlor+glufosinate; oxadiargyl+metolachlor+glufosinate; oxadiargyl+compound of the formula A+glufosinate; oxadiargyl+terbutryn+glufosinate; oxadiargyl+simazine+glufosinate; oxadiargyl+dimethenamid or (S)-dimethenamid+glufosinate; oxadiargyl+flufenacet+glufosinate; oxadiargyl+acetochlor+glufosinate; oxadiargyl+alachlor+glufosinate; oxadiargyl+isoxaflutole+glufosinate; oxadiargyl+isoxachlortole+glufosinate; oxadiargyl+mesotrione+glufosinate; oxadiargyl+sulcotrione +glufosinate; oxadiargyl+metosulam+glufosinate; oxadiargyl+flumetsulam+glufosinate; oxadiargyl+pendimethalin+glufosinate; oxadiargyl+bromoxynil+glufosinate; oxadiargyl+bentazone+glufosinate; oxadiargyl+carfentrazone+glufosinate; oxadiargyl +clomazone+glufosinate; oxadiargyl+nicosulfuron+glufosinate; oxadiargyl+rimsulfuron +glufosinate; oxadiargyl+halosulfuron+glufosinate; oxadiargyl+metribuzin+glufosinate; oxadiargyl+flumiclorac+glufosinate; oxadiargyl+prosulfuron+glufosinate; oxadiargyl+primisulfuron+glufosinate; oxadiargyl+dicamba+glufosinate; oxadiargyl+fluthiacet+glufosinate; oxadiargyl+pyridate+glufosinate; oxadiargyl+compound of the formula B+glufosinate; oxadiargyl+2,4-D+glufosinate; oxadiargyl+clopyralide+glufosinate; oxadiargyl+diflufenzopyr+glufosinate; oxadiargyl+fluroxypyr+glufosinate; oxadiargyl+MCPA+glufosinate; oxadiargyl+MCPB+glufosinate; oxadiargyl+MCPP+glufosinate; oxadiargyl+metobenzuron+glufosinate; oxadiargyl+thifensulfuron+glufosinate; oxadiargyl+aclonifen+glufosinate; oxadiargyl+EPTC+glufosinate; oxadiargyl+cyanazine+glufosinate; oxadiazon+atrazin+glufosinate; oxadiazon+terbuthylazine+glufosinate; oxadiazon+(S)-metolachlor+glufosinate; oxadiazon+metolachlor+glufosinate; oxadiazon+compound of the formula A+glufosinate; oxadiazon+terbutryn+glufosinate; oxadiazon+simazine+glufosinate; oxadiazon+dimethenamid or (S)-dimethenamid+glufosinate; oxadiazon+flufenacet+glufosinate; oxadiazon+acetochlor+glufosinate; oxadiazon+alachlor+glufosinate; oxadiazon+isoxaflutole+glufosinate; oxadiazon+isoxachlortole+glufosinate; oxadiazon+mesotrione+glufosinate; oxadiazon +sulcotrione+glufosinate; oxadiazon+metosulam+glufosinate; oxadiazon+flumetsulam +glufosinate; oxadiazon+pendimethalin+glufosinate; oxadiazon+bromoxynil+glufosinate; oxadiazon+bentazone+glufosinate; oxadiazon+carfentrazone+glufosinate; oxadiazon+clomazone+glufosinate; oxadiazon+nicosulfuron+glufosinate; oxadiazon+rimsulfuron+glufosinate; oxadiazon+halosulfuron+glufosinate; oxadiazon+metribuzin+glufosinate; oxadiazon+flumiclorac+glufosinate; oxadiazon+prosulfuron+glufosinate; oxadiazon+primisulfuron+glufosinate; oxadiazon+dicamba+glufosinate; oxadiazon+fluthiacet+glufosinate; oxadiazon+pyridate+glufosinate; oxadiazon+compound of the formula B+glufosinate; oxadiazon+2,4-D+glufosinate; oxadiazon+clopyralide+glufosinate; oxadiazon+diflufenzopyr+glufosinate; oxadiazon+fluroxypyr+glufosinate; oxadiazon+MCPA+glufosinate; oxadiazon+MCPB+glufosinate; oxadiazon+MCPP+glufosinate; oxadiazon+metobenzuron+glufosinate; oxadiazon+thifensulfuron+glufosinate; oxadiazon+aclonifen+glufosinate; oxadiazon+EPTC+glufosinate; oxadiazon+cyanazine+glufosinate; pentoxazone+atrazin+glufosinate; pentoxazone+terbuthylazine+glufosinate; pentoxazone+(S)-metolachlor+glufosinate; pentoxazone+metolachlor+glufosinate; pentoxazone+compound of the formula A+glufosinate; pentoxazone+terbutryn+glufosinate; pentoxazone+simazine+glufosinate; pentoxazone+dimethenamid or (S)-dimethenamid+glufosinate; pentoxazone+flufenacet+glufosinate; pentoxazone+acetochlor+glufosinate; pentoxazone+alachlor +glufosinate; pentoxazone+isoxaflutole+glufosinate; pentoxazone+isoxachlortole+glufosinate; pentoxazone+mesotrione+glufosinate; pentoxazone+sulcotrione+glufosinate; pentoxazone+metosulam+glufosinate; pentoxazone+flumetsulam+glufosinate; pentoxazone+pendimethalin+glufosinate; pentoxazone+bromoxynil+glufosinate; pentoxazone+bentazone+glufosinate; pentoxazone+carfentrazone+glufosinate; pentoxazone+clomazone+glufosinate; pentoxazone+nicosulfuron+glufosinate; pentoxazone+rimsulfuron+glufosinate; pentoxazone+halosulfuron+glufosinate; pentoxazone+metribuzin+glufosinate; pentoxazone+flumiclorac+glufosinate; pentoxazone+prosulfuron+glufosinate; pentoxazone+primisulfuron+glufosinate; pentoxazone+dicamba+glufosinate; pentoxazone+fluthiacet+glufosinate; pentoxazone+pyridate+glufosinate; pentoxazone+compound of the formula B+glufosinate; pentoxazone+2,4-D+glufosinate; pentoxazone+clopyralide+glufosinate; pentoxazone+diflufenzopyr+glufosinate; pentoxazone+fluroxypyr+glufosinate; pentoxazone+MCPA+glufosinate; pentoxazone+MCPB+glufosinate; pentoxazone+MCPP+glufosinate; pentoxazone+metobenzuron+glufosinate; pentoxazone+thifensulfuron+glufosinate; pentoxazone+aclonifen+glufosinate; pentoxazone+EPTC +glufosinate; pentoxazone+cyanazine+glufosinate; sulfentrazone+atrazin+glufosinate; sulfentrazone+terbuthylazine+glufosinate; sulfentrazone+(S)-metolachlor+glufosinate; sulfentrazone+metolachlor+glufosinate; sulfentrazone+compound of the formula A+glufosinate; sulfentrazone+terbutryn+glufosinate; sulfentrazone+simazine+glufosinate; sulfentrazone+dimethenamid or (S)-dimethenamid+glufosinate; sulfentrazone+flufenacet+glufosinate; sulfentrazone+acetochlor+glufosinate; sulfentrazone+alachlor+glufosinate; sulfentrazone+isoxaflutole+glufosinate; sulfentrazone+isoxachlortole+glufosinate; sulfentrazone+mesotrione+glufosinate; sulfentrazone+sulcotrione+glufosinate; sulfentrazone+metosulam+glufosinate; sulfentrazone+flumetsulam+glufosinate; sulfentrazone+pendimethalin+glufosinate; sulfentrazone+bromoxynil+glufosinate; sulfentrazone+bentazone+glufosinate; sulfentrazone+carfentrazone+glufosinate; sulfentrazone+clomazone+glufosinate; sulfentrazone+nicosulfuron+glufosinate; sulfentrazone+rimsulfuron+glufosinate; sulfentrazone+halosulfuron+glufosinate; sulfentrazone+metribuzin+glufosinate; sulfentrazone+flumiclorac+glufosinate; sulfentrazone+prosulfuron+glufosinate; sulfentrazone+primisulfuron+glufosinate; sulfentrazone+dicamba+glufosinate; sulfentrazone+fluthiacet+glufosinate; sulfentrazone+pyridate+glufosinate; sulfentrazone+compound of the formula B+glufosinate; sulfentrazone+2,4-D+glufosinate; sulfentrazone+clopyralide+glufosinate; sulfentrazone+diflufenzopyr+glufosinate; sulfentrazone+fluroxypyr+glufosinate; sulfentrazone+MCPA+glufosinate; sulfentrazone+MCPB+glufosinate; sulfentrazone+MCPP+glufosinate; sulfentrazone+metobenzuron+glufosinate; sulfentrazone+thifensulfuron+glufosinate; sulfentrazone+aclonifen+glufosinate; sulfentrazone+EPTC+glufosinate; sulfentrazone+cyanazine+glufosinate; fluazolate+atrazin+glufosinate; fluazolate+terbuthylazine+glufosinate; fluazolate+(S)-metolachlor+glufosinate; fluazolate+metolachlor+glufosinate; fluazolate+compound of the formula A+glufosinate; fluazolate+terbutryn+glufosinate; fluazolate+simazine+glufosinate; fluazolate+dimethenamid or (S)-dimethenamid+glufosinate; fluazolate+flufenacet+glufosinate; fluazolate+acetochlor+glufosinate; fluazolate+alachlor+glufosinate; fluazolate+isoxaflutole+glufosinate; fluazolate+isoxachlortole+glufosinate; fluazolate+mesotrione+glufosinate; fluazolate+sulcotrione +glufosinate; fluazolate+metosulam+glufosinate; fluazolate+flumetsulam+glufosinate; fluazolate+pendimethalin+glufosinate; fluazolate+bromoxynil+glufosinate; fluazolate+bentazone+glufosinate; fluazolate+carfentrazone+glufosinate; fluazolate+clomazone+glufosinate; fluazolate+nicosulfuron+glufosinate; fluazolate+rimsulfuron+glufosinate; fluazolate+halosulfuron+glufosinate; fluazolate+metribuzin+glufosinate; fluazolate+flumiclorac+glufosinate; fluazolate+prosulfuron+glufosinate; fluazolate+primisulfuron+glufosinate; fluazolate+dicamba+glufosinate; fluazolate+fluthiacet+glufosinate; fluazolate+pyridate+glufosinate; fluazolate+compound of the formula B+glufosinate; fluazolate+2,4-D+glufosinate; fluazolate+clopyralide+glufosinate; fluazolate+diflufenzopyr+glufosinate; fluazolate+fluroxypyr+glufosinate; fluazolate+MCPA+glufosinate; fluazolate+MCPB+glufosinate; fluazolate+MCPP+glufosinate; fluazolate+metobenzuron+glufosinate; fluazolate+thifensulfuron+glufosinate; fluazolate+aclonifen+glufosinate; fluazolate+EPTC+glufosinate; fluazolate+cyanazine+glufosinate; pyraflufen-ethyl+atrazin+glufosinate; pyraflufen-ethyl+terbuthylazine+glufosinate; pyraflufen-ethyl+(S)-metolachlor+glufosinate; pyraflufen-ethyl+metolachlor+glufosinate; pyraflufen-ethyl+compound of the formula A +glufosinate; pyraflufen-ethyl+terbutryn+glufosinate; pyraflufen-ethyl+simazine+glufosinate; pyraflufen-ethyl+dimethenamid or (S)-dimethenamid+glufosinate; pyraflufen-ethyl+flufenacet+glufosinate; pyraflufen-ethyl+acetochlor+glufosinate; pyraflufen-ethyl+alachlor+glufosinate; pyraflufen-ethyl+isoxaflutole+glufosinate; pyraflufen-ethyl +isoxachlortole+glufosinate; pyraflufen-ethyl+mesotrione+glufosinate; pyraflufen-ethyl +sulcotrione+glufosinate; pyraflufen-ethyl+metosulam+glufosinate; pyraflufen-ethyl+flumetsulam+glufosinate; pyraflufen-ethyl+pendimethalin+glufosinate; pyraflufen-ethyl +bromoxynil+glufosinate; pyraflufen-ethyl+bentazone+glufosinate; pyraflufen-ethyl+carfentrazone+glufosinate; pyraflufen-ethyl+clomazone+glufosinate; pyraflufen-ethyl+nicosulfuron+glufosinate; pyraflufen-ethyl+rimsulfuron+glufosinate; pyraflufen-ethyl+halosulfuron+glufosinate; pyraflufen-ethyl+metribuzin+glufosinate; pyraflufen-ethyl+flumiclorac+glufosinate; pyraflufen-ethyl+prosulfuron+glufosinate; pyraflufen-ethyl+primisulfuron+glufosinate; pyraflufen-ethyl+dicamba+glufosinate; pyraflufen-ethyl+fluthiacet+glufosinate; pyraflufen-ethyl+pyridate+glufosinate; pyraflufen-ethyl+compound of the formula B+glufosinate; pyraflufen -ethyl+2,4-D+glufosinate; pyraflufen-ethyl+clopyralide+glufosinate; pyraflufen-ethyl+diflufenzopyr+glufosinate; pyraflufen-ethyl+fluroxypyr+glufosinate; pyraflufen-ethyl+MCPA+glufosinate; pyraflufen-ethyl+MCPB+glufosinate; pyraflufen-ethyl+MCPP+glufosinate; pyraflufen-ethyl+metobenzuron+glufosinate; pyraflufen-ethyl+thifensulfuron+glufosinate; pyraflufen-ethyl+aclonifen+glufosinate; pyraflufen-ethyl+EPTC+glufosinate; pyraflufen-ethyl+cyanazine+glufosinate; flumipropyn+atrazin+glufosinate; flumipropyn+terbuthylazine+glufosinate; flumipropyn+(S)-metolachlor+glufosinate; flumipropyn+metolachlor+glufosinate; flumipropyn+compound of the formula A+glufosinate; flumipropyn+terbutryn +glufosinate; flumipropyn+simazine+glufosinate; flumipropyn+dimethenamid or (S)-dimethenamid+glufosinate; flumipropyn+flufenacet+glufosinate; flumipropyn+acetochlor+glufosinate; flumipropyn+alachlor+glufosinate; flumipropyn+isoxaflutole+glufosinate; flumipropyn+isoxachlortole+glufosinate; flumipropyn+mesotrione+glufosinate; flumipropyn+sulcotrione+glufosinate; flumipropyn+metosulam+glufosinate; flumipropyn+flumetsulam+glufosinate; flumipropyn+pendimethalin+glufosinate; flumipropyn+bromoxynil+glufosinate; flumipropyn+bentazone+glufosinate; flumipropyn +carfentrazone+glufosinate; flumipropyn+clomazone+glufosinate; flumipropyn+nicosulfuron+glufosinate; flumipropyn+rimsulfuron+glufosinate; flumipropyn+halosulfuron+glufosinate; flumipropyn+metribuzin+glufosinate; flumipropyn+flumiclorac +glufosinate; flumipropyn+prosulfuron+glufosinate; flumipropyn+primisulfuron+glufosinate; flumipropyn+dicamba+glufosinate; flumipropyn+fluthiacet+glufosinate; flumipropyn+pyridate+glufosinate; flumipropyn+compound of the formula B+glufosinate; flumipropyn+2,4-D+glufosinate; flumipropyn+clopyralide+glufosinate; flumipropyn+diflufenzopyr+glufosinate; flumipropyn+fluroxypyr+glufosinate; flumipropyn+MCPA+glufosinate; flumipropyn+MCPB+glufosinate; flumipropyn+MCPP +glufosinate; flumipropyn+metobenzuron+glufosinate; flumipropyn+thifensulfuron+glufosinate; flumipropyn+aclonifen+glufosinate; flumipropyn+EPTC+glufosinate; flumipropyn+cyanazine+glufosinate; flupropacil+atrazin+glufosinate; flupropacil+terbuthylazine+glufosinate; flupropacil+(S)-metolachlor+glufosinate; flupropacil+metolachlor+glufosinate; flupropacil+compound of the formula A+glufosinate; flupropacil +terbutryn+glufosinate; flupropacil+simazine+glufosinate; flupropacil+dimethenamid or (S)-dimethenamid+glufosinate; flupropacil+flufenacet+glufosinate; flupropacil+acetochlor+glufosinate; flupropacil+alachlor+glufosinate; flupropacil+isoxaflutole+glufosinate; flupropacil+isoxachlortole+glufosinate; flupropacil+mesotrione+glufosinate; flupropacil+sulcotrione+glufosinate; flupropacil+metosulam+glufosinate; flupropacil+flumetsulam+glufosinate; flupropacil+pendimethalin+glufosinate; flupropacil+bromoxynil+glufosinate; flupropacil+bentazone+glufosinate; flupropacil+carfentrazone+glufosinate; flupropacil+clomazone+glufosinate; flupropacil+nicosulfuron+glufosinate; flupropacil+rimsulfuron+glufosinate; flupropacil+halosulfuron +glufosinate; flupropacil+metribuzin+glufosinate; flupropacil+flumiclorac+glufosinate; flupropacil+prosulfuron+glufosinate; flupropacil+primisulfuron+glufosinate; flupropacil+dicamba+glufosinate; flupropacil+fluthiacet+glufosinate; flupropacil+pyridate+glufosinate; flupropacil+compound of the formula B+glufosinate; flupropacil+2,4-D+glufosinate; flupropacil .+clopyralide+glufosinate; flupropacil+diflufenzopyr+glufosinate; flupropacil+fluroxypyr+glufosinate; flupropacil+MCPA+glufosinate; flupropacil+MCPB +glufosinate; flupropacil+MCPP+glufosinate; flupropacil+metobenzuron+glufosinate; flupropacil+thifensulfuron+glufosinate; flupropacil+aclonifen+glufosinate; flupropacil+EPTC+glufosinate; flupropacil+cyanazine+glufosinate; nipyraclofen+atrazin+glufosinate; nipyraclofen+terbuthylazine+glufosinate; nipyraclofen+(S)-metolachlor+glufosinate; nipyraclofen+metolachlor+glufosinate; nipyraclofen+compound of the formula A+glufosinate; nipyraclofen+terbutryn+glufosinate; nipyraclofen+simazine+glufosinate; nipyraclofen+dimethenamid or (S)-dimethenamid+glufosinate; nipyraclofen+flufenacet+glufosinate; nipyraclofen+acetochlor+glufosinate; nipyraclofen+alachlor+glufosinate; nipyraclofen+isoxaflutole+glufosinate; nipyraclofen+isoxachlortole+glufosinate; nipyraclofen+mesotrione+glufosinate; nipyraclofen+sulcotrione+glufosinate; nipyraclofen+metosulam+glufosinate; nipyraclofen+flumetsulam+glufosinate; nipyraclofen+pendimethalin+glufosinate; nipyraclofen+bromoxynil+glufosinate; nipyraclofen+bentazone+glufosinate; nipyraclofen+carfentrazone+glufosinate; nipyraclofen+clomazone+glufosinate; nipyraclofen+nicosulfuron+glufosinate; nipyraclofen+rimsulfuron+glufosinate; nipyraclofen+halosulfuron+glufosinate; nipyraclofen+metribuzin+glufosinate; nipyraclofen+flumiclorac+glufosinate; nipyraclofen+prosulfuron+glufosinate; nipyraclofen+primisulfuron+glufosinate; nipyraclofen+dicamba+glufosinate; nipyraclofen+fluthiacet+glufosinate; nipyraclofen+pyridate+glufosinate; nipyraclofen+compound of the formula B+glufosinate; nipyraclofen+2,4-D+glufosinate; nipyraclofen+clopyralide+glufosinate; nipyraclofen+diflufenzopyr+glufosinate; nipyraclofen+fluroxypyr+glufosinate; nipyraclofen+MCPA+glufosinate; nipyraclofen+MCPB+glufosinate; nipyraclofen+MCPP+glufosinate; nipyraclofen+metobenzuron+glufosinate; nipyraclofen+thifensulfuron+glufosinate; nipyraclofen+aclonifen+glufosinate; nipyraclofen+EPTC+glufosinate; nipyraclofen+cyanazine+glufosinate; benzfendizone+atrazin+glufosinate; benzfendizone+terbuthylazine+glufosinate; benzfendizone+(S)-metolachlor+glufosinate; benzfendizone+metolachlor+glufosinate; benzfendizone+compound of the formula A+glufosinate; benzfendizone+terbutryn+glufosinate; benzfendizone+simazine +glufosinate; benzfendizone+dimethenamid or (S)-dimethenamid+glufosinate; benzfendizone+flufenacet+glufosinate; benzfendizone+acetochlor+glufosinate; benzfendizone+alachlor+glufosinate; benzfendizone+isoxaflutole+glufosinate; benzfendizone+isoxachlortole+glufosinate; benzfendizone+mesotrione+glufosinate; benzfendizone+sulcotrione+glufosinate; benzfendizone+metosulam+glufosinate; benzfendizone+flumetsulam+glufosinate; benzfendizone+pendimethalin+glufosinate; benzfendizone+bromoxynil+glufosinate; benzfendizone+bentazone+glufosinate; benzfendizone+carfentrazone+glufosinate; benzfendizone+clomazone+glufosinate; benzfendizone+nicosulfuron+glufosinate; benzfendizone+rimsulfuron+glufosinate; benzfendizone+halosulfuron+glufosinate; benzfendizone+metribuzin+glufosinate; benzfendizone+flumiclorac+glufosinate; benzfendizone+prosulfuron+glufosinate; benzfendizone+primisulfuron+glufosinate; benzfendizone+dicamba+glufosinate; benzfendizone+fluthiacet+glufosinate; benzfendizone+pyridate+glufosinate; benzfendizone+compound of the formula B+glufosinate; benzfendizone+2,4-D+glufosinate; benzfendizone+clopyralide+glufosinate; benzfendizone+diflufenzopyr+glufosinate; benzfendizone+fluroxypyr+glufosinate; benzfendizone+MCPA+glufosinate; benzfendizone+MCPB+glufosinate; benzfendizone+MCPP+glufosinate; benzfendizone+metobenzuron+glufosinate; benzfendizone+thifensulfuron+glufosinate; benzfendizone+aclonifen+glufosinate; benzfendizone+EPTC+glufosinate; benzfendizone+cyanazine+glufosinate; thidiazimin+atrazin+glufosinate; thidiazimin+terbuthylazine+glufosinate; thidiazimin+(S)-metolachlor+glufosinate; thidiazimin+metolachlor+glufosinate; thidiazimin+compound of the formula A+glufosinate; thidiazimin+terbutryn+glufosinate; thidiazimin+simazine+glufosinate; thidiazimin+dimethenamid or (S)-dimethenamid+glufosinate; thidiazimin+flufenacet+glufosinate; thidiazimin+acetochlor+glufosinate; thidiazimin+alachlor+glufosinate; thidiazimin+isoxaflutole+glufosinate; thidiazimin+isoxachlortole+glufosinate; thidiazimin+mesotrione+glufosinate; thidiazimin+sulcotrione+glufosinate; thidiazimin+metosulam+glufosinate; thidiazimin+flumetsulam+glufosinate; thidiazimin+pendimethalin+glufosinate; thidiazimin+bromoxynil+glufosinate; thidiazimin+bentazone+glufosinate; thidiazimin+carfentrazone+glufosinate; thidiazimin+clomazone+glufosinate; thidiazimin +nicosulfuron+glufosinate; thidiazimin+rimsulfuron+glufosinate; thidiazimin+halosulfuron+glufosinate; thidiazimin+metribuzin+glufosinate; thidiazimin+flumiclorac+glufosinate; thidiazimin+prosulfuron+glufosinate; thidiazimin+primisulfuron+glufosinate; thidiazimin+dicamba+glufosinate; thidiazimin+fluthiacet+glufosinate; thidiazimin+pyridate+glufosinate; thidiazimin+compound of the formula B+glufosinate; thidiazimin+2,4-D+glufosinate; thidiazimin+clopyralide+glufosinate; thidiazimin+diflufenzopyr+glufosinate; thidiazimin+fluroxypyr+glufosinate; thidiazimin+MCPA+glufosinate; thidiazimin+MCPB+glufosinate; thidiazimin+MCPP+glufosinate; thidiazimin+metobenzuron+glufosinate; thidiazimin+thifensulfuron+glufosinate; thidiazimin+aclonifen+glufosinate; thidiazimin+EPTC+glufosinate; and thidiazimin+cyanazine+glufosinate.

acifluorfen+atrazin+sulfosate; acifluorfen+terbuthylazine+sulfosate; acifluorfen+(S)-metolachlor+sulfosate; acifluorfen+metolachlor+sulfosate; acifluorfen+compound of the formula A+sulfosate; acifluorfen+terbutryn+sulfosate; acifluorfen+simazine+sulfosate; acifluorfen+dimethenamid or (S)-dimethenamid+sulfosate; acifluorfen+flufenacet+sulfosate; acifluorfen+acetochlor+sulfosate; acifluorfen+alachlor+sulfosate; acifluorfen+isoxaflutole+sulfosate; acifluorfen+isoxachlortole+sulfosate; acifluorfen+mesotrione+sulfosate; acifluorfen+sulcotrione+sulfosate; acifluorfen+metosulam+sulfosate; acifluorfen+flumetsulam+sulfosate; acifluorfen+pendimethalin+sulfosate; acifluorfen+bromoxynil+sulfosate; acifluorfen+bentazone+sulfosate; acifluorfen+carfentrazone+sulfosate; acifluorfen+clomazone+sulfosate; acifluorfen+nicosulfuron+sulfosate; acifluorfen+rimsulfuron+sulfosate; acifluorfen+halosulfuron+sulfosate; acifluorfen+metribuzin+sulfosate; acifluorfen+flumiclorac+sulfosate; acifluorfen+prosulfuron+sulfosate; acifluorfen+primisulfuron+sulfosate; acifluorfen+dicamba+sulfosate; acifluorfen+fluthiacet+sulfosate; acifluorfen+pyridate+sulfosate; acifluorfen+compound of the formula B+sulfosate; acifluorfen+2,4-D+sulfosate; acifluorfen+clopyralide+sulfosate; acifluorfen+diflufenzopyr+sulfosate; acifluorfen+fluroxypyr+sulfosate; acifluorfen+MCPA+sulfosate; acifluorfen+MCPB+sulfosate; acifluorfen+MCPP+sulfosate; acifluorfen+metobenzuron+sulfosate; acifluorfen+thifensulfuron+sulfosate; acifluorfen+aclonifen+sulfosate; acifluorfen+EPTC+sulfosate; acifluorfen+cyanazine+sulfosate; aclonifen+atrazin+sulfosate; aclonifen+terbuthylazine+sulfosate; aclonifen+(S)-metolachlor+sulfosate; aclonifen+metolachlor +sulfosate; aclonifen+compound of the formula A+sulfosate; aclonifen+terbutryn+sulfosate; aclonifen+simazine+sulfosate; aclonifen+dimethenamid or (S)-dimethenamid +sulfosate; aclonifen+flufenacet+sulfosate; aclonifen+acetochlor+sulfosate; aclonifen +alachlor+sulfosate; aclonifen+isoxaflutole+sulfosate; aclonifen+isoxachlortole+sulfosate; aclonifen+mesotrione+sulfosate; aclonifen+sulcotrione+sulfosate; aclonifen +metosulam+sulfosate; aclonifen+flumetsulam+sulfosate; aclonifen+pendimethalin+sulfosate; aclonifen+bromoxynil+sulfosate; aclonifen+bentazone+sulfosate; aclonifen +carfentrazone+sulfosate; aclonifen+clomazone+sulfosate; aclonifen+nicosulfuron+sulfosate; aclonifen+rimsulfuron+sulfosate; aclonifen+halosulfuron+sulfosate; aclonifen+metribuzin+sulfosate; aclonifen+flumiclorac+sulfosate; aclonifen+prosulfuron+sulfosate; aclonifen+primisulfuron+sulfosate; aclonifen+dicamba+sulfosate; aclonifen+fluthiacet+sulfosate; aclonifen+pyridate+sulfosate; aclonifen+compound of the formula B+sulfosate; aclonifen+2,4-D+sulfosate; aclonifen+clopyralide+sulfosate; aclonifen+diflufenzopyr+sulfosate; aclonifen+fluroxypyr+sulfosate; aclonifen+MCPA+sulfosate; aclonifen+MCPB+sulfosate; aclonifen+MCPP +sulfosate; aclonifen+metobenzuron+sulfosate; aclonifen+thifensulfuron+sulfosate; aclonifen+EPTC+sulfosate; aclonifen+cyanazine+sulfosate; bifenox+atrazin+sulfosate; bifenox+terbuthylazine+sulfosate; bifenox+(S)-metolachlor+sulfosate; bifenox+metolachlor+sulfosate; bifenox+compound of the formula A+sulfosate; bifenox +terbutryn+sulfosate; bifenox+simazine+sulfosate; bifenox+dimethenamid or (S)-dimethenamid+sulfosate; bifenox+flufenacet+sulfosate; bifenox+acetochlor+sulfosate; bifenox+alachlor+sulfosate; bifenox+isoxaflutole+sulfosate; bifenox+isoxachlortole+sulfosate; bifenox+mesotrione+sulfosate; bifenox+sulcotrione+sulfosate; bifenox+metosulam+sulfosate; bifenox+flumetsulam+sulfosate; bifenox+pendimethalin+sulfosate; bifenox+bromoxynil+sulfosate; bifenox+bentazone+sulfosate; bifenox+carfentrazone+sulfosate; bifenox+clomazone+sulfosate; bifenox+nicosulfuron+sulfosate; bifenox+rimsulfuron+sulfosate; bifenox+halosulfuron+sulfosate; bifenox+metribuzin+sulfosate; bifenox+flumiclorac+sulfosate; bifenox+prosulfuron+sulfosate; bifenox+primisulfuron+sulfosate; bifenox+dicamba+sulfosate; bifenox+fluthiacet+sulfosate; bifenox+pyridate+sulfosate; bifenox+compound of the formula B+sulfosate; bifenox+2,4-D+sulfosate; bifenox+clopyralide+sulfosate; bifenox +diflufenzopyr+sulfosate; bifenox+fluroxypyr+sulfosate; bifenox+MCPA+sulfosate; bifenox+MCPB+sulfosate; bifenox+MCPP+sulfosate; bifenox+metobenzuron+sulfosate; bifenox+thifensulfuron+sulfosate; bifenox+aclonifen+sulfosate; bifenox+EPTC+sulfosate; bifenox+cyanazine+sulfosate; chlomitrofen+atrazin+sulfosate; chlomitrofen+terbuthylazine+sulfosate; chlomitrofen+(S)-metolachlor+sulfosate; chlomitrofen+metolachlor+sulfosate; chlomitrofen+compound of the formula A+sulfosate; chlomitrofen+terbutryn+sulfosate; chlomitrofen+simazine+sulfosate; chlomitrofen+dimethenamid or (S)-dimethenamid+sulfosate; chlomitrofen+flufenacet+sulfosate; chlomitrofen+acetochlor+sulfosate; chlomitrofen+alachlor+sulfosate; chlomitrofen+isoxaflutole+sulfosate; chlomitrofen+isoxachlortole+sulfosate; chlomitrofen+mesotrione+sulfosate; chlomitrofen+sulcotrione+sulfosate; chlomitrofen +metosulam+sulfosate; chlomitrofen+flumetsulam+sulfosate; chlomitrofen+pendimethalin+sulfosate; chlomitrofen+bromoxynil+sulfosate; chlomitrofen+bentazone +sulfosate; chlomitrofen+carfentrazone+sulfosate; chlomitrofen+clomazone+sulfosate; chlomitrofen+nicosulfuron+sulfosate; chlomitrofen+rimsulfuron+sulfosate; chlomitrofen+halosulfuron+sulfosate; chlomitrofen+metribuzin+sulfosate; chlomitrofen +flumiclorac+sulfosate; chlomitrofen+prosulfuron+sulfosate; chlomitrofen+primisulfuron+sulfosate; chlomitrofen+dicamba+sulfosate; chlomitrofen+fluthiacet+sulfosate; chlomitrofen+pyridate+sulfosate; chlomitrofen+compound of the formula B+sulfosate; chlomitrofen+2,4-D+sulfosate; chlomitrofen+clopyralide+sulfosate; chlomitrofen+diflufenzopyr+sulfosate; chlomitrofen+fluroxypyr+sulfosate; chlomitrofen +MCPA+sulfosate; chlomitrofen+MCPB+sulfosate; chlomitrofen+MCPP+sulfosate; chlomitrofen+metobenzuron+sulfosate; chlomitrofen+thifensulfuron+sulfosate; chlomitrofen+aclonifen+sulfosate; chlomitrofen+EPTC+sulfosate; chlomitrofen+cyanazine+sulfosate; ethoxyfen+atrazin+sulfosate; ethoxyfen+terbuthylazine+sulfosate; ethoxyfen+(S)-metolachlor+sulfosate; ethoxyfen+metolachlor+sulfosate; ethoxyfen+compound of the formula A+sulfosate; ethoxyfen+terbutryn+sulfosate; ethoxyfen+simazine+sulfosate; ethoxyfen+dimethenamid or (S)-dimethenamid+sulfosate; ethoxyfen+flufenacet+sulfosate; ethoxyfen+acetochlor+sulfosate; ethoxyfen +alachlor+sulfosate; ethoxyfen+isoxaflutole+sulfosate; ethoxyfen+isoxachlortole+sulfosate; ethoxyfen+mesotrione+sulfosate; ethoxyfen+sulcotrione+sulfosate; ethoxyfen+metosulam+sulfosate; ethoxyfen+flumetsulam+sulfosate; ethoxyfen+pendimethalin+sulfosate; ethoxyfen+bromoxynil+sulfosate; ethoxyfen+bentazone+sulfosate; ethoxyfen+carfentrazone+sulfosate; ethoxyfen+clomazone+sulfosate; ethoxyfen+nicosulfuron+sulfosate; ethoxyfen+rimsulfuron+sulfosate; ethoxyfen+halosulfuron+sulfosate; ethoxyfen+metribuzin+sulfosate; ethoxyfen+flumiclorac+sulfosate; ethoxyfen+prosulfuron+sulfosate; ethoxyfen+primisulfuron+sulfosate; ethoxyfen+dicamba+sulfosate; ethoxyfen+fluthiacet+sulfosate; ethoxyfen+pyridate+sulfosate; ethoxyfen+compound of the formula B+sulfosate; ethoxyfen+2,4-D+sulfosate; ethoxyfen+clopyralide+sulfosate; ethoxyfen+diflufenzopyr+sulfosate; ethoxyfen+fluroxypyr+sulfosate; ethoxyfen+MCPA+sulfosate; ethoxyfen+MCPB+sulfosate; ethoxyfen+MCPP+sulfosate; ethoxyfen+metobenzuron+sulfosate; ethoxyfen +thifensulfuron+sulfosate; ethoxyfen+aclonifen+sulfosate; ethoxyfen+EPTC+sulfosate; ethoxyfen+cyanazine+sulfosate; fluoroglycofen+atrazin+sulfosate; fluoroglycofen+terbuthylazine+sulfosate; fluoroglycofen+(S)-metolachlor+sulfosate; fluoroglycofen+metolachlor+sulfosate; fluoroglycofen+compound of the formula A+sulfosate; fluoroglycofen+terbutryn+sulfosate; fluoroglycofen+simazine+sulfosate; fluoroglycofen+dimethenamid or (S)-dimethenamid+sulfosate; fluoroglycofen+flufenacet +sulfosate; fluoroglycofen+acetochlor+sulfosate; fluoroglycofen+alachlor+sulfosate; fluoroglycofen+isoxaflutole+sulfosate; fluoroglycofen+isoxachlortole+sulfosate; fluoroglycofen+mesotrione+sulfosate; fluoroglycofen+sulcotrione+sulfosate; fluoroglycofen+metosulam+sulfosate; fluoroglycofen+flumetsulam+sulfosate; fluoroglycofen+pendimethalin+sulfosate; fluoroglycofen+bromoxynil+sulfosate; fluoroglycofen+bentazone+sulfosate; fluoroglycofen+carfentrazone+sulfosate; fluoroglycofen+clomazone+sulfosate; fluoroglycofen+nicosulfuron+sulfosate; fluoroglycofen+rimsulfuron+sulfosate; fluoroglycofen+halosulfuron+sulfosate; fluoroglycofen+metribuzin+sulfosate; fluoroglycofen+flumiclorac+sulfosate; fluoroglycofen+prosulfuron+sulfosate; fluoroglycofen+primisulfuron+sulfosate; fluoroglycofen+dicamba+sulfosate; fluoroglycofen+fluthiacet+sulfosate; fluoroglycofen +pyridate+sulfosate; fluoroglycofen+compound of the formula B+sulfosate; fluoroglycofen+2,4-D+sulfosate; fluoroglycofen+clopyralide+sulfosate; fluoroglycofen+diflufenzopyr+sulfosate; fluoroglycofen+fluroxypyr+sulfosate; fluoroglycofen+MCPA+sulfosate; fluoroglycofen+MCPB+sulfosate; fluoroglycofen+MCPP+sulfosate; fluoroglycofen+metobenzuron+sulfosate; fluoroglycofen+thifensulfuron+sulfosate; fluoroglycofen+aclonifen+sulfosate; fluoroglycofen+EPTC+sulfosate; fluoroglycofen+cyanazine+sulfosate; fomesafen+atrazin+sulfosate; fomesafen+terbuthylazine+sulfosate; fomesafen+(S)-metolachlor+sulfosate; fomesafen+metolachlor+sulfosate; fomesafen+compound of the formula A+sulfosate; fomesafen+terbutryn+sulfosate; fomesafen+simazine+sulfosate; fomesafen+dimethenamid or (S)-dimethenamid+sulfosate; fomesafen+flufenacet+sulfosate; fomesafen+acetochlor+sulfosate; fomesafen+alachlor+sulfosate; fomesafen+isoxaflutole+sulfosate; fomesafen+isoxachlortole+sulfosate; fomesafen+mesotrione+sulfosate; fomesafen+sulcotrione+sulfosate; fomesafen+metosulam+sulfosate; fomesafen+flumetsulam+sulfosate; fomesafen+pendimethalin+sulfosate; fomesafen+bromoxynil+sulfosate; fomesafen+bentazone+sulfosate; fomesafen+carfentrazone+sulfosate; fomesafen+clomazone+sulfosate; fomesafen+nicosulfuron+sulfosate; fomesafen+rimsulfuron+sulfosate; fomesafen+halosulfuron+sulfosate; fomesafen+metribuzin+sulfosate; fomesafen+flumiclorac+sulfosate; fomesafen+prosulfuron+sulfosate; fomesafen+primisulfuron+sulfosate; fomesafen+dicamba+sulfosate; fomesafen+fluthiacet+sulfosate; fomesafen +pyridate+sulfosate; fomesafen+compound of the formula B+sulfosate; fomesafen+2,4-D+sulfosate; fomesafen+clopyralide+sulfosate; fomesafen+diflufenzopyr+sulfosate; fomesafen+fluroxypyr+sulfosate; fomesafen+MCPA+sulfosate; fomesafen+MCPB+sulfosate; fomesafen+MCPP+sulfosate; fomesafen+metobenzuron+sulfosate; fomesafen+thifensulfuron+sulfosate; fomesafen+aclonifen+sulfosate; fomesafen+EPTC+sulfosate; fomesafen+cyanazine+sulfosate; lactofen+atrazin+sulfosate; lactofen+terbuthylazine+sulfosate; lactofen+(S)-metolachlor+sulfosate; lactofen+metolachlor+sulfosate; lactofen+compound of the formula A+sulfosate; lactofen+terbutryn+sulfosate; lactofen+simazine+sulfosate; lactofen+dimethenamid or (S)-dimethenamid+sulfosate; lactofen+flufenacet+sulfosate; lactofen+acetochlor+sulfosate; lactofen+alachlor+sulfosate; lactofen+isoxaflutole+sulfosate; lactofen+isoxachlortole+sulfosate; lactofen+mesotrione+sulfosate; lactofen+sulcotrione+sulfosate; lactofen+metosulam+sulfosate; lactofen+flumetsulam+sulfosate; lactofen+pendimethalin+sulfosate; lactofen+bromoxynil+sulfosate; lactofen+bentazone+sulfosate; lactofen+carfentrazone+sulfosate; lactofen+clomazone+sulfosate; lactofen +nicosulfuron+sulfosate; lactofen+rimsulfuron+sulfosate; lactofen+halosulfuron+sulfosate; lactofen+metribuzin+sulfosate; lactofen+flumiclorac+sulfosate; lactofen+prosulfuron+sulfosate; lactofen+primisulfuron+sulfosate; lactofen+dicamba+sulfosate; lactofen+fluthiacet+sulfosate; lactofen+pyridate+sulfosate; lactofen+compound of the formula B+sulfosate; lactofen+2,4-D+sulfosate; lactofen+clopyralide +sulfosate; lactofen+diflufenzopyr+sulfosate; lactofen+fluroxypyr+sulfosate; lactofen+MCPA+sulfosate; lactofen+MCPB+sulfosate; lactofen+MCPP+sulfosate; lactofen+metobenzuron+sulfosate; lactofen+thifensulfuron+sulfosate; lactofen+aclonifen+sulfosate; lactofen+EPTC+sulfosate; lactofen+cyanazine+sulfosate; oxyfluorfen+atrazin+sulfosate; oxyfluorfen+terbuthylazine+sulfosate; oxyfluorfen+(S)-metolachlor+sulfosate; oxyfluorfen+metolachlor+sulfosate; oxyfluorfen+compound of the formula A+sulfosate; oxyfluorfen+terbutryn+sulfosate; oxyfluorfen+simazine+sulfosate; oxyfluorfen+dimethenamid or (S)-dimethenamid+sulfosate; oxyfluorfen+flufenacet+sulfosate; oxyfluorfen+acetochlor+sulfosate; oxyfluorfen+alachlor+sulfosate; oxyfluorfen+isoxaflutole+sulfosate; oxyfluorfen+isoxachlortole+sulfosate; oxyfluorfen+mesotrione+sulfosate; oxyfluorfen+sulcotrione+sulfosate; oxyfluorfen+metosulam+sulfosate; oxyfluorfen+flumetsulam+sulfosate; oxyfluorfen+pendimethalin+sulfosate; oxyfluorfen+bromoxynil+sulfosate; oxyfluorfen+bentazone+sulfosate; oxyfluorfen+carfentrazone+sulfosate; oxyfluorfen+clomazone+sulfosate; oxyfluorfen+nicosulfuron +sulfosate; oxyfluorfen+rimsulfuron+sulfosate; oxyfluorfen+halosulfuron+sulfosate; oxyfluorfen+metribuzin+sulfosate; oxyfluorfen+flumiclorac+sulfosate; oxyfluorfen+prosulfuron+sulfosate; oxyfluorfen+primisulfuron+sulfosate; oxyfluorfen+dicamba+sulfosate; oxyfluorfen+fluthiacet+sulfosate; oxyfluorfen+pyridate+sulfosate; oxyfluorfen +compound of the formula B+sulfosate; oxyfluorfen+2,4-D+sulfosate; oxyfluorfen+clopyralide+sulfosate; oxyfluorfen+diflufenzopyr+sulfosate; oxyfluorfen+fluroxypyr+sulfosate; oxyfluorfen+MCPA+sulfosate; oxyfluorfen+MCPB+sulfosate; oxyfluorfen+MCPP+sulfosate; oxyfluorfen+metobenzuron+sulfosate; oxyfluorfen+thifensulfuron+sulfosate; oxyfluorfen+aclonifen+sulfosate; oxyfluorfen+EPTC+sulfosate; oxyfluorfen+cyanazine+sulfosate; azafenidin+atrazin+sulfosate; azafenidin+terbuthylazine+sulfosate; azafenidin+(S)-metolachlor+sulfosate; azafenidin+metolachlor+sulfosate; azafenidin+compound of the formula A+sulfosate; azafenidin+terbutryn+sulfosate; azafenidin+simazine+sulfosate; azafenidin+dimethenamid or (S)-dimethenamid+sulfosate; azafenidin+flufenacet+sulfosate; azafenidin+acetochlor+sulfosate; azafenidin+alachlor+sulfosate; azafenidin+isoxaflutole+sulfosate; azafenidin+isoxachlortole+sulfosate; azafenidin+mesotrione+sulfosate; azafenidin+sulcotrione+sulfosate; azafenidin+metosulam+sulfosate; azafenidin+flumetsulam+sulfosate; azafenidin+pendimethalin+sulfosate; azafenidin+bromoxynil+sulfosate; azafenidin+bentazone+sulfosate; azafenidin+carfentrazone+sulfosate; azafenidin+clomazone+sulfosate; azafenidin+nicosulfuron+sulfosate; azafenidin+rimsulfuron+sulfosate; azafenidin+halosulfuron+sulfosate; azafenidin+metribuzin+sulfosate; azafenidin+flumiclorac+sulfosate; azafenidin+prosulfuron+sulfosate; azafenidin+primisulfuron+sulfosate; azafenidin+dicamba+sulfosate; azafenidin+fluthiacet+sulfosate; azafenidin +pyridate+sulfosate; azafenidin+compound of the formula B+sulfosate; azafenidin+2,4-D+sulfosate; azafenidin+clopyralide+sulfosate; azafenidin+diflufenzopyr+sulfosate; azafenidin+fluroxypyr+sulfosate; azafenidin+MCPA+sulfosate; azafenidin+MCPB+sulfosate; azafenidin+MCPP+sulfosate; azafenidin+metobenzuron+sulfosate; azafenidin+thifensulfuron+sulfosate; azafenidin+aclonifen+sulfosate; azafenidin+EPTC+sulfosate; azafenidin+cyanazine+sulfosate; carfentrazone-ethyl+atrazin+sulfosate; carfentrazone-ethyl+terbuthylazine+sulfosate; carfentrazone-ethyl+(S)-metolachlor+sulfosate; carfentrazone-ethyl+metolachlor+sulfosate; carfentrazone-ethyl +compound of the formula A+sulfosate; carfentrazone-ethyl+terbutryn+sulfosate; carfentrazone-ethyl+simazine+sulfosate; carfentrazone-ethyl+dimethenamid or (S)-dimethenamid+sulfosate; carfentrazone-ethyl+flufenacet+sulfosate; carfentrazone-ethyl +acetochlor+sulfosate; carfentrazone-ethyl+alachlor+sulfosate; carfentrazone-ethyl+isoxaflutole+sulfosate; carfentrazone-ethyl+isoxachlortole+sulfosate; carfentrazone-ethyl+mesotrione+sulfosate; carfentrazone-ethyl+sulcotrione+sulfosate; carfentrazone-ethyl+metosulam+sulfosate; carfentrazone-ethyl+flumetsulam+sulfosate; carfentrazone-ethyl+pendimethalin+sulfosate; carfentrazone-ethyl+bromoxynil+sulfosate; carfentrazone-ethyl+bentazone+sulfosate; carfentrazone-ethyl+clomazone+sulfosate; carfentrazone-ethyl+nicosulfuron+sulfosate; carfentrazone-ethyl+rimsulfuron +sulfosate; carfentrazone-ethyl+halosulfuron+sulfosate; carfentrazone-ethyl+metribuzin +sulfosate; carfentrazone-ethyl+flumiclorac+sulfosate; carfentrazone-ethyl+prosulfuron +sulfosate; carfentrazone-ethyl+primisulfuron+sulfosate; carfentrazone-ethyl+dicamba +sulfosate; carfentrazone-ethyl+fluthiacet+sulfosate; carfentrazone-ethyl+pyridate+sulfosate; carfentrazone-ethyl+compound of the formula B+sulfosate; carfentrazone-ethyl +2,4-D+sulfosate; carfentrazone-ethyl+clopyralide+sulfosate; carfentrazone-ethyl+diflufenzopyr+sulfosate; carfentrazone-ethyl+fluroxypyr+sulfosate; carfentrazone-ethyl+MCPA+sulfosate; carfentrazone-ethyl+MCPB+sulfosate; carfentrazone-ethyl+MCPP+sulfosate; carfentrazone-ethyl+metobenzuron+sulfosate; carfentrazone-ethyl+thifensulfuron+sulfosate; carfentrazone-ethyl+aclonifen+sulfosate; carfentrazone-ethyl+EPTC+sulfosate; carfentrazone-ethyl+cyanazine+sulfosate; compound of the formula A +atrazin+sulfosate; compound of the formula A+terbuthylazine+sulfosate; compound of the formula A+(S)-metolachlor+sulfosate; compound of the formula A+metolachlor+sulfosate; compound of the formula A+terbutryn+sulfosate; compound of the formula A+simazine+sulfosate; compound of the formula A+dimethenamid or (S)-dimethenamid+sulfosate; compound of the formula A+flufenacet+sulfosate; compound of the formula A +acetochlor+sulfosate; compound of the formula A+alachlor; compound of the formula A +isoxaflutole+sulfosate; compound of the formula A+isoxachlortole+sulfosate; compound of the formula A+mesotrione+sulfosate; compound of the formula A+sulcotrione+sulfosate; compound of the formula A+metosulam+sulfosate; compound of the formula A+flumetsulam+sulfosate; compound of the formula A+pendimethalin+sulfosate; compound of the formula A+bromoxynil+sulfosate; compound of the formula A +bentazone+sulfosate; compound of the formula A+carfentrazone+sulfosate; compound of the formula A+clomazone+sulfosate; compound of the formula A+nicosulfuron+sulfosate; compound of the formula A+rimsulfuron+sulfosate; compound of the formula A+halosulfuron+sulfosate; compound of the formula A+metribuzin+sulfosate; compound of the formula A+flumiclorac+sulfosate; compound of the formula A +prosulfuron+sulfosate; compound of the formula A+primisulfuron+sulfosate; compound of the formula A+dicamba+sulfosate; compound of the formula A+fluthiacet +sulfosate; compound of the formula A+pyridate+sulfosate; compound of the formula A +compound of the formula B+sulfosate; compound of the formula A+2,4-D+sulfosate; compound of the formula A+clopyralide+sulfosate; compound of the formula A+diflufenzopyr+sulfosate; compound of the formula A+fluroxypyr+sulfosate; compound of the formula A+MCPA+sulfosate; compound of the formula A+MCPB+sulfosate; compound of the formula A+MCPP+sulfosate; compound of the formula A+metobenzuron+sulfosate; compound of the formula A+thifensulfuron+sulfosate; compound of the formula A+aclonifen+sulfosate; compound of the formula A+EPTC+sulfosate; compound of the formula A+cyanazine+sulfosate; cinidon-ethyl+atrazin+sulfosate; cinidon-ethyl+terbuthylazine+sulfosate; cinidon-ethyl+(S)-metolachlor+sulfosate; cinidon-ethyl+metolachlor+sulfosate; cinidon-ethyl+compound of the formula A+sulfosate; cinidon-ethyl+terbutryn+sulfosate; cinidon-ethyl+simazine+sulfosate; cinidon-ethyl+dimethenamid or (S)-dimethenamid+sulfosate; cinidon-ethyl+flufenacet+sulfosate; cinidon-ethyl+acetochlor+sulfosate; cinidon-ethyl+alachlor+sulfosate; cinidon-ethyl+isoxaflutole+sulfosate; cinidon-ethyl+isoxachlortole+sulfosate; cinidon-ethyl+mesotrione+sulfosate; cinidon-ethyl+sulcotrione+sulfosate; cinidon-ethyl+metosulam+sulfosate; cinidon-ethyl+flumetsulam+sulfosate; cinidon-ethyl+pendimethalin+sulfosate; cinidon-ethyl+bromoxynil+sulfosate; cinidon-ethyl+bentazone +sulfosate; cinidon-ethyl+carfentrazone+sulfosate; cinidon-ethyl+clomazone+sulfosate; cinidon-ethyl+nicosulfuron+sulfosate; cinidon-ethyl+rimsulfuron+sulfosate; cinidon-ethyl+halosulfuron+sulfosate; cinidon-ethyl+metribuzin+sulfosate; cinidon-ethyl +flumiclorac+sulfosate; cinidon-ethyl+prosulfuron+sulfosate; cinidon-ethyl+primisulfuron+sulfosate; cinidon-ethyl+dicamba+sulfosate; cinidon-ethyl+fluthiacet+sulfosate; cinidon-ethyl+pyridate+sulfosate; cinidon-ethyl+compound of the formula B+sulfosate; cinidon-ethyl+2,4-D+sulfosate; cinidon-ethyl+clopyralide+sulfosate; cinidon-ethyl+diflufenzopyr+sulfosate; cinidon-ethyl+fluroxypyr+sulfosate; cinidon-ethyl+MCPA+sulfosate; cinidon-ethyl+MCPB+sulfosate; cinidon-ethyl+MCPP+sulfosate; cinidon-ethyl+metobenzuron+sulfosate; cinidon-ethyl+thifensulfuron+sulfosate; cinidon-ethyl+aclonifen+sulfosate; cinidon-ethyl+EPTC+sulfosate; cinidon-ethyl+cyanazine+sulfosate; flumiclorac-pentyl+atrazin+sulfosate; flumiclorac-pentyl+terbuthylazine+sulfosate; flumiclorac-pentyl+(S)-metolachlor+sulfosate; flumiclorac-pentyl+metolachlor+sulfosate; flumiclorac-pentyl+compound of the formula A+sulfosate; flumiclorac-pentyl+terbutryn+sulfosate; flumiclorac-pentyl+simazine+sulfosate; flumiclorac-pentyl+dimethenamid or (S)-dimethenamid+sulfosate; flumiclorac-pentyl+flufenacet+sulfosate; flumiclorac-pentyl+acetochlor+sulfosate; flumiclorac-pentyl+alachlor+sulfosate; flumiclorac-pentyl+isoxaflutole+sulfosate; flumiclorac-pentyl +isoxachlortole+sulfosate; flumiclorac-pentyl+mesotrione+sulfosate; flumiclorac-pentyl +sulcotrione+sulfosate; flumiclorac-pentyl+metosulam+sulfosate; flumiclorac-pentyl+flumetsulam+sulfosate; flumiclorac-pentyl+pendimethalin+sulfosate; flumiclorac-pentyl+bromoxynil+sulfosate; flumiclorac-pentyl+bentazone+sulfosate; flumiclorac-pentyl+carfentrazone+sulfosate; flumiclorac-pentyl+clomazone+sulfosate; flumiclorac-pentyl+nicosulfuron+sulfosate; flumiclorac-pentyl+rimsulfuron+sulfosate; flumiclorac-pentyl+halosulfuron+sulfosate; flumiclorac-pentyl+metribuzin+sulfosate; flumiclorac-pentyl+prosulfuron+sulfosate; flumiclorac-pentyl+primisulfuron+sulfosate; flumiclorac-pentyl+dicamba+sulfosate; flumiclorac-pentyl+fluthiacet+sulfosate; flumiclorac-pentyl+pyridate +sulfosate; flumiclorac-pentyl+compound of the formula B+sulfosate; flumiclorac-pentyl +2,4-D+sulfosate; flumiclorac-pentyl+clopyralide+sulfosate; flumiclorac-pentyl+diflufenzopyr+sulfosate; flumiclorac-pentyl+fluroxypyr+sulfosate; flumiclorac-pentyl+MCPA+sulfosate; flumiclorac-pentyl+MCPB+sulfosate; flumiclorac-pentyl+MCPP+sulfosate; flumiclorac-pentyl+metobenzuron+sulfosate; flumiclorac-pentyl+thifensulfuron +sulfosate; flumiclorac-pentyl+aclonifen+sulfosate; flumiclorac-pentyl+EPTC+sulfosate; flumiclorac-pentyl+cyanazine+sulfosate; flumioxazin+atrazin+sulfosate; flumioxazin+terbuthylazine+sulfosate; flumioxazin+(S)-metolachlor+sulfosate; flumioxazin+metolachlor+sulfosate; flumioxazin+compound of the formula A+sulfosate; flumioxazin+terbutryn+sulfosate; flumioxazin+simazine+sulfosate; flumioxazin+dimethenamid or (S)-dimethenamid+sulfosate; flumioxazin+flufenacet+sulfosate; flumioxazin+acetochlor+sulfosate; flumioxazin+alachlor+sulfosate; flumioxazin+isoxaflutole+sulfosate; flumioxazin+isoxachlortole+sulfosate; flumioxazin+mesotrione+sulfosate; flumioxazin+sulcotrione+sulfosate; flumioxazin+metosulam+sulfosate; flumioxazin+flumetsulam+sulfosate; flumioxazin+pendimethalin+sulfosate; flumioxazin +bromoxynil+sulfosate; flumioxazin+bentazone+sulfosate; flumioxazin+carfentrazone +sulfosate; flumioxazin+clomazone+sulfosate; flumioxazin+nicosulfuron+sulfosate; flumioxazin+rimsulfuron+sulfosate; flumioxazin+halosulfuron+sulfosate; flumioxazin+metribuzin+sulfosate; flumioxazin+flumiclorac+sulfosate; flumioxazin+prosulfuron+sulfosate; flumioxazin+primisulfuron+sulfosate; flumioxazin+dicamba+sulfosate; flumioxazin+fluthiacet+sulfosate; flumioxazin+pyridate+sulfosate; flumioxazin+compound of the formula B+sulfosate; flumioxazin+2,4-D+sulfosate; flumioxazin+clopyralide+sulfosate; flumioxazin+diflufenzopyr+sulfosate; flumioxazin+fluroxypyr+sulfosate; flumioxazin+MCPA+sulfosate; flumioxazin+MCPB+sulfosate; flumioxazin+MCPP+sulfosate; flumioxazin+metobenzuron+sulfosate; flumioxazin+thifensulfuron+sulfosate; flumioxazin+aclonifen+sulfosate; flumioxazin+EPTC+sulfosate; flumioxazin +cyanazine+sulfosate; fluthiacet-methyl+atrazin+sulfosate; fluthiacet-methyl+terbuthylazine+sulfosate; fluthiacet-methyl+(S)-metolachlor+sulfosate; fluthiacet-methyl +metolachlor+sulfosate; fluthiacet-methyl+compound of the formula A+sulfosate; fluthiacet-methyl+terbutryn+sulfosate; fluthiacet-methyl+simazine+sulfosate; fluthiacet-methyl+dimethenamid or (S)-dimethenamid+sulfosate; fluthiacet-methyl+flufenacet+sulfosate; fluthiacet-methyl+acetochlor+sulfosate; fluthiacet-methyl+alachlor+sulfosate; fluthiacet-methyl+isoxaflutole+sulfosate; fluthiacet-methyl+isoxachlortole+sulfosate; fluthiacet-methyl+mesotrione+sulfosate; fluthiacet-methyl+sulcotrione+sulfosate; fluthiacet-methyl+metosulam+sulfosate; fluthiacet-methyl+flumetsulam+sulfosate; fluthiacet-methyl+pendimethalin+sulfosate; fluthiacet-methyl+bromoxynil+sulfosate; fluthiacet-methyl+bentazone+sulfosate; fluthiacet-methyl+carfentrazone+sulfosate; fluthiacet-methyl+clomazone+sulfosate; fluthiacet-methyl+nicosulfuron+sulfosate; fluthiacet-methyl+rimsulfuron+sulfosate; fluthiacet-methyl+halosulfuron+sulfosate; fluthiacet-methyl+metribuzin+sulfosate; fluthiacet-methyl+flumiclorac+sulfosate; fluthiacet-methyl+prosulfuron+sulfosate; fluthiacet-methyl+primisulfuron+sulfosate; fluthiacet-methyl+dicamba+sulfosate; fluthiacet-methyl+pyridate+sulfosate; fluthiacet-methyl+compound of the formula B+sulfosate; fluthiacet-methyl+2,4-D+sulfosate; fluthiacet-methyl+clopyralide+sulfosate; fluthiacet-methyl+diflufenzopyr+sulfosate; fluthiacet-methyl+fluroxypyr+sulfosate; fluthiacet-methyl+MCPA+sulfosate; fluthiacet-methyl+MCPB+sulfosate; fluthiacet-methyl+MCPP+sulfosate; fluthiacet-methyl+metobenzuron+sulfosate; fluthiacet-methyl+thifensulfuron+sulfosate; fluthiacet-methyl+aclonifen+sulfosate; fluthiacet-methyl+EPTC+sulfosate; fluthiacet-methyl+cyanazine+sulfosate; oxadiargyl+atrazin+sulfosate; oxadiargyl+terbuthylazine+sulfosate; oxadiargyl+(S)-metolachlor+sulfosate; oxadiargyl+metolachlor+sulfosate; oxadiargyl+compound of the formula A+sulfosate; oxadiargyl+terbutryn+sulfosate; oxadiargyl+simazine+sulfosate; oxadiargyl+dimethenamid or (S)-dimethenamid+sulfosate; oxadiargyl+flufenacet+sulfosate; oxadiargyl+acetochlor+sulfosate; oxadiargyl+alachlor+sulfosate; oxadiargyl+isoxaflutole+sulfosate; oxadiargyl+isoxachlortole+sulfosate; oxadiargyl+mesotrione+sulfosate; oxadiargyl+sulcotrione+sulfosate; oxadiargyl+metosulam+sulfosate; oxadiargyl+flumetsulam+sulfosate; oxadiargyl+pendimethalin+sulfosate; oxadiargyl+bromoxynil+sulfosate; oxadiargyl+bentazone+sulfosate; oxadiargyl+carfentrazone+sulfosate; oxadiargyl+clomazone+sulfosate; oxadiargyl+nicosulfuron+sulfosate; oxadiargyl+rimsulfuron+sulfosate; oxadiargyl+halosulfuron+sulfosate; oxadiargyl+metribuzin+sulfosate; oxadiargyl+flumiclorac+sulfosate; oxadiargyl+prosulfuron+sulfosate; oxadiargyl+primisulfuron+sulfosate; oxadiargyl+dicamba+sulfosate; oxadiargyl+fluthiacet+sulfosate; oxadiargyl+pyridate +sulfosate; oxadiargyl+compound of the formula B+sulfosate; oxadiargyl+2,4-D+sulfosate; oxadiargyl+clopyralide+sulfosate; oxadiargyl+diflufenzopyr+sulfosate; oxadiargyl+fluroxypyr+sulfosate; oxadiargyl+MCPA+sulfosate; oxadiargyl+MCPB+sulfosate; oxadiargyl+MCPP+sulfosate; oxadiargyl+metobenzuron+sulfosate; oxadiargyl+thifensulfuron+sulfosate; oxadiargyl+aclonifen+sulfosate; oxadiargyl+EPTC+sulfosate; oxadiargyl+cyanazine+sulfosate; oxadiazon+atrazin+sulfosate; oxadiazon+terbuthylazine+sulfosate; oxadiazon+(S)-metolachlor+sulfosate; oxadiazon +metolachlor+sulfosate; oxadiazon+compound of the formula A+sulfosate; oxadiazon+terbutryn+sulfosate; oxadiazon+simazine+sulfosate; oxadiazon+dimethenamid or (S)-dimethenamid+sulfosate; oxadiazon+flufenacet+sulfosate; oxadiazon+acetochlor+sulfosate; oxadiazon+alachlor+sulfosate; oxadiazon+isoxaflutole+sulfosate; oxadiazon +isoxachlortole+sulfosate; oxadiazon+mesotrione+sulfosate; oxadiazon+sulcotrione+sulfosate; oxadiazon+metosulam+sulfosate; oxadiazon+flumetsulam+sulfosate; oxadiazon+pendimethalin+sulfosate; oxadiazon+bromoxynil+sulfosate; oxadiazon+bentazone+sulfosate; oxadiazon+carfentrazone+sulfosate; oxadiazon+clomazone+sulfosate; oxadiazon+nicosulfuron+sulfosate; oxadiazon+rimsulfuron+sulfosate; oxadiazon+halosulfuron+sulfosate; oxadiazon+metribuzin+sulfosate; oxadiazon+flumiclorac+sulfosate; oxadiazon+prosulfuron+sulfosate; oxadiazon+primisulfuron+sulfosate; oxadiazon+dicamba+sulfosate; oxadiazon+fluthiacet+sulfosate; oxadiazon+pyridate+sulfosate; oxadiazon+compound of the formula B+sulfosate; oxadiazon+2,4-D+sulfosate; oxadiazon+clopyralide+sulfosate; oxadiazon+diflufenzopyr+sulfosate; oxadiazon+fluroxypyr+sulfosate; oxadiazon+MCPA+sulfosate; oxadiazon+MCPB+sulfosate; oxadiazon+MCPP+sulfosate; oxadiazon+metobenzuron+sulfosate; oxadiazon+thifensulfuron+sulfosate; oxadiazon+aclonifen+sulfosate; oxadiazon+EPTC+sulfosate; oxadiazon+cyanazine+sulfosate; pentoxazone+atrazin+sulfosate; pentoxazone+terbuthylazine+sulfosate; pentoxazone+(S)-metolachlor+sulfosate; pentoxazone+metolachlor+sulfosate; pentoxazone+compound of the formula A+sulfosate; pentoxazone+terbutryn+sulfosate; pentoxazone+simazine+sulfosate; pentoxazone+dimethenamid or (S)-dimethenamid+sulfosate; pentoxazone+flufenacet +sulfosate; pentoxazone+acetochlor+sulfosate; pentoxazone+alachlor+sulfosate; pentoxazone+isoxaflutole+sulfosate; pentoxazone+isoxachlortole+sulfosate; pentoxazone+mesotrione+sulfosate; pentoxazone+sulcotrione+sulfosate; pentoxazone+metosulam+sulfosate; pentoxazone+flumetsulam+sulfosate; pentoxazone+pendimethalin+sulfosate; pentoxazone+bromoxynil+sulfosate; pentoxazone+bentazone+sulfosate; pentoxazone+carfentrazone+sulfosate; pentoxazone+clomazone+sulfosate; pentoxazone+nicosulfuron+sulfosate; pentoxazone+rimsulfuron+sulfosate; pentoxazone+halosulfuron+sulfosate; pentoxazone+metribuzin+sulfosate; pentoxazone+flumiclorac+sulfosate; pentoxazone+prosulfuron+sulfosate; pentoxazone+primisulfuron+sulfosate; pentoxazone+dicamba+sulfosate; pentoxazone+fluthiacet+sulfosate; pentoxazone+pyridate+sulfosate; pentoxazone+compound of the formula B+sulfosate; pentoxazone +2,4-D+sulfosate; pentoxazone+clopyralide+sulfosate; pentoxazone+diflufenzopyr+sulfosate; pentoxazone+fluroxypyr+sulfosate; pentoxazone+MCPA+sulfosate; pentoxazone+MCPB+sulfosate; pentoxazone+MCPP+sulfosate; pentoxazone+metobenzuron+sulfosate; pentoxazone+thifensulfuron+sulfosate; pentoxazone+aclonifen+sulfosate; pentoxazone+EPTC+sulfosate; pentoxazone+cyanazine+sulfosate; sulfentrazone+atrazin+sulfosate; sulfentrazone+terbuthylazine+sulfosate; sulfentrazone+(S)-metolachlor+sulfosate; sulfentrazone+metolachlor+sulfosate; sulfentrazone+compound of the formula A+sulfosate; sulfentrazone+terbutryn+sulfosate; sulfentrazone+simazine+sulfosate; sulfentrazone+dimethenamid or (S)-dimethenamid+sulfosate; sulfentrazone+flufenacet+sulfosate; sulfentrazone+acetochlor+sulfosate; sulfentrazone+alachlor+sulfosate; sulfentrazone+isoxaflutole+sulfosate; sulfentrazone+isoxachlortole+sulfosate; sulfentrazone+mesotrione+sulfosate; sulfentrazone+sulcotrione+sulfosate; sulfentrazone+metosulam+sulfosate; sulfentrazone+flumetsulam+sulfosate; sulfentrazone+pendimethalin+sulfosate; sulfentrazone+bromoxynil+sulfosate; sulfentrazone+bentazone+sulfosate; sulfentrazone+carfentrazone+sulfosate; sulfentrazone+clomazone+sulfosate; sulfentrazone+nicosulfuron+sulfosate; sulfentrazone+rimsulfuron+sulfosate; sulfentrazone+halosulfuron+sulfosate; sulfentrazone+metribuzin+sulfosate; sulfentrazone+flumiclorac+sulfosate; sulfentrazone+prosulfuron+sulfosate; sulfentrazone+primisulfuron+sulfosate; sulfentrazone+dicamba+sulfosate; sulfentrazone+fluthiacet+sulfosate; sulfentrazone+pyridate+sulfosate; sulfentrazone+compound of the formula B+sulfosate; sulfentrazone+2,4-D+sulfosate; sulfentrazone+clopyralide+sulfosate; sulfentrazone+diflufenzopyr+sulfosate; sulfentrazone+fluroxypyr +sulfosate; sulfentrazone+MCPA+sulfosate; sulfentrazone+MCPB+sulfosate; sulfentrazone+MCPP+sulfosate; sulfentrazone+metobenzuron+sulfosate; sulfentrazone+thifensulfuron+sulfosate; sulfentrazone+aclonifen+sulfosate; sulfentrazone+EPTC+sulfosate; sulfentrazone+cyanazine+sulfosate; fluazolate+atrazin+sulfosate; fluazolate+terbuthylazine+sulfosate; fluazolate+(S)-metolachlor+sulfosate; fluazolate+metolachlor+sulfosate; fluazolate+compound of the formula A+sulfosate; fluazolate+terbutryn+sulfosate; fluazolate+simazine+sulfosate; fluazolate +dimethenamid or (S)-dimethenamid+sulfosate; fluazolate+flufenacet+sulfosate; fluazolate+acetochlor+sulfosate; fluazolate+alachlor+sulfosate; fluazolate+isoxaflutole+sulfosate; fluazolate+isoxachlortole+sulfosate; fluazolate+mesotrione+sulfosate; fluazolate+sulcotrione+sulfosate; fluazolate+metosulam+sulfosate; fluazolate+flumetsulam+sulfosate; fluazolate+pendimethalin+sulfosate; fluazolate+bromoxynil+sulfosate; fluazolate+bentazone+sulfosate; fluazolate+carfentrazone+sulfosate; fluazolate+clomazone+sulfosate; fluazolate+nicosulfuron+sulfosate; fluazolate+rimsulfuron+sulfosate; fluazolate+halosulfuron+sulfosate; fluazolate+metribuzin+sulfosate; fluazolate+flumiclorac+sulfosate; fluazolate+prosulfuron+sulfosate; fluazolate+primisulfuron+sulfosate; fluazolate+dicamba+sulfosate; fluazolate+fluthiacet+sulfosate; fluazolate+pyridate+sulfosate; fluazolate+compound of the formula B+sulfosate; fluazolate+2,4-D+sulfosate; fluazolate+clopyralide+sulfosate; fluazolate+diflufenzopyr+sulfosate; fluazolate+fluroxypyr+sulfosate; fluazolate+MCPA+sulfosate; fluazolate+MCPB+sulfosate; fluazolate+MCPP+sulfosate; fluazolate+metobenzuron+sulfosate; fluazolate+thifensulfuron+sulfosate; fluazolate+aclonifen+sulfosate; fluazolate+EPTC+sulfosate; fluazolate+cyanazine+sulfosate; pyraflufen-ethyl+atrazin+sulfosate; pyraflufen-ethyl+terbuthylazine+sulfosate; pyraflufen-ethyl+(S)-metolachlor+sulfosate; pyraflufen-ethyl +metolachlor+sulfosate; pyraflufen-ethyl+compound of the formula A+sulfosate; pyraflufen-ethyl+terbutryn+sulfosate; pyraflufen-ethyl+simazine+sulfosate; pyraflufen-ethyl+dimethenamid or (S)-dimethenamid+sulfosate; pyraflufen-ethyl+flufenacet+sulfosate; pyraflufen-ethyl+acetochlor+sulfosate; pyraflufen-ethyl+alachlor+sulfosate; pyraflufen-ethyl+isoxaflutole+sulfosate; pyraflufen-ethyl+isoxachlortole+sulfosate; pyraflufen-ethyl+mesotrione+sulfosate; pyraflufen-ethyl+sulcotrione+sulfosate; pyraflufen-ethyl+metosulam+sulfosate; pyraflufen-ethyl+flumetsulam+sulfosate; pyraflufen-ethyl+pendimethalin+sulfosate; pyraflufen-ethyl+bromoxynil+sulfosate; pyraflufen-ethyl+bentazone+sulfosate; pyraflufen-ethyl+carfentrazone+sulfosate; pyraflufen-ethyl+clomazone+sulfosate; pyraflufen-ethyl+nicosulfuron+sulfosate; pyraflufen-ethyl+rimsulfuron+sulfosate; pyraflufen-ethyl+halosulfuron+sulfosate; pyraflufen-ethyl+metribuzin+sulfosate; pyraflufen-ethyl+flumiclorac+sulfosate; pyraflufen-ethyl+prosulfuron+sulfosate; pyraflufen-ethyl+primisulfuron+sulfosate; pyraflufen-ethyl+dicamba+sulfosate; pyraflufen-ethyl+fluthiacet+sulfosate; pyraflufen-ethyl+pyridate+sulfosate; pyraflufen-ethyl+compound of the formula B+sulfosate; pyraflufen-ethyl+2,4-D+sulfosate; pyraflufen-ethyl+clopyralide+sulfosate; pyraflufen-ethyl+diflufenzopyr+sulfosate; pyraflufen-ethyl+fluroxypyr+sulfosate; pyraflufen-ethyl +MCPA+sulfosate; pyraflufen-ethyl+MCPB+sulfosate; pyraflufen-ethyl+MCPP+sulfosate; pyraflufen-ethyl+metobenzuron+sulfosate; pyraflufen-ethyl+thifensulfuron+sulfosate; pyraflufen-ethyl+aclonifen+sulfosate; pyraflufen-ethyl+EPTC+sulfosate; pyraflufen-ethyl+cyanazine+sulfosate; flumipropyn+atrazin+sulfosate; flumipropyn+terbuthylazine+sulfosate; flumipropyn+(S)-metolachlor+sulfosate; flumipropyn+metolachlor+sulfosate; flumipropyn+compound of the formula A+sulfosate; flumipropyn +terbutryn+sulfosate; flumipropyn+simazine+sulfosate; flumipropyn+dimethenamid or (S)-dimethenamid+sulfosate; flumipropyn+flufenacet+sulfosate; flumipropyn+acetochlor+sulfosate; flumipropyn+alachlor+sulfosate; flumipropyn+isoxaflutole+sulfosate; flumipropyn+isoxachlortole+sulfosate; flumipropyn+mesotrione+sulfosate; flumipropyn+sulcotrione+sulfosate; flumipropyn+metosulam+sulfosate; flumipropyn+flumetsulam+sulfosate; flumipropyn+pendimethalin+sulfosate; flumipropyn+bromoxynil +sulfosate; flumipropyn+bentazone+sulfosate; flumipropyn+carfentrazone+sulfosate; flumipropyn+clomazone+sulfosate; flumipropyn+nicosulfuron+sulfosate; flumipropyn+rimsulfuron+sulfosate; flumipropyn+halosulfuron+sulfosate; flumipropyn+metribuzin+sulfosate; flumipropyn+flumiclorac+sulfosate; flumipropyn+prosulfuron+sulfosate; flumipropyn+primisulfuron+sulfosate; flumipropyn+dicamba+sulfosate; flumipropyn+fluthiacet+sulfosate; flumipropyn+pyridate+sulfosate; flumipropyn+compound of the formula B+sulfosate; flumipropyn+2,4-D+sulfosate; flumipropyn+clopyralide+sulfosate; flumipropyn+diflufenzopyr+sulfosate; flumipropyn+fluroxypyr+sulfosate; flumipropyn+MCPA+sulfosate; flumipropyn+MCPB+sulfosate; flumipropyn+MCPP+sulfosate; flumipropyn+metobenzuron+sulfosate; flumipropyn+thifensulfuron+sulfosate; flumipropyn+aclonifen+sulfosate; flumipropyn+EPTC+sulfosate; flumipropyn +cyanazine+sulfosate; flupropacil+atrazin+sulfosate; flupropacil+terbuthylazine+sulfosate; flupropacil+(S)-metolachlor+sulfosate; flupropacil+metolachlor+sulfosate; flupropacil+compound of the formula A+sulfosate; flupropacil+terbutryn+sulfosate; flupropacil+simazine+sulfosate; flupropacil+dimethenamid or (S)-dimethenamid+sulfosate; flupropacil+flufenacet+sulfosate; flupropacil+acetochlor+sulfosate; flupropacil+alachlor+sulfosate; flupropacil+isoxaflutole+sulfosate; flupropacil+isoxachlortole+sulfosate; flupropacil+mesotrione+sulfosate; flupropacil+sulcotrione+sulfosate; flupropacil+metosulam+sulfosate; flupropacil+flumetsulam+sulfosate; flupropacil+pendimethalin+sulfosate; flupropacil+bromoxynil+sulfosate; flupropacil+bentazone+sulfosate; flupropacil+carfentrazone+sulfosate; flupropacil+clomazone+sulfosate; flupropacil+nicosulfuron+sulfosate; flupropacil+rimsulfuron+sulfosate; flupropacil+halosulfuron+sulfosate; flupropacil+metribuzin+sulfosate; flupropacil+flumiclorac+sulfosate; flupropacil+prosulfuron+sulfosate; flupropacil+primisulfuron+sulfosate; flupropacil+dicamba+sulfosate; flupropacil+fluthiacet+sulfosate; flupropacil+pyridate+sulfosate; flupropacil+compound of the formula B+sulfosate; flupropacil+2,4-D+sulfosate; flupropacil+clopyralide+sulfosate; flupropacil+diflufenzopyr+sulfosate; flupropacil+fluroxypyr+sulfosate; flupropacil+MCPA+sulfosate; flupropacil+MCPB+sulfosate; flupropacil+MCPP+sulfosate; flupropacil+metobenzuron+sulfosate; flupropacil+thifensulfuron+sulfosate; flupropacil+aclonifen+sulfosate; flupropacil+EPTC+sulfosate; flupropacil+cyanazine+sulfosate; nipyraclofen+atrazin+sulfosate; nipyraclofen+terbuthylazine+sulfosate; nipyraclofen+(S)-metolachlor+sulfosate; nipyraclofen+metolachlor+sulfosate; nipyraclofen+compound of the formula A+sulfosate; nipyraclofen+terbutryn+sulfosate; nipyraclofen+simazine+sulfosate; nipyraclofen+dimethenamid or (S)-dimethenamid+sulfosate; nipyraclofen+flufenacet+sulfosate; nipyraclofen+acetochlor+sulfosate; nipyraclofen+alachlor+sulfosate; nipyraclofen+isoxaflutole+sulfosate; nipyraclofen+isoxachlortole+sulfosate; nipyraclofen+mesotrione+sulfosate; nipyraclofen+sulcotrione+sulfosate; nipyraclofen+metosulam+sulfosate; nipyraclofen+flumetsulam+sulfosate; nipyraclofen+pendimethalin+sulfosate; nipyraclofen+bromoxynil+sulfosate; nipyraclofen+bentazone +sulfosate; nipyraclofen+carfentrazone+sulfosate; nipyraclofen+clomazone+sulfosate; nipyraclofen+nicosulfuron+sulfosate; nipyraclofen+rimsulfuron+sulfosate; nipyraclofen +halosulfuron+sulfosate; nipyraclofen+metribuzin+sulfosate; nipyraclofen+flumiclorac +sulfosate; nipyraclofen+prosulfuron+sulfosate; nipyraclofen+primisulfuron+sulfosate; nipyraclofen+dicamba+sulfosate; nipyraclofen+fluthiacet+sulfosate; nipyraclofen+pyridate+sulfosate; nipyraclofen+compound of the formula B+sulfosate; nipyraclofen+2,4-D+sulfosate; nipyraclofen+clopyralide+sulfosate; nipyraclofen+diflufenzopyr+sulfosate; nipyraclofen+fluroxypyr+sulfosate; nipyraclofen+MCPA+sulfosate; nipyraclofen+MCPB+sulfosate; nipyraclofen+MCPP+sulfosate; nipyraclofen+metobenzuron+sulfosate; nipyraclofen+thifensulfuron+sulfosate; nipyraclofen+aclonifen+sulfosate; nipyraclofen+EPTC+sulfosate; nipyraclofen+cyanazine+sulfosate; benzfendizone+atrazin+sulfosate; benzfendizone+terbuthylazine+sulfosate; benzfendizone+(S)-metolachlor+sulfosate; benzfendizone+metolachlor+sulfosate; benzfendizone+compound of the formula A+sulfosate; benzfendizone+terbutryn+sulfosate; benzfendizone+simazine+sulfosate; benzfendizone+dimethenamid or (S)-dimethenamid+sulfosate; benzfendizone+flufenacet+sulfosate; benzfendizone+acetochlor+sulfosate; benzfendizone+alachlor+sulfosate; benzfendizone+isoxaflutole +sulfosate; benzfendizone+isoxachlortole+sulfosate; benzfendizone+mesotrione+sulfosate; benzfendizone+sulcotrione+sulfosate; benzfendizone+metosulam+sulfosate; benzfendizone+flumetsulam+sulfosate; benzfendizone+pendimethalin+sulfosate; benzfendizone+bromoxynil+sulfosate; benzfendizone+bentazone+sulfosate; benzfendizone+carfentrazone+sulfosate; benzfendizone+clomazone+sulfosate; benzfendizone+nicosulfuron+sulfosate; benzfendizone+rimsulfuron+sulfosate; benzfendizone+halosulfuron+sulfosate; benzfendizone+metribuzin+sulfosate; benzfendizone+flumiclorac+sulfosate; benzfendizone+prosulfuron+sulfosate; benzfendizone+primisulfuron+sulfosate; benzfendizone+dicamba+sulfosate; benzfendizone+fluthiacet+sulfosate; benzfendizone+pyridate+sulfosate; benzfendizone+compound of the formula B+sulfosate; benzfendizone+2,4-D+sulfosate; benzfendizone+clopyralide+sulfosate; benzfendizone+diflufenzopyr+sulfosate; benzfendizone+fluroxypyr+sulfosate; benzfendizone+MCPA+sulfosate; benzfendizone+MCPB+sulfosate; benzfendizone+MCPP+sulfosate; benzfendizone+metobenzuron+sulfosate; benzfendizone+thifensulfuron+sulfosate; benzfendizone+aclonifen+sulfosate; benzfendizone+EPTC+sulfosate; benzfendizone+cyanazine+sulfosate; thidiazimin+atrazin+sulfosate; thidiazimin+terbuthylazine+sulfosate; thidiazimin+(S)-metolachlor+sulfosate; thidiazimin+metolachlor+sulfosate; thidiazimin+compound of the formula A+sulfosate; thidiazimin+terbutryn+sulfosate; thidiazimin+simazine+sulfosate; thidiazimin+dimethenamid or (S)-dimethenamid+sulfosate; thidiazimin+flufenacet+sulfosate; thidiazimin+acetochlor+sulfosate; thidiazimin+alachlor+sulfosate; thidiazimin+isoxaflutole+sulfosate; thidiazimin+isoxachlortole+sulfosate; thidiazimin+mesotrione+sulfosate; thidiazimin+sulcotrione+sulfosate; thidiazimin+metosulam+sulfosate; thidiazimin+flumetsulam+sulfosate; thidiazimin+pendimethalin+sulfosate; thidiazimin+bromoxynil+sulfosate; thidiazimin+bentazone+sulfosate; thidiazimin+carfentrazone+sulfosate; thidiazimin+clomazone+sulfosate; thidiazimin+nicosulfuron+sulfosate; thidiazimin+rimsulfuron+sulfosate; thidiazimin+halosulfuron+sulfosate; thidiazimin+metribuzin+sulfosate; thidiazimin+flumiclorac+sulfosate; thidiazimin+prosulfuron+sulfosate; thidiazimin+primisulfuron+sulfosate; thidiazimin+dicamba+sulfosate; thidiazimin+fluthiacet+sulfosate; thidiazimin+pyridate +sulfosate; thidiazimin+compound of the formula B+sulfosate; thidiazimin+2,4-D+sulfosate; thidiazimin+clopyralide+sulfosate; thidiazimin+diflufenzopyr+sulfosate; thidiazimin+fluroxypyr+sulfosate; thidiazimin+MCPA+sulfosate; thidiazimin+MCPB+sulfosate; thidiazimin+MCPP+sulfosate; thidiazimin+metobenzuron+sulfosate; thidiazimin+thifensulfuron+sulfosate; thidiazimin+aclonifen+sulfosate; thidiazimin+EPTC+sulfosate; and thidiazimin+cyanazine+sulfosate.

acifluorfen+(S)-metolachlor+glyphosate+benoxacor; acifluorfen+metolachlor+glyphosate+benoxacor; acifluorfen+dimethenamid or (S)-dimethenamid+glyphosate+benoxacor; acifluorfen+acetochlor+glyphosate+benoxacor; acifluorfen+alachlor+glyphosate+benoxacor; aclonifen+(S)-metolachlor+glyphosate+benoxacor; aclonifen+metolachlor+glyphosate+benoxacor; aclonifen+dimethenamid or (S)-dimethenamid+glyphosate+benoxacor; aclonifen+acetochlor+glyphosate+benoxacor; aclonifen+alachlor+glyphosate+benoxacor; bifenox+(S)-metolachlor+glyphosate+benoxacor; bifenox+metolachlor+glyphosate+benoxacor; bifenox+dimethenamid or (S)-dimethenamid+glyphosate+benoxacor; bifenox+acetochlor+glyphosate+benoxacor; bifenox+alachlor+glyphosate+benoxacor; chlomitrofen+(S)-metolachlor+glyphosate+benoxacor; chlomitrofen+metolachlor+glyphosate+benoxacor; chlomitrofen+dimethenamid or (S)-dimethenamid+glyphosate+benoxacor; chlomitrofen+acetochlor+glyphosate+benoxacor; chlomitrofen+alachlor+glyphosate+benoxacor; ethoxyfen+(S)-metolachlor+glyphosate+benoxacor; ethoxyfen+metolachlor+glyphosate+benoxacor; ethoxyfen+dimethenamid or (S)-dimethenamid+glyphosate+benoxacor; ethoxyfen+acetochlor+glyphosate+benoxacor; ethoxyfen+alachlor+glyphosate+benoxacor; fluoroglycofen+(S)-metolachlor+glyphosate+benoxacor; fluoroglycofen+metolachlor+glyphosate+benoxacor; fluoroglycofen+dimethenamid or (S)-dimethenamid +glyphosate+benoxacor; fluoroglycofen+acetochlor+glyphosate+benoxacor; fluoroglycofen+alachlor+glyphosate+benoxacor; fomesafen+(S)-metolachlor+glyphosate+benoxacor; fomesafen+metolachlor+glyphosate+benoxacor; fomesafen+dimethenamid or (S)-dimethenamid+glyphosate+benoxacor; fomesafen+acetochlor+glyphosate+benoxacor; fomesafen+alachlor+glyphosate+benoxacor; lactofen+(S)-metolachlor+glyphosate+benoxacor; lactofen+metolachlor+glyphosate+benoxacor; lactofen+dimethenamid or (S)-dimethenamid+glyphosate+benoxacor; lactofen+acetochlor+glyphosate+benoxacor; lactofen+alachlor+glyphosate+benoxacor; oxyfluorfen+(S)-metolachlor+glyphosate+benoxacor; oxyfluorfen+metolachlor+glyphosate+benoxacor; oxyfluorfen+dimethenamid or (S)-dimethenamid+glyphosate+benoxacor; oxyfluorfen+acetochlor+glyphosate+benoxacor; oxyfluorfen+alachlor+glyphosate+benoxacor; azafenidin+(S)-metolachlor+glyphosate+benoxacor; azafenidin +metolachlor+glyphosate+benoxacor; azafenidin+dimethenamid or (S)-dimethenamid+glyphosate+benoxacor; azafenidin+acetochlor+glyphosate+benoxacor; azafenidin+alachlor+glyphosate+benoxacor; carfentrazone-ethyl+(S)-metolachlor+glyphosate+benoxacor; carfentrazone-ethyl+metolachlor+glyphosate+benoxacor; carfentrazone-ethyl+dimethenamid or (S)-dimethenamid+glyphosate+benoxacor; carfentrazone-ethyl+acetochlor+glyphosate+benoxacor; carfentrazone-ethyl+alachlor+glyphosate+benoxacor; compound of the formula A+(S)-metolachlor+glyphosate+benoxacor; compound of the formula A+metolachlor+glyphosate+benoxacor; compound of the formula A+dimethenamid or (S)-dimethenamid+glyphosate+benoxacor; compound of the formula A+acetochlor+glyphosate+benoxacor; compound of the formula A+alachlor+glyphosate+benoxacor; cinidon-ethyl+(S)-metolachlor+glyphosate+benoxacor; cinidon-ethyl+metolachlor+glyphosate+benoxacor; cinidon-ethyl+dimethenamid or (S)-dimethenamid+glyphosate+benoxacor; cinidon-ethyl+acetochlor+glyphosate+benoxacor; cinidon-ethyl+alachlor+glyphosate+benoxacor; flumiclorac-pentyl+(S)-metolachlor+glyphosate+benoxacor; flumiclorac-pentyl+metolachlor+glyphosate+benoxacor; flumiclorac-pentyl+dimethenamid or (S)-dimethenamid+glyphosate+benoxacor; flumiclorac-pentyl+acetochlor+glyphosate+benoxacor; flumiclorac-pentyl+alachlor+glyphosate+benoxacor; flumioxazin+(S)-metolachlor+glyphosate+benoxacor; flumioxazin+metolachlor+glyphosate+benoxacor; flumioxazin +dimethenamid or (S)-dimethenamid+glyphosate+benoxacor; flumioxazin+acetochlor+glyphosate+benoxacor; flumioxazin+alachlor+glyphosate+benoxacor; fluthiacet-methyl +(S)-metolachlor+glyphosate+benoxacor; fluthiacet-methyl+metolachlor+glyphosate+benoxacor; fluthiacet-methyl+dimethenamid or (S)-dimethenamid+glyphosate+benoxacor; fluthiacet-methyl+acetochlor+glyphosate+benoxacor; fluthiacet-methyl+alachlor+glyphosate+benoxacor; oxadiargyl+(S)-metolachlor+glyphosate+benoxacor; oxadiargyl+metolachlor+glyphosate+benoxacor; oxadiargyl+dimethenamid or (S)-dimethenamid+glyphosate+benoxacor; oxadiargyl+acetochlor+glyphosate+benoxacor; oxadiargyl+alachlor+glyphosate+benoxacor; oxadiazon+(S)-metolachlor+glyphosate+benoxacor; oxadiazon+metolachlor+glyphosate+benoxacor; oxadiazon+dimethenamid or (S)-dimethenamid+glyphosate+benoxacor; oxadiazon+acetochlor+glyphosate+benoxacor; oxadiazon+alachlor+glyphosate+benoxacor; pentoxazone+(S)-metolachlor+glyphosate+benoxacor; pentoxazone+metolachlor+glyphosate+benoxacor; pentoxazone+dimethenamid or (S)-dimethenamid+glyphosate+benoxacor; pentoxazone+acetochlor+glyphosate+benoxacor; pentoxazone+alachlor+glyphosate+benoxacor; sulfentrazone+(S)-metolachlor+glyphosate+benoxacor; sulfentrazone+metolachlor+glyphosate+benoxacor; sulfentrazone+dimethenamid or (S)-dimethenamid+glyphosate+benoxacor; sulfentrazone+acetochlor+glyphosate+benoxacor; sulfentrazone+alachlor+glyphosate+benoxacor; fluazolate+(S)-metolachlor+glyphosate+benoxacor; fluazolate+metolachlor+glyphosate+benoxacor; fluazolate+dimethenamid or (S)-dimethenamid+glyphosate+benoxacor; fluazolate+acetochlor+glyphosate+benoxacor; fluazolate+alachlor+glyphosate+benoxacor; pyraflufen-ethyl+(S)-metolachlor+glyphosate+benoxacor; pyraflufen-ethyl+metolachlor+glyphosate+benoxacor; pyraflufen-ethyl+dimethenamid or (S)-dimethenamid+glyphosate+benoxacor; pyraflufen-ethyl+acetochlor+glyphosate+benoxacor; pyraflufen-ethyl+alachlor+glyphosate+benoxacor; flumipropyn+(S)-metolachlor+glyphosate+benoxacor; flumipropyn+metolachlor+glyphosate+benoxacor; flumipropyn+dimethenamid or (S)-dimethenamid+glyphosate+benoxacor; flumipropyn+acetochlor+glyphosate+benoxacor; flumipropyn+alachlor+glyphosate+benoxacor; flupropacil+(S)-metolachlor+glyphosate+benoxacor; flupropacil+metolachlor+glyphosate+benoxacor; flupropacil+dimethenamid or (S)-dimethenamid+glyphosate+benoxacor; flupropacil+acetochlor+glyphosate+benoxacor; flupropacil+alachlor+glyphosate+benoxacor; nipyraclofen+(S)-metolachlor+glyphosate+benoxacor; nipyraclofen+metolachlor+glyphosate+benoxacor; nipyraclofen+dimethenamid or (S)-dimethenamid+glyphosate+benoxacor; nipyraclofen+acetochlor+glyphosate+benoxacor; nipyraclofen+alachlor+glyphosate+benoxacor; benzfendizone +(S)-metolachlor+glyphosate+benoxacor; benzfendizone+metolachlor+glyphosate+benoxacor; benzfendizone+dimethenamid or (S)-dimethenamid+glyphosate+benoxacor; benzfendizone+acetochlor+glyphosate+benoxacor; benzfendizone+alachlor+glyphosate+benoxacor; thidiazimin+(S)-metolachlor+glyphosate+benoxacor; thidiazimin+metolachlor+glyphosate+benoxacor; thidiazimin+dimethenamid or (S)-dimethenamid+glyphosate+benoxacor; thidiazimin+acetochlor+glyphosate+benoxacor; and thidiazimin+alachlor+glyphosate+benoxacor.

acifluorfen+(S)-metolachlor+glyphosate+MON 4660; acifluorfen+metolachlor+glyphosate+MON 4660; acifluorfen+dimethenamid or (S)-dimethenamid+glyphosate+MON 4660; acifluorfen+acetochlor+glyphosate+MON 4660; acifluorfen+alachlor+glyphosate+MON 4660; aclonifen+(S)-metolachlor+glyphosate+MON 4660; aclonifen+metolachlor+glyphosate+MON 4660; aclonifen+dimethenamid or (S)-dimethenamid+glyphosate+MON 4660; aclonifen+acetochlor+glyphosate+MON 4660; aclonifen+alachlor+glyphosate+MON 4660; bifenox+(S)-metolachlor+glyphosate+MON 4660; bifenox+metolachlor+glyphosate+MON 4660; bifenox+dimethenamid or (S)-dimethenamid+glyphosate+MON 4660; bifenox+acetochlor+glyphosate+MON 4660; bifenox+alachlor+glyphosate+MON 4660; chlomitrofen+(S)-metolachlor+glyphosate+MON 4660; chlomitrofen+metolachlor+glyphosate+MON 4660; chlomitrofen+dimethenamid or (S)-dimethenamid+glyphosate+MON 4660; chlomitrofen+acetochlor+glyphosate+MON 4660; chlomitrofen+alachlor+glyphosate+MON 4660; ethoxyfen+(S)-metolachlor+glyphosate+MON 4660; ethoxyfen+metolachlor+glyphosate+MON 4660; ethoxyfen+dimethenamid or (S)-dimethenamid+glyphosate+MON 4660; ethoxyfen+acetochlor+glyphosate+MON 4660; ethoxyfen+alachlor+glyphosate+MON 4660; fluoroglycofen+(S)-metolachlor+glyphosate+MON 4660; fluoroglycofen+metolachlor+glyphosate+MON 4660; fluoroglycofen+dimethenamid or (S)-dimethenamid +glyphosate+MON 4660; fluoroglycofen+acetochlor+glyphosate+MON 4660; fluoroglycofen+alachlor+glyphosate+MON 4660; fomesafen+(S)-metolachlor+glyphosate+MON 4660; fomesafen+metolachlor+glyphosate+MON 4660; fomesafen+dimethenamid or (S)-dimethenamid+glyphosate+MON 4660; fomesafen+acetochlor+glyphosate+MON 4660; fomesafen+alachlor+glyphosate+MON 4660; lactofen+(S)-metolachlor+glyphosate+MON 4660; lactofen+metolachlor+glyphosate+MON 4660; lactofen+dimethenamid or (S)-dimethenamid+glyphosate+MON 4660; lactofen+acetochlor+glyphosate+MON 4660; lactofen+alachlor+glyphosate+MON 4660; oxyfluorfen+(S)-metolachlor+glyphosate+MON 4660; oxyfluorfen+metolachlor+glyphosate+MON 4660; oxyfluorfen+dimethenamid or (S)-dimethenamid+glyphosate+MON 4660; oxyfluorfen+acetochlor+glyphosate+MON 4660; oxyfluorfen+alachlor+glyphosate+MON 4660; azafenidin+(S)-metolachlor+glyphosate+MON 4660; azafenidin+metolachlor+glyphosate+MON 4660; azafenidin+dimethenamid or (S)-dimethenamid+glyphosate+MON 4660; azafenidin+acetochlor+glyphosate+MON 4660; azafenidin+alachlor+glyphosate+MON 4660; carfentrazone-ethyl+(S)-metolachlor+glyphosate+MON 4660; carfentrazone-ethyl+metolachlor+glyphosate+MON 4660; carfentrazone-ethyl+dimethenamid or (S)-dimethenamid+glyphosate+MON 4660; carfentrazone-ethyl+acetochlor+glyphosate+MON 4660; carfentrazone-ethyl+alachlor+glyphosate+MON 4660; compound of the formula A+(S)-metolachlor+glyphosate+MON 4660; compound of the formula A+metolachlor+glyphosate+MON 4660; compound of the formula A+dimethenamid or (S)-dimethenamid+glyphosate+MON 4660; compound of the formula A+acetochlor+glyphosate+MON 4660; compound of the formula A+alachlor+glyphosate+MON 4660; cinidon-ethyl+(S)-metolachlor+glyphosate+MON 4660; cinidon-ethyl+metolachlor+glyphosate+MON 4660; cinidon-ethyl+dimethenamid or (S)-dimethenamid+glyphosate+MON 4660; cinidon-ethyl+acetochlor+glyphosate+MON 4660; cinidon-ethyl+alachlor+glyphosate+MON 4660; flumiclorac-pentyl+(S)-metolachlor+glyphosate+MON 4660; flumiclorac-pentyl+metolachlor+glyphosate+MON 4660; flumiclorac-pentyl+dimethenamid or (S)-dimethenamid+glyphosate+MON 4660; flumiclorac-pentyl+acetochlor+glyphosate+MON 4660; flumiclorac-pentyl+alachlor+glyphosate+MON 4660; flumioxazin+(S)-metolachlor+glyphosate+MON 4660; flumioxazin+metolachlor+glyphosate+MON 4660; flumioxazin+dimethenamid or (S)-dimethenamid+glyphosate+MON 4660; flumioxazin+acetochlor+glyphosate+MON 4660; flumioxazin+alachlor+glyphosate+MON 4660; fluthiacet-methyl+(S)-metolachlor+glyphosate+MON 4660; fluthiacet-methyl +metolachlor+glyphosate+MON 4660; fluthiacet-methyl+dimethenamid or (S)-dimethenamid+glyphosate+MON 4660; fluthiacet-methyl+acetochlor+glyphosate+MON 4660; fluthiacet-methyl+alachlor+glyphosate+MON 4660; oxadiargyl+(S)-metolachlor+glyphosate+MON 4660; oxadiargyl+metolachlor+glyphosate+MON 4660; oxadiargyl+dimethenamid or (S)-dimethenamid+glyphosate+MON 4660; oxadiargyl+acetochlor+glyphosate+MON 4660; oxadiargyl+alachlor+glyphosate+MON 4660; oxadiazon+(S)-metolachlor+glyphosate+MON 4660; oxadiazon+metolachlor+glyphosate+MON 4660; oxadiazon+dimethenamid or (S)-dimethenamid+glyphosate+MON 4660; oxadiazon+acetochlor+glyphosate+MON 4660; oxadiazon+alachlor+glyphosate+MON 4660; pentoxazone+(S)-metolachlor+glyphosate+MON 4660; pentoxazone+metolachlor+glyphosate+MON 4660; pentoxazone+dimethenamid or (S)-dimethenamid+glyphosate+MON 4660; pentoxazone+acetochlor+glyphosate+MON 4660; pentoxazone+alachlor+glyphosate+MON 4660; sulfentrazone+(S)-metolachlor+glyphosate+MON 4660; sulfentrazone+metolachlor+glyphosate+MON 4660; sulfentrazone+dimethenamid or (S)-dimethenamid+glyphosate+MON 4660; sulfentrazone+acetochlor+glyphosate+MON 4660; sulfentrazone+alachlor+glyphosate+MON 4660; fluazolate+(S)-metolachlor+glyphosate+MON 4660; fluazolate +metolachlor+glyphosate+MON 4660; fluazolate+dimethenamid or (S)-dimethenamid+glyphosate+MON 4660; fluazolate+acetochlor+glyphosate+MON 4660; fluazolate+alachlor+glyphosate+MON 4660; pyraflufen-ethyl+(S)-metolachlor+glyphosate+MON 4660; pyraflufen-ethyl+metolachlor+glyphosate+MON 4660; pyraflufen-ethyl+dimethenamid or (S)-dimethenamid+glyphosate+MON 4660; pyraflufen-ethyl+acetochlor+glyphosate+MON 4660; pyraflufen-ethyl+alachlor+glyphosate+MON 4660; flumipropyn+(S)-metolachlor+glyphosate+MON 4660; flumipropyn+metolachlor+glyphosate+MON 4660; flumipropyn+dimethenamid or (S)-dimethenamid+glyphosate+MON 4660; flumipropyn+acetochlor+glyphosate+MON 4660; flumipropyn+alachlor+glyphosate+MON 4660; flupropacil+(S)-metolachlor+glyphosate+MON 4660; flupropacil+metolachlor+glyphosate+MON 4660; flupropacil+dimethenamid or (S)-dimethenamid+glyphosate+MON 4660; flupropacil+acetochlor+glyphosate+MON 4660; flupropacil+alachlor+glyphosate+MON 4660; nipyraclofen+(S)-metolachlor+glyphosate+MON 4660; nipyraclofen+metolachlor+glyphosate+MON 4660; nipyraclofen+dimethenamid or (S)-dimethenamid+glyphosate+MON 4660; nipyraclofen +acetochlor+glyphosate+MON 4660; nipyraclofen+alachlor+glyphosate+MON 4660; benzfendizone+(S)-metolachlor+glyphosate+MON 4660; benzfendizone+metolachlor+glyphosate+MON 4660; benzfendizone+dimethenamid or (S)-dimethenamid+glyphosate +MON 4660; benzfendizone+acetochlor+glyphosate+MON 4660; benzfendizone+alachlor+glyphosate+MON 4660; thidiazimin+(S)-metolachlor+glyphosate+MON 4660; thidiazimin+metolachlor+glyphosate+MON 4660; thidiazimin+dimethenamid or (S)-dimethenamid+glyphosate+MON 4660; thidiazimin+acetochlor+glyphosate+MON 4660; and thidiazimin+alachlor+glyphosate+MON 4660.

Acifluorfen+(S)-metolachlor+glyphosate+flurazole; acifluorfen+metolachlor+glyphosate+flurazole; acifluorfen+dimethenamid or (S)-dimethenamid+glyphosate+flurazole; acifluorfen+acetochlor+glyphosate+flurazole; acifluorfen+alachlor+glyphosate+flurazole; aclonifen+(S)-metolachlor+glyphosate+flurazole; aclonifen+metolachlor+glyphosate+flurazole; aclonifen+dimethenamid or (S)-dimethenamid+glyphosate+flurazole; aclonifen+acetochlor+glyphosate+flurazole; aclonifen+alachlor +glyphosate+flurazole; bifenox+(S)-metolachlor+glyphosate+flurazole; bifenox+metolachlor+glyphosate+flurazole; bifenox+dimethenamid or (S)-dimethenamid+glyphosate+flurazole; bifenox+acetochlor+glyphosate+flurazole; bifenox+alachlor+glyphosate+flurazole; chlomitrofen+(S)-metolachlor+glyphosate+flurazole; chlomitrofen+metolachlor+glyphosate+flurazole; chlomitrofen+dimethenamid or (S)-dimethenamid+glyphosate+flurazole; chlomitrofen+acetochlor+glyphosate+flurazole; chlomitrofen+alachlor+glyphosate+flurazole; ethoxyfen+(S)-metolachlor+glyphosate +flurazole; ethoxyfen+metolachlor+glyphosate+flurazole; ethoxyfen+dimethenamid or (S)-dimethenamid+glyphosate+flurazole; ethoxyfen+acetochlor+glyphosate+flurazole; ethoxyfen+alachlor+glyphosate+flurazole; fluoroglycofen+(S)-metolachlor+glyphosate +flurazole; fluoroglycofen+metolachlor+glyphosate+flurazole; fluoroglycofen+dimethenamid or (S)-dimethenamid+glyphosate+flurazole; fluoroglycofen+acetochlor+glyphosate+flurazole; fluoroglycofen+alachlor+glyphosate+flurazole; fomesafen+(S)-metolachlor+glyphosate+flurazole; fomesafen+metolachlor+glyphosate+flurazole; fomesafen+dimethenamid or (S)-dimethenamid+glyphosate+flurazole; fomesafen+acetochlor+glyphosate+flurazole; fomesafen+alachlor+glyphosate+flurazole; lactofen +(S)-metolachlor+glyphosate+flurazole; lactofen+metolachlor+glyphosate+flurazole; lactofen+dimethenamid or (S)-dimethenamid+glyphosate+flurazole; lactofen+acetochlor+glyphosate+flurazole; lactofen+alachlor+glyphosate+flurazole; oxyfluorfen +(S)-metolachlor+glyphosate+flurazole; oxyfluorfen+metolachlor+glyphosate+flurazole; oxyfluorfen+dimethenamid or (S)-dimethenamid+glyphosate+flurazole; oxyfluorfen+acetochlor+glyphosate+flurazole; oxyfluorfen+alachlor+glyphosate+flurazole; azafenidin+(S)-metolachlor+glyphosate+flurazole; azafenidin+metolachlor+glyphosate+flurazole; azafenidin+dimethenamid or (S)-dimethenamid+glyphosate+flurazole; azafenidin+acetochlor+glyphosate+flurazole; azafenidin+alachlor+glyphosate+flurazole; carfentrazone-ethyl+(S)-metolachlor+glyphosate+flurazole; carfentrazone-ethyl+metolachlor+glyphosate+flurazole; carfentrazone-ethyl+dimethenamid or (S)-dimethenamid+glyphosate+flurazole; carfentrazone-ethyl+acetochlor+glyphosate+flurazole; carfentrazone-ethyl+alachlor+glyphosate+flurazole; compound of the formula A+(S)-metolachlor+glyphosate+flurazole; compound of the formula A+metolachlor+glyphosate+flurazole; compound of the formula A+dimethenamid or (S)-dimethenamid+glyphosate+flurazole; compound of the formula A+acetochlor+glyphosate+flurazole; compound of the formula A+alachlor+glyphosate+flurazole; cinidon-ethyl+(S)-metolachlor+glyphosate+flurazole; cinidon-ethyl+metolachlor+glyphosate+flurazole; cinidon-ethyl+dimethenamid or (S)-dimethenamid+glyphosate+flurazole; cinidon-ethyl+acetochlor+glyphosate+flurazole; cinidon-ethyl+alachlor+glyphosate+flurazole; flumiclorac-pentyl+(S)-metolachlor+glyphosate+flurazole; flumiclorac-pentyl+metolachlor+glyphosate+flurazole; flumiclorac-pentyl+dimethenamid or (S)-dimethenamid+glyphosate+flurazole; flumiclorac-pentyl+acetochlor +glyphosate+flurazole; flumiclorac-pentyl+alachlor+glyphosate+flurazole; flumioxazin +(S)-metolachlor+glyphosate+flurazole; flumioxazin+metolachlor+glyphosate+flurazole; flumioxazin+dimethenamid or (S)-dimethenamid+glyphosate+flurazole; flumioxazin+acetochlor+glyphosate+flurazole; flumioxazin+alachlor+glyphosate+flurazole; fluthiacet-methyl+(S)-metolachlor+glyphosate+flurazole; fluthiacet-methyl+metolachlor+glyphosate+flurazole; fluthiacet-methyl+dimethenamid or (S)-dimethenamid +glyphosate+flurazole; fluthiacet-methyl+acetochlor+glyphosate+flurazole; fluthiacet-methyl+alachlor+glyphosate+flurazole; oxadiargyl+(S)-metolachlor+glyphosate+flurazole; oxadiargyl+metolachlor+glyphosate+flurazole; oxadiargyl+dimethenamid or (S)-dimethenamid+glyphosate+flurazole; oxadiargyl+acetochlor+glyphosate+flurazole; oxadiargyl+alachlor+glyphosate+flurazole; oxadiazon+(S)-metolachlor+glyphosate+flurazole; oxadiazon+metolachlor+glyphosate+flurazole; oxadiazon+dimethenamid or (S)-dimethenamid+glyphosate+flurazole; oxadiazon+acetochlor+glyphosate+flurazole; oxadiazon+alachlor+glyphosate+flurazole; pentoxazone+(S)-metolachlor+glyphosate+flurazole; pentoxazone+metolachlor+glyphosate+flurazole; pentoxazone+dimethenamid or (S)-dimethenamid+glyphosate+flurazole; pentoxazone +acetochlor+glyphosate+flurazole; pentoxazone+alachlor+glyphosate+flurazole; sulfentrazone+(S)-metolachlor+glyphosate+flurazole; sulfentrazone+metolachlor+glyphosate+flurazole; sulfentrazone+dimethenamid or (S)-dimethenamid+glyphosate+flurazole; sulfentrazone+acetochlor+glyphosate+flurazole; sulfentrazone+alachlor+glyphosate+flurazole; fluazolate+(S)-metolachlor+glyphosate+flurazole; fluazolate+metolachlor+glyphosate+flurazole; fluazolate+dimethenamid or (S)-dimethenamid+glyphosate+flurazole; fluazolate+acetochlor+glyphosate+flurazole; fluazolate+alachlor+glyphosate+flurazole; pyraflufen-ethyl+(S)-metolachlor+glyphosate+flurazole; pyraflufen-ethyl+metolachlor+glyphosate+flurazole; pyraflufen-ethyl+dimethenamid or (S)-dimethenamid+glyphosate+flurazole; pyraflufen-ethyl+acetochlor +glyphosate+flurazole; pyraflufen-ethyl+alachlor+glyphosate+flurazole; flumipropyn+(S)-metolachlor+glyphosate+flurazole; flumipropyn+metolachlor+glyphosate+flurazole; flumipropyn+dimethenamid or (S)-dimethenamid+glyphosate+flurazole; flumipropyn+acetochlor+glyphosate+flurazole; flumipropyn+alachlor+glyphosate+flurazole; flupropacil+(S)-metolachlor+glyphosate+flurazole; flupropacil+metolachlor+glyphosate+flurazole; flupropacil+dimethenamid or (S)-dimethenamid+glyphosate+flurazole; flupropacil+acetochlor+glyphosate+flurazole; flupropacil+alachlor+glyphosate+flurazole; nipyraclofen+(S)-metolachlor+glyphosate+flurazole; nipyraclofen +metolachlor+glyphosate+flurazole; nipyraclofen+dimethenamid or (S)-dimethenamid+glyphosate+flurazole; nipyraclofen+acetochlor+glyphosate+flurazole; nipyraclofen+alachlor+glyphosate+flurazole; benzfendizone+(S)-metolachlor+glyphosate+flurazole; benzfendizone+metolachlor+glyphosate+flurazole; benzfendizone+dimethenamid or (S)-dimethenamid+glyphosate+flurazole; benzfendizone+acetochlor+glyphosate+flurazole; benzfendizone+alachlor+glyphosate+flurazole; thidiazimin+(S)-metolachlor+glyphosate+flurazole; thidiazimin+metolachlor+glyphosate+flurazole; thidiazimin+dimethenamid or (S)-dimethenamid+glyphosate+flurazole; thidiazimin+acetochlor+glyphosate+flurazole; and thidiazimin+alachlor+glyphosate+flurazole.

Acifluorfen+(S)-metolachlor+glyphosate+dichlormid; acifluorfen+metolachlor+glyphosate+dichlormid; acifluorfen+dimethenamid or (S)-dimethenamid+glyphosate+dichlormid; acifluorfen+acetochlor+glyphosate+dichlormid; acifluorfen+alachlor+glyphosate+dichlormid; aclonifen+(S)-metolachlor+glyphosate+dichlormid; aclonifen+metolachlor+glyphosate+dichlormid; aclonifen+dimethenamid or (S)-dimethenamid+glyphosate+dichlormid; aclonifen+acetochlor+glyphosate+dichlormid; aclonifen+alachlor+glyphosate+dichlormid; bifenox+(S)-metolachlor+glyphosate+dichlormid; bifenox+metolachlor+glyphosate+dichlormid; bifenox+dimethenamid or (S)-dimethenamid+glyphosate+dichlormid; bifenox+acetochlor+glyphosate+dichlormid; bifenox+alachlor+glyphosate+dichlormid; chlomitrofen+(S)-metolachlor+glyphosate+dichlormid; chlomitrofen+metolachlor+glyphosate+dichlormid; chlomitrofen+dimethenamid or (S)-dimethenamid+glyphosate+dichlormid; chlomitrofen+acetochlor+glyphosate+dichlormid; chlomitrofen+alachlor+glyphosate+dichlormid; ethoxyfen+(S)-metolachlor+glyphosate+dichlormid; ethoxyfen+metolachlor+glyphosate+dichlormid; ethoxyfen+dimethenamid or (S)-dimethenamid+glyphosate+dichlormid; ethoxyfen+acetochlor+glyphosate+dichlormid; ethoxyfen+alachlor+glyphosate+dichlormid; fluoroglycofen+(S)-metolachlor+glyphosate+dichlormid; fluoroglycofen+metolachlor+glyphosate+dichlormid; fluoroglycofen+dimethenamid or (S)-dimethenamid+glyphosate +dichlormid; fluoroglycofen+acetochlor+glyphosate+dichlormid; fluoroglycofen+alachlor+glyphosate+dichlormid; fomesafen+(S)-metolachlor+glyphosate+dichlormid; fomesafen+metolachlor+glyphosate+dichlormid; fomesafen+dimethenamid or (S)-dimethenamid+glyphosate+dichlormid; fomesafen+acetochlor+glyphosate+dichlormid; fomesafen+alachlor+glyphosate+dichlormid; lactofen+(S)-metolachlor+glyphosate+dichlormid; lactofen+metolachlor+glyphosate+dichlormid; lactofen+dimethenamid or (S)-dimethenamid+glyphosate+dichlormid; lactofen+acetochlor+glyphosate+dichlormid; lactofen+alachlor+glyphosate+dichlormid; oxyfluorfen+(S)-metolachlor+glyphosate+dichlormid; oxyfluorfen+metolachlor+glyphosate+dichlormid; oxyfluorfen+dimethenamid or (S)-dimethenamid+glyphosate+dichlormid; oxyfluorfen+acetochlor+glyphosate+dichlormid; oxyfluorfen+alachlor+glyphosate+dichlormid; azafenidin+(S)-metolachlor+glyphosate+dichlormid; azafenidin+metolachlor+glyphosate+dichlormid; azafenidin+dimethenamid or (S)-dimethenamid+glyphosate+dichlormid; azafenidin+acetochlor+glyphosate+dichlormid; azafenidin+alachlor+glyphosate+dichlormid; carfentrazone-ethyl+(S)-metolachlor+glyphosate+dichlormid; carfentrazone-ethyl+metolachlor+glyphosate+dichlormid; carfentrazone-ethyl+dimethenamid or (S)-dimethenamid+glyphosate+dichlormid; carfentrazone-ethyl+acetochlor+glyphosate+dichlormid; carfentrazone-ethyl+alachlor+glyphosate+dichlormid; compound of the formula A+(S)-metolachlor+glyphosate+dichlormid; compound of the formula A+metolachlor+glyphosate+dichlormid; compound of the formula A+dimethenamid or (S)-dimethenamid+glyphosate+dichlormid; compound of the formula A+acetochlor+glyphosate+dichlormid; compound of the formula A+alachlor +glyphosate+dichlormid; cinidon-ethyl+(S)-metolachlor+glyphosate+dichlormid; cinidon-ethyl+metolachlor+glyphosate+dichlormid; cinidon-ethyl+dimethenamid or (S)-dimethenamid+glyphosate+dichlormid; cinidon-ethyl+acetochlor+glyphosate+dichlormid; cinidon-ethyl+alachlor+glyphosate+dichlormid; flumiclorac-pentyl+(S)-metolachlor+glyphosate+dichlormid; flumiclorac-pentyl+metolachlor+glyphosate+dichlormid; flumiclorac-pentyl+dimethenamid or (S)-dimethenamid+glyphosate+dichlormid; flumiclorac-pentyl+acetochlor+glyphosate+dichlormid; flumiclorac-pentyl+alachlor+glyphosate+dichlormid; flumioxazin+(S)-metolachlor+glyphosate+dichlormid; flumioxazin+metolachlor+glyphosate+dichlormid; flumioxazin+dimethenamid or (S)-dimethenamid+glyphosate+dichlormid; flumioxazin+acetochlor+glyphosate+dichlormid; flumioxazin+alachlor+glyphosate+dichlormid; fluthiacet-methyl+(S)-metolachlor+glyphosate+dichlormid; fluthiacet-methyl+metolachlor+glyphosate+dichlormid; fluthiacet-methyl+dimethenamid or (S)-dimethenamid+glyphosate+dichlormid; fluthiacet-methyl+acetochlor+glyphosate+dichlormid; fluthiacet-methyl+alachlor+glyphosate+dichlormid; oxadiargyl+(S)-metolachlor+glyphosate+dichlormid; oxadiargyl+metolachlor+glyphosate+dichlormid; oxadiargyl+dimethenamid or (S)-dimethenamid+glyphosate+dichlormid; oxadiargyl+acetochlor+glyphosate+dichlormid; oxadiargyl+alachlor+glyphosate+dichlormid; oxadiazon+(S)-metolachlor+glyphosate +dichlormid; oxadiazon+metolachlor+glyphosate+dichlormid; oxadiazon+dimethenamid or (S)-dimethenamid+glyphosate+dichlormid; oxadiazon+acetochlor+glyphosate+dichlormid; oxadiazon+alachlor+glyphosate+dichlormid; pentoxazone+(S)-metolachlor+glyphosate+dichlormid; pentoxazone+metolachlor+glyphosate+dichlormid; pentoxazone+dimethenamid or (S)-dimethenamid+glyphosate+dichlormid; pentoxazone+acetochlor+glyphosate+dichlormid; pentoxazone+alachlor+glyphosate +dichlormid; sulfentrazone+(S)-metolachlor+glyphosate+dichlormid; sulfentrazone+metolachlor+glyphosate+dichlormid; sulfentrazone+dimethenamid or (S)-dimethenamid +glyphosate+dichlormid; sulfentrazone+acetochlor+glyphosate+dichlormid; sulfentrazone+alachlor+glyphosate+dichlormid; fluazolate+(S)-metolachlor+glyphosate+dichlormid; fluazolate+metolachlor+glyphosate+dichlormid; fluazolate+dimethenamid or (S)-dimethenamid+glyphosate+dichlormid; fluazolate+acetochlor+glyphosate+dichlormid; fluazolate+alachlor+glyphosate+dichlormid; pyraflufen-ethyl+(S)-metolachlor+glyphosate+dichlormid; pyraflufen-ethyl+metolachlor+glyphosate+dichlormid; pyraflufen-ethyl+dimethenamid or (S)-dimethenamid+glyphosate+dichlormid; pyraflufen-ethyl+acetochlor+glyphosate+dichlormid; pyraflufen-ethyl+alachlor+glyphosate+dichlormid; flumipropyn+(S)-metolachlor+glyphosate+dichlormid; flumipropyn+metolachlor+glyphosate+dichlormid; flumipropyn+dimethenamid or (S)-dimethenamid+glyphosate+dichlormid; flumipropyn+acetochlor+glyphosate+dichlormid; flumipropyn+alachlor+glyphosate+dichlormid; flupropacil+(S)-metolachlor+glyphosate+dichlormid; flupropacil+metolachlor+glyphosate+dichlormid; flupropacil+dimethenamid or (S)-dimethenamid+glyphosate+dichlormid; flupropacil+acetochlor+glyphosate+dichlormid; flupropacil+alachlor+glyphosate+dichlormid; nipyraclofen+(S)-metolachlor+glyphosate+dichlormid; nipyraclofen+metolachlor+glyphosate+dichlormid; nipyraclofen+dimethenamid or (S)-dimethenamid+glyphosate+dichlormid; nipyraclofen+acetochlor+glyphosate+dichlormid; nipyraclofen+alachlor+glyphosate+dichlormid; benzfendizone+(S)-metolachlor+glyphosate+dichlormid; benzfendizone+metolachlor+glyphosate+dichlormid; benzfendizone+dimethenamid or (S)-dimethenamid+glyphosate+dichlormid; benzfendizone+acetochlor+glyphosate+dichlormid; benzfendizone+alachlor+glyphosate+dichlormid; thidiazimin+(S)-metolachlor+glyphosate+dichlormid; thidiazimin+metolachlor+glyphosate+dichlormid; thidiazimin+dimethenamid or (S)-dimethenamid+glyphosate+dichlormid; thidiazimin+acetochlor+glyphosate+dichlormid; and thidiazimin+alachlor+glyphosate+dichlormid.

Acifluorfen+(S)-metolachlor+glyphosate+furilazole; acifluorfen+metolachlor+glyphosate+furilazole; acifluorfen+dimethenamid or (S)-dimethenamid+glyphosate+furilazole; acifluorfen+acetochlor+glyphosate+furilazole; acifluorfen+alachlor+glyphosate+furilazole; aclonifen+(S)-metolachlor+glyphosate+furilazole; aclonifen+metolachlor+glyphosate+furilazole; aclonifen+dimethenamid or (S)-dimethenamid+glyphosate+furilazole; aclonifen+acetochlor+glyphosate+furilazole; aclonifen+alachlor +glyphosate+furilazole; bifenox+(S)-metolachlor+glyphosate+furilazole; bifenox+metolachlor+glyphosate+furilazole; bifenox+dimethenamid or (S)-dimethenamid+glyphosate+furilazole; bifenox+acetochlor+glyphosate+furilazole; bifenox+alachlor+glyphosate+furilazole; chlomitrofen+(S)-metolachlor+glyphosate+furilazole; chlomitrofen+metolachlor+glyphosate+furilazole; chlomitrofen+dimethenamid or (S)-dimethenamid+glyphosate+furilazole; chlomitrofen+acetochlor+glyphosate+furilazole; chlomitrofen+alachlor+glyphosate+furilazole; ethoxyfen+(S)-metolachlor+glyphosate +furilazole; ethoxyfen+metolachlor+glyphosate+furilazole; ethoxyfen+dimethenamid or (S)-dimethenamid+glyphosate+furilazole; ethoxyfen+acetochlor+glyphosate+furilazole; ethoxyfen+alachlor+glyphosate+furilazole; fluoroglycofen+(S)-metolachlor+glyphosate+furilazole; fluoroglycofen+metolachlor+glyphosate+furilazole; fluoroglycofen+dimethenamid or (S)-dimethenamid+glyphosate+furilazole; fluoroglycofen+acetochlor+glyphosate+furilazole; fluoroglycofen+alachlor+glyphosate +furilazole; fomesafen+(S)-metolachlor+glyphosate+furilazole; fomesafen+metolachlor+glyphosate+furilazole; fomesafen+dimethenamid or (S)-dimethenamid+glyphosate+furilazole; fomesafen+acetochlor+glyphosate+furilazole; fomesafen+alachlor+glyphosate+furilazole; lactofen+(S)-metolachlor+glyphosate+furilazole; lactofen+metolachlor+glyphosate+furilazole; lactofen+dimethenamid or (S)-dimethenamid+glyphosate+furilazole; lactofen+acetochlor+glyphosate+furilazole; lactofen+alachlor+glyphosate+furilazole; oxyfluorfen+(S)-metolachlor+glyphosate+furilazole; oxyfluorfen+metolachlor+glyphosate+furilazole; oxyfluorfen+dimethenamid or (S)-dimethenamid+glyphosate+furilazole; oxyfluorfen+acetochlor+glyphosate+furilazole; oxyfluorfen+alachlor+glyphosate+furilazole; azafenidin+(S)-metolachlor+glyphosate+furilazole; azafenidin+metolachlor+glyphosate+furilazole; azafenidin+dimethenamid or (S)-dimethenamid+glyphosate+furilazole; azafenidin+acetochlor+glyphosate+furilazole; azafenidin+alachlor+glyphosate+furilazole; carfentrazone-ethyl +(S)-metolachlor+glyphosate+furilazole; carfentrazone-ethyl+metolachlor+glyphosate +furilazole; carfentrazone-ethyl+dimethenamid or (S)-dimethenamid+glyphosate+furilazole; carfentrazone-ethyl+acetochlor+glyphosate+furilazole; carfentrazone-ethyl+alachlor+glyphosate+furilazole; compound of the formula A+(S)-metolachlor+glyphosate+furilazole; compound of the formula A+metolachlor+glyphosate+furilazole; compound of the formula A+dimethenamid or (S)-dimethenamid+glyphosate+furilazole; compound of the formula A+acetochlor+glyphosate+furilazole; compound of the formula A+alachlor+glyphosate+furilazole; cinidon-ethyl+(S)-metolachlor+glyphosate+furilazole; cinidon-ethyl+metolachlor+glyphosate+furilazole; cinidon-ethyl+dimethenamid or (S)-dimethenamid+glyphosate+furilazole; cinidon-ethyl+acetochlor+glyphosate+furilazole; cinidon-ethyl+alachlor+glyphosate+furilazole; flumiclorac-pentyl +(S)-metolachlor+glyphosate+furilazole; flumiclorac-pentyl+metolachlor+glyphosate+furilazole; flumiclorac-pentyl+dimethenamid or (S)-dimethenamid+glyphosate+furilazole; flumiclorac-pentyl+acetochlor+glyphosate+furilazole; flumiclorac-pentyl+alachlor+glyphosate+furilazole; flumioxazin+(S)-metolachlor+glyphosate+furilazole; flumioxazin +metolachlor+glyphosate+furilazole; flumioxazin+dimethenamid or (S)-dimethenamid+glyphosate+furilazole; flumioxazin+acetochlor+glyphosate+furilazole; flumioxazin+alachlor+glyphosate+furilazole; fluthiacet-methyl+(S)-metolachlor+glyphosate+furilazole; fluthiacet-methyl+metolachlor+glyphosate+furilazole; fluthiacet-methyl+dimethenamid or (S)-dimethenamid+glyphosate+furilazole; fluthiacet-methyl+acetochlor +glyphosate+furilazole; fluthiacet-methyl+alachlor+glyphosate+furilazole; oxadiargyl+(S)-metolachlor+glyphosate+furilazole; oxadiargyl+metolachlor+glyphosate+furilazole; oxadiargyl+dimethenamid or (S)-dimethenamid+glyphosate+furilazole; oxadiargyl+acetochlor+glyphosate+furilazole; oxadiargyl+alachlor+glyphosate+furilazole; oxadiazon+(S)-metolachlor+glyphosate+furilazole; oxadiazon+metolachlor+glyphosate+furilazole; oxadiazon+dimethenamid or (S)-dimethenamid+glyphosate+furilazole; oxadiazon+acetochlor+glyphosate+furilazole; oxadiazon+alachlor+glyphosate+furilazole; pentoxazone+(S)-metolachlor+glyphosate+furilazole; pentoxazone+metolachlor+glyphosate+furilazole; pentoxazone+dimethenamid or (S)-dimethenamid+glyphosate+furilazole; pentoxazone+acetochlor+glyphosate+furilazole; pentoxazone+alachlor+glyphosate+furilazole; sulfentrazone+(S)-metolachlor+glyphosate+furilazole; sulfentrazone+metolachlor+glyphosate+furilazole; sulfentrazone+dimethenamid or (S)-dimethenamid+glyphosate+furilazole; sulfentrazone +acetochlor+glyphosate+furilazole; sulfentrazone+alachlor+glyphosate+furilazole; fluazolate+(S)-metolachlor+glyphosate+furilazole; fluazolate+metolachlor+glyphosate+furilazole; fluazolate+dimethenamid or (S)-dimethenamid+glyphosate+furilazole; fluazolate+acetochlor+glyphosate+furilazole; fluazolate+alachlor+glyphosate+furilazole; pyraflufen-ethyl+(S)-metolachlor+glyphosate+furilazole; pyraflufen-ethyl+metolachlor+glyphosate+furilazole; pyraflufen-ethyl+dimethenamid or (S)-dimethenamid+glyphosate+furilazole; pyraflufen-ethyl+acetochlor+glyphosate+furilazole; pyraflufen-ethyl+alachlor+glyphosate+furilazole; flumipropyn+(S)-metolachlor+glyphosate+furilazole; flumipropyn+metolachlor+glyphosate+furilazole; flumipropyn+dimethenamid or (S)-dimethenamid+glyphosate+furilazole; flumipropyn+acetochlor+glyphosate+furilazole; flumipropyn+alachlor+glyphosate+furilazole; flupropacil+(S)-metolachlor+glyphosate+furilazole; flupropacil+metolachlor+glyphosate+furilazole; flupropacil+dimethenamid or (S)-dimethenamid+glyphosate+furilazole; flupropacil+acetochlor+glyphosate+furilazole; flupropacil+alachlor+glyphosate+furilazole; nipyraclofen+(S)-metolachlor+glyphosate+furilazole; nipyraclofen+metolachlor+glyphosate+furilazole; nipyraclofen+dimethenamid or (S)-dimethenamid+glyphosate+furilazole; nipyraclofen+acetochlor+glyphosate+furilazole; nipyraclofen+alachlor+glyphosate+furilazole; benzfendizone+(S)-metolachlor+glyphosate+furilazole; benzfendizone+metolachlor+glyphosate+furilazole; benzfendizone+dimethenamid or (S)-dimethenamid+glyphosate+furilazole; benzfendizone+acetochlor+glyphosate+furilazole; benzfendizone+alachlor+glyphosate+furilazole; thidiazimin+(S)-metolachlor+glyphosate+furilazole; thidiazimin+metolachlor+glyphosate+furilazole; thidiazimin+dimethenamid or (S)-dimethenamid+glyphosate+furilazole; thidiazimin+acetochlor+glyphosate+furilazole; and thidiazimin+alachlor+glyphosate+furilazole.

Acifluorfen+(S)-metolachlor+glufosinate+benoxacor; acifluorfen+metolachlor+glufosinate+benoxacor; acifluorfen+dimethenamid or (S)-dimethenamid+glufosinate+benoxacor; acifluorfen+acetochlor+glufosinate+benoxacor; acifluorfen+alachlor+glufosinate+benoxacor; aclonifen+(S)-metolachlor+glufosinate+benoxacor; aclonifen+metolachlor+glufosinate+benoxacor; aclonifen+dimethenamid or (S)-dimethenamid+glufosinate+benoxacor; aclonifen+acetochlor+glufosinate+benoxacor; aclonifen+alachlor+glufosinate+benoxacor; bifenox+(S)-metolachlor+glufosinate+benoxacor; bifenox+metolachlor+glufosinate+benoxacor; bifenox+dimethenamid or (S)-dimethenamid+glufosinate+benoxacor; bifenox+acetochlor+glufosinate+benoxacor; bifenox+alachlor+glufosinate+benoxacor; chlomitrofen+(S)-metolachlor+glufosinate+benoxacor; chlomitrofen+metolachlor+glufosinate+benoxacor; chlomitrofen+dimethenamid or (S)-dimethenamid+glufosinate+benoxacor; chlomitrofen+acetochlor+glufosinate+benoxacor; chlomitrofen+alachlor+glufosinate+benoxacor; ethoxyfen+(S)-metolachlor+glufosinate+benoxacor; ethoxyfen+metolachlor+glufosinate+benoxacor; ethoxyfen+dimethenamid or (S)-dimethenamid+glufosinate+benoxacor; ethoxyfen+acetochlor+glufosinate+benoxacor; ethoxyfen+alachlor+glufosinate+benoxacor; fluoroglycofen+(S)-metolachlor+glufosinate+benoxacor; fluoroglycofen+metolachlor+glufosinate+benoxacor; fluoroglycofen+dimethenamid or (S)-dimethenamid +glufosinate+benoxacor; fluoroglycofen+acetochlor+glufosinate+benoxacor; fluoroglycofen+alachlor+glufosinate+benoxacor; fomesafen+(S)-metolachlor+glufosinate+benoxacor; fomesafen+metolachlor+glufosinate+benoxacor; fomesafen+dimethenamid or (S)-dimethenamid+glufosinate+benoxacor; fomesafen+acetochlor+glufosinate+benoxacor; fomesafen+alachlor+glufosinate+benoxacor; lactofen+(S)-metolachlor+glufosinate+benoxacor; lactofen+metolachlor+glufosinate+benoxacor; lactofen+dimethenamid or (S)-dimethenamid+glufosinate+benoxacor; lactofen+acetochlor+glufosinate+benoxacor; lactofen+alachlor+glufosinate+benoxacor; oxyfluorfen+(S)-metolachlor+glufosinate+benoxacor; oxyfluorfen+metolachlor+glufosinate+benoxacor; oxyfluorfen+dimethenamid or (S)-dimethenamid+glufosinate+benoxacor; oxyfluorfen+acetochlor+glufosinate+benoxacor; oxyfluorfen+alachlor+glufosinate+benoxacor; azafenidin+(S)-metolachlor+glufosinate+benoxacor; azafenidin+metolachlor+glufosinate+benoxacor; azafenidin+dimethenamid or (S)-dimethenamid+glufosinate+benoxacor; azafenidin+acetochlor+glufosinate+benoxacor; azafenidin+alachlor+glufosinate+benoxacor; carfentrazone-ethyl+(S)-metolachlor+glufosinate+benoxacor; carfentrazone-ethyl+metolachlor+glufosinate+benoxacor; carfentrazone-ethyl+dimethenamid or (S)-dimethenamid+glufosinate+benoxacor; carfentrazone-ethyl+acetochlor+glufosinate+benoxacor; carfentrazone-ethyl +alachlor+glufosinate+benoxacor; compound of the formula A+(S)-metolachlor+glufosinate+benoxacor; compound of the formula A+metolachlor+glufosinate+benoxacor; compound of the formula A+dimethenamid or (S)-dimethenamid+glufosinate +benoxacor; compound of the formula A+acetochlor+glufosinate+benoxacor; compound of the formula A+alachlor+glufosinate+benoxacor; cinidon-ethyl+(S)-metolachlor+glufosinate+benoxacor; cinidon-ethyl+metolachlor+glufosinate+benoxacor; cinidon-ethyl+dimethenamid or (S)-dimethenamid+glufosinate+benoxacor; cinidon-ethyl+acetochlor+glufosinate+benoxacor; cinidon-ethyl+alachlor+glufosinate +benoxacor; flumiclorac-pentyl+(S)-metolachlor+glufosinate+benoxacor; flumiclorac-pentyl+metolachlor+glufosinate+benoxacor; flumiclorac-pentyl+dimethenamid or (S)-dimethenamid+glufosinate+benoxacor; flumiclorac-pentyl+acetochlor+glufosinate+benoxacor; flumiclorac-pentyl+alachlor+glufosinate+benoxacor; flumioxazin+(S)-metolachlor+glufosinate+benoxacor; flumioxazin+metolachlor+glufosinate+benoxacor; flumioxazin+dimethenamid or (S)-dimethenamid+glufosinate+benoxacor; flumioxazin+acetochlor+glufosinate+benoxacor; flumioxazin+alachlor+glufosinate+benoxacor; fluthiacet-methyl+(S)-metolachlor+glufosinate+benoxacor; fluthiacet-methyl +metolachlor+glufosinate+benoxacor; fluthiacet-methyl+dimethenamid or (S)-dimethenamid+glufosinate+benoxacor; fluthiacet-methyl+acetochlor+glufosinate+benoxacor; fluthiacet-methyl+alachlor+glufosinate+benoxacor; oxadiargyl+(S)-metolachlor+glufosinate+benoxacor; oxadiargyl+metolachlor+glufosinate+benoxacor; oxadiargyl+dimethenamid or (S)-dimethenamid+glufosinate+benoxacor; oxadiargyl+acetochlor+glufosinate+benoxacor; oxadiargyl+alachlor+glufosinate+benoxacor; oxadiazon+(S)-metolachlor+glufosinate+benoxacor; oxadiazon+metolachlor+glufosinate+benoxacor; oxadiazon+dimethenamid or (S)-dimethenamid+glufosinate+benoxacor, oxadiazon+acetochlor+glufosinate+benoxacor; oxadiazon+alachlor+glufosinate+benoxacor; pentoxazone+(S)-metolachlor+glufosinate+benoxacor; pentoxazone+metolachlor+glufosinate+benoxacor; pentoxazone+dimethenamid or (S)-dimethenamid+glufosinate+benoxacor; pentoxazone+acetochlor+glufosinate+benoxacor; pentoxazone+alachlor+glufosinate+benoxacor; sulfentrazone+(S)-metolachlor+glufosinate+benoxacor; sulfentrazone+metolachlor+glufosinate+benoxacor; sulfentrazone+dimethenamid or (S)-dimethenamid+glufosinate+benoxacor; sulfentrazone+acetochlor+glufosinate+benoxacor; sulfentrazone+alachlor+glufosinate+benoxacor; fluazolate+(S)-metolachlor+glufosinate+benoxacor; fluazolate +metolachlor+glufosinate+benoxacor; fluazolate+dimethenamid or (S)-dimethenamid+glufosinate+benoxacor; fluazolate+acetochlor+glufosinate+benoxacor; fluazolate+alachlor+glufosinate+benoxacor; pyraflufen-ethyl+(S)-metolachlor+glufosinate+benoxacor; pyraflufen-ethyl+metolachlor+glufosinate+benoxacor; pyraflufen-ethyl+dimethenamid or (S)-dimethenamid+glufosinate+benoxacor; pyraflufen-ethyl+acetochlor+glufosinate+benoxacor; pyraflufen-ethyl+alachlor+glufosinate+benoxacor; flumipropyn+(S)-metolachlor+glufosinate+benoxacor; flumipropyn+metolachlor+glufosinate+benoxacor; flumipropyn+dimethenamid or (S)-dimethenamid+glufosinate+benoxacor; flumipropyn+acetochlor+glufosinate+benoxacor; flumipropyn+alachlor+glufosinate+benoxacor; flupropacil+(S)-metolachlor+glufosinate+benoxacor; flupropacil+metolachlor+glufosinate+benoxacor; flupropacil+dimethenamid or (S)-dimethenamid+glufosinate+benoxacor; flupropacil+acetochlor+glufosinate+benoxacor; flupropacil+alachlor+glufosinate+benoxacor; nipyraclofen+(S)-metolachlor +glufosinate+benoxacor; nipyraclofen+metolachlor+glufosinate+benoxacor; nipyraclofen+dimethenamid or (S)-dimethenamid+glufosinate+benoxacor; nipyraclofen +acetochlor+glufosinate+benoxacor; nipyraclofen+alachlor+glufosinate+benoxacor; benzfendizone+(S)-metolachlor+glufosinate+benoxacor; benzfendizone+metolachlor+glufosinate+benoxacor; benzfendizone+dimethenamid or (S)-dimethenamid+glufosinate +benoxacor; benzfendizone+acetochlor+glufosinate+benoxacor; benzfendizone+alachlor+glufosinate+benoxacor; thidiazimin+(S)-metolachlor+glufosinate+benoxacor; thidiazimin+metolachlor+glufosinate+benoxacor; thidiazimin+dimethenamid or (S)-dimethenamid+glufosinate+benoxacor; thidiazimin+acetochlor+glufosinate+benoxacor; and thidiazimin+alachlor+glufosinate+benoxacor.

Acifluorfen+(S)-metolachlor+glufosinate+MON 4660; acifluorfen+metolachlor+glufosinate+MON 4660; acifluorfen+dimethenamid or (S)-dimethenamid+glufosinate+MON 4660; acifluorfen+acetochlor+glufosinate+MON 4660; acifluorfen+alachlor+glufosinate+MON 4660; aclonifen+(S)-metolachlor+glufosinate+MON 4660; aclonifen +metolachlor+glufosinate+MON 4660; aclonifen+dimethenamid or (S)-dimethenamid+glufosinate+MON 4660; aclonifen+acetochlor+glufosinate+MON 4660; aclonifen+alachlor+glufosinate+MON 4660; bifenox+(S)-metolachlor+glufosinate+MON 4660; bifenox+metolachlor+glufosinate+MON 4660; bifenox+dimethenamid or (S)-dimethenamid+glufosinate+MON 4660; bifenox+acetochlor+glufosinate+MON 4660; bifenox+alachlor+glufosinate+MON 4660; chlomitrofen+(S)-metolachlor+glufosinate+MON 4660; chlomitrofen+metolachlor+glufosinate+MON 4660; chlomitrofen+dimethenamid or (S)-dimethenamid+glufosinate+MON 4660; chlomitrofen+acetochlor+glufosinate+MON 4660; chlomitrofen+alachlor+glufosinate+MON 4660; ethoxyfen+(S)-metolachlor+glufosinate+MON 4660; ethoxyfen+metolachlor+glufosinate+MON 4660; ethoxyfen+dimethenamid or (S)-dimethenamid+glufosinate+MON 4660; ethoxyfen+acetochlor+glufosinate+MON 4660; ethoxyfen+alachlor+glufosinate+MON 4660; fluoroglycofen+(S)-metolachlor+glufosinate+MON 4660; fluoroglycofen+metolachlor+glufosinate+MON 4660; fluoroglycofen+dimethenamid or (S)-dimethenamid +glufosinate+MON 4660; fluoroglycofen+acetochlor+glufosinate+MON 4660; fluoroglycofen+alachlor+glufosinate+MON 4660; fomesafen+(S)-metolachlor+glufosinate+MON 4660; fomesafen+metolachlor+glufosinate+MON 4660; fomesafen+dimethenamid or (S)-dimethenamid+glufosinate+MON 4660; fomesafen+acetochlor+glufosinate+MON 4660; fomesafen+alachlor+glufosinate+MON 4660; lactofen+(S)-metolachlor+glufosinate+MON 4660; lactofen+metolachlor+glufosinate+MON 4660; lactofen+dimethenamid or (S)-dimethenamid+glufosinate+MON 4660; lactofen+acetochlor+glufosinate+MON 4660; lactofen+alachlor+glufosinate+MON 4660; oxyfluorfen+(S)-metolachlor+glufosinate+MON 4660; oxyfluorfen+metolachlor+glufosinate+MON 4660; oxyfluorfen+dimethenamid or (S)-dimethenamid+glufosinate+MON 4660; oxyfluorfen+acetochlor+glufosinate+MON 4660; oxyfluorfen+alachlor+glufosinate+MON 4660; azafenidin+(S)-metolachlor+glufosinate+MON 4660; azafenidin+metolachlor+glufosinate+MON 4660; azafenidin+dimethenamid or (S)-dimethenamid+glufosinate+MON 4660; azafenidin+acetochlor+glufosinate+MON 4660; azafenidin+alachlor+glufosinate+MON 4660; carfentrazone-ethyl+(S)-metolachlor+glufosinate+MON 4660; carfentrazone-ethyl+metolachlor+glufosinate+MON 4660; carfentrazone-ethyl+dimethenamid or (S)-dimethenamid+glufosinate+MON 4660; carfentrazone-ethyl+acetochlor+glufosinate+MON 4660; carfentrazone-ethyl+alachlor+glufosinate+MON 4660; compound of the formula A+(S)-metolachlor+glufosinate+MON 4660; compound of the formula A+metolachlor+glufosinate+MON 4660; compound of the formula A+dimethenamid or (S)-dimethenamid+glufosinate+MON 4660; compound of the formula A+acetochlor+glufosinate+MON 4660; compound of the formula A+alachlor+glufosinate+MON 4660; cinidon-ethyl+(S)-metolachlor+glufosinate+MON 4660; cinidon-ethyl+metolachlor+glufosinate+MON 4660; cinidon-ethyl+dimethenamid or (S)-dimethenamid+glufosinate+MON 4660; cinidon-ethyl+acetochlor+glufosinate+MON 4660; cinidon-ethyl+alachlor+glufosinate+MON 4660; flumiclorac-pentyl+(S)-metolachlor+glufosinate+MON 4660; flumiclorac-pentyl+metolachlor+glufosinate+MON 4660; flumiclorac-pentyl+dimethenamid or (S)-dimethenamid+glufosinate+MON 4660; flumiclorac-pentyl+acetochlor+glufosinate+MON 4660; flumiclorac-pentyl+alachlor+glufosinate+MON 4660; flumioxazin+(S)-metolachlor+glufosinate+MON 4660; flumioxazin+metolachlor+glufosinate+MON 4660; flumioxazin+dimethenamid or (S)-dimethenamid+glufosinate+MON 4660; flumioxazin+acetochlor+glufosinate+MON 4660; flumioxazin+alachlor+glufosinate+MON 4660; fluthiacet-methyl+(S)-metolachlor+glufosinate+MON 4660; fluthiacet-methyl +metolachlor+glufosinate+MON 4660; fluthiacet-methyl+dimethenamid or (S)-dimethenamid+glufosinate+MON 4660; fluthiacet-methyl+acetochlor+glufosinate+MON 4660; fluthiacet-methyl+alachlor+glufosinate+MON 4660; oxadiargyl+(S)-metolachlor+glufosinate+MON 4660; oxadiargyl+metolachlor+glufosinate+MON 4660; oxadiargyl+dimethenamid or (S)-dimethenamid+glufosinate+MON 4660; oxadiargyl+acetochlor+glufosinate+MON 4660; oxadiargyl+alachlor+glufosinate+MON 4660; oxadiazon+(S)-metolachlor+glufosinate+MON 4660; oxadiazon+metolachlor+glufosinate+MON 4660; oxadiazon+dimethenamid or (S)-dimethenamid+glufosinate+MON 4660; oxadiazon+acetochlor+glufosinate+MON 4660; oxadiazon+alachlor+glufosinate+MON 4660; pentoxazone+(S)-metolachlor+glufosinate+MON 4660; pentoxazone+metolachlor+glufosinate+MON 4660; pentoxazone+dimethenamid or (S)-dimethenamid+glufosinate+MON 4660; pentoxazone+acetochlor +glufosinate+MON 4660; pentoxazone+alachlor+glufosinate+MON 4660; sulfentrazone+(S)-metolachlor+glufosinate+MON 4660; sulfentrazone+metolachlor+glufosinate+MON 4660; sulfentrazone+dimethenamid or (S)-dimethenamid+glufosinate +MON 4660; sulfentrazone+acetochlor+glufosinate+MON 4660; sulfentrazone+alachlor+glufosinate+MON 4660; fluazolate+(S)-metolachlor+glufosinate+MON 4660; fluazolate+metolachlor+glufosinate+MON 4660; fluazolate+dimethenamid or (S)-dimethenamid+glufosinate+MON 4660; fluazolate+acetochlor+glufosinate+MON 4660; fluazolate+alachlor+glufosinate+MON 4660; pyraflufen-ethyl+(S)-metolachlor+glufosinate+MON 4660; pyraflufen-ethyl+metolachlor+glufosinate+MON 4660; pyraflufen-ethyl+dimethenamid or (S)-dimethenamid+glufosinate+MON 4660; pyraflufen-ethyl+acetochlor+glufosinate+MON 4660; pyraflufen-ethyl+alachlor+glufosinate+MON 4660; flumipropyn+(S)-metolachlor+glufosinate+MON 4660; flumipropyn+metolachlor+glufosinate+MON 4660; flumipropyn+dimethenamid or (S)-dimethenamid+glufosinate+MON 4660; flumipropyn+acetochlor+glufosinate+MON 4660; flumipropyn+alachlor+glufosinate+MON 4660; flupropacil+(S)-metolachlor+glufosinate+MON 4660; flupropacil+metolachlor+glufosinate+MON 4660; flupropacil+dimethenamid or (S)-dimethenamid+glufosinate+MON 4660; flupropacil+acetochlor+glufosinate+MON 4660; flupropacil+alachlor+glufosinate+MON 4660; nipyraclofen+(S)-metolachlor+glufosinate+MON 4660; nipyraclofen+metolachlor+glufosinate+MON 4660; nipyraclofen+dimethenamid or (S)-dimethenamid+glufosinate+MON 4660; nipyraclofen+acetochlor+glufosinate+MON 4660; nipyraclofen+alachlor+glufosinate+MON 4660; benzfendizone+(S)-metolachlor+glufosinate+MON 4660; benzfendizone+metolachlor+glufosinate+MON 4660; benzfendizone+dimethenamid or (S)-dimethenamid+glufosinate+MON 4660; benzfendizone+acetochlor+glufosinate+MON 4660; benzfendizone+alachlor+glufosinate+MON 4660; thidiazimin+(S)-metolachlor+glufosinate+MON 4660; thidiazimin+metolachlor+glufosinate+MON 4660; thidiazimin+dimethenamid or (S)-dimethenamid+glufosinate+MON 4660; thidiazimin+acetochlor+glufosinate+MON 4660; and thidiazimin+alachlor+glufosinate+MON 4660.

Acifluorfen+(S)-metolachlor+glufosinate+flurazole; acifluorfen+metolachlor+glufosinate+flurazole; acifluorfen+dimethenamid or (S)-dimethenamid+glufosinate+flurazole; acifluorfen+acetochlor+glufosinate+flurazole; acifluorfen+alachlor+glufosinate+flurazole; aclonifen+(S)-metolachlor+glufosinate+flurazole; aclonifen+metolachlor+glufosinate+flurazole; aclonifen+dimethenamid or (S)-dimethenamid+glufosinate+flurazole; aclonifen+acetochlor+glufosinate+flurazole; aclonifen+alachlor +glufosinate+flurazole; bifenox+(S)-metolachlor+glufosinate+flurazole; bifenox+metolachlor+glufosinate+flurazole; bifenox+dimethenamid or (S)-dimethenamid+glufosinate+flurazole; bifenox+acetochlor+glufosinate+flurazole; bifenox+alachlor+glufosinate+flurazole; chlomitrofen+(S)-metolachlor+glufosinate+flurazole; chlomitrofen+metolachlor+glufosinate+flurazole; chlomitrofen+dimethenamid or (S)-dimethenamid+glufosinate+flurazole; chlomitrofen+acetochlor+glufosinate+flurazole; chlomitrofen+alachlor+glufosinate+flurazole; ethoxyfen+(S)-metolachlor+glufosinate +flurazole; ethoxyfen+metolachlor+glufosinate+flurazole; ethoxyfen+dimethenamid or (S)-dimethenamid+glufosinate+flurazole; ethoxyfen+acetochlor+glufosinate+flurazole; ethoxyfen+alachlor+glufosinate+flurazole; fluoroglycofen+(S)-metolachlor+glufosinate+flurazole; fluoroglycofen+metolachlor+glufosinate+flurazole; fluoroglycofen +dimethenamid or (S)-dimethenamid+glufosinate+flurazole; fluoroglycofen+acetochlor +glufosinate+flurazole; fluoroglycofen+alachlor+glufosinate+flurazole; fomesafen+(S)-metolachlor+glufosinate+flurazole; fomesafen+metolachlor+glufosinate+flurazole; fomesafen+dimethenamid or (S)-dimethenamid+glufosinate+flurazole; fomesafen+acetochlor+glufosinate+flurazole; fomesafen+alachlor+glufosinate+flurazole; lactofen +(S)-metolachlor+glufosinate+flurazole; lactofen+metolachlor+glufosinate+flurazole; lactofen+dimethenamid or (S)-dimethenamid+glufosinate+flurazole; lactofen+acetochlor+glufosinate+flurazole; lactofen+alachlor+glufosinate+flurazole; oxyfluorfen +(S)-metolachlor+glufosinate+flurazole; oxyfluorfen+metolachlor+glufosinate+flurazole; oxyfluorfen+dimethenamid or (S)-dimethenamid+glufosinate+flurazole; oxyfluorfen+acetochlor+glufosinate+flurazole; oxyfluorfen+alachlor+glufosinate+flurazole; azafenidin+(S)-metolachlor+glufosinate+flurazole; azafenidin+metolachlor+glufosinate+flurazole; azafenidin+dimethenamid or (S)-dimethenamid+glufosinate+flurazole; azafenidin+acetochlor+glufosinate+flurazole; azafenidin+alachlor+glufosinate+flurazole; carfentrazone-ethyl+(S)-metolachlor+glufosinate+flurazole; carfentrazone-ethyl+metolachlor+glufosinate+flurazole; carfentrazone-ethyl+dimethenamid or (S)-dimethenamid+glufosinate+flurazole; carfentrazone-ethyl+acetochlor+glufosinate+flurazole; carfentrazone-ethyl+alachlor+glufosinate+flurazole; compound of the formula A+(S)-metolachlor+glufosinate+flurazole; compound of the formula A+metolachlor+glufosinate+flurazole; compound of the formula A+dimethenamid or (S)-dimethenamid+glufosinate+flurazole; compound of the formula A+acetochlor+glufosinate+flurazole; compound of the formula A+alachlor+glufosinate+flurazole; cinidon-ethyl+(S)-metolachlor+glufosinate+flurazole; cinidon-ethyl+metolachlor+glufosinate+flurazole; cinidon-ethyl+dimethenamid or (S)-dimethenamid+glufosinate+flurazole; cinidon-ethyl+acetochlor+glufosinate+flurazole; cinidon-ethyl+alachlor+glufosinate+flurazole; flumiclorac-pentyl+(S)-metolachlor+glufosinate+flurazole; flumiclorac-pentyl+metolachlor+glufosinate+flurazole; flumiclorac-pentyl+dimethenamid or (S)-dimethenamid+glufosinate+flurazole; flumiclorac-pentyl+acetochlor +glufosinate+flurazole; flumiclorac-pentyl+alachlor+glufosinate+flurazole; flumioxazin +(S)-metolachlor+glufosinate+flurazole; flumioxazin+metolachlor+glufosinate+flurazole; flumioxazin+dimethenamid or (S)-dimethenamid+glufosinate+flurazole; flumioxazin+acetochlor+glufosinate+flurazole; flumioxazin+alachlor+glufosinate+flurazole; fluthiacet-methyl+(S)-metolachlor+glufosinate+flurazole; fluthiacet-methyl+metolachlor+glufosinate+flurazole; fluthiacet-methyl+dimethenamid or (S)-dimethenamid +glufosinate+flurazole; fluthiacet-methyl+acetochlor+glufosinate+flurazole; fluthiacet-methyl+alachlor+glufosinate+flurazole; oxadiargyl+(S)-metolachlor+glufosinate+flurazole; oxadiargyl+metolachlor+glufosinate+flurazole; oxadiargyl+dimethenamid or (S)-dimethenamid+glufosinate+flurazole; oxadiargyl+acetochlor+glufosinate+flurazole; oxadiargyl+alachlor+glufosinate+flurazole; oxadiazon+(S)-metolachlor+glufosinate+flurazole; oxadiazon+metolachlor+glufosinate+flurazole; oxadiazon+dimethenamid or (S)-dimethenamid+glufosinate+flurazole; oxadiazon+acetochlor+glufosinate+flurazole; oxadiazon+alachlor+glufosinate+flurazole; pentoxazone+(S)-metolachlor+glufosinate+flurazole; pentoxazone+metolachlor+glufosinate+flurazole; pentoxazone+dimethenamid or (S)-dimethenamid+glufosinate+flurazole; pentoxazone +acetochlor+glufosinate+flurazole; pentoxazone+alachlor+glufosinate+flurazole; sulfentrazone+(S)-metolachlor+glufosinate+flurazole; sulfentrazone+metolachlor+glufosinate+flurazole; sulfentrazone+dimethenamid or (S)-dimethenamid+glufosinate+flurazole; sulfentrazone+acetochlor+glufosinate+flurazole; sulfentrazone+alachlor+glufosinate+flurazole; fluazolate+(S)-metolachlor+glufosinate+flurazole; fluazolate+metolachlor+glufosinate+flurazole; fluazolate+dimethenamid or (S)-dimethenamid+glufosinate+flurazole; fluazolate+acetochlor+glufosinate+flurazole; fluazolate+alachlor+glufosinate+flurazole; pyraflufen-ethyl+(S)-metolachlor+glufosinate+flurazole; pyraflufen-ethyl+metolachlor+glufosinate+flurazole; pyraflufen-ethyl+dimethenamid or (S)-dimethenamid+glufosinate+flurazole; pyraflufen-ethyl+acetochlor +glufosinate+flurazole; pyraflufen-ethyl+alachlor+glufosinate+flurazole; flumipropyn+(S)-metolachlor+glufosinate+flurazole; flumipropyn+metolachlor+glufosinate+flurazole; flumipropyn+dimethenamid or (S)-dimethenamid+glufosinate+flurazole; flumipropyn+acetochlor+glufosinate+flurazole; flumipropyn+alachlor+glufosinate+flurazole; flupropacil+(S)-metolachlor+glufosinate+flurazole; flupropacil+metolachlor+glufosinate+flurazole; flupropacil+dimethenamid or (S)-dimethenamid+glufosinate+flurazole; flupropacil+acetochlor+glufosinate+flurazole; flupropacil+alachlor+glufosinate+flurazole; nipyraclofen+(S)-metolachlor+glufosinate+flurazole; nipyraclofen +metolachlor+glufosinate+flurazole; nipyraclofen+dimethenamid or (S)-dimethenamid+glufosinate+flurazole; nipyraclofen+acetochlor+glufosinate+flurazole; nipyraclofen+alachlor+glufosinate+flurazole; benzfendizone+(S)-metolachlor+glufosinate+flurazole; benzfendizone+metolachlor+glufosinate+flurazole; benzfendizone+dimethenamid or (S)-dimethenamid+glufosinate+flurazole; benzfendizone+acetochlor+glufosinate+flurazole; benzfendizone+alachlor+glufosinate+flurazole; thidiazimin+(S)-metolachlor+glufosinate+flurazole; thidiazimin+metolachlor+glufosinate+flurazole; thidiazimin+dimethenamid or (S)-dimethenamid+glufosinate+flurazole; thidiazimin+acetochlor+glufosinate+flurazole; and thidiazimin+alachlor+glufosinate+flurazole.

Acifluorfen+(S)-metolachlor+glufosinate+dichlormid; acifluorfen+metolachlor+glufosinate+dichlormid; acifluorfen+dimethenamid or (S)-dimethenamid+glufosinate+dichlormid; acifluorfen+acetochlor+glufosinate+dichlormid; acifluorfen+alachlor+glufosinate+dichlormid; aclonifen+(S)-metolachlor+glufosinate+dichlormid; aclonifen+metolachlor+glufosinate+dichlormid; aclonifen+dimethenamid or (S)-dimethenamid+glufosinate+dichlormid; aclonifen+acetochlor+glufosinate+dichlormid; aclonifen+alachlor+glufosinate+dichlormid; bifenox+(S)-metolachlor+glufosinate+dichlormid; bifenox+metolachlor+glufosinate+dichlormid; bifenox+dimethenamid or (S)-dimethenamid+glufosinate+dichlormid; bifenox+acetochlor+glufosinate+dichlormid; bifenox+alachlor+glufosinate+dichlormid; chlomitrofen+(S)-metolachlor+glufosinate+dichlormid; chlomitrofen+metolachlor+glufosinate+dichlormid; chlomitrofen+dimethenamid or (S)-dimethenamid+glufosinate+dichlormid; chlomitrofen+acetochlor+glufosinate+dichlormid; chlomitrofen+alachlor+glufosinate+dichlormid; ethoxyfen+(S)-metolachlor+glufosinate+dichlormid; ethoxyfen+metolachlor+glufosinate+dichlormid; ethoxyfen+dimethenamid or (S)-dimethenamid+glufosinate+dichlormid; ethoxyfen+acetochlor+glufosinate+dichlormid; ethoxyfen+alachlor+glufosinate+dichlormid; fluoroglycofen+(S)-metolachlor+glufosinate+dichlormid; fluoroglycofen+metolachlor+glufosinate+dichlormid; fluoroglycofen+dimethenamid or (S)-dimethenamid+glufosinate +dichlormid; fluoroglycofen+acetochlor+glufosinate+dichlormid; fluoroglycofen+alachlor+glufosinate+dichlormid; fomesafen+(S)-metolachlor+glufosinate+dichlormid; fomesafen+metolachlor+glufosinate+dichlormid; fomesafen+dimethenamid or (S)-dimethenamid+glufosinate+dichlormid; fomesafen+acetochlor+glufosinate+dichlormid; fomesafen+alachlor+glufosinate+dichlormid; lactofen+(S)-metolachlor+glufosinate+dichlormid; lactofen+metolachlor+glufosinate+dichlormid; lactofen+dimethenamid or (S)-dimethenamid+glufosinate+dichlormid; lactofen+acetochlor+glufosinate+dichlormid; lactofen+alachlor+glufosinate+dichlormid; oxyfluorfen+(S)-metolachlor+glufosinate+dichlormid; oxyfluorfen+metolachlor+glufosinate+dichlormid; oxyfluorfen+dimethenamid or (S)-dimethenamid+glufosinate+dichlormid; oxyfluorfen+acetochlor+glufosinate+dichlormid; oxyfluorfen+alachlor+glufosinate+dichlormid; azafenidin+(S)-metolachlor+glufosinate+dichlormid; azafenidin+metolachlor+glufosinate+dichlormid; azafenidin+dimethenamid or (S)-dimethenamid+glufosinate+dichlormid; azafenidin+acetochlor+glufosinate+dichlormid; azafenidin+alachlor+glufosinate+dichlormid; carfentrazone-ethyl+(S)-metolachlor+glufosinate+dichlormid; carfentrazone-ethyl+metolachlor+glufosinate+dichlormid; carfentrazone-ethyl+dimethenamid or (S)-dimethenamid+glufosinate+dichlormid; carfentrazone-ethyl+acetochlor+glufosinate+dichlormid; carfentrazone-ethyl+alachlor+glufosinate+dichlormid; compound of the formula A+(S)-metolachlor+glufosinate+dichlormid; compound of the formula A+metolachlor+glufosinate+dichlormid; compound of the formula A+dimethenamid or (S)-dimethenamid+glufosinate+dichlormid; compound of the formula A+acetochlor+glufosinate+dichlormid; compound of the formula A+alachlor +glufosinate+dichlormid; cinidon-ethyl+(S)-metolachlor+glufosinate+dichlormid; cinidon-ethyl+metolachlor+glufosinate+dichlormid; cinidon-ethyl+dimethenamid or (S)-dimethenamid+glufosinate+dichlormid; cinidon-ethyl+acetochlor+glufosinate+dichlormid; cinidon-ethyl+alachlor+glufosinate+dichlormid; flumiclorac-pentyl+(S)-metolachlor+glufosinate+dichlormid; flumiclorac-pentyl+metolachlor+glufosinate+dichlormid; flumiclorac-pentyl+dimethenamid or (S)-dimethenamid+glufosinate+dichlormid; flumiclorac-pentyl+acetochlor+glufosinate+dichlormid; flumiclorac-pentyl+alachlor+glufosinate+dichlormid; flumioxazin+(S)-metolachlor+glufosinate+dichlormid; flumioxazin+metolachlor+glufosinate+dichlormid; flumioxazin+dimethenamid or (S)-dimethenamid+glufosinate+dichlormid; flumioxazin+acetochlor+glufosinate+dichlormid; flumioxazin+alachlor+glufosinate+dichlormid; fluthiacet-methyl+(S)-metolachlor+glufosinate+dichlormid; fluthiacet-methyl+metolachlor+glufosinate+dichlormid; fluthiacet-methyl+dimethenamid or (S)-dimethenamid+glufosinate+dichlormid; fluthiacet-methyl+acetochlor+glufosinate+dichlormid; fluthiacet-methyl+alachlor+glufosinate+dichlormid; oxadiargyl+(S)-metolachlor+glufosinate+dichlormid; oxadiargyl+metolachlor+glufosinate+dichlormid; oxadiargyl+dimethenamid or (S)-dimethenamid+glufosinate+dichlormid; oxadiargyl+acetochlor+glufosinate+dichlormid; oxadiargyl+alachlor+glufosinate+dichlormid; oxadiazon+(S)-metolachlor+glufosinate+dichlormid; oxadiazon+metolachlor+glufosinate+dichlormid; oxadiazon+dimethenamid or (S)-dimethenamid+glufosinate+dichlormid; oxadiazon+acetochlor+glufosinate+dichlormid; oxadiazon+alachlor+glufosinate+dichlormid; pentoxazone+(S)-metolachlor+glufosinate+dichlormid; pentoxazone+metolachlor+glufosinate+dichlormid; pentoxazone+dimethenamid or (S)-dimethenamid+glufosinate+dichlormid; pentoxazone+acetochlor+glufosinate+dichlormid; pentoxazone+alachlor+glufosinate +dichlormid; sulfentrazone+(S)-metolachlor+glufosinate+dichlormid; sulfentrazone+metolachlor+glufosinate+dichlormid; sulfentrazone+dimethenamid or (S)-dimethenamid +glufosinate+dichlormid; sulfentrazone+acetochlor+glufosinate+dichlormid; sulfentrazone+alachlor+glufosinate+dichlormid; fluazolate+(S)-metolachlor+glufosinate+dichlormid; fluazolate+metolachlor+glufosinate+dichlormid; fluazolate+dimethenamid or (S)-dimethenamid+glufosinate+dichlormid; fluazolate+acetochlor+glufosinate+dichlormid; fluazolate+alachlor+glufosinate+dichlormid; pyraflufen-ethyl+(S)-metolachlor+glufosinate+dichlormid; pyraflufen-ethyl+metolachlor+glufosinate+dichlormid; pyraflufen-ethyl+dimethenamid or (S)-dimethenamid+glufosinate+dichlormid; pyraflufen-ethyl+acetochlor+glufosinate+dichlormid; pyraflufen-ethyl+alachlor+glufosinate+dichlormid; flumipropyn+(S)-metolachlor+glufosinate+dichlormid; flumipropyn+metolachlor+glufosinate+dichlormid; flumipropyn+dimethenamid or (S)-dimethenamid+glufosinate+dichlormid; flumipropyn+acetochlor+glufosinate+dichlormid; flumipropyn+alachlor+glufosinate+dichlormid; flupropacil+(S)-metolachlor+glufosinate+dichlormid; flupropacil+metolachlor+glufosinate+dichlormid; flupropacil+dimethenamid or (S)-dimethenamid+glufosinate+dichlorrmid; flupropacil+acetochlor+glufosinate+dichlormid; flupropacil+alachlor+glufosinate+dichlormid; nipyraclofen+(S)-metolachlor+glufosinate+dichlormid; nipyraclofen+metolachlor+glufosinate+dichlormid; nipyraclofen+dimethenamid or (S)-dimethenamid+glufosinate+dichlormid; nipyraclofen+acetochlor+glufosinate+dichlormid; nipyraclofen+alachlor+glufosinate+dichlormid; benzfendizone+(S)-metolachlor+glufosinate+dichlormid; benzfendizone+metolachlor+glufosinate+dichlormid; benzfendizone+dimethenamid or (S)-dimethenamid+glufosinate+dichlormid; benzfendizone+acetochlor+glufosinate+dichlormid; benzfendizone+alachlor+glufosinate+dichlormid; thidiazimin+(S)-metolachlor+glufosinate+dichlormid; thidiazimin+metolachlor+glufosinate+dichlormid; thidiazimin+dimethenamid or (S)-dimethenamid+glufosinate+dichlormid; thidiazimin+acetochlor+glufosinate+dichlormid; and thidiazimin+alachlor+glufosinate+dichlormid.

Acifluorfen+(S)-metolachlor+glufosinate+furilazole; acifluorfen+metolachlor+glufosinate+furilazole; acifluorfen+dimethenamid or (S)-dimethenamid+glufosinate+furilazole; acifluorfen+acetochlor+glufosinate+furilazole; acifluorfen+alachlor+glufosinate+furilazole; aclonifen+(S)-metolachlor+glufosinate+furilazole; aclonifen+metolachlor+glufosinate+furilazole; aclonifen+dimethenamid or (S)-dimethenamid+glufosinate+furilazole; aclonifen+acetochlor+glufosinate+furilazole; aclonifen+alachlor+glufosinate+furilazole; bifenox+(S)-metolachlor+glufosinate+furilazole; bifenox+metolachlor+glufosinate+furilazole; bifenox+dimethenamid or (S)-dimethenamid+glufosinate+furilazole; bifenox+acetochlor+glufosinate+furilazole; bifenox+alachlor+glufosinate+furilazole; chlomitrofen+(S)-metolachlor+glufosinate+furilazole; chlomitrofen+metolachlor+glufosinate+furilazole; chlomitrofen+dimethenamid or (S)-dimethenamid+glufosinate+furilazole; chlomitrofen+acetochlor+glufosinate+furilazole; chlomitrofen+alachlor+glufosinate+furilazole; ethoxyfen+(S)-metolachlor+glufosinate+furilazole; ethoxyfen+metolachlor+glufosinate+furilazole; ethoxyfen+dimethenamid or (S)-dimethenamid+glufosinate+furilazole; ethoxyfen+acetochlor+glufosinate+furilazole; ethoxyfen+alachlor+glufosinate+furilazole; fluoroglycofen+(S)-metolachlor+glufosinate+furilazole; fluoroglycofen+metolachlor+glufosinate+furilazole; fluoroglycofen+dimethenamid or (S)-dimethenamid+glufosinate+furilazole; fluoroglycofen+acetochlor+glufosinate+furilazole; fluoroglycofen+alachlor+glufosinate+furilazole; fomesafen+(S)-metolachlor+glufosinate+furilazole; fomesafen+metolachlor+glufosinate+furilazole; fomesafen+dimethenamid or (S)-dimethenamid+glufosinate+furilazole; fomesafen+acetochlor+glufosinate+furilazole; fomesafen+alachlor+glufosinate+furilazole; lactofen+(S)-metolachlor+glufosinate+furilazole; lactofen+metolachlor+glufosinate+furilazole; lactofen+dimethenamid or (S)-dimethenamid+glufosinate+furilazole; lactofen+acetochlor+glufosinate+furilazole; lactofen+alachlor+glufosinate+furilazole; oxyfluorfen+(S)-metolachlor+glufosinate+furilazole; oxyfluorfen+metolachlor+glufosinate+furilazole; oxyfluorfen+dimethenamid or (S)-dimethenamid+glufosinate+furilazole; oxyfluorfen+acetochlor+glufosinate+furilazole; oxyfluorfen+alachlor+glufosinate+furilazole; azafenidin+(S)-metolachlor+glufosinate+furilazole; azafenidin+metolachlor+glufosinate+furilazole; azafenidin+dimethenamid or (S)-dimethenamid+glufosinate+furilazole; azafenidin+acetochlor+glufosinate+furilazole; azafenidin+alachlor+glufosinate+furilazole; carfentrazone-ethyl +(S)-metolachlor+glufosinate+furilazole; carfentrazone-ethyl+metolachlor+glufosinate +furilazole; carfentrazone-ethyl+dimethenamid or (S)-dimethenamid+glufosinate+furilazole; carfentrazone-ethyl+acetochlor+glufosinate+furilazole; carfentrazone-ethyl+alachlor+glufosinate+furilazole; compound of the formula A+(S)-metolachlor+glufosinate+furilazole; compound of the formula A+metolachlor+glufosinate+furilazole; compound of the formula A+dimethenamid or (S)-dimethenamid+glufosinate+furilazole; compound of the formula A+acetochlor+glufosinate+furilazole; compound of the formula A+alachlor+glufosinate+furilazole; cinidon-ethyl+(S)-metolachlor+glufosinate+furilazole; cinidon-ethyl+metolachlor+glufosinate+furilazole; cinidon-ethyl+dimethenamid or (S)-dimethenamid+glufosinate+furilazole; cinidon-ethyl+acetochlor+glufosinate+furilazole; cinidon-ethyl+alachlor+glufosinate+furilazole; flumiclorac-pentyl +(S)-metolachlor+glufosinate+furilazole; flumiclorac-pentyl+metolachlor+glufosinate+furilazole; flumiclorac-pentyl+dimethenamid or (S)-dimethenamid+glufosinate+furilazole; flumiclorac-pentyl+acetochlor+glufosinate+furilazole; flumiclorac-pentyl+alachlor+glufosinate+furilazole; flumioxazin+(S)-metolachlor+glufosinate+furilazole; flumioxazin +metolachlor+glufosinate+furilazole; flumioxazin+dimethenamid or (S)-dimethenamid+glufosinate+furilazole; flumioxazin+acetochlor+glufosinate+furilazole; flumioxazin+alachlor+glufosinate+furilazole; fluthiacet-methyl+(S)-metolachlor+glufosinate+furilazole; fluthiacet-methyl+metolachlor+glufosinate+furilazole; fluthiacet-methyl+dimethenamid or (S)-dimethenamid+glufosinate+furilazole; fluthiacet-methyl+acetochlor +glufosinate+furilazole; fluthiacet-methyl+alachlor+glufosinate+furilazole; oxadiargyl+(S)-metolachlor+glufosinate+furilazole; oxadiargyl+metolachlor+glufosinate+furilazole; oxadiargyl+dimethenamid or (S)-dimethenamid+glufosinate+furilazole; oxadiargyl+acetochlor+glufosinate+furilazole; oxadiargyl+alachlor+glufosinate+furilazole; oxadiazon+(S)-metolachlor+glufosinate+furilazole; oxadiazon+metolachlor+glufosinate+furilazole; oxadiazon+dimethenamid or (S)-dimethenamid+glufosinate+furilazole; oxadiazon+acetochlor+glufosinate+furilazole; oxadiazon+alachlor+glufosinate+furilazole; pentoxazone+(S)-metolachlor+glufosinate+furilazole; pentoxazone+metolachlor+glufosinate+furilazole; pentoxazone+dimethenamid or (S)-dimethenamid+glufosinate+furilazole; pentoxazone+acetochlor+glufosinate+furilazole; pentoxazone+alachlor+glufosinate+furilazole; sulfentrazone+(S)-metolachlor+glufosinate+furilazole; sulfentrazone+metolachlor+glufosinate+furilazole; sulfentrazone+dimethenamid or (S)-dimethenamid+glufosinate+furilazole; sulfentrazone +acetochlor+glufosinate+furilazole; sulfentrazone+alachlor+glufosinate+furilazole; fluazolate+(S)-metolachlor+glufosinate+furilazole; fluazolate+metolachlor+glufosinate+furilazole; fluazolate+dimethenamid or (S)-dimethenamid+glufosinate+furilazole; fluazolate+acetochlor+glufosinate+furilazole; fluazolate+alachlor+glufosinate+furilazole; pyraflufen-ethyl+(S)-metolachlor+glufosinate+furilazole; pyraflufen-ethyl+metolachlor+glufosinate+furilazole; pyraflufen-ethyl+dimethenamid or (S)-dimethenamid+glufosinate+furilazole; pyraflufen-ethyl+acetochlor+glufosinate+furilazole; pyraflufen-ethyl+alachlor+glufosinate+furilazole; flumipropyn+(S)-metolachlor+glufosinate+furilazole; flumipropyn+metolachlor+glufosinate+furilazole; flumipropyn+dimethenamid or (S)-dimethenamid+glufosinate+furilazole; flumipropyn+acetochlor+glufosinate+furilazole; flumipropyn+alachlor+glufosinate+furilazole; flupropacil+(S)-metolachlor+glufosinate+furilazole; flupropacil+metolachlor+glufosinate+furilazole; flupropacil+dimethenamid or (S)-dimethenamid+glufosinate+furilazole; flupropacil+acetochlor+glufosinate+furilazole; flupropacil+alachlor+glufosinate+furilazole; nipyraclofen+(S)-metolachlor+glufosinate+furilazole; nipyraclofen+metolachlor+glufosinate+furilazole; nipyraclofen+dimethenamid or (S)-dimethenamid+glufosinate+furilazole; nipyracloten+acetochlor+glufosinate+furilazole; nipyraclofen+alachlor+glufosinate+furilazole; benzfendizone+(S)-metolachlor+glufosinate+furilazole; benzfendizone+metolachlor+glufosinate+furilazole; benzfendizone+dimethenamid or (S)-dimethenamid+glufosinate+furilazole; benzfendizone+acetochlor+glufosinate+furilazole; benzfendizone+alachlor+glufosinate+furilazole; thidiazimin+(S)-metolachlor+glufosinate+furilazole; thidiazimin+metolachlor+glufosinate+furilazole; thidiazimin+dimethenamid or (S)-dimethenamid+glufosinate+furilazole; thidiazimin+acetochlor+glufosinate+furilazole; and thidiazimin+alachlor+glufosinate+furilazole.

Acifluorfen+(S)-metolachlor+sulfosate+benoxacor; acifluorfen+metolachlor+sulfosate +benoxacor; acifluorfen+dimethenamid or (S)-dimethenamid+sulfosate+benoxacor; acifluorfen+acetochlor+sulfosate+benoxacor; acifluorfen+alachlor+sulfosate+benoxacor; aclonifen+(S)-metolachlor+sulfosate+benoxacor; aclonifen+metolachlor+sulfosate+benoxacor; aclonifen+dimethenamid or (S)-dimethenamid+sulfosate+benoxacor, aclonifen+acetochlor+sulfosate+benoxacor; aclonifen+alachlor+sulfosate +benoxacor; bifenox+(S)-metolachlor+sulfosate+benoxacor; bifenox+metolachlor+sulfosate+benoxacor; bifenox+dimethenamid or (S)-dimethenamid+sulfosate+benoxacor; bifenox+acetochlor+sulfosate+benoxacor; bifenox+alachlor+sulfosate+benoxacor; chlomitrofen+(S)-metolachlor+sulfosate+benoxacor; chlomitrofen+metolachlor+sulfosate+benoxacor; chlomitrofen+dimethenamid or (S)-dimethenamid+sulfosate+benoxacor; chlomitrofen+acetochlor+sulfosate+benoxacor; chlomitrofen+alachlor+sulfosate+benoxacor; ethoxyfen+(S)-metolachlor+sulfosate+benoxacor; ethoxyfen+metolachlor+sulfosate+benoxacor; ethoxyfen+dimethenamid or (S)-dimethenamid+sulfosate+benoxacor; ethoxyfen+acetochlor+sulfosate+benoxacor; ethoxyfen+alachlor+sulfosate+benoxacor; fluoroglycofen+(S)-metolachlor+sulfosate +benoxacor; fluoroglycofen+metolachlor+sulfosate+benoxacor; fluoroglycofen+dimethenamid or (S)-dimethenamid+sulfosate+benoxacor; fluoroglycofen+acetochlor+sulfosate+benoxacor; fluoroglycofen+alachlor+sulfosate+benoxacor; fomesafen+(S)-metolachlor+sulfosate+benoxacor; fomesafen+metolachlor+sulfosate+benoxacor; fomesafen+dimethenamid or (S)-dimethenamid+sulfosate+benoxacor; fomesafen+acetochlor+sulfosate+benoxacor; fomesafen+alachlor+sulfosate+benoxacor; lactofen +(S)-metolachlor+sulfosate+benoxacor; lactofen+metolachlor+sulfosate+benoxacor; lactofen+dimethenamid or (S)-dimethenamid+sulfosate+benoxacor; lactofen+acetochlor+sulfosate+benoxacor; lactofen+alachlor+sulfosate+benoxacor; oxyfluorfen+(S)-metolachlor+sulfosate+benoxacor; oxyfluorfen+metolachlor+sulfosate+benoxacor; oxyfluorfen+dimethenamid or (S)-dimethenamid+sulfosate+benoxacor; oxyfluorfen+acetochlor+sulfosate+benoxacor; oxyfluorfen+alachlor+sulfosate+benoxacor; azafenidin+(S)-metolachlor+sulfosate+benoxacor; azafenidin+metolachlor+sulfosate+benoxacor; azafenidin+dimethenamid or (S)-dimethenamid+sulfosate+benoxacor; azafenidin+acetochlor+sulfosate+benoxacor; azafenidin+alachlor+sulfosate+benoxacor; carfentrazone-ethyl+(S)-metolachlor+sulfosate+benoxacor; carfentrazone-ethyl+metolachlor+sulfosate+benoxacor; carfentrazone-ethyl +dimethenamid or (S)-dimethenamid+sulfosate+benoxacor; carfentrazone-ethyl+acetochlor+sulfosate+benoxacor; carfentrazone-ethyl+alachlor+sulfosate+benoxacor; compound of the formula A+(S)-metolachlor+sulfosate+benoxacor; compound of the formula A+metolachlor+sulfosate+benoxacor; compound of the formula A+dimethenamid or (S)-dimethenamid+sulfosate+benoxacor; compound of the formula A+acetochlor+sulfosate+benoxacor; compound of the formula A+alachlor+sulfosate+benoxacor; cinidon-ethyl+(S)-metolachlor+sulfosate+benoxacor; cinidon-ethyl+metolachlor+sulfosate+benoxacor; cinidon-ethyl+dimethenamid or (S)-dimethenamid+sulfosate+benoxacor; cinidon-ethyl+acetochlor+sulfosate+benoxacor; cinidon-ethyl+alachlor+sulfosate+benoxacor; flumiclorac-pentyl+(S)-metolachlor+sulfosate+benoxacor; flumiclorac-pentyl+metolachlor+sulfosate+benoxacor; flumiclorac-pentyl+dimethenamid or (S)-dimethenamid+sulfosate+benoxacor; flumiclorac-pentyl+acetochlor +sulfosate+benoxacor; flumiclorac-pentyl+alachlor+sulfosate+benoxacor; flumioxazin +(S)-metolachlor+sulfosate+benoxacor; flumioxazin+metolachlor+sulfosate+benoxacor; flumioxazin+dimethenamid or (S)-dimethenamid+sulfosate+benoxacor; flumioxazin+acetochlor+sulfosate+benoxacor; flumioxazin+alachlor+sulfosate+benoxacor; fluthiacet-methyl+(S)-metolachlor+sulfosate+benoxacor; fluthiacet-methyl+metolachlor+sulfosate+benoxacor; fluthiacet-methyl+dimethenamid or (S)-dimethenamid+sulfosate+benoxacor; fluthiacet-methyl+acetochlor+sulfosate+benoxacor; fluthiacet-methyl+alachlor+sulfosate+benoxacor; oxadiargyl+(S)-metolachlor+sulfosate+benoxacor; oxadiargyl+metolachlor+sulfosate+benoxacor; oxadiargyl+dimethenamid or (S)-dimethenamid+sulfosate+benoxacor; oxadiargyl+acetochlor+sulfosate+benoxacor; oxadiargyl+alachlor+sulfosate+benoxacor; oxadiazon+(S)-metolachlor+sulfosate+benoxacor; oxadiazon+metolachlor+sulfosate +benoxacor; oxadiazon+dimethenamid or (S)-dimethenamid+sulfosate+benoxacor; oxadiazon+acetochlor+sulfosate+benoxacor; oxadiazon+alachlor+sulfosate+benoxacor; pentoxazone+(S)-metolachlor+sulfosate+benoxacor; pentoxazone+metolachlor+sulfosate+benoxacor; pentoxazone+dimethenamid or (S)-dimethenamid+sulfosate+benoxacor; pentoxazone+acetochlor+sulfosate+benoxacor; pentoxazone+alachlor+sulfosate+benoxacor; sulfentrazone+(S)-metolachlor+sulfosate+benoxacor; sulfentrazone+metolachlor+sulfosate+benoxacor; sulfentrazone+dimethenamid or (S)-dimethenamid+sulfosate+benoxacor; sulfentrazone+acetochlor+sulfosate+benoxacor; sulfentrazone+alachlor+sulfosate+benoxacor; fluazolate+(S)-metolachlor +sulfosate+benoxacor; fluazolate+metolachlor+sulfosate+benoxacor; fluazolate+dimethenamid or (S)-dimethenamid+sulfosate+benoxacor; fluazolate+acetochlor+sulfosate+benoxacor; fluazolate+alachlor+sulfosate+benoxacor; pyraflufen-ethyl+(S)-metolachlor+sulfosate+benoxacor; pyraflufen-ethyl+metolachlor+sulfosate+benoxacor; pyraflufen-ethyl+dimethenamid or (S)-dimethenamid+sulfosate+benoxacor; pyraflufen-ethyl+acetochlor+sulfosate+benoxacor; pyraflufen-ethyl+alachlor+sulfosate+benoxacor; flumipropyn+(S)-metolachlor+sulfosate+benoxacor; flumipropyn +metolachlor+sulfosate+benoxacor; flumipropyn+dimethenamid or (S)-dimethenamid+sulfosate+benoxacor; flumipropyn+acetochlor+sulfosate+benoxacor; flumipropyn+alachlor+sulfosate+benoxacor; flupropacil+(S)-metolachlor+sulfosate+benoxacor; flupropacil+metolachlor+sulfosate+benoxacor; flupropacil+dimethenamid or (S)-dimethenamid+sulfosate+benoxacor; flupropacil+acetochlor+sulfosate+benoxacor; flupropacil+alachlor+sulfosate+benoxacor; nipyraclofen+(S)-metolachlor+sulfosate+benoxacor; nipyraclofen+metolachlor+sulfosate+benoxacor; nipyraclofen+dimethenamid or (S)-dimethenamid+sulfosate+benoxacor; nipyraclofen+acetochlor+sulfosate+benoxacor; nipyraclofen+alachlor+sulfosate+benoxacor; benzfendizone+(S)-metolachlor+sulfosate+benoxacor; benzfendizone+metolachlor+sulfosate+benoxacor; benzfendizone+dimethenamid or (S)-dimethenamid+sulfosate+benoxacor; benzfendizone+acetochlor+sulfosate+benoxacor; benzfendizone+alachlor+sulfosate +benoxacor; thidiazimin+(S)-metolachlor+sulfosate+benoxacor; thidiazimin+metolachlor+sulfosate+benoxacor; thidiazimin+dimethenamid or (S)-dimethenamid+sulfosate+benoxacor; thidiazimin+acetochlor+sulfosate+benoxacor; and thidiazimin+alachlor+sulfosate+benoxacor.

Acifluorfen+(S)-metolachlor+sulfosate+MON 4660; acifluorfen+metolachlor+sulfosate +MON 4660; acifluorfen+dimethenamid or (S)-dimethenamid+sulfosate+MON 4660; acifluorfen+acetochlor+sulfosate+MON 4660; acifluorfen+alachlor+sulfosate+MON 4660; aclonifen+(S)-metolachlor+sulfosate+MON 4660; aclonifen+metolachlor+sulfosate+MON 4660; aclonifen+dimethenamid or (S)-dimethenamid+sulfosate+MON 4660; aclonifen+acetochlor+sulfosate+MON 4660; aclonifen+alachlor+sulfosate+MON 4660; bifenox+(S)-metolachlor+sulfosate+MON 4660; bifenox+metolachlor+sulfosate+MON 4660; bifenox+dimethenamid or (S)-dimethenamid+sulfosate+MON 4660; bifenox+acetochlor+sulfosate+MON 4660; bifenox+alachlor+sulfosate+MON 4660; chlomitrofen+(S)-metolachlor+sulfosate+MON 4660; chlomitrofen+metolachlor+sulfosate+MON 4660; chlomitrofen+dimethenamid or (S)-dimethenamid+sulfosate+MON 4660; chlomitrofen+acetochlor+sulfosate+MON 4660; chlomitrofen+alachlor+sulfosate+MON 4660; ethoxyfen+(S)-metolachlor+sulfosate+MON 4660; ethoxyfen+metolachlor+sulfosate+MON 4660; ethoxyfen+dimethenamid or (S)-dimethenamid+sulfosate+MON 4660; ethoxyfen+acetochlor+sulfosate+MON 4660; ethoxyfen+alachlor+sulfosate+MON 4660; fluoroglycofen+(S)-metolachlor+sulfosate+MON 4660; fluoroglycofen+metolachlor+sulfosate+MON 4660; fluoroglycofen+dimethenamid or (S)-dimethenamid+sulfosate+MON 4660; fluoroglycofen+acetochlor+sulfosate+MON 4660; fluoroglycofen+alachlor+sulfosate+MON 4660; fomesafen+(S)-metolachlor +sulfosate+MON 4660; fomesafen+metolachlor+sulfosate+MON 4660; fomesafen+dimethenamid or (S)-dimethenamid+sulfosate+MON 4660; fomesafen+acetochlor+sulfosate+MON 4660; fomesafen+alachlor+sulfosate+MON 4660; lactofen+(S)-metolachlor+sulfosate+MON 4660; lactofen+metolachlor+sulfosate+MON 4660; lactofen+dimethenamid or (S)-dimethenamid+sulfosate+MON 4660; lactofen+acetochlor+sulfosate+MON 4660; lactofen+alachlor+sulfosate+MON 4660; oxyfluorfen+(S)-metolachlor+sulfosate+MON 4660; oxyfluorfen+metolachlor+sulfosate+MON 4660; oxyfluorfen+dimethenamid or (S)-dimethenamid+sulfosate+MON 4660; oxyfluorfen+acetochlor+sulfosate+MON 4660; oxyfluorfen+alachlor+sulfosate+MON 4660; azafenidin+(S)-metolachlor+sulfosate+MON 4660; azafenidin+metolachlor+sulfosate+MON 4660; azafenidin+dimethenamid or (S)-dimethenamid+sulfosate+MON 4660; azafenidin+acetochlor+sulfosate+MON 4660; azafenidin+alachlor+sulfosate+MON 4660; carfentrazone-ethyl+(S)-metolachlor+sulfosate+MON 4660; carfentrazone-ethyl+metolachlor+sulfosate+MON 4660; carfentrazone-ethyl+dimethenamid or (S)-dimethenamid+sulfosate+MON 4660; carfentrazone-ethyl+acetochlor+sulfosate+MON 4660; carfentrazone-ethyl+alachlor+sulfosate+MON 4660; compound of the formula A+(S)-metolachlor+sulfosate+MON 4660; compound of the formula A+metolachlor+sulfosate+MON 4660; compound of the formula A+dimethenamid or (S)-dimethenamid+sulfosate+MON 4660; compound of the formula A+acetochlor+sulfosate+MON 4660; compound of the formula A+alachlor+sulfosate+MON 4660; cinidon-ethyl+(S)-metolachlor+sulfosate+MON 4660; cinidon-ethyl+metolachlor+sulfosate+MON 4660; cinidon-ethyl+dimethenamid or (S)-dimethenamid+sulfosate+MON 4660; cinidon-ethyl+acetochlor+sulfosate+MON 4660; cinidon-ethyl+alachlor+sulfosate+MON 4660; flumiclorac-pentyl+(S)-metolachlor+sulfosate+MON 4660; flumiclorac-pentyl+metolachlor+sulfosate+MON 4660; flumiclorac-pentyl+dimethenamid or (S)-dimethenamid+sulfosate+MON 4660; flumiclorac-pentyl+acetochlor+sulfosate+MON 4660; flumiclorac-pentyl+alachlor+sulfosate+MON 4660; flumioxazin+(S)-metolachlor+sulfosate+MON 4660; flumioxazin+metolachlor+sulfosate+MON 4660; flumioxazin+dimethenamid or (S)-dimethenamid+sulfosate+MON 4660; flumioxazin+acetochlor+sulfosate+MON 4660; flumioxazin+alachlor+sulfosate+MON 4660; fluthiacet-methyl+(S)-metolachlor+sulfosate+MON 4660; fluthiacet-methyl+metolachlor+sulfosate+MON 4660; fluthiacet-methyl+dimethenamid or (S)-dimethenamid+sulfosate+MON 4660; fluthiacet-methyl+acetochlor+sulfosate+MON 4660; fluthiacet-methyl+alachlor+sulfosate+MON 4660; oxadiargyl+(S)-metolachlor+sulfosate+MON 4660; oxadiargyl+metolachlor+sulfosate+MON 4660; oxadiargyl+dimethenamid or (S)-dimethenamid+sulfosate+MON 4660; oxadiargyl+acetochlor+sulfosate+MON 4660; oxadiargyl+alachlor+sulfosate+MON 4660; oxadiazon+(S)-metolachlor+sulfosate+MON 4660; oxadiazon+metolachlor+sulfosate +MON 4660; oxadiazon+dimethenamid or (S)-dimethenamid+sulfosate+MON 4660; oxadiazon+acetochlor+sulfosate+MON 4660; oxadiazon+alachlor+sulfosate+MON 4660; pentoxazone+(S)-metolachlor+sulfosate+MON 4660; pentoxazone+metolachlor+sulfosate+MON 4660; pentoxazone+dimethenamid or (S)-dimethenamid+sulfosate+MON 4660; pentoxazone+acetochlor+sulfosate+MON 4660; pentoxazone +alachlor+sulfosate+MON 4660; sulfentrazone+(S)-metolachlor+sulfosate+MON 4660; sulfentrazone+metolachlor+sulfosate+MON 4660; sulfentrazone+dimethenamid or (S)-dimethenamid+sulfosate+MON 4660; sulfentrazone+acetochlor+sulfosate+MON 4660; sulfentrazone+alachlor+sulfosate+MON 4660; fluazolate+(S)-metolachlor +sulfosate+MON 4660; fluazolate+metolachlor+sulfosate+MON 4660; fluazolate+dimethenamid or (S)-dimethenamid+sulfosate+MON 4660; fluazolate+acetochlor+sulfosate+MON 4660; fluazolate+alachlor+sulfosate+MON 4660; pyraflufen-ethyl+(S)-metolachlor+sulfosate+MON 4660; pyraflufen-ethyl+metolachlor+sulfosate+MON 4660; pyraflufen-ethyl+dimethenamid or (S)-dimethenamid+sulfosate+MON 4660; pyraflufen-ethyl+acetochlor+sulfosate+MON 4660; pyraflufen-ethyl+alachlor+sulfosate+MON 4660; flumipropyn+(S)-metolachlor+sulfosate+MON 4660; flumipropyn +metolachlor+sulfosate+MON 4660; flumipropyn+dimethenamid or (S)-dimethenamid+sulfosate+MON 4660; flumipropyn+acetochlor+sulfosate+MON 4660; flumipropyn+alachlor+sulfosate+MON 4660; flupropacil+(S)-metolachlor+sulfosate+MON 4660; flupropacil+metolachlor+sulfosate+MON 4660; flupropacil+dimethenamid or (S)-dimethenamid+sulfosate+MON 4660; flupropacil+acetochlor+sulfosate+MON 4660; flupropacil+alachlor+sulfosate+MON 4660; nipyraclofen+(S)-metolachlor+sulfosate+MON 4660; nipyraclofen+metolachlor+sulfosate+MON 4660; nipyraclofen+dimethenamid or (S)-dimethenamid+sulfosate+MON 4660; nipyraclofen+acetochlor+sulfosate+MON 4660; nipyraclofen+alachlor+sulfosate+MON 4660; benzfendizone+(S)-metolachlor+sulfosate+MON 4660; benzfendizone+metolachlor+sulfosate+MON 4660; benzfendizone+dimethenamid or (S)-dimethenamid+sulfosate+MON 4660; benzfendizone+acetochlor+sulfosate+MON 4660; benzfendizone+alachlor+sulfosate +MON 4660; thidiazimin+(S)-metolachlor+sulfosate+MON 4660; thidiazimin+metolachlor+sulfosate+MON 4660; thidiazimin+dimethenamid or (S)-dimethenamid+sulfosate+MON 4660; thidiazimin+acetochlor+sulfosate+MON 4660; and thidiazimin+alachlor+sulfosate+MON 4660.

Acifluorfen+(S)-metolachlor+sulfosate+flurazole; acifluorfen+metolachlor+sulfosate+flurazole; acifluorfen+dimethenamid or (S)-dimethenamid+sulfosate+flurazole; acifluorfen+acetochlor+sulfosate+flurazole; acifluorfen+alachlor+sulfosate+flurazole; aclonifen+(S)-metolachlor+sulfosate+flurazole; aclonifen+metolachlor+sulfosate+flurazole; aclonifen+dimethenamid or (S)-dimethenamid+sulfosate+flurazole; aclonifen+acetochlor+sulfosate+flurazole; aclonifen+alachlor+sulfosate+flurazole; bifenox+(S)-metolachlor+sulfosate+flurazole; bifenox+metolachlor+sulfosate+flurazole; bifenox+dimethenamid or (S)-dimethenamid+sulfosate+flurazole; bifenox+acetochlor+sulfosate+flurazole; bifenox+alachlor+sulfosate+flurazole; chlomitrofen+(S)-metolachlor+sulfosate+flurazole; chlomitrofen+metolachlor+sulfosate+flurazole; chlomitrofen+dimethenamid or (S)-dimethenamid+sulfosate+flurazole; chlomitrofen+acetochlor+sulfosate+flurazole; chlomitrofen+alachlor+sulfosate+flurazole; ethoxyfen +(S)-metolachlor+sulfosate+flurazole; ethoxyfen+metolachlor+sulfosate+flurazole; ethoxyfen+dimethenamid or (S)-dimethenamid+sulfosate+flurazole; ethoxyfen+acetochlor+sulfosate+flurazole; ethoxyfen+alachlor+sulfosate+flurazole; fluoroglycofen+(S)-metolachlor+sulfosate+flurazole; fluoroglycofen+metolachlor+sulfosate+flurazole; fluoroglycofen+dimethenamid or (S)-dimethenamid+sulfosate+flurazole; fluoroglycofen+acetochlor+sulfosate+flurazole; fluoroglycofen+alachlor+sulfosate+flurazole; fomesafen+(S)-metolachlor+sulfosate+flurazole; fomesafen+metolachlor+sulfosate+flurazole; fomesafen+dimethenamid or (S)-dimethenamid+sulfosate+flurazole; fomesafen+acetochlor+sulfosate+flurazole; fomesafen+alachlor +sulfosate+flurazole; lactofen+(S)-metolachlor+sulfosate+flurazole; lactofen+metolachlor+sulfosate+flurazole; lactofen+dimethenamid or (S)-dimethenamid+sulfosate+flurazole; lactofen+acetochlor+sulfosate+flurazole; lactofen+alachlor+sulfosate+flurazole; oxyfluorfen+(S)-metolachlor+sulfosate+flurazole; oxyfluorfen+metolachlor+sulfosate+flurazole; oxyfluorfen+dimethenamid or (S)-dimethenamid+sulfosate+flurazole; oxyfluorfen+acetochlor+sulfosate+flurazole; oxyfluorfen+alachlor +sulfosate+flurazole; azafenidin+(S)-metolachlor+sulfosate+flurazole; azafenidin+metolachlor+sulfosate+flurazole; azafenidin+dimethenamid or (S)-dimethenamid+sulfosate+flurazole; azafenidin+acetochlor+sulfosate+flurazole; azafenidin+alachlor+sulfosate+flurazole; carfentrazone-ethyl+(S)-metolachlor+sulfosate+flurazole; carfentrazone-ethyl+metolachlor+sulfosate+flurazole; carfentrazone-ethyl+dimethenamid or (S)-dimethenamid+sulfosate+flurazole; carfentrazone-ethyl+acetochlor +sulfosate+flurazole; carfentrazone-ethyl+alachlor+sulfosate+flurazole; compound of the formula A+(S)-metolachlor+sulfosate+flurazole; compound of the formula A+metolachlor+sulfosate+flurazole; compound of the formula A+dimethenamid or (S)-dimethenamid+sulfosate+flurazole; compound of the formula A+acetochlor+sulfosate +flurazole; compound of the formula A+alachlor+sulfosate+flurazole; cinidon-ethyl+(S)-metolachlor+sulfosate+flurazole; cinidon-ethyl+metolachlor+sulfosate+flurazole; cinidon-ethyl+dimethenamid or (S)-dimethenamid+sulfosate+flurazole; cinidon-ethyl+acetochlor+sulfosate+flurazole; cinidon-ethyl+alachlor+sulfosate+flurazole; flumiclorac-pentyl+(S)-metolachlor+sulfosate+flurazole; flumiclorac-pentyl+metolachlor +sulfosate+flurazole; flumiclorac-pentyl+dimethenamid or (S)-dimethenamid+sulfosate +flurazole; flumiclorac-pentyl+acetochlor+sulfosate+flurazole; flumiclorac-pentyl+alachlor+sulfosate+flurazole; flumioxazin+(S)-metolachlor+sulfosate+flurazole; flumioxazin+metolachlor+sulfosate+flurazole; flumioxazin+dimethenamid or (S)-dimethenamid+sulfosate+flurazole; flumioxazin+acetochlor+sulfosate+flurazole; flumioxazin+alachlor+sulfosate+flurazole; fluthiacet-methyl+(S)-metolachlor+sulfosate +flurazole; fluthiacet-methyl+metolachlor+sulfosate+flurazole; fluthiacet-methyl+dimethenamid or (S)-dimethenamid+sulfosate+flurazole; fluthiacet-methyl+acetochlor+sulfosate+flurazole; fluthiacet-methyl+alachlor+sulfosate+flurazole; oxadiargyl+(S)-metolachlor+sulfosate+flurazole; oxadiargyl+metolachlor+sulfosate+flurazole; oxadiargyl+dimethenamid or (S)-dimethenamid+sulfosate+flurazole; oxadiargyl+acetochlor+sulfosate+flurazole; oxadiargyl+alachlor+sulfosate+flurazole; oxadiazon+(S)-metolachlor+sulfosate+flurazole; oxadiazon+metolachlor+sulfosate+flurazole; oxadiazon+dimethenamid or (S)-dimethenamid+sulfosate+flurazole; oxadiazon+acetochlor+sulfosate+flurazole; oxadiazon+alachlor+sulfosate+flurazole; pentoxazone+(S)-metolachlor+sulfosate+flurazole; pentoxazone+metolachlor+sulfosate+flurazole; pentoxazone+dimethenamid or (S)-dimethenamid+sulfosate+flurazole; pentoxazone+acetochlor+sulfosate+flurazole; pentoxazone+alachlor+sulfosate+flurazole; sulfentrazone+(S)-metolachlor+sulfosate+flurazole; sulfentrazone +metolachlor+sulfosate+flurazole; sulfentrazone+dimethenamid or (S)-dimethenamid+sulfosate+flurazole; sulfentrazone+acetochlor+sulfosate+flurazole; sulfentrazone+alachlor+sulfosate+flurazole; fluazolate+(S)-metolachlor+sulfosate+flurazole; fluazolate+metolachlor+sulfosate+flurazole; fluazolate+dimethenamid or (S)-dimethenamid+sulfosate+flurazole; fluazolate+acetochlor+sulfosate+flurazole; fluazolate+alachlor+sulfosate+flurazole; pyraflufen-ethyl+(S)-metolachlor+sulfosate +flurazole; pyraflufen-ethyl+metolachlor+sulfosate+flurazole; pyraflufen-ethyl+dimethenamid or (S)-dimethenamid+sulfosate+flurazole; pyraflufen-ethyl+acetochlor+sulfosate+flurazole; pyraflufen-ethyl+alachlor+sulfosate+flurazole; flumipropyn+(S)-metolachlor+sulfosate+flurazole; flumipropyn+metolachlor+sulfosate+flurazole; flumipropyn+dimethenamid or (S)-dimethenamid+sulfosate+flurazole; flumipropyn+acetochlor+sulfosate+flurazole; flumipropyn+alachlor+sulfosate+flurazole; flupropacil +(S)-metolachlor+sulfosate+flurazole; flupropacil+metolachlor+sulfosate+flurazole; flupropacil+dimethenamid or (S)-dimethenamid+sulfosate+flurazole; flupropacil+acetochlor+sulfosate+flurazole; flupropacil+alachlor+sulfosate+flurazole; nipyraclofen +(S)-metolachlor+sulfosate+flurazole; nipyraclofen+metolachlor+sulfosate+flurazole; nipyraclofen+dimethenamid or (S)-dimethenamid+sulfosate+flurazole; nipyraclofen+acetochlor+sulfosate+flurazole; nipyraclofen+alachlor+sulfosate+flurazole; benzfendizone+(S)-metolachlor+sulfosate+flurazole; benzfendizone+metolachlor+sulfosate+flurazole; benzfendizone+dimethenamid or (S)-dimethenamid+sulfosate+flurazole; benzfendizone+acetochlor+sulfosate+flurazole; benzfendizone+alachlor+sulfosate+flurazole; thidiazimin+(S)-metolachlor+sulfosate+flurazole; thidiazimin+metolachlor+sulfosate+flurazole; thidiazimin+dimethenamid or (S)-dimethenamid+sulfosate+flurazole; thidiazimin+acetochlor+sulfosate+flurazole; and thidiazimin+alachlor+sulfosate+flurazole.

Acifluorfen+(S)-metolachlor+sulfosate+dichlormid; acifluorfen+metolachlor+sulfosate +dichlormid; acifluorfen+dimethenamid or (S)-dimethenamid+sulfosate+dichlormid; acifluorfen+acetochlor+sulfosate+dichlormid; acifluorfen+alachlor+sulfosate+dichlormid; aclonifen+(S)-metolachlor+sulfosate+dichlormid; aclonifen+metolachlor+sulfosate+dichlormid; aclonifen+dimethenamid or (S)-dimethenamid+sulfosate+dichlormid; aclonifen+acetochlor+sulfosate+dichlormid; aclonifen+alachlor+sulfosate +dichlormid; bifenox+(S)-metolachlor+sulfosate+dichlormid; bifenox+metolachlor+sulfosate+dichlormid; bifenox+dimethenamid or (S)-dimethenamid+sulfosate+dichlormid; bifenox+acetochlor+sulfosate+dichlormid; bifenox+alachlor+sulfosate+dichlormid; chlomitrofen+(S)-metolachlor+sulfosate+dichlormid; chlomitrofen+metolachlor+sulfosate+dichlormid; chlomitrofen+dimethenamid or (S)-dimethenamid+sulfosate+dichlormid; chlomitrofen+acetochlor+sulfosate+dichlormid; chlomitrofen+alachlor+sulfosate+dichlormid; ethoxyfen+(S)-metolachlor+sulfosate+dichlormid; ethoxyfen+metolachlor+sulfosate+dichlormid; ethoxyfen+dimethenamid or (S)-dimethenamid+sulfosate+dichlormid; ethoxyfen+acetochlor+sulfosate+dichlormid; ethoxyfen+alachlor+sulfosate+dichlormid; fluoroglycofen+(S)-metolachlor+sulfosate+dichlormid; fluoroglycofen+metolachlor+sulfosate+dichlormid; fluoroglycofen+dimethenamid or (S)-dimethenamid+sulfosate+dichlormid; fluoroglycofen+acetochlor+sulfosate+dichlormid; fluoroglycofen+alachlor+sulfosate+dichlormid; fomesafen+(S)-metolachlor+sulfosate+dichlormid; fomesafen+metolachlor+sulfosate+dichlormid; fomesafen+dimethenamid or (S)-dimethenamid+sulfosate+dichlormid; fomesafen+acetochlor+sulfosate+dichlormid; fomesafen+alachlor+sulfosate+dichlormid; lactofen +(S)-metolachlor+sulfosate+dichlormid; lactofen+metolachlor+sulfosate+dichlormid; lactofen+dimethenamid or (S)-dimethenamid+sulfosate+dichlormid; lactofen+acetochlor+sulfosate+dichlormid; lactofen+alachlor+sulfosate+dichlormid; oxyfluorfen +(S)-metolachlor+sulfosate+dichlormid; oxyfluorfen+metolachlor+sulfosate+dichlormid; oxyfluorien+dimethenamid or (S)-dimethenamid+sulfosate+dichlormid; oxyfluorfen+acetochlor+sulfosate+dichlormid; oxyfluorfen+alachlor+sulfosate+dichlormid; azafenidin+(S)-metolachlor+sulfosate+dichlormid; azafenidin+metolachlor +sulfosate+dichlormid; azafenidin+dimethenamid or (S)-dimethenamid+sulfosate+dichlormid; azafenidin+acetochlor+sulfosate+dichlormid; azafenidin+alachlor+sulfosate+dichlormid; carfentrazone-ethyl+(S)-metolachlor+sulfosate+dichlormid; carfentrazone-ethyl+metolachlor+sulfosate+dichlormid; carfentrazone-ethyl+dimethenamid or (S)-dimethenamid+sulfosate+dichlormid; carfentrazone-ethyl+acetochlor+sulfosate+dichlormid; carfentrazone-ethyl+alachlor+sulfosate+dichlormid; compound of the formula A+(S)-metolachlor+sulfosate+dichlormid; compound of the formula A+metolachlor+sulfosate+dichlormid; compound of the formula A+dimethenamid or (S)-dimethenamid+sulfosate+dichlormid; compound of the formula A+acetochlor+sulfosate+dichlormid; compound of the formula A+alachlor+sulfosate+dichlormid; cinidon-ethyl+(S)-metolachlor+sulfosate+dichlormid; cinidon-ethyl+metolachlor+sulfosate+dichlormid; cinidon-ethyl+dimethenamid or (S)-dimethenamid+sulfosate+dichlormid; cinidon-ethyl+acetochlor+sulfosate+dichlormid; cinidon-ethyl+alachlor+sulfosate+dichlormid; flumiclorac-pentyl+(S)-metolachlor+sulfosate+dichlormid; flumiclorac-pentyl+metolachlor+sulfosate+dichlormid; flumiclorac-pentyl+dimethenamid or (S)-dimethenamid+sulfosate+dichlormid; flumiclorac-pentyl+acetochlor +sulfosate+dichlormid; flumiclorac-pentyl+alachlor+sulfosate+dichlormid; flumioxazin +(S)-metolachlor+sulfosate+dichlormid; flumioxazin+metolachlor+sulfosate+dichlormid; flumioxazin+dimethenamid or (S)-dimethenamid+sulfosate+dichlormid; flumioxazin+acetochlor+sulfosate+dichlormid; flumioxazin+alachlor+sulfosate+dichlormid; fluthiacet-methyl+(S)-metolachlor+sulfosate+dichlormid; fluthiacet-methyl+metolachlor+sulfosate+dichlormid; fluthiacet-methyl+dimethenamid or (S)-dimethenamid +sulfosate+dichlormid; fluthiacet-methyl+acetochlor+sulfosate+dichlormid; fluthiacet-methyl+alachlor+sulfosate+dichlormid; oxadiargyl+(S)-metolachlor+sulfosate+dichlormid; oxadiargyl+metolachlor+sulfosate+dichlormid; oxadiargyl+dimethenamid or (S)-dimethenamid+sulfosate+dichlormid; oxadiargyl+acetochlor+sulfosate+dichlormid; oxadiargyl+alachlor+sulfosate+dichlormid; oxadiazon+(S)-metolachlor+sulfosate+dichlormid; oxadiazon+metolachlor+sulfosate+dichlormid; oxadiazon+dimethenamid or (S)-dimethenamid+sulfosate+dichlormid; oxadiazon+acetochlor+sulfosate+dichlormid; oxadiazon+alachlor+sulfosate+dichlormid; pentoxazone+(S)-metolachlor+sulfosate+dichlormid; pentoxazone+metolachlor+sulfosate+dichlormid; pentoxazone +dimethenamid or (S)-dimethenamid+sulfosate+dichlormid; pentoxazone+acetochlor+sulfosate+dichlormid; pentoxazone+alachlor+sulfosate+dichlormid; sulfentrazone+(S)-metolachlor+sulfosate+dichlormid; sulfentrazone+metolachlor+sulfosate+dichlormid; sulfentrazone+dimethenamid or (S)-dimethenamid+sulfosate+dichlormid; sulfentrazone+acetochlor+sulfosate+dichlormid; sulfentrazone+alachlor+sulfosate+dichlormid; fluazolate+(S)-metolachlor+sulfosate+dichlormid; fluazolate+metolachlor +sulfosate+dichlormid; fluazolate+dimethenamid or (S)-dimethenamid+sulfosate+dichlormid; fluazolate+acetochlor+sulfosate+dichlormid; fluazolate+alachlor+sulfosate+dichlormid; pyraflufen-ethyl+(S)-metolachlor+sulfosate+dichlormid; pyraflufen-ethyl+metolachlor+sulfosate+dichlormid; pyraflufen-ethyl+dimethenamid or (S)-dimethenamid+sulfosate+dichlormid; pyraflufen-ethyl+acetochlor+sulfosate+dichlormid; pyraflufen-ethyl+alachlor+sulfosate+dichlormid; flumipropyn+(S)-metolachlor+sulfosate+dichlormid; flumipropyn+metolachlor+sulfosate+dichlormid; flumipropyn+dimethenamid or (S)-dimethenamid+sulfosate+dichlormid; flumipropyn+acetochlor+sulfosate+dichlormid; flumipropyn+alachlor+sulfosate+dichlormid; flupropacil+(S)-metolachlor+sulfosate+dichlormid; flupropacil+metolachlor+sulfosate +dichlormid; flupropacil+dimethenamid or (S)-dimethenamid+sulfosate+dichlormid; flupropacil+acetochlor+sulfosate+dichlormid; flupropacil+alachlor+sulfosate+dichlormid; nipyraclofen+(S)-metolachlor+sulfosate+dichlormid; nipyraclofen+metolachlor+sulfosate+dichlormid; nipyraclofen+dimethenamid or (S)-dimethenamid+sulfosate+dichlormid; nipyraclofen+acetochlor+sulfosate+dichlormid; nipyraclofen+alachlor+sulfosate+dichlormid; benzfendizone+(S)-metolachlor+sulfosate+dichlormid; benzfendizone+metolachlor+sulfosate+dichlormid; benzfendizone+dimethenamid or (S)-dimethenamid+sulfosate+dichlormid; benzfendizone+acetochlor+sulfosate+dichlormid; benzfendizone+alachlor+sulfosate+dichlormid; thidiazimin+(S)-metolachlor +sulfosate+dichlormid; thidiazimin+metolachlor+sulfosate+dichlormid; thidiazimin+dimethenamid or (S)-dimethenamid+sulfosate+dichlormid; thidiazimin+acetochlor+sulfosate+dichlormid; and thidiazimin+alachlor+sulfosate+dichlormid.

Acifluorfen+(S)-metolachlor+sulfosate+furilazole; acifluorfen+metolachlor+sulfosate+furilazole; acifluorfen+dimethenamid or (S)-dimethenamid+sulfosate+furilazole; acifluorfen+acetochlor+sulfosate+furilazole; acifluorfen+alachlor+sulfosate+furilazole; aclonifen+(S)-metolachlor+sulfosate+furilazole; aclonifen+metolachlor+sulfosate+furilazole; aclonifen+dimethenamid or (S)-dimethenamid+sulfosate+furilazole; aclonifen+acetochlor+sulfosate+furilazole; aclonifen+alachlor+sulfosate+furilazole; bifenox+(S)-metolachlor+sulfosate+furilazole; bifenox+metolachlor+sulfosate+furilazole; bifenox+dimethenamid or (S)-dimethenamid+sulfosate+furilazole; bifenox+acetochlor+sulfosate+furilazole; bifenox+alachlor+sulfosate+furilazole; chlomitrofen+(S)-metolachlor+sulfosate+furilazole; chlomitrofen+metolachlor+sulfosate+furilazole; chlomitrofen+dimethenamid or (S)-dimethenamid+sulfosate+furilazole; chlomitrofen+acetochlor+sulfosate+furilazole; chlomitrofen+alachlor+sulfosate+furilazole; ethoxyfen+(S)-metolachlor+sulfosate+furilazole; ethoxyfen+metolachlor+sulfosate+furilazole; ethoxyfen+dimethenamid or (S)-dimethenamid+sulfosate+furilazole; ethoxyfen+acetochlor+sulfosate+furilazole; ethoxyfen+alachlor+sulfosate+furilazole; fluoroglycofen+(S)-metolachlor+sulfosate+furilazole; fluoroglycofen+metolachlor+sulfosate+furilazole; fluoroglycofen+dimethenamid or (S)-dimethenamid+sulfosate+furilazole; fluoroglycofen+acetochlor+sulfosate+furilazole; fluoroglycofen+alachlor+sulfosate+furilazole; fomesafen+(S)-metolachlor+sulfosate+furilazole; fomesafen+metolachlor+sulfosate+furilazole; fomesafen+dimethenamid or (S)-dimethenamid+sulfosate+furilazole; fomesafen+acetochlor+sulfosate+furilazole; fomesafen+alachlor+sulfosate+furilazole; lactofen+(S)-metolachlor+sulfosate+furilazole; lactofen+metolachlor+sulfosate+furilazole; lactofen+dimethenamid or (S)-dimethenamid+sulfosate+furilazole; lactofen+acetochlor+sulfosate+furilazole; lactofen+alachlor+sulfosate+furilazole; oxyfluorfen+(S)-metolachlor+sulfosate+furilazole; oxyfluorfen+metolachlor+sulfosate+furilazole; oxyfluorfen+dimethenamid or (S)-dimethenamid+sulfosate+furilazole; oxyfluorfen+acetochlor+sulfosate+furilazole; oxyfluorfen+alachlor+sulfosate+furilazole; azafenidin+(S)-metolachlor+sulfosate+furilazole; azafenidin+metolachlor+sulfosate+furilazole; azafenidin+dimethenamid or (S)-dimethenamid+sulfosate+furilazole; azafenidin+acetochlor+sulfosate+furilazole; azafenidin+alachlor+sulfosate+furilazole; carfentrazone-ethyl+(S)-metolachlor+sulfosate+furilazole; carfentrazone-ethyl+metolachlor+sulfosate+furilazole; carfentrazone-ethyl+dimethenamid or (S)-dimethenamid+sulfosate+furilazole; carfentrazone-ethyl+acetochlor+sulfosate+furilazole; carfentrazone-ethyl+alachlor+sulfosate+furilazole; compound of the formula A+(S)-metolachlor+sulfosate+furilazole; compound of the formula A+metolachlor+sulfosate+furilazole; compound of the formula A+dimethenamid or (S)-dimethenamid+sulfosate+furilazole; compound of the formula A +acetochlor+sulfosate+furilazole; compound of the formula A+alachlor+sulfosate+furilazole; cinidon-ethyl+(S)-metolachlor+sulfosate+furilazole; cinidon-ethyl+metolachlor+sulfosate+furilazole; cinidon-ethyl+dimethenamid or (S)-dimethenamid+sulfosate+furilazole; cinidon-ethyl+acetochlor+sulfosate+furilazole; cinidon-ethyl+alachlor+sulfosate+furilazole; flumiclorac-pentyl+(S)-metolachlor+sulfosate+furilazole; flumiclorac-pentyl+metolachlor+sulfosate+furilazole; flumiclorac-pentyl+dimethenamid or (S)-dimethenamid+sulfosate+furilazole; flumiclorac-pentyl+acetochlor+sulfosate+furilazole; flumiclorac-pentyl+alachlor+sulfosate+furilazole; flumioxazin+(S)-metolachlor+sulfosate+furilazole; flumioxazin+metolachlor+sulfosate+furilazole; flumioxazin+dimethenamid or (S)-dimethenamid+sulfosate+furilazole; flumioxazin+acetochlor+sulfosate+furilazole; flumioxazin+alachlor+sulfosate+furilazole; fluthiacet-methyl+(S)-metolachlor+sulfosate+furilazole; fluthiacet-methyl+metolachlor+sulfosate +furilazole; fluthiacet-methyl+dimethenamid or (S)-dimethenamid+sulfosate+furilazole; fluthiacet-methyl+acetochlor+sulfosate+furilazole; fluthiacet-methyl+alachlor+sulfosate+furilazole; oxadiargyl+(S)-metolachlor+sulfosate+furilazole; oxadiargyl+metolachlor+sulfosate+furilazole; oxadiargyl+dimethenamid or (S)-dimethenamid+sulfosate+furilazole; oxadiargyl+acetochlor+sulfosate+furilazole; oxadiargyl+alachlor +sulfosate+furilazole; oxadiazon+(S)-metolachlor+sulfosate+furilazole; oxadiazon+metolachlor+sulfosate+furilazole; oxadiazon+dimethenamid or (S)-dimethenamid+sulfosate+furilazole; oxadiazon+acetochlor+sulfosate+furilazole; oxadiazon+alachlor +sulfosate+furilazole; pentoxazone+(S)-metolachlor+sulfosate+furilazole; pentoxazone+metolachlor+sulfosate+furilazole; pentoxazone+dimethenamid or (S)-dimethenamid+sulfosate+furilazole; pentoxazone+acetochlor+sulfosate+furilazole; pentoxazone+alachlor+sulfosate+furilazole; sulfentrazone+(S)-metolachlor+sulfosate +furilazole; sulfentrazone+metolachlor+sulfosate+furilazole; sulfentrazone+dimethenamid or (S)-dimethenamid+sulfosate+furilazole; sulfentrazone+acetochlor+sulfosate+furilazole; sulfentrazone+alachlor+sulfosate+furilazole; fluazolate+(S)-metolachlor+sulfosate+furilazole; fluazolate+metolachlor+sulfosate+furilazole; fluazolate+dimethenamid or (S)-dimethenamid+sulfosate+furilazole; fluazolate+acetochlor+sulfosate+furilazole; fluazolate+alachlor+sulfosate+furilazole; pyraflufen-ethyl+(S)-metolachlor+sulfosate+furilazole; pyraflufen-ethyl+metolachlor+sulfosate+furilazole; pyraflufen-ethyl+dimethenamid or (S)-dimethenamid+sulfosate+furilazole; pyraflufen-ethyl+acetochlor+sulfosate+furilazole; pyraflufen-ethyl+alachlor+sulfosate+furilazole; flumipropyn+(S)-metolachlor+sulfosate+furilazole; flumipropyn+metolachlor+sulfosate+furilazole; flumipropyn+dimethenamid or (S)-dimethenamid+sulfosate+furilazole; flumipropyn+acetochlor+sulfosate+furilazole; flumipropyn+alachlor+sulfosate+furilazole; flupropacil+(S)-metolachlor+sulfosate+furilazole; flupropacil+metolachlor+sulfosate+furilazole; flupropacil+dimethenamid or (S)-dimethenamid+sulfosate+furilazole; flupropacil+acetochlor+sulfosate+furilazole; flupropacil+alachlor+sulfosate+furilazole; nipyraclofen+(S)-metolachlor+sulfosate+furilazole; nipyraclofen+metolachlor+sulfosate+furilazole; nipyraclofen+dimethenamid or (S)-dimethenamid+sulfosate+furilazole; nipyraclofen+acetochlor+sulfosate+furilazole; nipyraclofen+alachlor+sulfosate+furilazole; benzfendizone+(S)-metolachlor +sulfosate+furilazole; benzfendizone+metolachlor+sulfosate+furilazole; benzfendizone+dimethenamid or (S)-dimethenamid+sulfosate+furilazole; benzfendizone+acetochlor+sulfosate+furilazole; benzfendizone+alachlor+sulfosate+furilazole; thidiazimin+(S)-metolachlor+sulfosate+furilazole; thidiazimin+metolachlor+sulfosate+furilazole; thidiazimin+dimethenamid or (S)-dimethenamid+sulfosate+furilazole; thidiazimin+acetochlor+sulfosate+furilazole; and thidiazimin+alachlor+sulfosate+furilazole.

The following specific combinations of the compounds under a) with the co-herbicides under b) (4-compound and 5-compound combinations) have been found to be further groups of very particularly effective herbicidal synergistic and selective-herbicidal compositions, in particular in crops of maize resistant to protoporphyrinogen oxidase inhibitors:

acifluorfen+prosulfuron+primisulfuron+glyphosate; acifluorfen+prosulfuron+dicamba +glyphosate; acifluorfen+primisulfuron+dicamba+glyphosate; acifluorfen+nicosulfuron +primisulfuron+glyphosate; acifluorfen+nicosulfuron+prosulfuron+glyphosate; acifluorfen+rimsulfuron+primisulfuron+glyphosate; acifluorfen+rimsulfuron+prosulfuron+glyphosate; acifluorfen+metolachlor+isoxaflutole+glyphosate; acifluorfen +metolachlor+isoxaflutole+glyphosate+benoxacor; acifluorfen+S-metolachlor+isoxaflutole+glyphosate; acifluorfen+S-metolachlor+isoxaflutole+glyphosate+benoxacor; acifluorfen+metolachlor+mesotrione+glyphosate; acifluorfen+metolachlor+mesotrione+glyphosate+benoxacor; acifluorfen+S-metolachlor+mesotrione+glyphosate; acifluorfen+S-metolachlor+mesotrione+benoxacor+glyphosate; acifluorfen +metolachlor+atrazine+glyphosate; acifluorfen+metolachlor+atrazine+glyphosate+benoxacor; acifluorfen+S-metolachlor+atrazine+glyphosate; acifluorfen+S-metolachlor +atrazine+glyphosate+benoxacor; acifluorfen+metolachlor+terbuthylazine+glyphosate; acifluorfen+metolachlor+terbuthylazine+glyphosate+benoxacor; acifluorfen+S-metolachlor+terbuthylazine+glyphosate; acifluorfen+S-metolachlor+terbuthylazine+glyphosate+benoxacor; acifluorfen+atrazine+nicosulfuron+glyphosate; acifluorfen+atrazine+nicosulfuron+glyphosate+benoxacor; aclonifen+prosulfuron+primisulfuron+glyphosate; aclonifen+prosulfuron+dicamba+glyphosate; aclonifen+primisulfuron+dicamba+glyphosate; aclonifen+nicosulfuron+primisulfuron+glyphosate; aclonifen+nicosulfuron+prosulfuron+glyphosate; aclonifen+rimsulfuron+primisulfuron+glyphosate; aclonifen+rimsulfuron+prosulfuron+glyphosate; aclonifen+metolachlor+isoxaflutole+glyphosate; aclonifen+metolachlor+isoxaflutole+glyphosate +benoxacor; aclonifen+S-metolachlor+isoxaflutole+glyphosate; aclonifen+S-metolachlor+isoxaflutole+glyphosate+benoxacor; aclonifen+metolachlor+mesotrione +glyphosate; aclonifen+metolachlor+mesotrione+glyphosate+benoxacor; aclonifen+S-metolachlor+mesotrione+glyphosate; aclonifen+S-metolachlor+mesotrione+glyphosate+benoxacor; aclonifen+metolachlor+atrazine+glyphosate; aclonifen+metolachlor+atrazine+glyphosate+benoxacor; aclonifen+S-metolachlor+atrazine+glyphosate; aclonifen+S-metolachlor+atrazine+glyphosate+benoxacor; aclonifen+metolachlor+terbuthylazine+glyphosate; aclonifen+metolachlor+terbuthylazine+glyphosate+benoxacor; aclonifen+S-metolachlor+terbuthylazine+glyphosate; aclonifen +S-metolachlor+terbuthylazine+glyphosate+benoxacor; aclonifen+atrazine+nicosulfuron+glyphosate; aclonifen+atrazine+nicosulfuron+glyphosate+benoxacor; bifenox+prosulfuron+primisulfuron+glyphosate; bifenox+prosulfuron+dicamba+glyphosate; bifenox+primisulfuron+dicamba+glyphosate; bifenox+nicosulfuron+primisulfuron+glyphosate; bifenox+nicosulfuron+prosulfuron+glyphosate; bifenox+rimsulfuron+primisulfuron+glyphosate; bifenox+rimsulfuron+prosulfuron+glyphosate; bifenox+metolachlor+isoxaflutole+glyphosate; bifenox+metolachlor+isoxaflutole+glyphosate+benoxacor; bifenox+S-metolachlor+isoxaflutole+glyphosate; bifenox+S-metolachlor+isoxaflutole+glyphosate+benoxacor; bifenox+metolachlor+mesotrione+glyphosate; bifenox+metolachlor+mesotrione+glyphosate+benoxacor; bifenox+S-metolachlor+mesotrione+glyphosate; bifenox+S-metolachlor+mesotrione+glyphosate +benoxacor; bifenox+metolachlor+atrazine+glyphosate; bifenox+metolachlor+atrazine+glyphosate+benoxacor; bifenox+S-metolachlor+atrazine+glyphosate; bifenox+S-metolachlor+atrazine+glyphosate+benoxacor; bifenox+metolachlor+terbuthylazine+glyphosate; bifenox+metolachlor+terbuthylazine+glyphosate+benoxacor; bifenox+S-metolachlor+terbuthylazine+glyphosate; bifenox+S-metolachlor +terbuthylazine+glyphosate+benoxacor; bifenox+atrazine+nicosulfuron+glyphosate; bifenox+atrazine+nicosulfuron+glyphosate+benoxacor; chlomitrofen+prosulfuron+primisulfuron+glyphosate; chlomitrofen+prosulfuron+dicamba+glyphosate; chlomitrofen+primisulfuron+dicamba+glyphosate; chlomitrofen+nicosulfuron+primisulfuron+glyphosate; chlomitrofen+nicosulfuron+prosulfuron+glyphosate; chlomitrofen+rimsulfuron+primisulfuron+glyphosate; chlomitrofen+rimsulfuron+prosulfuron+glyphosate; chlomitrofen+metolachlor+isoxaflutole+glyphosate; chlomitrofen+metolachlor+isoxaflutole+glyphosate+benoxacor; chlomitrofen+S-metolachlor+isoxaflutole+glyphosate; chlomitrofen+S-metolachlor+isoxaflutole+glyphosate+benoxacor; chlomitrofen+metolachlor+mesotrione+glyphosate; chlomitrofen+metolachlor+mesotrione+glyphosate+benoxacor; chlomitrofen+S-metolachlor+mesotrione+glyphosate; chlomitrofen+S-metolachlor+mesotrione+glyphosate+benoxacor; chlomitrofen+metolachlor+atrazine+glyphosate; chlomitrofen+metolachlor+atrazine+glyphosate+benoxacor; chlomitrofen+S-metolachlor+atrazine+glyphosate; chlomitrofen+S-metolachlor+atrazine+glyphosate+benoxacor, chlomitrofen+metolachlor+terbuthylazine+glyphosate; chlomitrofen+metolachlor+terbuthylazine+glyphosate+benoxacor; chlomitrofen+S-metolachlor+terbuthylazine+glyphosate; chlomitrofen+S-metolachlor+terbuthylazine+glyphosate+benoxacor; chlomitrofen+atrazine+nicosulfuron+glyphosate; chlomitrofen+atrazine+nicosulfuron +glyphosate+benoxacor; ethoxyfen+prosulfuron+primisulfuron+glyphosate; ethoxyfen +prosulfuron+dicamba+glyphosate; ethoxyfen+primisulfuron+dicamba+glyphosate; ethoxyfen+nicosulfuron+primisulfuron+glyphosate; ethoxyfen+nicosulfuron+prosulfuron+glyphosate; ethoxyfen+rimsulfuron+primisulfuron+glyphosate; ethoxyfen+rimsulfuron+prosulfuron+glyphosate; ethoxyfen+metolachlor+isoxaflutole+glyphosate; ethoxyfen+metolachlor+isoxaflutole+glyphosate+benoxacor; ethoxyfen+S-metolachlor+isoxaflutole+glyphosate; ethoxyfen+S-metolachlor+isoxaflutole+glyphosate+benoxacor; ethoxyfen+metolachlor+mesotrione+glyphosate; ethoxyfen+metolachlor+mesotrione+glyphosate+benoxacor; ethoxyfen+S-metolachlor+mesotrione+glyphosate; ethoxyfen+S-metolachlor+mesotrione+glyphosate+benoxacor; ethoxyfen+metolachlor+atrazine+glyphosate; ethoxyfen+metolachlor+atrazine+glyphosate+benoxacor; ethoxyfen+S-metolachlor+atrazine+glyphosate; ethoxyfen+S-metolachlor+atrazine+glyphosate+benoxacor; ethoxyfen+metolachlor+terbuthylazine+glyphosate; ethoxyfen+metolachlor+terbuthylazine+glyphosate+benoxacor; ethoxyfen+S-metolachlor+terbuthylazine+glyphosate; ethoxyfen+S-metolachlor+terbuthylazine+glyphosate+benoxacor; ethoxyfen+atrazine+nicosulfuron +glyphosate; ethoxyfen+atrazine+nicosulfuron+glyphosate+benoxacor; fluoroglycofen+prosulfuron+primisulfuron+glyphosate; fluoroglycofen+prosulfuron+dicamba+glyphosate; fluoroglycofen+primisulfuron+dicamba+glyphosate; fluoroglycofen+nicosulfuron+primisulfuron+glyphosate; fluoroglycofen+nicosulfuron+prosulfuron+glyphosate; fluoroglycofen+rimsulfuron+primisulfuron+glyphosate; fluoroglycofen+rimsulfuron+prosulfuron+glyphosate; fluoroglycofen+metolachlor+isoxaflutole+glyphosate; fluoroglycofen+metolachlor+isoxaflutole+glyphosate+benoxacor; fluoroglycofen+S-metolachlor+isoxaflutole+glyphosate; fluoroglycofen+S-metolachlor+isoxaflutole+glyphosate+benoxacor; fluoroglycofen+metolachlor+mesotrione+glyphosate; fluoroglycofen+metolachlor+mesotrione+glyphosate+benoxacor; fluoroglycofen+S-metolachlor+mesotrione+glyphosate; fluoroglycofen+S-metolachlor+mesotrione+glyphosate+benoxacor; fluoroglycofen+metolachlor+atrazine+glyphosate; fluoroglycofen+metolachlor+atrazine+glyphosate+benoxacor; fluoroglycofen+S-metolachlor+atrazine+glyphosate; fluoroglycofen+S-metolachlor+atrazine+glyphosate+benoxacor; fluoroglycofen+metolachlor+terbuthylazine+glyphosate; fluoroglycofen+metolachlor+terbuthylazine+glyphosate+benoxacor; fluoroglycofen+S-metolachlor+terbuthylazine+glyphosate; fluoroglycofen+S-metolachlor+terbuthylazine+glyphosate+benoxacor; fluoroglycofen+atrazine+nicosulfuron+glyphosate; fluoroglycofen+atrazine+nicosulfuron+glyphosate+benoxacor; fomesafen+prosulfuron+primisulfuron+glyphosate; fomesafen+prosulfuron +dicamba+glyphosate; fomesafen+primisulfuron+dicamba+glyphosate; fomesafen+nicosulfuron+primisulfuron+glyphosate; fomesafen+nicosulfuron+prosulfuron+glyphosate; fomesafen+rimsulfuron+primisulfuron+glyphosate; fomesafen+rimsulfuron +prosulfuron+glyphosate; fomesafen+metolachlor+isoxaflutole+glyphosate; fomesafen+metolachlor+isoxaflutole+glyphosate+benoxacor; fomesafen+S-metolachlor+isoxaflutole+glyphosate; fomesafen+S-metolachlor+isoxaflutole+glyphosate+benoxacor; fomesafen+metolachlor+mesotrione+glyphosate; fomesafen+metolachlor+mesotrione+glyphosate+benoxacor; fomesafen+S-metolachlor+mesotrione+glyphosate; fomesafen+S-metolachlor+mesotrione+glyphosate+benoxacor; fomesafen+metolachlor+atrazine+glyphosate; fomesafen+metolachlor+atrazine+glyphosate+benoxacor; fomesafen+S-metolachlor+atrazine+glyphosate; fomesafen+S-metolachlor+atrazine+glyphosate+benoxacor; fomesafen+metolachlor +terbuthylazine+glyphosate; fomesafen+metolachlor+terbuthylazine+glyphosate+benoxacor; fomesafen+S-metolachlor+terbuthylazine+glyphosate; fomesafen+S-metolachlor+terbuthylazine+glyphosate+benoxacor; fomesafen+atrazine+nicosulfuron+glyphosate; fomesafen+atrazine+nicosulfuron+glyphosate+benoxacor; lactofen+prosulfuron+primisulfuron+glyphosate; lactofen+prosulfuron+dicamba+glyphosate; lactofen+primisulfuron+dicamba+glyphosate; lactofen+nicosulfuron+primisulfuron+glyphosate; lactofen+nicosulfuron+prosulfuron+glyphosate; lactofen+rimsulfuron+primisulfuron+glyphosate; lactofen+rimsulfuron+prosulfuron+glyphosate; lactofen+metolachlor+isoxaflutole+glyphosate; lactofen+metolachlor+isoxaflutole+glyphosate+benoxacor; lactofen+S-metolachlor+isoxaflutole+glyphosate; lactofen+S-metolachlor+isoxaflutole+glyphosate+benoxacor; lactofen+metolachlor+mesotrione+glyphosate; lactofen+metolachlor+mesotrione+glyphosate+benoxacor; lactofen+S-metolachlor+mesotrione+glyphosate; lactofen+S-metolachlor+mesotrione+glyphosate +benoxacor; lactofen+metolachlor+atrazine+glyphosate; lactofen+metolachlor+atrazine+benoxacor; lactofen+S-metolachlor+atrazine; lactofen+S-metolachlor+atrazine+glyphosate+benoxacor; lactofen+metolachlor+terbuthylazine+glyphosate; lactofen+metolachlor+terbuthylazine+glyphosate+benoxacor; lactofen+S-metolachlor +terbuthylazine+glyphosate; lactofen+S-metolachlor+terbuthylazine+glyphosate+benoxacor; lactofen+atrazine+nicosulfuron+glyphosate; lactofen+atrazine+nicosulfuron+glyphosate+benoxacor; oxyfluorfen+prosulfuron+primisulfuron+glyphosate; oxyfluorfen+prosulfuron+dicamba+glyphosate; oxyfluorfen+primisulfuron+dicamba+glyphosate; oxyfluorfen+nicosulfuron+primisulfuron+glyphosate; oxyfluorfen +nicosulfuron+prosulfuron+glyphosate; oxyfluorfen+rimsulfuron+primisulfuron+glyphosate; oxyfluorfen+rimsulfuron+prosulfuron+glyphosate; oxyfluorfen+metolachlor +isoxaflutole+glyphosate; oxyfluorfen+metolachlor+isoxaflutole+glyphosate+benoxacor; oxyfluorfen+S-metolachlor+isoxaflutole+glyphosate; oxyfluorfen+S-metolachlor+isoxaflutole+glyphosate+benoxacor; oxyfluorfen+metolachlor+mesotrione+glyphosate; oxyfluorfen+metolachlor+mesotrione+glyphosate+benoxacor; oxyfluorfen+S-metolachlor+mesotrione+glyphosate; oxyfluorfen+S-metolachlor+mesotrione+glyphosate+benoxacor; oxyfluorfen+metolachlor+atrazine+glyphosate; oxyfluorfen+metolachlor+atrazine+glyphosate+benoxacor; oxyfluorfen+S-metolachlor+atrazine+glyphosate; oxyfluorfen+S-metolachlor+atrazine+glyphosate +benoxacor; oxyfluorfen+metolachlor+terbuthylazine+glyphosate; oxyfluorfen+metolachlor+terbuthylazine+glyphosate+benoxacor; oxyfluorfen+S-metolachlor+terbuthylazine+glyphosate; oxyfluorfen+S-metolachlor+terbuthylazine+glyphosate+benoxacor; oxyfluorfen+atrazine+nicosulfuron+glyphosate; oxyfluorfen+atrazine+nicosulfuron+glyphosate+benoxacor; azafenidin+prosulfuron+primisulfuron+glyphosate; azafenidin+prosulfuron+dicamba+glyphosate; azafenidin+primisulfuron+dicamba+glyphosate; azafenidin+nicosulfuron+primisulfuron+glyphosate; azafenidin+nicosulfuron+prosulfuron+glyphosate; azafenidin+rimsulfuron+primisulfuron+glyphosate; azafenidin+rimsulfuron+prosulfuron+glyphosate; azafenidin+metolachlor+isoxaflutole+glyphosate; azafenidin+metolachlor+isoxaflutole+glyphosate+benoxacor; azafenidin+S-metolachlor+isoxaflutole+glyphosate; azafenidin+S-metolachlor+isoxaflutole+glyphosate+benoxacor; azafenidin+metolachlor+mesotrione+glyphosate; azafenidin+metolachlor+mesotrione+glyphosate+benoxacor; azafenidin+S-metolachlor+mesotrione+glyphosate; azafenidin+S-metolachlor+mesotrione+glyphosate+benoxacor; azafenidin+metolachlor+atrazine+glyphosate; azafenidin+metolachlor+atrazine+glyphosate+benoxacor; azafenidin+S-metolachlor+atrazine+glyphosate; azafenidin+S-metolachlor+atrazine+glyphosate+benoxacor; azafenidin+metolachlor+terbuthylazine+glyphosate; azafenidin+metolachlor+terbuthylazine+glyphosate+benoxacor; azafenidin+S-metolachlor+terbuthylazine+glyphosate; azafenidin+S-metolachlor+terbuthylazine+glyphosate+benoxacor; azafenidin+atrazine+nicosulfuron+glyphosate; azafenidin+atrazine+nicosulfuron+glyphosate+benoxacor; carfentrazone-ethyl+prosulfuron+primisulfuron+glyphosate; carfentrazone-ethyl+prosulfuron+dicamba+glyphosate; carfentrazone-ethyl+primisulfuron+dicamba +glyphosate; carfentrazone-ethyl+nicosulfuron+primisulfuron+glyphosate; carfentrazone-ethyl+nicosulfuron+prosulfuron+glyphosate; carfentrazone-ethyl+rimsulfuron+primisulfuron+glyphosate; carfentrazone-ethyl+rimsulfuron+prosulfuron+glyphosate; carfentrazone-ethyl+metolachlor+isoxaflutole+glyphosate; carfentrazone-ethyl+metolachlor+isoxaflutole+glyphosate+benoxacor; carfentrazone-ethyl+S-metolachlor+isoxaflutole+glyphosate; carfentrazone-ethyl+S-metolachlor+isoxaflutole +glyphosate+benoxacor; carfentrazone-ethyl+metolachlor+mesotrione+glyphosate; carfentrazone-ethyl+metolachlor+mesotrione+glyphosate+benoxacor; carfentrazone-ethyl+S-metolachlor+mesotrione+glyphosate; carfentrazone-ethyl+S-metolachlor+mesotrione+glyphosate+benoxacor; carfentrazone-ethyl+metolachlor+atrazine+glyphosate; carfentrazone-ethyl+metolachlor+atrazine+glyphosate+benoxacor; carfentrazone-ethyl+S-metolachlor+atrazine+glyphosate; carfentrazone-ethyl+S-metolachlor+atrazine+glyphosate+benoxacor; carfentrazone-ethyl+metolachlor+terbuthylazine+glyphosate; carfentrazone-ethyl+metolachlor+terbuthylazine+glyphosate+benoxacor; carfentrazone-ethyl+S-metolachlor+terbuthylazine+glyphosate; carfentrazone-ethyl+S-metolachlor+terbuthylazine+glyphosate+benoxacor; carfentrazone-ethyl+atrazine+nicosulfuron+glyphosate; carfentrazone-ethyl+atrazine+nicosulfuron+glyphosate+benoxacor; compound of the formula A+prosulfuron+primisulfuron+glyphosate; compound of the formula A+prosulfuron+dicamba+glyphosate; compound of the formula A+primisulfuron+dicamba+glyphosate; compound of the formula A+nicosulfuron+primisulfuron+glyphosate; compound of the formula A+nicosulfuron+prosulfuron+glyphosate; compound of the formula A+rimsulfuron+primisulfuron+glyphosate; compound of the formula A+rimsulfuron+prosulfuron+glyphosate; compound of the formula A+metolachlor+isoxaflutole+glyphosate;

compound of the formula A+metolachlor+isoxaflutole+glyphosate+benoxacor; compound of the formula A+S-metolachlor+isoxaflutole+glyphosate; compound of the formula A+S-metolachlor+isoxaflutole+glyphosate+benoxacor; compound of the formula A+metolachlor+mesotrione+glyphosate; compound of the formula A+metolachlor+mesotrione+glyphosate+benoxacor; compound of the formula A+S-metolachlor+mesotrione+glyphosate; compound of the formula A+S-metolachlor+mesotrione+glyphosate+benoxacor; compound of the formula A+metolachlor+atrazine +glyphosate; compound of the formula A+metolachlor+atrazine+glyphosate+benoxacor; compound of the formula A+S-metolachlor+atrazine+glyphosate; compound of the formula A+S-metolachlor+atrazine+glyphosate+benoxacor; compound of the formula A+metolachlor+terbuthylazine+glyphosate; compound of the formula A+metolachlor+terbuthylazine+glyphosate+benoxacor; compound of the formula A+S-metolachlor+terbuthylazine+glyphosate; compound of the formula A+S-metolachlor+terbuthylazine+glyphosate+benoxacor; compound of the formula A+atrazine+nicosulfuron+glyphosate; compound of the formula A+atrazine+nicosulfuron+glyphosate+benoxacor; cinidon-ethyl+prosulfuron+primisulfuron+glyphosate; cinidon-ethyl+prosulfuron+dicamba+glyphosate; cinidon-ethyl+primisulfuron+dicamba+glyphosate; cinidon-ethyl+nicosulfuron+primisulfuron+glyphosate; cinidon-ethyl+nicosulfuron+prosulfuron+glyphosate; cinidon-ethyl+rimsulfuron+primisulfuron+glyphosate; cinidon-ethyl+rimsulfuron+prosulfuron+glyphosate; cinidon-ethyl+metolachlor+isoxaflutole+glyphosate; cinidon-ethyl+metolachlor+isoxaflutole+glyphosate+benoxacor; cinidon-ethyl+S-metolachlor+isoxaflutole+glyphosate; cinidon-ethyl+S-metolachlor+isoxaflutole+glyphosate+benoxacor; cinidon-ethyl+metolachlor+mesotrione+glyphosate; cinidon-ethyl+metolachlor+mesotrione+glyphosate+benoxacor; cinidon-ethyl+S-metolachlor+mesotrione+glyphosate; cinidon-ethyl+S-metolachlor+mesotrione+glyphosate+benoxacor; cinidon-ethyl+metolachlor+atrazine +glyphosate; cinidon-ethyl+metolachlor+atrazine+glyphosate+benoxacor; cinidon-ethyl+S-metolachlor+atrazine+glyphosate; cinidon-ethyl+S-metolachlor+atrazine+glyphosate+benoxacor; cinidon-ethyl+metolachlor+terbuthylazine+glyphosate; cinidon-ethyl+metolachlor+terbuthylazine+glyphosate+benoxacor; cinidon-ethyl+S-metolachlor+terbuthylazine+glyphosate; cinidon-ethyl+S-metolachlor+terbuthylazine+glyphosate+benoxacor; cinidon-ethyl+atrazine+nicosulfuron+glyphosate; cinidon-ethyl +atrazine+nicosulfuron+glyphosate+benoxacor; flumiclorac-pentyl+prosulfuron+primisulfuron+glyphosate; flumiclorac-pentyl+prosulfuron+dicamba+glyphosate; flumiclorac-pentyl+primisulfuron+dicamba+glyphosate; flumiclorac-pentyl+nicosulfuron +primisulfuron+glyphosate; flumiclorac-pentyl+nicosulfuron+prosulfuron+glyphosate; flumiclorac-pentyl+rimsulfuron+primisulfuron+glyphosate; flumiclorac-pentyl+rimsulfuron+prosulfuron+glyphosate; flumiclorac-pentyl+metolachlor+isoxaflutole+glyphosate; flumiclorac-pentyl+metolachlor+isoxaflutole+glyphosate+benoxacor; flumiclorac-pentyl+S-metolachlor+isoxaflutole+glyphosate; flumiclorac-pentyl+S-metolachlor+isoxaflutole+glyphosate+benoxacor; flumiclorac-pentyl+metolachlor+mesotrione+glyphosate; flumiclorac-pentyl+metolachlor+mesotrione+glyphosate+benoxacor; flumiclorac-pentyl+S-metolachlor+mesotrione+glyphosate; flumiclorac-pentyl +S-metolachlor+mesotrione+glyphosate+benoxacor; flumiclorac-pentyl+metolachlor+atrazine+glyphosate; flumiclorac-pentyl+metolachlor+atrazine+glyphosate+benoxacor; flumiclorac-pentyl+S-metolachlor+atrazine+glyphosate; flumiclorac-pentyl+S-metolachlor+atrazine+glyphosate+benoxacor; flumiclorac-pentyl+metolachlor+terbuthylazine+glyphosate; flumiclorac-pentyl+metolachlor+terbuthylazine+glyphosate +benoxacor; flumiclorac-pentyl+S-metolachlor+terbuthylazine+glyphosate; flumiclorac-pentyl+S-metolachlor+terbuthylazine+glyphosate+benoxacor; flumiclorac-pentyl+atrazine+nicosulfuron+glyphosate; flumiclorac-pentyl+atrazine+nicosulfuron+glyphosate+benoxacor; flumioxazin+prosulfuron+primisulfuron+glyphosate; flumioxazin+prosulfuron+dicamba+glyphosate; flumioxazin+primisulfuron+dicamba+glyphosate; flumioxazin+nicosulfuron+primisulfuron+glyphosate; flumioxazin+nicosulfuron+prosulfuron+glyphosate; flumioxazin+rimsulfuron+primisulfuron+glyphosate; flumioxazin+rimsulfuron+prosulfuron+glyphosate; flumioxazin+metolachlor +isoxaflutole+glyphosate; flumioxazin+metolachlor+isoxaflutole+glyphosate+benoxacor; flumioxazin+S-metolachlor+isoxaflutole+glyphosate; flumioxazin+S-metolachlor+isoxaflutole+glyphosate+benoxacor; flumioxazin+metolachlor+mesotrione+glyphosate; flumioxazin+metolachlor+mesotrione+glyphosate+benoxacor; flumioxazin+S-metolachlor+mesotrione+glyphosate; flumioxazin+S-metolachlor+mesotrione+glyphosate+benoxacor; flumioxazin+metolachlor+atrazine+glyphosate; flumioxazin+metolachlor+atrazine+glyphosate+benoxacor; flumioxazin+S-metolachlor+atrazine+glyphosate; flumioxazin+S-metolachlor+atrazine+glyphosate +benoxacor; flumioxazin+metolachlor+terbuthylazine+glyphosate; flumioxazin+metolachlor+terbuthylazine+glyphosate+benoxacor; flumioxazin+S-metolachlor+terbuthylazine+glyphosate; flumioxazin+S-metolachlor+terbuthylazine+glyphosate+benoxacor; flumioxazin+atrazine+nicosulfuron+glyphosate; flumioxazin+atrazine+nicosulfuron+glyphosate+benoxacor; fluthiacet-methyl+prosulfuron+primisulfuron+glyphosate; fluthiacet-methyl+prosulfuron+dicamba+glyphosate; fluthiacet-methyl+primisulfuron+dicamba+glyphosate; fluthiacet-methyl+nicosulfuron+primisulfuron+glyphosate; fluthiacet-methyl+nicosulfuron+prosulfuron+glyphosate; fluthiacet-methyl+rimsulfuron+primisulfuron+glyphosate; fluthiacet-methyl+rimsulfuron+prosulfuron+glyphosate; fluthiacet-methyl+metolachlor+isoxaflutole+glyphosate; fluthiacet-methyl+metolachlor+isoxaflutole+glyphosate+benoxacor; fluthiacet-methyl+S-metolachlor+isoxaflutole+glyphosate; fluthiacet-methyl+S-metolachlor+isoxaflutole+glyphosate+benoxacor; fluthiacet-methyl+metolachlor+mesotrione+glyphosate; fluthiacet-methyl+metolachlor+mesotrione+glyphosate+benoxacor; fluthiacet-methyl+S-metolachlor+mesotrione+glyphosate; fluthiacet-methyl+S-metolachlor+mesotrione+glyphosate+benoxacor, fluthiacet-methyl+metolachlor+atrazine+glyphosate; fluthiacet-methyl+metolachlor+atrazine+glyphosate+benoxacor; fluthiacet-methyl+S-metolachlor+atrazine+glyphosate; fluthiacet-methyl+S-metolachlor+atrazine+glyphosate+benoxacor; fluthiacet-methyl+metolachlor+terbuthylazine+glyphosate; fluthiacet-methyl +metolachlor+terbuthylazine+glyphosate+benoxacor, fluthiacet-methyl+S-metolachlor +terbuthylazine+glyphosate; fluthiacet-methyl+S-metolachlor+terbuthylazine+glyphosate+benoxacor; fluthiacet-methyl+atrazine+nicosulfuron+glyphosate; fluthiacet-methyl+atrazine+nicosulfuron+glyphosate+benoxacor; oxadiargyl+prosulfuron+primisulfuron+glyphosate; oxadiargyl+prosulfuron+dicamba+glyphosate; oxadiargyl+primisulfuron+dicamba+glyphosate; oxadiargyl+nicosulfuron+primisulfuron+glyphosate; oxadiargyl+nicosulfuron+prosulfuron+glyphosate; oxadiargyl+rimsulfuron+primisulfuron+glyphosate; oxadiargyl+rimsulfuron+prosulfuron+glyphosate; oxadiargyl +metolachlor+isoxaflutole+glyphosate; oxadiargyl+metolachlor+isoxaflutole+glyphosate+benoxacor; oxadiargyl+S-metolachlor+isoxaflutole+glyphosate; oxadiargyl +S-metolachlor+isoxaflutole+glyphosate+benoxacor; oxadiargyl+metolachlor+mesotrione+glyphosate; oxadiargyl+metolachlor+mesotrione+glyphosate+benoxacor; oxadiargyl+S-metolachlor+mesotrione+glyphosate; oxadiargyl+S-metolachlor+mesotrione+glyphosate+benoxacor; oxadiargyl+metolachlor+atrazine+glyphosate; oxadiargyl+metolachlor+atrazine+glyphosate+benoxacor; oxadiargyl+S-metolachlor+atrazine+glyphosate; oxadiargyl+S-metolachlor+atrazine+glyphosate+benoxacor; oxadiargyl+metolachlor+terbuthylazine+glyphosate; oxadiargyl+metolachlor+terbuthylazine+glyphosate+benoxacor; oxadiargyl+S-metolachlor+terbuthylazine+glyphosate; oxadiargyl+S-metolachlor+terbuthylazine+glyphosate+benoxacor; oxadiargyl+atrazine+nicosulfuron+glyphosate; oxadiargyl+atrazine+nicosulfuron+glyphosate+benoxacor; oxadiazon+prosulfuron+primisulfuron+glyphosate; oxadiazon +prosulfuron+dicamba+glyphosate; oxadiazon+primisulfuron+dicamba+glyphosate; oxadiazon+nicosulfuron+primisulfuron+glyphosate; oxadiazon+nicosulfuron+prosulfuron+glyphosate; oxadiazon+rimsulfuron+primisulfuron+glyphosate; oxadiazon +rimsulfuron+prosulfuron+glyphosate; oxadiazon+metolachlor+isoxaflutole+glyphosate; oxadiazon+metolachlor+isoxaflutole+glyphosate+benoxacor; oxadiazon+S-metolachlor+isoxaflutole+glyphosate; oxadiazon+S-metolachlor+isoxaflutole+glyphosate+benoxacor; oxadiazon+metolachlor+mesotrione+glyphosate; oxadiazon+metolachlor+mesotrione+glyphosate+benoxacor; oxadiazon+S-metolachlor+mesotrione+glyphosate; oxadiazon+S-metolachlor+mesotrione+glyphosate+benoxacor; oxadiazon+metolachlor+atrazine+glyphosate; oxadiazon+metolachlor+atrazine+glyphosate+benoxacor; oxadiazon+S-metolachlor+atrazine+glyphosate; oxadiazon+S-metolachlor+atrazine+glyphosate+benoxacor; oxadiazon+metolachlor+terbuthylazine+glyphosate; oxadiazon+metolachlor+terbuthylazine+glyphosate+benoxacor; oxadiazon+S-metolachlor+terbuthylazine+glyphosate; oxadiazon+S-metolachlor+terbuthylazine+glyphosate+benoxacor; oxadiazon+atrazine+nicosulfuron +glyphosate; oxadiazon+atrazine+nicosulfuron+glyphosate+benoxacor; pentoxazone +prosulfuron+primisulfuron+glyphosate; pentoxazone+prosulfuron+dicamba+glyphosate; pentoxazone+primisulfuron+dicamba+glyphosate; pentoxazone+nicosulfuron+primisulfuron+glyphosate; pentoxazone+nicosulfuron+prosulfuron+glyphosate; pentoxazone+rimsulfuron+primisulfuron+glyphosate; pentoxazone+rimsulfuron+prosulfuron+glyphosate; pentoxazone+metolachlor+isoxaflutole+glyphosate; pentoxazone+metolachlor+isoxaflutole+glyphosate+benoxacor; pentoxazone+S-metolachlor+isoxaflutole+glyphosate; pentoxazone+S-metolachlor+isoxaflutole+glyphosate+benoxacor; pentoxazone+metolachlor+mesotrione+glyphosate; pentoxazone+metolachlor+mesotrione+glyphosate+benoxacor; pentoxazone+S-metolachlor+mesotrione+glyphosate; pentoxazone+S-metolachlor+mesotrione+glyphosate+benoxacor; pentoxazone+metolachlor+atrazine+glyphosate; pentoxazone+metolachlor+atrazine+glyphosate+benoxacor; pentoxazone+S-metolachlor+atrazine+glyphosate; pentoxazone+S-metolachlor+atrazine+glyphosate +benoxacor; pentoxazone+metolachlor+terbuthylazine+glyphosate; pentoxazone+metolachlor+terbuthylazine+glyphosate+benoxacor; pentoxazone+S-metolachlor+terbuthylazine+glyphosate; pentoxazone+S-metolachlor+terbuthylazine+glyphosate+benoxacor; pentoxazone+atrazine+nicosulfuron+glyphosate; pentoxazone+atrazine+nicosulfuron+glyphosate+benoxacor; sulfentrazone+prosulfuron+primisulfuron+glyphosate; sulfentrazone+prosulfuron+dicamba+glyphosate; sulfentrazone+primisulfuron+dicamba+glyphosate; sulfentrazone+nicosulfuron+primisulfuron+glyphosate; sulfentrazone+nicosulfuron+prosulfuron+glyphosate; sulfentrazone+rimsulfuron+primisulfuron+glyphosate; sulfentrazone+rimsulfuron+prosulfuron+glyphosate; sulfentrazone+metolachlor+isoxaflutole+glyphosate; sulfentrazone+metolachlor+isoxaflutole+glyphosate+benoxacor; sulfentrazone+S-metolachlor+isoxaflutole+glyphosate; sulfentrazone+S-metolachlor+isoxaflutole+glyphosate+benoxacor; sulfentrazone+metolachlor+mesotrione+glyphosate; sulfentrazone+metolachlor+mesotrione+glyphosate+benoxacor; sulfentrazone+S-metolachlor+mesotrione+glyphosate; sulfentrazone+S-metolachlor+mesotrione+glyphosate+benoxacor; sulfentrazone+metolachlor+atrazine+glyphosate; sulfentrazone+metolachlor+atrazine+glyphosate+benoxacor; sulfentrazone+S-metolachlor+atrazine +glyphosate; sulfentrazone+S-metolachlor+atrazine+glyphosate+benoxacor; sulfentrazone+metolachlor+terbuthylazine+glyphosate; sulfentrazone+metolachlor+terbuthylazine+glyphosate+benoxacor; sulfentrazone+S-metolachlor+terbuthylazine+glyphosate; sulfentrazone+S-metolachlor+terbuthylazine+glyphosate+benoxacor; sulfentrazone+atrazine+nicosulfuron+glyphosate; sulfentrazone+atrazine+nicosulfuron+glyphosate+benoxacor; fluazolate+prosulfuron+primisulfuron+glyphosate; fluazolate+prosulfuron+dicamba+glyphosate; fluazolate+primisulfuron+dicamba+glyphosate; fluazolate+nicosulfuron+primisulfuron+glyphosate; fluazolate+nicosulfuron+prosulfuron+glyphosate; fluazolate+rimsulfuron+primisulfuron+glyphosate; fluazolate+rimsulfuron+prosulfuron+glyphosate; fluazolate+metolachlor+isoxaflutole+glyphosate; fluazolate+metolachlor+isoxaflutole+glyphosate+benoxacor; fluazolate+S-metolachlor+isoxaflutole+glyphosate; fluazolate+S-metolachlor+isoxaflutole+glyphosate+benoxacor; fluazolate+metolachlor+mesotrione+glyphosate; fluazolate+metolachlor+mesotrione+glyphosate+benoxacor; fluazolate+S-metolachlor +mesotrione+glyphosate; fluazolate+S-metolachlor+mesotrione+glyphosate+benoxacor; fluazolate+metolachlor+atrazine+glyphosate; fluazolate+metolachlor+atrazine+glyphosate+benoxacor; fluazolate+S-metolachlor+atrazine+glyphosate; fluazolate+S-metolachlor+atrazine+glyphosate+benoxacor; fluazolate+metolachlor+terbuthylazine+glyphosate; fluazolate+metolachlor+terbuthylazine+glyphosate+benoxacor; fluazolate+S-metolachlor+terbuthylazine+glyphosate; fluazolate+S-metolachlor+terbuthylazine+glyphosate+benoxacor; fluazolate+atrazine+nicosulfuron +glyphosate; fluazolate+atrazine+nicosulfuron+glyphosate+benoxacor; pyraflufen-ethyl+prosulfuron+primisulfuron+glyphosate; pyraflufen-ethyl+prosulfuron+dicamba+glyphosate; pyraflufen-ethyl+primisulfuron+dicamba+glyphosate; pyraflufen-ethyl+nicosulfuron+primisulfuron+glyphosate; pyraflufen-ethyl+nicosulfuron+prosulfuron+glyphosate; pyraflufen-ethyl+rimsulfuron+primisulfuron+glyphosate; pyraflufen-ethyl+rimsulfuron+prosulfuron+glyphosate; pyraflufen-ethyl+metolachlor+isoxaflutole+glyphosate; pyraflufen-ethyl+metolachlor+isoxaflutole+glyphosate+benoxacor; pyraflufen-ethyl+S-metolachlor+isoxaflutole+glyphosate; pyraflufen-ethyl+S-metolachlor+isoxaflutole+glyphosate+benoxacor; pyraflufen-ethyl+metolachlor+mesotrione+glyphosate; pyraflufen-ethyl+metolachlor+mesotrione+glyphosate+benoxacor; pyraflufen-ethyl+S-metolachlor+mesotrione+glyphosate; pyraflufen-ethyl+S-metolachlor+mesotrione+glyphosate+benoxacor; pyraflufen-ethyl+metolachlor+atrazine+glyphosate; pyraflufen-ethyl+metolachlor+atrazine+glyphosate+benoxacor; pyraflufen-ethyl+S-metolachlor+atrazine+glyphosate; pyraflufen-ethyl+S-metolachlor+atrazine+glyphosate+benoxacor; pyraflufen-ethyl+metolachlor+terbuthylazine+glyphosate; pyraflufen-ethyl+metolachlor+terbuthylazine+glyphosate+benoxacor; pyraflufen-ethyl+S-metolachlor+terbuthylazine+glyphosate; pyraflufen-ethyl+S-metolachlor+terbuthylazine+glyphosate+benoxacor; pyraflufen-ethyl+atrazine+nicosulfuron+glyphosate; pyraflufen-ethyl+atrazine+nicosulfuron+glyphosate+benoxacor; flumipropyn+prosulfuron+primisulfuron+glyphosate; flumipropyn+prosulfuron+dicamba+glyphosate; flumipropyn+primisulfuron+dicamba+glyphosate; flumipropyn+nicosulfuron+primisulfuron+glyphosate; flumipropyn+nicosulfuron+prosulfuron+glyphosate; flumipropyn+rimsulfuron+primisulfuron+glyphosate; flumipropyn+rimsulfuron+prosulfuron+glyphosate; flumipropyn+metolachlor+isoxaflutole+glyphosate; flumipropyn+metolachlor+isoxaflutole+glyphosate+benoxacor; flumipropyn+S-metolachlor+isoxaflutole+glyphosate; flumipropyn+S-metolachlor+isoxaflutole+glyphosate+benoxacor; flumipropyn+metolachlor+mesotrione+glyphosate; flumipropyn+metolachlor+mesotrione+glyphosate+benoxacor; flumipropyn+S-metolachlor+mesotrione+glyphosate; flumipropyn+S-metolachlor+mesotrione+glyphosate+benoxacor; flumipropyn+metolachlor+atrazine+glyphosate; flumipropyn+metolachlor+atrazine+glyphosate+benoxacor; flumipropyn+S-metolachlor+atrazine+glyphosate; flumipropyn+S-metolachlor+atrazine+glyphosate +benoxacor; flumipropyn+metolachlor+terbuthylazine+glyphosate; flumipropyn+metolachlor+terbuthylazine+glyphosate+benoxacor; flumipropyn+S-metolachlor+terbuthylazine+glyphosate; flumipropyn+S-metolachlor+terbuthylazine+glyphosate+benoxacor; flumipropyn+atrazine+nicosulfuron+glyphosate; flumipropyn+atrazine+nicosulfuron+glyphosate+benoxacor; flupropacil+prosulfuron+primisulfuron+glyphosate; flupropacil+prosulfuron+dicamba+glyphosate; flupropacil+primisulfuron+dicamba+glyphosate; flupropacil+nicosulfuron+primisulfuron+glyphosate; flupropacil+nicosulfuron+prosulfuron+glyphosate; flupropacil+rimsulfuron+primisulfuron+glyphosate; flupropacil+rimsulfuron+prosulfuron+glyphosate; flupropacil+metolachlor+isoxaflutole+glyphosate; flupropacil+metolachlor+isoxaflutole+glyphosate+benoxacor; flupropacil+S-metolachlor+isoxaflutole+glyphosate; flupropacil+S-metolachlor+isoxaflutole+glyphosate+benoxacor; flupropacil+metolachlor+mesotrione+glyphosate; flupropacil+metolachlor+mesotrione+glyphosate+benoxacor; flupropacil+S-metolachlor+mesotrione+glyphosate; flupropacil+S-metolachlor+mesotrione+glyphosate+benoxacor; flupropacil+metolachlor+atrazine+glyphosate; flupropacil+metolachlor+atrazine+glyphosate+benoxacor; flupropacil+S-metolachlor+atrazine+glyphosate; flupropacil+S-metolachlor+atrazine+glyphosate+benoxacor; flupropacil+metolachlor+terbuthylazine+glyphosate; flupropacil+metolachlor+terbuthylazine+glyphosate+benoxacor; flupropacil+S-metolachlor+terbuthylazine+glyphosate; flupropacil+S-metolachlor+terbuthylazine+glyphosate+benoxacor; flupropacil+atrazine+nicosulfuron+glyphosate; flupropacil+atrazine+nicosulfuron+glyphosate+benoxacor; nipyraclofen+prosulfuron+primisulfuron+glyphosate; nipyraclofen+prosulfuron+dicamba+glyphosate; nipyraclofen+primisulfuron+dicamba+glyphosate; nipyraclofen+nicosulfuron+primisulfuron+glyphosate; nipyraclofen+nicosulfuron+prosulfuron+glyphosate; nipyraclofen+rimsulfuron+primisulfuron+glyphosate; nipyraclofen+rimsulfuron+prosulfuron+glyphosate; nipyraclofen+metolachlor+isoxaflutole+glyphosate; nipyraclofen+metolachlor+isoxaflutole+glyphosate+benoxacor; nipyraclofen+S-metolachlor+isoxaflutole+glyphosate; nipyraclofen+S-metolachlor+isoxaflutole+glyphosate+benoxacor; nipyraclofen+metolachlor+mesotrione+glyphosate; nipyraclofen+metolachlor+mesotrione+glyphosate+benoxacor; nipyraclofen+S-metolachlor+mesotrione+glyphosate; nipyraclofen+S-metolachlor+mesotrione+glyphosate+benoxacor; nipyraclofen+metolachlor+atrazine +glyphosate; nipyraclofen+metolachlor+atrazine+glyphosate+benoxacor; nipyraclofen +S-metolachlor+atrazine+glyphosate; nipyraclofen+S-metolachlor+atrazine+glyphosate+benoxacor; nipyraclofen+metolachlor+terbuthylazine+glyphosate; nipyraclofen+metolachlor+terbuthylazine+glyphosate+benoxacor; nipyraclofen+S-metolachlor+terbuthylazine+glyphosate; nipyraclofen+S-metolachlor+terbuthylazine+glyphosate+benoxacor; nipyraclofen+atrazine+nicosulfuron+glyphosate; nipyraclofen+atrazine+nicosulfuron+glyphosate+benoxacor; benzfendizone+prosulfuron+primisulfuron+glyphosate; benzfendizone+prosulfuron+dicamba+glyphosate; benzfendizone+primisulfuron+dicamba+glyphosate; benzfendizone+nicosulfuron+primisulfuron+glyphosate; benzfendizone+nicosulfuron+prosulfuron+glyphosate; benzfendizone+rimsulfuron+primisulfuron+glyphosate; benzfendizone+rimsulfuron+prosulfuron+glyphosate; benzfendizone+metolachlor+isoxaflutole+glyphosate; benzfendizone+metolachlor+isoxaflutole+glyphosate+benoxacor; benzfendizone+S-metolachlor+isoxaflutole+glyphosate; benzfendizone+S-metolachlor+isoxaflutole+glyphosate+benoxacor; benzfendizone+metolachlor+mesotrione+glyphosate; benzfendizone+metolachlor+mesotrione+glyphosate+benoxacor; benzfendizone+S-metolachlor+mesotrione+glyphosate; benzfendizone+S-metolachlor+mesotrione+glyphosate+benoxacor; benzfendizone+metolachlor+atrazine+glyphosate; benzfendizone+metolachlor+atrazine+glyphosate+benoxacor; benzfendizone+S-metolachlor+atrazine+glyphosate; benzfendizone+S-metolachlor+atrazine+glyphosate+benoxacor; benzfendizone+metolachlor+terbuthylazine+glyphosate; benzfendizone+metolachlor+terbuthylazine+glyphosate+benoxacor; benzfendizone+S-metolachlor+terbuthylazine+glyphosate; benzfendizone+S-metolachlor+terbuthylazine+glyphosate+benoxacor; benzfendizone+atrazine+nicosulfuron+glyphosate; benzfendizone+atrazine+nicosulfuron+glyphosate+benoxacor; thidiazimin +prosulfuron+primisulfuron+glyphosate; thidiazimin+prosulfuron+dicamba+glyphosate; thidiazimin+primisulfuron+dicamba+glyphosate; thidiazimin+nicosulfuron+primisulfuron+glyphosate; thidiazimin+nicosulfuron+prosulfuron+glyphosate; thidiazimin+rimsulfuron+primisulfuron+glyphosate; thidiazimin+rimsulfuron+prosulfuron+glyphosate; thidiazimin+metolachlor+isoxaflutole+glyphosate; thidiazimin +metolachlor+isoxaflutole+glyphosate+benoxacor; thidiazimin+S-metolachlor+isoxaflutole+glyphosate; thidiazimin+S-metolachlor+isoxaflutole+glyphosate+benoxacor; thidiazimin+metolachlor+mesotrione+glyphosate; thidiazimin+metolachlor+mesotrione+glyphosate+benoxacor; thidiazimin+S-metolachlor+mesotrione+glyphosate; thidiazimin+S-metolachlor+mesotrione+glyphosate+benoxacor; thidiazimin +metolachlor+atrazine+glyphosate; thidiazimin+metolachlor+atrazine+glyphosate+benoxacor; thidiazimin+S-metolachlor+atrazine+glyphosate; thidiazimin+S-metolachlor +atrazine+glyphosate+benoxacor; thidiazimin+metolachlor+terbuthylazine+glyphosate; thidiazimin+metolachlor+terbuthylazine+glyphosate+benoxacor; thidiazimin+S-metolachlor+terbuthylazine+glyphosate; thidiazimin+S-metolachlor+terbuthylazine+glyphosate+benoxacor; thidiazimin+atrazine+nicosulfuron+glyphosate; and thidiazimin+atrazine+nicosulfuron+glyphosate+benoxacor.

Acifluorfen+metolachlor+isoxaflutole+glyphosate+MON 4660; acifluorfen+S-metolachlor+isoxaflutole+glyphosate+MON 4660; acifluorfen+metolachlor+mesotrione+glyphosate+MON 4660; acifluorfen+S-metolachlor+mesotrione+glyphosate+MON 4660; acifluorfen+metolachlor+atrazine+glyphosate+MON 4660; acifluorfen+S-metolachlor+atrazine+glyphosate+MON 4660; acifluorfen+metolachlor +terbuthylazine+glyphosate+MON 4660; acifluorfen+S-metolachlor+terbuthylazine+glyphosate+MON 4660; acifluorfen+atrazine+nicosulfuron+glyphosate+MON 4660; aclonifen+metolachlor+isoxaflutole+glyphosate+MON 4660; aclonifen+S-metolachlor +isoxaflutole+glyphosate+MON 4660; aclonifen+metolachlor+mesotrione+glyphosate+MON 4660; aclonifen+S-metolachlor+mesotrione+glyphosate+MON 4660; aclonifen+metolachlor+atrazine+glyphosate+MON 4660; aclonifen+S-metolachlor+atrazine+glyphosate+MON 4660; aclonifen+metolachlor+terbuthylazine +glyphosate+MON 4660; aclonifen+S-metolachlor+terbuthylazine+glyphosate+MON 4660; aclonifen+atrazine+nicosulfuron+glyphosate+MON 4660; bifenox+metolachlor +isoxaflutole+glyphosate+MON 4660; bifenox+S-metolachlor+isoxaflutole+glyphosate+MON 4660; bifenox+metolachlor+mesotrione+glyphosate+MON 4660; bifenox+S-metolachlor+mesotrione+glyphosate+MON 4660; bifenox+metolachlor+atrazine+glyphosate+MON 4660; bifenox+S-metolachlor+atrazine+glyphosate+MON 4660; bifenox+metolachlor+terbuthylazine+glyphosate+MON 4660; bifenox+S-metolachlor+terbuthylazine+glyphosate+MON 4660; bifenox+atrazine+nicosulfuron+glyphosate+MON 4660; chlomitrofen+metolachlor+isoxaflutole+glyphosate+MON 4660; chlomitrofen+S-metolachlor+isoxaflutole+glyphosate+MON 4660; chlomitrofen+metolachlor+mesotrione+glyphosate+MON 4660; chlomitrofen+S-metolachlor+mesotrione+glyphosate+MON 4660; chlomitrofen+metolachlor+atrazine+glyphosate +MON 4660; chlomitrofen+S-metolachlor+atrazine+glyphosate+MON 4660; chlomitrofen+metolachlor+terbuthylazine+glyphosate+MON 4660; chlomitrofen+S-metolachlor+terbuthylazine+glyphosate+MON 4660; chlomitrofen+atrazine+nicosulfuron+glyphosate+MON 4660; ethoxyfen+metolachlor+isoxaflutole+glyphosate+MON 4660; ethoxyfen+S-metolachlor+isoxaflutole+glyphosate+MON 4660; ethoxyfen+metolachlor+mesotrione+glyphosate+MON 4660; ethoxyfen+S-metolachlor+mesotrione+glyphosate+MON 4660; ethoxyfen+metolachlor+atrazine+glyphosate+MON 4660; ethoxyfen+S-metolachlor+atrazine+glyphosate+MON 4660; ethoxyfen+metolachlor+terbuthylazine+glyphosate+MON 4660; ethoxyfen+S-metolachlor+terbuthylazine+glyphosate+MON 4660; ethoxyfen+atrazine+nicosulfuron+glyphosate+MON 4660; fluoroglycofen+metolachlor+isoxaflutole+glyphosate+MON 4660; fluoroglycofen+S-metolachlor+isoxaflutole+glyphosate+MON 4660; fluoroglycofen+metolachlor+mesotrione+glyphosate+MON 4660; fluoroglycofen +S-metolachlor+mesotrione+glyphosate+MON 4660; fluoroglycofen+metolachlor+atrazine+glyphosate+MON 4660; fluoroglycofen+S-metolachlor+atrazine+glyphosate +MON 4660; fluoroglycofen+metolachlor+terbuthylazine+glyphosate+MON 4660; fluoroglycofen+S-metolachlor+terbuthylazine+glyphosate+MON 4660; fluoroglycofen+atrazine+nicosulfuron+glyphosate+MON 4660; fomesafen+metolachlor+isoxaflutole +glyphosate+MON 4660; fomesafen+S-metolachlor+isoxaflutole+glyphosate+MON 4660; fomesafen+metolachlor+mesotrione+glyphosate+MON 4660; fomesafen+S-metolachlor+mesotrione+glyphosate+MON 4660; fomesafen+metolachlor+atrazine+glyphosate+MON 4660; fomesafen+S-metolachlor+atrazine+glyphosate+MON 4660; fomesafen+metolachlor+terbuthylazine+glyphosate+MON 4660; fomesafen+S-metolachlor+terbuthylazine+glyphosate+MON 4660; fomesafen+atrazine+nicosulfuron+glyphosate+MON 4660; lactofen+metolachlor+isoxaflutole+glyphosate +MON 4660; lactofen+S-metolachlor+isoxaflutole+glyphosate+MON 4660; lactofen+metolachlor+mesotrione+glyphosate+MON 4660; lactofen+S-metolachlor+mesotrione +glyphosate+MON 4660; lactofen+metolachlor+atrazine+glyphosate+MON 4660; +lactofen+S-metolachlor+atrazine+MON 4660; lactofen+metolachlor+terbuthylazine+glyphosate+MON 4660; lactofen+S-metolachlor+terbuthylazine+glyphosate+MON 4660; lactofen+atrazine+nicosulfuron+glyphosate+MON 4660; oxyfluorfen+metolachlor+isoxaflutole+glyphosate+MON 4660; oxyfluorfen+S-metolachlor or+isoxaflutole+glyphosate+MON 4660; oxyfluorfen+metolachlor+mesotrione+glyphosate+MON 4660; oxyfluorfen+S-metolachlor+mesotrione+glyphosate+MON 4660; oxyfluorfen+metolachlor+atrazine+glyphosate+MON 4660; oxyfluorfen+S-metolachlor+atrazine+glyphosate+MON 4660; oxyfluorfen+metolachlor+terbuthylazine+glyphosate+MON 4660; oxyfluorfen+S-metolachlor+terbuthylazine+glyphosate+MON 4660; oxyfluorfen+atrazine+nicosulfuron+glyphosate+MON 4660; azafenidin+metolachlor+isoxaflutole+glyphosate+MON 4660; azafenidin+S-metolachlor+isoxaflutole+glyphosate+MON 4660; azafenidin+metolachlor+mesotrione+glyphosate+MON 4660; azafenidin+S-metolachlor+mesotrione+glyphosate+MON 4660; azafenidin+metolachlor+atrazine+glyphosate+MON 4660; azafenidin+S-metolachlor+atrazine+glyphosate+MON 4660; azafenidin+metolachlor +terbuthylazine+glyphosate+MON 4660; azafenidin+S-metolachlor+terbuthylazine+glyphosate+MON 4660; azafenidin+atrazine+nicosulfuron+glyphosate+MON 4660; carfentrazone-ethyl+metolachlor+isoxaflutole+glyphosate+MON 4660; carfentrazone-ethyl+S-metolachlor+isoxaflutole+glyphosate+MON 4660; carfentrazone-ethyl+metolachlor+mesotrione+glyphosate+MON 4660; carfentrazone-ethyl+S-metolachlor+mesotrione+glyphosate+MON 4660; carfentrazone-ethyl+metolachlor+atrazine+glyphosate+MON 4660; carfentrazone-ethyl+S-metolachlor+atrazine+glyphosate+MON 4660; carfentrazone-ethyl+metolachlor+terbuthylazine+glyphosate+MON 4660; carfentrazone-ethyl+S-metolachlor+terbuthylazine+glyphosate+MON 4660; carfentrazone-ethyl+atrazine+nicosulfuron+glyphosate+MON 4660; compound of the formula A+metolachlor+isoxaflutole+glyphosate+MON 4660; compound of the formula A+S-metolachlor+isoxaflutole+glyphosate+MON 4660; compound of the formula A+metolachlor+mesotrione+glyphosate+MON 4660; compound of the formula A+S-metolachlor+mesotrione+glyphosate+MON 4660; compound of the formula A+metolachlor+atrazine+glyphosate+MON 4660; compound of the formula A+S-metolachlor+atrazine+glyphosate+MON 4660; compound of the formula A+metolachlor +terbuthylazine+glyphosate+MON 4660; compound of the formula A+S-metolachlor+terbuthylazine+glyphosate+MON 4660; compound of the formula A+atrazine+nicosulfuron+glyphosate+MON 4660; cinidon-ethyl+metolachlor+isoxaflutole+glyphosate+MON 4660; cinidon-ethyl+S-metolachlor+isoxaflutole+glyphosate+MON 4660; cinidon-ethyl+metolachlor+mesotrione+glyphosate+MON 4660; cinidon-ethyl+S-metolachlor+mesotrione+glyphosate+MON 4660; cinidon-ethyl+metolachlor+atrazine+glyphosate+MON 4660; cinidon-ethyl+S-metolachlor+atrazine+glyphosate+MON 4660; cinidon-ethyl+metolachlor+terbuthylazine+glyphosate+MON 4660; cinidon-ethyl+S-metolachlor+terbuthylazine+glyphosate+MON 4660; cinidon-ethyl+atrazine+nicosulfuron+glyphosate+MON 4660; flumiclorac-pentyl+metolachlor+isoxaflutole+glyphosate+MON 4660; flumiclorac-pentyl+S-metolachlor+isoxaflutole+glyphosate+MON 4660; flumiclorac-pentyl+metolachlor+mesotrione+glyphosate+MON 4660; flumiclorac-pentyl+S-metolachlor+mesotrione+glyphosate+MON 4660; flumiclorac-pentyl+metolachlor+atrazine+glyphosate+MON 4660; flumiclorac-pentyl+S-metolachlor+atrazine+glyphosate+MON 4660; flumiclorac-pentyl+metolachlor+terbuthylazine+glyphosate+MON 4660; flumiclorac-pentyl+S-metolachlor+terbuthylazine+glyphosate+MON 4660; flumiclorac-pentyl+atrazine+nicosulfuron+glyphosate+MON 4660; flumioxazin+metolachlor+isoxaflutole+glyphosate+MON 4660; flumioxazin+S-metolachlor+isoxaflutole+glyphosate+MON 4660; flumioxazin+metolachlor+mesotrione+glyphosate+MON 4660; flumioxazin+S-metolachlor+mesotrione+glyphosate+MON 4660; flumioxazin+metolachlor+atrazine+glyphosate+MON 4660; flumioxazin+S-metolachlor+atrazine+glyphosate+MON 4660; flumioxazin+metolachlor+terbuthylazine+glyphosate+MON 4660; flumioxazin+S-metolachlor+terbuthylazine+glyphosate+MON 4660; flumioxazin+atrazine+nicosulfuron+glyphosate+MON 4660; fluthiacet-methyl+metolachlor+isoxaflutole+glyphosate+MON 4660; fluthiacet-methyl+S-metolachlor+isoxaflutole+glyphosate+MON 4660; fluthiacet-methyl+metolachlor+mesotrione+glyphosate+MON 4660; fluthiacet-methyl+S-metolachlor+mesotrione+glyphosate+MON 4660; fluthiacet-methyl+metolachlor+atrazine+glyphosate+MON 4660; fluthiacet-methyl+S-metolachlor+atrazine+glyphosate+MON 4660; fluthiacet-methyl+metolachlor+terbuthylazine+glyphosate+MON 4660; fluthiacet-methyl+S-metolachlor+terbuthylazine+glyphosate+MON 4660; fluthiacet-methyl+atrazine+nicosulfuron+glyphosate+MON 4660; oxadiargyl+metolachlor+isoxaflutole+glyphosate+MON 4660; oxadiargyl+S-metolachlor+isoxaflutole+glyphosate+MON 4660; oxadiargyl+metolachlor+mesotrione+glyphosate +MON 4660; oxadiargyl+S-metolachlor+mesotrione+glyphosate+MON 4660; oxadiargyl+metolachlor+atrazine+glyphosate+MON 4660; oxadiargyl+S-metolachlor+atrazine+glyphosate+MON 4660; oxadiargyl+metolachlor+terbuthylazine+glyphosate +MON 4660; oxadiargyl+S-metolachlor+terbuthylazine+glyphosate+MON 4660; oxadiargyl+atrazine+nicosulfuron+glyphosate+MON 4660; oxadiazon+metolachlor+isoxaflutole+glyphosate+MON 4660; oxadiazon+S-metolachlor+isoxaflutole+glyphosate+MON 4660; oxadiazon+metolachlor+mesotrione+glyphosate+MON 4660; oxadiazon+S-metolachlor+mesotrione+glyphosate+MON 4660; oxadiazon+metolachlor+atrazine+glyphosate+MON 4660; oxadiazon+S-metolachlor+atrazine+glyphosate+MON 4660; oxadiazon+metolachlor+terbuthylazine+glyphosate+MON 4660; oxadiazon+S-metolachlor+terbuthylazine+glyphosate+MON 4660; oxadiazon+atrazine+nicosulfuron+glyphosate+MON 4660; pentoxazone+metolachlor+isoxaflutole+glyphosate+MON 4660; pentoxazone+S-metolachlor+isoxaflutole+glyphosate+MON 4660; pentoxazone+metolachlor+mesotrione+glyphosate+MON 4660; pentoxazone+S-metolachlor+mesotrione+glyphosate+MON 4660; pentoxazone +metolachlor+atrazine+glyphosate+MON 4660; pentoxazone+S-metolachlor+atrazine+glyphosate+MON 4660; pentoxazone+metolachlor+terbuthylazine+glyphosate+MON 4660; pentoxazone+S-metolachlor+terbuthylazine+glyphosate+MON 4660; pentoxazone+atrazine+nicosulfuron+glyphosate+MON 4660; sulfentrazone+metolachlor+isoxaflutole+glyphosate+MON 4660; sulfentrazone+S-metolachlor+isoxaflutole+glyphosate+MON 4660; sulfentrazone+metolachlor+mesotrione+glyphosate+MON 4660; sulfentrazone+S-metolachlor+mesotrione+glyphosate+MON 4660; sulfentrazone+metolachlor+atrazine+glyphosate+MON 4660; sulfentrazone+S-metolachlor+atrazine+glyphosate+MON 4660; sulfentrazone+metolachlor+terbuthylazine+glyphosate+MON 4660; sulfentrazone+S-metolachlor+terbuthylazine+glyphosate+MON 4660; sulfentrazone+atrazine+nicosulfuron+glyphosate+MON 4660; fluazolate+metolachlor+isoxaflutole+glyphosate+MON 4660; fluazolate+S-metolachlor+isoxaflutole+glyphosate+MON 4660; fluazolate+metolachlor+mesotrione+glyphosate+MON 4660; fluazolate+S-metolachlor+mesotrione+glyphosate+MON 4660; fluazolate+metolachlor+atrazine+glyphosate+MON 4660; fluazolate+S-metolachlor+atrazine+glyphosate+MON 4660; fluazolate+metolachlor+terbuthylazine+glyphosate+MON 4660; fluazolate+S-metolachlor+terbuthylazine+glyphosate+MON 4660; fluazolate+atrazine+nicosulfuron+glyphosate +MON 4660; pyraflufen-ethyl+metolachlor+isoxaflutole+glyphosate+MON 4660; pyraflufen-ethyl+S-metolachlor+isoxaflutole+glyphosate+MON 4660; pyraflufen-ethyl+metolachlor+mesotrione+glyphosate+MON 4660; pyraflufen-ethyl+S-metolachlor+mesotrione+glyphosate+MON 4660; pyraflufen-ethyl+metolachlor+atrazine+glyphosate+MON 4660; pyraflufen-ethyl+S-metolachlor+atrazine+glyphosate+MON 4660; pyraflufen-ethyl+metolachlor+terbuthylazine+glyphosate+MON 4660; pyraflufen-ethyl+S-metolachlor+terbuthylazine+glyphosate+MON 4660; pyraflufen-ethyl+atrazine+nicosulfuron+glyphosate+MON 4660; flumipropyn+metolachlor+isoxaflutole +glyphosate+MON 4660; flumipropyn+S-metolachlor+isoxaflutole+glyphosate+MON 4660; flumipropyn+metolachlor+mesotrione+glyphosate+MON 4660; flumipropyn+S-metolachlor+mesotrione+glyphosate+MON 4660; flumipropyn+metolachlor+atrazine +glyphosate+MON 4660; flumipropyn+S-metolachlor+atrazine+glyphosate+MON 4660; flumipropyn+metolachlor+terbuthylazine+glyphosate+MON 4660; flumipropyn+S-metolachlor+terbuthylazine+glyphosate+MON 4660; flumipropyn+atrazine+nicosulfuron+glyphosate+MON 4660; flupropacil+metolachlor+isoxaflutole+glyphosate+MON 4660; flupropacil+S-metolachlor+isoxaflutole+glyphosate+MON 4660; flupropacil+metolachlor+mesotrione+glyphosate+MON 4660; flupropacil+S-metolachlor+mesotrione+glyphosate+MON 4660; flupropacil+metolachlor+atrazine+glyphosate+MON 4660; flupropacil+S-metolachlor+atrazine+glyphosate+MON 4660; flupropacil+metolachlor+terbuthylazine+glyphosate+MON 4660; flupropacil+S-metolachlor+terbuthylazine+glyphosate+MON 4660; flupropacil+atrazine+nicosulfuron+glyphosate+MON 4660; nipyraclofen+metolachlor+isoxaflutole+glyphosate+MON 4660; nipyraclofen+S-metolachlor+isoxaflutole+glyphosate+MON 4660; nipyraclofen+metolachlor+mesotrione+glyphosate+MON 4660; nipyraclofen+S-metolachlor+mesotrione+glyphosate+MON 4660; nipyraclofen+metolachlor+atrazine +glyphosate+MON 4660; nipyraclofen+S-metolachlor+atrazine+glyphosate+MON 4660; nipyraclofen+metolachlor+terbuthylazine+glyphosate+MON 4660; nipyraclofen+S-metolachlor+terbuthylazine+glyphosate+MON 4660; nipyraclofen+atrazine+nicosulfuron+glyphosate+MON 4660; benzfendizone+metolachlor+isoxaflutole+glyphosate+MON 4660; benzfendizone+S-metolachlor+isoxaflutole+glyphosate+MON 4660; benzfendizone+metolachlor+mesotrione+glyphosate+MON 4660; benzfendizone+S-metolachlor+mesotrione+glyphosate+MON 4660; benzfendizone+metolachlor+atrazine+glyphosate+MON 4660; benzfendizone+S-metolachlor+atrazine+glyphosate+MON 4660; benzfendizone+metolachlor+terbuthylazine+glyphosate+MON 4660; benzfendizone+S-metolachlor+terbuthylazine+glyphosate+MON 4660; benzfendizone+atrazine+nicosulfuron+glyphosate+MON 4660; thidiazimin +metolachlor+isoxaflutole+glyphosate+MON 4660; thidiazimin+S-metolachlor+isoxaflutole+glyphosate+MON 4660; thidiazimin+metolachlor+mesotrione+glyphosate +MON 4660; thidiazimin+S-metolachlor+mesotrione+glyphosate+MON 4660; thidiazimin+metolachlor+atrazine+glyphosate+MON 4660; thidiazimin+S-metolachlor +atrazine+glyphosate+MON 4660; thidiazimin+metolachlor+terbuthylazine+glyphosate+MON 4660; thidiazimin+S-metolachlor+terbuthylazine+glyphosate+MON 4660; and thidiazimin+atrazine+nicosulfuron+glyphosate+MON 4660.

Acifluorfen+metolachlor+isoxaflutole+glyphosate+FLURAZOLE; acifluorfen+S-metolachlor+isoxaflutole+glyphosate+FLURAZOLE; acifluorfen+metolachlor+mesotrione+glyphosate+FLURAZOLE; acifluorfen+S-metolachlor+mesotrione+glyphosate+FLURAZOLE; acifluorfen+metolachlor+atrazine+glyphosate+FLURAZOLE; acifluorfen+S-metolachlor+atrazine+glyphosate+FLURAZOLE; acifluorfen+metolachlor+terbuthylazine+glyphosate+FLURAZOLE; acifluorfen+S-metolachlor+terbuthylazine+glyphosate+FLURAZOLE; acifluorfen+atrazine+nicosulfuron+glyphosate+FLURAZOLE; aclonifen+metolachlor+isoxaflutole+glyphosate+FLURAZOLE; aclonifen+S-metolachlor+isoxaflutole+glyphosate+FLURAZOLE; aclonifen+metolachlor+mesotrione+glyphosate+FLURAZOLE; aclonifen +S-metolachlor+mesotrione+glyphosate+FLURAZOLE; aclonifen+metolachlor+atrazine+glyphosate+FLURAZOLE; aclonifen+S-metolachlor+atrazine+glyphosate+FLURAZOLE; aclonifen+metolachlor+terbuthylazine+glyphosate+FLURAZOLE; aclonifen+S-metolachlor+terbuthylazine+glyphosate+FLURAZOLE; aclonifen+atrazine+nicosulfuron+glyphosate+FLURAZOLE; bifenox+metolachlor+isoxaflutole+glyphosate+FLURAZOLE; bifenox+S-metolachlor+isoxaflutole+glyphosate+FLURAZOLE; bifenox+metolachlor+mesotrione+glyphosate+FLURAZOLE; bifenox+S-metolachlor+mesotrione+glyphosate+FLURAZOLE; bifenox+metolachlor+atrazine +glyphosate+FLURAZOLE; bifenox+S-metolachlor+atrazine+glyphosate+FLURAZOLE; bifenox+metolachlor+terbuthylazine+glyphosate+FLURAZOLE; bifenox +S-metolachlor+terbuthylazine+glyphosate+FLURAZOLE; bifenox+atrazine+nicosulfuron+glyphosate+FLURAZOLE; chlomitrofen+metolachlor+isoxaflutole+glyphosate+FLURAZOLE; chlomitrofen+S-metolachlor+isoxaflutole+glyphosate+FLURAZOLE; chlomitrofen+metolachlor+mesotrione+glyphosate+FLURAZOLE; chlomitrofen+S-metolachlor+mesotrione+glyphosate+FLURAZOLE; chlomitrofen+metolachlor+atrazine+glyphosate+FLURAZOLE; chlomitrofen+S-metolachlor+atrazine+glyphosate+FLURAZOLE; chlomitrofen+metolachlor+terbuthylazine+glyphosate+FLURAZOLE; chlomitrofen+S-metolachlor+terbuthylazine+glyphosate+FLURAZOLE; chlomitrofen+atrazine+nicosulfuron+glyphosate+FLURAZOLE; ethoxyfen+metolachlor+isoxaflutole+glyphosate+FLURAZOLE; ethoxyfen+S-metolachlor+isoxaflutole+glyphosate+FLURAZOLE; ethoxyfen+metolachlor+mesotrione+glyphosate+FLURAZOLE; ethoxyfen+S-metolachlor+mesotrione+glyphosate+FLURAZOLE; ethoxyfen+metolachlor+atrazine+glyphosate+FLURAZOLE; ethoxyfen+S-metolachlor+atrazine+glyphosate+FLURAZOLE; ethoxyfen +metolachlor+terbuthylazine+glyphosate+FLURAZOLE; ethoxyfen+S-metolachlor+terbuthylazine+glyphosate+FLURAZOLE; ethoxyfen+atrazine+nicosulfuron+glyphosate+FLURAZOLE; fluoroglycofen+metolachlor+isoxaflutole+glyphosate+FLURAZOLE; fluoroglycofen+S-metolachlor+isoxaflutole+glyphosate+FLURAZOLE; fluoroglycofen+metolachlor+mesotrione+glyphosate+FLURAZOLE; fluoroglycofen+S-metolachlor+mesotrione+glyphosate+FLURAZOLE; fluoroglycofen+metolachlor+atrazine+glyphosate+FLURAZOLE; fluoroglycofen+S-metolachlor+atrazine+glyphosate+FLURAZOLE; fluoroglycofen+metolachlor+terbuthylazine+glyphosate+FLURAZOLE; fluoroglycofen+S-metolachlor+terbuthylazine+glyphosate+FLURAZOLE; fluoroglycofen+atrazine+nicosulfuron+glyphosate+FLURAZOLE; fomesafen+metolachlor+isoxaflutole+glyphosate+FLURAZOLE; fomesafen+S-metolachlor+isoxaflutole+glyphosate+FLURAZOLE; fomesafen+metolachlor+mesotrione+glyphosate+FLURAZOLE; fomesafen+S-metolachlor+mesotrione+glyphosate+FLURAZOLE; fomesafen+metolachlor+atrazine+glyphosate+FLURAZOLE; fomesafen +S-metolachlor+atrazine+glyphosate+FLURAZOLE; fomesafen+metolachlor+terbuthylazine+glyphosate+FLURAZOLE; fomesafen+S-metolachlor+terbuthylazine+glyphosate+FLURAZOLE; fomesafen+atrazine+nicosulfuron+glyphosate+FLURAZOLE; lactofen+metolachlor+isoxaflutole+glyphosate+FLURAZOLE; lactofen+S-metolachlor+isoxaflutole+glyphosate+FLURAZOLE; lactofen+metolachlor+mesotrione+glyphosate+FLURAZOLE; lactofen+S-metolachlor+mesotrione+glyphosate+FLURAZOLE; lactofen+metolachlor+atrazine+glyphosate+FLURAZOLE; lactofen+S-metolachlor+atrazine+glyphosate+FLURAZOLE; lactofen+metolachlor+terbuthylazine+glyphosate+FLURAZOLE; lactofen+S-metolachlor+terbuthylazine+glyphosate+FLURAZOLE; lactofen+atrazine+nicosulfuron+glyphosate+FLURAZOLE; oxyfluorfen+metolachlor+isoxaflutole+glyphosate+FLURAZOLE; oxyfluorfen+S-metolachlor+isoxaflutole+glyphosate+FLURAZOLE; oxyfluorfen+metolachlor+mesotrione+glyphosate+FLURAZOLE; oxyfluorfen+S-metolachlor+mesotrione+glyphosate+FLURAZOLE; oxyfluorfen+metolachlor+atrazine+glyphosate+FLURAZOLE; oxyfluorfen+S-metolachlor+atrazine+glyphosate+FLURAZOLE; oxyfluorfen+metolachlor+terbuthylazine+glyphosate+FLURAZOLE; oxyfluorfen+S-metolachlor+terbuthylazine+glyphosate+FLURAZOLE; oxyfluorfen+atrazine+nicosulfuron+glyphosate+FLURAZOLE; azafenidin+metolachlor+isoxaflutole+glyphosate+FLURAZOLE; azafenidin+S-metolachlor+isoxaflutole+glyphosate+FLURAZOLE; azafenidin+metolachlor+mesotrione+glyphosate+FLURAZOLE; azafenidin+S-metolachlor+mesotrione+glyphosate+FLURAZOLE; azafenidin+metolachlor+atrazine+glyphosate+FLURAZOLE; azafenidin+S-metolachlor+atrazine +glyphosate+FLURAZOLE; azafenidin+metolachlor+terbuthylazine+glyphosate+FLURAZOLE; azafenidin+S-metolachlor+terbuthylazine+glyphosate+FLURAZOLE; azafenidin+atrazine+nicosulfuron+glyphosate+FLURAZOLE; carfentrazone-ethyl+metolachlor+isoxaflutole+glyphosate+FLURAZOLE; carfentrazone-ethyl+S-metolachlor +isoxaflutole+glyphosate+FLURAZOLE; carfentrazone-ethyl+metolachlor+mesotrione +glyphosate+FLURAZOLE; carfentrazone-ethyl+S-metolachlor+mesotrione+glyphosate+FLURAZOLE; carfentrazone-ethyl+metolachlor+atrazine+glyphosate+FLURAZOLE; carfentrazone-ethyl+S-metolachlor+atrazine+glyphosate+FLURAZOLE; carfentrazone-ethyl+metolachlor+terbuthylazine+glyphosate+FLURAZOLE; carfentrazone-ethyl+S-metolachlor+terbuthylazine+glyphosate+FLURAZOLE; carfentrazone-ethyl+atrazine+nicosulfuron+glyphosate+FLURAZOLE; compound of the formula A+metolachlor+isoxaflutole+glyphosate+FLURAZOLE; compound of the formula A+S-metolachlor+isoxaflutole+glyphosate+FLURAZOLE; compound of the formula A+metolachlor+mesotrione+glyphosate+FLURAZOLE; compound of the formula A+S-metolachlor+mesotrione+glyphosate+FLURAZOLE; compound of the formula A+metolachlor+atrazine+glyphosate+FLURAZOLE; compound of the formula A+S-metolachlor+atrazine+glyphosate+FLURAZOLE; compound of the formula A+metolachlor+terbuthylazine+glyphosate+FLURAZOLE; compound of the formula A+S-metolachlor+terbuthylazine+glyphosate+FLURAZOLE; compound of the formula A+atrazine+nicosulfuron+glyphosate+FLURAZOLE; cinidon-ethyl+metolachlor+isoxaflutole+glyphosate+FLURAZOLE; cinidon-ethyl+S-metolachlor+isoxaflutole+glyphosate+FLURAZOLE; cinidon-ethyl+metolachlor+mesotrione+glyphosate+FLURAZOLE; cinidon-ethyl+S-metolachlor+mesotrione+glyphosate+FLURAZOLE; cinidon-ethyl+metolachlor+atrazine+glyphosate+FLURAZOLE; cinidon-ethyl+S-metolachlor+atrazine+glyphosate+FLURAZOLE; cinidon-ethyl+metolachlor+terbuthylazine+glyphosate+FLURAZOLE; cinidon-ethyl+S-metolachlor+terbuthylazine +glyphosate+FLURAZOLE; cinidon-ethyl+atrazine+nicosulfuron+glyphosate+FLURAZOLE; flumiclorac-pentyl+metolachlor+isoxaflutole+glyphosate+FLURAZOLE; flumiclorac-pentyl+S-metolachlor+isoxaflutole+glyphosate+FLURAZOLE; flumiclorac-pentyl+metolachlor+mesotrione+glyphosate+FLURAZOLE; flumiclorac-pentyl+S-metolachlor+mesotrione+glyphosate+FLURAZOLE; flumiclorac-pentyl+metolachlor+atrazine+glyphosate+FLURAZOLE; flumiclorac-pentyl+S-metolachlor+atrazine+glyphosate+FLURAZOLE; flumiclorac-pentyl+metolachlor+terbuthylazine+glyphosate+FLURAZOLE; flumiclorac-pentyl+S-metolachlor+terbuthylazine+glyphosate+FLURAZOLE; flumiclorac-pentyl+atrazine+nicosulfuron+glyphosate+FLURAZOLE; flumioxazin+metolachlor+isoxaflutole+glyphosate+FLURAZOLE; flumioxazin+S-metolachlor+isoxaflutole+glyphosate+FLURAZOLE; flumioxazin+metolachlor+mesotrione+glyphosate+FLURAZOLE; flumioxazin+S-metolachlor+mesotrione+glyphosate+FLURAZOLE; flumioxazin+metolachlor+atrazine+glyphosate+FLURAZOLE; flumioxazin+S-metolachlor+atrazine+glyphosate+FLURAZOLE; flumioxazin+metolachlor+terbuthylazine+glyphosate+FLURAZOLE; flumioxazin+S-metolachlor+terbuthylazine+glyphosate+FLURAZOLE; flumioxazin+atrazine+nicosulfuron+glyphosate+FLURAZOLE; fluthiacet-methyl+metolachlor+isoxaflutole+glyphosate+FLURAZOLE; fluthiacet-methyl+S-metolachlor+isoxaflutole+glyphosate+FLURAZOLE; fluthiacet-methyl+metolachlor+mesotrione+glyphosate+FLURAZOLE; fluthiacet-methyl+S-metolachlor+mesotrione+glyphosate+FLURAZOLE; fluthiacet-methyl+metolachlor+atrazine+glyphosate+FLURAZOLE; fluthiacet-methyl+S-metolachlor+atrazine+glyphosate+FLURAZOLE; fluthiacet-methyl+metolachlor+terbuthylazine+glyphosate+FLURAZOLE; fluthiacet-methyl+S-metolachlor+terbuthylazine+glyphosate+FLURAZOLE; fluthiacet-methyl+atrazine+nicosulfuron+glyphosate+FLURAZOLE; oxadiargyl+metolachlor+isoxaflutole+glyphosate+FLURAZOLE; oxadiargyl+S-metolachlor+isoxaflutole+glyphosate+FLURAZOLE; oxadiargyl+metolachlor+mesotrione+glyphosate+FLURAZOLE; oxadiargyl+S-metolachlor+mesotrione+glyphosate+FLURAZOLE; oxadiargyl+metolachlor+atrazine +glyphosate+FLURAZOLE; oxadiargyl+S-metolachlor+atrazine+glyphosate+FLURAZOLE; oxadiargyl+metolachlor+terbuthylazine+glyphosate+FLURAZOLE; oxadiargyl+S-metolachlor+terbuthylazine+glyphosate+FLURAZOLE; oxadiargyl+atrazine+nicosulfuron+glyphosate+FLURAZOLE; oxadiazon+metolachlor+isoxaflutole+glyphosate+FLURAZOLE; oxadiazon+S-metolachlor+isoxaflutole+glyphosate+FLURAZOLE; oxadiazon+metolachlor+mesotrione+glyphosate+FLURAZOLE; oxadiazon+S-metolachlor+mesotrione+glyphosate+FLURAZOLE; oxadiazon+metolachlor+atrazine+glyphosate+FLURAZOLE; oxadiazon+S-metolachlor+atrazine+glyphosate+FLURAZOLE; oxadiazon+metolachlor+terbuthylazine+glyphosate+FLURAZOLE; oxadiazon+S-metolachlor+terbuthylazine+glyphosate+FLURAZOLE; oxadiazon+atrazine+nicosulfuron+glyphosate+FLURAZOLE; pentoxazone+metolachlor+isoxaflutole+glyphosate+FLURAZOLE; pentoxazone+S-metolachlor+isoxaflutole+glyphosate+FLURAZOLE; pentoxazone+metolachlor+mesotrione+glyphosate+FLURAZOLE; pentoxazone+S-metolachlor+mesotrione+glyphosate+FLURAZOLE; pentoxazone+metolachlor+atrazine+glyphosate+FLURAZOLE; pentoxazone+S-metolachlor+atrazine+glyphosate+FLURAZOLE; pentoxazone+metolachlor+terbuthylazine+glyphosate+FLURAZOLE; pentoxazone+S-metolachlor+terbuthylazine+glyphosate+FLURAZOLE; pentoxazone+atrazine+nicosulfuron+glyphosate+FLURAZOLE; sulfentrazone+metolachlor+isoxaflutole+glyphosate+FLURAZOLE; sulfentrazone+S-metolachlor+isoxaflutole+glyphosate+FLURAZOLE; sulfentrazone+metolachlor+mesotrione+glyphosate+FLURAZOLE; sulfentrazone+S-metolachlor+mesotrione+glyphosate+FLURAZOLE; sulfentrazone+metolachlor+atrazine+glyphosate+FLURAZOLE; sulfentrazone+S-metolachlor+atrazine+glyphosate+FLURAZOLE; sulfentrazone+metolachlor+terbuthylazine+glyphosate+FLURAZOLE; sulfentrazone+S-metolachlor+terbuthylazine +glyphosate+FLURAZOLE; sulfentrazone+atrazine+nicosulfuron+glyphosate+FLURAZOLE; fluazolate+metolachlor+isoxaflutole+glyphosate+FLURAZOLE; fluazolate+S-metolachlor+isoxaflutole+glyphosate+FLURAZOLE; fluazolate+metolachlor+mesotrione+glyphosate+FLURAZOLE; fluazolate+S-metolachlor+mesotrione+glyphosate+FLURAZOLE; fluazolate+metolachlor+atrazine+glyphosate+FLURAZOLE; fluazolate+S-metolachlor+atrazine+glyphosate+FLURAZOLE; fluazolate +metolachlor+terbuthylazine+glyphosate+FLURAZOLE; fluazolate+S-metolachlor+terbuthylazine+glyphosate+FLURAZOLE; fluazolate+atrazine+nicosulfuron+glyphosate+FLURAZOLE; pyraflufen-ethyl+metolachlor+isoxaflutole+glyphosate+FLURAZOLE; pyraflufen-ethyl+S-metolachlor+isoxaflutole+glyphosate+FLURAZOLE; pyraflufen-ethyl+metolachlor+mesotrione+glyphosate+FLURAZOLE; pyraflufen-ethyl+S-metolachlor+mesotrione+glyphosate+FLURAZOLE; pyraflufen-ethyl+metolachlor+atrazine+glyphosate+FLURAZOLE; pyraflufen-ethyl+S-metolachlor+atrazine+glyphosate+FLURAZOLE; pyraflufen-ethyl+metolachlor+terbuthylazine+glyphosate+FLURAZOLE; pyraflufen-ethyl+S-metolachlor+terbuthylazine+glyphosate+FLURAZOLE; pyraflufen-ethyl+atrazine+nicosulfuron+glyphosate+FLURAZOLE; flumipropyn+metolachlor+isoxaflutole+glyphosate+FLURAZOLE; flumipropyn+S-metolachlor+isoxaflutole+glyphosate+FLURAZOLE; flumipropyn+metolachlor+mesotrione+glyphosate+FLURAZOLE; flumipropyn+S-metolachlor+mesotrione+glyphosate+FLURAZOLE; flumipropyn+metolachlor+atrazine+glyphosate+FLURAZOLE; flumipropyn+S-metolachlor+atrazine+glyphosate+FLURAZOLE; flumipropyn+metolachlor+terbuthylazine+glyphosate+FLURAZOLE; flumipropyn+S-metolachlor+terbuthylazine+glyphosate+FLURAZOLE; flumipropyn+atrazine+nicosulfuron+glyphosate+FLURAZOLE; flupropacil+metolachlor+isoxaflutole+glyphosate+FLURAZOLE; flupropacil+S-metolachlor+isoxaflutole+glyphosate+FLURAZOLE; flupropacil+metolachlor+mesotrione+glyphosate+FLURAZOLE; flupropacil+S-metolachlor+mesotrione+glyphosate+FLURAZOLE; flupropacil+metolachlor+atrazine+glyphosate+FLURAZOLE; flupropacil+S-metolachlor+atrazine +glyphosate+FLURAZOLE; flupropacil+metolachlor+terbuthylazine+glyphosate+FLURAZOLE; flupropacil+S-metolachlor+terbuthylazine+glyphosate+FLURAZOLE; flupropacil+atrazine+nicosulfuron+glyphosate+FLURAZOLE; nipyraclofen+metolachlor+isoxaflutole+glyphosate+FLURAZOLE; nipyraclofen+S-metolachlor+isoxaflutole+glyphosate+FLURAZOLE; nipyraclofen+metolachlor+mesotrione+glyphosate+FLURAZOLE; nipyraclofen+S-metolachlor+mesotrione+glyphosate+FLURAZOLE; nipyraclofen+metolachlor+atrazine+glyphosate+FLURAZOLE; nipyraclofen+S-metolachlor+atrazine+glyphosate+FLURAZOLE; nipyraclofen+metolachlor+terbuthylazine+glyphosate+FLURAZOLE; nipyraclofen+S-metolachlor+terbuthylazine+glyphosate+FLURAZOLE; nipyraclofen+atrazine+nicosulfuron+glyphosate+FLURAZOLE; benzfendizone+metolachlor+isoxaflutole+glyphosate+FLURAZOLE; benzfendizone+S-metolachlor+isoxaflutole+glyphosate+FLURAZOLE; benzfendizone+metolachlor+mesotrione+glyphosate+FLURAZOLE; benzfendizone+S-metolachlor+mesotrione+glyphosate+FLURAZOLE; benzfendizone+metolachlor+atrazine+glyphosate+FLURAZOLE; benzfendizone+S-metolachlor+atrazine+glyphosate+FLURAZOLE; benzfendizone+metolachlor+terbuthylazine+glyphosate+FLURAZOLE; benzfendizone+S-metolachlor+terbuthylazine+glyphosate+FLURAZOLE; benzfendizone+atrazine+nicosulfuron+glyphosate+FLURAZOLE; thidiazimin+metolachlor+isoxaflutole+glyphosate+FLURAZOLE; thidiazimin+S-metolachlor+isoxaflutole+glyphosate+FLURAZOLE; thidiazimin+metolachlor+mesotrione+glyphosate+FLURAZOLE; thidiazimin+S-metolachlor+mesotrione+glyphosate+FLURAZOLE; thidiazimin+metolachlor+atrazine+glyphosate+FLURAZOLE; thidiazimin+S-metolachlor+atrazine+glyphosate+FLURAZOLE; thidiazimin+metolachlor+terbuthylazine+glyphosate+FLURAZOLE; thidiazimin+S-metolachlor+terbuthylazine+glyphosate+FLURAZOLE; and thidiazimin+atrazine+nicosulfuron+glyphosate+FLURAZOLE.

Acifluorfen+metolachlor+isoxaflutole+glyphosate+DICHLORMID; acifluorfen+S-metolachlor+isoxaflutole+glyphosate+DICHLORMID; acifluorfen+metolachlor+mesotrione+glyphosate+DICHLORMID; acifluorfen+S-metolachlor+mesotrione+glyphosate+DICHLORMID; acifluorfen+metolachlor+atrazine+glyphosate+DICHLORMID; acifluorfen+S-metolachlor+atrazine+glyphosate+DICHLORMID; acifluorfen+metolachlor+terbuthylazine+glyphosate+DICHLORMID; acifluorfen+S-metolachlor+terbuthylazine+glyphosate+DICHLORMID; acifluorfen+atrazine+nicosulfuron+glyphosate+DICHLORMID; aclonifen+metolachlor+isoxaflutole+glyphosate+DICHLORMID; aclonifen+S-metolachlor+isoxaflutole+glyphosate+DICHLORMID; aclonifen+metolachlor+mesotrione+glyphosate+DICHLORMID; aclonifen+S-metolachlor+mesotrione+DICHLORMID; aclonifen+metolachlor+atrazine +glyphosate+DICHLORMID; aclonifen+S-metolachlor+atrazine+glyphosate+DICHLORMID; aclonifen+metolachlor+terbuthylazine+glyphosate+DICHLORMID; aclonifen+S-metolachlor+terbuthylazine+glyphosate+DICHLORMID; aclonifen+atrazine+nicosulfuron+glyphosate+DICHLORMID; bifenox+metolachlor+isoxaflutole +glyphosate+DICHLORMID; bifenox+S-metolachlor+isoxaflutole+glyphosate+DICHLORMID; bifenox+metolachlor+mesotrione+glyphosate+DICHLORMID; bifenox+S-metolachlor+mesotrione+glyphosate+DICHLORMID; bifenox+metolachlor+atrazine +glyphosate+DICHLORMID; bifenox+S-metolachlor+atrazine+glyphosate+DICHLORMID; bifenox+metolachlor+terbuthylazine+glyphosate+DICHLORMID; bifenox+S-metolachlor+terbuthylazine+glyphosate+DICHLORMID; bifenox+atrazine+nicosulfuron+glyphosate+DICHLORMID; chlomitrofen+metolachlor+isoxaflutole+glyphosate+DICHLORMID; chlomitrofen+S-metolachlor+isoxaflutole+glyphosate+DICHLORMID; chlomitrofen+metolachlor+mesotrione+glyphosate+DICHLORMID; chlomitrofen+S-metolachlor+mesotrione+glyphosate+DICHLORMID; chlomitrofen+metolachlor+atrazine+glyphosate+DICHLORMID; chlomitrofen+S-metolachlor+atrazine+glyphosate+DICHLORMID; chlomitrofen+metolachlor+terbuthylazine+glyphosate+DICHLORMID; chlomitrofen+S-metolachlor+terbuthylazine+glyphosate+DICHLORMID; chlomitrofen+atrazine+nicosulfuron+glyphosate+DICHLORMID; ethoxyfen+metolachlor+isoxaflutole+glyphosate+DICHLORMID; ethoxyfen+S-metolachlor+isoxaflutole+glyphosate+DICHLORMID; ethoxyfen+metolachlor+mesotrione+glyphosate+DICHLORMID; ethoxyfen+S-metolachlor+mesotrione+glyphosate+DICHLORMID; ethoxyfen+metolachlor+atrazine+glyphosate+DICHLORMID; ethoxyfen+S-metolachlor+atrazine+glyphosate+DICHLORMID; ethoxyfen+metolachlor+terbuthylazine+glyphosate+DICHLORMID; ethoxyfen+S-metolachlor+terbuthylazine+glyphosate+DICHLORMID; ethoxyfen+atrazine+nicosulfuron+glyphosate+DICHLORMID; fluoroglycofen+metolachlor+isoxaflutole+glyphosate+DICHLORMID; fluoroglycofen+S-metolachlor+isoxaflutole+glyphosate+DICHLORMID; fluoroglycofen+metolachlor+mesotrione+glyphosate+DICHLORMID; fluoroglycofen+S-metolachlor+mesotrione+glyphosate+DICHLORMID; fluoroglycofen+metolachlor+atrazine+glyphosate+DICHLORMID; fluoroglycofen+S-metolachlor+atrazine+glyphosate+DICHLORMID; fluoroglycofen+metolachlor+terbuthylazine+glyphosate+DICHLORMID; fluoroglycofen+S-metolachlor+terbuthylazine+glyphosate+DICHLORMID; fluoroglycofen+atrazine+nicosulfuron+glyphosate+DICHLORMID; fomesafen+metolachlor+isoxaflutole+glyphosate+DICHLORMID; fomesafen+S-metolachlor+isoxaflutole+glyphosate+DICHLORMID; fomesafen+metolachlor+mesotrione+glyphosate+DICHLORMID; fomesafen+S-metolachlor+mesotrione+glyphosate+DICHLORMID; fomesafen+metolachlor+atrazine+glyphosate+DICHLORMID; fomesafen+S-metolachlor+atrazine+glyphosate+DICHLORMID; fomesafen+metolachlor+terbuthylazine+glyphosate+DICHLORMID; fomesafen+S-metolachlor+terbuthylazine+glyphosate+DICHLORMID; fomesafen+atrazine+nicosulfuron+glyphosate+DICHLORMID; lactofen+metolachlor+isoxaflutole+glyphosate+DICHLORMID; lactofen+S-metolachlor+isoxaflutole+glyphosate+DICHLORMID; lactofen+metolachlor+mesotrione+glyphosate+DICHLORMID; lactofen +S-metolachlor+mesotrione+glyphosate+DICHLORMID; lactofen+metolachlor+atrazine+glyphosate+DICHLORMID; lactofen+S-metolachlor+atrazine+glyphosate+DICHLORMID; lactofen+metolachlor+terbuthylazine+glyphosate+DICHLORMID; lactofen+S-metolachlor+terbuthylazine+glyphosate+DICHLORMID; lactofen+atrazine +nicosulfuron+glyphosate+DICHLORMID; oxyfluorfen+metolachlor+isoxaflutole+glyphosate+DICHLORMID; oxyfluorfen+S-metolachlor+isoxaflutole+glyphosate+DICHLORMID; oxyfluorfen+metolachlor+mesotrione+glyphosate+DICHLORMID; oxyfluorfen+S-metolachlor+mesotrione+glyphosate+DICHLORMID; oxyfluorfen+metolachlor+atrazine+glyphosate+DICHLORMID; oxyfluorfen+S-metolachlor+atrazine +glyphosate+DICHLORMID; oxyfluorfen+metolachlor+terbuthylazine+glyphosate+DICHLORMID; oxyfluorfen+S-metolachlor+terbuthylazine+glyphosate+DICHLORMID; oxyfluorfen+atrazine+nicosulfuron+glyphosate+DICHLORMID; azafenidin+metolachlor+isoxaflutole+glyphosate+DICHLORMID; azafenidin+S-metolachlor+isoxaflutole+glyphosate+DICHLORMID; azafenidin+metolachlor+mesotrione+glyphosate+DICHLORMID; azafenidin+S-metolachlor+mesotrione+glyphosate+DICHLORMID; azafenidin+metolachlor+atrazine+glyphosate+DICHLORMID; azafenidin+S-metolachlor+atrazine+glyphosate+DICHLORMID; azafenidin+metolachlor+terbuthylazine+glyphosate+DICHLORMID; azafenidin+S-metolachlor+terbuthylazine+glyphosate+DICHLORMID; azafenidin+atrazine+nicosulfuron+glyphosate+DICHLORMID; carfentrazone-ethyl+metolachlor+isoxaflutole+glyphosate +DICHLORMID; carfentrazone-ethyl+S-metolachlor+isoxaflutole+glyphosate+DICHLORMID; carfentrazone-ethyl+metolachlor+mesotrione+glyphosate+DICHLORMID; carfentrazone-ethyl+S-metolachlor+mesotrione+glyphosate+DICHLORMID; carfentrazone-ethyl+metolachlor+atrazine+glyphosate+DICHLORMID; carfentrazone-ethyl+S-metolachlor+atrazine+glyphosate+DICHLORMID; carfentrazone-ethyl+metolachlor+terbuthylazine+glyphosate+DICHLORMID; carfentrazone-ethyl+S-metolachlor+terbuthylazine+glyphosate+DICHLORMID; carfentrazone-ethyl+atrazine+nicosulfuron+DICHLORMID; compound of the formula A +metolachlor+isoxaflutole+glyphosate+DICHLORMID; compound of the formula A+S-metolachlor+isoxaflutole+glyphosate+DICHLORMID; compound of the formula A+metolachlor+mesotrione+glyphosate+DICHLORMID; compound of the formula A+S-metolachlor+mesotrione+glyphosate+DICHLORMID; compound of the formula A+metolachlor+atrazine+glyphosate+DICHLORMID; compound of the formula A+S-metolachlor+atrazine+glyphosate+DICHLORMID; compound of the formula A+metolachlor+terbuthylazine+glyphosate+DICHLORMID; compound of the formula A+S-metolachlor+terbuthylazine+glyphosate+DICHLORMID; compound of the formula A+atrazine+nicosulfuron+glyphosate+DICHLORMID; cinidon-ethyl+metolachlor+isoxaflutole+glyphosate+DICHLORMID; cinidon-ethyl+S-metolachlor+isoxaflutole+glyphosate+DICHLORMID; cinidon-ethyl+metolachlor+mesotrione+glyphosate+DICHLORMID; cinidon-ethyl+S-metolachlor+mesotrione+glyphosate+DICHLORMID; cinidon-ethyl+metolachlor+atrazine+glyphosate+DICHLORMID; cinidon-ethyl+S-metolachlor+atrazine+glyphosate+DICHLORMID; cinidon-ethyl+metolachlor+terbuthylazine+glyphosate+DICHLORMID; cinidon-ethyl+S-metolachlor+terbuthylazine +glyphosate+DICHLORMID; cinidon-ethyl+atrazine+nicosulfuron+glyphosate+DICHLORMID; flumiclorac-pentyl+metolachlor+isoxaflutole+DICHLORMID; flumiclorac-pentyl+S-metolachlor+isoxaflutole+glyphosate+DICHLORMID; flumiclorac-pentyl+metolachlor+mesotrione+glyphosate+DICHLORMID; flumiclorac-pentyl+S-metolachlor +mesotrione+glyphosate+DICHLORMID; flumiclorac-pentyl+metolachlor+atrazine+glyphosate+DICHLORMID; flumiclorac-pentyl+S-metolachlor+atrazine+glyphosate+DICHLORMID; flumiclorac-pentyl+metolachlor+terbuthylazine+glyphosate+DICHLORMID; flumiclorac-pentyl+S-metolachlor+terbuthylazine+glyphosate+DICHLORMID; flumiclorac-pentyl+atrazine+nicosulfuron+glyphosate+DICHLORMID; flumioxazin+metolachlor+isoxaflutole+glyphosate+DICHLORMID; flumioxazin+S-metolachlor+isoxaflutole+glyphosate+DICHLORMID; flumioxazin+metolachlor+mesotrione+glyphosate+DICHLORMID; flumioxazin+S-metolachlor+mesotrione+glyphosate+DICHLORMID; flumioxazin+metolachlor+atrazine+glyphosate+DICHLORMID; flumioxazin+S-metolachlor+atrazine+glyphosate+DICHLORMID; flumioxazin+metolachlor+terbuthylazine+glyphosate+DICHLORMID; flumioxazin+S-metolachlor+terbuthylazine+glyphosate+DICHLORMID; flumioxazin+atrazine+nicosulfuron+glyphosate+DICHLORMID; fluthiacet-methyl+metolachlor+isoxaflutole+glyphosate+DICHLORMID; fluthiacet-methyl+S-metolachlor+isoxaflutole+glyphosate+DICHLORMID; fluthiacet-methyl+metolachlor+mesotrione+glyphosate+DICHLORMID; fluthiacet-methyl+S-metolachlor+mesotrione+glyphosate+DICHLORMID; fluthiacet-methyl+metolachlor+atrazine+glyphosate+DICHLORMID; fluthiacet-methyl+S-metolachlor+atrazine+glyphosate+DICHLORMID; fluthiacet-methyl+metolachlor+terbuthylazine+glyphosate+DICHLORMID; fluthiacet-methyl+S-metolachlor+terbuthylazine+glyphosate+DICHLORMID; fluthiacet-methyl+atrazine+nicosulfuron+glyphosate+DICHLORMID; oxadiargyl+metolachlor+isoxaflutole+glyphosate+DICHLORMID; oxadiargyl+S-metolachlor+isoxaflutole+glyphosate+DICHLORMID; oxadiargyl+metolachlor+mesotrione+glyphosate+DICHLORMID; oxadiargyl+S-metolachlor+mesotrione+glyphosate+DICHLORMID; oxadiargyl+metolachlor+atrazine +glyphosate+DICHLORMID; oxadiargyl+S-metolachlor+atrazine+glyphosate+DICHLORMID; oxadiargyl+metolachlor+terbuthylazine+glyphosate+DICHLORMID; oxadiargyl+S-metolachlor+terbuthylazine+glyphosate+DICHLORMID; oxadiargyl+atrazine+nicosulfuron+glyphosate+DICHLORMID; oxadiazon+metolachlor+isoxaflutole+glyphosate+DICHLORMID; oxadiazon+S-metolachlor+isoxaflutole+glyphosate+DICHLORMID; oxadiazon+metolachlor+mesotrione+glyphosate+DICHLORMID; oxadiazon+S-metolachlor+mesotrione+glyphosate+DICHLORMID; oxadiazon+metolachlor+atrazine+glyphosate+DICHLORMID; oxadiazon+S-metolachlor+atrazine+glyphosate+DICHLORMID; oxadiazon+metolachlor+terbuthylazine+glyphosate+DICHLORMID; oxadiazon+S-metolachlor+terbuthylazine+glyphosate+DICHLORMID; oxadiazon+atrazine+nicosulfuron+glyphosate+DICHLORMID; pentoxazone+metolachlor+isoxaflutole+glyphosate+DICHLORMID; pentoxazone+S-metolachlor+isoxaflutole+glyphosate+DICHLORMID; pentoxazone+metolachlor+mesotrione+glyphosate+DICHLORMID; pentoxazone+S-metolachlor+mesotrione+glyphosate+DICHLORMID; pentoxazone+metolachlor+atrazine+glyphosate+DICHLORMID; pentoxazone+S-metolachlor+atrazine+glyphosate+DICHLORMID; pentoxazone+metolachlor+terbuthylazine+glyphosate+DICHLORMID; pentoxazone+S-metolachlor+terbuthylazine+glyphosate+DICHLORMID; pentoxazone +atrazine+nicosulfuron+glyphosate+DICHLORMID; sulfentrazone+metolachlor+isoxaflutole+glyphosate+DICHLORMID; sulfentrazone+S-metolachlor+isoxaflutole+glyphosate+DICHLORMID; sulfentrazone+metolachlor+mesotrione+glyphosate+DICHLORMID; sulfentrazone+S-metolachlor+mesotrione+glyphosate+DICHLORMID; sulfentrazone+metolachlor+atrazine+glyphosate+DICHLORMID; sulfentrazone+S-metolachlor+atrazine+glyphosate+DICHLORMID; sulfentrazone+metolachlor+terbuthylazine+glyphosate+DICHLORMID; sulfentrazone+S-metolachlor+terbuthylazine+glyphosate+DICHLORMID; sulfentrazone+atrazine+nicosulfuron+glyphosate+DICHLORMID; fluazolate+metolachlor+isoxaflutole+glyphosate+DICHLORMID; fluazolate+S-metolachlor+isoxaflutole+glyphosate+DICHLORMID; fluazolate+metolachlor+mesotrione+glyphosate+DICHLORMID; fluazolate+S-metolachlor+mesotrione+glyphosate+DICHLORMID; fluazolate+metolachlor+atrazine +glyphosate+DICHLORMID; fluazolate+S-metolachlor+atrazine+glyphosate+DICHLORMID; fluazolate+metolachlor+terbuthylazine+glyphosate+DICHLORMID; fluazolate+S-metolachlor+terbuthylazine+glyphosate+DICHLORMID; fluazolate+atrazine+nicosulfuron+glyphosate+DICHLORMID; pyraflufen-ethyl+metolachlor+isoxaflutole+glyphosate+DICHLORMID; pyraflufen-ethyl+S-metolachlor+isoxaflutole+glyphosate+DICHLORMID; pyraflufen-ethyl+metolachlor+mesotrione+glyphosate+DICHLORMID; pyraflufen-ethyl+S-metolachlor+mesotrione+glyphosate+DICHLORMID; pyraflufen-ethyl+metolachlor+atrazine+glyphosate+DICHLORMID; pyraflufen-ethyl+S-metolachlor+atrazine+glyphosate+DICHLORMID; pyraflufen-ethyl+metolachlor+terbuthylazine+glyphosate+DICHLORMID; pyraflufen-ethyl+S-metolachlor+terbuthylazine+glyphosate+DICHLORMID; pyraflufen-ethyl+atrazine+nicosulfuron+glyphosate+DICHLORMID; flumipropyn+metolachlor+isoxaflutole+glyphosate+DICHLORMID; flumipropyn+S-metolachlor+isoxaflutole+glyphosate+DICHLORMID; flumipropyn+metolachlor+mesotrione+glyphosate+DICHLORMID; flumipropyn+S-metolachlor+mesotrione+glyphosate+DICHLORMID; flumipropyn+metolachlor+atrazine+glyphosate+DICHLORMID; flumipropyn+S-metolachlor+atrazine+glyphosate +DICHLORMID; flumipropyn+metolachlor+terbuthylazine+glyphosate+DICHLORMID; flumipropyn+S-metolachlor+terbuthylazine+glyphosate+DICHLORMID; flumipropyn+atrazine+nicosulfuron+glyphosate+DICHLORMID; flupropacil+metolachlor+isoxaflutole+glyphosate+DICHLORMID; flupropacil+S-metolachlor+isoxaflutole+glyphosate+DICHLORMID; flupropacil+metolachlor+mesotrione+glyphosate+DICHLORMID; flupropacil+S-metolachlor+mesotrione+glyphosate+DICHLORMID; flupropacil+metolachlor+atrazine+glyphosate+DICHLORMID; flupropacil+S-metolachlor+atrazine+glyphosate+DICHLORMID; flupropacil+metolachlor+terbuthylazine+glyphosate+DICHLORMID; flupropacil+S-metolachlor+terbuthylazine+glyphosate+DICHLORMID; flupropacil+atrazine+nicosulfuron+glyphosate+DICHLORMID; nipyraclofen+metolachlor+isoxaflutole+glyphosate+DICHLORMID; nipyraclofen+S-metolachlor+isoxaflutole+glyphosate+DICHLORMID; nipyraclofen+metolachlor+mesotrione+glyphosate+DICHLORMID; nipyraclofen+S-metolachlor+mesotrione+glyphosate+DICHLORMID; nipyraclofen+metolachlor+atrazine+glyphosate+DICHLORMID; nipyraclofen+S-metolachlor+atrazine+glyphosate+DICHLORMID; nipyraclofen+metolachlor+terbuthylazine+glyphosate+DICHLORMID; nipyraclofen+S-metolachlor+terbuthylazine+glyphosate+DICHLORMID; nipyraclofen+atrazine+nicosulfuron+glyphosate+DICHLORMID; benzfendizone+metolachlor+isoxaflutole+glyphosate+DICHLORMID; benzfendizone+S-metolachlor+isoxaflutole+glyphosate+DICHLORMID; benzfendizone+metolachlor+mesotrione+glyphosate+DICHLORMID; benzfendizone+S-metolachlor+mesotrione+glyphosate+DICHLORMID; benzfendizone+metolachlor+atrazine+glyphosate+DICHLORMID; benzfendizone+S-metolachlor+atrazine+glyphosate+DICHLORMID; benzfendizone+metolachlor+terbuthylazine+glyphosate+DICHLORMID; benzfendizone+S-metolachlor+terbuthylazine+glyphosate+DICHLORMID; benzfendizone+atrazine+nicosulfuron+glyphosate+DICHLORMID; thidiazimin+metolachlor+isoxaflutole+glyphosate+DICHLORMID; thidiazimin+S-metolachlor+isoxaflutole+glyphosate+DICHLORMID; thidiazimin+metolachlor+mesotrione+glyphosate+DICHLORMID; thidiazimin+S-metolachlor+mesotrione+glyphosate+DICHLORMID; thidiazimin+metolachlor+atrazine+glyphosate+DICHLORMID; thidiazimin+S-metolachlor+atrazine+glyphosate +DICHLORMID; thidiazimin+metolachlor+terbuthylazine+glyphosate+DICHLORMID; thidiazimin+S-metolachlor+terbuthylazine+glyphosate+DICHLORMID; and thidiazimin +atrazine+nicosulfuron+glyphosate+DICHLORMID.

Acifluorfen+metolachlor+isoxaflutole+glyphosate+FURILAZOLE; acifluorfen+S-metolachlor+isoxaflutole+glyphosate+FURILAZOLE; acifluorfen+metolachlor+mesotrione+glyphosate+FURILAZOLE; acifluorfen+S-metolachlor+mesotrione+glyphosate+FURILAZOLE; acifluorfen+metolachlor+atrazine+glyphosate+FURILAZOLE; acifluorfen+S-metolachlor+atrazine+glyphosate+FURILAZOLE; acifluorfen+metolachlor+terbuthylazine+glyphosate+FURILAZOLE; acifluorfen+S-metolachlor+terbuthylazine+glyphosate+FURILAZOLE; acifluorfen+atrazine+nicosulfuron+glyphosate+FURILAZOLE; aclonifen+metolachlor+isoxaflutole+glyphosate+FURILAZOLE; aclonifen+S-metolachlor+isoxaflutole+glyphosate+FURILAZOLE; aclonifen+metolachlor+mesotrione+glyphosate+FURILAZOLE; aclonifen+S-metolachlor+mesotrione+glyphosate+FURILAZOLE; aclonifen+metolachlor+atrazine+glyphosate+FURILAZOLE; aclonifen+S-metolachlor+atrazine+glyphosate+FURILAZOLE; aclonifen+metolachlor+terbuthylazine+glyphosate+FURILAZOLE; aclonifen+S-metolachlor+terbuthylazine+glyphosate+FURILAZOLE; aclonifen+atrazine+nicosulfuron+glyphosate+FURILAZOLE; bifenox+metolachlor+isoxaflutole+glyphosate+FURILAZOLE; bifenox+S-metolachlor+isoxaflutole+glyphosate+FURILAZOLE; bifenox+metolachlor+mesotrione+glyphosate+FURILAZOLE; bifenox+S-metolachlor+mesotrione+glyphosate+FURILAZOLE; bifenox +metolachlor+atrazine+glyphosate+FURILAZOLE; bifenox+S-metolachlor+atrazine+glyphosate+FURILAZOLE; bifenox+metolachlor+terbuthylazine+glyphosate+FURILAZOLE; bifenox+S-metolachlor+terbuthylazine+glyphosate+FURILAZOLE; bifenox+atrazine+nicosulfuron+glyphosate+FURILAZOLE; chlomitrofen+metolachlor +isoxaflutole+glyphosate+FURILAZOLE; chlomitrofen+S-metolachlor+isoxaflutole+glyphosate+FURILAZOLE; chlomitrofen+metolachlor+mesotrione+glyphosate+FURILAZOLE; chlomitrofen+S-metolachlor+mesotrione+glyphosate+FURILAZOLE; chlomitrofen+metolachlor+atrazine+glyphosate+FURILAZOLE; chlomitrofen+S-metolachlor+atrazine+glyphosate+FURILAZOLE; chlomitrofen+metolachlor+terbuthylazine+glyphosate+FURILAZOLE; chlomitrofen+S-metolachlor+terbuthylazine +glyphosate+FURILAZOLE; chlomitrofen+atrazine+nicosulfuron+glyphosate+FURILAZOLE; ethoxyfen+metolachlor+isoxaflutole+glyphosate+FURILAZOLE; ethoxyfen+S-metolachlor+isoxaflutole+glyphosate+FURILAZOLE; ethoxyfen+metolachlor+mesotrione+glyphosate+FURILAZOLE; ethoxyfen+S-metolachlor+mesotrione+glyphosate+FURILAZOLE; ethoxyfen+metolachlor+atrazine+glyphosate +FURILAZOLE; ethoxyfen+S-metolachlor+atrazine+glyphosate+FURILAZOLE; ethoxyfen+metolachlor+terbuthylazine+glyphosate+FURILAZOLE; ethoxyfen+S-metolachlor+terbuthylazine+glyphosate+FURILAZOLE; ethoxyfen+atrazine+nicosulfuron+glyphosate+FURILAZOLE; fluoroglycofen+metolachlor+isoxaflutole+glyphosate+FURILAZOLE; fluoroglycofen+S-metolachlor+isoxaflutole+glyphosate+FURILAZOLE; fluoroglycofen+metolachlor+mesotrione+glyphosate+FURILAZOLE; fluoroglycofen+S-metolachlor+mesotrione+glyphosate+FURILAZOLE; fluoroglycofen+metolachlor+atrazine+glyphosate+FURILAZOLE; fluoroglycofen+S-metolachlor+atrazine+glyphosate+FURILAZOLE; fluoroglycofen+metolachlor+terbuthylazine+glyphosate+FURILAZOLE; fluoroglycofen+S-metolachlor+terbuthylazine+glyphosate+FURILAZOLE; fluoroglycofen+atrazine+nicosulfuron+glyphosate+FURILAZOLE; fomesafen+metolachlor+isoxaflutole+glyphosate+FURILAZOLE; fomesafen+S-metolachlor+isoxaflutole+glyphosate+FURILAZOLE; fomesafen+metolachlor+mesotrione+glyphosate+FURILAZOLE; fomesafen+S-metolachlor+mesotrione+glyphosate+FURILAZOLE; fomesafen+metolachlor+atrazine+glyphosate+FURILAZOLE; fomesafen+S-metolachlor+atrazine+glyphosate+FURILAZOLE; fomesafen+metolachlor+terbuthylazine+glyphosate+FURILAZOLE; fomesafen+S-metolachlor+terbuthylazine+glyphosate+FURILAZOLE; fomesafen+atrazine+nicosulfuron+glyphosate+FURILAZOLE; lactofen+metolachlor+isoxaflutole+glyphosate+FURILAZOLE; lactofen+S-metolachlor+isoxaflutole+glyphosate+FURILAZOLE; lactofen+metolachlor+mesotrione+glyphosate+FURILAZOLE; lactofen +S-metolachlor+mesotrione+glyphosate+FURILAZOLE; lactofen+metolachlor+atrazine+glyphosate+FURILAZOLE; lactofen+S-metolachlor+atrazine+glyphosate+FURILAZOLE; lactofen+metolachlor+terbuthylazine+glyphosate+FURILAZOLE; lactofen+S-metolachlor+terbuthylazine+glyphosate+FURILAZOLE; lactofen+atrazine +nicosulfuron+glyphosate+FURILAZOLE; oxyfluorfen+metolachlor+isoxaflutole+glyphosate+FURILAZOLE; oxyfluorfen+S-metolachlor+isoxaflutole+glyphosate+FURILAZOLE; oxyfluorfen+metolachlor+mesotrione+glyphosate+FURILAZOLE; oxyfluorfen+S-metolachlor+mesotrione+glyphosate+FURILAZOLE; oxyfluorfen+metolachlor+atrazine+glyphosate+FURILAZOLE; oxyfluorfen+S-metolachlor+atrazine +glyphosate+FURILAZOLE; oxyfluorfen+metolachlor+terbuthylazine+glyphosate+FURILAZOLE; oxyfluorfen+S-metolachlor+terbuthylazine+glyphosate+FURILAZOLE; oxyfluorfen+atrazine+nicosulfuron+glyphosate+FURILAZOLE; azafenidin+metolachlor+isoxaflutole+glyphosate+FURILAZOLE; azafenidin+S-metolachlor+isoxaflutole+glyphosate+FURILAZOLE; azafenidin+metolachlor+mesotrione+glyphosate+FURILAZOLE; azafenidin+S-metolachlor+mesotrione+glyphosate+FURILAZOLE; azafenidin+metolachlor+atrazine+glyphosate+FURILAZOLE; azafenidin +S-metolachlor+atrazine+glyphosate+FURILAZOLE; azafenidin+metolachlor+terbuthylazine+glyphosate+FURILAZOLE; azafenidin+S-metolachlor+terbuthylazine+glyphosate+FURILAZOLE; azafenidin+atrazine+nicosulfuron+glyphosate+FURILAZOLE; carfentrazone-ethyl+metolachlor+isoxaflutole+glyphosate+FURILAZOLE; carfentrazone-ethyl+S-metolachlor+isoxaflutole+glyphosate+FURILAZOLE; carfentrazone-ethyl+metolachlor+mesotrione+glyphosate+FURILAZOLE; carfentrazone-ethyl+S-metolachlor+mesotrione+glyphosate+FURILAZOLE; carfentrazone-ethyl+metolachlor+atrazine+glyphosate+FURILAZOLE; carfentrazone-ethyl+S-metolachlor+atrazine+glyphosate+FURILAZOLE; carfentrazone-ethyl+metolachlor+terbuthylazine+glyphosate+FURILAZOLE; carfentrazone-ethyl+S-metolachlor+terbuthylazine+glyphosate+FURILAZOLE; B carfentrazone-ethyl+atrazine+nicosulfuron+glyphosate+FURILAZOLE; compound of the formula A+metolachlor+isoxaflutole+glyphosate+FURILAZOLE; compound of the formula A+S-metolachlor+isoxaflutole+glyphosate+FURILAZOLE; compound of the formula A+metolachlor+mesotrione+glyphosate+FURILAZOLE; compound of the formula A+S-metolachlor+mesotrione+glyphosate+FURILAZOLE; compound of the formula A+metolachlor+atrazine+glyphosate+FURILAZOLE; compound of the formula A+S-metolachlor+atrazine+glyphosate+FURILAZOLE; compound of the formula A+metolachlor+terbuthylazine+glyphosate+FURILAZOLE; compound of the formula A+S-metolachlor+terbuthylazine+glyphosate+FURILAZOLE; compound of the formula A+atrazine+nicosulfuron+glyphosate+FURILAZOLE; cinidon-ethyl+metolachlor+isoxaflutole+glyphosate+FURILAZOLE; cinidon-ethyl+S-metolachlor+isoxaflutole+glyphosate+FURILAZOLE; cinidon-ethyl+metolachlor+mesotrione+glyphosate+FURILAZOLE; cinidon-ethyl+S-metolachlor+mesotrione+glyphosate+FURILAZOLE; cinidon-ethyl+metolachlor+atrazine+glyphosate+FURILAZOLE; cinidon-ethyl+S-metolachlor+atrazine+glyphosate+FURILAZOLE; cinidon-ethyl+metolachlor+terbuthylazine+glyphosate+FURILAZOLE; cinidon-ethyl+S-metolachlor+terbuthylazine +glyphosate+FURILAZOLE; cinidon-ethyl+atrazine+nicosulfuron+glyphosate+FURILAZOLE; Flumiclorac-pentyl+metolachlor+isoxaflutole+glyphosate+FURILAZOLE; flumiclorac-pentyl+S-metolachlor+isoxaflutole+glyphosate+FURILAZOLE; flumiclorac-pentyl+metolachlor+mesotrione+glyphosate+FURILAZOLE; flumiclorac-pentyl+S-metolachlor+mesotrione+glyphosate+FURILAZOLE; flumiclorac-pentyl+metolachlor+atrazine+glyphosate+FURILAZOLE; flumiclorac-pentyl+S-metolachlor+atrazine+glyphosate+FURILAZOLE; flumiclorac-pentyl+metolachlor+terbuthylazine+glyphosate +FURILAZOLE; flumiclorac-pentyl+S-metolachlor+terbuthylazine+glyphosate+FURILAZOLE; flumiclorac-pentyl+atrazine+nicosulfuron+glyphosate+FURILAZOLE; flumioxazin+metolachlor+isoxaflutole+glyphosate+FURILAZOLE; flumioxazin+S-metolachlor+isoxaflutole+glyphosate+FURILAZOLE; flumioxazin+metolachlor+mesotrione+glyphosate+FURILAZOLE; flumioxazin+S-metolachlor+mesotrione+glyphosate+FURILAZOLE; flumioxazin+metolachlor+atrazine+glyphosate+FURILAZOLE; flumioxazin+S-metolachlor+atrazine+glyphosate+FURILAZOLE; flumioxazin+metolachlor+terbuthylazine+glyphosate+FURILAZOLE; flumioxazin+S-metolachlor+terbuthylazine+glyphosate+FURILAZOLE; flumioxazin+atrazine+nicosulfuron+glyphosate+FURILAZOLE; fluthiacet-methyl+metolachlor+isoxaflutole+glyphosate+FURILAZOLE; fluthiacet-methyl+S-metolachlor+isoxaflutole+glyphosate+FURILAZOLE; fluthiacet-methyl+metolachlor+mesotrione+glyphosate+FURILAZOLE; fluthiacet-methyl+S-metolachlor+mesotrione+glyphosate+FURILAZOLE; fluthiacet-methyl+metolachlor+atrazine+glyphosate+FURILAZOLE; fluthiacet-methyl+S-metolachlor+atrazine+glyphosate+FURILAZOLE; fluthiacet-methyl+metolachlor+terbuthylazine+glyphosate+FURILAZOLE; fluthiacet-methyl+S-metolachlor+terbuthylazine+glyphosate+FURILAZOLE; fluthiacet-methyl+atrazine+nicosulfuron+glyphosate+FURILAZOLE; oxadiargyl+metolachlor+isoxaflutole+glyphosate+FURILAZOLE; oxadiargyl+S-metolachlor+isoxaflutole+glyphosate+FURILAZOLE; oxadiargyl+metolachlor+mesotrione+glyphosate+FURILAZOLE; oxadiargyl+S-metolachlor+mesotrione+glyphosate+FURILAZOLE; oxadiargyl+metolachlor+atrazine +glyphosate+FURILAZOLE; oxadiargyl+S-metolachlor+atrazine+glyphosate+FURILAZOLE; oxadiargyl+metolachlor+terbuthylazine+glyphosate+FURILAZOLE; oxadiargyl+S-metolachlor+terbuthylazine+glyphosate+FURILAZOLE; oxadiargyl+atrazine+nicosulfuron+glyphosate+FURILAZOLE; oxadiazon+metolachlor+isoxaflutole+glyphosate+FURILAZOLE; oxadiazon+S-metolachlor+isoxaflutole+glyphosate+FURILAZOLE; oxadiazon+metolachlor+mesotrione+glyphosate+FURILAZOLE; oxadiazon+S-metolachlor+mesotrione+glyphosate+FURILAZOLE; oxadiazon+metolachlor+atrazine+glyphosate+FURILAZOLE; oxadiazon+S-metolachlor+atrazine+glyphosate+FURILAZOLE; oxadiazon+metolachlor+terbuthylazine+glyphosate+FURILAZOLE; oxadiazon+S-metolachlor+terbuthylazine+glyphosate+FURILAZOLE; oxadiazon+atrazine+nicosulfuron+glyphosate+FURILAZOLE; pentoxazone+metolachlor+isoxaflutole+glyphosate+FURILAZOLE; pentoxazone+S-metolachlor+isoxaflutole+glyphosate+FURILAZOLE; pentoxazone+metolachlor+mesotrione+glyphosate+FURILAZOLE; pentoxazone+S-metolachlor+mesotrione+glyphosate+FURILAZOLE; pentoxazone+metolachlor+atrazine+glyphosate+FURILAZOLE; pentoxazone+S-metolachlor+atrazine+glyphosate+FURILAZOLE; pentoxazone+metolachlor+terbuthylazine+glyphosate+FURILAZOLE; pentoxazone+S-metolachlor+terbuthylazine+glyphosate+FURILAZOLE; pentoxazone +atrazine+nicosulfuron+glyphosate+FURILAZOLE; sulfentrazone+metolachlor+isoxaflutole+glyphosate+FURILAZOLE; sulfentrazone+S-metolachlor+isoxaflutole+glyphosate+FURILAZOLE; sulfentrazone+metolachlor+mesotrione+glyphosate+FURILAZOLE; sulfentrazone+S-metolachlor+mesotrione+glyphosate+FURILAZOLE; sulfentrazone+metolachlor+atrazine+glyphosate+FURILAZOLE; sulfentrazone+S-metolachlor+atrazine+glyphosate+FURILAZOLE; sulfentrazone+metolachlor+terbuthylazine+glyphosate+FURILAZOLE; sulfentrazone+S-metolachlor+terbuthylazine +glyphosate+FURILAZOLE; sulfentrazone+atrazine+nicosultfuron+glyphosate+FURILAZOLE; fluazolate+metolachlor+isoxaflutole+glyphosate+FURILAZOLE; fluazolate+S-metolachlor+isoxaflutole+glyphosate+FURILAZOLE; fluazolate+metolachlor+mesotrione+glyphosate+FURILAZOLE; fluazolate+S-metolachlor+mesotrione+glyphosate+FURILAZOLE; fluazolate+metolachlor+atrazine+glyphosate +FURILAZOLE; fluazolate+S-metolachlor+atrazine+glyphosate+FURILAZOLE; fluazolate+metolachlor+terbuthylazine+glyphosate+FURILAZOLE; fluazolate+S-metolachlor+terbuthylazine+glyphosate+FURILAZOLE; fluazolate+atrazine+nicosulfuron+glyphosate+FURILAZOLE; pyraflufen-ethyl+metolachlor+isoxaflutole+glyphosate+FURILAZOLE; pyraflufen-ethyl+S-metolachlor+isoxaflutole+glyphosate+FURILAZOLE; pyraflufen-ethyl+metolachlor+mesotrione+glyphosate+FURILAZOLE; pyraflufen-ethyl+S-metolachlor+mesotrione+glyphosate+FURILAZOLE; pyraflufen-p ethyl+metolachlor+atrazine+glyphosate+FURILAZOLE; pyraflufen-ethyl+S-metolachlor+atrazine+glyphosate+FURILAZOLE; pyraflufen-ethyl+metolachlor+terbuthylazine+glyphosate+FURILAZOLE; pyraflufen-ethyl+S-metolachlor+terbuthylazine+glyphosate+FURILAZOLE; pyraflufen-ethyl+atrazine+nicosulfuron+glyphosate+FURILAZOLE; flumipropyn+metolachlor+isoxaflutole+glyphosate+FURILAZOLE; flumipropyn+S-metolachlor+isoxaflutole+glyphosate+FURILAZOLE; flumipropyn+metolachlor+mesotrione+glyphosate+FURILAZOLE; flumipropyn+S-metolachlor or+mesotrione+glyphosate+FURILAZOLE; flumipropyn+metolachlor+atrazine+glyphosate+FURILAZOLE; flumipropyn+S-metolachlor+atrazine+glyphosate +FURILAZOLE; flumipropyn+metolachlor+terbuthylazine+glyphosate+FURILAZOLE; flumipropyn+S-metolachlor+terbuthylazine+glyphosate+FURILAZOLE; flumipropyn+atrazine+nicosulfuron+glyphosate+FURILAZOLE; flupropacil+metolachlor+isoxaflutole+glyphosate+FURILAZOLE; flupropacil+S-metolachlor+isoxaflutole+glyphosate+FURILAZOLE; flupropacil+metolachlor+mesotrione+glyphosate+FURILAZOLE; flupropacil+S-metolachlor+mesotrione+glyphosate+FURILAZOLE; flupropacil+metolachlor+atrazine+glyphosate+FURILAZOLE; flupropacil+S-metolachlor+atrazine+glyphosate+FURILAZOLE; flupropacil+metolachlor+terbuthylazine+glyphosate+FURILAZOLE; flupropacil+S-metolachlor+terbuthylazine+glyphosate+FURILAZOLE; flupropacil+atrazine+nicosulfuron+glyphosate+FURILAZOLE; nipyraclofen+metolachlor+isoxaflutole+glyphosate+FURILAZOLE; nipyraclofen+S-metolachlor+isoxaflutole+glyphosate+FURILAZOLE; nipyraclofen+metolachlor+mesotrione+glyphosate+FURILAZOLE; nipyraclofen+S-metolachlor+mesotrione+glyphosate+FURILAZOLE; nipyraclofen+metolachlor+atrazine+glyphosate+FURILAZOLE; nipyraclofen+S-metolachlor+atrazine+glyphosate+FURILAZOLE; nipyraclofen+metolachlor+terbuthylazine+glyphosate+FURILAZOLE; nipyraclofen+S-metolachlor+terbuthylazine+glyphosate+FURILAZOLE; nipyraclofen+atrazine+nicosulfuron+glyphosate+FURILAZOLE; benzfendizone+metolachlor+isoxaflutole+glyphosate+FURILAZOLE; benzfendizone+S-metolachlor+isoxaflutole+glyphosate+FURILAZOLE; benzfendizone+metolachlor+mesotrione+glyphosate+FURILAZOLE; benzfendizone+S-metolachlor+mesotrione+glyphosate+FURILAZOLE; benzfendizone+metolachlor+atrazine+glyphosate+FURILAZOLE; benzfendizone+S-metolachlor+atrazine+glyphosate+FURILAZOLE; benzfendizone+metolachlor+terbuthylazine+glyphosate+FURILAZOLE; benzfendizone+S-metolachlor+terbuthylazine+glyphosate+FURILAZOLE; benzfendizone+atrazine+nicosulfuron+glyphosate+FURILAZOLE; thidiazimin+metolachlor+isoxaflutole+glyphosate+FURILAZOLE; thidiazimin+S-metolachlor+isoxaflutole+glyphosate+FURILAZOLE; thidiazimin+metolachlor+mesotrione+glyphosate+FURILAZOLE; thidiazimin+S-metolachlor+mesotrione+glyphosate+FURILAZOLE; thidiazimin+metolachlor+atrazine +glyphosate+FURILAZOLE; thidiazimin+S-metolachlor+atrazine+glyphosate+FURILAZOLE; thidiazimin+metolachlor+terbuthylazine+glyphosate+FURILAZOLE; thidiazimin+S-metolachlor+terbuthylazine+glyphosate+FURILAZOLE; and thidiazimin+atrazine+nicosulfuron+glyphosate+FURILAZOLE.

acifluorfen+prosulfuron+primisulfuron;+glufosinate; acifluorfen+prosulfuron+dicamba +glufosinate; acifluorfen+primisulfuron+dicamba+glufosinate; acifluorfen+nicosulfuron +primisulfuron+glufosinate; acifluorfen+nicosulfuron+prosulfuron+glufosinate; acifluorfen+rimsulfuron+primisulfuron+glufosinate; acifluorfen+rimsulfuron+prosulfuron+glufosinate; acifluorfen+metolachlor+isoxaflutole+glufosinate; acifluorfen +metolachlor+isoxaflutole+glufosinate+benoxacor; acifluorfen+S-metolachlor+isoxaflutole+glufosinate; acifluorfen+S-metolachlor+isoxaflutole+glufosinate+benoxacor; acifluorfen+metolachlor+mesotrione+glufosinate; acifluorfen+metolachlor+mesotrione+glufosinate+benoxacor; acifluorfen+S-metolachlor+mesotrione+glufosinate; acifluorfen+S-metolachlor+mesotrione+benoxacor+glufosinate; acifluorfen +metolachlor+atrazine+glufosinate; acifluorfen+metolachlor+atrazine+glufosinate+benoxacor; acifluorfen+S-metolachlor+atrazine+glufosinate; acifluorfen+S-metolachlor +atrazine+glufosinate+benoxacor; acifluorfen+metolachlor+terbuthylazine+glufosinate; acifluorfen+metolachlor+terbuthylazine+glufosinate+benoxacor; acifluorfen+S-metolachlor+terbuthylazine+glufosinate; acifluorfen+S-metolachlor+terbuthylazine+glufosinate+benoxacor; acifluorfen+atrazine+nicosulfuron+glufosinate; acifluorfen+atrazine+nicosulfuron+glufosinate+benoxacor; aclonifen+prosulfuron+primisulfuron+glufosinate; aclonifen+prosulfuron+dicamba+glufosinate; aclonifen+primisulfuron+dicamba+glufosinate; aclonifen+nicosulfuron+primisulfuron+glufosinate; aclonifen+nicosulfuron+prosulfuron+glufosinate; aclonifen+rimsulfuron+primisulfuron+glufosinate; aclonifen+rimsulfuron+prosulfuron+glufosinate; aclonifen+metolachlor+isoxaflutole+glufosinate; aclonifen+metolachlor+isoxaflutole+glufosinate +benoxacor; aclonifen+S-metolachlor+isoxaflutole+glufosinate; aclonifen+S-metolachlor+isoxaflutole+glufosinate+benoxacor; aclonifen+metolachlor+mesotrione +glufosinate; aclonifen+metolachlor+mesotrione+glufosinate+benoxacor; aclonifen+S-metolachlor+mesotrione+glufosinate; aclonifen+S-metolachlor+mesotrione+glufosinate+benoxacor; aclonifen+metolachlor+atrazine+glufosinate; aclonifen+metolachlor+atrazine+glufosinate+benoxacor; aclonifen+S-metolachlor+atrazine+glufosinate; aclonifen+S-metolachlor+atrazine+glufosinate+benoxacor; aclonifen+metolachlor+terbuthylazine+glufosinate; aclonifen+metolachlor+terbuthylazine+glufosinate+benoxacor; aclonifen+S-metolachlor+terbuthylazine+glufosinate; aclonifen +S-metolachlor+terbuthylazine+glufosinate+benoxacor; aclonifen+atrazine+nicosulfuron+glufosinate; aclonifen+atrazine+nicosulfuron+glufosinate+benoxacor; bifenox+prosulfuron+primisulfuron+glufosinate; bifenox+prosulfuron+dicamba+glufosinate; bifenox+primisulfuron+dicamba+glufosinate; bifenox+nicosulfuron+primisulfuron+glufosinate; bifenox+nicosulfuron+prosulfuron+glufosinate; bifenox+rimsulfuron+primisulfuron+glufosinate; bifenox+rimsulfuron+prosulfuron+glufosinate; bifenox+metolachlor+isoxaflutole+glufosinate; bifenox+metolachlor+isoxaflutole+glufosinate+benoxacor; bifenox+S-metolachlor+isoxaflutole+glufosinate; bifenox+S-metolachlor+isoxaflutole+glufosinate+benoxacor; bifenox+metolachlor+mesotrione+glufosinate; bifenox+metolachlor+mesotrione+glufosinate+benoxacor; bifenox+S-metolachlor+mesotrione+glufosinate; bifenox+S-metolachlor+mesotrione+glufosinate +benoxacor; bifenox+metolachlor+atrazine+glufosinate; bifenox+metolachlor+atrazine+glufosinate+benoxacor; bifenox+S-metolachlor+atrazine+glufosinate; bifenox+S-metolachlor+atrazine+glufosinate+benoxacor; bifenox+metolachlor+terbuthylazine+glufosinate; bifenox+metolachlor+terbuthylazine+glufosinate+benoxacor; bifenox+S-metolachlor+terbuthylazine+glufosinate; bifenox+S-metolachlor +terbuthylazine+glufosinate+benoxacor; bifenox+atrazine+nicosulfuron+glufosinate; bifenox+atrazine+nicosulfuron+glufosinate+benoxacor; chlomitrofen+prosulfuron+primisulfuron+glufosinate; chlomitrofen+prosulfuron+dicamba+glufosinate; chlomitrofen+primisulfuron+dicamba+glufosinate; chlomitrofen+nicosulfuron+primisulfuron+glufosinate; chlomitrofen+nicosulfuron+prosulfuron+glufosinate; chlomitrofen+rimsulfuron+primisulfuron+glufosinate; chlomitrofen+rimsulfuron+prosulfuron+glufosinate; chlomitrofen+metolachlor+isoxaflutole+glufosinate; chlomitrofen+metolachlor+isoxaflutole+glufosinate+benoxacor; chlomitrofen+S-metolachlor+isoxaflutole+glufosinate; chlomitrofen+S-metolachlor+isoxaflutole+glufosinate+benoxacor; chlomitrofen+metolachlor+mesotrione+glufosinate; chlomitrofen+metolachlor+mesotrione+glufosinate+benoxacor; chlomitrofen+S-metolachlor+mesotrione+glufosinate; chlomitrofen+S-metolachlor+mesotrione+glufosinate+benoxacor; chlomitrofen+metolachlor+atrazine+glufosinate; chlomitrofen+metolachlor+atrazine+glufosinate+benoxacor; chlomitrofen+S-metolachlor+atrazine+glufosinate; chlomitrofen+S-metolachlor+atrazine+glufosinate+benoxacor; chlomitrofen+metolachlor+terbuthylazine+glufosinate; chlomitrofen+metolachlor+terbuthylazine+glufosinate+benoxacor; chlomitrofen+S-metolachlor+terbuthylazine+glufosinate; chlomitrofen+S-metolachlor+terbuthylazine+glufosinate+benoxacor; chlomitrofen+atrazine+nicosulfuron+glufosinate; chlomitrofen+atrazine+nicosulfuron +glufosinate+benoxacor; ethoxyfen+prosulfuron+primisulfuron+glufosinate; ethoxyfen +prosulfuron+dicamba+glufosinate; ethoxyfen+primisulfuron+dicamba+glufosinate; ethoxyfen+nicosulfuron+primisulfuron+glufosinate; ethoxyfen+nicosulfuron+prosulfuron+glufosinate; ethoxyfen+rimsulfuron+primisulfuron+glufosinate; ethoxyfen+rimsulfuron+prosulfuron+glufosinate; ethoxyfen+metolachlor+isoxaflutole+glufosinate; ethoxyfen+metolachlor+isoxaflutole+glufosinate+benoxacor; ethoxyfen+S-metolachlor+isoxaflutole+glufosinate; ethoxyfen+S-metolachlor+isoxaflutole+glufosinate+benoxacor; ethoxyfen+metolachlor+mesotrione+glufosinate; ethoxyfen+metolachlor+mesotrione+glufosinate+benoxacor; ethoxyfen+S-metolachlor+mesotrione+glufosinate; ethoxyfen+S-metolachlor+mesotrione+glufosinate+benoxacor; ethoxyfen+metolachlor+atrazine+glufosinate; ethoxyfen+metolachlor+atrazine+glufosinate+benoxacor; ethoxyfen+S-metolachlor+atrazine+glufosinate; ethoxyfen+S-metolachlor+atrazine+glufosinate+benoxacor; ethoxyfen+metolachlor+terbuthylazine+glufosinate; ethoxyfen+metolachlor+terbuthylazine+glufosinate+benoxacor; ethoxyfen+S-metolachlor+terbuthylazine+glufosinate; ethoxyfen+S-metolachlor+terbuthylazine+glufosinate+benoxacor; ethoxyfen+atrazine+nicosulfuron +glufosinate; ethoxyfen+atrazine+nicosulfuron+glufosinate+benoxacor; fluoroglycofen+prosulfuron+primisulfuron+glufosinate; fluoroglycofen+prosulfuron+dicamba+glufosinate; fluoroglycofen+primisulfuron+dicamba+glufosinate; fluoroglycofen+nicosulfuron+primisulfuron+glufosinate; fluoroglycofen+nicosulfuron+prosulfuron+glufosinate; fluoroglycofen+rimsulfuron+primisulfuron+glufosinate; fluoroglycofen+rimsulfuron+prosulfuron+glufosinate; fluoroglycofen+metolachlor+isoxaflutole+glufosinate; fluoroglycofen+metolachlor+isoxaflutole+glufosinate+benoxacor; fluoroglycofen+S-metolachlor+isoxaflutole+glufosinate; fluoroglycofen+S-metolachlor+isoxaflutole+glufosinate+benoxacor; fluoroglycofen+metolachlor+mesotrione+glufosinate; fluoroglycofen+metolachlor+mesotrione+glufosinate+benoxacor; fluoroglycofen+S-metolachlor+mesotrione+glufosinate; fluoroglycofen+S-metolachlor+mesotrione+glufosinate+benoxacor; fluoroglycofen+metolachlor+atrazine+glufosinate; fluoroglycofen+metolachlor+atrazine+glufosinate+benoxacor; fluoroglycofen+S-metolachlor+atrazine+glufosinate; fluoroglycofen+S-metolachlor+atrazine+glufosinate+benoxacor; fluoroglycofen+metolachlor+terbuthylazine+glufosinate; fluoroglycofen+metolachlor+terbuthylazine+glufosinate+benoxacor; fluoroglycofen+S-metolachlor+terbuthylazine+glufosinate; fluoroglycofen+S-metolachlor+terbuthylazine+glufosinate+benoxacor; fluoroglycofen+atrazine+nicosulfuron+glufosinate; fluoroglycofen+atrazine+nicosulfuron+glufosinate+benoxacor; fomesafen+prosulfuron+primisulfuron+glufosinate; fomesafen+prosulfuron +dicamba+glufosinate; fomesafen+primisulfuron+dicamba+glufosinate; fomesafen+nicosulfuron+primisulfuron+glufosinate; fomesafen+nicosulfuron+prosulfuron+glufosinate; fomesafen+rimsulfuron+primisulfuron+glufosinate; fomesafen+rimsulfuron +prosulfuron+glufosinate; fomesafen+metolachlor+isoxaflutole+glufosinate; fomesafen+metolachlor+isoxaflutole+glufosinate+benoxacor; fomesafen+S-metolachlor+isoxaflutole+glufosinate; fomesafen+S-metolachlor+isoxaflutole+glufosinate+benoxacor; fomesafen+metolachlor+mesotrione+glufosinate; fomesafen+metolachlor+mesotrione+glufosinate+benoxacor; fomesafen+S-metolachlor+mesotrione+glufosinate; fomesafen+S-metolachlor+mesotrione+glufosinate+benoxacor; fomesafen+metolachlor+atrazine+glufosinate; fomesafen+metolachlor+atrazine+glufosinate+benoxacor; fomesafen+S-metolachlor+atrazine+glufosinate; fomesaten+S-metolachlor+atrazine+glufosinate+benoxacor; fomesafen+metolachlor +terbuthylazine+glufosinate; fomesafen+metolachlor+terbuthylazine+glufosinate+benoxacor; fomesafen+S-metolachlor+terbuthylazine+glufosinate; fomesafen+S-metolachlor+terbuthylazine+glufosinate+benoxacor; fomesafen+atrazine+nicosulfuron+glufosinate; fomesafen+atrazine+nicosulfuron+glufosinate+benoxacor; lactofen+prosulfuron+primisulfuron+glufosinate; lactofen+prosulfuron+dicamba+glufosinate; lactofen+primisulfuron+dicamba+glufosinate; lactofen+nicosulfuron+primisulfuron+glufosinate; lactofen+nicosulfuron+prosulfuron+glufosinate; lactofen+rimsulfuron+primisulfuron+glufosinate; lactofen+rimsulfuron+prosulfuron+glufosinate; lactofen+metolachlor+isoxaflutole+glufosinate; lactofen+metolachlor+isoxaflutole+glufosinate+benoxacor; lactofen+S-metolachlor+isoxaflutole+glufosinate; lactofen+S-metolachlor+isoxaflutole+glufosinate+benoxacor, lactofen+metolachlor+mesotrione+glufosinate; lactofen+metolachlor+mesotrione+glufosinate+benoxacor; lactofen+S-metolachlor+mesotrione+glufosinate; lactofen+S-metolachlor+mesotrione+glufosinate +benoxacor; lactofen+metolachlor+atrazine+glufosinate; lactofen+metolachlor+atrazine+benoxacor; lactofen+S-metolachlor+atrazine; lactofen+S-metolachlor+atrazine+glufosinate+benoxacor; lactofen+metolachlor+terbuthylazine+glufosinate; lactofen+metolachlor+terbuthylazine+glufosinate+benoxacor; lactofen+S-metolachlor +terbuthylazine+glufosinate; lactofen+S-metolachlor+terbuthylazine+glufosinate+benoxacor; lactofen+atrazine+nicosulfuron+glufosinate; lactofen+atrazine+nicosulfuron+glufosinate+benoxacor; oxyfluorfen+prosulfuron+primisulfuron+glufosinate; oxyfluorfen+prosulfuron+dicamba+glufosinate; oxyfluorfen+primisulfuron+dicamba+glufosinate; oxyfluorfen+nicosulfuron+primisulfuron+glufosinate; oxyfluorfen +nicosulfuron+prosulfuron+glufosinate; oxyfluorfen+rimsulfuron+primisulfuron+glufosinate; oxyfluorfen+rimsulfuron+prosulfuron+glufosinate; oxyfluorfen+metolachlor +isoxaflutole+glufosinate; oxyfluorfen+metolachlor+isoxaflutole+glufosinate+benoxacor; oxyfluorfen+S-metolachlor+isoxaflutole+glufosinate; oxyfluorfen+S-metolachlor+isoxaflutole+glufosinate+benoxacor; oxyfluorfen+metolachlor+mesotrione+glufosinate; oxyfluorfen+metolachlor+mesotrione+glufosinate+benoxacor; oxyfluorfen+S-metolachlor+mesotrione+glufosinate; oxyfluorfen+S-metolachlor+mesotrione+glufosinate+benoxacor; oxyfluorfen+metolachlor+atrazine+glufosinate; oxyfluorfen+metolachlor+atrazine+glufosinate+benoxacor; oxyfluorfen+S-metolachlor+atrazine+glufosinate; oxyfluorfen+S-metolachlor+atrazine+glufosinate +benoxacor; oxyfluorfen+metolachlor+terbuthylazine+glufosinate; oxyfluorfen+metolachlor+terbuthylazine+glufosinate+benoxacor; oxyfluorfen+S-metolachlor+terbuthylazine+glufosinate; oxyfluorfen+S-metolachlor+terbuthylazine+glufosinate+benoxacor; oxyfluorfen+atrazine+nicosulfuron+glufosinate; oxyfluorfen+atrazine+nicosulfuron+glufosinate+benoxacor, azafenidin+prosulfuron+primisulfuron+glufosinate; azafenidin+prosulfuron+dicamba+glufosinate; azafenidin+primisulfuron+dicamba+glufosinate; azafenidin+nicosulfuron+primisulfuron+glufosinate; azafenidin+nicosulfuron+prosulfuron+glufosinate; azafenidin+rimsulfuron+primisulfuron+glufosinate; azafenidin+rimsulfuron+prosulfuron+glufosinate; azafenidin+metolachlor+isoxaflutole+glufosinate; azafenidin+metolachlor+isoxaflutole+glufosinate+benoxacor; azafenidin+S-metolachlor+isoxaflutole+glufosinate; azafenidin+S-metolachlor+isoxaflutole+glufosinate+benoxacor; azafenidin+metolachlor+mesotrione +glufosinate; azafenidin+metolachlor+mesotrione+glufosinate+benoxacor; azafenidin +S-metolachlor+mesotrione+glufosinate; azafenidin+S-metolachlor+mesotrione+glufosinate+benoxacor; azafenidin+metolachlor+atrazine+glufosinate; azafenidin+metolachlor+atrazine+glufosinate+benoxacor; azafenidin+S-metolachlor+atrazine+glufosinate; azafenidin+S-metolachlor+atrazine+glufosinate+benoxacor; azafenidin+metolachlor+terbuthylazine+glufosinate; azafenidin+metolachlor+terbuthylazine+glufosinate+benoxacor; azafenidin+S-metolachlor+terbuthylazine+glufosinate; azafenidin+S-metolachlor+terbuthylazine+glufosinate+benoxacor; azafenidin+atrazine+nicosulfuron+glufosinate; azafenidin+atrazine+nicosulfuron+glufosinate+benoxacor; carfentrazone-ethyl+prosulfuron+primisulfuron+glufosinate; carfentrazone-ethyl+prosulfuron+dicamba+glufosinate; carfentrazone-ethyl+primisulfuron+dicamba +glufosinate; carfentrazone-ethyl+nicosulfuron+primisulfuron+glufosinate; carfentrazone-ethyl+nicosulfuron+prosulfuron+glufosinate; carfentrazone-ethyl+rimsulfuron+primisulfuron+glufosinate; carfentrazone-ethyl+rimsulfuron+prosulfuron+glufosinate; carfentrazone-ethyl+metolachlor+isoxaflutole+glufosinate; carfentrazone-ethyl+metolachlor+isoxaflutole+glufosinate+benoxacor; carfentrazone-ethyl+S-metolachlor+isoxaflutole+glufosinate; carfentrazone-ethyl+S-metolachlor+isoxaflutole +glufosinate+benoxacor; carfentrazone-ethyl+metolachlor+mesotrione+glufosinate; carfentrazone-ethyl+metolachlor+mesotrione+glufosinate+benoxacor; carfentrazone-ethyl+S-metolachlor+mesotrione+glufosinate; carfentrazone-ethyl+S-metolachlor+mesotrione+glufosinate+benoxacor; carfentrazone-ethyl+metolachlor+atrazine+glufosinate; carfentrazone-ethyl+metolachlor+atrazine+glufosinate+benoxacor; carfentrazone-ethyl+S-metolachlor+atrazine+glufosinate; carfentrazone-ethyl+S-metolachlor+atrazine+glufosinate+benoxacor; carfentrazone-ethyl+metolachlor+terbuthylazine+glufosinate; carfentrazone-ethyl+metolachlor+terbuthylazine+glufosinate+benoxacor; carfentrazone-ethyl+S-metolachlor+terbuthylazine+glufosinate; carfentrazone-ethyl+S-metolachlor+terbuthylazine+glufosinate+benoxacor; carfentrazone-ethyl+atrazine+nicosulfuron+glufosinate; carfentrazone-ethyl +atrazine+nicosulfuron+glufosinate+benoxacor; compound of the formula A+prosulfuron+primisulfuron+glufosinate; compound of the formula A+prosulfuron+dicamba+glufosinate; compound of the formula A+primisulfuron+dicamba+glufosinate; compound of the formula A+nicosulfuron+primisulfuron+glufosinate; compound of the formula A+nicosulfuron+prosulfuron+glufosinate; compound of the formula A+rimsulfuron+primisulfuron+glufosinate; compound of the formula A+rimsulfuron+prosulfuron+glufosinate; compound of the formula A+metolachlor+isoxaflutole+glufosinate; compound of the formula A+metolachlor+isoxaflutole+glufosinate+benoxacor; compound of the formula A+S-metolachlor+isoxaflutole+glufosinate; compound of the formula A+S-metolachlor+isoxaflutole+glufosinate+benoxacor; compound of the formula A+metolachlor+mesotrione+glufosinate; compound of the formula A+metolachlor+mesotrione+glufosinate+benoxacor; compound of the formula A+S-metolachlor+mesotrione+glufosinate; compound of the formula A+S-metolachlor +mesotrione+glufosinate+benoxacor; compound of the formula A+metolachlor+atrazine+glufosinate; compound of the formula A+metolachlor+atrazine+glufosinate+benoxacor; compound of the formula A+S-metolachlor+atrazine+glufosinate; compound of the formula A+S-metolachlor+atrazine+glufosinate+benoxacor; compound of the formula A+metolachlor+terbuthylazine+glufosinate; compound of the formula A+metolachlor+terbuthylazine+glufosinate+benoxacor; compound of the formula A+S-metolachlor+terbuthylazine+glufosinate; compound of the formula A+S-metolachlor+terbuthylazine+glufosinate+benoxacor; compound of the formula A+atrazine+nicosulfuron+glufosinate; compound of the formula A+atrazine+nicosulfuron+glufosinate+benoxacor; cinidon-ethyl+prosulfuron+primisulfuron+glufosinate; cinidon-ethyl+prosulfuron+dicamba+glufosinate; cinidon-ethyl+primisulfuron+dicamba+glufosinate; cinidon-ethyl+nicosulfuron+primisulfuron+glufosinate; cinidon-ethyl+nicosulfuron+prosulfuron+glufosinate; cinidon-ethyl+rimsulfuron+primisulfuron+glufosinate; cinidon-ethyl+rimsulfuron+prosulfuron+glufosinate; cinidon-ethyl+metolachlor+isoxaflutole+glufosinate; cinidon-ethyl+metolachlor+isoxaflutole+glufosinate+benoxacor; cinidon-ethyl+S-metolachlor+isoxaflutole+glufosinate; cinidon-ethyl+S-metolachlor+isoxaflutole+glufosinate+benoxacor; cinidon-ethyl+metolachlor+mesotrione+glufosinate; cinidon-ethyl+metolachlor+mesotrione+glufosinate+benoxacor; cinidon-ethyl+S-metolachlor+mesotrione+glufosinate; cinidon-ethyl+S-metolachlor+mesotrione+glufosinate+benoxacor; cinidon-ethyl+metolachlor+atrazine +glufosinate; cinidon-ethyl+metolachlor+atrazine+glufosinate+benoxacor; cinidon-ethyl+S-metolachlor+atrazine+glufosinate; cinidon-ethyl+S-metolachlor+atrazine+glufosinate+benoxacor; cinidon-ethyl+metolachlor+terbuthylazine+glufosinate; cinidon-ethyl+metolachlor+terbuthylazine+glufosinate+benoxacor; cinidon-ethyl+S-metolachlor+terbuthylazine+glufosinate; cinidon-ethyl+S-metolachlor+terbuthylazine+glufosinate+benoxacor; cinidon-ethyl+atrazine+nicosulfuron+glufosinate; cinidon-ethyl +atrazine+nicosulfuron+glufosinate+benoxacor; flumiclorac-pentyl+prosulfuron+primisulfuron+glufosinate; flumiclorac-pentyl+prosulfuron+dicamba+glufosinate; flumiclorac-pentyl+primisulfuron+dicamba+glufosinate; flumiclorac-pentyl+nicosulfuron +primisulfuron+glufosinate; flumiclorac-pentyl+nicosulfuron+prosulfuron+glufosinate; flumiclorac-pentyl+rimsulfuron+primisulfuron+glufosinate; flumiclorac-pentyl+rimsulfuron+prosulfuron+glufosinate; flumiclorac-pentyl+metolachlor+isoxaflutole+glufosinate; flumiclorac-pentyl+metolachlor+isoxaflutole+glufosinate+benoxacor; flumiclorac-pentyl+S-metolachlor+isoxaflutole+glufosinate; flumiclorac-pentyl+S-metolachlor+isoxaflutole+glufosinate+benoxacor; flumiclorac-pentyl+metolachlor+mesotrione+glufosinate; flumiclorac-pentyl+metolachlor+mesotrione+glufosinate+benoxacor; flumiclorac-pentyl+S-metolachlor+mesotrione+glufosinate; flumiclorac-pentyl +S-metolachlor+mesotrione+glufosinate+benoxacor; flumiclorac-pentyl+metolachlor+atrazine+glufosinate; flumiclorac-pentyl+metolachlor+atrazine+glufosinate+benoxacor, flumiclorac-pentyl+S-metolachlor+atrazine+glufosinate; flumiclorac-pentyl+S-metolachlor+atrazine+glufosinate+benoxacor; flumiclorac-pentyl+metolachlor+terbuthylazine+glufosinate; flumiclorac-pentyl+metolachlor+terbuthylazine+glufosinate +benoxacor; flumiclorac-pentyl+S-metolachlor+terbuthylazine+glufosinate; flumiclorac-pentyl+S-metolachlor+terbuthylazine+glufosinate+benoxacor; flumiclorac-pentyl+atrazine+nicosulfuron+glufosinate; flumiclorac-pentyl+atrazine+nicosulfuron+glufosinate+benoxacor; flumioxazin+prosulfuron+primisulfuron+glufosinate; flumioxazin+prosulfuron+dicamba+glufosinate; flumioxazin+primisulfuron+dicamba+glufosinate; flumioxazin+nicosulfuron+primisulfuron+glufosinate; flumioxazin+nicosulfuron+prosulfuron+glufosinate; flumioxazin+rimsulfuron+primisulfuron+glufosinate; flumioxazin+rimsulfuron+prosulfuron+glufosinate; flumioxazin+metolachlor +isoxaflutole+glufosinate; flumioxazin+metolachlor+isoxaflutole+glufosinate+benoxacor; flumioxazin+S-metolachlor+isoxaflutole+glufosinate; flumioxazin+S-metolachlor+isoxaflutole+glufosinate+benoxacor; flumioxazin+metolachlor+mesotrione+glufosinate; flumioxazin+metolachlor+mesotrione+glufosinate+benoxacor, flumioxazin+S-metolachlor+mesotrione+glufosinate; flumioxazin+S-metolachlor+mesotrione+glufosinate+benoxacor; flumioxazin+metolachlor+atrazine+glufosinate; flumioxazin+metolachlor+atrazine+glufosinate+benoxacor; flumioxazin+S-metolachlor+atrazine+glufosinate; flumioxazin+S-metolachlor+atrazine+glufosinate +benoxacor; flumioxazin+metolachlor+terbuthylazine+glufosinate; flumioxazin+metolachlor+terbuthylazine+glufosinate+benoxacor; flumioxazin+S-metolachlor+terbuthylazine+glufosinate; flumioxazin+S-metolachlor+terbuthylazine+glufosinate+benoxacor; flumioxazin+atrazine+nicosulfuron+glufosinate; flumioxazin+atrazine+nicosulfuron+glufosinate+benoxacor; fluthiacet-methyl+prosulfuron+primisulfuron+glufosinate; fluthiacet-methyl+prosulfuron+dicamba+glulosinate; fluthiacet-methyl+primisulfuron+dicamba+glufosinate; fluthiacet-methyl+nicosulfuron+primisulfuron+glufosinate; fluthiacet-methyl+nicosulfuron+prosulfuron+glufosinate; fluthiacet-methyl+rimsulfuron+primisulfuron+glufosinate; fluthiacet-methyl+rimsulfuron+prosulfuron+glufosinate; fluthiacet-methyl+metolachlor+isoxaflutole+glufosinate; fluthiacet-methyl+metolachlor+isoxaflutole+glufosinate+benoxacor; fluthiacet-methyl+S-metolachlor+isoxaflutole+glufosinate; fluthiacet-methyl+S-metolachlor+isoxaflutole+glufosinate+benoxacor; fluthiacet-methyl+metolachlor+mesotrione+glufosinate; fluthiacet-methyl+metolachlor+mesotrione+glufosinate+benoxacor; fluthiacet-methyl+S-metolachlor+mesotrione+glufosinate; fluthiacet-methyl+S-metolachlor+mesotrione+glufosinate+benoxacor; fluthiacet-methyl+metolachlor+atrazine+glufosinate; fluthiacet-methyl+metolachlor+atrazine+glufosinate+benoxacor; fluthiacet-methyl+S-metolachlor+atrazine+glufosinate; fluthiacet-methyl+S-metolachlor+atrazine+glufosinate+benoxacor; fluthiacet-methyl+metolachlor+terbuthylazine+glufosinate; fluthiacet-methyl +metolachlor+terbuthylazine+glufosinate+benoxacor; fluthiacet-methyl+S-metolachlor +terbuthylazine+glufosinate; fluthiacet-methyl+S-metolachlor+terbuthylazine+glufosinate+benoxacor; fluthiacet-methyl+atrazine+nicosulfuron+glufosinate; fluthiacet-methyl+atrazine+nicosulfuron+glufosinate+benoxacor; oxadiargyl+prosulfuron+primisulfuron+glufosinate; oxadiargyl+prosulfuron+dicamba+glufosinate; oxadiargyl+primisulfuron+dicamba+glufosinate; oxadiargyl+nicosulfuron+primisulfuron+glufosinate; oxadiargyl+nicosulfuron+prosulfuron+glufosinate; oxadiargyl+rimsulfuron +primisulfuron+glufosinate; oxadiargyl+rimsulfuron+prosulfuron+glufosinate; oxadiargyl+metolachlor+isoxaflutole+glufosinate; oxadiargyl+metolachlor+isoxaflutole +glufosinate+benoxacor; oxadiargyl+S-metolachlor+isoxaflutole+glufosinate; oxadiargyl+S-metolachlor+isoxaflutole+glufosinate+benoxacor; oxadiargyl+metolachlor+mesotrione+glufosinate; oxadiargyl+metolachlor+mesotrione+glufosinate +benoxacor; oxadiargyl+S-metolachlor+mesotrione+glufosinate; oxadiargyl+S-metolachlor+mesotrione+glufosinate+benoxacor; oxadiargyl+metolachlor+atrazine+glufosinate; oxadiargyl+metolachlor+atrazine+glufosinate+benoxacor; oxadiargyl+S-metolachlor+atrazine+glufosinate; oxadiargyl+S-metolachlor+atrazine+glufosinate+benoxacor; oxadiargyl+metolachlor+terbuthylazine+glufosinate; oxadiargyl+metolachlor+terbuthylazine+glufosinate+benoxacor; oxadiargyl+S-metolachlor+terbuthylazine+glufosinate; oxadiargyl+S-metolachlor+terbuthylazine+glufosinate+benoxacor; oxadiargyl+atrazine+nicosulfuron+glufosinate; oxadiargyl+atrazine+nicosulfuron+glufosinate+benoxacor; oxadiazon+prosulfuron+primisulfuron+glufosinate; oxadiazon+prosulfuron+dicamba+glufosinate; oxadiazon+primisulfuron+dicamba+glufosinate; oxadiazon+nicosulfuron+primisulfuron+glufosinate; oxadiazon+nicosulfuron+prosulfuron+glufosinate; oxadiazon+rimsulfuron+primisulfuron+glufosinate; oxadiazon+rimsulfuron+prosulfuron+glufosinate; oxadiazon+metolachlor+isoxaflutole+glufosinate; oxadiazon+metolachlor+isoxaflutole+glufosinate+benoxacor; oxadiazon+S-metolachlor+isoxaflutole+glufosinate; oxadiazon+S-metolachlor+isoxaflutole+glufosinate+benoxacor; oxadiazon+metolachlor+mesotrione+glufosinate; oxadiazon+metolachlor+mesotrione+glufosinate+benoxacor; oxadiazon+S-metolachlor+mesotrione+glufosinate; oxadiazon+S-metolachlor+mesotrione+glufosinate+benoxacor; oxadiazon+metolachlor+atrazine+glufosinate; oxadiazon+metolachlor+atrazine+glufosinate+benoxacor; oxadiazon+S-metolachlor+atrazine+glufosinate; oxadiazon+S-metolachlor+atrazine+glufosinate+benoxacor; oxadiazon+metolachlor+terbuthylazine+glufosinate; oxadiazon+metolachlor+terbuthylazine+glufosinate+benoxacor; oxadiazon+S-metolachlor+terbuthylazine+glufosinate; oxadiazon+S-metolachlor+terbuthylazine+glufosinate+benoxacor; oxadiazon+atrazine+nicosulfuron+glufosinate; oxadiazon+atrazine+nicosulfuron+glufosinate+benoxacor; pentoxazone+prosulfuron+primisulfuron+glufosinate; pentoxazone+prosulfuron+dicamba+glufosinate; pentoxazone+primisulfuron+dicamba+glufosinate; pentoxazone+nicosulfuron+primisulfuron+glufosinate; pentoxazone+nicosulfuron+prosulfuron+glufosinate; pentoxazone+rimsulfuron+primisulfuron+glufosinate; pentoxazone+rimsulfuron+prosulfuron+glufosinate; pentoxazone+metolachlor+isoxaflutole+glufosinate; pentoxazone+metolachlor+isoxaflutole+glufosinate+benoxacor; pentoxazone+S-metolachlor+isoxaflutole+glufosinate; pentoxazone+S-metolachlor+isoxaflutole+glufosinate+benoxacor; pentoxazone+metolachlor+mesotrione+glufosinate; pentoxazone+metolachlor+mesotrione+glufosinate+benoxacor; pentoxazone+S-metolachlor+mesotrione+glufosinate; pentoxazone+S-metolachlor+mesotrione+glufosinate+benoxacor; pentoxazone+metolachlor+atrazine +glufosinate; pentoxazone+metolachlor+atrazine+glufosinate+benoxacor; pentoxazone+S-metolachlor+atrazine+glufosinate; pentoxazone+S-metolachlor+atrazine+glufosinate+benoxacor; pentoxazone+metolachlor+terbuthylazine+glufosinate; pentoxazone+metolachlor+terbuthylazine+glufosinate+benoxacor; pentoxazone+S-metolachlor+terbuthylazine+glufosinate; pentoxazone+S-metolachlor +terbuthylazine+glufosinate+benoxacor; pentoxazone+atrazine+nicosulfuron+glufosinate; pentoxazone+atrazine+nicosulfuron+glufosinate+benoxacor; sulfentrazone+prosulfuron+primisulfuron+glufosinate; sulfentrazone+prosulfuron+dicamba+glufosinate; sulfentrazone+primisulfuron+dicamba+glufosinate; sulfentrazone+nicosulfuron+primisulfuron+glufosinate; sulfentrazone+nicosulfuron+prosulfuron+glufosinate; sulfentrazone+rimsulfuron+primisulfuron+glufosinate; sulfentrazone+rimsulfuron+prosulfuron+glufosinate; sulfentrazone+metolachlor+isoxaflutole+glufosinate; sulfentrazone+metolachlor+isoxaflutole+glufosinate+benoxacor; sulfentrazone+S-metolachlor+isoxaflutole+glufosinate; sulfentrazone+S-metolachlor+isoxaflutole+glufosinate+benoxacor; sulfentrazone+metolachlor+mesotrione+glufosinate; sulfentrazone+metolachlor+mesotrione+glufosinate+benoxacor; sulfentrazone+S-metolachlor+mesotrione+glufosinate; sulfentrazone+S-metolachlor+mesotrione+glufosinate+benoxacor; sulfentrazone+metolachlor+atrazine +glufosinate; sulfentrazone+metolachlor+atrazine+glufosinate+benoxacor, sulfentrazone+S-metolachlor+atrazine+glufosinate; sulfentrazone+S-metolachlor+atrazine+glufosinate+benoxacor; sulfentrazone+metolachlor+terbuthylazine+glufosinate; sulfentrazone+metolachlor+terbuthylazine+glufosinate+benoxacor; sulfentrazone+S-metolachlor+terbuthylazine+glufosinate; sulfentrazone+S-metolachlor +terbuthylazine+glufosinate+benoxacor; sulfentrazone+atrazine+nicosulfuron+glufosinate; sulfentrazone+atrazine+nicosulfuron+glufosinate+benoxacor; fluazolate+prosulfuron+primisulfuron+glufosinate; fluazolate+prosulfuron+dicamba+glufosinate; fluazolate+primisulfuron+dicamba+glufosinate; fluazolate+nicosulfuron+primisulfuron +glufosinate; fluazolate+nicosulfuron+prosulfuron+glufosinate; fluazolate+rimsulfuron +primisulfuron+glufosinate; fluazolate+rimsulfuron+prosulfuron+glufosinate; fluazolate +metolachlor+isoxaflutole+glufosinate; fluazolate+metolachlor+isoxaflutole+glufosinate+benoxacor; fluazolate+S-metolachlor+isoxaflutole+glufosinate; fluazolate +S-metolachlor+isoxaflutole+glufosinate+benoxacor; fluazolate+metolachlor+mesotrione+glufosinate; fluazolate+metolachlor+mesotrione+glufosinate+benoxacor; fluazolate+S-metolachlor+mesotrione+glufosinate; fluazolate+S-metolachlor+mesotrione+glufosinate+benoxacor; fluazolate+metolachlor+atrazine+glufosinate; fluazolate+metolachlor+atrazine+glufosinate+benoxacor; fluazolate+S-metolachlor+atrazine+glufosinate; fluazolate+S-metolachlor+atrazine+glufosinate+benoxacor; fluazolate+metolachlor+terbuthylazine+glufosinate; fluazolate+metolachlor+terbuthylazine+glufosinate+benoxacor; fluazolate+S-metolachlor+terbuthylazine+glufosinate; fluazolate+S-metolachlor+terbuthylazine+glufosinate+benoxacor; fluazolate+atrazine+nicosulfuron+glufosinate; fluazolate+atrazine+nicosulfuron+glufosinate+benoxacor; pyraflufen-ethyl+prosulfuron+primisulfuron+glufosinate; pyraflufen-ethyl+prosulfuron+dicamba+glufosinate; pyraflufen-ethyl+primisulfuron+dicamba+glufosinate; pyraflufen-ethyl+nicosulfuron+primisulfuron+glufosinate; pyraflufen-ethyl+nicosulfuron+prosulfuron+glufosinate; pyraflufen-ethyl+rimsulfuron+primisulfuron+glufosinate; pyraflufen-ethyl+rimsulfuron+prosulfuron+glufosinate; pyraflufen-ethyl+metolachlor+isoxaflutole+glufosinate; pyraflufen-ethyl+metolachlor+isoxaflutole+glufosinate+benoxacor; pyraflufen-ethyl+S-metolachlor+isoxaflutole+glufosinate; pyraflufen-ethyl+S-metolachlor+isoxaflutole+glufosinate+benoxacor; pyraflufen-ethyl+metolachlor+mesotrione+glufosinate; pyraflufen-ethyl+metolachlor+mesotrione+glufosinate+benoxacor; pyraflufen-ethyl+S-metolachlor+mesotrione+glufosinate; pyraflufen-ethyl+S-metolachlor+mesotrione+glufosinate+benoxacor; pyraflufen-ethyl+metolachlor+atrazine+glufosinate; pyraflufen-ethyl+metolachlor+atrazine+glufosinate+benoxacor; pyraflufen-ethyl+S-metolachlor+atrazine+glufosinate; pyraflufen-ethyl+S-metolachlor+atrazine+glufosinate+benoxacor; pyraflufen-ethyl+metolachlor+terbuthylazine+glufosinate; pyraflufen-ethyl+metolachlor +terbuthylazine+glufosinate+benoxacor; pyraflufen-ethyl+S-metolachlor+terbuthylazine+glufosinate; pyraflufen-ethyl+S-metolachlor+terbuthylazine+glufosinate +benoxacor; pyraflufen-ethyl+atrazine+nicosulfuron+glufosinate; pyraflufen-ethyl+atrazine+nicosulfuron+glufosinate+benoxacor; flumipropyn+prosulfuron+primisulfuron +glufosinate; flumipropyn+prosulfuron+dicamba+glufosinate; flumipropyn+primisulfuron+dicamba+glufosinate; flumipropyn+nicosulfuron+primisulfuron+glufosinate; flumipropyn+nicosulfuron+prosulfuron+glufosinate; flumipropyn+rimsulfuron+primisulfuron+glufosinate; flumipropyn+rimsulfuron+prosulfuron+glufosinate; flumipropyn+metolachlor+isoxaflutole+glufosinate; flumipropyn+metolachlor+isoxaflutole+glufosinate+benoxacor; flumipropyn+S-metolachlor+isoxaflutole+glufosinate; flumipropyn+S-metolachlor+isoxaflutole+glufosinate+benoxacor, flumipropyn+metolachlor+mesotrione+glufosinate; flumipropyn+metolachlor+mesotrione+glufosinate+benoxacor; flumipropyn+S-metolachlor+mesotrione+glufosinate; flumipropyn+S-metolachlor+mesotrione+glufosinate+benoxacor; flumipropyn+metolachlor+atrazine+glufosinate; flumipropyn+metolachlor+atrazine+glufosinate+benoxacor; flumipropyn+S-metolachlor+atrazine+glufosinate; flumipropyn+3-metolachlor+atrazine+glufosinate+benoxacor; flumipropyn+metolachlor+terbuthylazine+glufosinate; flumipropyn+metolachlor+terbuthylazine+glufosinate+benoxacor; flumipropyn+S-metolachlor+terbuthylazine+glufosinate; flumipropyn+S-metolachlor+terbuthylazine+glufosinate+benoxacor; flumipropyn+atrazine+nicosulfuron+glufosinate; flumipropyn+atrazine+nicosulfuron+glufosinate+benoxacor; flupropacil+prosulfuron+primisulfuron+glufosinate; flupropacil+prosulfuron +dicamba+glufosinate; flupropacil+primisulfuron+dicamba+glufosinate; flupropacil+nicosulfuron+primisulfuron+glufosinate; flupropacil+nicosulfuron+prosulfuron+glufosinate; flupropacil+rimsulfuron+primisulfuron+glufosinate; flupropacil+rimsulfuron +prosulfuron+glufosinate; flupropacil+metolachlor+isoxaflutole+glufosinate; flupropacil +metolachlor+isoxaflutole+glufosinate+benoxacor; flupropacil+S-metolachlor+isoxaflutole+glufosinate; flupropacil+S-metolachlor+isoxaflutole+glufosinate+benoxacor; flupropacil+metolachlor+mesotrione+glufosinate; flupropacil+metolachlor+mesotrione+glufosinate+benoxacor; flupropacil+S-metolachlor+mesotrione+glufosinate; flupropacil+S-metolachlor+mesotrione+glufosinate+benoxacor; flupropacil +metolachlor+atrazine+glufosinate; flupropacil+metolachlor+atrazine+glufosinate+benoxacor; flupropacil+S-metolachlor+atrazine+glufosinate; flupropacil+S-metolachlor +atrazine+glufosinate+benoxacor; flupropacil+metolachlor+terbuthylazine+glufosinate; flupropacil+metolachlor+terbuthylazine+glufosinate+benoxacor; flupropacil +S-metolachlor+terbuthylazine+glufosinate; flupropacil+S-metolachlor+terbuthylazine +glufosinate+benoxacor; flupropacil+atrazine+nicosulfuron+glufosinate; flupropacil+atrazine+nicosulfuron+glufosinate+benoxacor; nipyraclofen+prosulfuron+primisulfuron+glufosinate; nipyraclofen+prosulfuron+dicamba+glufosinate; nipyraclofen+primisulfuron+dicamba+glufosinate; nipyraclofen+nicosulfuron+primisulfuron+glufosinate; nipyraclofen+nicosulfuron+prosulfuron+glufosinate; nipyraclofen+rimsulfuron+primisulfuron+glufosinate; nipyraclofen+rimsulfuron+prosulfuron+glufosinate; nipyraclofen+metolachlor+isoxaflutole+glufosinate; nipyraclofen+metolachlor+isoxaflutole+glufosinate+benoxacor; nipyraclofen+S-metolachlor+isoxaflutole+glufosinate; nipyraclofen+S-metolachlor+isoxaflutole+glufosinate+benoxacor; nipyraclofen+metolachlor+mesotrione+glufosinate; nipyraclofen+metolachlor+mesotrione+glufosinate+benoxacor; nipyraclofen+S-metolachlor+mesotrione+glufosinate; nipyraclofen+S-metolachlor+mesotrione+glufosinate+benoxacor; nipyraclofen+metolachlor+atrazine+glufosinate; nipyraclofen+metolachlor+atrazine+glufosinate+benoxacor; nipyraclofen+S-metolachlor+atrazine+glufosinate; nipyraclofen+S-metolachlor+atrazine+glufosinate+benoxacor; nipyraclofen +metolachlor+terbuthylazine+glufosinate; nipyraclofen+metolachlor+terbuthylazine+glufosinate+benoxacor; nipyraclofen+S-metolachlor+terbuthylazine+glufosinate; nipyraclofen+S-metolachlor+terbuthylazine+glufosinate+benoxacor; nipyraclofen+atrazine+nicosulfuron+glufosinate; nipyraclofen+atrazine+nicosulfuron+glufosinate+benoxacor; benzfendizone+prosulfuron+primisulfuron+glufosinate; benzfendizone+prosulfuron+dicamba+glufosinate; benzfendizone+primisulfuron+dicamba+glufosinate; benzfendizone+nicosulfuron+primisulfuron+glufosinate; benzfendizone+nicosulfuron+prosulfuron+glufosinate; benzfendizone+rimsulfuron+primisulfuron+glufosinate; benzfendizone+rimsulfuron+prosulfuron+glufosinate; benzfendizone+metolachlor+isoxaflutole+glufosinate; benzfendizone+metolachlor+isoxaflutole+glufosinate+benoxacor; benzfendizone+S-metolachlor+isoxaflutole+glufosinate; benzfendizone+S-metolachlor+isoxaflutole+glufosinate+benoxacor; benzfendizone+metolachlor+mesotrione+glufosinate; benzfendizone+metolachlor+mesotrione+glufosinate+benoxacor; benzfendizone+S-metolachlor+mesotrione+glufosinate; benzfendizone+S-metolachlor+mesotrione+glufosinate+benoxacor; benzfendizone+metolachlor+atrazine+glufosinate; benzfendizone+metolachlor+atrazine+glufosinate +benoxacor; benzfendizone+S-metolachlor+atrazine+glufosinate; benzfendizone+S-metolachlor+atrazine+glufosinate+benoxacor; benzfendizone+metolachlor+terbuthylazine+glufosinate; benzfendizone+metolachlor+terbuthylazine+glufosinate+benoxacor; benzfendizone+S-metolachlor+terbuthylazine+glufosinate; benzfendizone+S-metolachlor+terbuthylazine+glufosinate+benoxacor; benzfendizone+atrazine+nicosulfuron+glufosinate; benzfendizone+atrazine+nicosulfuron+glufosinate+benoxacor; thidiazimin+prosulfuron+primisulfuron+glufosinate; thidiazimin+prosulfuron +dicamba+glufosinate; thidiazimin+primisulfuron+dicamba+glufosinate; thidiazimin+nicosulfuron+primisulfuron+glufosinate; thidiazimin+nicosulfuron+prosulfuron+glufosinate; thidiazimin+rimsulfuron+primisulfuron+glufosinate; thidiazimin+rimsulfuron +prosulfuron+glufosinate; thidiazimin+metolachlor+isoxaflutole+glufosinate; thidiazimin+metolachlor+isoxaflutole+glufosinate+benoxacor; thidiazimin+S-metolachlor+isoxaflutole+glufosinate; thidiazimin+S-metolachlor+isoxaflutole+glufosinate+benoxacor; thidiazimin+metolachlor+mesotrione+glufosinate; thidiazimin+metolachlor+mesotrione+glufosinate+benoxacor; thidiazimin+S-metolachlor+mesotrione+glufosinate; thidiazimin+S-metolachlor+mesotrione+glufosinate+benoxacor; thidiazimin+metolachlor+atrazine+glufosinate; thidiazimin+metolachlor+atrazine+glufosinate+benoxacor; thidiazimin+S-metolachlor+atrazine+glufosinate; thidiazimin+S-metolachlor+atrazine+glufosinate+benoxacor; thidiazimin+metolachlor +terbuthylazine+glufosinate; thidiazimin+metolachlor+terbuthylazine+glufosinate+benoxacor; thidiazimin+S-metolachlor+terbuthylazine+glufosinate; thidiazimin+S-metolachlor+terbuthylazine+glufosinate+benoxacor; thidiazimin+atrazine+nicosulfuron+glufosinate; and thidiazimin+atrazine+nicosulfuron+glufosinate+benoxacor.

Acifluorfen+metolachlor+isoxaflutole+glufosinate+MON 4660; acifluorfen+S-metolachlor+isoxaflutole+glufosinate+MON 4660; acifluorfen+metolachlor+mesotrione+glufosinate+MON 4660; acifluorfen+S-metolachlor+mesotrione+glufosinate+MON 4660; acifluorfen+metolachlor+atrazine+glufosinate+MON 4660; acifluorfen+S-metolachlor+atrazine+glufosinate+MON 4660; acifluorfen+metolachlor +terbuthylazine+glufosinate+MON 4660; acifluorfen+S-metolachlor+terbuthylazine+glufosinate+MON 4660; acifluorfen+atrazine+nicosulfuron+glufosinate+MON 4660; aclonifen+metolachlor+isoxaflutole+glufosinate+MON 4660; aclonifen+S-metolachlor +isoxaflutole+glufosinate+MON 4660; aclonifen+metolachlor+mesotrione+glufosinate+MON 4660; aclonifen+S-metolachlor+mesotrione+glufosinate+MON 4660; aclonifen+metolachlor+atrazine+glufosinate+MON 4660; aclonifen+S-metolachlor+atrazine+glufosinate+MON 4660; aclonifen+metolachlor+terbuthylazine +glufosinate+MON 4660; aclonifen+S-metolachlor+terbuthylazine+glufosinate+MON 4660; aclonifen+atrazine+nicosulfuron+glufosinate+MON 4660; bifenox+metolachlor +isoxaflutole+glufosinate+MON 4660; bifenox+S-metolachlor+isoxaflutole+glufosinate+MON 4660; bifenox+metolachlor+mesotrione+glufosinate+MON 4660; bifenox+S-metolachlor+mesotrione+glufosinate+MON 4660; bifenox+metolachlor+atrazine+glufosinate+MON 4660; bifenox+S-metolachlor+atrazine+glufosinate+MON 4660; bifenox+metolachlor+terbuthylazine+glufosinate+MON 4660; bifenox+S-metolachlor+terbuthylazine+glufosinate+MON 4660; bifenox+atrazine+nicosulfuron+glufosinate+MON 4660; chlomitrofen+metolachlor+isoxaflutole+glufosinate+MON 4660; chlomitrofen+S-metolachlor+isoxaflutole+glufosinate+MON 4660; chlomitrofen+metolachlor+mesotrione+glufosinate+MON 4660; chlomitrofen+S-metolachlor+mesotrione+glufosinate+MON 4660; chlomitrofen+metolachlor+atrazine+glufosinate +MON 4660; chlomitrofen+S-metolachlor+atrazine+glufosinate+MON 4660; chlomitrofen+metolachlor+terbuthylazine+glufosinate+MON 4660; chlomitrofen+S-metolachlor+terbuthylazine+glufosinate+MON 4660; chlomitrofen+atrazine+nicosulfuron+glufosinate+MON 4660; ethoxyfen+metolachlor+isoxaflutole+glufosinate+MON 4660; ethoxyfen+S-metolachlor+isoxaflutole+glufosinate+MON 4660; ethoxyfen+metolachlor+mesotrione+glufosinate+MON 4660; ethoxyfen+S-metolachlor+mesotrione+glufosinate+MON 4660; ethoxyfen+metolachlor+atrazine+glufosinate+MON 4660; ethoxyfen+S-metolachlor+atrazine+glufosinate+MON 4660; ethoxyfen+metolachlor+terbuthylazine+glufosinate+MON 4660; ethoxyfen+S-metolachlor+terbuthylazine+glufosinate+MON 4660; ethoxyfen+atrazine+nicosulfuron+glufosinate+MON 4660; fluoroglycofen+metolachlor+isoxaflutole+glufosinate+MON 4660; fluoroglycofen+S-metolachlor+isoxaflutole+glufosinate+MON 4660; fluoroglycofen+metolachlor+mesotrione+glufosinate+MON 4660; fluoroglycofen +S-metolachlor+mesotrione+glufosinate+MON 4660; fluoroglycofen+metolachlor+atrazine+glufosinate+MON 4660; fluoroglycofen+S-metolachlor+atrazine+glufosinate +MON 4660; fluoroglycofen+metolachlor+terbuthylazine+glufosinate+MON 4660; fluoroglycofen+S-metolachlor+terbuthylazine+glufosinate+MON 4660; fluoroglycofen+atrazine+nicosulfuron+glufosinate+MON 4660; fomesafen+metolachlor+isoxaflutole +glufosinate+MON 4660; fomesafen+S-metolachlor+isoxaflutole+glufosinate+MON 4660; fomesafen+metolachlor+mesotrione+glufosinate+MON 4660; fomesafen+S-metolachlor+mesotrione+glufosinate+MON 4660; fomesafen+metolachlor+atrazine+glufosinate+MON 4660; fomesafen+S-metolachlor+atrazine+glufosinate+MON 4660; fomesafen+metolachlor+terbuthylazine+glufosinate+MON 4660; fomesafen+S-metolachlor+terbuthylazine+glufosinate+MON 4660; fomesafen+atrazine+nicosulfuron+glufosinate+MON 4660; lactofen+metolachlor+isoxaflutole+glufosinate +MON 4660; lactofen+S-metolachlor+isoxaflutole+glufosinate+MON 4660; lactofen+metolachlor+mesotrione+glufosinate+MON 4660; lactofen+S-metolachlor+mesotrione +glufosinate+MON 4660; lactofen+metolachlor+atrazine+glufosinate+MON 4660; lactofen+S-metolachlor+atrazine+MON 4660; lactofen+metolachlor+terbuthylazine+glufosinate+MON 4660; lactofen+S-metolachlor+terbuthylazine+glufosinate+MON 4660; lactofen+atrazine+nicosulfuron+glufosinate+MON 4660; oxyfluorfen+metolachlor+isoxaflutole+glufosinate+MON 4660; oxyfluorfen+S-metolachlor+isoxaflutole+glufosinate+MON 4660; oxyfluorfen+metolachlor+mesotrione+glufosinate+MON 4660; oxyfluorfen+S-metolachlor+mesotrione+glufosinate+MON 4660; oxyfluorfen+metolachlor+atrazine+glufosinate+MON 4660; oxyfluorfen+S-metolachlor+atrazine+glufosinate+MON 4660; oxyfluorfen+metolachlor+terbuthylazine+glufosinate+MON 4660; oxyfluorfen+S-metolachlor+terbuthylazine+glufosinate+MON 4660; oxyfluorfen+atrazine+nicosulfuron+glufosinate+MON 4660; azafenidin+metolachlor+isoxaflutole+glufosinate+MON 4660; azafenidin+S-metolachlor+isoxaflutole+glufosinate+MON 4660; azafenidin+metolachlor+mesotrione+glufosinate+MON 4660; azafenidin+S-metolachlor+mesotrione+glufosinate+MON 4660; azafenidin+metolachlor+atrazine+glufosinate+MON 4660; azafenidin+S-metolachlor+atrazine+glufosinate+MON 4660; azafenidin+metolachlor +terbuthylazine+glufosinate+MON 4660; azafenidin+S-metolachlor+terbuthylazine+glufosinate+MON 4660; azafenidin+atrazine+nicosulfuron+glufosinate+MON 4660; carfentrazone-ethyl+metolachlor+isoxaflutole+glufosinate+MON 4660; carfentrazone-ethyl+S-metolachlor+isoxaflutole+glufosinate+MON 4660; carfentrazone-ethyl+metolachlor+mesotrione+glufosinate+MON 4660; carfentrazone-ethyl+S-metolachlor+mesotrione+glufosinate+MON 4660; carfentrazone-ethyl+metolachlor+atrazine+glufosinate+MON 4660; carfentrazone-ethyl+S-metolachlor+atrazine+glufosinate+MON 4660; carfentrazone-ethyl+metolachlor+terbuthylazine+glufosinate+MON 4660; carfentrazone-ethyl+S-metolachlor+terbuthylazine+glufosinate+MON 4660; carfentrazone-ethyl+atrazine+nicosulfuron+glufosinate+MON 4660; compound of the formula A+metolachlor+isoxaflutole+glufosinate+MON 4660; compound of the formula A+S-metolachlor+isoxaflutole+glufosinate+MON 4660; compound of the formula A+metolachlor+mesotrione+glufosinate+MON 4660; compound of the formula A+S-metolachlor+mesotrione+glufosinate+MON 4660; compound of the formula A+metolachlor+atrazine+glufosinate+MON 4660; compound of the formula A+S-metolachlor+atrazine+glufosinate+MON 4660; compound of the formula A+metolachlor +terbuthylazine+glufosinate+MON 4660; compound of the formula A+S-metolachlor+terbuthylazine+glufosinate+MON 4660; compound of the formula A+atrazine+nicosulfuron+glufosinate+MON 4660; cinidon-ethyl+metolachlor+isoxaflutole+glufosinate+MON 4660; cinidon-ethyl+S-metolachlor+isoxaflutole+glufosinate+MON 4660; cinidon-ethyl+metolachlor+mesotrione+glufosinate+MON 4660; cinidon-ethyl+S-metolachlor+mesotrione+glufosinate+MON 4660; cinidon-ethyl+metolachlor+atrazine+glufosinate+MON 4660; cinidon-ethyl+S-metolachlor+atrazine+glufosinate+MON 4660; cinidon-ethyl+metolachlor+terbuthylazine+glufosinate+MON 4660; cinidon-ethyl+S-metolachlor+terbuthylazine+glufosinate+MON 4660; cinidon-ethyl+atrazine+nicosulfuron+glufosinate+MON 4660; flumiclorac-pentyl+metolachlor+isoxaflutole+glufosinate+MON 4660; flumiclorac-pentyl+S-metolachlor+isoxaflutole+glufosinate+MON 4660; flumiclorac-pentyl+metolachlor+mesotrione+glufosinate+MON 4660; flumiclorac-pentyl+S-metolachlor+mesotrione+glufosinate+MON 4660; flumiclorac-pentyl+metolachlor+atrazine+glufosinate+MON 4660; flumiclorac-pentyl+S-metolachlor+atrazine+glufosinate+MON 4660; flumiclorac-pentyl+metolachlor+terbuthylazine+glufosinate+MON 4660; flumiclorac-pentyl+S-metolachlor+terbuthylazine+glufosinate+MON 4660; flumiclorac-pentyl+atrazine+nicosulfuron+glufosinate+MON 4660; flumioxazin+metolachlor+isoxaflutole+glufosinate+MON 4660; flumioxazin+S-metolachlor+isoxaflutole+glufosinate+MON 4660; flumioxazin+metolachlor+mesotrione+glufosinate+MON 4660; flumioxazin+S-metolachlor+mesotrione+glufosinate+MON 4660; flumioxazin+metolachlor+atrazine+glufosinate+MON 4660; flumioxazin+S-metolachlor+atrazine+glufosinate+MON 4660; flumioxazin+metolachlor+terbuthylazine+glufosinate+MON 4660; flumioxazin+S-metolachlor+terbuthylazine+glufosinate+MON 4660; flumioxazin+atrazine+nicosulfuron+glufosinate+MON 4660; fluthiacet-methyl+metolachlor+isoxaflutole+glufosinate+MON 4660; fluthiacet-methyl+S-metolachlor+isoxaflutole+glufosinate+MON 4660; fluthiacet-methyl+metolachlor+mesotrione+glufosinate+MON 4660; fluthiacet-methyl+S-metolachlor+mesotrione+glufosinate+MON 4660; fluthiacet-methyl+metolachlor+atrazine+glufosinate+MON 4660; fluthiacet-methyl+S-metolachlor+atrazine+glufosinate+MON 4660; fluthiacet-methyl+metolachlor+terbuthylazine+glufosinate+MON 4660; fluthiacet-methyl+S-metolachlor+terbuthylazine+glufosinate+MON 4660; fluthiacet-methyl+atrazine+nicosulfuron+glufosinate+MON 4660; oxadiargyl+metolachlor+isoxaflutole+glufosinate+MON 4660; oxadiargyl+S-metolachlor+isoxaflutole+glufosinate+MON 4660; oxadiargyl+metolachlor+mesotrione+glufosinate +MON 4660; oxadiargyl+S-metolachlor+mesotrione+glufosinate+MON 4660; oxadiargyl+metolachlor+atrazine+glufosinate+MON 4660; oxadiargyl+S-metolachlor +atrazine+glufosinate+MON 4660; oxadiargyl+metolachlor+terbuthylazine+glufosinate+MON 4660; oxadiargyl+S-metolachlor+terbuthylazine+glufosinate+MON 4660; oxadiargyl+atrazine+nicosulfuron+glufosinate+MON 4660; oxadiazon+metolachlor+isoxaflutole+glufosinate+MON 4660; oxadiazon+S-metolachlor+isoxaflutole+glufosinate+MON 4660; oxadiazon+metolachlor+mesotrione+glufosinate +MON 4660; oxadiazon+S-metolachlor+mesotrione+glufosinate+MON 4660; oxadiazon+metolachlor+atrazine+glufosinate+MON 4660; oxadiazon+S-metolachlor +atrazine+glufosinate+MON 4660; oxadiazon+metolachlor+terbuthylazine+glufosinate+MON 4660; oxadiazon+S-metolachlor+terbuthylazine+glufosinate+MON 4660; oxadiazon+atrazine+nicosulfuron+glufosinate+MON 4660; pentoxazone+metolachlor+isoxaflutole+glufosinate+MON 4660; pentoxazone+S-metolachlor+isoxaflutole+glufosinate+MON 4660; pentoxazone+metolachlor+mesotrione+glufosinate+MON 4660; pentoxazone+S-metolachlor+mesotrione+glufosinate+MON 4660; pentoxazone+metolachlor+atrazine+glufosinate+MON 4660; pentoxazone+S-metolachlor+atrazine+glufosinate+MON 4660; pentoxazone+metolachlor+terbuthylazine+glufosinate+MON 4660; pentoxazone+S-metolachlor+terbuthylazine+glufosinate+MON 4660; pentoxazone+atrazine+nicosulfuron+glufosinate+MON 4660; sulfentrazone+metolachlor+isoxaflutole+glufosinate+MON 4660; sulfentrazone+S-metolachlor+isoxaflutole+glufosinate+MON 4660; sulfentrazone+metolachlor+mesotrione+glufosinate+MON 4660; sulfentrazone+S-metolachlor+mesotrione+glufosinate+MON 4660; sulfentrazone+metolachlor+atrazine+glufosinate+MON 4660; sulfentrazone+S-metolachlor+atrazine+glufosinate+MON 4660; sulfentrazone+metolachlor+terbuthylazine+glufosinate+MON 4660; sulfentrazone+S-metolachlor+terbuthylazine+glufosinate+MON 4660; sulfentrazone+atrazine+nicosulfuron+glufosinate+MON 4660; fluazolate+metolachlor+isoxaflutole+glufosinate+MON 4660; fluazolate+S-metolachlor+isoxaflutole+glufosinate+MON 4660; fluazolate+metolachlor+mesotrione+glufosinate+MON 4660; fluazolate+S-metolachlor+mesotrione+glufosinate+MON 4660; fluazolate+metolachlor+atrazine+glufosinate+MON 4660; fluazolate+S-metolachlor+atrazine+glufosinate+MON 4660; fluazolate+metolachlor+terbuthylazine+glufosinate+MON 4660; fluazolate+S-metolachlor+terbuthylazine+glufosinate+MON 4660; fluazolate+atrazine+nicosulfuron+glufosinate +MON 4660; pyraflufen-ethyl+metolachlor+isoxaflutole+glufosinate+MON 4660; pyraflufen-ethyl+S-metolachlor+isoxaflutole+glufosinate+MON 4660; pyraflufen-ethyl+metolachlor+mesotrione+glufosinate+MON 4660; pyraflufen-ethyl+S-metolachlor+mesotrione+glufosinate+MON 4660; pyraflufen-ethyl+metolachlor+atrazine+glufosinate+MON 4660; pyraflufen-ethyl+S-metolachlor+atrazine+glufosinate+MON 4660; pyraflufen-ethyl+metolachlor+terbuthylazine+glufosinate+MON 4660; pyraflufen-ethyl+S-metolachlor+terbuthylazine+glufosinate+MON 4660; pyraflufen-ethyl+atrazine+nicosulfuron+glufosinate+MON 4660; flumipropyn+metolachlor+isoxaflutole +glufosinate+MON 4660; flumipropyn+S-metolachlor+isoxaflutole+glufosinate+MON 4660; flumipropyn+metolachlor+mesotrione+glufosinate+MON 4660; flumipropyn+S-metolachlor+mesotrione+glufosinate+MON 4660; flumipropyn+metolachlor+atrazine +glufosinate+MON 4660; flumipropyn+S-metolachlor+atrazine+glufosinate+MON 4660; flumipropyn+metolachlor+terbuthylazine+glufosinate+MON 4660; flumipropyn+S-metolachlor+terbuthylazine+glufosinate+MON 4660; flumipropyn+atrazine+nicosulfuron+glufosinate+MON 4660; flupropacil+metolachlor+isoxaflutole+glufosinate+MON 4660; flupropacil+S-metolachlor+isoxaflutole+glufosinate+MON 4660; flupropacil+metolachlor+mesotrione+glufosinate+MON 4660; flupropacil+S-metolachlor+mesotrione+glufosinate+MON 4660; flupropacil+metolachlor+atrazine+glufosinate+MON 4660; flupropacil+S-metolachlor+atrazine+glufosinate+MON 4660; flupropacil+metolachlor+terbuthylazine+glufosinate+MON 4660; flupropacil+S-metolachlor+terbuthylazine+glufosinate+MON 4660; flupropacil+atrazine+nicosulfuron+glufosinate+MON 4660; nipyraclofen+metolachlor+isoxaflutole+glufosinate+MON 4660; nipyraclofen+S-metolachlor+isoxaflutole+glufosinate+MON 4660; nipyraclofen+metolachlor+mesotrione+glufosinate+MON 4660; nipyraclofen+S-metolachlor+mesotrione+glufosinate+MON 4660; nipyraclofen+metolachlor+atrazine +glufosinate+MON 4660; nipyraclofen+S-metolachlor+atrazine+glufosinate+MON 4660; nipyraclofen+metolachlor+terbuthylazine+glufosinate+MON 4660; nipyraclofen+S-metolachlor+terbuthylazine+glufosinate+MON 4660; nipyraclofen+atrazine+nicosulfuron+glufosinate+MON 4660; benzfendizone+metolachlor+isoxaflutole+glufosinate+MON 4660; benzfendizone+S-metolachlor+isoxaflutole+glufosinate+MON 4660; benzfendizone+metolachlor+mesotrione+glufosinate+MON 4660; benzfendizone+S-metolachlor+mesotrione+glufosinate+MON 4660; benzfendizone+metolachlor+atrazine+glufosinate+MON 4660; benzfendizone+S-metolachlor+atrazine+glufosinate+MON 4660; benzfendizone+metolachlor+terbuthylazine+glufosinate+MON 4660; benzfendizone+S-metolachlor+terbuthylazine+glufosinate+MON 4660; benzfendizone+atrazine+nicosulfuron+glufosinate+MON 4660; thidiazimin +metolachlor+isoxaflutole+glufosinate+MON 4660; thidiazimin+S-metolachlor+isoxaflutole+glufosinate+MON 4660; thidiazimin+metolachlor+mesotrione+glufosinate +MON 4660; thidiazimin+S-metolachlor+mesotrione+glufosinate+MON 4660; thidiazimin+metolachlor+atrazine+glufosinate+MON 4660; thidiazimin+S-metolachlor +atrazine+glufosinate+MON 4660; thidiazimin+metolachlor+terbuthylazine+glufosinate+MON 4660; thidiazimin+S-metolachlor+terbuthylazine+glufosinate+MON 4660; and thidiazimin+atrazine+nicosulfuron+glufosinate+MON 4660.

Acifluorfen+metolachlor+isoxaflutole+glufosinate+FLURAZOLE; acifluorfen+S-metolachlor+isoxaflutole+glufosinate+FLURAZOLE; acifluorfen+metolachlor+mesotrione+glufosinate+FLURAZOLE; acifluorfen+S-metolachlor+mesotrione+glufosinate+FLURAZOLE; acifluorfen+metolachlor+atrazine+glufosinate+FLURAZOLE; acifluorfen+S-metolachlor+atrazine+glufosinate+FLURAZOLE; acifluorfen+metolachlor+terbuthylazine+glufosinate+FLURAZOLE; acifluorfen+S-metolachlor+terbuthylazine+glufosinate+FLURAZOLE; acifluorfen+atrazine+nicosulfuron+glufosinate+FLURAZOLE; aclonifen+metolachlor+isoxaflutole+glufosinate+FLURAZOLE; aclonifen+S-metolachlor+isoxaflutole+glufosinate+FLURAZOLE; aclonifen+metolachlor+mesotrione+glufosinate+FLURAZOLE; aclonifen +S-metolachlor+mesotrione+glufosinate+FLURAZOLE; aclonifen+metolachlor+atrazine+glufosinate+FLURAZOLE; aclonifen+S-metolachlor+atrazine+glufosinate+FLURAZOLE; aclonifen+metolachlor+terbuthylazine+glufosinate+FLURAZOLE; aclonifen+S-metolachlor+terbuthylazine+glufosinate+FLURAZOLE; aclonifen+atrazine+nicosulfuron+glufosinate+FLURAZOLE; bifenox+metolachlor+isoxaflutole+glufosinate+FLURAZOLE; bifenox+S-metolachlor+isoxaflutole+glufosinate+FLURAZOLE; bifenox+metolachlor+mesotrione+glufosinate+FLURAZOLE; bifenox+S-metolachlor+mesotrione+glufosinate+FLURAZOLE; bifenox+metolachlor+atrazine +glufosinate+FLURAZOLE; bifenox+S-metolachlor+atrazine+glufosinate+FLURAZOLE; bifenox+metolachlor+terbuthylazine+glufosinate+FLURAZOLE; bifenox +S-metolachlor+terbuthylazine+glufosinate+FLURAZOLE; bifenox+atrazine+nicosulfuron+glufosinate+FLURAZOLE; chlomitrofen+metolachlor+isoxaflutole+glufosinate+FLURAZOLE; chlomitrofen+S-metolachlor+isoxaflutole+glufosinate+FLURAZOLE; chlomitrofen+metolachlor+mesotrione+glufosinate+FLURAZOLE; chlomitrofen+S-metolachlor+mesotrione+glufosinate+FLURAZOLE; chlomitrofen+metolachlor+atrazine+glufosinate+FLURAZOLE; chlomitrofen+S-metolachlor+atrazine+glufosinate+FLURAZOLE; chlomitrofen+metolachlor+terbuthylazine+glufosinate+FLURAZOLE; chlomitrofen+S-metolachlor+terbuthylazine+glufosinate+FLURAZOLE; chlomitrofen+atrazine+nicosulfuron+glufosinate+FLURAZOLE; ethoxyfen+metolachlor+isoxaflutole+glufosinate+FLURAZOLE; ethoxyfen+S-metolachlor+isoxaflutole+glufosinate+FLURAZOLE; ethoxyfen+metolachlor+mesotrione+glufosinate+FLURAZOLE; ethoxyfen+S-metolachlor+mesotrione+glufosinate+FLURAZOLE; ethoxyfen+metolachlor+atrazine+glufosinate+FLURAZOLE; ethoxyfen+S-metolachlor+atrazine+glufosinate+FLURAZOLE; ethoxyfen +metolachlor+terbuthylazine+glufosinate+FLURAZOLE; ethoxyfen+S-metolachlor+terbuthylazine+glufosinate+FLURAZOLE; ethoxyfen+atrazine+nicosulfuron+glufosinate+FLURAZOLE; fluoroglycofen+metolachlor+isoxaflutole+glufosinate+FLURAZOLE; fluoroglycofen+S-metolachlor+isoxaflutole+glufosinate+FLURAZOLE; fluoroglycofen+metolachlor+mesotrione+glufosinate+FLURAZOLE; fluoroglycofen+S-metolachlor+mesotrione+glufosinate+FLURAZOLE; fluoroglycofen+metolachlor+atrazine+glufosinate+FLURAZOLE; fluoroglycofen+S-metolachlor+atrazine+glufosinate+FLURAZOLE; fluoroglycofen+metolachlor+terbuthylazine+glufosinate+FLURAZOLE; fluoroglycofen+S-metolachlor+terbuthylazine+glufosinate+FLURAZOLE; fluoroglycofen+atrazine+nicosulfuron+glufosinate+FLURAZOLE; fomesafen+metolachlor+isoxaflutole+glufosinate+FLURAZOLE; fomesafen+S-metolachlor+isoxaflutole+glufosinate+FLURAZOLE; fomesafen+metolachlor+mesotrione+glufosinate+FLURAZOLE; fomesafen+S-metolachlor+mesotrione+glufosinate+FLURAZOLE; fomesafen+metolachlor+atrazine+glufosinate+FLURAZOLE; fomesafen +S-metolachlor+atrazine+glufosinate+FLURAZOLE; fomesafen+metolachlor+terbuthylazine+glufosinate+FLURAZOLE; fomesafen+S-metolachlor+terbuthylazine+glufosinate+FLURAZOLE; fomesafen+atrazine+nicosulfuron+glufosinate+FLURAZOLE; lactofen+metolachlor+isoxaflutole+glufosinate+FLURAZOLE; lactofen+S-metolachlor+isoxaflutole+glufosinate+FLURAZOLE; lactofen+metolachlor+mesotrione+glufosinate+FLURAZOLE; lactofen+S-metolachlor+mesotrione+glufosinate+FLURAZOLE; lactofen+metolachlor+atrazine+glufosinate+FLURAZOLE; lactofen+S-metolachlor+atrazine+glufosinate+FLURAZOLE; lactofen+metolachlor+terbuthylazine+glufosinate+FLURAZOLE; lactofen+S-metolachlor+terbuthylazine+glufosinate+FLURAZOLE; lactofen+atrazine+nicosulfuron+glufosinate+FLURAZOLE; oxyfluorfen+metolachlor+isoxaflutole+glufosinate+FLURAZOLE; oxyfluorfen+S-metolachlor+isoxaflutole+glufosinate+FLURAZOLE; oxyfluorfen+metolachlor+mesotrione+glufosinate+FLURAZOLE; oxyfluorfen+S-metolachlor+mesotrione+glufosinate+FLURAZOLE; oxyfluorfen+metolachlor+atrazine+glufosinate+FLURAZOLE; oxyfluorfen+S-metolachlor+atrazine+glufosinate+FLURAZOLE; oxyfluorfen+metolachlor+terbuthylazine+glufosinate+FLURAZOLE; oxyfluorfen+S-metolachlor+terbuthylazine+glufosinate+FLURAZOLE; oxyfluorfen+atrazine+nicosulfuron+glufosinate+FLURAZOLE; azafenidin+metolachlor+isoxaflutole+glufosinate+FLURAZOLE; azafenidin+S-metolachlor+isoxaflutole+glufosinate+FLURAZOLE; azafenidin+metolachlor+mesotrione+glufosinate+FLURAZOLE; azafenidin+S-metolachlor+mesotrione+glufosinate+FLURAZOLE; azafenidin+metolachlor+atrazine+glufosinate+FLURAZOLE; azafenidin+S-metolachlor+atrazine +glufosinate+FLURAZOLE; azafenidin+metolachlor+terbuthylazine+glufosinate+FLURAZOLE; azafenidin+S-metolachlor+terbuthylazine+glufosinate+FLURAZOLE; azafenidin+atrazine+nicosulfuron+glufosinate+FLURAZOLE; carfentrazone-ethyl+metolachlor+isoxaflutole+glufosinate+FLURAZOLE; carfentrazone-ethyl+S-metolachlor+isoxaflutole+glufosinate+FLURAZOLE; carfentrazone-ethyl+metolachlor+mesotrione+glufosinate+FLURAZOLE; carfentrazone-ethyl+S-metolachlor+mesotrione +glufosinate+FLURAZOLE; carfentrazone-ethyl+metolachlor+atrazine+glufosinate+FLURAZOLE; carfentrazone-ethyl+S-metolachlor+atrazine+glufosinate+FLURAZOLE; carfentrazone-ethyl+metolachlor+terbuthylazine+glufosinate+FLURAZOLE; carfentrazone-ethyl+S-metolachlor+terbuthylazine+glufosinate+FLURAZOLE; carfentrazone-ethyl+atrazine+nicosulfuron+glufosinate+FLURAZOLE; compound of the formula A+metolachlor+isoxaflutole+glufosinate+FLURAZOLE; compound of the formula A+S-metolachlor+isoxaflutole+glufosinate+FLURAZOLE; compound of the formula A+metolachlor+mesotrione+glufosinate+FLURAZOLE; compound of the formula A+S-metolachlor+mesotrione+glufosinate+FLURAZOLE; compound of the formula A+metolachlor+atrazine+glufosinate+FLURAZOLE; compound of the formula A+S-metolachlor+atrazine+glufosinate+FLURAZOLE; compound of the formula A+metolachlor+terbuthylazine+glufosinate+FLURAZOLE; compound of the formula A+S-metolachlor+terbuthylazine+glufosinate+FLURAZOLE; compound of the formula A+atrazine+nicosulfuron+glufosinate+FLURAZOLE; cinidon-ethyl+metolachlor+isoxaflutole+glufosinate+FLURAZOLE; cinidon-ethyl+S-metolachlor+isoxaflutole+glufosinate+FLURAZOLE; cinidon-ethyl+metolachlor+mesotrione+glufosinate+FLURAZOLE; cinidon-ethyl+S-metolachlor+mesotrione+glufosinate+FLURAZOLE; cinidon-ethyl+metolachlor+atrazine+glufosinate+FLURAZOLE; cinidon-ethyl+S-metolachlor+atrazine+glufosinate+FLURAZOLE; cinidon-ethyl+metolachlor+terbuthylazine+glufosinate+FLURAZOLE; cinidon-ethyl+S-metolachlor+terbuthylazine +glufosinate+FLURAZOLE; cinidon-ethyl+atrazine+nicosulfuron+glufosinate+FLURAZOLE; flumiclorac-pentyl+metolachlor+isoxaflutole+glufosinate+FLURAZOLE; flumiclorac-pentyl+S-metolachlor+isoxaflutole+glufosinate+FLURAZOLE; flumiclorac-pentyl+metolachlor+mesotrione+glufosinate+FLURAZOLE; flumiclorac-pentyl+S-metolachlor+mesotrione+glufosinate+FLURAZOLE; flumiclorac-pentyl+metolachlor+atrazine+glufosinate+FLURAZOLE; flumiclorac-pentyl+S-metolachlor+atrazine+glufosinate+FLURAZOLE; flumiclorac-pentyl+metolachlor+terbuthylazine+glufosinate+FLURAZOLE; flumiclorac-pentyl+S-metolachlor+terbuthylazine+glufosinate+FLURAZOLE; flumiclorac-pentyl+atrazine+nicosulfuron+glufosinate+FLURAZOLE; flumioxazin+metolachlor+isoxaflutole+glufosinate+FLURAZOLE; flumioxazin+S-metolachlor+isoxaflutole+glufosinate+FLURAZOLE; flumioxazin+metolachlor+mesotrione+glufosinate+FLURAZOLE; flumioxazin+S-metolachlor+mesotrione+glufosinate+FLURAZOLE; flumioxazin+metolachlor+atrazine+glufosinate+FLURAZOLE; flumioxazin+S-metolachlor+atrazine+glufosinate+FLURAZOLE; flumioxazin+metolachlor+terbuthylazine+glufosinate+FLURAZOLE; flumioxazin+S-metolachlor+terbuthylazine+glufosinate+FLURAZOLE; flumioxazin+atrazine+nicosulfuron+glufosinate+FLURAZOLE; fluthiacet-methyl+metolachlor+isoxaflutole+glufosinate+FLURAZOLE; fluthiacet-methyl+S-metolachlor+isoxaflutole+glufosinate+FLURAZOLE; fluthiacet-methyl+metolachlor+mesotrione+glufosinate+FLURAZOLE; fluthiacet-methyl+S-metolachlor+mesotrione+glufosinate+FLURAZOLE; fluthiacet-methyl+metolachlor+atrazine+glufosinate+FLURAZOLE; fluthiacet-methyl+S-metolachlor+atrazine+glufosinate+FLURAZOLE; fluthiacet-methyl+metolachlor+terbuthylazine+glufosinate+FLURAZOLE; fluthiacet-methyl+S-metolachlor+terbuthylazine+glufosinate+FLURAZOLE; fluthiacet-methyl+atrazine+nicosulfuron+glufosinate+FLURAZOLE; oxadiargyl+metolachlor+isoxaflutole+glufosinate+FLURAZOLE; oxadiargyl+S-metolachlor+isoxaflutole+glufosinate+FLURAZOLE; oxadiargyl+metolachlor+mesotrione+glufosinate+FLURAZOLE; oxadiargyl+S-metolachlor+mesotrione+glufosinate+FLURAZOLE; oxadiargyl+metolachlor+atrazine +glufosinate+FLURAZOLE; oxadiargyl+S-metolachlor+atrazine+glufosinate+FLURAZOLE; oxadiargyl+metolachlor+terbuthylazine+glufosinate+FLURAZOLE; oxadiargyl+S-metolachlor+terbuthylazine+glufosinate+FLURAZOLE; oxadiargyl+atrazine+nicosulfuron+glufosinate+FLURAZOLE; oxadiazon+metolachlor+isoxaflutole+glufosinate+FLURAZOLE; oxadiazon+S-metolachlor+isoxaflutole+glufosinate+FLURAZOLE; oxadiazon+metolachlor+mesotrione+glufosinate+FLURAZOLE; oxadiazon+S-metolachlor+mesotrione+glufosinate+FLURAZOLE; oxadiazon+metolachlor+atrazine+glufosinate+FLURAZOLE; oxadiazon+S-metolachlor+atrazine+glufosinate+FLURAZOLE; oxadiazon+metolachlor+terbuthylazine+glufosinate+FLURAZOLE; oxadiazon+S-metolachlor+terbuthylazine+glufosinate+FLURAZOLE; oxadiazon+atrazine+nicosulfuron+glufosinate+FLURAZOLE; pentoxazone+metolachlor+isoxaflutole+glufosinate+FLURAZOLE; pentoxazone+S-metolachlor+isoxaflutole+glufosinate+FLURAZOLE; pentoxazone+metolachlor+mesotrione+glufosinate+FLURAZOLE; pentoxazone+S-metolachlor+mesotrione+glufosinate+FLURAZOLE; pentoxazone+metolachlor+atrazine+glufosinate+FLURAZOLE; pentoxazone+S-metolachlor+atrazine+glufosinate+FLURAZOLE; pentoxazone+metolachlor+terbuthylazine+glufosinate+FLURAZOLE; pentoxazone+S-metolachlor+terbuthylazine+glufosinate+FLURAZOLE; pentoxazone+atrazine+nicosulfuron+glufosinate+FLURAZOLE; sulfentrazone+metolachlor+isoxaflutole+glufosinate+FLURAZOLE; sulfentrazone+S-metolachlor+isoxaflutole+glufosinate+FLURAZOLE; sulfentrazone+metolachlor+mesotrione+glufosinate+FLURAZOLE; sulfentrazone+S-metolachlor+mesotrione+glufosinate+FLURAZOLE; sulfentrazone+metolachlor+atrazine+glufosinate+FLURAZOLE; sulfentrazone+S-metolachlor+atrazine+glufosinate+FLURAZOLE; sulfentrazone+metolachlor+terbuthylazine+glufosinate+FLURAZOLE; sulfentrazone+S-metolachlor+terbuthylazine +glufosinate+FLURAZOLE; sulfentrazone+atrazine+nicosulfuron+glufosinate+FLURAZOLE; fluazolate+metolachlor+isoxaflutole+glufosinate+FLURAZOLE; fluazolate+S-metolachlor+isoxaflutole+glufosinate+FLURAZOLE; fluazolate+metolachlor+mesotrione+glufosinate+FLURAZOLE; fluazolate+S-metolachlor+mesotrione+glufosinate+FLURAZOLE; fluazolate+metolachlor+atrazine+glufosinate+FLURAZOLE; fluazolate+S-metolachlor+atrazine+glufosinate+FLURAZOLE; fluazolate +metolachlor+terbuthylazine+glufosinate+FLURAZOLE; fluazolate+S-metolachlor+terbuthylazine+glufosinate+FLURAZOLE; fluazolate+atrazine+nicosulfuron+glufosinate+FLURAZOLE; pyraflufen-ethyl+metolachlor+isoxaflutole+glufosinate+FLURAZOLE; pyraflufen-ethyl+S-metolachlor+isoxaflutole+glufosinate+FLURAZOLE; pyraflufen-ethyl+metolachlor+mesotrione+glufosinate+FLURAZOLE; pyraflufen-ethyl+S-metolachlor+mesotrione+glufosinate+FLURAZOLE; pyraflufen-ethyl+metolachlor+atrazine+glufosinate+FLURAZOLE; pyraflufen-ethyl+S-metolachlor+atrazine+glufosinate+FLURAZOLE; pyraflufen-ethyl+metolachlor+terbuthylazine+glufosinate+FLURAZOLE; pyraflufen-ethyl+S-metolachlor+terbuthylazine+glufosinate+FLURAZOLE; pyraflufen-ethyl+atrazine+nicosulfuron+glufosinate+FLURAZOLE; flumipropyn+metolachlor+isoxaflutole+glufosinate+FLURAZOLE; flumipropyn+S-metolachlor+isoxaflutole+glufosinate+FLURAZOLE; flumipropyn+metolachlor+mesotrione+glufosinate+FLURAZOLE; flumipropyn+S-metolachlor+mesotrione+glufosinate+FLURAZOLE; flumipropyn+metolachlor+atrazine+glufosinate+FLURAZOLE; flumipropyn+S-metolachlor+atrazine+glufosinate+FLURAZOLE; flumipropyn+metolachlor+terbuthylazine+glufosinate+FLURAZOLE; flumipropyn+S-metolachlor+terbuthylazine+glufosinate+FLURAZOLE; flumipropyn+atrazine+nicosulfuron+glufosinate+FLURAZOLE; flupropacil+metolachlor+isoxaflutole+glufosinate+FLURAZOLE; flupropacil+S-metolachlor+isoxaflutole+glufosinate+FLURAZOLE; flupropacil+metolachlor+mesotrione+glufosinate+FLURAZOLE; flupropacil+S-metolachlor+mesotrione+glufosinate+FLURAZOLE; flupropacil+metolachlor+atrazine+glufosinate+FLURAZOLE; flupropacil+S-metolachlor+atrazine +glufosinate+FLURAZOLE; flupropacil+metolachlor+terbuthylazine+glufosinate+FLURAZOLE; flupropacil+S-metolachlor+terbuthylazine+glufosinate+FLURAZOLE; flupropacil+atrazine+nicosulfuron+glufosinate+FLURAZOLE; nipyraclofen+metolachlor+isoxaflutole+glufosinate+FLURAZOLE; nipyraclofen+S-metolachlor+isoxaflutole+glufosinate+FLURAZOLE; nipyraclofen+metolachlor+mesotrione+glufosinate+FLURAZOLE; nipyraclofen+S-metolachlor+mesotrione+glufosinate+FLURAZOLE; nipyraclofen+metolachlor+atrazine+glufosinate+FLURAZOLE; nipyraclofen+S-metolachlor+atrazine+glufosinate+FLURAZOLE; nipyraclofen+metolachlor+terbuthylazine+glufosinate+FLURAZOLE; nipyraclofen+S-metolachlor+terbuthylazine+glufosinate+FLURAZOLE; nipyraclofen+atrazine+nicosulfuron+glufosinate+FLURAZOLE; benzfendizone+metolachlor+isoxaflutole+glufosinate+FLURAZOLE; benzfendizone+S-metolachlor+isoxaflutole+glufosinate+FLURAZOLE; benzfendizone+metolachlor+mesotrione+glufosinate+FLURAZOLE; benzfendizone+S-metolachlor+mesotrione+glufosinate+FLURAZOLE; benzfendizone+metolachlor+atrazine+glufosinate+FLURAZOLE; benzfendizone+S-metolachlor+atrazine+glufosinate+FLURAZOLE; benzfendizone+metolachlor+terbuthylazine+glufosinate+FLURAZOLE; benzfendizone+S-metolachlor+terbuthylazine+glufosinate+FLURAZOLE; benzfendizone+atrazine+nicosulfuron+glufosinate+FLURAZOLE; thidiazimin+metolachlor+isoxaflutole+glufosinate+FLURAZOLE; thidiazimin+S-metolachlor+isoxaflutole+glufosinate+FLURAZOLE; thidiazimin+metolachlor+mesotrione+glufosinate+FLURAZOLE; thidiazimin+S-metolachlor+mesotrione+glufosinate+FLURAZOLE; thidiazimin+metolachlor+atrazine+glufosinate+FLURAZOLE; thidiazimin+S-metolachlor+atrazine+glufosinate+FLURAZOLE; thidiazimin+metolachlor+terbuthylazine+glufosinate+FLURAZOLE; thidiazimin+S-metolachlor+terbuthylazine+glufosinate+FLURAZOLE; and thidiazimin+atrazine+nicosulfuron+glufosinate+FLURAZOLE. Acifluorfen+metolachlor+isoxaflutole+glufosinate+DICHLORMID; acifluorfen+S-metolachlor+isoxaflutole+glufosinate+DICHLORMID; acifluorfen+metolachlor+mesotrione+glufosinate+DICHLORMID; acifluorfen+S-metolachlor+mesotrione+glufosinate+DICHLORMID; acifluorfen+metolachlor+atrazine+glufosinate+DICHLORMID; acifluorfen+S-metolachlor+atrazine+glufosinate+DICHLORMID; acifluorfen+metolachlor+terbuthylazine+glufosinate+DICHLORMID; acifluorfen+S-metolachlor+terbuthylazine+glufosinate+DICHLORMID; acifluorfen+atrazine+nicosulfuron+glufosinate+DICHLORMID; aclonifen+metolachlor+isoxaflutole+glufosinate+DICHLORMID; aclonifen+S-metolachlor+isoxaflutole+glufosinate+DICHLORMID; aclonifen+metolachlor+mesotrione+glufosinate+DICHLORMID; aclonifen+S-metolachlor+mesotrione+DICHLORMID; aclonifen+metolachlor+atrazine +glufosinate+DICHLORMID; aclonifen+S-metolachlor+atrazine+glufosinate+DICHLORMID; aclonifen+metolachlor+terbuthylazine+glufosinate+DICHLORMID; aclonifen+S-metolachlor+terbuthylazine+glufosinate+DICHLORMID; aclonifen+atrazine+nicosulfuron+glufosinate+DICHLORMID; bifenox+metolachlor+isoxaflutole +glufosinate+DICHLORMID; bifenox+S-metolachlor+isoxaflutole+glufosinate+DICHLORMID; bifenox+metolachlor+mesotrione+glufosinate+DICHLORMID; bifenox+S-metolachlor+mesotrione+glufosinate+DICHLORMID; bifenox+metolachlor+atrazine +glufosinate+DICHLORMID; bifenox+S-metolachlor+atrazine+glufosinate+DICHLORMID; bifenox+metolachlor+terbuthylazine+glufosinate+DICHLORMID; bifenox+S-metolachlor+terbuthylazine+glufosinate+DICHLORMID; bifenox+atrazine+nicosulfuron+glufosinate+DICHLORMID; chlomitrofen+metolachlor+isoxaflutole+glufosinate+DICHLORMID; chlomitrofen+S-metolachlor+isoxaflutole+glufosinate+DICHLORMID; chlomitrofen+metolachlor+mesotrione+glufosinate+DICHLORMID; chlomitrofen+S-metolachlor+mesotrione+glufosinate+DICHLORMID; chlomitrofen+metolachlor+atrazine+glufosinate+DICHLORMID; chlomitrofen+S-metolachlor+atrazine+glufosinate+DICHLORMID; chlomitrofen+metolachlor+terbuthylazine+glufosinate+DICHLORMID; chlomitrofen+S-metolachlor+terbuthylazine+glufosinate+DICHLORMID; chlomitrofen+atrazine+nicosulfuron+glufosinate+DICHLORMID; ethoxyfen+metolachlor+isoxaflutole+glufosinate+DICHLORMID; ethoxyfen+S-metolachlor+isoxaflutole+glufosinate+DICHLORMID; ethoxyfen+metolachlor+mesotrione+glufosinate+DICHLORMID; ethoxyfen+S-metolachlor+mesotrione+glufosinate+DICHLORMID; ethoxyfen+metolachlor+atrazine+glufosinate+DICHLORMID; ethoxyfen+S-metolachlor+atrazine+glufosinate+DICHLORMID; ethoxyfen+metolachlor+terbuthylazine+glufosinate+DICHLORMID; ethoxyfen+S-metolachlor+terbuthylazine+glufosinate+DICHLORMID; ethoxyfen+atrazine+nicosulfuron+glufosinate+DICHLORMID; fluoroglycofen+metolachlor+isoxaflutole+glufosinate+DICHLORMID; fluoroglycofen+S-metolachlor+isoxaflutole+glufosinate+DICHLORMID; fluoroglycofen+metolachlor+mesotrione+glufosinate+DICHLORMID; fluoroglycofen+S-metolachlor+mesotrione+glufosinate+DICHLORMID; fluoroglycofen+metolachlor+atrazine+glufosinate+DICHLORMID; fluoroglycofen+S-metolachlor+atrazine+glufosinate+DICHLORMID; fluoroglycofen+metolachlor+terbuthylazine+glufosinate+DICHLORMID; fluoroglycofen+S-metolachlor+terbuthylazine+glufosinate+DICHLORMID; fluoroglycofen+atrazine+nicosulfuron+glufosinate+DICHLORMID; fomesafen+metolachlor+isoxaflutole+glufosinate+DICHLORMID; fomesafen+S-metolachlor+isoxaflutole+glufosinate+DICHLORMID; fomesafen+metolachlor+mesotrione+glufosinate+DICHLORMID; fomesafen+S-metolachlor+mesotrione+glufosinate+DICHLORMID; fomesafen+metolachlor+atrazine+glufosinate+DICHLORMID; fomesafen+S-metolachlor+atrazine+glufosinate+DICHLORMID; fomesafen+metolachlor+terbuthylazine+glufosinate+DICHLORMID; fomesafen+S-metolachlor+terbuthylazine+glufosinate+DICHLORMID; fomesafen+atrazine+nicosulfuron+glufosinate+DICHLORMID; lactofen+metolachlor+isoxaflutole+glufosinate+DICHLORMID; lactofen+S-metolachlor+isoxaflutole+glufosinate+DICHLORMID; lactofen+metolachlor+mesotrione+glufosinate+DICHLORMID; lactofen +S-metolachlor+mesotrione+glufosinate+DICHLORMID; lactofen+metolachlor+atrazine+glufosinate+DICHLORMID; lactofen+S-metolachlor+atrazine+glufosinate+DICHLORMID; lactofen+metolachlor+terbuthylazine+glufosinate+DICHLORMID; lactofen+S-metolachlor+terbuthylazine+glufosinate+DICHLORMID; lactofen+atrazine +nicosulfuron+glufosinate+DICHLORMID; oxyfluorfen+metolachlor+isoxaflutole+glufosinate+DICHLORMID; oxyfluorfen+S-metolachlor+isoxaflutole+glufosinate+DICHLORMID; oxyfluorfen+metolachlor+mesotrione+glufosinate+DICHLORMID; oxyfluorfen+S-metolachlor+mesotrione+glufosinate+DICHLORMID; oxyfluorfen+metolachlor+atrazine+glufosinate+DICHLORMID; oxyfluorfen+S-metolachlor+atrazine +glufosinate+DICHLORMID; oxyfluorfen+metolachlor+terbuthylazine+glufosinate+DICHLORMID; oxyfluorfen+S-metolachlor+terbuthylazine+glufosinate+DICHLORMID; oxyfluorfen+atrazine+nicosulfuron+glufosinate+DICHLORMID; azafenidin+metolachlor+isoxaflutole+glufosinate+DICHLORMID; azafenidin+S-metolachlor+isoxaflutole+glufosinate+DICHLORMID; azafenidin+metolachlor+mesotrione+glufosinate+DICHLORMID; azafenidin+S-metolachlor+mesotrione+glufosinate+DICHLORMID; azafenidin+metolachlor+atrazine+glufosinate+DICHLORMID; azafenidin+S-metolachlor+atrazine+glufosinate+DICHLORMID; azafenidin+metolachlor+terbuthylazine+glufosinate+DICHLORMID; azafenidin+S-metolachlor+terbuthylazine+glufosinate+DICHLORMID; azafenidin+atrazine+nicosulfuron+glufosinate+DICHLORMID; carfentrazone-ethyl+metolachlor+isoxaflutole+glufosinate +DICHLORMID; carfentrazone-ethyl+S-metolachlor+isoxaflutole+glufosinate+DICHLORMID; carfentrazone-ethyl+metolachlor+mesotrione+glufosinate+DICHLORMID; carfentrazone-ethyl+S-metolachlor+mesotrione+glufosinate+DICHLORMID; carfentrazone-ethyl+metolachlor+atrazine+glufosinate+DICHLORMID; carfentrazone-ethyl+S-metolachlor+atrazine+glufosinate+DICHLORMID; carfentrazone-ethyl+metolachlor+terbuthylazine+glufosinate+DICHLORMID; carfentrazone-ethyl+S-metolachlor+terbuthylazine+glufosinate+DICHLORMID; carfentrazone-ethyl+atrazine+nicosulfuron+DICHLORMID; compound of the formula A +metolachlor+isoxaflutole+glufosinate+DICHLORMID; compound of the formula A+S-metolachlor+isoxaflutole+glufosinate+DICHLORMID; compound of the formula A+metolachlor+mesotrione+glufosinate+DICHLORMID; compound of the formula A+S-metolachlor+mesotrione+glufosinate+DICHLORMID; compound of the formula A+metolachlor+atrazine+glufosinate+DICHLORMID; compound of the formula A+S-metolachlor+atrazine+glufosinate+DICHLORMID; compound of the formula A+metolachlor+terbuthylazine+glufosinate+DICHLORMID; compound of the formula A+S-metolachlor+terbuthylazine+glufosinate+DICHLORMID; compound of the formula A+atrazine+nicosulfuron+glufosinate+DICHLORMID; cinidon-ethyl+metolachlor+isoxaflutole+glufosinate+DICHLORMID; cinidon-ethyl+S-metolachlor+isoxaflutole+glufosinate+DICHLORMID; cinidon-ethyl+metolachlor+mesotrione+glufosinate+DICHLORMID; cinidon-ethyl+S-metolachlor+mesotrione+glufosinate+DICHLORMID; cinidon-ethyl+metolachlor+atrazine+glufosinate+DICHLORMID; cinidon-ethyl+S-metolachlor+atrazine+glufosinate+DICHLORMID; cinidon-ethyl+metolachlor+terbuthylazine+glufosinate+DICHLORMID; cinidon-ethyl+S-metolachlor+terbuthylazine +glufosinate+DICHLORMID; cinidon-ethyl+atrazine+nicosulfuron+glufosinate+DICHLORMID; flumiclorac-pentyl+metolachlor+isoxaflutole+DICHLORMID; flumiclorac-pentyl+S-metolachlor+isoxaflutole+glufosinate+DICHLORMID; flumiclorac-pentyl+metolachlor+mesotrione+glufosinate+DICHLORMID; flumiclorac-pentyl+S-metolachlor +mesotrione+glufosinate+DICHLORMID; flumiclorac-pentyl+metolachlor+atrazine+glufosinate+DICHLORMID; flumiclorac-pentyl+S-metolachlor+atrazine+glufosinate+DICHLORMID; flumiclorac-pentyl+metolachlor+terbuthylazine+glufosinate+DICHLORMID; flumiclorac-pentyl+S-metolachlor+terbuthylazine+glufosinate+DICHLORMID; flumiclorac-pentyl+atrazine+nicosulfuron+glufosinate+DICHLORMID; flumioxazin+metolachlor+isoxaflutole+glufosinate+DICHLORMID; flumioxazin+S-metolachlor+isoxaflutole+glufosinate+DICHLORMID; flumioxazin+metolachlor+mesotrione+glufosinate+DICHLORMID; flumioxazin+S-metolachlor+mesotrione+glufosinate+DICHLORMID; flumioxazin+metolachlor+atrazine+glufosinate+DICHLORMID; flumioxazin+S-metolachlor+atrazine+glufosinate+DICHLORMID; flumioxazin+metolachlor+terbuthylazine+glufosinate+DICHLORMID; flumioxazin+S-metolachlor+terbuthylazine+glufosinate+DICHLORMID; flumioxazin+atrazine+nicosulfuron+glufosinate+DICHLORMID; fluthiacet-methyl+metolachlor+isoxaflutole+glufosinate+DICHLORMID; fluthiacet-methyl+S-metolachlor+isoxaflutole+glufosinate+DICHLORMID; fluthiacet-methyl+metolachlor+mesotrione+glufosinate+DICHLORMID; fluthiacet-methyl+S-metolachlor+mesotrione+glufosinate+DICHLORMID; fluthiacet-methyl+metolachlor+atrazine+glufosinate+DICHLORMID; fluthiacet-methyl+S-metolachlor+atrazine+glufosinate+DICHLORMID; fluthiacet-methyl+metolachlor+terbuthylazine+glufosinate+DICHLORMID; fluthiacet-methyl+S-metolachlor+terbuthylazine+glufosinate+DICHLORMID; fluthiacet-methyl+atrazine+nicosulfuron+glufosinate+DICHLORMID; oxadiargyl+metolachlor+isoxaflutole+glufosinate+DICHLORMID; oxadiargyl+S-metolachlor+isoxaflutole+glufosinate+DICHLORMID; oxadiargyl+metolachlor+mesotrione+glufosinate+DICHLORMID; oxadiargyl+S-metolachlor+mesotrione+glufosinate+DICHLORMID; oxadiargyl+metolachlor+atrazine +glufosinate+DICHLORMID; oxadiargyl+S-metolachlor+atrazine+glufosinate+DICHLORMID; oxadiargyl+metolachlor+terbuthylazine+glufosinate+DICHLORMID; oxadiargyl+S-metolach or+terbuthylazine+glufosinate+DICHLORMID; oxadiargyl+atrazine+nicosulfuron+glufosinate+DICHLORMID; oxadiazon+metolachlor+isoxaflutole+glufosinate+DICHLORMID; oxadiazon+S-metolachlor+isoxaflutole+glufosinate+DICHLORMID; oxadiazon+metolachlor+mesotrione+glufosinate+DICHLORMID; oxadiazon+S-metolachlor+mesotrione+glufosinate+DICHLORMID; oxadiazon+metolachlor+atrazine+glufosinate+DICHLORMID; oxadiazon+S-metolachlor+atrazine+glufosinate+DICHLORMID; oxadiazon+metolachlor+terbuthylazine+glufosinate+DICHLORMID; oxadiazon+S-metolachlor+terbuthylazine+glufosinate+DICHLORMID; oxadiazon+atrazine+nicosulfuron+glufosinate+DICHLORMID; pentoxazone+metolachlor+isoxaflutole+glufosinate+DICHLORMID; pentoxazone+S-metolachlor+isoxaflutole+glufosinate+DICHLORMID; pentoxazone+metolachlor+mesotrione+glufosinate+DICHLORMID; pentoxazone+S-metolachlor+mesotrione+glufosinate+DICHLORMID; pentoxazone+metolachlor+atrazine+glufosinate+DICHLORMID; pentoxazone+S-metolachlor+atrazine+glufosinate+DICHLORMID; pentoxazone+metolachlor+terbuthylazine+glufosinate+DICHLORMID; pentoxazone+S-metolachlor+terbuthylazine+glufosinate+DICHLORMID; pentoxazone +atrazine+nicosulfuron+glufosinate+DICHLORMID; sulfentrazone+metolachlor+isoxaflutole+glufosinate+DICHLORMID; sulfentrazone+S-metolachlor+isoxaflutole+glufosinate+DICHLORMID; sulfentrazone+metolachlor+mesotrione+glufosinate+DICHLORMID; sulfentrazone+S-metolachlor+mesotrione+glufosinate+DICHLORMID; sulfentrazone+metolachlor+atrazine+glufosinate+DICHLORMID; sulfentrazone+S-metolachlor+atrazine+glufosinate+DICHLORMID; sulfentrazone+metolachlor+terbuthylazine+glufosinate+DICHLORMID; sulfentrazone+S-metolachlor+terbuthylazine+glufosinate+DICHLORMID; sulfentrazone+atrazine+nicosulfuron+glufosinate+DICHLORMID; fluazolate+metolachlor+isoxaflutole+glufosinate+DICHLORMID; fluazolate+S-metolachlor+isoxaflutole+glufosinate+DICHLORMID; fluazolate+metolachlor+mesotrione+glufosinate+DICHLORMID; fluazolate+S-metolachlor+mesotrione+glufosinate+DICHLORMID; fluazolate+metolachlor+atrazine +glufosinate+DICHLORMID; fluazolate+S-metolachlor+atrazine+glufosinate+DICHLORMID; fluazolate+metolachlor+terbuthylazine+glufosinate+DICHLORMID; fluazolate+S-metolachlor+terbuthylazine+glufosinate+DICHLORMID; fluazolate+atrazine+nicosulfuron+glufosinate+DICHLORMID; pyraflufen-ethyl+metolachlor+isoxaflutole+glufosinate+DICHLORMID; pyraflufen-ethyl+S-metolachlor+isoxaflutole+glufosinate+DICHLORMID; pyraflufen-ethyl+metolachlor+mesotrione+glufosinate+DICHLORMID; pyraflufen-ethyl+S-metolachlor+mesotrione+glufosinate+DICHLORMID; pyraflufen-ethyl+metolachlor+atrazine+glufosinate+DICHLORMID; pyraflufen-ethyl+S-metolachlor+atrazine+glufosinate+DICHLORMID; pyraflufen-ethyl+metolachlor+terbuthylazine+glufosinate+DICHLORMID; pyraflufen-ethyl+S-metolachlor+terbuthylazine+glufosinate+DICHLORMID; pyraflufen-ethyl+atrazine+nicosulfuron+glufosinate+DICHLORMID; flumipropyn+metolachlor+isoxaflutole+glufosinate+DICHLORMID; flumipropyn+S-metolachlor+isoxaflutole+glufosinate+DICHLORMID; flumipropyn+metolachlor+mesotrione+glufosinate+DICHLORMID; flumipropyn+S-metolachlor+mesotrione+glufosinate+DICHLORMID; flumipropyn+metolachlor+atrazine+glufosinate+DICHLORMID; flumipropyn+S-metolachlor+atrazine+glufosinate +DICHLORMID; flumipropyn+metolachlor+terbuthylazine+glufosinate+DICHLORMID; flumipropyn+S-metolachlor+terbuthylazine+glufosinate+DICHLORMID; flumipropyn+atrazine+nicosulfuron+glufosinate+DICHLORMID; flupropacil+metolachlor+isoxaflutole+glufosinate+DICHLORMID; flupropacil+S-metolachlor+isoxaflutole+glufosinate+DICHLORMID; flupropacil+metolachlor+mesotrione+glufosinate+DICHLORMID; flupropacil+S-metolachlor+mesotrione+glufosinate+DICHLORMID; flupropacil+metolachlor+atrazine+glufosinate+DICHLORMID; flupropacil+S-metolachlor+atrazine+glufosinate+DICHLORMID; flupropacil+metolachlor+terbuthylazine+glufosinate+DICHLORMID; flupropacil+S-metolachlor+terbuthylazine+glufosinate+DICHLORMID; flupropacil+atrazine+nicosulfuron+glufosinate+DICHLORMID; nipyraclofen+metolachlor+isoxaflutole+glufosinate+DICHLORMID; nipyraclofen+S-metolachlor+isoxaflutole+glufosinate+DICHLORMID; nipyraclofen+metolachlor+mesotrione+glufosinate+DICHLORMID; nipyraclofen+S-metolachlor+mesotrione+glufosinate+DICHLORMID; nipyraclofen+metolachlor+atrazine+glufosinate+DICHLORMID; nipyraclofen+S-metolachlor+atrazine+glufosinate+DICHLORMID; nipyraclofen+metolachlor+terbuthylazine+glufosinate+DICHLORMID; nipyraclofen+S-metolachlor+terbuthylazine+glufosinate+DICHLORMID; nipyraclofen+atrazine+nicosulfuron+glufosinate+DICHLORMID; benzfendizone+metolachlor+isoxaflutole+glufosinate+DICHLORMID; benzfendizone+S-metolachlor+isoxaflutole+glufosinate+DICHLORMID; benzfendizone+metolachlor+mesotrione+glufosinate+DICHLORMID; benzfendizone+S-metolachlor+mesotrione+glufosinate+DICHLORMID; benzfendizone+metolachlor+atrazine+glufosinate+DICHLORMID; benzfendizone+S-metolachlor+atrazine+glufosinate+DICHLORMID; benzfendizone+metolachlor+terbuthylazine+glufosinate+DICHLORMID; benzfendizone+S-metolachlor+terbuthylazine+glufosinate+DICHLORMID; benzfendizone+atrazine+nicosulfuron+glufosinate+DICHLORMID; thidiazimin+metolachlor+isoxaflutole+glufosinate+DICHLORMID; thidiazimin+S-metolachlor+isoxaflutole+glufosinate+DICHLORMID; thidiazimin+metolachlor+mesotrione+glufosinate+DICHLORMID; thidiazimin+S-metolachlor+mesotrione+glufosinate+DICHLORMID; thidiazimin+metolachlor+atrazine+glufosinate+DICHLORMID; thidiazimin+S-metolachlor+atrazine+glufosinate +DICHLORMID; thidiazimin+metolachlor+terbuthylazine+glufosinate+DICHLORMID; thidiazimin+S-metolachlor+terbuthylazine+glufosinate+DICHLORMID; and thidiazimin +atrazine+nicosulfuron+glufosinate+DICHLORMID.

Acifluorfen+metolachlor+isoxaflutole+glufosinate+FURILAZOLE; acifluorfen+S-metolachlor+isoxaflutole+glufosinate+FURILAZOLE; acifluorfen+metolachlor+mesotrione+glufosinate+FURILAZOLE; acifluorfen+S-metolachlor+mesotrione+glufosinate+FURILAZOLE; acifluorfen+metolachlor+atrazine+glufosinate+FURILAZOLE; acifluorfen+S-metolachlor+atrazine+glufosinate+FURILAZOLE; acifluorfen+metolachlor+terbuthylazine+glufosinate+FURILAZOLE; acifluorfen+S-metolachlor+terbuthylazine+glufosinate+FURILAZOLE; acifluorfen+atrazine+nicosulfuron+glufosinate+FURILAZOLE; aclonifen+metolachlor+isoxaflutole+glufosinate+FURILAZOLE; aclonifen+S-metolachlor+isoxaflutole+glufosinate+FURILAZOLE; aclonifen+metolachlor+mesotrione+glufosinate+FURILAZOLE; aclonifen+S-metolachlor+mesotrione+glufosinate+FURILAZOLE; aclonifen+metolachlor+atrazine+glufosinate+FURILAZOLE; aclonifen+S-metolachlor+atrazine+glufosinate+FURILAZOLE; aclonifen+metolachlor+terbuthylazine+glufosinate+FURILAZOLE; aclonifen+S-metolachlor+terbuthylazine+glufosinate+FURILAZOLE; aclonifen+atrazine+nicosulfuron+glufosinate+FURILAZOLE; bifenox+metolachlor+isoxaflutole+glufosinate+FURILAZOLE; bifenox+S-metolachlor+isoxaflutole+glufosinate+FURILAZOLE; bifenox+metolachlor+mesotrione+glufosinate+FURILAZOLE; bifenox+S-metolachlor+mesotrione+glufosinate+FURILAZOLE; bifenox +metolachlor+atrazine+glufosinate+FURILAZOLE; bifenox+S-metolachlor+atrazine+glufosinate+FURILAZOLE; bifenox+metolachlor+terbuthylazine+glufosinate+FURILAZOLE; bifenox+S-metolachlor+terbuthylazine+glufosinate+FURILAZOLE; bifenox+atrazine+nicosulfuron+glufosinate+FURILAZOLE; chlomitrofen+metolachlor +isoxaflutole+glufosinate+FURILAZOLE; chlomitrofen+S-metolachlor+isoxaflutole+glufosinate+FURILAZOLE; chlomitrofen+metolachlor+mesotrione+glufosinate+FURILAZOLE; chlomitrofen+S-metolachlor+mesotrione+glufosinate+FURILAZOLE; chlomitrofen+metolachlor+atrazine+glufosinate+FURILAZOLE; chlomitrofen+S-metolachlor+atrazine+glufosinate+FURILAZOLE; chlomitrofen+metolachlor+terbuthylazine+glufosinate+FURILAZOLE; chlomitrofen+S-metolachlor+terbuthylazine +glufosinate+FURILAZOLE; chlomitrofen+atrazine+nicosulfuron+glufosinate+FURILAZOLE; ethoxyfen+metolachlor+isoxaflutole+glufosinate+FURILAZOLE; ethoxyfen+S-metolachlor+isoxaflutole+glufosinate+FURILAZOLE; ethoxyfen+metolachlor+mesotrione+glufosinate+FURILAZOLE; ethoxyfen+S-metolachlor+mesotrione+glufosinate+FURILAZOLE; ethoxyfen+metolachlor+atrazine+glufosinate +FURILAZOLE; ethoxyfen+S-metolachlor+atrazine+glufosinate+FURILAZOLE; ethoxyfen+metolachlor+terbuthylazine+glufosinate+FURILAZOLE; ethoxyfen+S-metolachlor+terbuthylazine+glufosinate+FURILAZOLE; ethoxyfen+atrazine+nicosulfuron+glufosinate+FURILAZOLE; fluoroglycofen+metolachlor+isoxaflutole+glufosinate+FURILAZOLE; fluoroglycofen+S-metolachlor+isoxaflutole+glufosinate+FURILAZOLE; fluoroglycofen+metolachlor+mesotrione+glufosinate+FURILAZOLE; fluoroglycofen+S-metolachlor+mesotrione+glufosinate+FURILAZOLE; fluoroglycofen+metolachlor+atrazine+glufosinate+FURILAZOLE; fluoroglycofen+S-metolachlor+atrazine+glufosinate+FURILAZOLE; fluoroglycofen+metolachlor+terbuthylazine+glufosinate+FURILAZOLE; fluoroglycofen+S-metolachlor+terbuthylazine+glufosinate+FURILAZOLE; fluoroglycofen+atrazine+nicosulfuron+glufosinate+FURILAZOLE; fomesafen+metolachlor+isoxaflutole+glufosinate+FURILAZOLE; fomesafen+S-metolachlor+isoxaflutole+glufosinate+FURILAZOLE; fomesafen+metolachlor+mesotrione+glufosinate+FURILAZOLE; fomesafen+S-metolachlor+mesotrione+glufosinate+FURILAZOLE; fomesafen+metolachlor+atrazine+glufosinate+FURILAZOLE; fomesafen+S-metolachlor+atrazine+glufosinate+FURILAZOLE; fomesafen+metolachlor+terbuthylazine+glufosinate+FURILAZOLE; fomesafen+S-metolachlor+terbuthylazine+glufosinate+FURILAZOLE; fomesafen+atrazine+nicosulfuron+glufosinate+FURILAZOLE; lactofen+metolachlor+isoxaflutole+glufosinate+FURILAZOLE; lactofen+S-metolachlor+isoxaflutole+glufosinate+FURILAZOLE; lactofen+metolachlor+mesotrione+glufosinate+FURILAZOLE; lactofen +S-metolachlor+mesotrione+glufosinate+FURILAZOLE; lactofen+metolachlor+atrazine+glufosinate+FURILAZOLE; lactofen+S-metolachlor+atrazine+glufosinate+FURILAZOLE; lactofen+metolachlor+terbuthylazine+glufosinate+FURILAZOLE; lactofen+S-metolachlor+terbuthylazine+glufosinate+FURILAZOLE; lactofen+atrazine +nicosulfuron+glufosinate+FURILAZOLE; oxyfluorfen+metolachlor+isoxaflutole+glufosinate+FURILAZOLE; oxyfluorfen+S-metolachlor+isoxaflutole+glufosinate+FURILAZOLE; oxyfluorfen+metolachlor+mesotrione+glufosinate+FURILAZOLE; oxyfluorfen+S-metolachlor+mesotrione+glufosinate+FURILAZOLE; oxyfluorfen+metolachlor+atrazine+glufosinate+FURILAZOLE; oxyfluorfen+S-metolachlor+atrazine +glufosinate+FURILAZOLE; oxyfluorfen+metolachlor+terbuthylazine+glufosinate+FURILAZOLE; oxyfluorfen+S-metolachlor+terbuthylazine+glufosinate+FURILAZOLE; oxyfluorfen+atrazine+nicosulfuron+glufosinate+FURILAZOLE; azafenidin+metolachlor+isoxaflutole+glufosinate+FURILAZOLE; azafenidin+S-metolachlor+isoxaflutole+glufosinate+FURILAZOLE; azafenidin+metolachlor+mesotrione+glufosinate+FURILAZOLE; azafenidin+S-metolachlor+mesotrione+glufosinate+FURILAZOLE; azafenidin+metolachlor+atrazine+glufosinate+FURILAZOLE; azafenidin +S-metolachlor+atrazine+glufosinate+FURILAZOLE; azafenidin+metolachlor+terbuthylazine+glufosinate+FURILAZOLE; azafenidin+S-metolachlor+terbuthylazine+glufosinate+FURILAZOLE; azafenidin+atrazine+nicosulfuron+glufosinate+FURILAZOLE; carfentrazone-ethyl+metolachlor+isoxaflutole+glufosinate+FURILAZOLE; carfentrazone-ethyl+S-metolachlor+isoxaflutole+glufosinate+FURILAZOLE; carfentrazone-ethyl+metolachlor+mesotrione+glufosinate+FURILAZOLE; carfentrazone-ethyl+S-metolachlor+mesotrione+glufosinate+FURILAZOLE; carfentrazone-ethyl+metolachlor+atrazine+glufosinate+FURILAZOLE; carfentrazone-ethyl+S-metolachlor+atrazine+glufosinate+FURILAZOLE; carfentrazone-ethyl+metolachlor+terbuthylazine+glufosinate+FURILAZOLE; carfentrazone-ethyl+S-metolachlor+terbuthylazine+glufosinate+FURILAZOLE; carfentrazone-ethyl+atrazine+nicosulfuron+glufosinate+FURILAZOLE; compound of the formula A+metolachlor+isoxaflutole+glufosinate+FURILAZOLE; compound of the formula A+S-metolachlor+isoxaflutole+glufosinate+FURILAZOLE; compound of the formula A+metolachlor+mesotrione+glufosinate+FURILAZOLE; compound of the formula A+S-metolachlor+mesotrione+glufosinate+FURILAZOLE; compound of the formula A+metolachlor+atrazine+glufosinate+FURILAZOLE; compound of the formula A+S-metolachlor+atrazine+glufosinate+FURILAZOLE; compound of the formula A+metolachlor+terbuthylazine+glufosinate+FURILAZOLE; compound of the formula A+S-metolachlor+terbuthylazine+glufosinate+FURILAZOLE; compound of the formula A+atrazine+nicosulfuron+glufosinate+FURILAZOLE; cinidon-ethyl+metolachlor+isoxaflutole+glufosinate+FURILAZOLE; cinidon-ethyl+S-metolachlor+isoxaflutole+glufosinate+FURILAZOLE; cinidon-ethyl+metolachlor+mesotrione+glufosinate+FURILAZOLE; cinidon-ethyl+S-metolachlor+mesotrione+glufosinate+FURILAZOLE; cinidon-ethyl+metolachlor+atrazine+glufosinate+FURILAZOLE; cinidon-ethyl+S-metolachlor+atrazine+glufosinate+FURILAZOLE; cinidon-ethyl+metolachlor+terbuthylazine+glufosinate+FURILAZOLE; cinidon-ethyl+S-metolachlor+terbuthylazine +glufosinate+FURILAZOLE; cinidon-ethyl+atrazine+nicosulfuron+glufosinate+FURILAZOLE; flumiclorac-pentyl+metolachlor+isoxaflutole+glufosinate+FURILAZOLE; flumiclorac-pentyl+S-metolachlor+isoxaflutole+glufosinate+FURILAZOLE; flumiclorac-pentyl+metolachlor+mesotrione+glufosinate+FURILAZOLE; flumiclorac-pentyl+S-metolachlor+mesotrione+glufosinate+FURILAZOLE; flumiclorac-pentyl+metolachlor+atrazine+glufosinate+FURILAZOLE; flumiclorac-pentyl+S-metolachlor+atrazine+glufosinate+FURILAZOLE; flumiclorac-pentyl+metolachlor+terbuthylazine+glufosinate +FURILAZOLE; flumiclorac-pentyl+S-metolachlor+terbuthylazine+glufosinate+FURILAZOLE; flumiclorac-pentyl+atrazine+nicosulfuron+glufosinate+FURILAZOLE; flumioxazin+metolachlor+isoxaflutole+glufosinate+FURILAZOLE; flumioxazin+S-metolachlor+isoxaflutole+glufosinate+FURILAZOLE; flumioxazin+metolachlor+mesotrione+glufosinate+FURILAZOLE; flumioxazin+S-metolachlor+mesotrione+glufosinate+FURILAZOLE; flumioxazin+metolachlor+atrazine+glufosinate+FURILAZOLE; flumioxazin+S-metolachlor+atrazine+glufosinate+FURILAZOLE; flumioxazin+metolachlor+terbuthylazine+glufosinate+FURILAZOLE; flumioxazin+S-metolachlor+terbuthylazine+glufosinate+FURILAZOLE; flumioxazin+atrazine+nicosulfuron+glufosinate+FURILAZOLE; fluthiacet-methyl+metolachlor+isoxaflutole+glufosinate+FURILAZOLE; fluthiacet-methyl+S-metolachlor+isoxaflutole+glufosinate+FURILAZOLE; fluthiacet-methyl+metolachlor+mesotrione+glufosinate+FURILAZOLE; fluthiacet-methyl+S-metolachlor+mesotrione+glufosinate+FURILAZOLE; fluthiacet-methyl+metolachlor+atrazine+glufosinate+FURILAZOLE; fluthiacet-methyl+S-metolachlor+atrazine+glufosinate+FURILAZOLE; fluthiacet-methyl+metolachlor+terbuthylazine+glufosinate+FURILAZOLE; fluthiacet-methyl+S-metolachlor+terbuthylazine+glufosinate+FURILAZOLE; fluthiacet-methyl+atrazine+nicosulfuron+glufosinate+FURILAZOLE; oxadiargyl+metolachlor+isoxaflutole+glufosinate+FURILAZOLE; oxadiargyl+S-metolachlor+isoxaflutole+glufosinate+FURILAZOLE; oxadiargyl+metolachlor+mesotrione+glufosinate+FURILAZOLE; oxadiargyl+S-metolachlor+mesotrione+glufosinate+FURILAZOLE; oxadiargyl+metolachlor+atrazine +glufosinate+FURILAZOLE; oxadiargyl+S-metolachlor+atrazine+glufosinate+FURILAZOLE; oxadiargyl+metolachlor+terbuthylazine+glufosinate+FURILAZOLE; oxadiargyl+S-metolachlor+terbuthylazine+glufosinate+FURILAZOLE; oxadiargyl+atrazine+nicosulfuron+glufosinate+FURILAZOLE; oxadiazon+metolachlor+isoxaflutole+glufosinate+FURILAZOLE; oxadiazon+S-metolachlor+isoxaflutole+glufosinate+FURILAZOLE; oxadiazon+metolachlor+mesotrione+glufosinate+FURILAZOLE; oxadiazon+S-metolachlor+mesotrione+glufosinate+FURILAZOLE; oxadiazon+metolachlor+atrazine+glufosinate+FURILAZOLE; oxadiazon+S-metolachlor+atrazine+glufosinate+FURILAZOLE; oxadiazon+metolachlor+terbuthylazine+glufosinate+FURILAZOLE; oxadiazon+S-metolachlor+terbuthylazine+glufosinate+FURILAZOLE; oxadiazon+atrazine+nicosulfuron+glufosinate+FURILAZOLE; pentoxazone+metolachlor+isoxaflutole+glufosinate+FURILAZOLE; FURILAZOLE; pentoxazone+S-metolachlor+isoxaflutole+glufosinate+FURILAZOLE; pentoxazone+metolachlor+mesotrione+glufosinate+FURILAZOLE; pentoxazone+S-metolachlor+mesotrione+glufosinate+FURILAZOLE; pentoxazone+metolachlor+atrazine+glufosinate+FURILAZOLE; pentoxazone+S-metolachlor+atrazine+glufosinate+FURILAZOLE; pentoxazone+metolachlor+terbuthylazine+glufosinate+FURILAZOLE; pentoxazone+S-metolachlor+terbuthylazine+glufosinate+FURILAZOLE; pentoxazone +atrazine+nicosulfuron+glufosinate+FURILAZOLE; sulfentrazone+metolachlor+isoxaflutole+glufosinate+FURILAZOLE; sulfentrazone+S-metolachlor+isoxaflutole+glufosinate+FURILAZOLE; sulfentrazone+metolachlor+mesotrione+glufosinate+FURILAZOLE; sulfentrazone+S-metolachlor+mesotrione+glufosinate+FURILAZOLE; sulfentrazone+metolachlor+atrazine+glufosinate+FURILAZOLE; sulfentrazone+S-metolachlor+atrazine+glufosinate+FURILAZOLE; sulfentrazone+metolachlor+terbuthylazine+glufosinate+FURILAZOLE; sulfentrazone+S-metolachlor+terbuthylazine+glufosinate+FURILAZOLE; sulfentrazone+atrazine+nicosulfuron+glufosinate+FURILAZOLE; fluazolate+metolachlor+isoxaflutole+glufosinate+FURILAZOLE; fluazolate+S-metolachlor+isoxaflutole+glufosinate+FURILAZOLE; fluazolate+metolachlor+mesotrione+glufosinate+FURILAZOLE; fluazolate+S-metolachlor+mesotrione+glufosinate+FURILAZOLE; fluazolate+metolachlor+atrazine +glufosinate+FURILAZOLE; fluazolate+S-metolachlor+atrazine+glufosinate+FURILAZOLE; fluazolate+metolachlor+terbuthylazine+glufosinate+FURILAZOLE; fluazolate+S-metolachlor+terbuthylazine+glufosinate+FURILAZOLE; fluazolate+atrazine+nicosulfuron+glufosinate+FURILAZOLE; pyraflufen-ethyl+metolachlor+isoxaflutole+glufosinate+FURILAZOLE; pyraflufen-ethyl+S-metolachlor+isoxaflutole+glufosinate+FURILAZOLE; pyraflufen-ethyl+metolachlor+mesotrione+glufosinate+FURILAZOLE; pyraflufen-ethyl+S-metolachlor+mesotrione+glufosinate+FURILAZOLE; pyraflufen-ethyl+metolachlor+atrazine+glufosinate+FURILAZOLE; pyraflufen-ethyl+S-metolachlor+atrazine+glufosinate+FURILAZOLE; pyraflufen-ethyl+metolachlor+terbuthylazine+glufosinate+FURILAZOLE; pyraflufen-ethyl+S-metolachlor+terbuthylazine+glufosinate+FURILAZOLE; pyraflufen-ethyl+atrazine+nicosulfuron+glufosinate+FURILAZOLE; flumipropyn+metolachlor+isoxaflutole+glufosinate+FURILAZOLE; flumipropyn+S-metolachlor+isoxaflutole+glufosinate+FURILAZOLE; flumipropyn+metolachlor+mesotrione+glufosinate+FURILAZOLE; flumipropyn+S-metolachlor+mesotrione+glufosinate+FURILAZOLE; flumipropyn+metolachlor+atrazine+glufosinate+FURILAZOLE; flumipropyn+S-metolachlor+atrazine+glufosinate +FURILAZOLE; flumipropyn+metolachlor+terbuthylazine+glufosinate+FURILAZOLE; flumipropyn+S-metolachlor+terbuthylazine+glufosinate+FURILAZOLE; flumipropyn+atrazine+nicosulfuron+glufosinate+FURILAZOLE; flupropacil+metolachlor+isoxaflutole+glufosinate+FURILAZOLE; flupropacil+S-metolachlor+isoxaflutole+glufosinate+FURILAZOLE; flupropacil+metolachlor+mesotrione+glufosinate+FURILAZOLE; flupropacil+S-metolachlor+mesotrione+glufosinate+FURILAZOLE; flupropacil+metolachlor+atrazine+glufosinate+FURILAZOLE; flupropacil+S-metolachlor+atrazine+glufosinate+FURILAZOLE; flupropacil+metolachlor+terbuthylazine+glufosinate+FURILAZOLE; flupropacil+S-metolachlor+terbuthylazine+glufosinate+FURILAZOLE; flupropacil+atrazine+nicosulfuron+glufosinate+FURILAZOLE; nipyraclofen+metolachlor+isoxaflutole+glufosinate+FURILAZOLE; nipyraclofen+S-metolachlor+isoxaflutole+glufosinate+FURILAZOLE; nipyraclofen+metolachlor+mesotrione+glufosinate+FURILAZOLE; nipyraclofen+S-metolachlor+mesotrione+glufosinate+FURILAZOLE; nipyraclofen+metolachlor+atrazine+glufosinate+FURILAZOLE; nipyraclofen+S-metolachlor+atrazine+glufosinate+FURILAZOLE; nipyraclofen+metolachlor+terbuthylazine+glufosinate+FURILAZOLE; nipyraclofen+S-metolachlor+terbuthylazine+glufosinate+FURILAZOLE; nipyraclofen+atrazine+nicosulfuron+glufosinate+FURILAZOLE; benzfendizone+metolachlor+isoxaflutole+glufosinate+FURILAZOLE; benzfendizone+S-metolachlor+isoxaflutole+glufosinate+FURILAZOLE; benzfendizone+metolachlor+mesotrione+glufosinate+FURILAZOLE; benzfendizone+S-metolachlor+mesotrione+glufosinate+FURILAZOLE; benzfendizone+metolachlor+atrazine+glufosinate+FURILAZOLE; benzfendizone+S-metolachlor+atrazine+glufosinate+FURILAZOLE; benzfendizone+metolachlor+terbuthylazine+glufosinate+FURILAZOLE; benzfendizone+S-metolachlor+terbuthylazine+glufosinate+FURILAZOLE; benzfendizone+atrazine+nicosulfuron+glufosinate+FURILAZOLE; thidiazimin+metolachlor+isoxaflutole+glufosinate+FURILAZOLE; thidiazimin+S-metolachlor+isoxaflutole+glufosinate+FURILAZOLE; thidiazimin+metolachlor+mesotrione+glufosinate+FURILAZOLE; thidiazimin+S-metolachlor+mesotrione+glufosinate+FURILAZOLE; thidiazimin+metolachlor+atrazine +glufosinate+FURILAZOLE; thidiazimin+S-metolachlor+atrazine+glufosinate+FURILAZOLE; thidiazimin+metolachlor+terbuthylazine+glufosinate+FURILAZOLE; thidiazimin+S-metolachlor+terbuthylazine+glufosinate+FURILAZOLE; and thidiazimin+atrazine+nicosulfuron+glufosinate+FURILAZOLE.

Acifluorfen+prosulfuron+primisulfuron+sulfosate; acifluorfen+prosulfuron+dicamba+sulfosate; acifluorfen+primisulfuron+dicamba+sulfosate; acifluorfen+nicosulfuron+primisulfuron+sulfosate; acifluorfen+nicosulfuron+prosulfuron+sulfosate; acifluorfen+rimsulfuron+primisulfuron+sulfosate; acifluorfen+rimsulfuron+prosulfuron+sulfosate; acifluorfen+metolachlor+isoxaflutole+sulfosate; acifluorfen+metolachlor+isoxaflutole +sulfosate+benoxacor; acifluorfen+S-metolachlor+isoxaflutole+sulfosate; acifluorfen+S-metolachlor+isoxaflutole+sulfosate+benoxacor; acifluorfen+metolachlor+mesotrione+sulfosate; acifluorfen+metolachlor+mesotrione+sulfosate+benoxacor; acifluorfen+S-metolachlor+mesotrione+sulfosate; acifluorfen+S-metolachlor+mesotrione+benoxacor+sulfosate; acifluorfen+metolachlor+atrazine+sulfosate; acifluorfen+metolachlor+atrazine+sulfosate+benoxacor; acifluorfen+S-metolachlor+atrazine+sulfosate; acifluorfen+S-metolachlor+atrazine+sulfosate+benoxacor; acifluorfen+metolachlor+terbuthylazine+sulfosate; acifluorfen+metolachlor+terbuthylazine+sulfosate+benoxacor; acifluorfen+S-metolachlor+terbuthylazine+sulfosate; acifluorfen+S-metolachlor+terbuthylazine+sulfosate+benoxacor; acifluorfen +atrazine+nicosulfuron+sulfosate; acifluorfen+atrazine+nicosulfuron+sulfosate+benoxacor; aclonifen+prosulfuron+primisulfuron+sulfosate; aclonifen+prosulfuron+dicamba+sulfosate; aclonifen+primisulfuron+dicamba+sulfosate; aclonifen+nicosulfuron+primisulfuron+sulfosate; aclonifen+nicosulfuron+prosulfuron+sulfosate; aclonifen+rimsulfuron+primisulfuron+sulfosate; aclonifen+rimsulfuron+prosulfuron+sulfosate; aclonifen+metolachlor+isoxaflutole+sulfosate; aclonifen+metolachlor+isoxaflutole+sulfosate+benoxacor; aclonifen+S-metolachlor+isoxaflutole+sulfosate; aclonifen+S-metolachlor+isoxaflutole+sulfosate+benoxacor; aclonifen+metolachlor+mesotrione+sulfosate; aclonifen+metolachlor+mesotrione+sulfosate+benoxacor; aclonifen+S-metolachlor+mesotrione+sulfosate; aclonifen+S-metolachlor+mesotrione +sulfosate+benoxacor; aclonifen+metolachlor+atrazine+sulfosate; aclonifen+metolachlor+atrazine+sulfosate+benoxacor; aclonifen+S-metolachlor+atrazine+sulfosate; aclonifen+S-metolachlor+atrazine+sulfosate+benoxacor; aclonifen+metolachlor+terbuthylazine+sulfosate; aclonifen+metolachlor+terbuthylazine+sulfosate+benoxacor; aclonifen+S-metolachlor+terbuthylazine+sulfosate; aclonifen+S-metolachlor+terbuthylazine+sulfosate+benoxacor; aclonifen+atrazine+nicosulfuron +sulfosate; aclonifen+atrazine+nicosulfuron+sulfosate+benoxacor; bifenox+prosulfuron+primisulfuron+sulfosate; bifenox+prosulfuron+dicamba+sulfosate; bifenox+primisulfuron+dicamba+sulfosate; bifenox+nicosulfuron+primisulfuron+sulfosate; bifenox+nicosulfuron+prosulfuron+sulfosate; bifenox+rimsulfuron+primisulfuron+sulfosate; bifenox+rimsulfuron+prosulfuron+sulfosate; bifenox+metolachlor+isoxaflutole+sulfosate; bifenox+metolachlor+isoxaflutole+sulfosate+benoxacor; bifenox+S-metolachlor+isoxaflutole+sulfosate; bifenox+S-metolachlor+isoxaflutole+sulfosate+benoxacor; bifenox+metolachlor+mesotrione+sulfosate; bifenox+metolachlor+mesotrione+sulfosate+benoxacor; bifenox+S-metolachlor+mesotrione+sulfosate; bifenox+S-metolachlor+mesotrione+sulfosate+benoxacor; bifenox+metolachlor+atrazine+sulfosate; bifenox+metolachlor+atrazine+sulfosate+benoxacor; bifenox+S-metolachlor+atrazine+sulfosate; bifenox+S-metolachlor+atrazine+sulfosate+benoxacor; bifenox+metolachlor+terbuthylazine+sulfosate; bifenox+metolachlor+terbuthylazine+sulfosate+benoxacor; bifenox+S-metolachlor+terbuthylazine+sulfosate; bifenox+S-metolachlor+terbuthylazine+sulfosate+benoxacor; bifenox+atrazine+nicosulfuron+sulfosate; bifenox+atrazine+nicosulfuron +sulfosate+benoxacor; chlomitrofen+prosulfuron+primisulfuron+sulfosate; chlomitrofen+prosulfuron+dicamba+sulfosate; chlomitrofen+primisulfuron+dicamba+sulfosate; chlomitrofen+nicosulfuron+primisulfuron+sulfosate; chlomitrofen+nicosulfuron+prosulfuron+sulfosate; chlomitrofen+rimsulfuron+primisulfuron+sulfosate; chlomitrofen+rimsulfuron+prosulfuron+sulfosate; chlomitrofen+metolachlor +isoxaflutole+sulfosate; chlomitrofen+metolachlor+isoxaflutole+sulfosate+benoxacor; chlomitrofen+S-metolachlor+isoxaflutole+sulfosate; chlomitrofen+S-metolachlor+isoxaflutole+sulfosate+benoxacor; chlomitrofen+metolachlor+mesotrione+sulfosate; chlomitrofen+metolachlor+mesotrione+sulfosate+benoxacor; chlomitrofen+S-metolachlor+mesotrione+sulfosate; chlomitrofen+S-metolachlor+mesotrione+sulfosate+benoxacor; chlomitrofen+metolachlor+atrazine+sulfosate; chlomitrofen+metolachlor+atrazine+sulfosate+benoxacor; chlomitrofen+S-metolachlor+atrazine+sulfosate; chlomitrofen+S-metolachlor+atrazine+sulfosate+benoxacor; chlomitrofen+metolachlor+terbuthylazine+sulfosate; chlomitrofen+metolachlor+terbuthylazine+sulfosate+benoxacor; chlomitrofen+S-metolachlor+terbuthylazine+sulfosate; chlomitrofen+S-metolachlor+terbuthylazine+sulfosate+benoxacor; chlomitrofen+atrazine+nicosulfuron+sulfosate; chlomitrofen+atrazine+nicosulfuron+sulfosate+benoxacor; ethoxyfen+prosulfuron+primisulfuron+sulfosate; ethoxyfen+prosulfuron+dicamba+sulfosate; ethoxyfen+primisulfuron+dicamba+sulfosate; ethoxyfen+nicosulfuron+primisulfuron+sulfosate; ethoxyfen+nicosulfuron+prosulfuron+sulfosate; ethoxyfen+rimsulfuron+primisulfuron+sulfosate; ethoxyfen+rimsulfuron+prosulfuron+sulfosate; ethoxyfen+metolachlor+isoxaflutole+sulfosate; ethoxyfen+metolachlor+isoxaflutole+sulfosate+benoxacor; ethoxyfen+S-metolachlor +isoxaflutole+sulfosate; ethoxyfen+S-metolachlor+isoxaflutole+sulfosate+benoxacor; ethoxyfen+metolachlor+mesotrione+sulfosate; ethoxyfen+metolachlor+mesotrione+sulfosate+benoxacor; ethoxyfen+S-metolachlor+mesotrione+sulfosate; ethoxyfen+S-metolachlor+mesotrione+sulfosate+benoxacor; ethoxyfen+metolachlor+atrazine+sulfosate; ethoxyfen+metolachlor+atrazine+sulfosate+benoxacor; ethoxyfen+S-metolachlor+atrazine+sulfosate; ethoxyfen+S-metolachlor+atrazine+sulfosate+benoxacor; ethoxyfen+metolachlor+terbuthylazine+sulfosate; ethoxyfen+metolachlor+terbuthylazine+sulfosate+benoxacor; ethoxyfen+S-metolachlor+terbuthylazine+sulfosate; ethoxyfen+S-metolachlor+terbuthylazine+sulfosate+benoxacor; ethoxyfen+atrazine+nicosulfuron+sulfosate; ethoxyfen+atrazine+nicosulfuron+sulfosate+benoxacor; fluoroglycofen+prosulfuron+primisulfuron+sulfosate; fluoroglycofen+prosulfuron+dicamba+sulfosate; fluoroglycofen+primisulfuron+dicamba+sulfosate; fluoroglycofen+nicosulfuron+primisulfuron+sulfosate; fluoroglycofen+nicosulfuron+prosulfuron+sulfosate; fluoroglycofen+rimsulfuron+primisulfuron+sulfosate; fluoroglycofen+rimsulfuron+prosulfuron+sulfosate; fluoroglycofen+metolachlor+isoxaflutole+sulfosate; fluoroglycofen+metolachlor+isoxaflutole+sulfosate+benoxacor; fluoroglycofen+S-metolachlor+isoxaflutole+sulfosate; fluoroglycofen+S-metolachlor+isoxaflutole+sulfosate+benoxacor; fluoroglycofen+metolachlor+mesotrione+sulfosate; fluoroglycofen+metolachlor+mesotrione+sulfosate+benoxacor; fluoroglycofen+S-metolachlor+mesotrione+sulfosate; fluoroglycofen+S-metolachlor+mesotrione+sulfosate+benoxacor; fluoroglycofen+metolachlor+atrazine+sulfosate; fluoroglycofen+metolachlor+atrazine+sulfosate+benoxacor; fluoroglycofen+S-metolachlor+atrazine+sulfosate; fluoroglycofen+S-metolachlor+atrazine+sulfosate+benoxacor; fluoroglycofen+metolachlor+terbuthylazine+sulfosate; fluoroglycofen+metolachlor+terbuthylazine+sulfosate+benoxacor; fluoroglycofen+S-metolachlor+terbuthylazine+sulfosate; fluoroglycofen+S-metolachlor+terbuthylazine+sulfosate+benoxacor; fluoroglycofen+atrazine+nicosulfuron+sulfosate; fluoroglycofen+atrazine+nicosulfuron+sulfosate+benoxacor; fomesafen+prosulfuron+primisulfuron+sulfosate; fomesafen+prosulfuron+dicamba+sulfosate; fomesafen+primisulfuron+dicamba+sulfosate; fomesafen+nicosulfuron+primisulfuron+sulfosate; fomesafen+nicosulfuron+prosulfuron+sulfosate; fomesafen+rimsulfuron+primisulfuron+sulfosate; fomesafen+rimsulfuron+prosulfuron+sulfosate; fomesafen+metolachlor+isoxaflutole+sulfosate; fomesafen+metolachlor+isoxaflutole+sulfosate+benoxacor; fomesafen+S-metolachlor +isoxaflutole+sulfosate; fomesafen+S-metolachlor+isoxaflutole+sulfosate+benoxacor; fomesafen+metolachlor+mesotrione+sulfosate; fomesafen+metolachlor+mesotrione+sulfosate+benoxacor; fomesafen+S-metolachlor+mesotrione+sulfosate; fomesafen+S-metolachlor+mesotrione+sulfosate+benoxacor; fomesafen+metolachlor +atrazine+sulfosate; fomesafen+metolachlor+atrazine+sulfosate+benoxacor; fomesafen+S-metolachlor+atrazine+sulfosate; fomesafen+S-metolachlor+atrazine+sulfosate+benoxacor; fomesafen+metolachlor+terbuthylazine+sulfosate; fomesafen+metolachlor+terbuthylazine+sulfosate+benoxacor; fomesafen+S-metolachlor+terbuthylazine+sulfosate; fomesafen+S-metolachlor+terbuthylazine+sulfosate+benoxacor; fomesafen+atrazine+nicosulfuron+sulfosate; fomesafen+atrazine+nicosulfuron+sulfosate+benoxacor; lactofen+prosulfuron+primisulfuron+sulfosate; lactofen+prosulfuron+dicamba+sulfosate; lactofen+primisulfuron+dicamba+sulfosate; lactofen+nicosulfuron+primisulfuron+sulfosate; lactofen+nicosulfuron+prosulfuron+sulfosate; lactofen+rimsulfuron+primisulfuron+sulfosate; lactofen+rimsulfuron+prosulfuron+sulfosate; lactofen+metolachlor+isoxaflutole+sulfosate; lactofen+metolachlor+isoxaflutole+sulfosate+benoxacor; lactofen+S-metolachlor+isoxaflutole+sulfosate; lactofen+S-metolachlor+isoxaflutole+sulfosate+benoxacor; lactofen+metolachlor+mesotrione+sulfosate; lactofen+metolachlor+mesotrione+sulfosate+benoxacor; lactofen+S-metolachlor+mesotrione+sulfosate; lactofen+S-metolachlor+mesotrione+sulfosate+benoxacor; lactofen+metolachlor+atrazine+sulfosate; lactofen+metolachlor+atrazine+benoxacor; lactofen+S-metolachlor+atrazine; lactofen+S-metolachlor+atrazine+sulfosate+benoxacor; lactofen+metolachlor+terbuthylazine+sulfosate; lactofen+metolachlor+terbuthylazine+sulfosate +benoxacor; lactofen+S-metolachlor+terbuthylazine+sulfosate; lactofen+S-metolachlor+terbuthylazine+sulfosate+benoxacor; lactofen+atrazine+nicosulfuron+sulfosate; lactofen+atrazine+nicosulfuron+sulfosate+benoxacor; oxyfluorfen+prosulfuron+primisulfuron+sulfosate; oxyfluorfen+prosulfuron+dicamba+sulfosate; oxyfluorfen+primisulfuron+dicamba+sulfosate; oxyfluorfen+nicosulfuron+primisulfuron+sulfosate; oxyfluorfen+nicosulfuron+prosulfuron+sulfosate; oxyfluorfen+rimsulfuron+primisulfuron+sulfosate; oxyfluorfen+rimsulfuron+prosulfuron+sulfosate; oxyfluorfen+metolachlor+isoxaflutole+sulfosate; oxyfluorfen+metolachlor+isoxaflutole +sulfosate+benoxacor; oxyfluorfen+S-metolachlor+isoxaflutole+sulfosate; oxyfluorfen +S-metolachlor+isoxaflutole+sulfosate+benoxacor; oxyfluorfen+metolachlor+mesotrione+sulfosate; oxyfluorfen+metolachlor+mesotrione+sulfosate+benoxacor; oxyfluorfen+S-metolachlor+mesotrione+sulfosate; oxyfluorfen+S-metolachlor+mesotrione+sulfosate+benoxacor; oxyfluorfen+metolachlor+atrazine+sulfosate; oxyfluorfen+metolachlor+atrazine+sulfosate+benoxacor; oxyfluorfen+S-metolachlor+atrazine+sulfosate; oxyfluorfen+S-metolachlor+atrazine+sulfosate+benoxacor; oxyfluorfen+metolachlor+terbuthylazine+sulfosate; oxyfluorfen+metolachlor+terbuthylazine+sulfosate+benoxacor; oxyfluorfen+S-metolachlor+terbuthylazine+sulfosate; oxyfluorfen+S-metolachlor+terbuthylazine+sulfosate+benoxacor; oxyfluorfen +atrazine+nicosulfuron+sulfosate; oxyfluorfen+atrazine+nicosulfuron+sulfosate+benoxacor; azafenidin+prosulfuron+primisulfuron+sulfosate; azafenidin+prosulfuron+dicamba+sulfosate; azafenidin+primisulfuron+dicamba+sulfosate; azafenidin+nicosulfuron+primisulfuron+sulfosate; azafenidin+nicosulfuron+prosulfuron+sulfosate; azafenidin+rimsulfuron+primisulfuron+sulfosate; azafenidin+rimsulfuron+prosulfuron+sulfosate; azafenidin+metolachlor+isoxaflutole+sulfosate; azafenidin+metolachlor+isoxaflutole+sulfosate+benoxacor; azafenidin+S-metolachlor+isoxaflutole+sulfosate; azafenidin+S-metolachlor+isoxaflutole+sulfosate+benoxacor; azafenidin+metolachlor+mesotrione+sulfosate; azafenidin+metolachlor+mesotrione+sulfosate+benoxacor; azafenidin+S-metolachlor+mesotrione+sulfosate; azafenidin+S-metolachlor+mesotrione+sulfosate+benoxacor; azafenidin+metolachlor+atrazine+sulfosate; azafenidin+metolachlor+atrazine+sulfosate+benoxacor; azafenidin+S-metolachlor+atrazine+sulfosate; azafenidin+S-metolachlor+atrazine+sulfosate+benoxacor; azafenidin+metolachlor+terbuthylazine+sulfosate; azafenidin+metolachlor +terbuthylazine+sulfosate+benoxacor; azafenidin+S-metolachlor+terbuthylazine+sulfosate; azafenidin+S-metolachlor+terbuthylazine+sulfosate+benoxacor; azafenidin +atrazine+nicosulfuron+sulfosate; azafenidin+atrazine+nicosulfuron+sulfosate+benoxacor; carfentrazone-ethyl+prosulfuron+primisulfuron+sulfosate; carfentrazone-ethyl+prosulfuron+dicamba+sulfosate; carfentrazone-ethyl+primisulfuron+dicamba+sulfosate; carfentrazone-ethyl+nicosulfuron+primisulfuron+sulfosate; carfentrazone-ethyl+nicosulfuron+prosulfuron+sulfosate; carfentrazone-ethyl+rimsulfuron+primisulfuron+sulfosate; carfentrazone-ethyl+rimsulfuron+prosulfuron+sulfosate; carfentrazone-ethyl+metolachlor+isoxaflutole+sulfosate; carfentrazone-ethyl+metolachlor+isoxaflutole+sulfosate+benoxacor; carfentrazone-ethyl+S-metolachlor+isoxaflutole+sulfosate; carfentrazone-ethyl+S-metolachlor+isoxaflutole+sulfosate+benoxacor; carfentrazone-ethyl+metolachlor+mesotrione+sulfosate; carfentrazone-ethyl +metolachlor+mesotrione+sulfosate+benoxacor; carfentrazone-ethyl+S-metolachlor+mesotrione+sulfosate; carfentrazone-ethyl+S-metolachlor+mesotrione+sulfosate+benoxacor; carfentrazone-ethyl+metolachlor+atrazine+sulfosate; carfentrazone-ethyl+metolachlor+atrazine+sulfosate+benoxacor; carfentrazone-ethyl+S-metolachlor+atrazine+sulfosate; carfentrazone-ethyl+S-metolachlor+atrazine+sulfosate+benoxacor; carfentrazone-ethyl+metolachlor+terbuthylazine+sulfosate; carfentrazone-ethyl+metolachlor+terbuthylazine+sulfosate+benoxacor; carfentrazone-ethyl+S-metolachlor+terbuthylazine+sulfosate; carfentrazone-ethyl+S-metolachlor+terbuthylazine+sulfosate+benoxacor; carfentrazone-ethyl+atrazine+nicosulfuron+sulfosate; carfentrazone-ethyl+atrazine+nicosulfuron+sulfosate+benoxacor; compound of the formula A+prosulfuron+primisulfuron+sulfosate; compound of the formula A+prosulfuron+dicamba+sulfosate; compound of the formula A+primisulfuron+dicamba+sulfosate; compound of the formula A+nicosulfuron+primisulfuron+sulfosate; compound of the formula A+nicosulfuron+prosulfuron+sulfosate; compound of the formula A+rimsulfuron+primisulfuron+sulfosate; compound of the formula A+rimsulfuron+prosulfuron+sulfosate; compound of the formula A+metolachlor+isoxaflutole+sulfosate; compound of the formula A+metolachlor+isoxaflutole+sulfosate+benoxacor; compound of the formula A+S-metolachlor+isoxaflutole+sulfosate; compound of the formula A+S-metolachlor+isoxaflutole+sulfosate+benoxacor; compound of the formula A+metolachlor+mesotrione+sulfosate; compound of the formula A+metolachlor+mesotrione+sulfosate+benoxacor; compound of the formula A+S-metolachlor+mesotrione+sulfosate; compound of the formula A+S-metolachlor+mesotrione+sulfosate+benoxacor; compound of the formula A+metolachlor+atrazine+sulfosate; compound of the formula A+metolachlor+atrazine+sulfosate+benoxacor; compound of the formula A+S-metolachlor+atrazine+sulfosate; compound of the formula A+S-metolachlor+atrazine+sulfosate+benoxacor; compound of the formula A+metolachlor+terbuthylazine+sulfosate; compound of the formula A+metolachlor+terbuthylazine+sulfosate+benoxacor; compound of the formula A+S-metolachlor+terbuthylazine+sulfosate; compound of the formula A+S-metolachlor+terbuthylazine+sulfosate+benoxacor; compound of the formula A+atrazine+nicosulfuron+sulfosate; compound of the formula A+atrazine+nicosulfuron+sulfosate+benoxacor; cinidon-ethyl+prosulfuron+primisulfuron+sulfosate; cinidon-ethyl+prosulfuron+dicamba+sulfosate; cinidon-ethyl+primisulfuron+dicamba+sulfosate; cinidon-ethyl+nicosulfuron+primisulfuron+sulfosate; cinidon-ethyl+nicosulfuron+prosulfuron+sulfosate; cinidon-ethyl+rimsulfuron+primisulfuron+sulfosate; cinidon-ethyl+rimsulfuron+prosulfuron+sulfosate; cinidon-ethyl+metolachlor+isoxaflutole+sulfosate; cinidon-ethyl+metolachlor +isoxaflutole+sulfosate+benoxacor; cinidon-ethyl+S-metolachlor+isoxaflutole+sulfosate; cinidon-ethyl+S-metolachlor+isoxaflutole+sulfosate+benoxacor; cinidon-ethyl+metolachlor+mesotrione+sulfosate; cinidon-ethyl+metolachlor+mesotrione+sulfosate+benoxacor; cinidon-ethyl+S-metolachlor+mesotrione+sulfosate; cinidon-ethyl +S-metolachlor+mesotrione+sulfosate+benoxacor; cinidon-ethyl+metolachlor+atrazine+sulfosate; cinidon-ethyl+metolachlor+atrazine+sulfosate+benoxacor; cinidon-ethyl+S-metolachlor+atrazine+sulfosate; cinidon-ethyl+S-metolachlor+atrazine+sulfosate+benoxacor; cinidon-ethyl+metolachlor+terbuthylazine+sulfosate; cinidon-ethyl+metolachlor+terbuthylazine+sulfosate+benoxacor; cinidon-ethyl+S-metolachlor+terbuthylazine+sulfosate; cinidon-ethyl+S-metolachlor+terbuthylazine+sulfosate+benoxacor; cinidon-ethyl+atrazine+nicosulfuron+sulfosate; cinidon-ethyl+atrazine+nicosulfuron+sulfosate+benoxacor; flumiclorac-pentyl+prosulfuron+primisulfuron+sulfosate; flumiclorac-pentyl+prosulfuron+dicamba+sulfosate; flumiclorac-pentyl+primisulfuron+dicamba+sulfosate; flumiclorac-pentyl+nicosulfuron+primisulfuron+sulfosate; flumiclorac-pentyl+nicosulfuron+prosulfuron+sulfosate; flumiclorac-pentyl+rimsulfuron+primisulfuron+sulfosate; flumiclorac-pentyl+rimsulfuron +prosulfuron+sulfosate; flumiclorac-pentyl+metolachlor+isoxaflutole+sulfosate; flumiclorac-pentyl+metolachlor+isoxaflutole+sulfosate+benoxacor; flumiclorac-pentyl+S-metolachlor+isoxaflutole+sulfosate; flumiclorac-pentyl+S-metolachlor+isoxaflutole+sulfosate+benoxacor; flumiclorac-pentyl+metolachlor+mesotrione+sulfosate; flumiclorac-pentyl+metolachlor+mesotrione+sulfosate+benoxacor; flumiclorac-pentyl+S-metolachlor+mesotrione+sulfosate; flumiclorac-pentyl+S-metolachlor+mesotrione+sulfosate+benoxacor; flumiclorac-pentyl+metolachlor+atrazine+sulfosate; flumiclorac-pentyl+metolachlor+atrazine+sulfosate+benoxacor; flumiclorac-pentyl+S-metolachlor +atrazine+sulfosate; flumiclorac-pentyl+S-metolachlor+atrazine+sulfosate+benoxacor; flumiclorac-pentyl+metolachlor+terbuthylazine+sulfosate; flumiclorac-pentyl +metolachlor+terbuthylazine+sulfosate+benoxacor; flumiclorac-pentyl+S-metolachlor +terbuthylazine+sulfosate; flumiclorac-pentyl+S-metolachlor+terbuthylazine+sulfosate +benoxacor; flumiclorac-pentyl+atrazine+nicosulfuron+sulfosate; flumiclorac-pentyl+atrazine+nicosulfuron+sulfosate+benoxacor; flumioxazin+prosulfuron+primisulfuron+sulfosate; flumioxazin+prosulfuron+dicamba+sulfosate; flumioxazin+primisulfuron+dicamba+sulfosate; flumioxazin+nicosulfuron+primisulfuron+sulfosate; flumioxazin+nicosulfuron+prosulfuron+sulfosate; flumioxazin+rimsulfuron+primisulfuron+sulfosate; flumioxazin+rimsulfuron+prosulfuron+sulfosate; flumioxazin+metolachlor+isoxaflutole +sulfosate; flumioxazin+metolachlor+isoxaflutole+sulfosate+benoxacor; flumioxazin+S-metolachlor+isoxaflutole+sulfosate; flumioxazin+S-metolachlor+isoxaflutole+sulfosate+benoxacor; flumioxazin+metolachlor+mesotrione+sulfosate; flumioxazin+metolachlor+mesotrione+sulfosate+benoxacor; flumioxazin+S-metolachlor+mesotrione+sulfosate; flumioxazin+S-metolachlor+mesotrione+sulfosate+benoxacor; flumioxazin+metolachlor+atrazine+sulfosate; flumioxazin+metolachlor+atrazine+sulfosate+benoxacor; flumioxazin+S-metolachlor+atrazine+sulfosate; flumioxazin+S-metolachlor+atrazine+sulfosate+benoxacor; flumioxazin+metolachlor+terbuthylazine +sulfosate; flumioxazin+metolachlor+terbuthylazine+sulfosate+benoxacor; flumioxazin +S-metolachlor+terbuthylazine+sulfosate; flumioxazin+S-metolachlor+terbuthylazine+sulfosate+benoxacor; flumioxazin+atrazine+nicosulfuron+sulfosate; flumioxazin+atrazine+nicosulfuron+sulfosate+benoxacor; fluthiacet-methyl+prosulfuron+primisulfuron+sulfosate; fluthiacet-methyl+prosulfuron+dicamba+sulfosate; fluthiacet-methyl+primisulfuron+dicamba+sulfosate; fluthiacet-methyl+nicosulfuron+primisulfuron+sulfosate; fluthiacet-methyl+nicosulfuron+prosulfuron+sulfosate; fluthiacet-methyl+rimsulfuron+primisulfuron+sulfosate; fluthiacet-methyl+rimsulfuron+prosulfuron+sulfosate; fluthiacet-methyl+metolachlor+isoxaflutole+sulfosate; fluthiacet-methyl+metolachlor+isoxaflutole+sulfosate+benoxacor; fluthiacet-methyl+S-metolachlor+isoxaflutole+sulfosate; fluthiacet-methyl+S-metolachlor+isoxaflutole+sulfosate+benoxacor; fluthiacet-methyl+metolachlor+mesotrione+sulfosate; fluthiacet-methyl+metolachlor+mesotrione+sulfosate+benoxacor; fluthiacet-methyl+S-metolachlor+mesotrione+sulfosate; fluthiacet-methyl+S-metolachlor+mesotrione+sulfosate+benoxacor; fluthiacet-methyl+metolachlor+atrazine+sulfosate; fluthiacet-methyl+metolachlor+atrazine+sulfosate+benoxacor; fluthiacet-methyl+S-metolachlor +atrazine+sulfosate; fluthiacet-methyl+S-metolachlor+atrazine+sulfosate+benoxacor; fluthiacet-methyl+metolachlor+terbuthylazine+sulfosate; fluthiacet-methyl+metolachlor +terbuthylazine+sulfosate+benoxacor; fluthiacet-methyl+S-metolachlor+terbuthylazine +sulfosate; fluthiacet-methyl+S-metolachlor+terbuthylazine+sulfosate+benoxacor; fluthiacet-methyl+atrazine+nicosulfuron+sulfosate; fluthiacet-methyl+atrazine+nicosulfuron+sulfosate+benoxacor; oxadiargyl+prosulfuron+primisulfuron+sulfosate; oxadiargyl+prosulfuron+dicamba+sulfosate; oxadiargyl+primisulfuron+dicamba+sulfosate; oxadiargyl+nicosulfuron+primisulfuron+sulfosate; oxadiargyl+nicosulfuron+prosulfuron+sulfosate; oxadiargyl+rimsulfuron+primisulfuron+sulfosate; oxadiargyl+rimsulfuron+prosulfuron+sulfosate; oxadiargyl+metolachlor+isoxaflutole+sulfosate; oxadiargyl+metolachlor+isoxaflutole+sulfosate+benoxacor; oxadiargyl+S-metolachlor +isoxaflutole+sulfosate; oxadiargyl+S-metolachlor+isoxaflutole+sulfosate+benoxacor; oxadiargyl+metolachlor+mesotrione+sulfosate; oxadiargyl+metolachlor+mesotrione+sulfosate+benoxacor; oxadiargyl+S-metolachlor+mesotrione+sulfosate; oxadiargyl+S-metolachlor+mesotrione+sulfosate+benoxacor; oxadiargyl+metolachlor +atrazine+sulfosate; oxadiargyl+metolachlor+atrazine+sulfosate+benoxacor; oxadiargyl+S-metolachlor+atrazine+sulfosate; oxadiargyl+S-metolachlor+atrazine+sulfosate+benoxacor; oxadiargyl+metolachlor+terbuthylazine+sulfosate; oxadiargyl+metolachlor+terbuthylazine+sulfosate+benoxacor; oxadiargyl+S-metolachlor+terbuthylazine+sulfosate; oxadiargyl+S-metolachlor+terbuthylazine+sulfosate+benoxacor; oxadiargyl+atrazine+nicosulfuron+sulfosate; oxadiargyl+atrazine+nicosulfuron+sulfosate+benoxacor; oxadiazon+prosulfuron+primisulfuron+sulfosate; oxadiazon+prosulfuron+dicamba+sulfosate; oxadiazon+primisulfuron+dicamba+sulfosate; oxadiazon+nicosulfuron+primisulfuron+sulfosate; oxadiazon+nicosulfuron+prosulfuron+sulfosate; oxadiazon+rimsulfuron+primisulfuron+sulfosate; oxadiazon+rimsulfuron+prosulfuron+sulfosate; oxadiazon+metolachlor+isoxaflutole+sulfosate; oxadiazon+metolachlor+isoxaflutole+sulfosate+benoxacor; oxadiazon+S-metolachlor +isoxaflutole+sulfosate; oxadiazon+S-metolachlor+isoxaflutole+sulfosate+benoxacor; oxadiazon+metolachlor+mesotrione+sulfosate; oxadiazon+metolachlor+mesotrione+sulfosate+benoxacor; oxadiazon+S-metolachlor+mesotrione+sulfosate; oxadiazon+S-metolachlor+mesotrione+sulfosate+benoxacor; oxadiazon+metolachlor +atrazine+sulfosate; oxadiazon+metolachlor+atrazine+sulfosate+benoxacor; oxadiazon+S-metolachlor+atrazine+sulfosate; oxadiazon+S-metolachlor+atrazine+sulfosate+benoxacor; oxadiazon+metolachlor+terbuthylazine+sulfosate; oxadiazon+metolachlor+terbuthylazine+sulfosate+benoxacor; oxadiazon+S-metolachlor+terbuthylazine+sulfosate; oxadiazon+S-metolachlor+terbuthylazine+sulfosate+benoxacor; oxadiazon+atrazine+nicosulfuron+sulfosate; oxadiazon+atrazine+nicosulfuron+sulfosate+benoxacor; pentoxazone+prosulfuron+primisulfuron+sulfosate; pentoxazone+prosulfuron+dicamba+sulfosate; pentoxazone+primisulfuron+dicamba+sulfosate; pentoxazone+nicosulfuron+primisulfuron+sulfosate; pentoxazone +nicosulfuron+prosulfuron+sulfosate; pentoxazone+rimsulfuron+primisulfuron+sulfosate; pentoxazone+rimsulfuron+prosulfuron+sulfosate; pentoxazone+metolachlor +isoxaflutole+sulfosate; pentoxazone+metolachlor+isoxaflutole+sulfosate+benoxacor, pentoxazone+S-metolachlor+isoxaflutole+sulfosate; pentoxazone+S-metolachlor+isoxaflutole+sulfosate+benoxacor; pentoxazone+metolachlor+mesotrione+sulfosate; pentoxazone+metolachlor+mesotrione+sulfosate+benoxacor; pentoxazone+S-metolachlor+mesotrione+sulfosate; pentoxazone+S-metolachlor+mesotrione+sulfosate+benoxacor; pentoxazone+metolachlor+atrazine+sulfosate; pentoxazone+metolachlor+atrazine+sulfosate+benoxacor; pentoxazone+S-metolachlor+atrazine+sulfosate; pentoxazone+S-metolachlor+atrazine+sulfosate+benoxacor; pentoxazone+metolachlor+terbuthylazine+sulfosate; pentoxazone+metolachlor+terbuthylazine+sulfosate+benoxacor; pentoxazone+S-metolachlor+terbuthylazine+sulfosate; pentoxazone+S-metolachlor+terbuthylazine+sulfosate+benoxacor; pentoxazone+atrazine+nicosulfuron+sulfosate; pentoxazone+atrazine+nicosulfuron+sulfosate+benoxacor; sulfentrazone+prosulfuron+primisulfuron+sulfosate; sulfentrazone+prosulfuron+dicamba+sulfosate; sulfentrazone+primisulfuron +dicamba+sulfosate; sulfentrazone+nicosulfuron+primisulfuron+sulfosate; sulfentrazone+nicosulfuron+prosulfuron+sulfosate; sulfentrazone+rimsulfuron+primisulfuron+sulfosate; sulfentrazone+rimsulfuron+prosulfuron+sulfosate; sulfentrazone+metolachlor+isoxaflutole+sulfosate; sulfentrazone+metolachlor+isoxaflutole+sulfosate+benoxacor; sulfentrazone+S-metolachlor+isoxaflutole+sulfosate; sulfentrazone+S-metolachlor+isoxaflutole+sulfosate+benoxacor; sulfentrazone+metolachlor+mesotrione+sulfosate; sulfentrazone+metolachlor+mesotrione+sulfosate+benoxacor; sulfentrazone+S-metolachlor+mesotrione+sulfosate; sulfentrazone+S-metolachlor+mesotrione+sulfosate+benoxacor; sulfentrazone+metolachlor+atrazine+sulfosate; sulfentrazone+metolachlor+atrazine+sulfosate+benoxacor; sulfentrazone+S-metolachlor+atrazine+sulfosate; sulfentrazone +S-metolachlor+atrazine+sulfosate+benoxacor; sulfentrazone+metolachlor+terbuthylazine+sulfosate; sulfentrazone+metolachlor+terbuthylazine+sulfosate+benoxacor; sulfentrazone+S-metolachlor+terbuthylazine+sulfosate; sulfentrazone+S-metolachlor+terbuthylazine+sulfosate+benoxacor; sulfentrazone+atrazine+nicosulfuron+sulfosate; sulfentrazone+atrazine+nicosulfuron+sulfosate+benoxacor; fluazolate+prosulfuron+primisulfuron+sulfosate; fluazolate+prosulfuron+dicamba+sulfosate; fluazolate+primisulfuron+dicamba+sulfosate; fluazolate+nicosulfuron+primisulfuron+sulfosate; fluazolate+nicosulfuron+prosulfuron+sulfosate; fluazolate+rimsulfuron+primisulfuron+sulfosate; fluazolate+rimsulfuron+prosulfuron+sulfosate; fluazolate+metolachlor+isoxaflutole+sulfosate; fluazolate+metolachlor+isoxaflutole+sulfosate+benoxacor; fluazolate+S-metolachlor+isoxaflutole+sulfosate; fluazolate+S-metolachlor+isoxaflutole+sulfosate+benoxacor, fluazolate+metolachlor+mesotrione+sulfosate; fluazolate+metolachlor+mesotrione+sulfosate+benoxacor; fluazolate+S-metolachlor+mesotrione+sulfosate; fluazolate+S-metolachlor+mesotrione+sulfosate+benoxacor, fluazolate+metolachlor+atrazine+sulfosate; fluazolate+metolachlor+atrazine+sulfosate+benoxacor; fluazolate+S-metolachlor+atrazine+sulfosate; fluazolate+S-metolachlor+atrazine+sulfosate+benoxacor; fluazolate+metolachlor+terbuthylazine+sulfosate; fluazolate+metolachlor+terbuthylazine+sulfosate+benoxacor; fluazolate+S-metolachlor+terbuthylazine+sulfosate; fluazolate+S-metolachlor+terbuthylazine+sulfosate+benoxacor; fluazolate+atrazine+nicosulfuron+sulfosate; fluazolate+atrazine+nicosulfuron+sulfosate+benoxacor; pyraflufen-ethyl+prosulfuron+primisulfuron+sulfosate; pyraflufen-ethyl+prosulfuron+dicamba+sulfosate; pyraflufen-ethyl+primisulfuron+dicamba+sulfosate; pyraflufen-ethyl+nicosulfuron+primisulfuron+sulfosate; pyraflufen-ethyl+nicosulfuron+prosulfuron+sulfosate; pyraflufen-ethyl+rimsulfuron+primisulfuron+sulfosate; pyraflufen-ethyl+rimsulfuron+prosulfuron+sulfosate; pyraflufen-ethyl+metolachlor+isoxaflutole+sulfosate; pyraflufen-ethyl+metolachlor+isoxaflutole+sulfosate+benoxacor; pyraflufen-ethyl+S-metolachlor+isoxaflutole+sulfosate; pyraflufen-ethyl+S-metolachlor+isoxaflutole+sulfosate+benoxacor; pyraflufen-ethyl+metolachlor+mesotrione+sulfosate; pyraflufen-ethyl+metolachlor+mesotrione+sulfosate+benoxacor; pyraflufen-ethyl+S-metolachlor+mesotrione+sulfosate; pyraflufen-ethyl+S-metolachlor+mesotrione+sulfosate+benoxacor; pyraflufen-ethyl+metolachlor+atrazine+sulfosate; pyraflufen-ethyl+metolachlor+atrazine+sulfosate+benoxacor; pyraflufen-ethyl+S-metolachlor+atrazine+sulfosate; pyraflufen-ethyl+S-metolachlor+atrazine+sulfosate+benoxacor; pyraflufen-ethyl+metolachlor+terbuthylazine+sulfosate; pyraflufen-ethyl+metolachlor+terbuthylazine+sulfosate+benoxacor; pyraflufen-ethyl+S-metolachlor+terbuthylazine+sulfosate; pyraflufen-ethyl+S-metolachlor+terbuthylazine+sulfosate+benoxacor; pyraflufen-ethyl+atrazine+nicosulfuron+sulfosate; pyraflufen-ethyl+atrazine +nicosulfuron+sulfosate+benoxacor; flumipropyn+prosulfuron+primisulfuron+sulfosate; flumipropyn+prosulfuron+dicamba+sulfosate; flumipropyn+primisulfuron+dicamba+sulfosate; flumipropyn+nicosulfuron+primisulfuron+sulfosate; flumipropyn+nicosulfuron+prosulfuron+sulfosate; flumipropyn+rimsulfuron+primisulfuron+sulfosate; flumipropyn+rimsulfuron+prosulfuron+sulfosate; flumipropyn+metolachlor+isoxaflutole+sulfosate; flumipropyn+metolachlor+isoxaflutole+sulfosate+benoxacor; flumipropyn+S-metolachlor+isoxaflutole+sulfosate; flumipropyn+S-metolachlor+isoxaflutole+sulfosate+benoxacor; flumipropyn+metolachlor+mesotrione+sulfosate; flumipropyn+metolachlor+mesotrione+sulfosate+benoxacor; flumipropyn+S-metolachlor+mesotrione+sulfosate; flumipropyn+S-metolachlor+mesotrione+sulfosate +benoxacor; flumipropyn+metolachlor+atrazine+sulfosate; flumipropyn+metolachlor+atrazine+sulfosate+benoxacor; flumipropyn+S-metolachlor+atrazine+sulfosate; flumipropyn+S-metolachlor+atrazine+sulfosate+benoxacor; flumipropyn+metolachlor +terbuthylazine+sulfosate; flumipropyn+metolachlor+terbuthylazine+sulfosate+benoxacor; flumipropyn+S-metolachlor+terbuthylazine+sulfosate; flumipropyn+S-metolachlor+terbuthylazine+sulfosate+benoxacor; flumipropyn+atrazine+nicosulfuron +sulfosate; flumipropyn+atrazine+nicosulfuron+sulfosate+benoxacor; flupropacil+prosulfuron+primisulfuron+sulfosate; flupropacil+prosulfuron+dicamba+sulfosate; flupropacil+primisulfuron+dicamba+sulfosate; flupropacil+nicosulfuron+primisulfuron +sulfosate; flupropacil+nicosulfuron+prosulfuron+sulfosate; flupropacil+rimsulfuron+primisulfuron+sulfosate; flupropacil+rimsulfuron+prosulfuron+sulfosate; flupropacil+metolachlor+isoxaflutole+sulfosate; flupropacil+metolachlor+isoxaflutole+sulfosate+benoxacor; flupropacil+S-metolachlor+isoxaflutole+sulfosate; flupropacil+S-metolachlor+isoxaflutole+sulfosate+benoxacor; flupropacil+metolachlor+mesotrione+sulfosate; flupropacil+metolachlor+mesotrione+sulfosate+benoxacor; flupropacil+S-metolachlor+mesotrione+sulfosate; flupropacil+S-metolachlor+mesotrione+sulfosate +benoxacor; flupropacil+metolachlor+atrazine+sulfosate; flupropacil+metolachlor+atrazine+sulfosate+benoxacor; flupropacil+S-metolachlor+atrazine+sulfosate; flupropacil+S-metolachlor+atrazine+sulfosate+benoxacor; flupropacil+metolachlor+terbuthylazine+sulfosate; flupropacil+metolachlor+terbuthylazine+sulfosate+benoxacor; flupropacil+S-metolachlor+terbuthylazine+sulfosate; flupropacil+S-metolachlor+terbuthylazine+sulfosate+benoxacor; flupropacil+atrazine+nicosulfuron +sulfosate; flupropacil+atrazine+nicosulfuron+sulfosate+benoxacor; nipyraclofen+prosulfuron+primisulfuron+sulfosate; nipyraclofen+prosulfuron+dicamba+sulfosate; nipyraclofen+primisulfuron+dicamba+sulfosate; nipyraclofen+nicosulfuron+primisulfuron+sulfosate; nipyraclofen+nicosulfuron+prosulfuron+sulfosate; nipyraclofen +rimsulfuron+primisulfuron+sulfosate; nipyraclofen+rimsulfuron+prosulfuron+sulfosate; nipyraclofen+metolachlor+isoxaflutole+sulfosate; nipyraclofen+metolachlor +isoxaflutole+sulfosate+benoxacor; nipyraclofen+S-metolachlor+isoxaflutole+sulfosate; nipyraclofen+S-metolachlor+isoxaflutole+sulfosate+benoxacor; nipyraclofen +metolachlor+mesotrione+sulfosate; nipyraclofen+metolachlor+mesotrione+sulfosate+benoxacor; nipyraclofen+S-metolachlor+mesotrione+sulfosate; nipyraclofen +S-metolachlor+mesotrione+sulfosate+benoxacor; nipyraclofen+metolachlor+atrazine+sulfosate; nipyraclofen+metolachlor+atrazine+sulfosate+benoxacor; nipyraclofen+S-metolachlor+atrazine+sulfosate; nipyraclofen+S-metolachlor+atrazine +sulfosate+benoxacor; nipyraclofen+metolachlor+terbuthylazine+sulfosate; nipyraclofen+metolachlor+terbuthylazine+sulfosate+benoxacor; nipyraclofen+S-metolachlor+terbuthylazine+sulfosate; nipyraclofen+S-metolachlor+terbuthylazine+sulfosate+benoxacor; nipyraclofen+atrazine+nicosulfuron+sulfosate; nipyraclofen+atrazine+nicosulfuron+sulfosate+benoxacor; benzfendizone+prosulfuron+primisulfuron+sulfosate; benzfendizone+prosulfuron+dicamba+sulfosate; benzfendizone+primisulfuron+dicamba+sulfosate; benzfendizone+nicosulfuron+primisulfuron+sulfosate; benzfendizone+nicosulfuron+prosulfuron+sulfosate; benzfendizone+rimsulfuron+primisulfuron+sulfosate; benzfendizone+rimsulfuron+prosulfuron+sulfosate; benzfendizone+metolachlor+isoxaflutole+sulfosate; benzfendizone+metolachlor+isoxaflutole+sulfosate+benoxacor; benzfendizone+S-metolachlor+isoxaflutole+sulfosate; benzfendizone+S-metolachlor+isoxaflutole+sulfosate+benoxacor; benzfendizone+metolachlor+mesotrione+sulfosate; benzfendizone+metolachlor+mesotrione+sulfosate+benoxacor; benzfendizone+S-metolachlor+mesotrione+sulfosate; benzfendizone+S-metolachlor+mesotrione+sulfosate+benoxacor; benzfendizone+metolachlor+atrazine+sulfosate; benzfendizone +metolachlor+atrazine+sulfosate+benoxacor; benzfendizone+S-metolachlor+atrazine+sulfosate; benzfendizone+S-metolachlor+atrazine+sulfosate+benoxacor; benzfendizone+metolachlor+terbuthylazine+sulfosate; benzfendizone+metolachlor+terbuthylazine+sulfosate+benoxacor; benzfendizone+S-metolachlor+terbuthylazine+sulfosate; benzfendizone+S-metolachlor+terbuthylazine+sulfosate+benoxacor; benzfendizone+atrazine+nicosulfuron+sulfosate; benzfendizone+atrazine+nicosulfuron+sulfosate+benoxacor; thidiazimin+prosulfuron+primisulfuron+sulfosate; thidiazimin+prosulfuron+dicamba+sulfosate; thidiazimin+primisulfuron+dicamba+sulfosate; thidiazimin+nicosulfuron+primisulfuron+sulfosate; thidiazimin+nicosulfuron+prosulfuron+sulfosate; thidiazimin+rimsulfuron+primisulfuron+sulfosate; thidiazimin+rimsulfuron+prosulfuron+sulfosate; thidiazimin+metolachlor+isoxaflutole+sulfosate; thidiazimin+metolachlor+isoxaflutole+sulfosate+benoxacor; thidiazimin+S-metolachlor +isoxaflutole+sulfosate; thidiazimin+S-metolachlor+isoxaflutole+sulfosate+benoxacor; thidiazimin+metolachlor+mesotrione+sulfosate; thidiazimin+metolachlor+mesotrione+sulfosate+benoxacor; thidiazimin+S-metolachlor+mesotrione+sulfosate; thidiazimin+S-metolachlor+mesotrione+sulfosate+benoxacor; thidiazimin+metolachlor +atrazine+sulfosate; thidiazimin+metolachlor+atrazine+sulfosate+benoxacor; thidiazimin+S-metolachlor+atrazine+sulfosate; thidiazimin+S-metolachlor+atrazine+sulfosate+benoxacor; thidiazimin+metolachlor+terbuthylazine+sulfosate; thidiazimin+metolachlor+terbuthylazine+sulfosate+benoxacor; thidiazimin+S-metolachlor+terbuthylazine+sulfosate; thidiazimin+S-metolachlor+terbuthylazine+sulfosate+benoxacor; thidiazimin+atrazine+nicosulfuron+sulfosate; and thidiazimin+atrazine+nicosulfuron+sulfosate+benoxacor.

Acifluorfen+metolachlor+isoxaflutole+sulfosate+MON 4660; acifluorfen+S-metolachlor+isoxaflutole+sulfosate+MON 4660; acifluorfen+metolachlor+mesotrione +sulfosate+MON 4660; acifluorfen+S-metolachlor+mesotrione+sulfosate+MON 4660; acifluorfen+metolachlor+atrazine+sulfosate+MON 4660; acifluorfen+S-metolachlor+atrazine+sulfosate+MON 4660; acifluorfen+metolachlor+terbuthylazine+sulfosate+MON 4660; acifluorfen+S-metolachlor+terbuthylazine+sulfosate+MON 4660; acifluorfen+atrazine+nicosulfuron+sulfosate+MON 4660; aclonifen+metolachlor +isoxaflutole+sulfosate+MON 4660; aclonifen+S-metolachlor+isoxaflutole+sulfosate +MON 4660; aclonifen+metolachlor+mesotrione+sulfosate+MON 4660; aclonifen+S-metolachlor+mesotrione+sulfosate+MON 4660; aclonifen+metolachlor+atrazine+sulfosate+MON 4660; aclonifen+S-metolachlor+atrazine+sulfosate+MON 4660; aclonifen+metolachlor+terbuthylazine+sulfosate+MON 4660; aclonifen+S-metolachlor +terbuthylazine+sulfosate+MON 4660; aclonifen+atrazine+nicosulfuron+sulfosate+MON 4660; bifenox+metolachlor+isoxaflutole+sulfosate+MON 4660; bifenox+S-metolachlor+isoxaflutole+sulfosate+MON 4660; bifenox+metolachlor+mesotrione+sulfosate+MON 4660; bifenox+S-metolachlor+mesotrione+sulfosate+MON 4660; bifenox+metolachlor+atrazine+sulfosate+MON 4660; bifenox+S-metolachlor+atrazine+sulfosate+MON 4660; bifenox+metolachlor+terbuthylazine+sulfosate+MON 4660; bifenox+S-metolachlor+terbuthylazine+sulfosate+MON 4660; bifenox+atrazine+nicosulfuron+sulfosate+MON 4660; chlomitrofen+metolachlor+isoxaflutole+sulfosate+MON 4660; chlomitrofen+S-metolachlor+isoxaflutole+sulfosate+MON 4660; chlomitrofen+metolachlor+mesotrione+sulfosate+MON 4660; chlomitrofen+S-metolachlor+mesotrione+sulfosate+MON 4660; chlomitrofen+metolachlor+atrazine+sulfosate+MON 4660; chlomitrofen+S-metolachlor+atrazine+sulfosate+MON 4660; chlomitrofen+metolachlor+terbuthylazine+sulfosate+MON 4660; chlomitrofen+S-metolachlor+terbuthylazine+sulfosate+MON 4660; chlomitrofen+atrazine+nicosulfuron+sulfosate+MON 4660; ethoxyfen+metolachlor+isoxaflutole+sulfosate+MON 4660; ethoxyfen+S-metolachlor+isoxaflutole+sulfosate+MON 4660; ethoxyfen+metolachlor+mesotrione+sulfosate+MON 4660; ethoxyfen+S-metolachlor+mesotrione +sulfosate+MON 4660; ethoxyfen+metolachlor+atrazine+sulfosate+MON 4660; ethoxyfen+S-metolachlor+atrazine+sulfosate+MON 4660; ethoxyfen+metolachlor+terbuthylazine+sulfosate+MON 4660; ethoxyfen+S-metolachlor+terbuthylazine+sulfosate+MON 4660; ethoxyfen+atrazine+nicosulfuron+sulfosate+MON 4660; fluoroglycofen+metolachlor+isoxaflutole+sulfosate+MON 4660; fluoroglycofen+S-metolachlor+isoxaflutole+sulfosate+MON 4660; fluoroglycofen+metolachlor+mesotrione+sulfosate+MON 4660; fluoroglycofen+S-metolachlor+mesotrione+sulfosate+MON 4660; fluoroglycofen+metolachlor+atrazine+sulfosate+MON 4660; fluoroglycofen+S-metolachlor+atrazine+sulfosate+MON 4660; fluoroglycofen+metolachlor+terbuthylazine+sulfosate+MON 4660; fluoroglycofen+S-metolachlor+terbuthylazine+sulfosate+MON 4660; fluoroglycofen+atrazine+nicosulfuron+sulfosate +MON 4660; fomesafen+metolachlor+isoxaflutole+sulfosate+MON 4660; fomesafen +S-metolachlor+isoxaflutole+sulfosate+MON 4660; fomesafen+metolachlor+mesotrione+sulfosate+MON 4660; fomesafen+S-metolachlor+mesotrione+sulfosate+MON 4660; fomesafen+metolachlor+atrazine+sulfosate+MON 4660; fomesafen+S-metolachlor+atrazine+sulfosate+MON 4660; fomesafen+metolachlor+terbuthylazine +sulfosate+MON 4660; fomesafen+S-metolachlor+terbuthylazine+sulfosate+MON 4660; fomesafen+atrazine+nicosulfuron+sulfosate+MON 4660; lactofen+metolachlor +isoxaflutole+sulfosate+MON 4660; lactofen+S-metolachlor+isoxaflutole+sulfosate+MON 4660; lactofen+metolachlor+mesotrione+sulfosate+MON 4660; lactofen+S-metolachlor+mesotrione+sulfosate+MON 4660; lactofen+metolachlor+atrazine+sulfosate+MON 4660; lactofen+S-metolachlor+atrazine+MON 4660; lactofen+metolachlor+terbuthylazine+sulfosate+MON 4660; lactofen+S-metolachlor+terbuthylazine+sulfosate+MON 4660; lactofen+atrazine+nicosulfuron+sulfosate+MON 4660; oxyfluorfen+metolachlor+isoxaflutole+sulfosate+MON 4660; oxyfluorfen+S-metolachlor+isoxaflutole+sulfosate+MON 4660; oxyfluorfen+metolachlor+mesotrione+sulfosate+MON 4660; oxyfluorfen+S-metolachlor+mesotrione+sulfosate +MON 4660; oxyfluorfen+metolachlor+atrazine+sulfosate+MON 4660; oxyfluorfen+S-metolachlor+atrazine+sulfosate+MON 4660; oxyfluorfen+metolachlor+terbuthylazine+sulfosate+MON 4660; oxyfluorfen+S-metolachlor+terbuthylazine+sulfosate+MON 4660; oxyfluorfen+atrazine+nicosulfuron+sulfosate+MON 4660; azafenidin+metolachlor+isoxaflutole+sulfosate+MON 4660; azafenidin+S-metolachlor +isoxaflutole+sulfosate+MON 4660; azafenidin+metolachlor+mesotrione+sulfosate+MON 4660; azafenidin+S-metolachlor+mesotrione+sulfosate+MON 4660; azafenidin+metolachlor+atrazine+sulfosate+MON 4660; azafenidin+S-metolachlor+atrazine+sulfosate+MON 4660; azafenidin+metolachlor+terbuthylazine+sulfosate+MON 4660; azafenidin+S-metolachlor+terbuthylazine+sulfosate+MON 4660; azafenidin+atrazine +nicosulfuron+sulfosate+MON 4660; carfentrazone-ethyl+metolachlor+isoxaflutole+sulfosate+MON 4660; carfentrazone-ethyl+S-metolachlor+isoxaflutole+sulfosate+MON 4660; carfentrazone-ethyl+metolachlor+mesotrione+sulfosate+MON 4660; carfentrazone-ethyl+S-metolachlor+mesotrione+sulfosate+MON 4660; carfentrazone-ethyl+metolachlor+atrazine+sulfosate+MON 4660; carfentrazone-ethyl+S-metolachlor +atrazine+sulfosate+MON 4660; carfentrazone-ethyl+metolachlor+terbuthylazine+sulfosate+MON 4660; carfentrazone-ethyl+S-metolachlor+terbuthylazine+sulfosate+MON 4660; carfentrazone-ethyl+atrazine+nicosulfuron+sulfosate+MON 4660; compound of the formula A+metolachlor+isoxaflutole+sulfosate+MON 4660; compound of the formula A+S-metolachlor+isoxaflutole+sulfosate+MON 4660; compound of the formula A+metolachlor+mesotrione+sulfosate+MON 4660; compound of the formula A+S-metolachlor+mesotrione+sulfosate+MON 4660; compound of the formula A+metolachlor+atrazine+sulfosate+MON 4660; compound of the formula A+S-metolachlor+atrazine+sulfosate+MON 4660; compound of the formula A+metolachlor+terbuthylazine+sulfosate+MON 4660; compound of the formula A+S-metolachlor+terbuthylazine+sulfosate+MON 4660; compound of the formula A+atrazine+nicosulfuron+sulfosate+MON 4660; cinidon-ethyl+metolachlor+isoxaflutole+sulfosate+MON 4660; cinidon-ethyl+S-metolachlor+isoxaflutole+sulfosate+MON 4660; cinidon-ethyl+metolachlor+mesotrione+sulfosate+MON 4660; cinidon-ethyl+S-metolachlor+mesotrione+sulfosate+MON 4660; cinidon-ethyl+metolachlor+atrazine+sulfosate+MON 4660; cinidon-ethyl+S-metolachlor+atrazine+sulfosate+MON 4660; cinidon-ethyl+metolachlor+terbuthylazine+sulfosate+MON 4660; cinidon-ethyl+S-metolachlor+terbuthylazine+sulfosate+MON 4660; cinidon-ethyl +atrazine+nicosulfuron+sulfosate+MON 4660; flumiclorac-pentyl+metolachlor+isoxaflutole+sulfosate+MON 4660; flumiclorac-pentyl+S-metolachlor+isoxaflutole+sulfosate+MON 4660; flumiclorac-pentyl+metolachlor+mesotrione+sulfosate+MON 4660; flumiclorac-pentyl+S-metolachlor+mesotrione+sulfosate+MON 4660; flumiclorac-pentyl+metolachlor+atrazine+sulfosate+MON 4660; flumiclorac-pentyl+S-metolachlor +atrazine+sulfosate+MON 4660; flumiclorac-pentyl+metolachlor+terbuthylazine+sulfosate+MON 4660; flumiclorac-pentyl+S-metolachlor+terbuthylazine+sulfosate+MON 4660; flumiclorac-pentyl+atrazine+nicosulfuron+sulfosate+MON 4660; flumioxazin+metolachlor+isoxaflutole+sulfosate+MON 4660; flumioxazin+S-metolachlor+isoxaflutole+sulfosate+MON 4660; flumioxazin+metolachlor+mesotrione +sulfosate+MON 4660; flumioxazin+S-metolachlor+mesotrione+sulfosate+MON 4660; flumioxazin+metolachlor+atrazine+sulfosate+MON 4660; flumioxazin+S-metolachlor+atrazine+sulfosate+MON 4660; flumioxazin+metolachlor+terbuthylazine +sulfosate+MON 4660; flumioxazin+S-metolachlor+terbuthylazine+sulfosate+MON 4660; flumioxazin+atrazine+nicosulfuron+sulfosate+MON 4660; fluthiacet-methyl+metolachlor+isoxaflutole+sulfosate+MON 4660; fluthiacet-methyl+S-metolachlor+isoxaflutole+sulfosate+MON 4660; fluthiacet-methyl+metolachlor+mesotrione+sulfosate+MON 4660; fluthiacet-methyl+S-metolachlor+mesotrione+sulfosate+MON 4660; fluthiacet-methyl+metolachlor+atrazine+sulfosate+MON 4660; fluthiacet-methyl +S-metolachlor+atrazine+sulfosate+MON 4660; fluthiacet-methyl+metolachlor+terbuthylazine+sulfosate+MON 4660; fluthiacet-methyl+S-metolachlor+terbuthylazine+sulfosate+MON 4660; fluthiacet-methyl+atrazine+nicosulfuron+sulfosate+MON 4660; oxadiargyl+metolachlor+isoxaflutole+sulfosate+MON 4660; oxadiargyl+S-metolachlor +isoxaflutole+sulfosate+MON 4660; oxadiargyl+metolachlor+mesotrione+sulfosate+MON 4660; oxadiargyl+S-metolachlor+mesotrione+sulfosate+MON 4660; oxadiargyl+metolachlor+atrazine+sulfosate+MON 4660; oxadiargyl+S-metolachlor+atrazine+sulfosate+MON 4660; oxadiargyl+metolachlor+terbuthylazine+sulfosate+MON 4660; oxadiargyl+S-metolachlor+terbuthylazine+sulfosate+MON 4660; oxadiargyl+atrazine +nicosulfuron+sulfosate+MON 4660; oxadiazon+metolachlor+isoxaflutole+sulfosate +MON 4660; oxadiazon+S-metolachlor+isoxaflutole+sulfosate+MON 4660; oxadiazon +metolachlor+mesotrione+sulfosate+MON 4660; oxadiazon+S-metolachlor+mesotrione+sulfosate+MON 4660; oxadiazon+metolachlor+atrazine+sulfosate+MON 4660; oxadiazon+S-metolachlor+atrazine+sulfosate+MON 4660; oxadiazon+metolachlor+terbuthylazine+sulfosate+MON 4660; oxadiazon+S-metolachlor+terbuthylazine+sulfosate+MON 4660; oxadiazon+atrazine+nicosulfuron+sulfosate+MON 4660; pentoxazone+metolachlor+isoxaflutole+sulfosate+MON 4660; pentoxazone+S-metolachlor+isoxaflutole+sulfosate+MON 4660; pentoxazone+metolachlor+mesotrione+sulfosate+MON 4660; pentoxazone+S-metolachlor+mesotrione+sulfosate+MON 4660; pentoxazone+metolachlor+atrazine+sulfosate+MON 4660; pentoxazone+S-metolachlor+atrazine+sulfosate+MON 4660; pentoxazone +metolachlor+terbuthylazine+sulfosate+MON 4660; pentoxazone+S-metolachlor+terbuthylazine+sulfosate+MON 4660; pentoxazone+atrazine+nicosulfuron+sulfosate +MON 4660; sulfentrazone+metolcarb; or+isoxaflutole+sulfosate+MON 4660; sulfentrazone+S-metolachlor+isoxaflutole+sulfosate+MON 4660; sulfentrazone+metolachlor+mesotrione+sulfosate+MON 4660; sulfentrazone+S-metolachlor+mesotrione+sulfosate+MON 4660; sulfentrazone+metolachlor+atrazine+sulfosate+MON 4660; sulfentrazone+S-metolachlor+atrazine+sulfosate+MON 4660; sulfentrazone+metolachlor+terbuthylazine+sulfosate+MON 4660; sulfentrazone+S-metolachlor+terbuthylazine+sulfosate+MON 4660; sulfentrazone+atrazine+nicosulfuron+sulfosate+MON 4660; fluazolate+metolachlor+isoxaflutole+sulfosate+MON 4660; fluazolate+S-metolachlor+isoxaflutole+sulfosate+MON 4660; fluazolate+metolachlor+mesotrione+sulfosate+MON 4660; fluazolate+S-metolachlor+mesotrione +sulfosate+MON 4660; fluazolate+metolachlor+atrazine+sulfosate+MON 4660; fluazolate+S-metolachlor+atrazine+sulfosate+MON 4660; fluazolate+metolachlor+terbuthylazine+sulfosate+MON 4660; fluazolate+S-metolachlor+terbuthylazine+sulfosate+MON 4660; fluazolate+atrazine+nicosulfuron+sulfosate+MON 4660; pyraflufen-ethyl+metolachlor+isoxaflutole+sulfosate+MON 4660; pyraflufen-ethyl+S-metolachlor+isoxaflutole+sulfosate+MON 4660; pyraflufen-ethyl+metolachlor+mesotrione+sulfosate+MON 4660; pyraflufen-ethyl+S-metolachlor+mesotrione+sulfosate+MON 4660; pyraflufen-ethyl+metolachlor+atrazine+sulfosate+MON 4660; pyraflufen-ethyl+S-metolachlor+atrazine+sulfosate+MON 4660; pyraflufen-ethyl+metolachlor+terbuthylazine+sulfosate+MON 4660; pyraflufen-ethyl+S-metolachlor+terbuthylazine+sulfosate+MON 4660; pyraflufen-ethyl+atrazine+nicosulfuron+sulfosate+MON 4660; flumipropyn+metolachlor+isoxaflutole+sulfosate+MON 4660; flumipropyn+S-metolachlor+isoxaflutole+sulfosate+MON 4660; flumipropyn+metolachlor+mesotrione+sulfosate+MON 4660; flumipropyn+S-metolachlor+mesotrione+sulfosate+MON 4660; flumipropyn+metolachlor+atrazine+sulfosate+MON 4660; flumipropyn+S-metolachlor+atrazine+sulfosate+MON 4660; flumipropyn+metolachlor+terbuthylazine+sulfosate+MON 4660; flumipropyn+S-metolachlor+terbuthylazine+sulfosate+MON 4660; flumipropyn+atrazine+nicosulfuron+sulfosate+MON 4660; flupropacil+metolachlor+isoxaflutole+sulfosate+MON 4660; flupropacil+S-metolachlor+isoxaflutole+sulfosate+MON 4660; flupropacil+metolachlor+mesotrione+sulfosate+MON 4660; flupropacil+S-metolachlor+mesotrione+sulfosate+MON 4660; flupropacil+metolachlor+atrazine+sulfosate+MON 4660; flupropacil+S-metolachlor+atrazine+sulfosate+MON 4660; flupropacil+metolachlor+terbuthylazine+sulfosate+MON 4660; flupropacil+S-metolachlor+terbuthylazine+sulfosate+MON 4660; flupropacil+atrazine+nicosulfuron+sulfosate+MON 4660; nipyraclofen+metolachlor+isoxaflutole+sulfosate+MON 4660; nipyraclofen+S-metolachlor+isoxaflutole+sulfosate+MON 4660; nipyraclofen+metolachlor+mesotrione+sulfosate+MON 4660; nipyraclofen+S-metolachlor+mesotrione+sulfosate+MON 4660; nipyraclofen+metolachlor+atrazine+sulfosate+MON 4660; nipyraclofen+S-metolachlor+atrazine+sulfosate+MON 4660; nipyraclofen+metolachlor+terbuthylazine +sulfosate+MON 4660; nipyraclofen+S-metolachlor+terbuthylazine+sulfosate+MON 4660; nipyraclofen+atrazine+nicosulfuron+sulfosate+MON 4660; benzfendizone+metolachlor+isoxaflutole+sulfosate+MON 4660; benzfendizone+S-metolachlor+isoxaflutole+sulfosate+MON 4660; benzfendizone+metolachlor+mesotrione+sulfosate+MON 4660; benzfendizone+S-metolachlor+mesotrione+sulfosate+MON 4660; benzfendizone+metolachlor+atrazine+sulfosate+MON 4660; benzfendizone+S-metolachlor+atrazine+sulfosate+MON 4660; benzfendizone+metolachlor+terbuthylazine+sulfosate+MON 4660; benzfendizone+S-metolachlor+terbuthylazine+sulfosate+MON 4660; benzfendizone+atrazine+nicosulfuron+sulfosate+MON 4660; thidiazimin+metolachlor+isoxaflutole+sulfosate+MON 4660; thidiazimin+S-metolachlor+isoxaflutole+sulfosate+MON 4660; thidiazimin+metolachlor+mesotrione +sulfosate+MON 4660; thidiazimin+S-metolachlor+mesotrione+sulfosate+MON 4660; thidiazimin+metolachlor+atrazine+sulfosate+MON 4660; thidiazimin+S-metolachlor+atrazine+sulfosate+MON 4660; thidiazimin+metolachlor+terbuthylazine +sulfosate+MON 4660; thidiazimin+S-metolachlor+terbuthylazine+sulfosate+MON 4660; and thidiazimin+atrazine+nicosulfuron+sulfosate+MON 4660.

Acifluorfen+metolachlor+isoxaflutole+sulfosate+FLURAZOLE; acifluorfen+S-metolachlor+isoxaflutole+sulfosate+FLURAZOLE; acifluorfen+metolachlor+mesotrione+sulfosate+FLURAZOLE; acifluorfen+S-metolachlor+mesotrione+sulfosate+FLURAZOLE; acifluorfen+metolachlor+atrazine+sulfosate+FLURAZOLE; acifluorfen+S-metolachlor+atrazine+sulfosate+FLURAZOLE; acifluorfen+metolachlor +terbuthylazine+sulfosate+FLURAZOLE; acifluorfen+S-metolachlor+terbuthylazine+sulfosate+FLURAZOLE; acifluorfen+atrazine+nicosulfuron+sulfosate+FLURAZOLE; aclonifen+metolachlor+isoxaflutole+sulfosate+FLURAZOLE; aclonifen+S-metolachlor +isoxaflutole+sulfosate+FLURAZOLE; aclonifen+metolachlor+mesotrione+sulfosate +FLURAZOLE; aclonifen+S-metolachlor+mesotrione+sulfosate+FLURAZOLE; aclonifen+metolachlor+atrazine+sulfosate+FLURAZOLE; aclonifen+S-metolachlor+atrazine+sulfosate+FLURAZOLE; aclonifen+metolachlor+terbuthylazine+sulfosate+FLURAZOLE; aclonifen+S-metolachlor+terbuthylazine+sulfosate+FLURAZOLE; aclonifen+atrazine+nicosulfuron+sulfosate+FLURAZOLE; bifenox+metolachlor+isoxaflutole+sulfosate+FLURAZOLE; bifenox+S-metolachlor+isoxaflutole+sulfosate+FLURAZOLE; bifenox+metolachlor+mesotrione+sulfosate+FLURAZOLE; bifenox+S-metolachlor+mesotrione+sulfosate+FLURAZOLE; bifenox+metolachlor+atrazine+sulfosate+FLURAZOLE; bifenox+S-metolachlor+atrazine+sulfosate+FLURAZOLE; bifenox+metolachlor+terbuthylazine+sulfosate+FLURAZOLE; bifenox+S-metolachlor +terbuthylazine+sulfosate+FLURAZOLE; bifenox+atrazine+nicosulfuron+sulfosate+FLURAZOLE; chlomitrofen+metolachlor+isoxaflutole+sulfosate+FLURAZOLE; chlomitrofen+S-metolachlor+isoxaflutole+sulfosate+FLURAZOLE; chlomitrofen+metolachlor+mesotrione+sulfosate+FLURAZOLE; chlomitrofen+S-metolachlor+mesotrione+sulfosate+FLURAZOLE; chlomitrofen+metolachlor+atrazine+sulfosate+FLURAZOLE; chiomitrofen+S-metolachlor+atrazine+sulfosate+FLURAZOLE; chiomitrofen+metolachilor+terbuthylazine+sulfosate+FLURAZOLE; chlomitrofen+S-metolachlor+terbuthylazine+sulfosate+FLURAZOLE; chlomitrofen+atrazine+nicosulfuron+sulfosate+FLURAZOLE; ethoxyfen+metolachlor+isoxaflutole+sulfosate +FLURAZOLE; ethoxyfen+S-metolachlor+isoxaflutole+sulfosate+FLURAZOLE; ethoxyfen+metolachlor+mesotrione+sulfosate+FLURAZOLE; ethoxyfen+S-metolachlor+mesotrione+sulfosate+FLURAZOLE; ethoxyfen+metolachlor+atrazine+sulfosate+FLURAZOLE; ethoxyfen+S-metolachlor+atrazine+sulfosate+FLURAZOLE; ethoxyfen+metolachlor+terbuthylazine+sulfosate+FLURAZOLE; ethoxyfen+S-metolachlor+terbuthylazine+sulfosate+FLURAZOLE; ethoxyfen+atrazine+nicosulfuron+sulfosate+FLURAZOLE; fluoroglycofen+metolachlor+isoxaflutole+sulfosate+FLURAZOLE; fluoroglycofen+S-metolachlor+isoxaflutole+sulfosate+FLURAZOLE; fluoroglycofen+metolachlor+mesotrione+sulfosate+FLURAZOLE; fluoroglycofen+S-metolachlor+mesotrione+sulfosate+FLURAZOLE; fluoroglycofen+metolachlor+atrazine+sulfosate+FLURAZOLE; fluoroglycofen+S-metolachlor+atrazine+sulfosate+FLURAZOLE; fluoroglycofen+metolachlor+terbuthylazine+sulfosate+FLURAZOLE; fluoroglycofen+S-metolachlor+terbuthylazine+sulfosate+FLURAZOLE; fluoroglycofen+atrazine+nicosulfuron+sulfosate+FLURAZOLE; fomesafen+metolachlor+isoxaflutole+sulfosate+FLURAZOLE; fomesafen+S-metolachlor+isoxaflutole+sulfosate+FLURAZOLE; fomesafen+metolachlor+mesotrione+sulfosate+FLURAZOLE; fomesafen+S-metolachlor+mesotrione+sulfosate+FLURAZOLE; fomesafen+metolachlor+atrazine+sulfosate+FLURAZOLE; fomesafen+S-metolachlor+atrazine+sulfosate+FLURAZOLE; fomesafen+metolachlor +terbuthylazine+sulfosate+FLURAZOLE; fomesafen+S-metolachlor+terbuthylazine+sulfosate+FLURAZOLE; fomesafen+atrazine+nicosulfuron+sulfosate+FLURAZOLE; lactofen+metolachlor+isoxaflutole+sulfosate+FLURAZOLE; lactofen+S-metolachlor+isoxaflutole+sulfosate+FLURAZOLE; lactofen+metolachlor+mesotrione+sulfosate+FLURAZOLE; lactofen+S-metolachlor+mesotrione+sulfosate+FLURAZOLE; lactofen+metolachlor+atrazine+sulfosate+FLURAZOLE; lactofen+S-metolachlor+atrazine+sulfosate+FLURAZOLE; lactofen+metolachlor+terbuthylazine+sulfosate+FLURAZOLE; lactofen+S-metolachlor+terbuthylazine+sulfosate+FLURAZOLE; lactofen+atrazine+nicosulfuron+sulfosate+FLURAZOLE; oxyfluorfen+metolachlor+isoxaflutole+sulfosate+FLURAZOLE; oxyfluorfen+S-metolachlor+isoxaflutole+sulfosate+FLURAZOLE; oxyfluorfen+metolachlor+mesotrione+sulfosate+FLURAZOLE; oxyfluorfen+S-metolachlor+mesotrione+sulfosate+FLURAZOLE; oxyfluorfen+metolachlor+atrazine+sulfosate+FLURAZOLE; oxyfluorfen+S-metolachlor+atrazine+sulfosate+FLURAZOLE; oxyfluorfen+metolachlor+terbuthylazine+sulfosate+FLURAZOLE; oxyfluorfen+S-metolachlor+terbuthylazine+sulfosate+FLURAZOLE; oxyfluorfen+atrazine+nicosulfuron+sulfosate+FLURAZOLE; azafenidin+metolachlor+isoxaflutole+sulfosate+FLURAZOLE; azafenidin+S-metolachlor+isoxaflutole+sulfosate+FLURAZOLE; azafenidin+metolachlor+mesotrione+sulfosate+FLURAZOLE; azafenidin+S-metolachlor+mesotrione+sulfosate+FLURAZOLE; azafenidin+metolachlor+atrazine+sulfosate+FLURAZOLE; azafenidin+S-metolachlor+atrazine+sulfosate+FLURAZOLE; azafenidin+metolachlor +terbuthylazine+sulfosate+FLURAZOLE; azafenidin+S-metolachlor+terbuthylazine+sulfosate+FLURAZOLE; azafenidin+atrazine+nicosulfuron+sulfosate+FLURAZOLE; carfentrazone-ethyl+metolachlor+isoxaflutole+sulfosate+FLURAZOLE; carfentrazone-ethyl+S-metolachlor+isoxaflutole+sulfosate+FLURAZOLE; carfentrazone-ethyl+metolachlor+mesotrione+sulfosate+FLURAZOLE; carfentrazone-ethyl+S-metolachlor+mesotrione+sulfosate+FLURAZOLE; carfentrazone-ethyl+metolachlor+atrazine+sulfosate+FLURAZOLE; carfentrazone-ethyl+S-metolachlor+atrazine+sulfosate+FLURAZOLE; carfentrazone-ethyl+metolachlor+terbuthylazine+sulfosate+FLURAZOLE; carfentrazone-ethyl+S-metolachlor+terbuthylazine+sulfosate+FLURAZOLE; carfentrazone-ethyl+atrazine+nicosulfuron+sulfosate+FLURAZOLE; compound of the formula A+metolachlor+isoxaflutole+sulfosate+FLURAZOLE; compound of the formula A+S-metolachlor+isoxaflutole+sulfosate+FLURAZOLE; compound of the formula A+metolachlor+mesotrione+sulfosate+FLURAZOLE; compound of the formula A+S-metolachlor+mesotrione+sulfosate+FLURAZOLE; compound of the formula A+metolachlor+atrazine+sulfosate+FLURAZOLE; compound of the formula A+S-metolachlor+atrazine+sulfosate+FLURAZOLE; compound of the formula A+metolachlor+terbuthylazine+sulfosate+FLURAZOLE; compound of the formula A+S-metolachlor+terbuthylazine+sulfosate+FLURAZOLE; compound of the formula A+atrazine+nicosulfuron+sulfosate+FLURAZOLE; cinidon-ethyl+metolachlor +isoxaflutole+sulfosate+FLURAZOLE; cinidon-ethyl+S-metolachlor+isoxaflutole+sulfosate+FLURAZOLE; cinidon-ethyl+metolachlor+mesotrione+sulfosate+FLURAZOLE; cinidon-ethyl+S-metolachlor+mesotrione+sulfosate+FLURAZOLE; cinidon-ethyl+metolachlor+atrazine+sulfosate+FLURAZOLE; cinidon-ethyl+S-metolachlor+atrazine+sulfosate+FLURAZOLE; cinidon-ethyl+metolachlor+terbuthylazine+sulfosate+FLURAZOLE; cinidon-ethyl+S-metolachlor+terbuthylazine+sulfosate+FLURAZOLE; cinidon-ethyl+atrazine+nicosulfuron+sulfosate+FLURAZOLE; flumiclorac-pentyl+metolachlor+isoxaflutole+sulfosate+FLURAZOLE; flumiclorac-pentyl+S-metolachlor+isoxaflutole+sulfosate+FLURAZOLE; flumiclorac-pentyl+metolachlor+mesotrione+sulfosate+FLURAZOLE; flumiclorac-pentyl+S-metolachlor+mesotrione+sulfosate+FLURAZOLE; flumiclorac-pentyl+metolachlor+atrazine+sulfosate+FLURAZOLE; flumiclorac-pentyl+S-metolachlor+atrazine+sulfosate+FLURAZOLE; flumiclorac-pentyl+metolachlor+terbuthylazine+sulfosate+FLURAZOLE; flumiclorac-pentyl+S-metolachlor+terbuthylazine+sulfosate+FLURAZOLE; flumiclorac-pentyl+atrazine+nicosulfuron+sulfosate+FLURAZOLE; flumioxazin+metolachlor+isoxaflutole+sulfosate+FLURAZOLE; flumioxazin+S-metolachlor+isoxaflutole+sulfosate+FLURAZOLE; flumioxazin+metolachlor+mesotrione+sulfosate+FLURAZOLE; flumioxazin+S-metolachlor+mesotrione+sulfosate+FLURAZOLE; flumioxazin+metolachlor+atrazine+sulfosate+FLURAZOLE; flumioxazin+S-metolachlor+atrazine+sulfosate+FLURAZOLE; flumioxazin+metolachlor+terbuthylazine+sulfosate+FLURAZOLE; flumioxazin+S-metolachlor+terbuthylazine+sulfosate+FLURAZOLE; flumioxazin+atrazine+nicosulfuron+sulfosate +FLURAZOLE; fluthiacet-methyl+metolachlor+isoxaflutole+sulfosate+FLURAZOLE; fluthiacet-methyl+S-metolachlor+isoxaflutole+sulfosate+FLURAZOLE; fluthiacet-methyl+metolachlor+mesotrione+sulfosate+FLURAZOLE; fluthiacet-methyl+S-metolachlor+mesotrione+sulfosate+FLURAZOLE; fluthiacet-methyl+metolachlor+atrazine+sulfosate+FLURAZOLE; fluthiacet-methyl+S-metolachlor+atrazine+sulfosate +FLURAZOLE; fluthiacet-methyl+metolachlor+terbuthylazine+sulfosate+FLURAZOLE; fluthiacet-methyl+S-metolachlor+terbuthylazine+sulfosate+FLURAZOLE; fluthiacet-methyl+atrazine+nicosulfuron+sulfosate+FLURAZOLE; oxadiargyl+metolachlor+isoxaflutole+sulfosate+FLURAZOLE; oxadiargyl+S-metolachlor+isoxaflutole+sulfosate+FLURAZOLE; oxadiargyl+metolachlor+mesotrione+sulfosate+FLURAZOLE; oxadiargyl+S-metolachlor+mesotrione+sulfosate+FLURAZOLE; oxadiargyl+metolachlor+atrazine+sulfosate+FLURAZOLE; oxadiargyl+S-metolachlor +atrazine+sulfosate+FLURAZOLE; oxadiargyl+metolachlor+terbuthylazine+sulfosate +FLURAZOLE; oxadiargyl+S-metolachlor+terbuthylazine+sulfosate+FLURAZOLE; oxadiargyl+atrazine+nicosulfuron+sulfosate+FLURAZOLE; oxadiazon+metolachlor+isoxaflutole+sulfosate+FLURAZOLE; oxadiazon+S-metolachlor+isoxaflutole+sulfosate+FLURAZOLE; oxadiazon+metolachlor+mesotrione+sulfosate+FLURAZOLE; oxadiazon+S-metolachlor+mesotrione+sulfosate+FLURAZOLE; oxadiazon+metolachlor+atrazine+sulfosate+FLURAZOLE; oxadiazon+S-metolachlor +atrazine+sulfosate+FLURAZOLE; oxadiazon+metolachlor+terbuthylazine+sulfosate +FLURAZOLE; oxadiazon+S-metolachlor+terbuthylazine+sulfosate+FLURAZOLE; oxadiazon+atrazine+nicosulfuron+sulfosate+FLURAZOLE; pentoxazone+metolachlor+isoxaflutole+sulfosate+FLURAZOLE; pentoxazone+S-metolachlor+isoxaflutole+sulfosate+FLURAZOLE; pentoxazone+metolachlor+mesotrione+sulfosate+FLURAZOLE; pentoxazone+S-metolachlor+mesotrione+sulfosate+FLURAZOLE; pentoxazone+metolachlor+atrazine+sulfosate+FLURAZOLE; pentoxazone+S-metolachlor+atrazine+sulfosate+FLURAZOLE; pentoxazone+metolachlor+terbuthylazine+sulfosate+FLURAZOLE; pentoxazone+S-metolachlor+terbuthylazine+sulfosate+FLURAZOLE; pentoxazone+atrazine+nicosulfuron+sulfosate+FLURAZOLE; sulfentrazone+metolachlor+isoxaflutole+sulfosate+FLURAZOLE; sulfentrazone+S-metolachlor+isoxaflutole+sulfosate+FLURAZOLE; sulfentrazone+metolachlor+mesotrione+sulfosate+FLURAZOLE; sulfentrazone+S-metolachlor+mesotrione+sulfosate+FLURAZOLE; sulfentrazone+metolachlor+atrazine+sulfosate+FLURAZOLE; sulfentrazone+S-metolachlor+atrazine+sulfosate+FLURAZOLE; sulfentrazone+metolachlor+terbuthylazine+sulfosate+FLURAZOLE; sulfentrazone+S-metolachlor+terbuthylazine+sulfosate+FLURAZOLE; sulfentrazone+atrazine+nicosulfuron+sulfosate+FLURAZOLE; fluazolate+metolachlor+isoxaflutole +sulfosate+FLURAZOLE; fluazolate+S-metolachlor+isoxaflutole+sulfosate+FLURAZOLE; fluazolate+metolachlor+mesotrione+sulfosate+FLURAZOLE; fluazolate +S-metolachlor+mesotrione+sulfosate+FLURAZOLE; fluazolate+metolachlor+atrazine+sulfosate+FLURAZOLE; fluazolate+S-metolachlor+atrazine+sulfosate+FLURAZOLE; fluazolate+metolachlor+terbuthylazine+sulfosate+FLURAZOLE; fluazolate+S-metolachlor+terbuthylazine+sulfosate+FLURAZOLE; fluazolate+atrazine +nicosulfuron+sulfosate+FLURAZOLE; pyraflufen-ethyl+metolachlor+isoxaflutole+sulfosate+FLURAZOLE; pyraflufen-ethyl+S-metolachlor+isoxaflutole+sulfosate+FLURAZOLE; pyraflufen-ethyl+metolachlor+mesotrione+sulfosate+FLURAZOLE; pyraflufen-ethyl+S-metolachlor+mesotrione+sulfosate+FLURAZOLE; pyraflufen-ethyl+metolachlor+atrazine+sulfosate+FLURAZOLE; pyraflufen-ethyl+S-metolachlor+atrazine+sulfosate+FLURAZOLE; pyraflufen-ethyl+metolachlor+terbuthylazine+sulfosate+FLURAZOLE; pyraflufen-ethyl+S-metolachlor+terbuthylazine+sulfosate+FLURAZOLE; pyraflufen-ethyl+atrazine+nicosulfuron+sulfosate+FLURAZOLE; flumipropyn+metolachlor+isoxaflutole+sulfosate+FLURAZOLE; flumipropyn+S-metolachlor+isoxaflutole+sulfosate+FLURAZOLE; flumipropyn+metolachlor+mesotrione+sulfosate+FLURAZOLE; flumipropyn+S-metolachlor+mesotrione+sulfosate+FLURAZOLE; flumipropyn+metolachlor+atrazine+sulfosate+FLURAZOLE; flumipropyn+S-metolachlor+atrazine+sulfosate+FLURAZOLE; flumipropyn+metolachlor+terbuthylazine+sulfosate+FLURAZOLE; flumipropyn+S-metolachlor+terbuthylazine+sulfosate+FLURAZOLE; flumipropyn+atrazine+nicosulfuron+sulfosate +FLURAZOLE; flupropacil+metolachlor+isoxaflutole+sulfosate+FLURAZOLE; flupropacil+S-metolachlor+isoxaflutole+sulfosate+FLURAZOLE; flupropacil+metolachlor+mesotrione+sulfosate+FLURAZOLE; flupropacil+S-metolachlor+mesotrione+sulfosate+FLURAZOLE; flupropacil+metolachlor+atrazine+sulfosate+FLURAZOLE; flupropacil+S-metolachlor+atrazine+sulfosate+FLURAZOLE; flupropacil +metolachlor+terbuthylazine+sulfosate+FLURAZOLE; flupropacil+S-metolachlor+terbuthylazine+sulfosate+FLURAZOLE; flupropacil+atrazine+nicosulfuron+sulfosate +FLURAZOLE; nipyraclofen+metolachlor+isoxaflutole+sulfosate+FLURAZOLE; nipyraclofen+S-metolachlor+isoxaflutole+sulfosate+FLURAZOLE; nipyraclofen+metolachlor+mesotrione+sulfosate+FLURAZOLE; nipyraclofen+S-metolachlor+mesotrione+sulfosate+FLURAZOLE; nipyraclofen+metolachlor+atrazine+sulfosate+FLURAZOLE; nipyraclofen+S-metolachlor+atrazine+sulfosate+FLURAZOLE; nipyraclofen+metolachlor+terbuthylazine+sulfosate+FLURAZOLE; nipyraclofen+S-metolachlor+terbuthylazine+sulfosate+FLURAZOLE; nipyraclofen+atrazine+nicosulfuron+sulfosate+FLURAZOLE; benzfendizone+metolachlor+isoxaflutole+sulfosate+FLURAZOLE; benzfendizone+S-metolachlor+isoxaflutole+sulfosate+FLURAZOLE; benzfendizone+metolachlor+mesotrione+sulfosate+FLURAZOLE; benzfendizone+S-metolachlor+mesotrione+sulfosate+FLURAZOLE; benzfendizone+metolachlor+atrazine+sulfosate+FLURAZOLE; benzfendizone+S-metolachlor+atrazine+sulfosate+FLURAZOLE; benzfendizone+metolachlor+terbuthylazine+sulfosate+FLURAZOLE; benzfendizone+S-metolachlor+terbuthylazine+sulfosate+FLURAZOLE; benzfendizone+atrazine+nicosulfuron+sulfosate+FLURAZOLE; thidiazimin+metolachlor+isoxaflutole+sulfosate+FLURAZOLE; thidiazimin+S-metolachlor+isoxaflutole+sulfosate+FLURAZOLE; thidiazimin+metolachlor+mesotrione+sulfosate+FLURAZOLE; thidiazimin+S-metolachlor+mesotrione+sulfosate+FLURAZOLE; thidiazimin+metolachlor+atrazine+sulfosate+FLURAZOLE; thidiazimin+S-metolachlor+atrazine+sulfosate+FLURAZOLE; thidiazimin+metolachlor +terbuthylazine+sulfosate+FLURAZOLE; thidiazimin+S-metolachlor+terbuthylazine+sulfosate+FLURAZOLE; and thidiazimin+atrazine+nicosulfuron+sulfosate+FLURAZOLE.

acifluorfen+metolachlor+isoxaflutole+sulfosate+DICHLORMID; acifluorfen+S-metolachlor+isoxaflutole+sulfosate+DICHLORMID; acifluorfen+metolachlor+mesotrione+sulfosate+DICHLORMID; acifluorfen+S-metolachlor+mesotrione+sulfosate+DICHLORMID; acifluorfen+metolachlor+atrazine+sulfosate+DICHLORMID; acifluorfen+S-metolachlor+atrazine+sulfosate+DICHLORMID; acifluorfen+metolachlor +terbuthylazine+sulfosate+DICHLORMID; acifluorfen+S-metolachlor+terbuthylazine+sulfosate+DICHLORMID; acifluorfen+atrazine+nicosulfuron+sulfosate+DICHLORMID; aclonifen+metolachlor+isoxaflutole+sulfosate+DICHLORMID; aclonifen+S-metolachlor+isoxaflutole+sulfosate+DICHLORMID; aclonifen+metolachlor+mesotrione+sulfosate+DICHLORMID; aclonifen+S-metolachlor+mesotrione+DICHLORMID; aclonifen+metolachlor+atrazine+sulfosate+DICHLORMID; aclonifen+S-metolachlor+atrazine+sulfosate+DICHLORMID; aclonifen+metolachlor+terbuthylazine+sulfosate+DICHLORMID; aclonifen+S-metolachlor+terbuthylazine+sulfosate+DICHLORMID; aclonifen+atrazine+nicosulfuron+sulfosate+DICHLORMID; bifenox+metolachlor+isoxaflutole+sulfosate+DICHLORMID; bifenox+S-metolachlor+isoxaflutole+sulfosate+DICHLORMID; bifenox+metolachlor+mesotrione+sulfosate+DICHLORMID; bifenox+S-metolachlor+mesotrione+sulfosate+DICHLORMID; bifenox+metolachlor+atrazine+sulfosate+DICHLORMID; bifenox+S-metolachlor+atrazine+sulfosate+DICHLORMID; bifenox+metolachlor+terbuthylazine+sulfosate+DICHLORMID; bifenox+S-metolachlor+terbuthylazine+sulfosate+DICHLORMID; bifenox+atrazine+nicosulfuron+sulfosate+DICHLORMID; chlomitrofen+metolachlor+isoxaflutole+sulfosate+DICHLORMID; chlomitrofen+S-metolachlor+isoxaflutole+sulfosate+DICHLORMID; chlomitrofen+metolachlor+mesotrione+sulfosate+DICHLORMID; chlomitrofen+S-metolachlor+mesotrione+sulfosate+DICHLORMID; chlomitrofen+metolachlor+atrazine+sulfosate+DICHLORMID; chlomitrofen+S-metolachlor+atrazine+sulfosate+DICHLORMID; chlomitrofen+metolachlor+terbuthylazine+sulfosate+DICHLORMID; chlomitrofen+S-metolachlor+terbuthylazine+sulfosate+DICHLORMID; chlomitrofen+atrazine+nicosulfuron+sulfosate+DICHLORMID; ethoxyfen+metolachlor+isoxaflutole+sulfosate+DICHLORMID; ethoxyfen+S-metolachlor+isoxaflutole+sulfosate+DICHLORMID; ethoxyfen+metolachlor+mesotrione+sulfosate+DICHLORMID; ethoxyfen+S-metolachlor+mesotrione+sulfosate+DICHLORMID; ethoxyfen+metolachlor+atrazine+sulfosate+DICHLORMID; ethoxyfen+S-metolachlor+atrazine+sulfosate+DICHLORMID; ethoxyfen +metolachlor+terbuthylazine+sulfosate+DICHLORMID; ethoxyfen+S-metolachlor+terbuthylazine+sulfosate+DICHLORMID; ethoxyfen+atrazine+nicosulfuron+sulfosate +DICHLORMID; fluoroglycofen+metolachlor+isoxaflutole+sulfosate+DICHLORMID; fluoroglycofen+S-metolachlor+isoxaflutole+sulfosate+DICHLORMID; fluoroglycofen+metolachlor+mesotrione+sulfosate+DICHLORMID; fluoroglycofen+S-metolachlor+mesotrione+sulfosate+DICHLORMID; fluoroglycofen+metolachlor+atrazine+sulfosate +DICHLORMID; fluoroglycofen+S-metolachlor+atrazine+sulfosate+DICHLORMID; fluoroglycofen+metolachlor+terbuthylazine+sulfosate+DICHLORMID; fluoroglycofen+S-metolachlor+terbuthylazine+sulfosate+DICHLORMID; fluoroglycofen+atrazine+nicosulfuron+sulfosate+DICHLORMID; fomesafen+metolachlor+isoxaflutole+sulfosate+DICHLORMID; fomesafen+S-metolachlor+isoxaflutole+sulfosate+DICHLORMID; fomesafen+metolachlor+mesotrione+sulfosate+DICHLORMID; fomesafen+S-metolachlor+mesotrione+sulfosate+DICHLORMID; fomesafen+metolachlor+atrazine+sulfosate+DICHLORMID; fomesafen+S-metolachlor+atrazine+sulfosate+DICHLORMID; fomesafen+metolachlor+terbuthylazine+sulfosate+DICHLORMID; fomesafen+S-metolachlor+terbuthylazine+sulfosate+DICHLORMID; fomesafen+atrazine+nicosulfuron+sulfosate+DICHLORMID; lactofen+metolachlor+isoxaflutole+sulfosate+DICHLORMID; lactofen+S-metolachlor+isoxaflutole+sulfosate +DICHLORMID; lactofen+metolachlor+mesotrione+sulfosate+DICHLORMID; lactofen +S-metolachlor+mesotrione+sulfosate+DICHLORMID; lactofen+metolachlor+atrazine +sulfosate+DICHLORMID; lactofen+S-metolachlor+atrazine+sulfosate+DICHLORMID; lactofen+metolachlor+terbuthylazine+sulfosate+DICHLORMID; lactofen +S-metolachlor+terbuthylazine+sulfosate+DICHLORMID; lactofen+atrazine+nicosulfuron+sulfosate+DICHLORMID; oxyfluorfen+metolachlor+isoxaflutole+sulfosate+DICHLORMID; oxyfluorfen+S-metolachlor+isoxaflutole+sulfosate+DICHLORMID; oxyfluorfen+metolachlor+mesotrione+sulfosate+DICHLORMID; oxyfluorfen+S-metolachlor+mesotrione+sulfosate+DICHLORMID; oxyfluorfen+metolachlor+atrazine+sulfosate+DICHLORMID; oxyfluorfen+S-metolachlor+atrazine+sulfosate+DICHLORMID; oxyfluorfen+metolachlor+terbuthylazine+sulfosate+DICHLORMID; oxyfluorfen+S-metolachlor+terbuthylazine+sulfosate+DICHLORMID; oxyfluorfen+atrazine+nicosulfuron+sulfosate+DICHLORMID; azafenidin+metolachlor +isoxaflutole+sulfosate+DICHLORMID; azafenidin+S-metolachlor+isoxaflutole+sulfosate+DICHLORMID; azafenidin+metolachlor+mesotrione+sulfosate+DICHLORMID; azafenidin+S-metolachlor+mesotrione+sulfosate+DICHLORMID; azafenidin+metolachlor+atrazine+sulfosate+DICHLORMID; azafenidin+S-metolachlor +atrazine+sulfosate+DICHLORMID; azafenidin+metolachlor+terbuthylazine+sulfosate+DICHLORMID; azafenidin+S-metolachlor+terbuthylazine+sulfosate+DICHLORMID; azafenidin+atrazine+nicosulfuron+sulfosate+DICHLORMID; carfentrazone-ethyl+metolachlor+isoxaflutole+sulfosate+DICHLORMID; carfentrazone-ethyl+S-metolachlor+isoxaflutole+sulfosate+DICHLORMID; carfentrazone-ethyl+metolachlor+mesotrione+sulfosate+DICHLORMID; carfentrazone-ethyl+S-metolachlor +mesotrione+sulfosate+DICHLORMID; carfentrazone-ethyl+metolachlor+atrazine+sulfosate+DICHLORMID; carfentrazone-ethyl+S-metolachlor+atrazine+sulfosate+DICHLORMID; carfentrazone-ethyl+metolachlor+terbuthylazine+sulfosate+DICHLORMID; carfentrazone-ethyl+S-metolachlor+terbuthylazine+sulfosate+DICHLORMID; carfentrazone-ethyl+atrazine+nicosulfuron+DICHLORMID; compound of the formula A+metolachlor+isoxaflutole+sulfosate+DICHLORMID; compound of the formula A+S-metolachlor+isoxaflutole+sulfosate+DICHLORMID; compound of the formula A+metolachlor+mesotrione+sulfosate+DICHLORMID; compound of the formula A+S-metolachlor+mesotrione+sulfosate+DICHLORMID; compound of the formula A+metolachlor+atrazine+sulfosate+DICHLORMID; compound of the formula A +S-metolachlor+atrazine+sulfosate+DICHLORMID; compound of the formula A+metolachlor+terbuthylazine+sulfosate+DICHLORMID; compound of the formula A+S-metolachlor+terbuthylazine+sulfosate+DICHLORMID; compound of the formula A+atrazine+nicosulfuron+sulfosate+DICHLORMID; cinidon-ethyl+metolachlor+isoxaflutole+sulfosate+DICHLORMID; cinidon-ethyl+S-metolachlor+isoxaflutole+sulfosate+DICHLORMID; cinidon-ethyl+metolachlor+mesotrione+sulfosate+DICHLORMID; cinidon-ethyl+S-metolachlor+mesotrione+sulfosate+DICHLORMID; cinidon-ethyl+metolachlor+atrazine+sulfosate+DICHLORMID; cinidon-ethyl+S-metolachlor+atrazine+sulfosate+DICHLORMID; cinidon-ethyl+metolachlor+terbuthylazine+sulfosate+DICHLORMID; cinidon-ethyl+S-metolachlor+terbuthylazine+sulfosate+DICHLORMID; cinidon-ethyl+atrazine+nicosulfuron+sulfosate+DICHLORMID; flumiclorac-pentyl+metolachlor+isoxaflutole+DICHLORMID; flumiclorac-pentyl+S-metolachlor+isoxaflutole+sulfosate+DICHLORMID; flumiclorac-pentyl+metolachlor+mesotrione+sulfosate+DICHLORMID; flumiclorac-pentyl+S-metolachlor+mesotrione+sulfosate+DICHLORMID; flumiclorac-pentyl+metolachlor+atrazine+sulfosate+DICHLORMID; flumiclorac-pentyl+S-metolachlor+atrazine+sulfosate+DICHLORMID; flumiclorac-pentyl+metolachlor+terbuthylazine+sulfosate+DICHLORMID; flumiclorac-pentyl+S-metolachlor+terbuthylazine+sulfosate+DICHLORMID; flumiclorac-pentyl+atrazine+nicosulfuron+sulfosate+DICHLORMID; flumioxazin+metolachlor+isoxaflutole+sulfosate+DICHLORMID; flumioxazin+S-metolachlor+isoxaflutole+sulfosate+DICHLORMID; flumioxazin+metolachlor+mesotrione+sulfosate+DICHLORMID; flumioxazin+S-metolachlor+mesotrione+sulfosate+DICHLORMID; flumioxazin+metolachlor+atrazine+sulfosate+DICHLORMID; flumioxazin+S-metolachlor+atrazine+sulfosate+DICHLORMID; flumioxazin+metolachlor+terbuthylazine+sulfosate+DICHLORMID; flumioxazin+S-metolachlor+terbuthylazine+sulfosate+DICHLORMID; flumioxazin+atrazine+nicosulfuron+sulfosate +DICHLORMID; fluthiacet-methyl+metolachlor+isoxaflutole+sulfosate+DICHLORMID; fluthiacet-methyl+S-metolachlor+isoxaflutole+sulfosate+DICHLORMID; fluthiacet-methyl+metolachlor+mesotrione+sulfosate+DICHLORMID; fluthiacet-methyl+S-metolachlor+mesotrione+sulfosate+DICHLORMID; fluthiacet-methyl+metolachlor+atrazine+sulfosate+DICHLORMID; fluthiacet-methyl+S-metolachlor+atrazine+sulfosate+DICHLORMID; fluthiacet-methyl+metolachlor+terbuthylazine+sulfosate+DICHLORMID; fluthiacet-methyl+S-metolachlor+terbuthylazine+sulfosate+DICHLORMID; fluthiacet-methyl+atrazine+nicosulfuron+sulfosate+DICHLORMID; oxadiargyl+metolachlor+isoxaflutole+sulfosate+DICHLORMID; oxadiargyl+S-metolachlor+isoxaflutole+sulfosate+DICHLORMID; oxadiargyl+metolachlor+mesotrione+sulfosate+DICHLORMID; oxadiargyl+S-metolachlor+mesotrione+sulfosate+DICHLORMID; oxadiargyl+metolachlor+atrazine+sulfosate+DICHLORMID; oxadiargyl+S-metolachlor+atrazine+sulfosate+DICHLORMID; oxadiargyl+metolachlor +terbuthylazine+sulfosate+DICHLORMID; oxadiargyl+S-metolachlor+terbuthylazine+sulfosate+DICHLORMID; oxadiargyl+atrazine+nicosulfuron+sulfosate+DICHLORMID; oxadiazon+metolachlor+isoxaflutole+sulfosate+DICHLORMID; oxadiazon+S-metolachlor+isoxaflutole+sulfosate+DICHLORMID; oxadiazon+metolachlor+mesotrione+sulfosate+DICHLORMID; oxadiazon+S-metolachlor+mesotrione+sulfosate+DICHLORMID; oxadiazon+metolachlor+atrazine+sulfosate+DICHLORMID; oxadiazon+S-metolachlor+atrazine+sulfosate+DICHLORMID; oxadiazon+metolachlor +terbuthylazine+sulfosate+DICHLORMID; oxadiazon+S-metolachlor+terbuthylazine+sulfosate+DICHLORMID; oxadiazon+atrazine+nicosulfuron+sulfosate+DICHLORMID; pentoxazone+metolachlor+isoxaflutole+sulfosate+DICHLORMID; pentoxazone+S-metolachlor+isoxaflutole+sulfosate+DICHLORMID; pentoxazone+metolachlor+mesotrione+sulfosate+DICHLORMID; pentoxazone+S-metolachlor+mesotrione+sulfosate+DICHLORMID; pentoxazone+metolachlor+atrazine+sulfosate+DICHLORMID; pentoxazone+S-metolachlor+atrazine+sulfosate+DICHLORMID; pentoxazone+metolachlor+terbuthylazine+sulfosate+DICHLORMID; pentoxazone+S-metolachlor+terbuthylazine+sulfosate+DICHLORMID; pentoxazone+atrazine+nicosulfuron+sulfosate+DICHLORMID; sulfentrazone+metolachlor+isoxaflutole+sulfosate+DICHLORMID; sulfentrazone+S-metolachlor+isoxaflutole+sulfosate+DICHLORMID; sulfentrazone+metolachlor+mesotrione+sulfosate+DICHLORMID; sulfentrazone+S-metolachlor+mesotrione+sulfosate+DICHLORMID; sulfentrazone+metolachlor+atrazine+sulfosate+DICHLORMID; sulfentrazone+S-metolachlor+atrazine+sulfosate+DICHLORMID; sulfentrazone+metolachlor+terbuthylazine+sulfosate+DICHLORMID; sulfentrazone+S-metolachlor+terbuthylazine+sulfosate+DICHLORMID; sulfentrazone+atrazine+nicosulfuron+sulfosate+DICHLORMID; fluazolate+metolachlor+isoxaflutole+sulfosate+DICHLORMID; fluazolate+S-metolachlor+isoxaflutole+sulfosate+DICHLORMID; fluazolate+metolachlor+mesotrione+sulfosate+DICHLORMID; fluazolate+S-metolachlor+mesotrione+sulfosate+DICHLORMID; fluazolate+metolachlor+atrazine+sulfosate+DICHLORMID; fluazolate+S-metolachlor+atrazine+sulfosate+DICHLORMID; fluazolate+metolachlor +terbuthylazine+sulfosate+DICHLORMID; fluazolate+S-metolachlor+terbuthylazine+sulfosate+DICHLORMID; fluazolate+atrazine+nicosulfuron+sulfosate+DICHLORMID; pyraflufen-ethyl+metolachlor+isoxaflutole+sulfosate+DICHLORMID; pyraflufen-ethyl+S-metolachlor+isoxaflutole+sulfosate+DICHLORMID; pyraflufen-ethyl+metolachlor+mesotrione+sulfosate+DICHLORMID; pyraflufen-ethyl+S-metolachlor+mesotrione+sulfosate+DICHLORMID; pyraflufen-ethyl+metolachlor+atrazine+sulfosate+DICHLORMID; pyraflufen-ethyl+S-metolachlor+atrazine+sulfosate+DICHLORMID; pyraflufen-ethyl+metolachlor+terbuthylazine+sulfosate+DICHLORMID; pyraflufen-ethyl +S-metolachlor+terbuthylazine+sulfosate+DICHLORMID; pyraflufen-ethyl+atrazine+nicosulfuron+sulfosate+DICHLORMID; flumipropyn+metolachlor+isoxaflutole+sulfosate+DICHLORMID; flumipropyn+S-metolachlor+isoxaflutole+sulfosate+DICHLORMID; flumipropyn+metolachlor+mesotrione+sulfosate+DICHLORMID; flumipropyn+S-metolachlor+mesotrione+sulfosate+DICHLORMID; flumipropyn+metolachlor+atrazine+sulfosate+DICHLORMID; flumipropyn+S-metolachlor+atrazine +sulfosate+DICHLORMID; flumipropyn+metolachlor+terbuthylazine+sulfosate+DICHLORMID; flumipropyn+S-metolachlor+terbuthylazine+sulfosate+DICHLORMID; flumipropyn+atrazine+nicosulfuron+sulfosate+DICHLORMID; flupropacil+metolachlor+isoxaflutole+sulfosate+DICHLORMID; flupropacil+S-metolachlor+isoxaflutole+sulfosate+DICHLORMID; flupropacil+metolachlor+mesotrione+sulfosate +DICHLORMID; flupropacil+S-metolachlor+mesotrione+sulfosate+DICHLORMID; flupropacil+metolachlor+atrazine+sulfosate+DICHLORMID; flupropacil+S-metolachlor +atrazine+sulfosate+DICHLORMID; flupropacil+metolachlor+terbuthylazine+sulfosate+DICHLORMID; flupropacil+S-metolachlor+terbuthylazine+sulfosate+DICHLORMID; flupropacil+atrazine+nicosulfuron+sulfosate+DICHLORMID; nipyraclofen+metolachlor+isoxaflutole+sulfosate+DICHLORMID; nipyraclofen+S-metolachlor+isoxaflutole+sulfosate+DICHLORMID; nipyraclofen+metolachlor+mesotrione+sulfosate+DICHLORMID; nipyraclofen+S-metolachlor+mesotrione+sulfosate+DICHLORMID; nipyraclofen+metolachlor+atrazine+sulfosate+DICHLORMID; nipyraclofen+S-metolachlor+atrazine+sulfosate+DICHLORMID; nipyraclofen+metolachlor+terbuthylazine+sulfosate+DICHLORMID; nipyraclofen+S-metolachlor+terbuthylazine+sulfosate+DICHLORMID; nipyraclofen+atrazine+nicosulfuron+sulfosate+DICHLORMID; benzfendizone+metolachlor+isoxaflutole+sulfosate+DICHLORMID; benzfendizone+S-metolachlor+isoxaflutole+sulfosate+DICHLORMID; benzfendizone+metolachlor+mesotrione+sulfosate+DICHLORMID; benzfendizone+S-metolachlor+mesotrione+sulfosate+DICHLORMID; benzfendizone+metolachlor+atrazine+sulfosate+DICHLORMID; benzfendizone+S-metolachlor+atrazine+sulfosate+DICHLORMID; benzfendizone+metolachlor+terbuthylazine+sulfosate+DICHLORMID; benzfendizone+S-metolachlor+terbuthylazine+sulfosate+DICHLORMID; benzfendizone+atrazine+nicosulfuron+sulfosate+DICHLORMID; thidiazimin+metolachlor+isoxaflutole+sulfosate+DICHLORMID; thidiazimin+S-metolachlor+isoxaflutole+sulfosate+DICHLORMID; thidiazimin+metolachlor+mesotrione+sulfosate+DICHLORMID; thidiazimin+S-metolachlor+mesotrione+sulfosate+DICHLORMID; thidiazimin+metolachlor+atrazine+sulfosate+DICHLORMID; thidiazimin+S-metolachlor+atrazine+sulfosate+DICHLORMID; thidiazimin+metolachlor+terbuthylazine+sulfosate+DICHLORMID; thidiazimin+S-metolachlor+terbuthylazine+sulfosate+DICHLORMID; and thidiazimin+atrazine+nicosulfuron+sulfosate+DICHLORMID.

Acifluorfen+metolachlor+isoxaflutole+sulfosate+FURILAZOLE; acifluorfen+S-metolachlor+isoxaflutole+sulfosate+FURILAZOLE; acifluorfen+metolachlor+mesotrione+sulfosate+FURILAZOLE; acifluorfen+S-metolachlor+mesotrione+sulfosate+FURILAZOLE; acifluorfen+metolachlor+atrazine+sulfosate+FURILAZOLE; acifluorfen+S-metolachlor+atrazine+sulfosate+FURILAZOLE; acifluorfen+metolachlor +terbuthylazine+sulfosate+FURILAZOLE; acifluorfen+S-metolachlor+terbuthylazine+sulfosate+FURILAZOLE; acifluorfen+atrazine+nicosulfuron+sulfosate+FURILAZOLE; aclonifen+metolachlor+isoxaflutole+sulfosate+FURILAZOLE; aclonifen+S-metolachlor+isoxaflutole+sulfosate+FURILAZOLE; aclonifen+metolachlor+mesotrione +sulfosate+FURILAZOLE; aclonifen+S-metolachlor+mesotrione+sulfosate+FURILAZOLE; aclonifen+metolachlor+atrazine+sulfosate+FURILAZOLE; aclonifen+S-metolachlor+atrazine+sulfosate+FURILAZOLE; aclonifen+metolachlor+terbuthylazine+sulfosate+FURILAZOLE; aclonifen+S-metolachlor+terbuthylazine+sulfosate+FURILAZOLE; aclonifen+atrazine+nicosulfuron+sulfosate+FURILAZOLE; bifenox+metolachlor+isoxaflutole+sulfosate+FURILAZOLE; bifenox+S-metolachlor+isoxaflutole+sulfosate+FURILAZOLE; bifenox+metolachlor+mesotrione+sulfosate+FURILAZOLE; bifenox+S-metolachlor+mesotrione+sulfosate+FURILAZOLE; bifenox+metolachlor+atrazine+sulfosate+FURILAZOLE; bifenox+S-metolachlor+atrazine+sulfosate+FURILAZOLE; bifenox+metolachlor+terbuthylazine+sulfosate+FURILAZOLE; bifenox+S-metolachlor+terbuthylazine+sulfosate+FURILAZOLE; bifenox+atrazine+nicosulfuron+sulfosate+FURILAZOLE; chlomitrofen+metolachlor+isoxaflutole+sulfosate+FURILAZOLE; chlomitrofen+S-metolachlor+isoxaflutole+sulfosate+FURILAZOLE; chlomitrofen+metolachlor+mesotrione+sulfosate+FURILAZOLE; chlomitrofen+S-metolachlor+mesotrione+sulfosate+FURILAZOLE; chlomitrofen+metolachlor+atrazine+sulfosate+FURILAZOLE; chlomitrofen+S-metolachlor+atrazine+sulfosate+FURILAZOLE; chlomitrofen+metolachlor+terbuthylazine+sulfosate+FURILAZOLE; chlomitrofen+S-metolachlor+terbuthylazine+sulfosate+FURILAZOLE; chlomitrofen+atrazine+nicosulfuron+sulfosate+FURILAZOLE; ethoxyfen+metolachlor+isoxaflutole+sulfosate+FURILAZOLE; ethoxyfen+S-metolachlor+isoxaflutole+sulfosate+FURILAZOLE; ethoxyfen+metolachlor+mesotrione+sulfosate+FURILAZOLE; ethoxyfen+S-metolachlor+mesotrione+sulfosate+FURILAZOLE; ethoxyfen+metolachlor+atrazine+sulfosate+FURILAZOLE; ethoxyfen+S-metolachlor+atrazine+sulfosate+FURILAZOLE; ethoxyfen +metolachlor+terbuthylazine+sulfosate+FURILAZOLE; ethoxyfen+S-metolachlor+terbuthylazine+sulfosate+FURILAZOLE; ethoxyfen+atrazine+nicosulfuron+sulfosate +FURILAZOLE; fluoroglycofen+metolachlor+isoxaflutole+sulfosate+FURILAZOLE; fluoroglycofen+S-metolachlor+isoxaflutole+sulfosate+FURILAZOLE; fluoroglycofen+metolachlor+mesotrione+sulfosate+FURILAZOLE; fluoroglycofen+S-metolachlor+mesotrione+sulfosate+FURILAZOLE; fluoroglycofen+metolachlor+atrazine+sulfosate +FURILAZOLE; fluoroglycofen+S-metolachlor+atrazine+sulfosate+FURILAZOLE; fluoroglycofen+metolachlor+terbuthylazine+sulfosate+FURILAZOLE; fluoroglycofen+S-metolachlor+terbuthylazine+sulfosate+FURILAZOLE; fluoroglycofen+atrazine+nicosulfuron+sulfosate+FURILAZOLE; fomesafen+metolachlor+isoxaflutole+sulfosate+FURILAZOLE; fomesafen+S-metolachlor+isoxaflutole+sulfosate+FURILAZOLE; fomesafen+metolachlor+mesotrione+sulfosate+FURILAZOLE; fomesafen+S-metolachlor+mesotrione+sulfosate+FURILAZOLE; fomesafen+metolachlor+atrazine+sulfosate+FURILAZOLE; fomesafen+S-metolachlor+atrazine+sulfosate+FURILAZOLE; fomesafen+metolachlor+terbuthylazine+sulfosate+FURILAZOLE; fomesafen+S-metolachlor+terbuthylazine+sulfosate+FURILAZOLE; fomesafen+atrazine+nicosulfuron+sulfosate+FURILAZOLE; lactofen+metolachlor+isoxaflutole+sulfosate+FURILAZOLE; lactofen+S-metolachlor+isoxaflutole+sulfosate +FURILAZOLE; lactofen+metolachlor+mesotrione+sulfosate+FURILAZOLE; lactofen +S-metolachlor+mesotrione+sulfosate+FURILAZOLE; lactofen+metolachlor+atrazine +sulfosate+FURILAZOLE; lactofen+S-metolachlor+atrazine+sulfosate+FURILAZOLE; lactofen+metolachlor+terbuthylazine+sulfosate+FURILAZOLE; lactofen +S-metolachlor+terbuthylazine+sulfosate+FURILAZOLE; lactofen+atrazine+nicosulfuron+sulfosate+FURILAZOLE; oxyfluorfen+metolachlor+isoxaflutole+sulfosate+FURILAZOLE; oxyfluorfen+S-metolachlor+isoxaflutole+sulfosate+FURILAZOLE; oxyfluorfen+metolachlor+mesotrione+sulfosate+FURILAZOLE; oxyfluorfen+S-metolachlor+mesotrione+sulfosate+FURILAZOLE; oxyfluorfen+metolachlor+atrazine+sulfosate+FURILAZOLE; oxyfluorfen+S-metolachlor+atrazine+sulfosate+FURILAZOLE; oxyfluorfen+metolachlor+terbuthylazine+sulfosate+FURILAZOLE; oxyfluorfen+S-metolachlor+terbuthylazine+sulfosate+FURILAZOLE; oxyfluorfen+atrazine+nicosulfuron+sulfosate+FURILAZOLE; azafenidin+metolachlor +isoxaflutole+sulfosate+FURILAZOLE; azafenidin+S-metolachlor+isoxaflutole+sulfosate+FURILAZOLE; azafenidin+metolachlor+mesotrione+sulfosate+FURILAZOLE; azafenidin+S-metolachlor+mesotrione+sulfosate+FURILAZOLE; azafenidin+metolachlor+atrazine+sulfosate+FURILAZOLE; azafenidin+S-metolachlor +atrazine+sulfosate+FURILAZOLE; azafenidin+metolachlor+terbuthylazine+sulfosate+FURILAZOLE; azafenidin+S-metolachlor+terbuthylazine+sulfosate+FURILAZOLE; azafenidin+atrazine+nicosulfuron+sulfosate+FURILAZOLE; carfentrazone-ethyl+metolachlor+isoxaflutole+sulfosate+FURILAZOLE; carfentrazone-ethyl+S-metolachlor+isoxaflutole+sulfosate+FURILAZOLE; carfentrazone-ethyl+metolachlor+mesotrione+sulfosate+FURILAZOLE; carfentrazone-ethyl+S-metolachlor +mesotrione+sulfosate+FURILAZOLE; carfentrazone-ethyl+metolachlor+atrazine+sulfosate+FURILAZOLE; carfentrazone-ethyl+S-metolachlor+atrazine+sulfosate+FURILAZOLE; carfentrazone-ethyl+metolachlor+terbuthylazine+sulfosate+FURILAZOLE; carfentrazone-ethyl+S-metolachlor+terbuthylazine+sulfosate+FURILAZOLE; carfentrazone-ethyl+atrazine+nicosulfuron+sulfosate+FURILAZOLE; compound of the formula A+metolachlor+isoxaflutole+sulfosate+FURILAZOLE; compound of the formula A+S-metolachlor+isoxaflutole+sulfosate+FURILAZOLE; compound of the formula A+metolachlor+mesotrione+sulfosate+FURILAZOLE; compound of the formula A+S-metolachlor+mesotrione+sulfosate+FURILAZOLE; compound of the formula A+metolachlor+atrazine+sulfosate+FURILAZOLE; compound of the formula A+S-metolachlor+atrazine+sulfosate+FURILAZOLE; compound of the formula A+metolachlor+terbuthylazine+sulfosate+FURILAZOLE; compound of the formula A+S-metolachlor+terbuthylazine+sulfosate+FURILAZOLE; compound of the formula A+atrazine+nicosulfuron+sulfosate+FURILAZOLE; cinidon-ethyl+metolachlor +isoxaflutole+sulfosate+FURILAZOLE; cinidon-ethyl+S-metolachlor+isoxaflutole+sulfosate+FURILAZOLE; cinidon-ethyl+metolachlor+mesotrione+sulfosate+FURILAZOLE; cinidon-ethyl+S-metolachlor+mesotrione+sulfosate+FURILAZOLE; cinidon-ethyl+metolachlor+atrazine+sulfosate+FURILAZOLE; cinidon-ethyl+S-metolachlor+atrazine+sulfosate+FURILAZOLE; cinidon-ethyl+metolachlor+terbuthylazine+sulfosate+FURILAZOLE; cinidon-ethyl+S-metolachlor+terbuthylazine+sulfosate+FURILAZOLE; cinidon-ethyl+atrazine+nicosulfuron+sulfosate+FURILAZOLE; flumiclorac-pentyl+metolachlor+isoxaflutole+sulfosate+FURILAZOLE; flumiclorac-pentyl+S-metolachlor+isoxaflutole+sulfosate+FURILAZOLE; flumiclorac-pentyl+metolachlor+mesotrione+sulfosate+FURILAZOLE; flumiclorac-pentyl+S-metolachlor+mesotrione+sulfosate+FURILAZOLE; flumiclorac-pentyl+metolachlor+atrazine+sulfosate+FURILAZOLE; flumiclorac-pentyl+S-metolachlor+atrazine+sulfosate+FURILAZOLE; flumiclorac-pentyl+metolachlor+terbuthylazine+sulfosate+FURILAZOLE; flumiclorac-pentyl+S-metolachlor+terbuthylazine+sulfosate+FURILAZOLE; flumiclorac-pentyl+atrazine+nicosulfuron+sulfosate+FURILAZOLE; flumioxazin+metolachlor+isoxaflutole+sulfosate+FURILAZOLE; flumioxazin+S-metolachlor+isoxaflutole+sulfosate+FURILAZOLE; flumioxazin+metolachlor+mesotrione+sulfosate+FURILAZOLE; flumioxazin+S-metolachlor+mesotrione+sulfosate+FURILAZOLE; flumioxazin+metolachlor+atrazine+sulfosate+FURILAZOLE; flumioxazin+S-metolachlor+atrazine+sulfosate+FURILAZOLE; flumioxazin+metolachlor+terbuthylazine+sulfosate+FURILAZOLE; flumioxazin+S-metolachlor+terbuthylazine+sulfosate+FURILAZOLE; flumioxazin+atrazine+nicosulfuron+sulfosate +FURILAZOLE; fluthiacet-methyl+metolachlor+isoxaflutole+sulfosate+FURILAZOLE; fluthiacet-methyl+S-metolachlor+isoxaflutole+sulfosate+FURILAZOLE; fluthiacet-methyl+metolachlor+mesotrione+sulfosate+FURILAZOLE; fluthiacet-methyl+S-metolachlor+mesotrione+sulfosate+FURILAZOLE; fluthiacet-methyl+metolachlor+atrazine+sulfosate+FURILAZOLE; fluthiacet-methyl+S-metolachlor+atrazine+sulfosate+FURILAZOLE; fluthiacet-methyl+metolachlor+terbuthylazine+sulfosate+FURILAZOLE; fluthiacet-methyl+S-metolachlor+terbuthylazine+sulfosate+FURILAZOLE; fluthiacet-methyl+atrazine+nicosulfuron+sulfosate+FURILAZOLE; oxadiargyl+metolachlor+isoxaflutole+sulfosate+FURILAZOLE; oxadiargyl+S-metolachlor+isoxaflutole+sulfosate+FURILAZOLE; oxadiargyl+metolachlor+mesotrione+sulfosate+FURILAZOLE; oxadiargyl+S-metolachlor+mesotrione+sulfosate+FURILAZOLE; oxadiargyl+metolachlor+atrazine+sulfosate+FURILAZOLE; oxadiargyl+S-metolachlor+atrazine+sulfosate+FURILAZOLE; oxadiargyl+metolachlor +terbuthylazine+sulfosate+FURILAZOLE; oxadiargyl+S-metolachlor+terbuthylazine+sulfosate+FURILAZOLE; oxadiargyl+atrazine+nicosulfuron+sulfosate+FURILAZOLE; oxadiazon+metolachlor+isoxaflutole+sulfosate+FURILAZOLE; oxadiazon+S-metolachlor+isoxaflutole+sulfosate+FURILAZOLE; oxadiazon+metolachlor+mesotrione+sulfosate+FURILAZOLE; oxadiazon+S-metolachlor+mesotrione+sulfosate+FURILAZOLE; oxadiazon+metolachlor+atrazine+sulfosate+FURILAZOLE; oxadiazon+S-metolachlor+atrazine+sulfosate+FURILAZOLE; oxadiazon+metolachlor +terbuthylazine+sulfosate+FURILAZOLE; oxadiazon+S-metolachlor+terbuthylazine+sulfosate+FURILAZOLE; oxadiazon+atrazine+nicosulfuron+sulfosate+FURILAZOLE; pentoxazone+metolachlor+isoxaflutole+sulfosate+FURILAZOLE; pentoxazone+S-metolachlor+isoxaflutole+sulfosate+FURILAZOLE; pentoxazone+metolachlor+mesotrione+sulfosate+FURILAZOLE; pentoxazone+S-metolachlor+mesotrione+sulfosate+FURILAZOLE; pentoxazone+metolachlor+atrazine+sulfosate+FURILAZOLE; pentoxazone+S-metolachlor+atrazine+sulfosate+FURILAZOLE; pentoxazone+metolachlor+terbuthylazine+sulfosate+FURILAZOLE; pentoxazone+S-metolachlor+terbuthylazine+sulfosate+FURILAZOLE; pentoxazone+atrazine+nicosulfuron+sulfosate+FURILAZOLE; sulfentrazone+metolachlor+isoxaflutole+sulfosate+FURILAZOLE; sulfentrazone+S-metolachlor+isoxaflutole+sulfosate+FURILAZOLE; sulfentrazone+metolachlor+mesotrione+sulfosate+FURILAZOLE; sulfentrazone+S-metolachlor+mesotrione+sulfosate+FURILAZOLE; sulfentrazone+metolachlor+atrazine+sulfosate+FURILAZOLE; sulfentrazone+S-metolachlor+atrazine+sulfosate+FURILAZOLE; sulfentrazone+metolachlor+terbuthylazine+sulfosate+FURILAZOLE; sulfentrazone+S-metolachlor+terbuthylazine+sulfosate+FURILAZOLE; sulfentrazone+atrazine+nicosulfuron+sulfosate+FURILAZOLE; fluazolate+metolachlor+isoxaflutole+sulfosate+FURILAZOLE; fluazolate+S-metolachlor+isoxaflutole+sulfosate+FURILAZOLE; fluazolate+metolachlor+mesotrione+sulfosate+FURILAZOLE; fluazolate+S-metolachlor+mesotrione+sulfosate+FURILAZOLE; fluazolate+metolachlor+atrazine+sulfosate+FURILAZOLE; fluazolate+S-metolachlor+atrazine+sulfosate+FURILAZOLE; fluazolate+metolachlor +terbuthylazine+sulfosate+FURILAZOLE; fluazolate+S-metolachlor+terbuthylazine+sulfosate+FURILAZOLE; fluazolate+atrazine+nicosulfuron+sulfosate+FURILAZOLE; pyraflufen-ethyl+metolachlor+isoxaflutole+sulfosate+FURILAZOLE; pyraflufen-ethyl+S-metolachlor+isoxaflutole+sulfosate+FURILAZOLE; pyraflufen-ethyl+metolachlor+mesotrione+sulfosate+FURILAZOLE; pyraflufen-ethyl+S-metolachlor+mesotrione+sulfosate+FURILAZOLE; pyraflufen-ethyl+metolachlor+atrazine+sulfosate+FURILAZOLE; pyraflufen-ethyl+S-metolachlor+atrazine+sulfosate+FURILAZOLE; pyraflufen-ethyl+metolachlor+terbuthylazine+sulfosate+FURILAZOLE; pyraflufen-ethyl +p-metolachlor+terbuthylazine+sulfosate+FURILAZOLE; pyraflufen-ethyl+atrazine+nicosulfuron+sulfosate+FURILAZOLE; flumipropyn+metolachlor+isoxaflutole+sulfosate+FURILAZOLE; flumipropyn+S-metolachlor+isoxaflutole+sulfosate+FURILAZOLE; flumipropyn+metolachlor+mesotrione+sulfosate+FURILAZOLE; flumipropyn+S-metolachlor+mesotrione+sulfosate+FURILAZOLE; flumipropyn+metolachlor+atrazine+sulfosate+FURILAZOLE; flumipropyn+S-metolachlor+atrazine +sulfosate+FURILAZOLE; flumipropyn+metolachlor+terbuthylazine+sulfosate+FURILAZOLE; flumipropyn+S-metolachlor+terbuthylazine+sulfosate+FURILAZOLE; flumipropyn+atrazine+nicosulfuron+sulfosate+FURILAZOLE; flupropacil+metolachlor +isoxaflutole+sulfosate+FURILAZOLE; flupropacil+S-metolachlor+isoxaflutole+sulfosate+FURILAZOLE; flupropacil+metolachlor+mesotrione+sulfosate+FURILAZOLE; flupropacil+S-metolachlor+mesotrione+sulfosate+FURILAZOLE; flupropacil+metolachlor+atrazine+sulfosate+FURILAZOLE; flupropacil+S-metolachlor +atrazine+sulfosate+FURILAZOLE; flupropacil+metolachlor+terbuthylazine+sulfosate+FURILAZOLE; flupropacil+S-metolachlor+terbuthylazine+sulfosate+FURILAZOLE; flupropacil+atrazine+nicosulfuron+sulfosate+FURILAZOLE; nipyraclofen+metolachlor+isoxaflutole+sulfosate+FURILAZOLE; nipyraclofen+S-metolachlor+isoxaflutole+sulfosate+FURILAZOLE; nipyraclofen+metolachlor+mesotrione+sulfosate+FURILAZOLE; nipyraclofen+S-metolachlor+mesotrione+sulfosate+FURILAZOLE; nipyraclofen+metolachlor+atrazine+sulfosate+FURILAZOLE; nipyraclofen+S-metolachlor+atrazine+sulfosate+FURILAZOLE; nipyraclofen+metolachlor+terbuthylazine+sulfosate+FURILAZOLE; nipyraclofen+S-metolachlor+terbuthylazine+sulfosate+FURILAZOLE; nipyraclofen+atrazine+nicosulfuron+sulfosate+FURILAZOLE; benzfendizone+metolachlor+isoxaflutole+sulfosate+FURILAZOLE; benzfendizone+S-metolachlor+isoxaflutole+sulfosate+FURILAZOLE; benzfendizone+metolachlor+mesotrione+sulfosate+FURILAZOLE; benzfendizone+S-metolachlor+mesotrione+sulfosate+FURILAZOLE; benzfendizone+metolachlor+atrazine+sulfosate+FURILAZOLE; benzfendizone+S-metolachlor+atrazine+sulfosate+FURILAZOLE; benzfendizone+metolachlor+terbuthylazine+sulfosate+FURILAZOLE; benzfendizone+S-metolachlor+terbuthylazine+sulfosate+FURILAZOLE; benzfendizone+atrazine+nicosulfuron+sulfosate+FURILAZOLE; thidiazimin+metolachlor+isoxaflutole+sulfosate+FURILAZOLE; thidiazimin+S-metolachlor+isoxaflutole+sulfosate+FURILAZOLE; thidiazimin+metolachlor+mesotrione+sulfosate+FURILAZOLE; thidiazimin+S-metolachlor+mesotrione+sulfosate +FURILAZOLE; thidiazimin+metolachlor+atrazine+sulfosate+FURILAZOLE; thidiazimin+S-metolachlor+atrazine+sulfosate+FURILAZOLE; thidiazimin+metolachlor +terbuthylazine+sulfosate+FURILAZOLE; thidiazimin+S-metolachlor+terbuthylazine+sulfosate+FURILAZOLE; and thidiazimin+atrazine+nicosulfuron+sulfosate+FURILAZOLE.

The weeds to be controlled can be both monocotyledonous and dicotyledonous weeds, for example Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica.

Areas under cultivation are the areas on which the crop plants are already growing, or on which the seeds of these crop plants have been sown, and also the soils which are intended to be cultivated with these crop plants.

Depending on the intended use, the safener c), for example benoxacor (61) and cloquintocet-mexyl (154), can be employed for pretreating the seeds of the crop plant (dressing of the seeds or the seedlings), or it fan be worked into the soil before or after seeding. However, it can also be applied on its own or together with the herbicide after the plants have emerged. Thus, the treatment of the plants or the seeds with the safener can, in principle, be carried out independently of when the herbicide is applied. However, the plant can also be treated by simultaneous application of herbicide and safener, for example as so-called “ready-mix” or as tank mix. The application rate of safener to herbicide to be applied depends essentially on the type of application. In an outdoor treatment which is carried out either by using a tank mix of a combination of safener and herbicide or by separate application of safener and herbicide, the ratio of herbicide to safener is generally from 100: to 1:10, preferably from 20:1 to 1:1.

In an outdoor treatment, generally from 1 to 2000 g of safener/ha, preferably from 1 to 500 g of safener/ha, are applied.

The application rates of herbicide a) and pesticide(s) b) are generally between 1 and 5000 g/ha, but preferably between 5 and 1000 g/ha.

The compositions according to the invention are suitable for all application methods which are customary in agriculture, for example pre-emergence application, post-emergence application and seed dressing.

For seed dressing, generally 0.001 to 10 g of safener/kg of seed, preferably 0.05 to 2 g of safener/kg of seed, are applied. If the safener c) applied in liquid form while swelling the seeds shortly before seeding, it is advantageous to employ safener solutions which comprise the active compound in a concentration of from 1 to 10,000, preferably from 100 to 1000 ppm.

For application, the safener c) and the herbicides under a) and b) are advantageously processed together with the auxiliaries conventionally used in the art of formulation, for example to give emulsion concentrates, spreadable pastes, directly sprayable or dilutable solutions, dilute emulsions, wettable powders, soluble powders, dusts, granules or microcapsules.

Such formulations are described, for example, in WO 97/34485 on pages 9 to 13. The formulations are prepared in a known manner, for example by intimate mixing and/or grinding of the active compounds with liquid or solid formulation auxiliaries, for example solvents or solid carriers. Surplus-active compounds (surfactants) can furthermore additionally be used during preparation of the formulations. Solvents and solid carriers which are suitable for this purpose are mentioned, for example, in WO 97/34485 on page 6.

Suitable surface-active compounds are, depending on the nature of the active compounds under a) and b) to be formulated, nonionic, cationic and/or anionic surfactants and surfactant mixtures having good emulsifying, dispersing and wetting properties. Examples of suitable anionic, nonionic and cationic surfactants are listed, for example, in WO 97/34485 on pages 7 and 8. The surfactants conventionally used in the art of formulation and which can also be used in the preparation of the herbicidal compositions according to the invention are described, inter alia, in ‘Mc Cutcheon's Detergents and Emulsifiers Annual” MC publishing Corp., Ridgewood, N.J., 1981, Stache, H., “Tensid-Taschenbuch” [Surfactant Handbook], Carl Hanser Verlag, Munich/Vienna, 1981 and M. and J. Ash, “Encyclopedia of Surfactants”, Vol I-III, Chemical publishing Co., New York, 1980-81.

The herbicidal formulations generally comprise 0.1 to 99% by weight, in particular 0.1 to 95% by weight, of the active compound mixture of the compound under a), the compounds selected under b) and the compounds under c), 1 to 99.9% by weight of a solid or liquid formulation auxiliary and 0 to 25% by weight, in particular 0.1 to 25% by weight, of a surfactant.

While concentrate compositions are usually preferred as commercial goods, the end user generally uses dilute compositions.

The compositions can also comprise further additives, such as stabilizers, for example epoxidized or non-epoxidized vegetable oils (epoxidized coconut oil, reepseed oil or Soya oil), defoamers, for example silicone oil, preservators, viscosity regulators, binders, tackifiers and fertilizers or other active substances. For using the safeners c) or compositions comprising them to protect crop plants against damaging effects of herbicides under a) and b), various methods and techniques are suitable, for example the following:

i) Seed dressing

a) Dressing of the seeds with an active compound c) formulated as a wettable powder by shaking in a vessel until even distribution on the surface of the seeds is achieved (dry dressing). Here, approximately 1 to 500 g of active compound under c) (4 g to 2 kg of wettable powder) are employed per 100 kg of seed.

b) Dressing the seeds using an emulsion concentrate of the active compound under c) according to method a) (wet dressing).

c) Dressing by dipping the seeds for 1 to 72 hours into a liquor containing 100-1000 ppm of active compound under c), with or without subsequent drying of the seeds (dip dressing).

Seed dressing or the treatment of the germinated seedlings are the naturally preferred application methods, since the treatment with active compound is completely directed at the target culture. In general, 1 to 1000 g of antidote c), preferably 5 to 250 g of antidote c), are employed per 100 kg of seed, but, depending on the method, which also permits the addition of other active compounds or micronutrients, it is possible to deviate above or below the stated limit concentration (repeat dressing).

ii) Application as tank mix

A liquid preparation of a mixture of antidote c) and herbicide a) and b) (neutral ratio between 10:1 and 1:100) is employed, the application rate of herbicide being from 5 to 5000 g per hector. Such tank mixers are applied before or after seeding.

iii) Application in the seed ferrule

The active compound under c) is applied into the open seeded seed ferrule as an emulsion concentrate, a wettable powder or as granules. After the seed ferrule has been covered, the herbicide is applied in a customary manner by the pre-emergence method.

iv) Controlled release of active compound

The active compound under c) is absorbed in solution onto mineral granule carriers or polymerized granules (urea/formaldehyde) and dried. If appropriate, a coating which allows the active compound to be released in metered form over a certain period of time can be applied (coated granules).

What is claimed is:

1. A herbicidal synergistic composition for the selective control of broad-leaved weeds and grasses in crops of useful plants resistant to protoporphyrinogen oxidase inhibitors, comprising, in addition to customary inert formulation auxiliaries, as active compounds a mixture of
a) a herbicide which inhibits the action of protoporphyrinogen oxidases and
b) at least one further pesticide selected from the group consisting of co-herbicides, fungicides and insecticides/parasites.

2. A composition according to claim 1, which comprises at least one further co-herbicide.

3. A herbicidal composition according to claim 2, comprising as herbicide a) a compound selected from the group of the diphenyl ethers, imides and phenylpyrazoles, and also fluazolate and thidiazimin.

4. A herbicidal composition according to claim 3, comprising as diphenyl ether acifluorphen, aclonifen, bifenox, chlomitrophen, ethoxyfen, fluoroglycofen-ethyl, fomesafen, lactofen or oxyfluorfen.

5. A herbicidal composition according to claim 3, comprising as imide azafenidin, carfentrazon-ethyl, cinidon-ethyl, flumiclorac-pentyl, flumioxazin, fluthiacet-methyl, oxadiargyl, oxadiazon, pentoxazone (KPP 314), sulfentrazone, flumipropyn, flupropacil, benzfendizone or the compound of the formula A

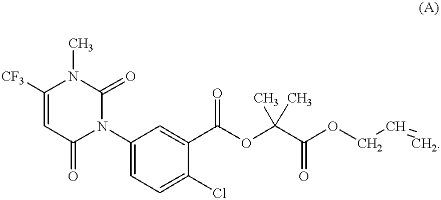

6. A herbicidal composition according to claim 3, comprising as phenylpyrazole nipyraclofen or pyraflufen-ethyl (ET 751).

7. A herbicidal composition according to claim 1 for controlling broad-leaved weeds and grasses in crops of maize, sugar beet, soya beans, rape, cotton, sunflowers, cereals, rice and sugar cane which are resistant to protoporphyrinogen oxidase inhibitors.

8. A herbicidal composition according to claim 1, for controlling weeds and grasses in crops of maize which are resistant to protoporphyrinogen inhibitors, where the co-herbicide b) is a compound selected from the group consisting of atrazine, terbuthylazine, (S)-metolachlor, metolachlor, terbutryn, simazine, dimethenamid or (S)-dimethenamid, flufenacet, acetochlor, alachlor, isoxaflutole, isoxachlortole, mesotrione, sulcotrione, metosulam, flumetsulam, pendimethalin, bromoxynil, bentazone, carfentrazone-ethyl, clomazone, nicosulfuron, rimsulfuron, halosulfuron-methyl, metribuzin, flumiclorac-pentyl, prosulfuron, primisulfuron-methyl, dicamba, fluthiacet-methyl, pyridate, 2,4-D, clopyralide, diflufenzopyr, fluroxypyr, MCPA, MCPB, mecoprop (MCPP), metobenzuron, thifensulfuron-methyl, aclonifen, EPTC, glyphosate, glufosinate, sulfosate and cyanazine, and compounds of the formulae A

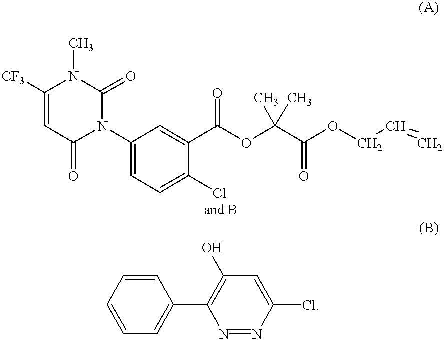

9. A herbicidal composition according to claim 8, where the co-herbicide b) is a compound selected from the group consisting of (S)-metolachlor, metolachlor, dimethenamid or (S)-dimethenamid, acetochlor and alachlor.

10. A herbicidal composition according to claim 9, comprising as additional component c) a safener of the benzoxazin type, in particular benoxacor, or MON 4660, flurazole, dichlormid or furilazole.

11. A herbicidal composition according to claim 1, for controlling weeds in crops of sugar beet resistant to protoporphyrinogen oxidase inhibitors, where the Go-herbicide b) is a compound selected from the group consisting of metolachlor, (S)-metolachlor, propaquizafop, metamitron, pyramin, phenmedipham, desmedipham, ethofumesate, triasulfuron, chloridazon, lenacil, triallate, fluazifop, sethoxydim, quizalofop, fenoxaprop, glyphosate, glufosinate, sulfosate and clethodim.

12. A herbicidal composition according to claim 1, for controlling weeds in crops of soya resistant to photoporphyrinogen oxidase inhibitors, where the co-herbicide b) is a compound selected from the group consisting of metolachlor, (S)-metolachlor, oxasulfuron, fluthiacet-methyl, propaquizafop, alachlor, dimethenamid or (S)-dimethenamid, acifluorfen, benazolin-ethyl, bentazone, carfentrazone-ethyl, sulfentrazone, chlorimuron-ethyl, cloransulam-methyl, thifensulfuron-methyl, clopyralid, flumiclorac-pentyl, flumetsulam, fomesafen, imazamox, imazaquin, imazethapyr, imazapyr, lactofen, pyridate, sethoxydim, fluazifop, quizalofop, clethodim, fenoxaprop(P-ethyl), thidiazuron, tribufos, pendimethalin, glyphosate, glufosinate, sulfosate and trifluralin.

13. A herbicidal composition according to claim 1, for controlling weeds in crops of rape resistant to protoporphyrinogen oxidase inhibitors, where the co-herbicide b) is a compound selected from the group consisting of dimethachlor, propaquizafop, clomazone, napropamide, quinmerac, metazachlor, carbetamide, dimefuron, propyzamide, clopyralid, ethametsulfuron-methyl, sethoxydim, fluazifop, quizalofop, clethodim, fenoxaprop(P-ethyl), glyphosate, glufosinate, sulfosate and tebutam.

14. A herbicidal composition according to claim 1, for controlling weeds in crops of cotton resistant to protoporphyrinogen oxidase inhibitors, where the co-herbicide b) is a compound selected from the group consisting of fluometuron, prometryn, metolachlor, (S)-metolachlor, norflurazon, propaquizafop, pyrithiobac-sodium, trifluralin, pendimethalin, bromoxynil, clomazone, MSMA, DMSA, fluazifop, quizalofop, fenoxaprop(P-ethyl), sethoxydim, clethodim, diuron, cyanazine, alachlor, acetochlor, flurochloridone, dithiopyr, thiazopyr, lactofen, oxyfluorfen, glyphosate, glufosinate, sulfosate and ethalfluralin, and also the compound of the formula C.

15. A herbicidal composition according to claim 1, for controlling weeds in crops of sunflowers resistant to protoporphyrinogen oxidase inhibitors, where the co-herbicide b) is a compound selected from the group consisting of metolachlor, (S)-metolachlor, pendimethalin, aclonifen, flurochloridon, prometryn, sethoxydim, fluazifop, quizalofop, clethodim, fenoxaprop(P-ethyl), terbutryn, acetochlor, glyphosate, glufosinate, sulfosate and trifluralin.

16. A herbicidal composition according to claim 1, for controlling weeds in crops of cereals resistant to protoporphyrinogen oxidase inhibitors, where the co-herbicide b) is a compound selected from the group consisting of triasulfuron, prosulfuron, clodinafop, terbutryn, amidosulfuron, bromoxynil, carfentrazone-ethyl, dicamba, diclofop-methyl, diflufenican, ethoxysulfuron, fenoxaprop(P-ethyl), fentrazamide, flazasulfuron, florasulam, fluazolate, flucarbazone, flufenacet, flupyrsulfuron-methyl sodium, flurtamone, iodosulfuron, isoproturon, chlortoluron, MCPA, MCPB, mecoprop (MCPP), chlorsulfuron, metsulfuron-methyl, sulfosulfuron, thifensulfuron-methyl, tribenuron-methyl, 2,4-D, 2,4-DB, 2,4-DP, bifenox, ethametsulfuron-methyl, flamprop-M, imazamethabenz-methyl, ioxynil, bromoxynil, metosulam, pyridate, quinmerac, tralkoxydim, fluoroglycofen-ethyl, methabenzthiazuron, ethalfluralin, pendimethalin, trifluralin, isoxaben, prosulfocarb, triallate, clopyralid, fluroxypyr, benazolin-ethyl, glyphosate, glufosinate, sulfosate and difenzoquat-metilsulfate.

17. A herbicidal composition according to claim 16, where the co-herbicide b) is a compound selected from the group consisting of triasulfuron, prosulfuron, clodinafop, amidosulfuron, diclofop-methyl, fenoxaprop(P-ethyl), flazasulfuron, flupyrsulfuron-methyl sodium, iodosulfuron, mecoprop (MCPP), chlorsulfuron, metsulfuron-methyl, sulfosulfuron and thifensulfuron-methyl.

18. A herbicidal composition according to claim 17, comprising as additional component c) a safener of the quinoline type, in particular cloquintocet-mexyl.

19. A herbicidal composition according to claim 1, for controlling weeds in crops of rice resistant to protoporphyrinogen oxidase inhibitors, where the co-herbicide b) is a compound selected from the group consisting of pretilachlor, cinosulfuron, triasulfuron, fenclorim, clodinafop, bensulfuron-methyl, imazosulfuron, pyrazosulfuron-ethyl, metsulfuron-methyl, azimsulfuron, halosulfuron-methyl, esprocarb, mefenacet, molinate, propanil, pyrazolate, cyhalofop-butyl, fenoxaprop(P-ethyl), bispyribac-sodium, pyriminobac-methyl, cafenstrole, oxadiargyl, oxadiazon, bromobutide, MY-100, dymron, NB 061, MK243, HW-52, glyphosate, glufosinate, sulfosate and AC 014, and also the compound of the formula D.

20. A herbicidal composition according to claim 1, for controlling weeds in crops of sugar cane resistant to protoporphyrinogen oxidase inhibitors, where the co-herbicide b) is a compound selected from the group consisting of atrazine, ametryn, dicamba, terbutryn, prosulfuron, hexazinone, asulam, diuron, 2,4-D, halosulfuron-methyl, flazasulfuron, isoxaflutole, azafenidin, tebuthiuron, sulcotrione, pendimethalin, clomazone, metribuzin, thiazopyr, glyphosate, glufosinate, sulfosate and ethoxysulfuron, and also the compound of the formula C.
